(19) United States
(12) Patent Application Publication
(10) Pub. No.: US 2023/0401628 A1
(43) Pub. Date: Dec. 14, 2023

(54) SYSTEM AND METHOD FOR ASSISTING GIFTERS WITH FINDING GIFTS FOR RECIPIENTS

(71) Applicant: GiftText.com Inc., Palo Alto, CA (US)

(72) Inventors: Adriana Ferreyr, Palm Beach, FL (US); Marcello Di Giovanni, Macerata Campania (CE) (IT)

(21) Appl. No.: 18/327,817

(22) Filed: Jun. 1, 2023

Related U.S. Application Data
(60) Provisional application No. 63/348,458, filed on Jun. 2, 2022.
(60) Provisional application No. 63/443,014, filed on Feb. 2, 2023.

(51) Int. Cl. G06Q 30/0601; G06Q 20/12

(52) U.S. Cl. CPC G06Q 30/0631; G06Q 20/123; G06Q 30/0641

(57) ABSTRACT

A gifting system for assisting a gifter with finding gift for selected recipients and delivering the gifts to the selected recipients and methods for making and utilizing the same. The gifting system enables the gifter to create a gifter profile and a recipient profile for each of one or more recipients. The recipient profile can include recipient preference information, a gift budget of the giver, an event type and other gift information. Evaluating the provided gift information, the gifting system can present one or more gift options to the gifter. The gifter can select one of the gift options for delivery to the recipient. The gifting system advantageously assist the gifter with finding a gift that is perfect for each recipient and each occasion.

### CROSS-REFERENCE TO RELATED APPLICATIONS

This application claims the benefit of, and priority to, U.S. Provisional Application Ser. No. 63/348,458, filed on Jun. 2, 2022, and U.S. Provisional Application Ser. No. 63/443,014, filed on Feb. 2, 2023, the disclosures of which are hereby incorporated herein by reference in their entireties and for all purposes.

### FIELD

The disclosed embodiments relate generally to the field of ecommerce and more particularly, but not exclusively, to systems and methods for assisting users with finding gifts for family members, friends and other individuals.

### BACKGROUND

The process of gifting always has involved time and effort to find a suitable gifts. As an initial matter, conventional gifting systems and methods require a gifter to physically travel to often-crowded brick and mortar stores or wade through endless webpages and internet links. The selection of available of gifts is limited by the vendor's stock, and, once a suitable gift is selected, the selected gift then must be packaged and shipped to the recipient.

The selection of a suitable gift requires the gifter to perform further work. The giver, for example, must spend time considering preferences of the recipient and remembering each birthday, anniversary and other significant occasion associated with the recipient. This work must be repeated for family member, friend or other individuals to whom the gifter wishes to send a gift.

Conventional gift registries can help to facilitate the gift-giving process. Such gift registries present static pages in which a giftee provides a list of gifts that the giftee wants and the gifters choose a gift from the list.

In view of the foregoing, a need exists for an improved system and method for assisting people with finding gifts for a group of recipients that overcome the aforementioned obstacles and deficiencies of currently-available gifting systems and methods.

### BRIEF DESCRIPTION OF THE DRAWINGS

FIG. 1 is a top-level flow chart illustrating an exemplary embodiment of a gifting method for assisting gifters with finding gifts for a group of recipients.

FIGS. 2A-G are detail diagrams illustrating exemplary embodiments of a personal profile page for enabling a gifter to enter a gifter profile via the gifting method of FIG. 1.

FIGS. 3A-L are detail diagrams illustrating exemplary embodiments of a recipient profile page for enabling the gifter to enter a recipient profile via the gifting method of FIG. 1.

FIG. 4A is a detail diagram illustrating an exemplary embodiment of an overview map for the gifting method of FIG. 1.

FIG. 4B is a detail diagram illustrating an exemplary embodiment of a landing page for the overview map of FIG. 4A.

FIGS. 5A-B are detail diagrams illustrating an exemplary embodiment of a registration page for the overview map of FIG. 4A.

FIGS. 5C-D are detail diagrams illustrating an exemplary embodiment of a login page for the overview map of FIG. 4A.

FIG. 6 is a detail diagram illustrating an exemplary embodiment of a new event page for the gifting method of FIG. 1.

FIGS. 7A-F are detail diagrams illustrating exemplary embodiments of an optional event management page for permitting the gifter to manage selected events associated with the recipient profiles via the gifting method of FIG. 1.

FIG. 8 is a detail diagram illustrating an exemplary embodiment of a home page for the gifting method of FIG. 1.

FIGS. 9A-R are detail diagrams illustrating an exemplary embodiment of a flower plan page for the gifting method of FIG. 1.

FIGS. 10A-L are detail diagrams illustrating an exemplary embodiment of a group gift exchange page for the gifting method of FIG. 1.

FIGS. 11A-J are detail diagrams illustrating an exemplary embodiment of a contact list page for the gifting method of FIG. 1.

FIGS. 12A-K are detail diagrams illustrating an exemplary embodiment of a gift preferences quiz page for the gifting method of FIG. 1.

FIGS. 13A-D are detail diagrams illustrating an exemplary embodiment of an occasions page for the gifting method of FIG. 1.

FIGS. 14A-I are detail diagrams illustrating an alternative embodiment of the occasions page of FIG. 13A-D, wherein the occasions page enables the gifter to send a text message to a selected recipient.

FIGS. 15A-K are detail diagrams illustrating another alternative embodiment of the occasions page of FIG. 13A-D, wherein the occasions page enables the gifter to send a virtual greeting card to the selected recipient.

FIGS. 16A-L are detail diagrams illustrating yet another alternative embodiment of the occasions page of FIG. 13A-D, wherein the occasions page enables the gifter to send a gift to the selected recipient.

FIGS. 17A-P are detail diagrams illustrating an exemplary embodiment of a direct gift page for the gifting method of FIG. 1.

FIGS. 18A-K are detail diagrams illustrating an exemplary embodiment of a local gift page for the gifting method of FIG. 1.

FIGS. 19A-O are detail diagrams illustrating an exemplary embodiment of a gifter profile page for the gifting method of FIG. 1.

FIGS. 20A-G are detail diagrams illustrating an exemplary alternative embodiment of the registration page of FIGS. 5A-B.

FIGS. 21A-I are detail diagrams illustrating an exemplary alternative embodiment of the login page of FIGS. 5C-D.

FIGS. 22A-H are detail diagrams illustrating an exemplary embodiment of a virtual gift page for the gifting method of FIG. 1.

FIGS. 23A-G are detail diagrams illustrating an exemplary embodiment of the gifting method of FIG. 1, wherein a vendor can enable the gifter to include one or more products and/or services available from the vendor into the gifter profile of the gifter.

FIGS. 24A-N are detail diagrams illustrating an alternative embodiment of the occasions page of FIGS. 14A-I, wherein the occasions page enables the gifter to send a text message with a charitable donation in the name of the selected recipient.

FIGS. 25A-P are detail diagrams illustrating another alternative embodiment of the occasions page of FIGS. 15A-K, wherein the occasions page enables the gifter to send a virtual greeting card with a charitable donation in the name of the selected recipient.

FIGS. 26A-N are detail diagrams illustrating another alternative embodiment of the occasions page of FIGS. 14A-I, wherein the occasions page enables the gifter to send a charitable donation in the name of the selected recipient.

FIGS. 27A-E are detail diagrams illustrating an alternative embodiment of the occasions page of FIGS. 14A-I, wherein the giving method includes sending a gift code with the text message to the selected recipient.

FIGS. 28A-E are detail diagrams illustrating another alternative embodiment of the occasions page of FIGS. 15A-K, wherein the giving method includes sending a greeting card code with the virtual greeting card to the selected recipient.

FIGS. 29A-D are detail diagrams illustrating an alternative embodiment of the occasions page of FIGS. 14A-I, wherein the giving method includes sending a gift card code with the text message to the selected recipient.

FIGS. 30A-H are detail diagrams illustrating an exemplary embodiment of a free gift feature for the gifting method of FIG. 1.

FIGS. 31A-N are detail diagrams illustrating an exemplary embodiment of a swipe to gift feature for the gifting method of FIG. 1.

FIG. 32 shows an example computer system for implementing the gifting method of FIG. 1.

FIGS. 33A-B are detail diagrams illustrating an exemplary alternative embodiment of the gift preferences quiz page of FIGS. 12A-K.

FIG. 34 is a detail diagram illustrating an exemplary alternative embodiment of the gift preferences quiz page of FIGS. 33A-B, wherein the gift preferences quiz page enables the gifter to select one or more kinds of clothing that the gifter would like to receive as a gift.

FIGS. 35A-L are detail diagrams illustrating an exemplary alternative embodiment of the gift preferences quiz page of FIG. 34, wherein the gift preferences quiz page presents one or more questions directed toward a first kind of clothing that the gifter would like to receive as a gift.

FIGS. 36A-I are detail diagrams illustrating another exemplary alternative embodiment of the gift preferences quiz page of FIG. 34, wherein the gift preferences quiz page presents one or more questions directed toward a second kind of clothing that the gifter would like to receive as a gift.

FIGS. 37A-I are detail diagrams illustrating yet another exemplary alternative embodiment of the gift preferences quiz page of FIG. 34, wherein the gift preferences quiz page presents one or more questions directed toward a third kind of clothing that the gifter would like to receive as a gift.

FIGS. 38A-I are detail diagrams illustrating another exemplary alternative embodiment of the gift preferences quiz page of FIGS. 33A-B, wherein the gift preferences quiz page enables the gifter to select one or more kinds of shoes that the gifter would like to receive as a gift.

FIG. 39 is a detail diagram illustrating yet another exemplary alternative embodiment of the gift preferences quiz page of FIGS. 33A-B, wherein the gift preferences quiz page enables the gifter to select one or more kinds of jewelry that the gifter would like to receive as a gift.

FIGS. 40A-H are detail diagrams illustrating an exemplary alternative embodiment of the gift preferences quiz page of FIG. 39, wherein the gift preferences quiz page presents one or more questions directed toward a first kind of jewelry that the gifter would like to receive as a gift.

FIGS. 41A-G are detail diagrams illustrating another exemplary alternative embodiment of the gift preferences quiz page of FIG. 39, wherein the gift preferences quiz page presents one or more questions directed toward a second kind of jewelry that the gifter would like to receive as a gift.

FIGS. 42A-H are detail diagrams illustrating yet another exemplary alternative embodiment of the gift preferences quiz page of FIG. 39, wherein the gift preferences quiz page presents one or more questions directed toward a third kind of jewelry that the gifter would like to receive as a gift.

FIG. 43A-C are detail diagrams illustrating still another exemplary alternative embodiment of the gift preferences quiz page of FIGS. 33A-B, wherein the gift preferences quiz page enables the gifter to select gifts at respective price points that the gifter would like to receive as a gift.

FIG. 44 is a detail diagram illustrating an exemplary embodiment of a completion page for the gift preferences quiz page of FIGS. 33A-B, wherein the completion page indicates that the gift preference quiz is complete and that the gifter profile of the gifter is complete.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

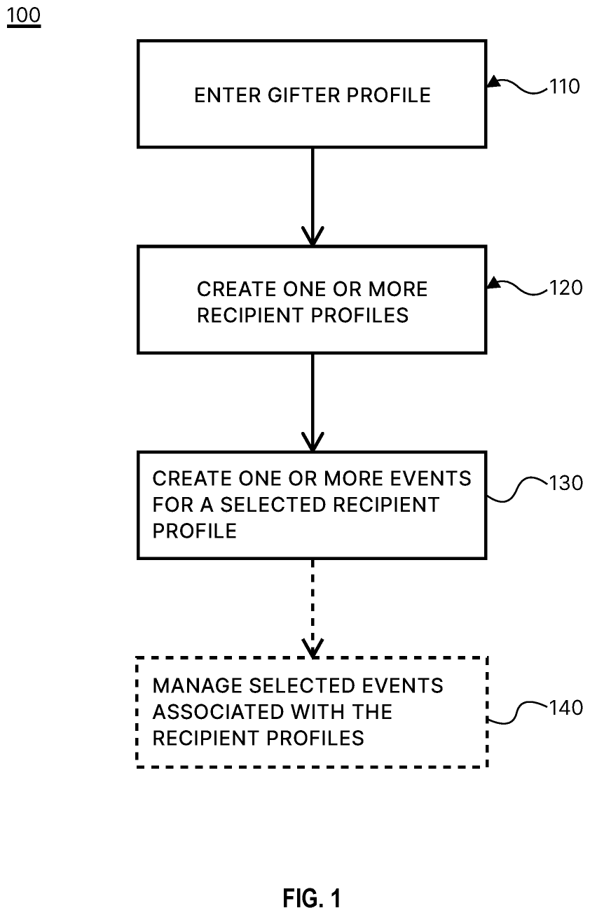

Since currently-available gifting systems and methods require a gifter to physically travel to stores, wade through endless webpages or visit static gift registry pages, to make a selection from a limited assortment of gifts that then must be packaged and shipped to the recipient, and to spend time considering preferences and remembering each significant occasion associated with each recipient, a gift profile system and method for dynamically assisting users with choosing, purchasing and delivering gifts for a group of recipients can prove desirable and provide a basis for a wide range of applications, such as for finding gifts for family members, friends, colleagues, acquaintances and other individuals. This result can be achieved, according to one embodiment disclosed herein, by a gifting method 100 as illustrated in FIG. 1.

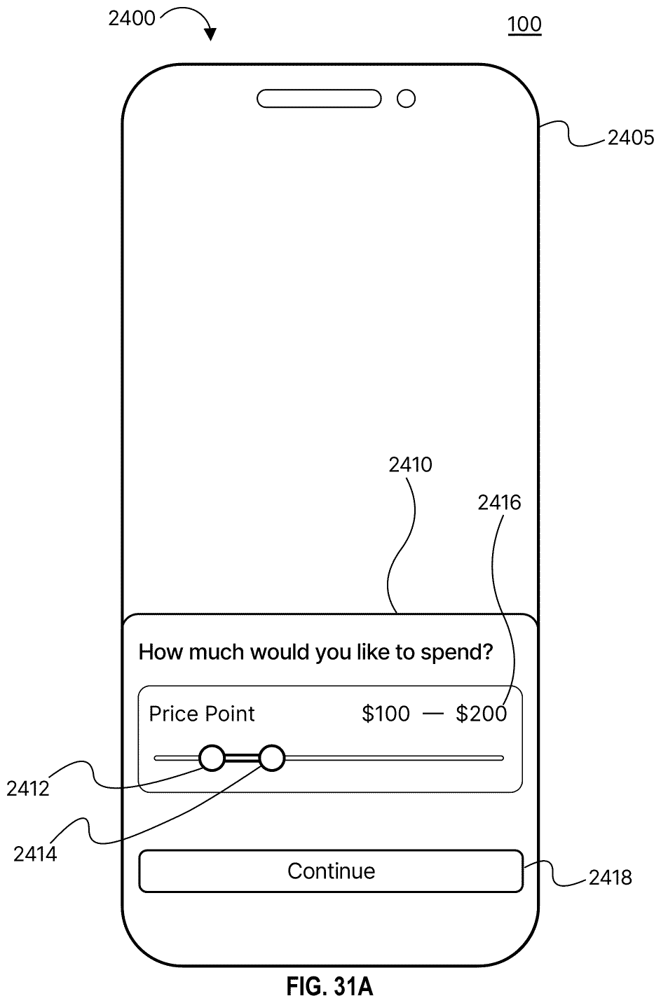

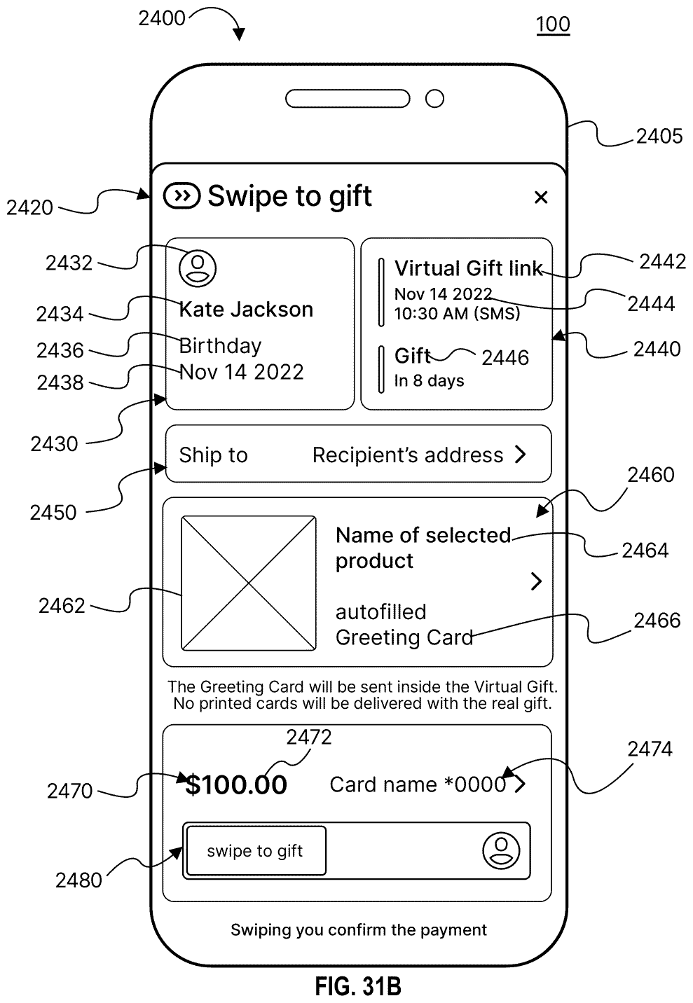

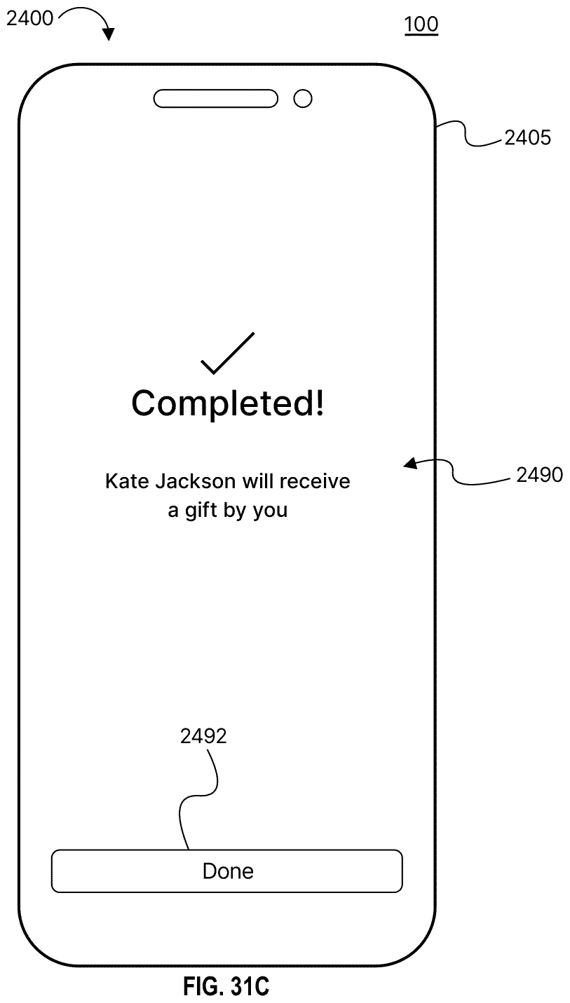

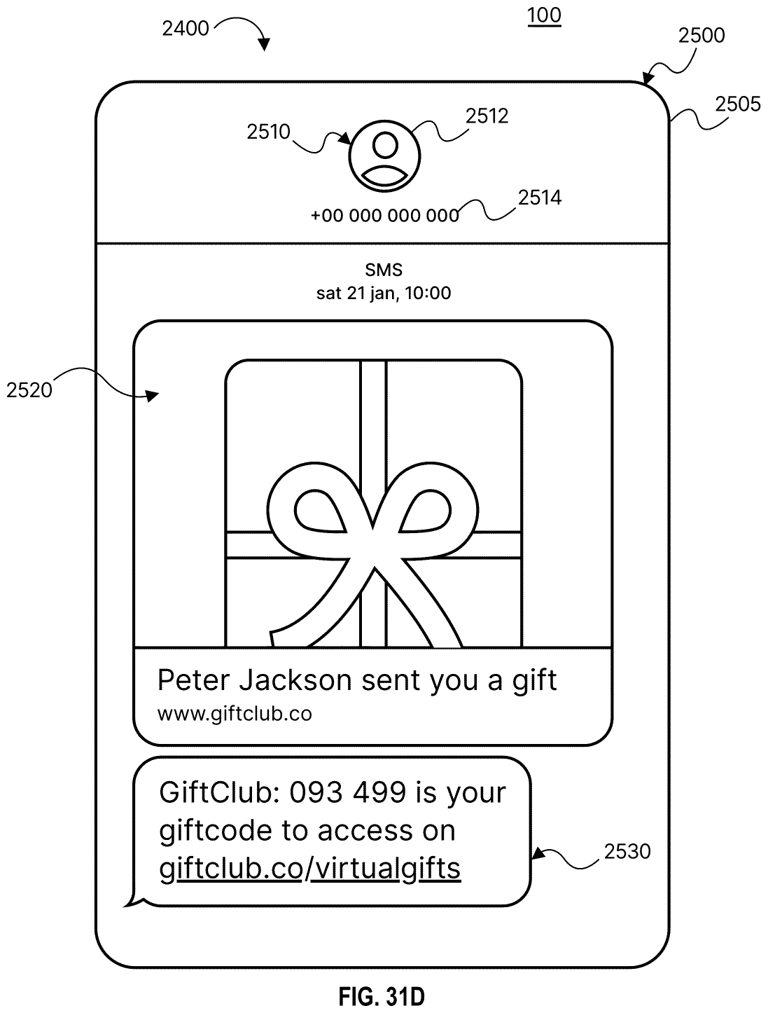

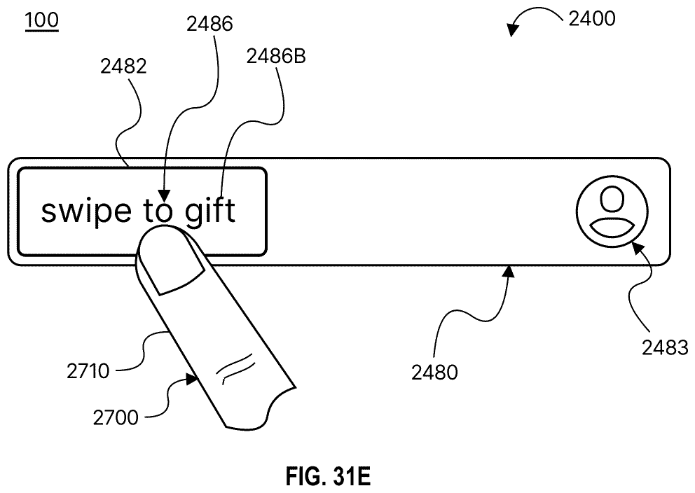

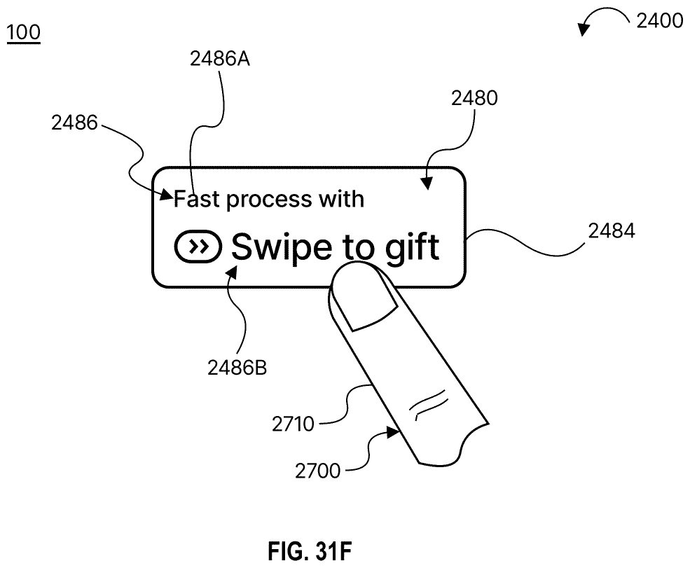

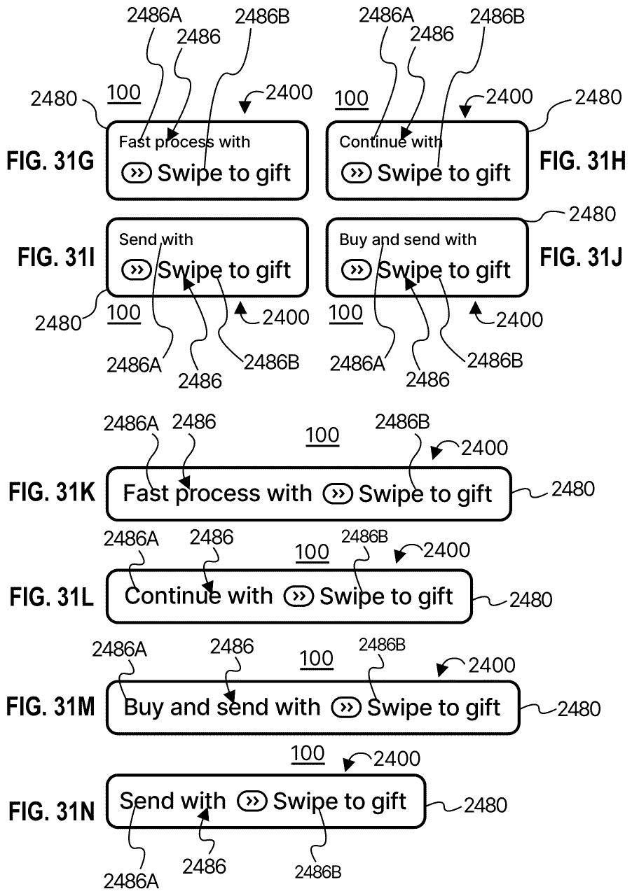

The gifting method 100 advantageously can comprise an innovation on the concept of a gift registry by providing a complete solution to giving and receiving gifts. The gifting method 100, for example, can assist a user (or gifter) 2700 (shown in FIG. 31E) with finding a perfect gift for a family member, a friend, a colleague, an acquaintance or other selected recipient (or giftee), purchasing the gift for the selected recipient and/or delivering the gift to the selected recipient with maximum ease and impact. In selected embodiments, the gifting method 100 can enable the gifter to create a gifter-created gift (or recipient) profile, such as by filling out a questionnaire for each selected recipient. The gifter-created recipient profile can include one or more preferences of the selected recipient. Gifters optionally can create a gifter profile that includes one or more preferences of the gifters themselves in a manner similar to how recipient profile is created.

In selected embodiments, the gifting method 100 can enable one or more recipients to create a recipient-created recipient profile. The recipient-created recipient profile, for example, can be created in the manner set forth herein with reference to the gifter-created recipient profile but with the giftee, rather than the gifter, providing the profile information.

The gifting method 100 optionally enable the selected recipient to make the recipient-created recipient profile available to the gifter and/or one or more other users of the gifting method 100. For example, the gifting method 100 can at least partially, and preferably completely, inhibit information included in the recipient-created recipient profile from being viewed or otherwise provided to the gifter or the other users. Additionally and/or alternatively, the selected recipient can provide permit access to the information included in the recipient-created recipient profile to the gifter or the other users.

The selected recipient can provide the gifter or the other users with a web address, a bar code, an access code or other profile identifying information for locating the recipient-created recipient profile of the selected recipient. In selected embodiments, the selected recipient can individually control the scope of recipient-created recipient profile access provided to the gifter and each other user. The gifter or the other users optionally can access the recipient-created recipient profile, without the knowledge of the selected recipient, if the gifter or the other users have a name, a telephone number and/or other personally-identifiable information about the selected recipient.

In selected embodiments, the gifter can create a gifter profile and/or the gifter-created recipient profile via the gifting method 100 by entering information into a questionnaire.

Additionally and/or alternatively, the gifting method 100 can enable the selected recipient to create the recipient-created recipient profile by entering information into a questionnaire. The questionnaire can include one or more question such as “What is your relationship with [the selected recipient]?,” “What is the occasion for the gift?” and/or “What is your budget for your gift to [the selected recipient]?” The questionnaire thereby can request, for example, personal information and/or categories of gift that interest the gifter and/or the selected recipient. Within these categories, the gifting method 100 can prompt the gifter and/or the selected recipient to choose among one or more gift options that match different price points and brands. The questionnaire optionally can permit the gifter and/or the selected recipient to provide preferences information. Exemplary preference information can include, but is not limited to, dietary preferences, favorite color, clothing styles, favorite flowers, types of chocolate, etc.

Contrary to conventional static gift registry pages, the gifting method 100 can dynamically display or otherwise provide one or more gift options based at least in part upon the gifter-created recipient profile and/or the recipient-created recipient profile. The gifting method 100 thereby can provide gift options that fit a budget of the gifter, a relationship between the gifter and the selected recipient, a relevant occasion and/or at least one of the preferences of the selected recipient as set forth in the gifter-created recipient profile and/or the recipient-created recipient profile. The gifting method 100 can enable the gifter to select one of the provided gift options for delivery to the selected recipient.

The gifting method 100 advantageously can display the gift options to the gifter based at least in part upon the recipient-created recipient profile. Additionally and/or alternatively, the recipient-created recipient profile can supersede the gifter-created recipient profile and the recipient-created recipient profile if any conflict arises between the gifter-created recipient profile and the recipient-created recipient profile in selected embodiments. In other words, the gift options displayed to the gifter can be based upon information included in the recipient-created recipient profile if the information included in the gifter-created recipient profile is not consistent with the information included in the recipient-created recipient profile.

Turning to FIG. 1, the gifting method 100 is shown as including entering a user (or gifter) profile, at 110, for the gifter or other user. The gifter can comprise any person who wishes to provide a gift another person, and the recipient can be the other person to whom the gift is to be presented (or given). In selected embodiments, the gifter profile can comprise information, such as demographic, contact and/or personal preference information, about the gifter. The demographic information for the gifter, for example, can comprise a first name, a middle name (or middle initial), a last name, a gender, and/or an age (or birthdate), without limitation. Exemplary contact information for the gifter can include, without limitation, a mailing address, a billing address, an email address, a home telephone number, a work telephone number, a mobile telephone number and/or a facsimile number.

In selected embodiments, the personal preference information for the gifter can comprise preference information for one or more preference categories. The gifter, for example, can select at least one category of gifts that the gifter would like to receive. Stated somewhat differently, the preference information can comprise gift preference information that a third party would want to know if selecting a gift to bestow on the gifter. Exemplary categories of gifts can include clothing, shoes, consumer electronics, books, movies, music, games, cosmetics, body care, bags, accessories, jewelry, food, drinks, household appliances, sports equipment, outdoor equipment, toys, baby products, do-it-yourself products, hobby supplies, garden supplies, pet supplies, tools and/or automobiles, without limitation.

Additionally and/or alternatively, the preference information can include a ranking of the selected categories of gifts. In some embodiments, the gifter may be required to provide preference information for at least a predetermined number of the categories of gifts. After providing preference information for the predetermined number of categories of gifts, for example, the gifter optionally can forego providing preference information for the remaining categories of gifts. The predetermined number can comprise any suitable number of categories such as within a range between one and five, inclusively. In selected embodiments, the gifter may be required to provide preference information for at least three of the categories of gifts.

One or more of the categories of gifts can include respective gift sub-categories. For example, the consumer electronics gift category can include gift sub-categories such as computers, televisions, cellular telephones, etc. In some embodiments, the gifter can be permitted to provide preference information for up to a preselected number of the gift sub-categories. The preselected number can comprise any suitable number of sub-categories such as within a range between one and ten, inclusively. In selected embodiments, the gifter can provide preference information for up to five of the sub-categories of gifts.

In selected embodiments, the gifting method 100 can prompt the gifter to provide the gifter profile information by presenting the gifter with one or more questions to be answered.

The gifting method 100, for example, can present one or more questions related to brand preferences, dietary preferences, dietary restrictions, favorite colors and/or favorite flowers, without limitation. The questions can include hierarchically-arranged questions. With regard to dietary preferences, the gifting method 100 initially can ask whether the gifter likes chocolate. If the gifter indicates an affinity for chocolate, the gifting method 100 can inquire about specific chocolate preferences, such as dark chocolate, milk chocolate, low carbohydrate chocolate, chocolate with nuts, etc. The gifting method 100 likewise can initially inquire about a favorite flower of the gifter. If the gifter identifies a favorite flower, the gifting method 100 can present an inquiry about a favorite color for the identified favorite flower. The gifting method 100 advantageously can enable the gifter to revise or otherwise update the gifter profile information as, for example, the preferences of the gifter change over time.

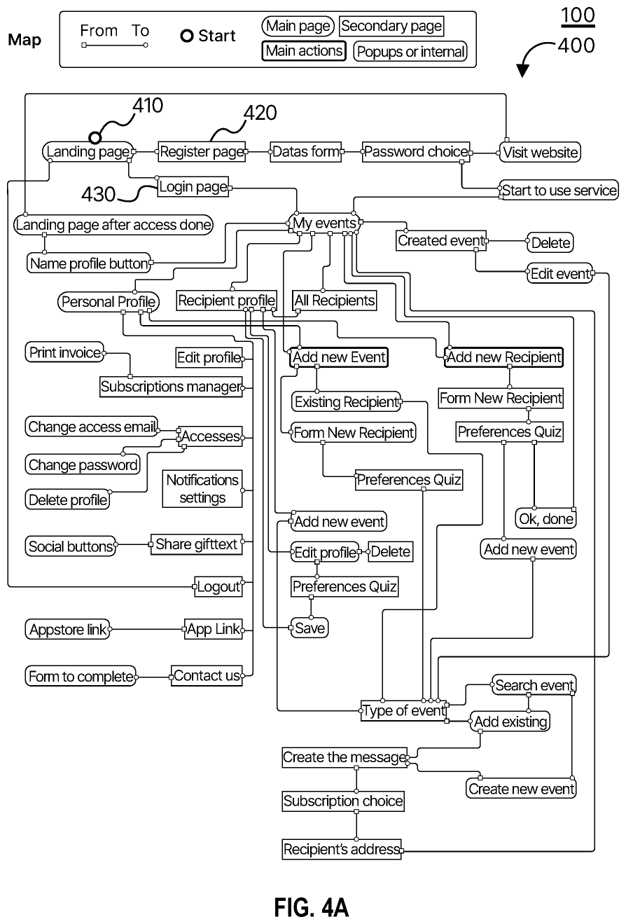

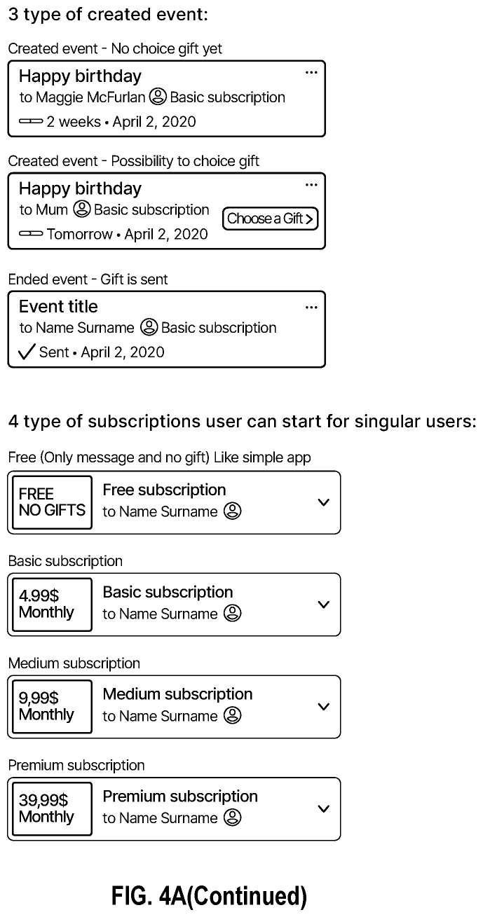

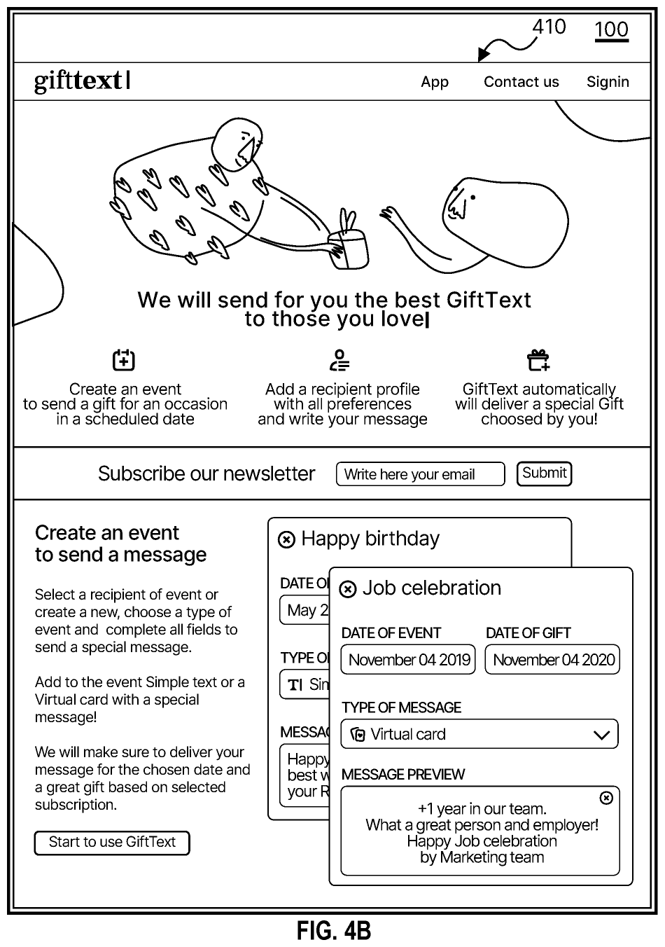

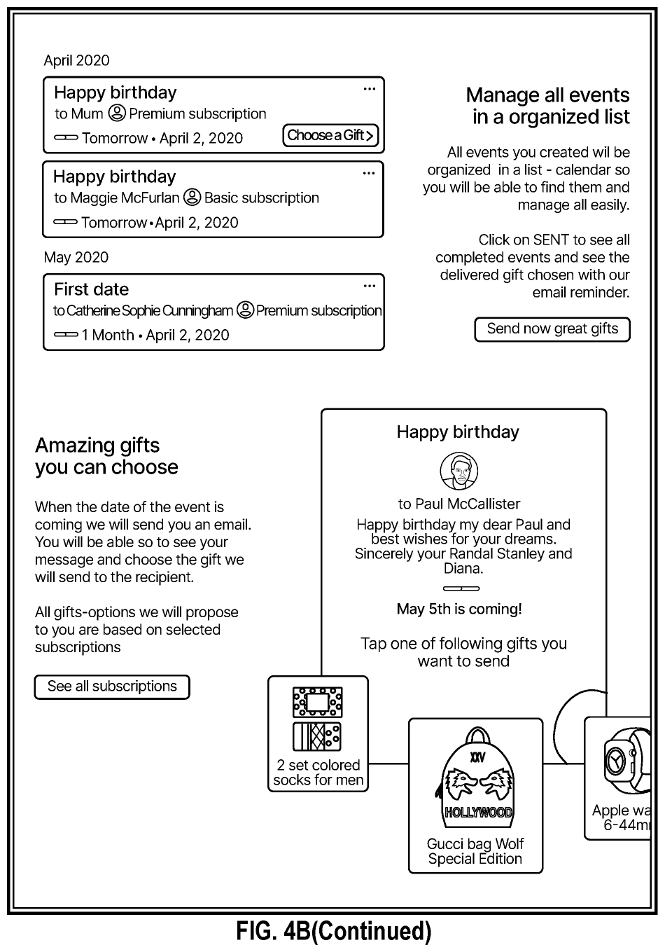

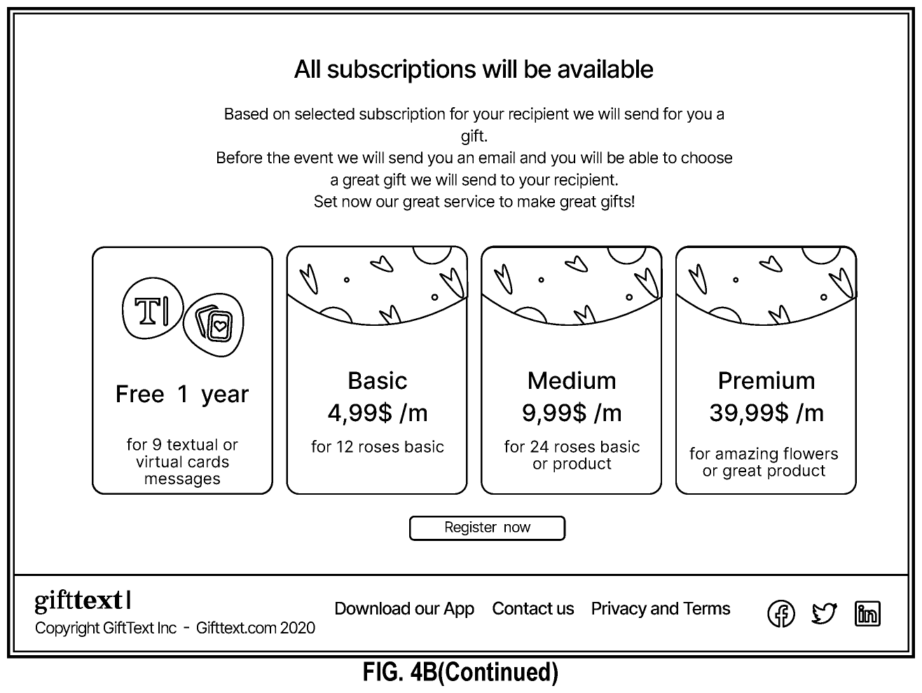

The gifting method 100 optionally can comprise a software application or other computer-implemented method. FIG. 4A illustrates an exemplary overview map 400 of the computer-implemented gifting method 100. In selected embodiments, for example, the gifting method 100 can be provided as a website, a mobile telephone application (or app) or other online system available via the Internet. If comprising a software application or other computer-implemented method, the gifting method 100 can include a landing page 410 for capturing information from the gifter. An exemplary landing page 410 is shown in FIG. 4B.

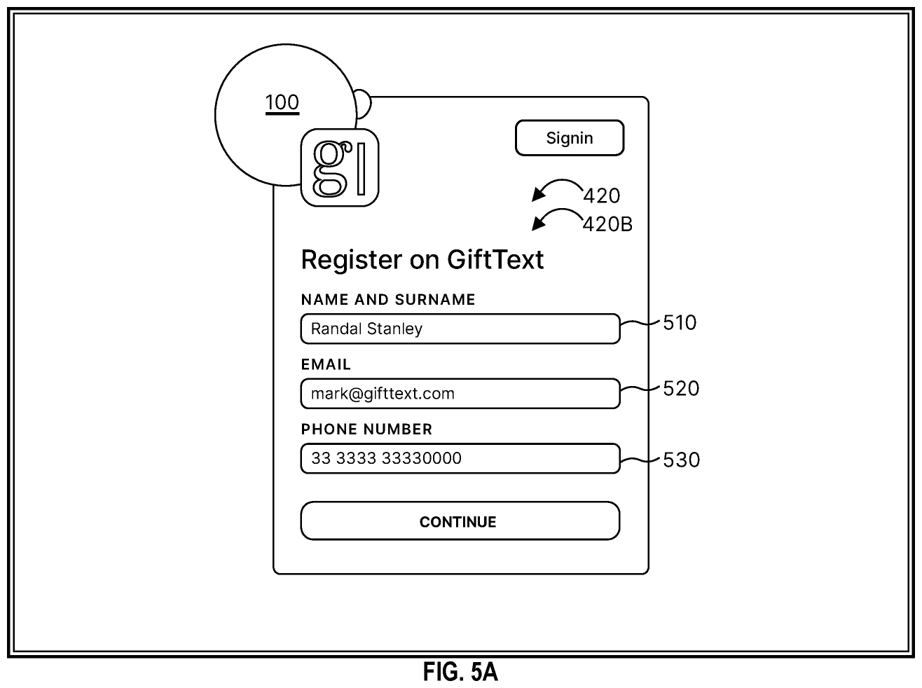

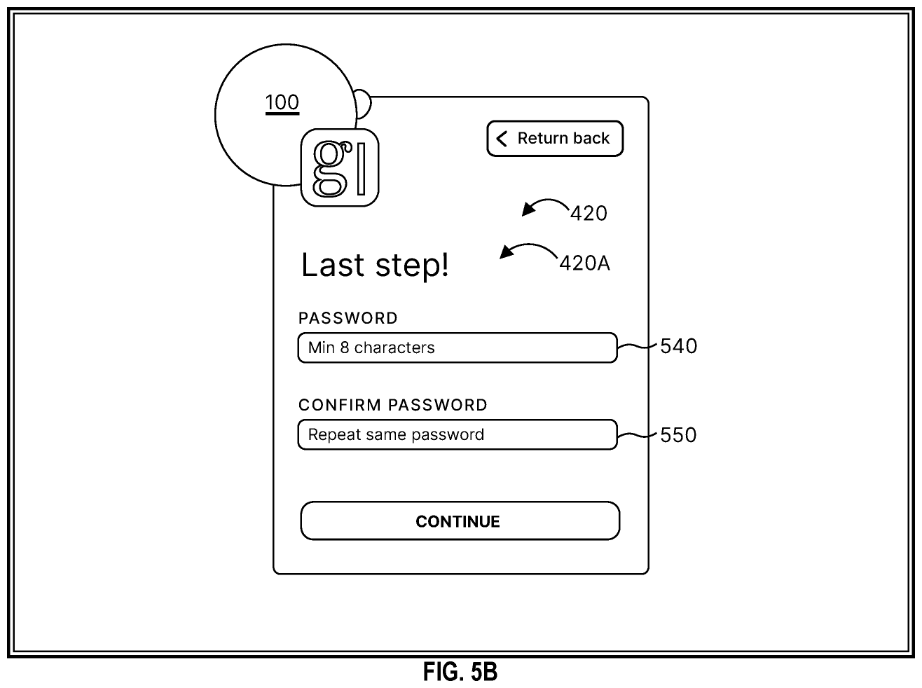

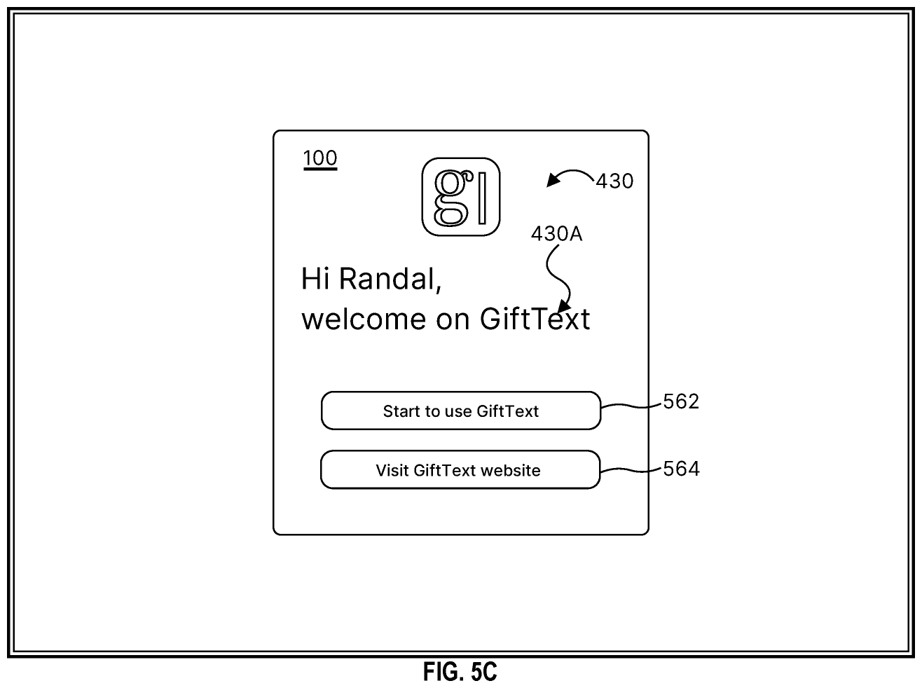

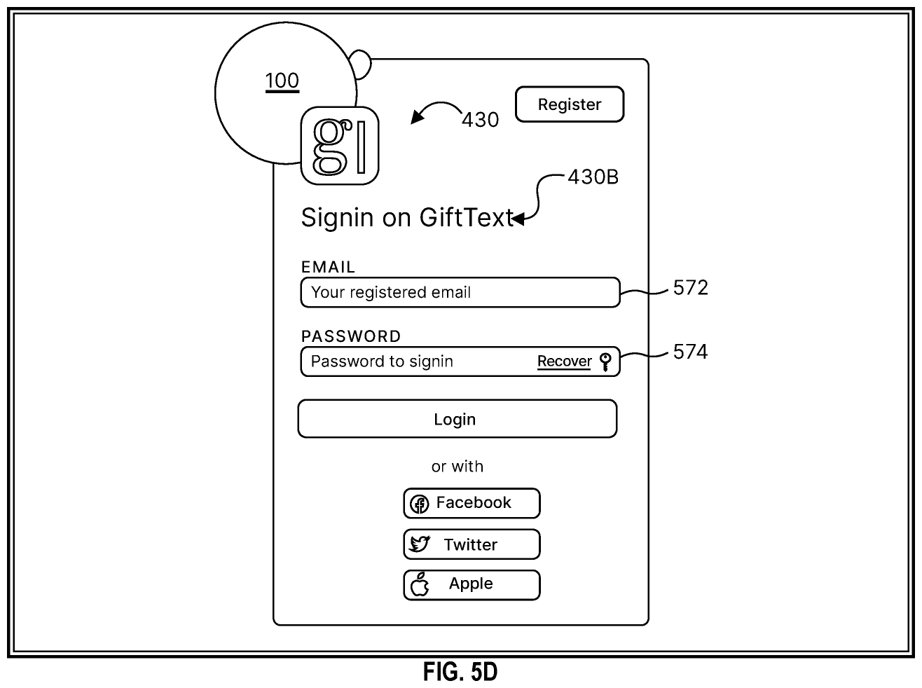

Additionally and/or alternatively, the overview map 400 of the computer-implemented gifting method 100 of FIG. 4A can include a registration page 420 and/or a welcome (or login) page 430. An exemplary embodiment of the registration page 420 is shown in FIGS. 5A-B.

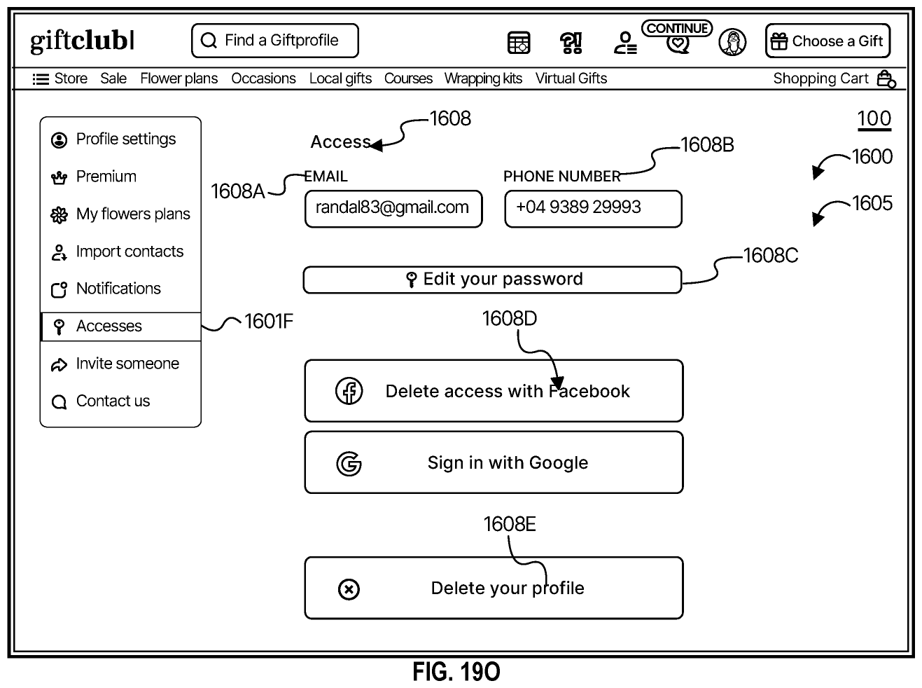

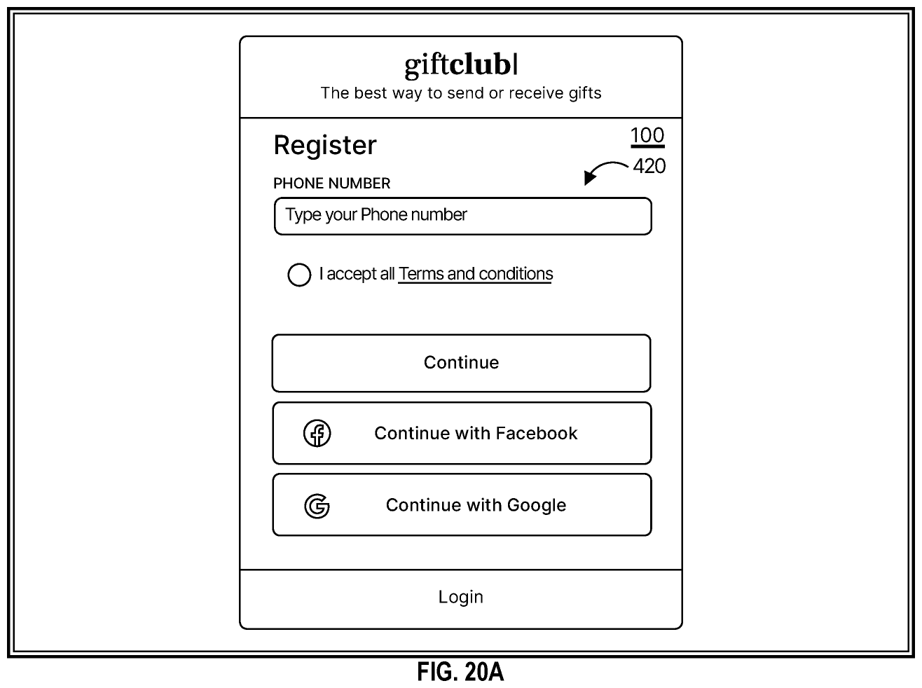

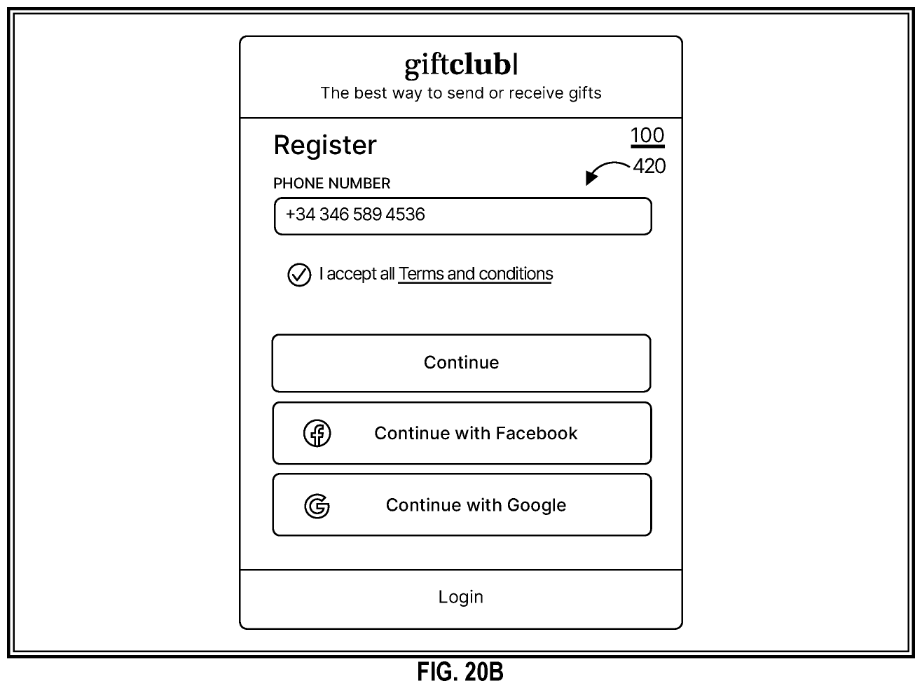

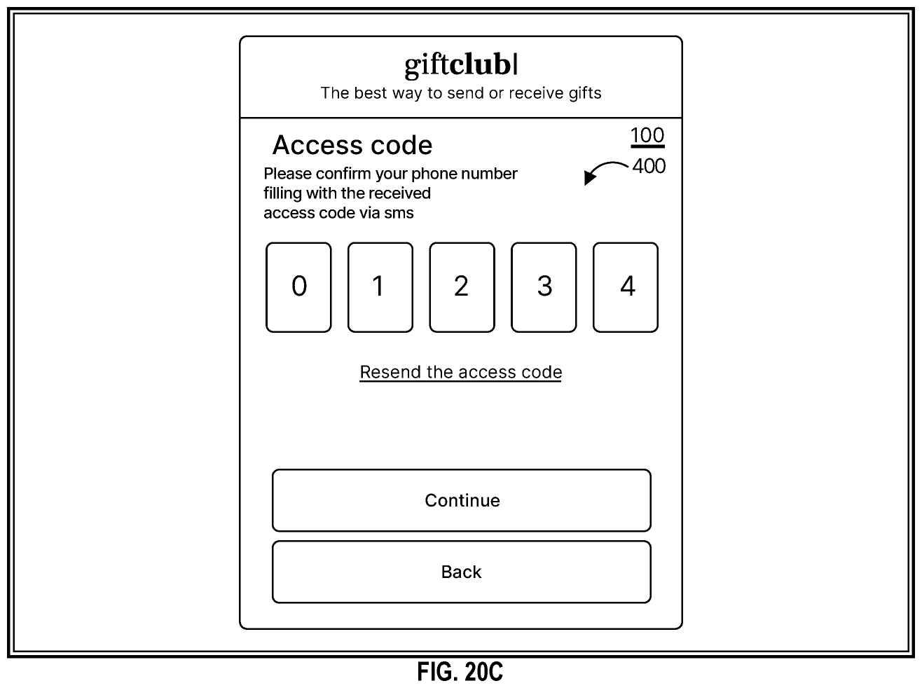

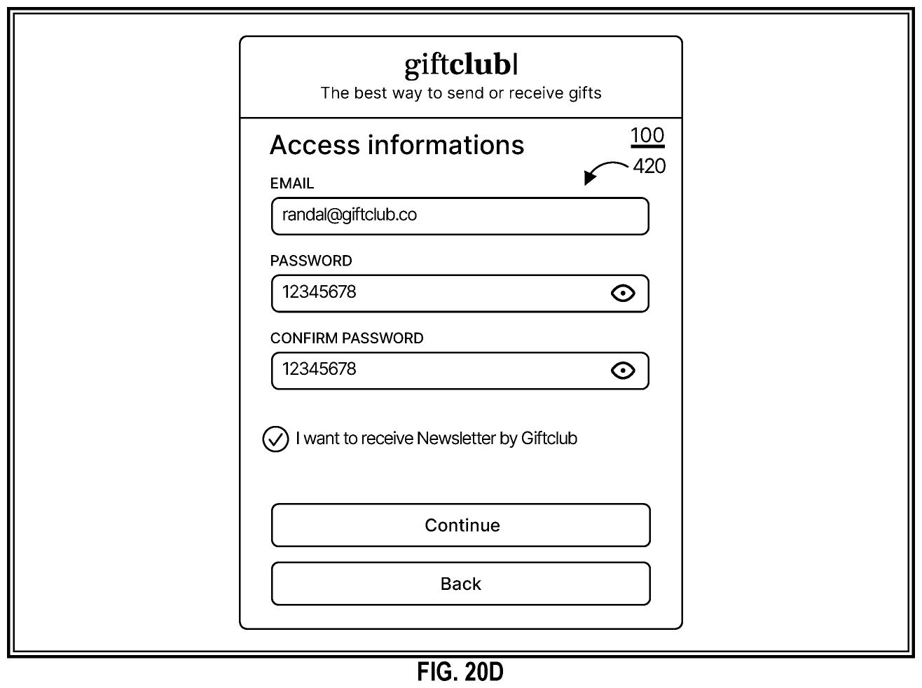

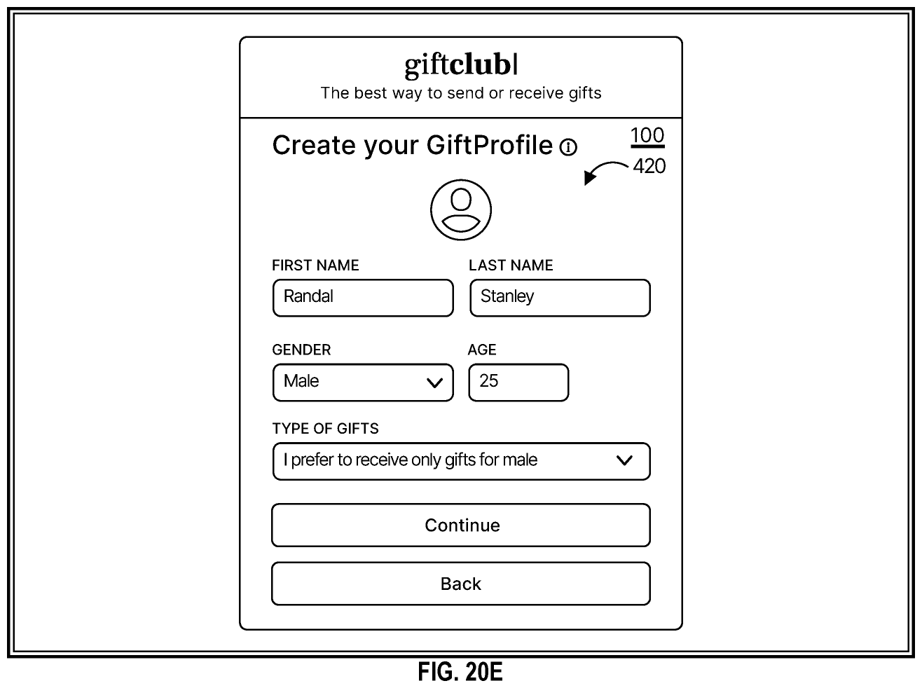

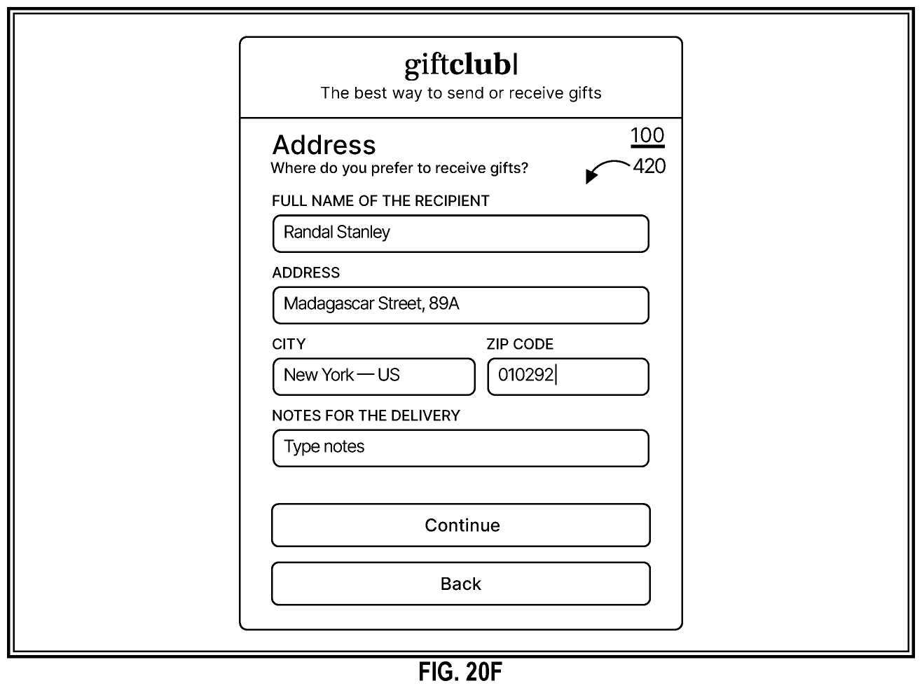

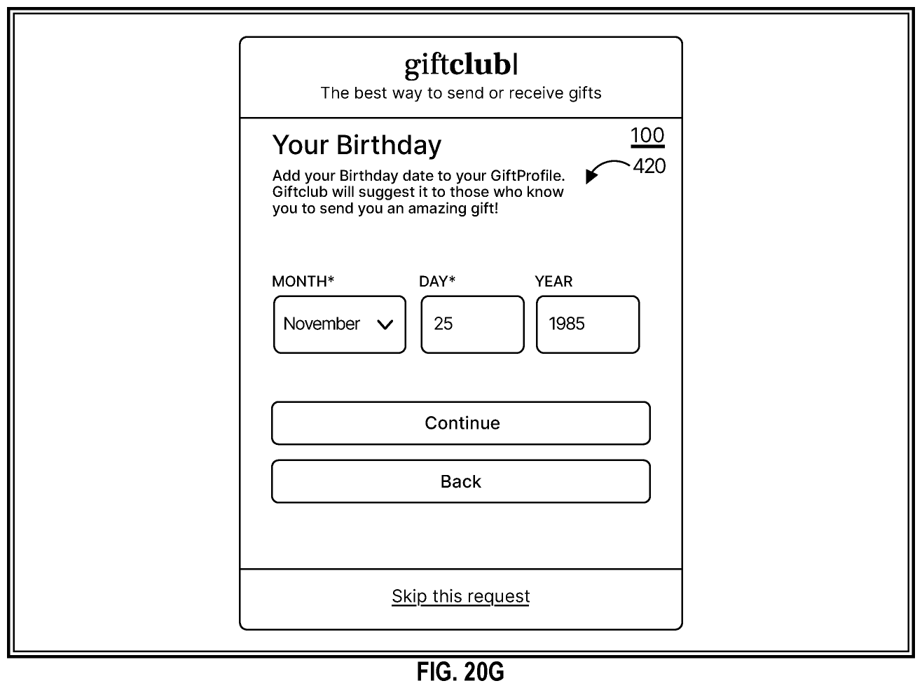

Turning to FIG. 5A, a first registration page 420A can enable the gifter to enter a user name 510, an email address 520, a telephone number 530 and/or any other identification information for registering to utilize the gifting method 100. The gifter can enter a password 540 and optionally confirm the entered password, at 550, on a second registration page 420B of the gifting method 100. Although shown and described as comprising two separate registration pages 420A, 420B for purposes of illustration only, the registration page 420 can comprise any suitable number of registration pages, including a single registration page. FIGS. 20A-G illustrate an alternative exemplary embodiment of the registration page 420.

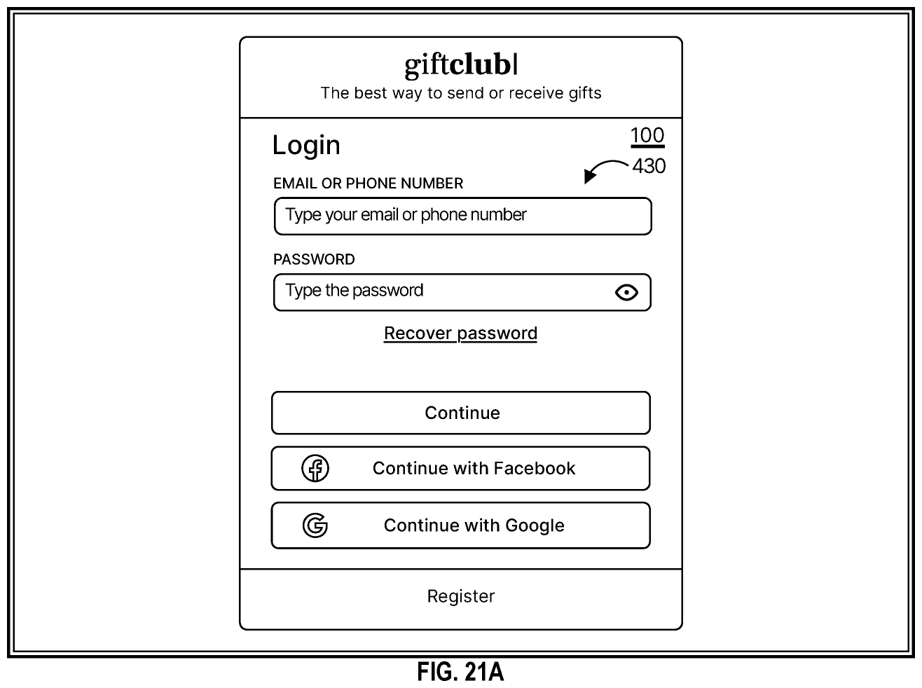

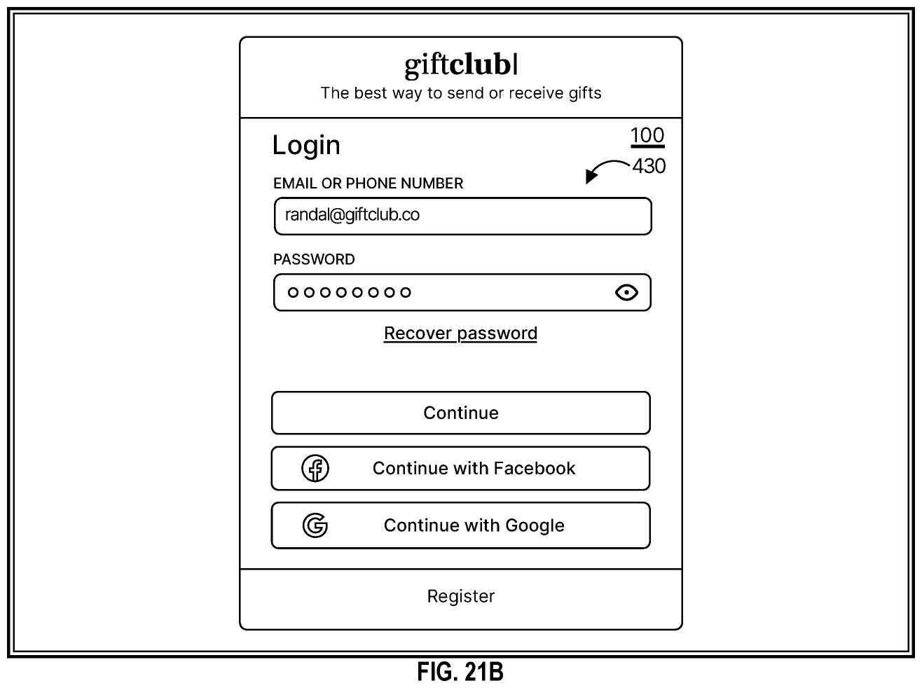

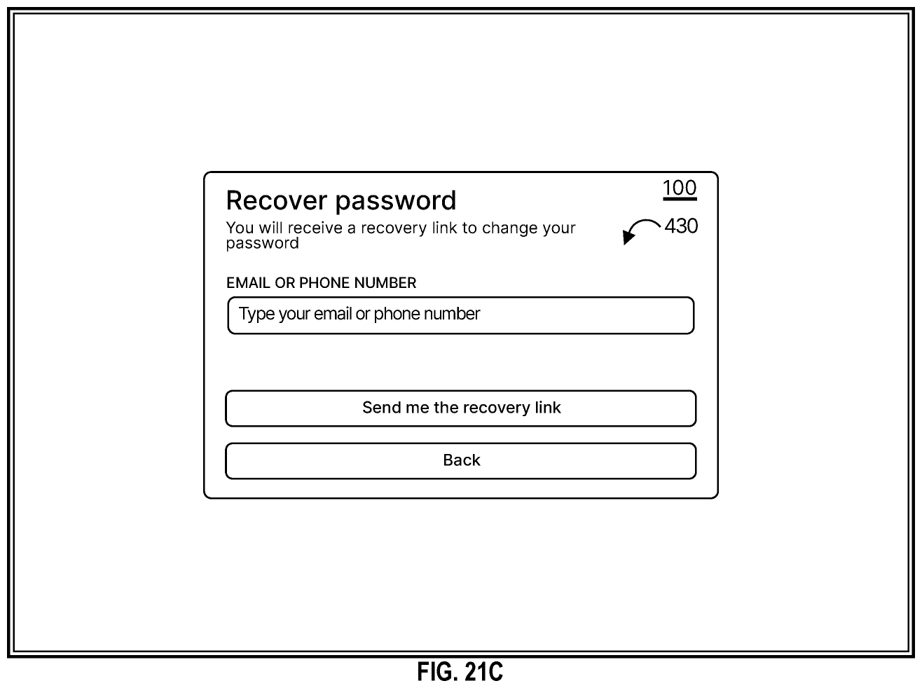

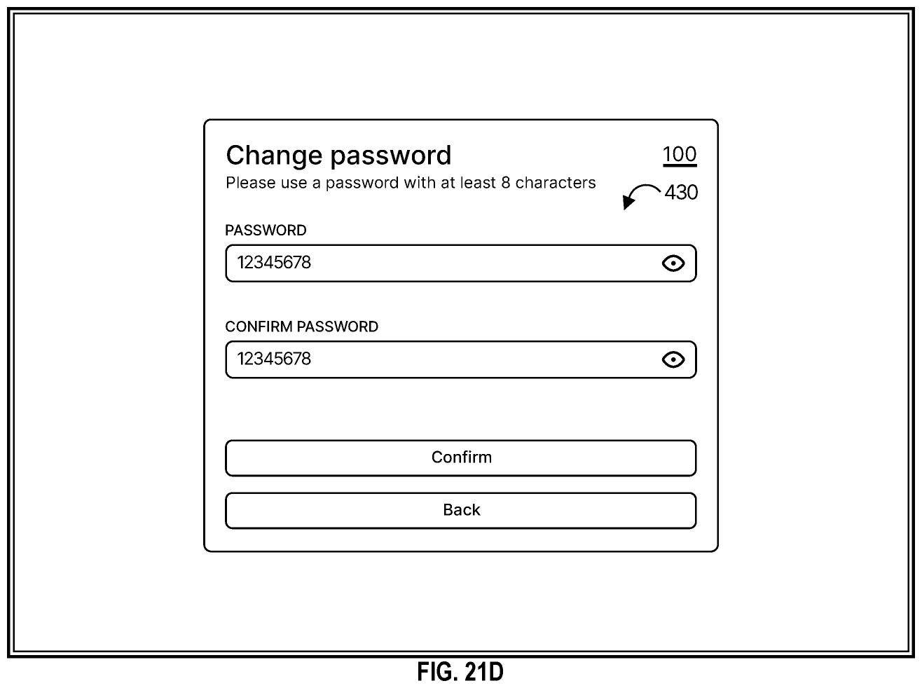

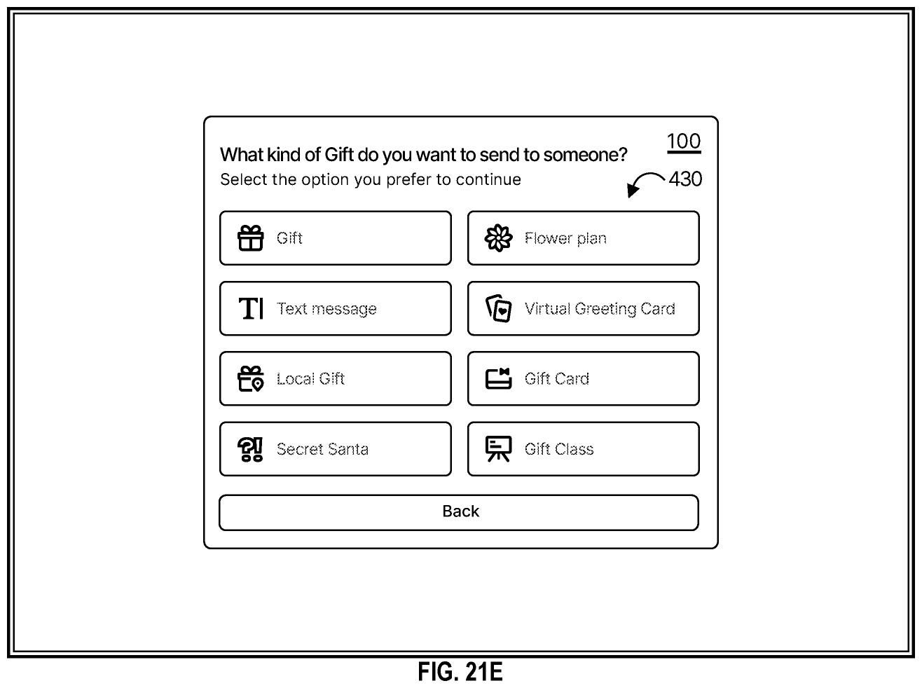

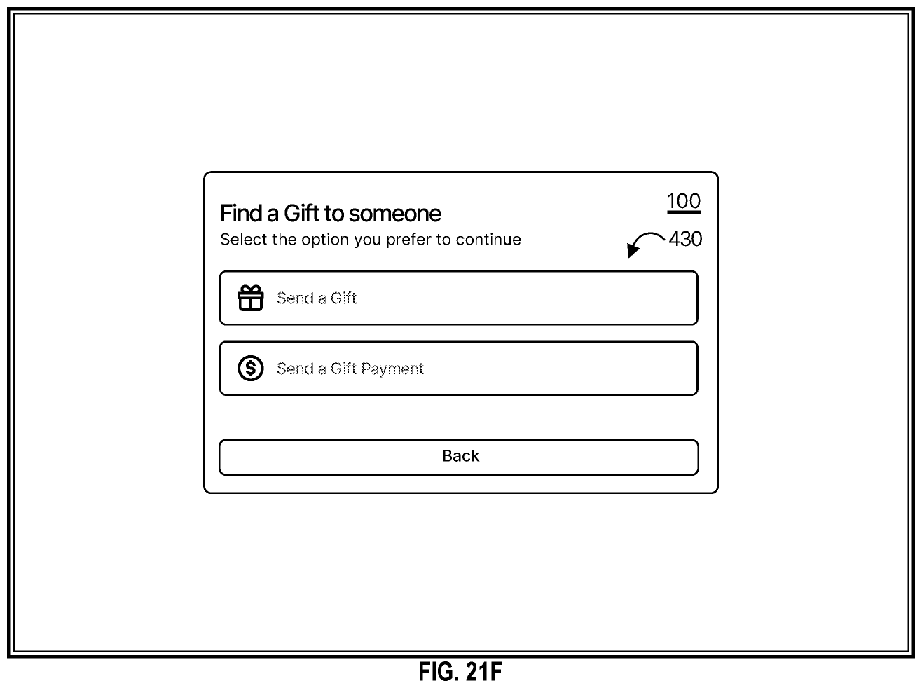

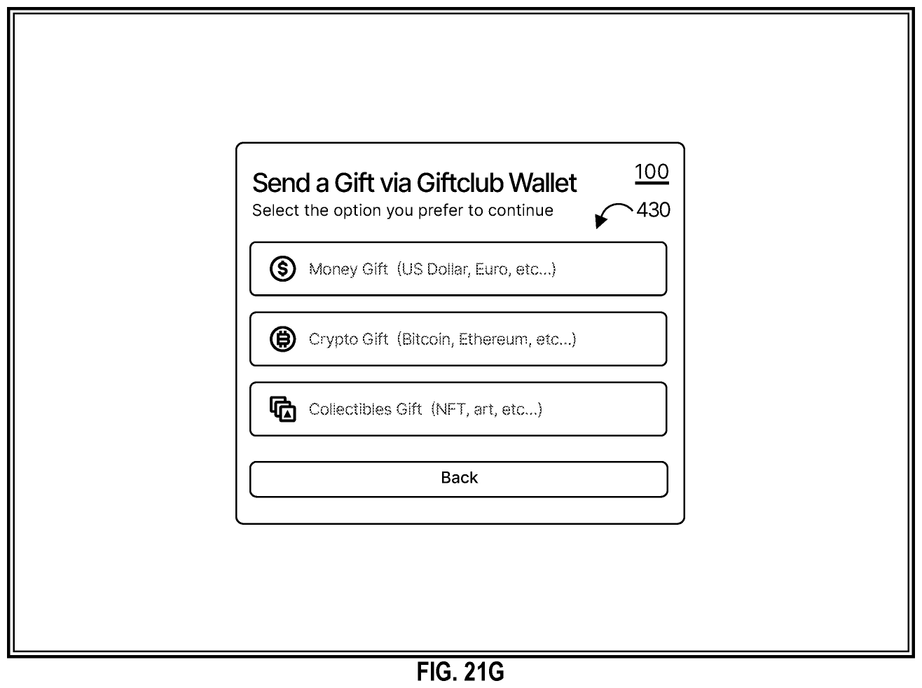

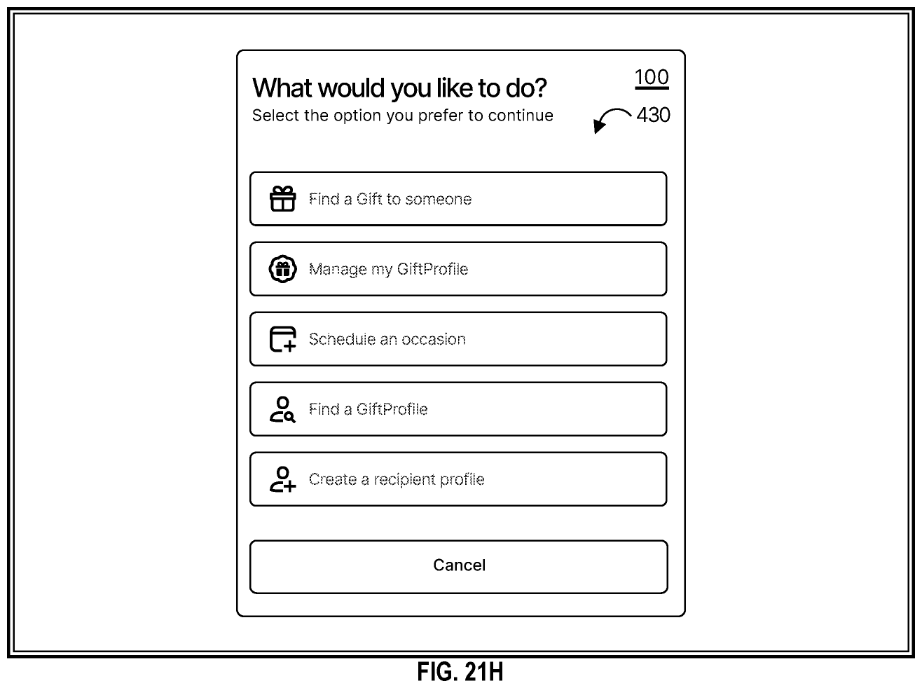

An exemplary login page 430 is shown in FIGS. 5C-D. Turning to FIG. 5C, for example, the login page 430 can include a welcome page 430A that can enable the gifter to utilize the gifting method 100, at 562, and/or to visit a website associated with the gifting method 100, at 562. If the gifter elects to utilize the gifting method 100, at 562, the gifting method 100 can present a signin page 430B. The signin page 430B can permit the gifter to enter the user name 510 (shown in FIG. 5A), the telephone number 530 (shown in FIG. 5A), the email address 572, the password 574 and/or the other identification information entered by the gifter when registering to utilize the gifting method 100. Although shown and described as comprising the welcome page 430A that is separate from the signin page 430B for purposes of illustration only, the login page 430 can comprise any suitable number of login (or welcome) pages, including a single login page. FIGS. 21A-I illustrate an alternative exemplary embodiment of the login page 430.

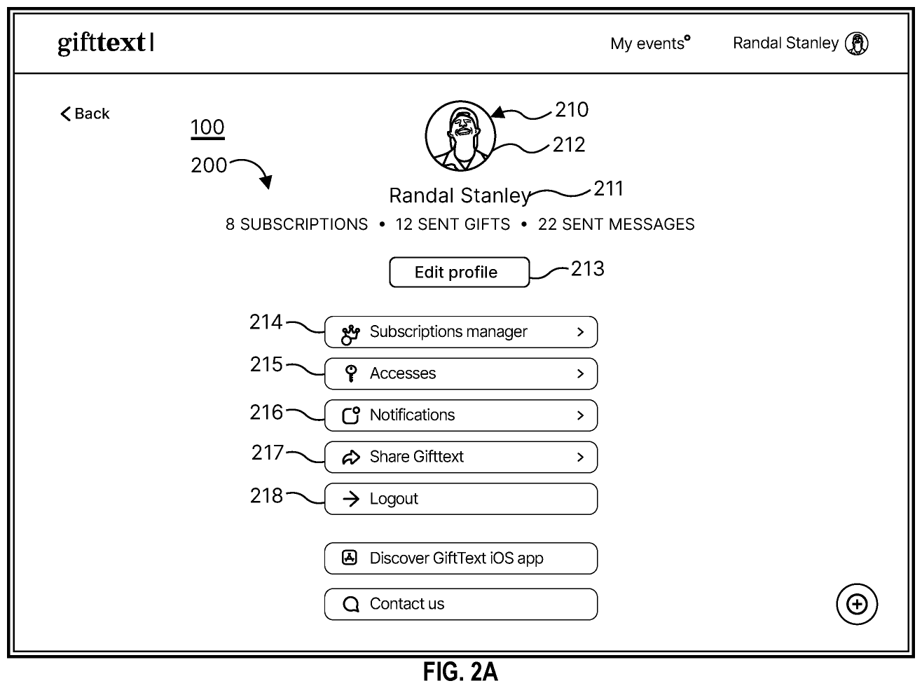

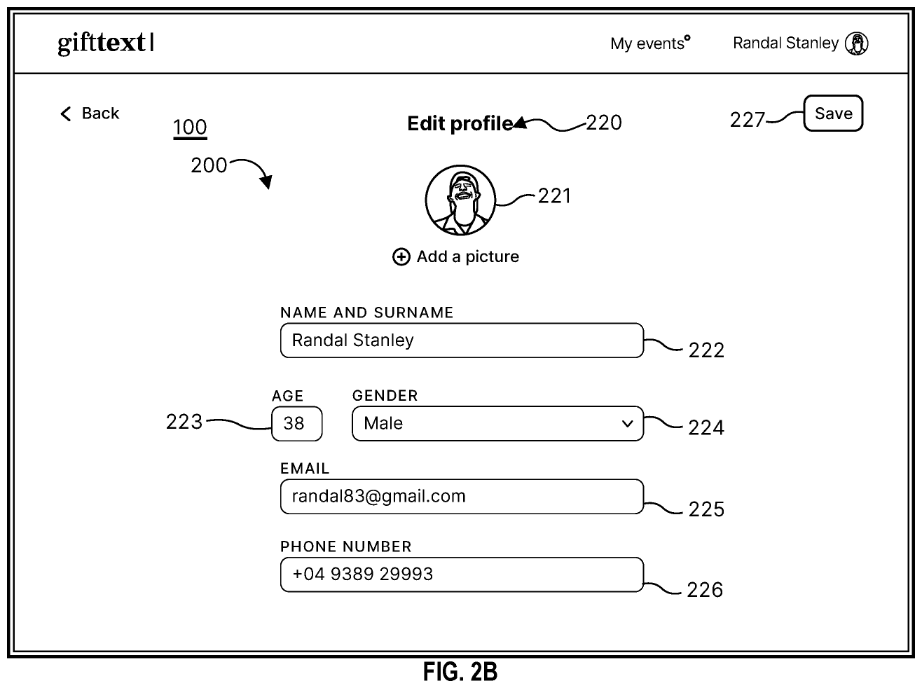

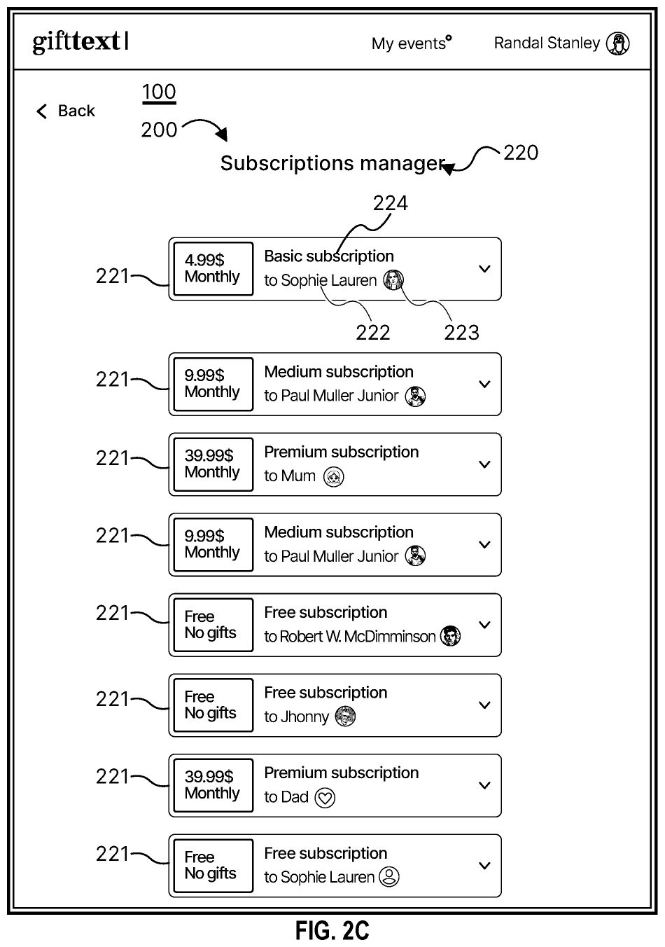

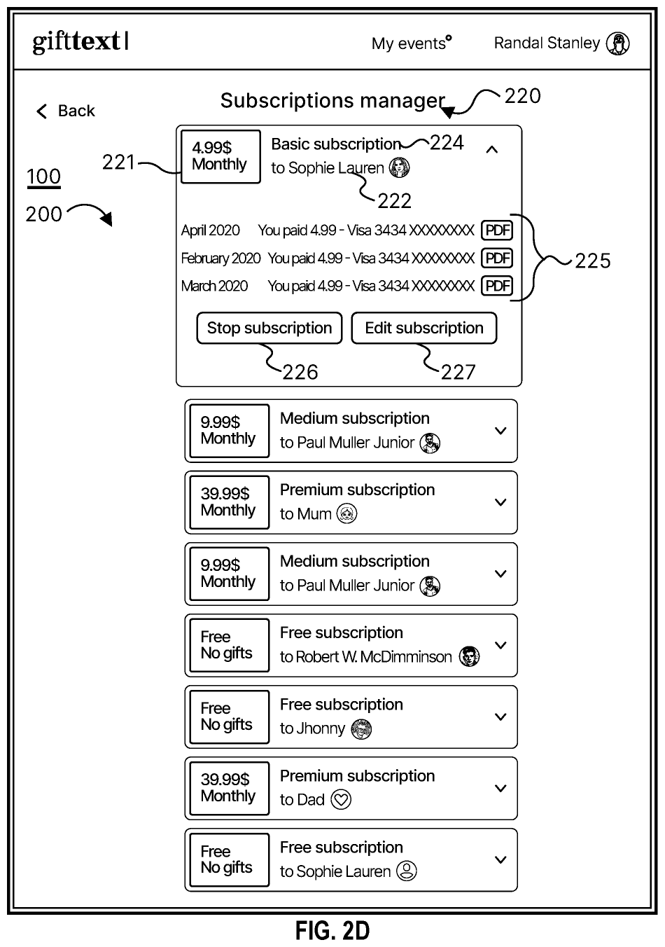

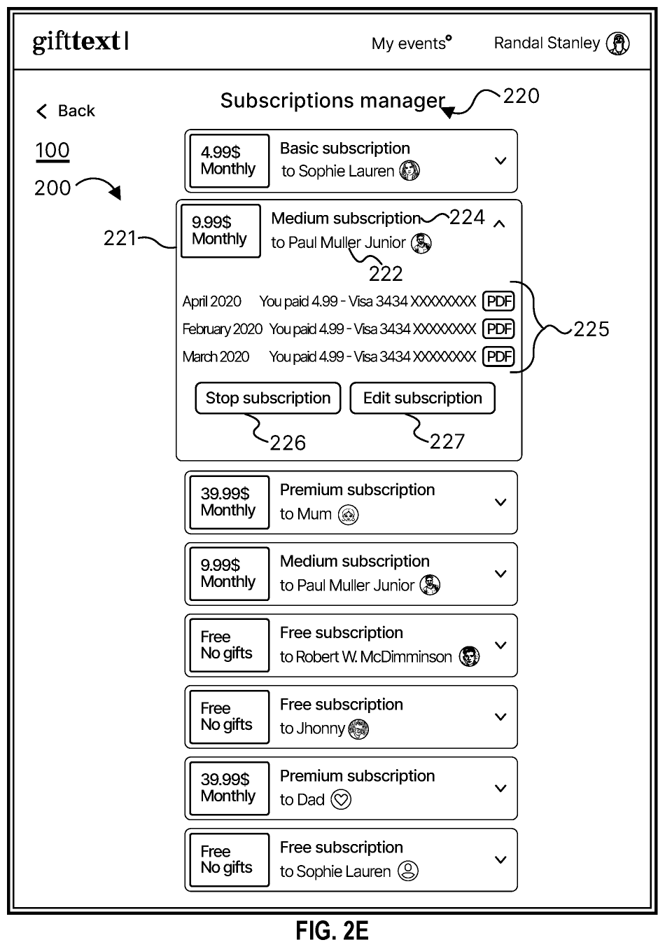

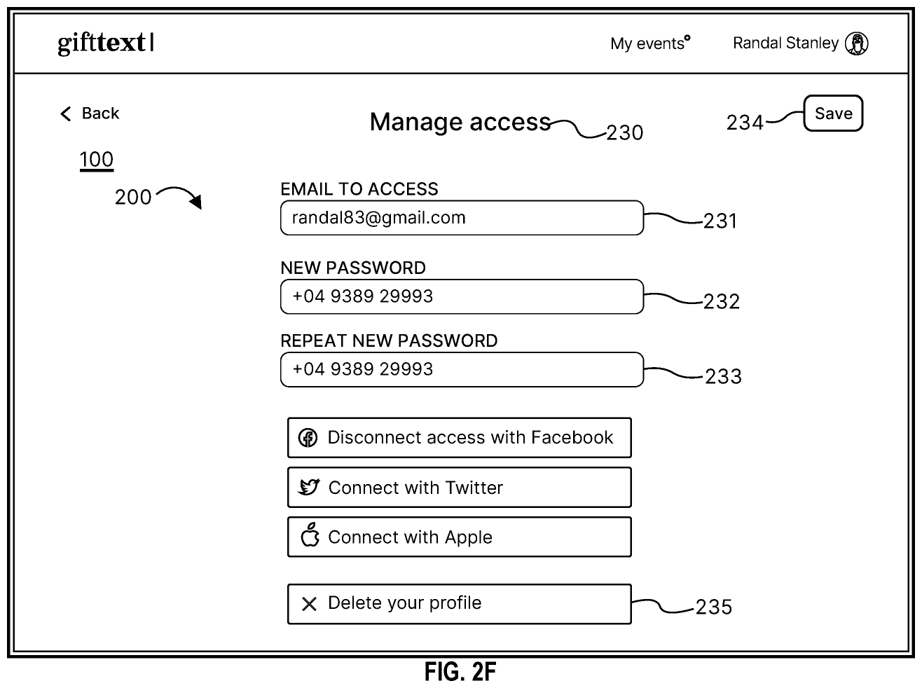

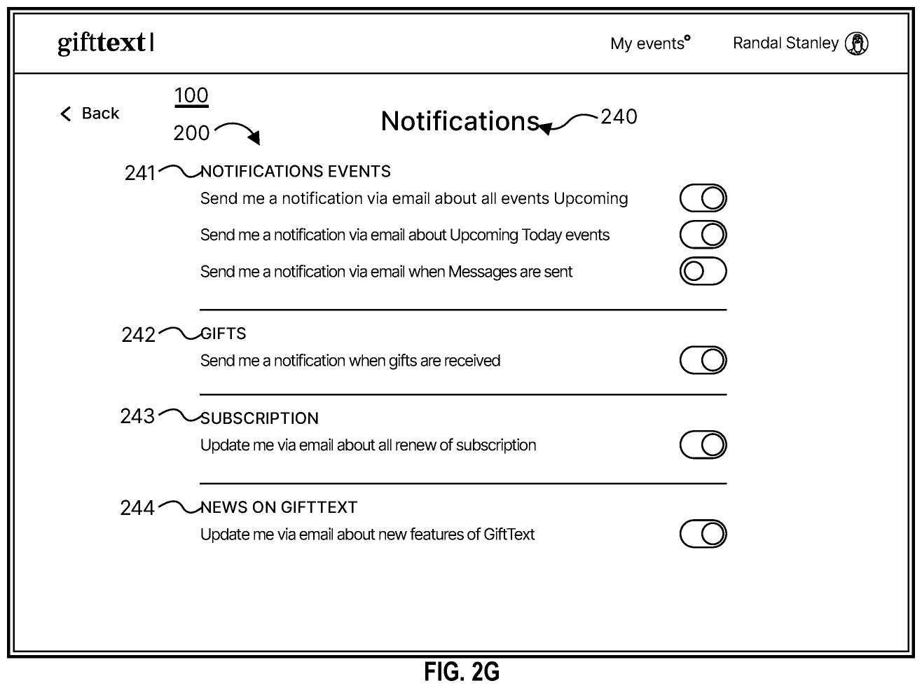

If comprising a software application or other computer-implemented method, the gifting method 100 can present one or more personal profile pages 200 for enabling the gifter to enter the gifter profile, at 110, as shown in FIGS. 2A-G. Turning to FIG. 2A, for example, the personal profile pages 200 can include a profile overview page 210. The profile overview page 210 can present a name 211, an image 212 and/or other gifter profile information of the gifter and/or, at 213, permit the gifter to enter and/or edit (or update) the gifter profile. Additionally and/or alternatively, the profile overview page 210 can enable the gifter to manage a subscription to the gifting method 100, at 214, manage accesses (or security) to the gifter profile, at 215, to manage notifications that the gifter may receive from the gifting method 100, at 216, to enable the gifter profile to be shared with one or more other users of the gifting method 100, at 217, and/or to log out of the gifting method 100, at 218.

By enabling the gifter profile to be shared with the other users, the gifter can permit the other users to view the gifter profile and, as desired, add the gifter as a gift recipient to the gifter profiles of the other users. In selected embodiments, a user can search among the shared gifter profiles in an effort to locate the shared gifter profile of the gifter. The user, for example, can base the search on selected information, such as a gifter name 222 (shown in FIG. 2B), a gifter email address 225 (shown in FIG. 2B) and/or a gifter telephone number 226 (shown in FIG. 2B), of the gifter. Thereby, the user can access the gifter profile without the knowledge of the gifter, such as, with regard to occasions for which the user wishes to surprise the gifter with a gift.

Optionally, the gifter can provide the user with a web address, a bar code, an access code or other profile identifying information for locating the shared gifter profile of the gifter.

If the user wishes to send a gift to the gifter upon locating the shared gifter profile of the gifter, the user can provide information, such as a budget range, about the intended gift. The gifting method 100 can evaluate the provided gift information and present one or more gift options to the user in the manner set forth in additional detail herein. The gift options, for example, can be gift options within the budget range of the user. In other words, the user can comprise a second gifter, and the original gifter can comprise a recipient of the gift option selected by the user. The gifting method 100 thereby can advantageously assist the user (or second gifter) with finding and/or purchasing a perfect gift for the gifter (or the recipient) and, in selected embodiments, delivering the gift to the recipient.

An exemplary personal profile editing page 210 is shown in FIG. 2B. The personal profile editing page 210 can permit the gifter to edit the gifter profile and/or the gifter profile information of the gifter. As illustrated in FIG. 2B, the personal profile editing page 210 can enable to the gifter to add, remove or otherwise edit an image 212 associated with the gifter, at 221. Additionally and/or alternatively, the personal profile editing page 210 can permit the gifter to add, remove or otherwise edit a gifter name 222, a gifter age 233 and/or a gifter gender 224. The personal profile editing page 210 optionally can enable the gifter to add, remove or otherwise edit gifter contact information, such as a gifter email address 225 and/or a gifter telephone number 226. Once completed, the edits to the gifter profile can be saved, at 227.

Turning to FIG. 2C, an exemplary subscription manager page 220 of the gifting method 100 is illustrated. The subscription manager page 220, for example, can present a recipient listing 221 of all recipients associated with the gifter profile of the gifter. The recipient listing 221 optionally can present one or more details about each listed recipient, such as a recipient name 222, a recipient image 223 and/or a recipient subscription type 224. Exemplary recipient subscription types 224 can include a free subscription type and/or one or more fee-based subscription types, including a basic subscription type, a medium subscription type and/or a premium subscription type.

As discussed in more detail herein, the free subscription type can permit the gifter to send free gifts, such a predetermined number of virtual (or textual) greeting cards, to a selected recipient during a preselected time period. The preselected time period can comprise any suitable time period, including one year. Alternatively, the fee-based subscription types can permit the gifter to send enhanced gifts to one or more recipients. The basic subscription type, for example, can be offered for a basic periodic fee and enable the gifter to send basic gifts, such as one dozen roses or other basic gifts, to a selected recipient during a basic subscription period. Additionally and/or alternatively, the medium subscription type can be available for a medium periodic fee, greater than the basic periodic fee, and enable the gifter to send medium gifts, such as two dozen roses or other medium gifts, to a selected recipient during a medium subscription period; whereas, the premium subscription type can be available for a premium periodic fee, greater than the medium periodic fee, and enable the gifter to send premium gifts, such as premium gifts, to a selected recipient during a premium subscription period.

The subscription manager page 220 advantageously can enable the gifter to access and/or revise subscription details for the recipients listed in the recipient listing 221. As shown in FIG. 2D, for example, the subscription manager page 220 can show a payment history of the basic periodic fee for a first subscription for a first selected recipient 222. The subscription manager page 220 of FIG. 2E shows a payment history of the medium periodic fee for a second subscription for a second selected recipient 222. Additionally and/or alternatively, the gifter can edit 227 and/or stop (or cancel) 226 the subscription for the first selected recipient and/or the second selected recipient, as desired, via the subscription manager page 220. The subscription manager page 220 thereby can permit the gifter to manage the subscription for each list recipient.

An exemplary manage access page 230 of FIG. 2F can permit the gifter to manage accesses (or security) to the gifter profile. As illustrated in FIG. 2F, the gifter can enter an email address 231 and/or a new password 232 for managing the access to the gifter profile. In selected embodiments, the gifter may be asked to confirm the new password, at 233. The gifter profile optionally can be deleted, at 235. Once completed, the edits to the gifter profile access can be saved, at 234.

Turning to FIG. 2G, an exemplary notifications page 240 is shown. The notifications page 240 can enable the gifter to manage one or more notifications that can be generated by the gifting method 100. Stated somewhat differently, the gifter can select which of the generated notifications that the gifter wishes to receive. The notifications, for example, can include notifications of events 241, a notification about any upcoming events, a notification about any upcoming events for the current day, and/or a notification when a gift has been sent to a selected recipient, without limitation. Additionally and/or alternatively, the notifications page 240 can enable the gifter to manage notifications 242 when gifts have been received by the respective recipients, notifications 243 associated with subscription renewals 243, and/or notifications 244 about newly-available features of the gifting method 100.

Returning to FIG. 1, the gifting method 100 is shown as including enabling the gifter to create one or more recipient profiles, at 120. In selected embodiments, each recipient profile can be provided in the manner set forth in more detail above with regard to the gifter profile. For example, each recipient profile can comprise information, such as demographic, contact and/or personal preference information, about the relevant recipient. The demographic information for the relevant recipient, for example, can comprise a first name, a middle name (or middle initial), a last name, a gender, and/or an age (or birthdate), without limitation. Exemplary contact information for the relevant recipient can include, without limitation, a mailing address, a billing address, an email address, a home telephone number, a work telephone number, a mobile telephone number and/or a facsimile number.

In selected embodiments, the personal preference information for the relevant recipient can comprise preference information for one or more preference categories. The gifter, for example, can select at least one category of gifts that the relevant recipient likely would like to receive. Stated somewhat differently, the preference information can comprise gift preference information that a third party would want to know if selecting a gift to bestow on the relevant recipient. Exemplary categories of gifts can include clothing, shoes, consumer electronics, books, movies, music, games, cosmetics, body care, bags, accessories, jewelry, food, drinks, household appliances, sports equipment, outdoor equipment, toys, baby products, do-it-yourself products, hobby supplies, garden supplies, pet supplies, tools and/or automobiles, without limitation.

Additionally and/or alternatively, the personal preference information for the relevant recipient can include budgetary information, such as a budget amount and/or a budget range. Exemplary budget amounts can include, but are not limited to, twenty-five dollars, fifty dollars, one hundred dollars, one hundred and fifty dollars, two hundred and fifty dollars, five hundred dollars, one thousand dollars, fifteen hundred dollars, twenty-five hundred dollars, five thousand dollars, or more. Exemplary budget ranges can include any suitable budget range, such as a one hundred dollar range or a one thousand dollar range, between a minimum budget amount and a maximum budget amount. For example, the minimum budget amount and/or the maximum budget amount can include the exemplary budget amounts set forth above. The gifting method 100 thereby can present gift options that satisfy the categories of gifts, budgetary and other the personal preference information for the relevant recipient as provided by the gifter.

The preference information for the relevant recipient, in selected embodiments, can include a ranking of the selected categories of gifts. In some embodiments, the gifter may be required to provide preference information for at least a predetermined number of the categories of gifts. After providing preference information for the predetermined number of categories of gifts, for example, the gifter optionally can forego providing preference information for the remaining categories of gifts. The predetermined number can comprise any suitable number of categories such as within a range between one and five, inclusively. In selected embodiments, the gifter may be required to provide preference information for at least three of the categories of gifts.

One or more of the categories of gifts can include respective gift sub-categories. For example, the consumer electronics gift category can include gift sub-categories such as computers, televisions, cellular telephones, etc. In some embodiments, the gifter can be permitted to provide preference information for up to a preselected number of the gift sub-categories. The preselected number can comprise any suitable number of sub-categories such as within a range between one and ten, inclusively. In selected embodiments, the gifter can provide preference information for up to five of the sub-categories of gifts.

In selected embodiments, the gifting method 100 can prompt the gifter to provide each recipient profile information by presenting the gifter with one or more questions to be answered. The gifting method 100, for example, can present one or more questions related to brand preferences, dietary preferences, dietary restrictions, favorite colors and/or favorite flowers, without limitation. The questions can include hierarchically-arranged questions. With regard to dietary preferences, the gifting method 100 initially can ask the gifter about whether the relevant recipient likes chocolate. If the gifter believes that the relevant recipient indicates an affinity for chocolate, the gifting method 100 can inquire about specific chocolate preferences, such as dark chocolate, milk chocolate, low carbohydrate chocolate, chocolate with nuts, etc. The gifting method 100 likewise can initially inquire about a favorite flower of the relevant recipient. If the gifter identifies a favorite flower for the relevant recipient, the gifting method 100 can present an inquiry about a favorite color of the relevant recipient for the identified favorite flower. The gifting method 100 advantageously can enable the gifter to revise or otherwise update the recipient profile information as, for example, the preferences of the relevant recipient change over time.

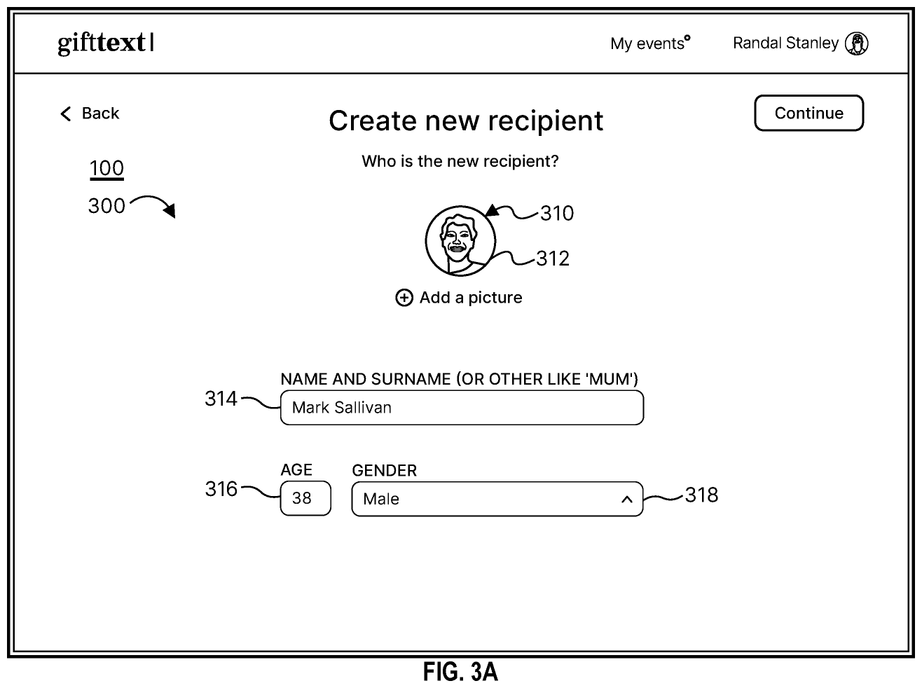

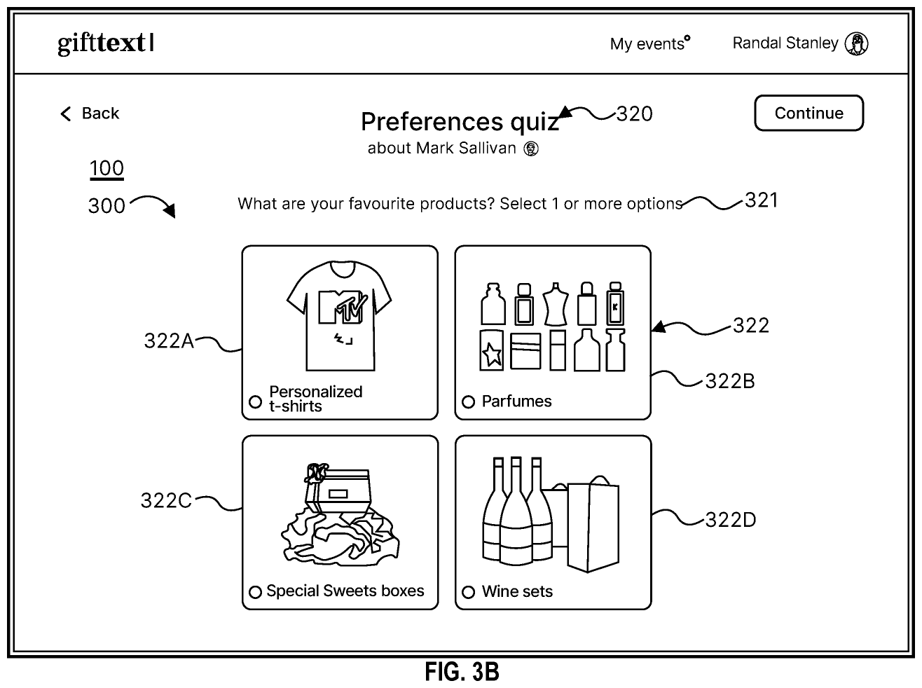

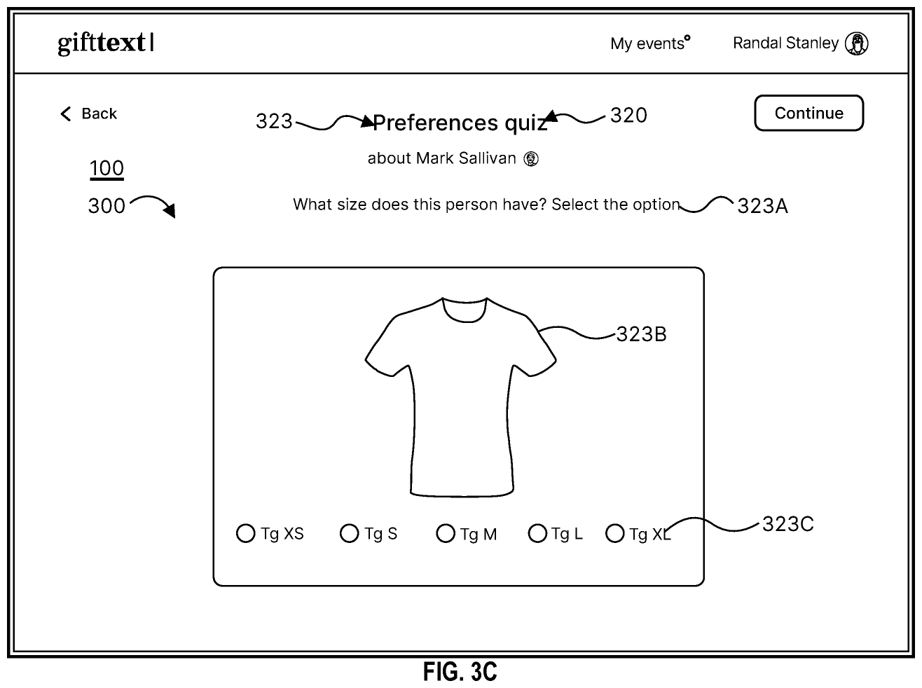

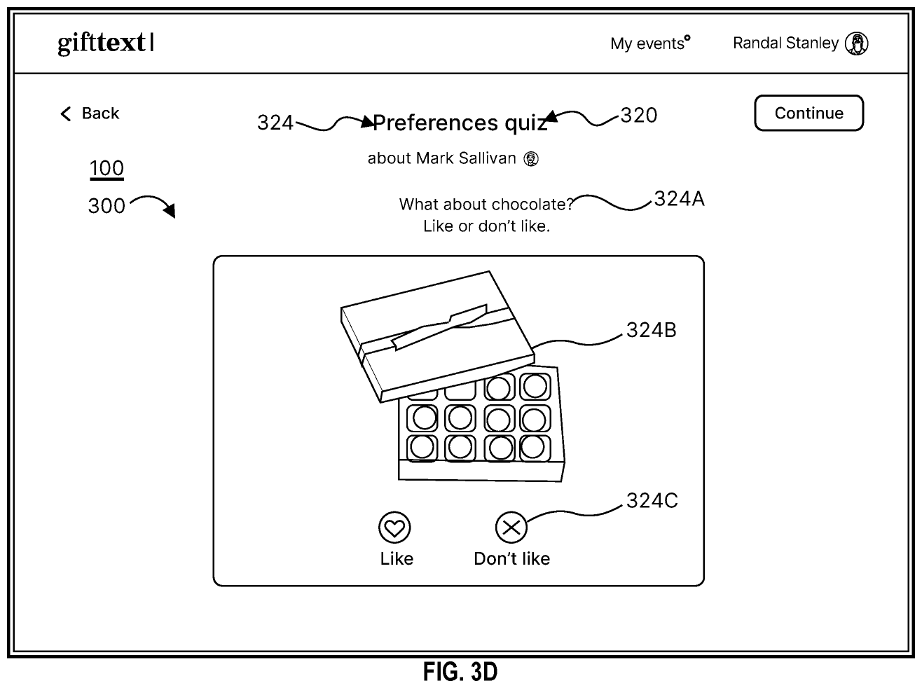

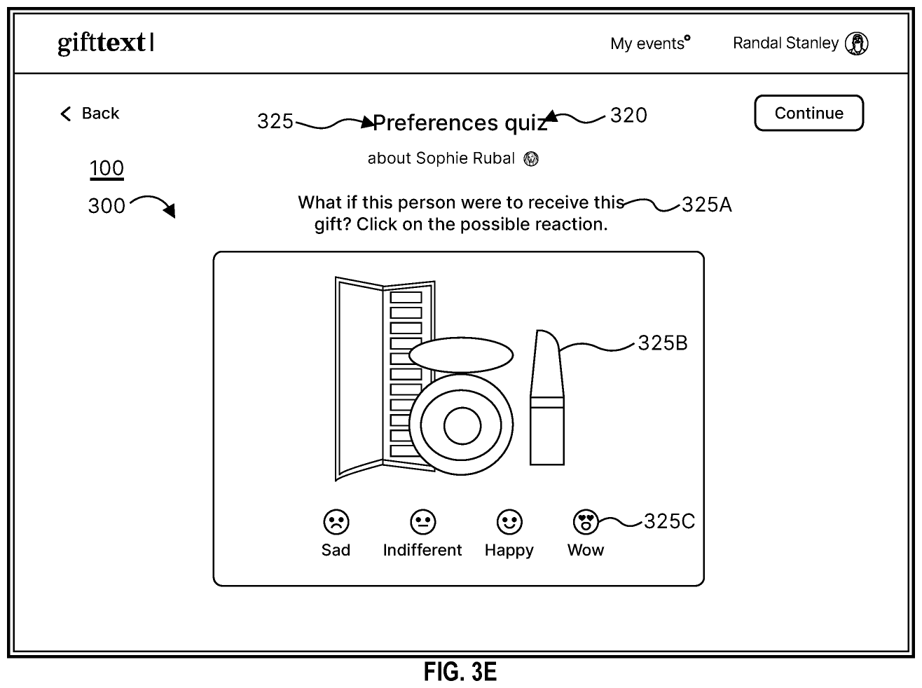

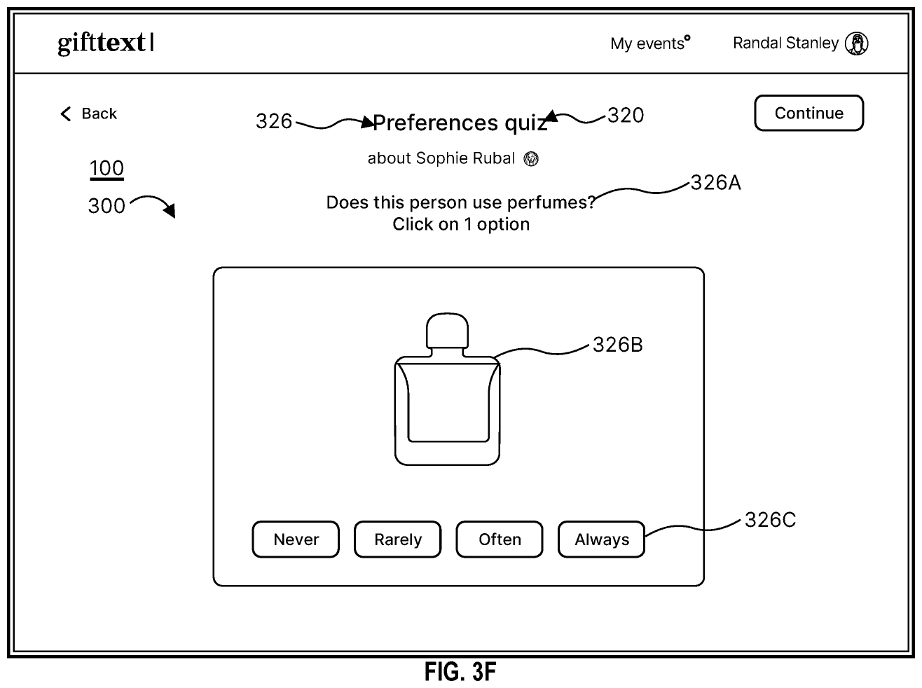

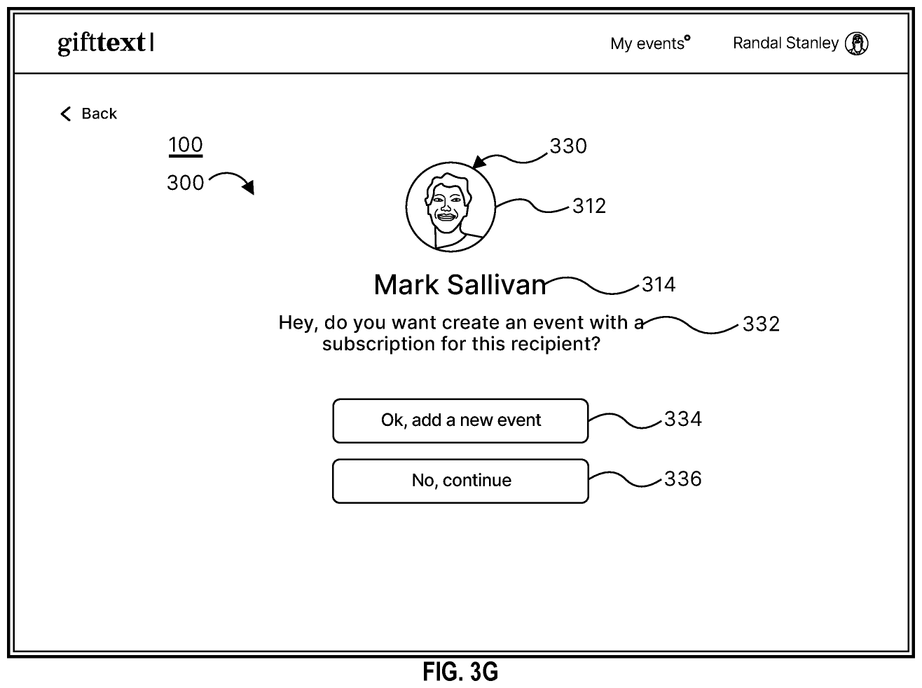

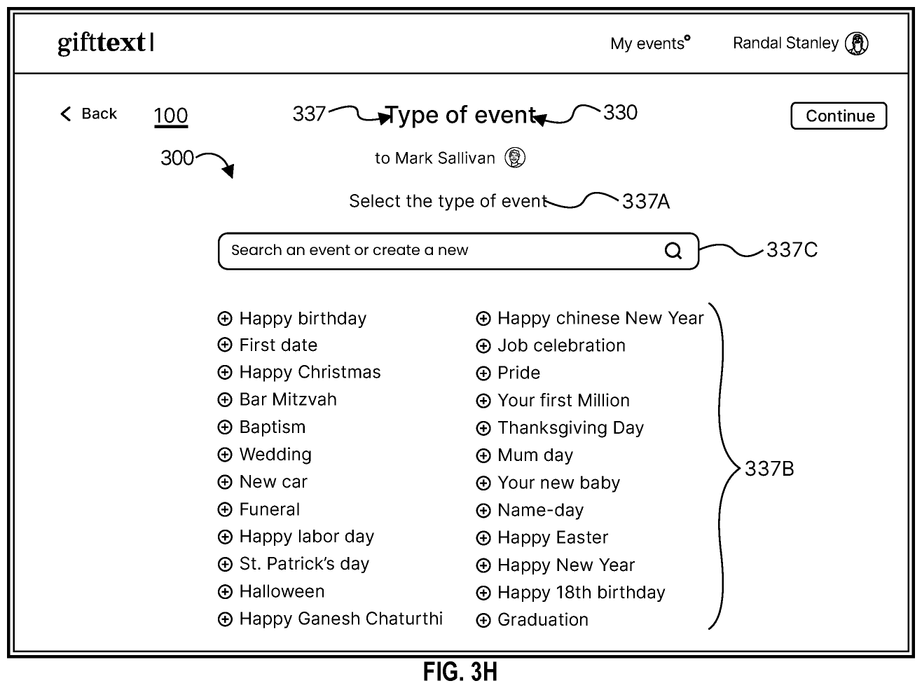

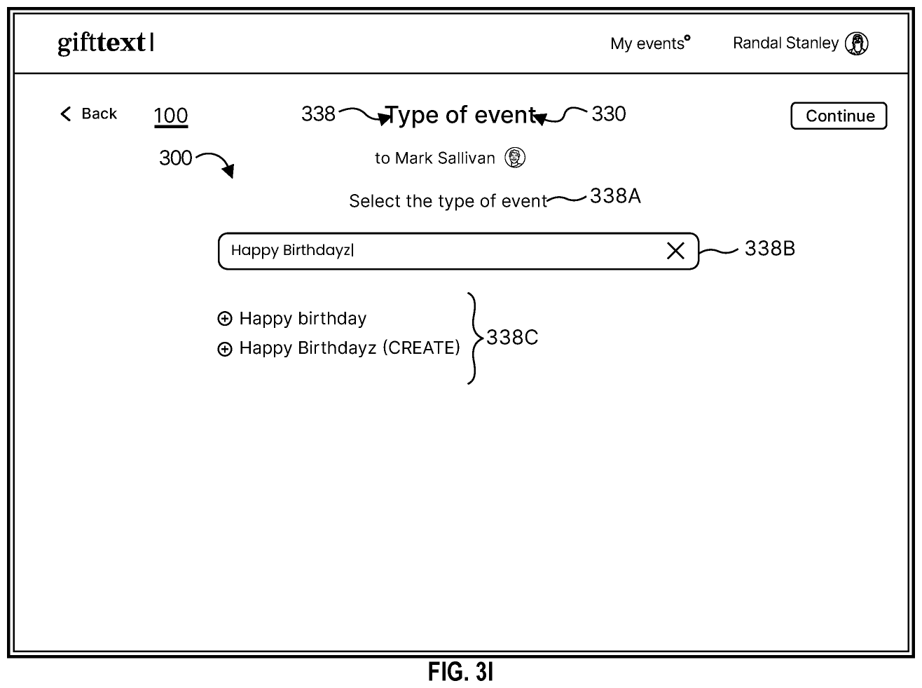

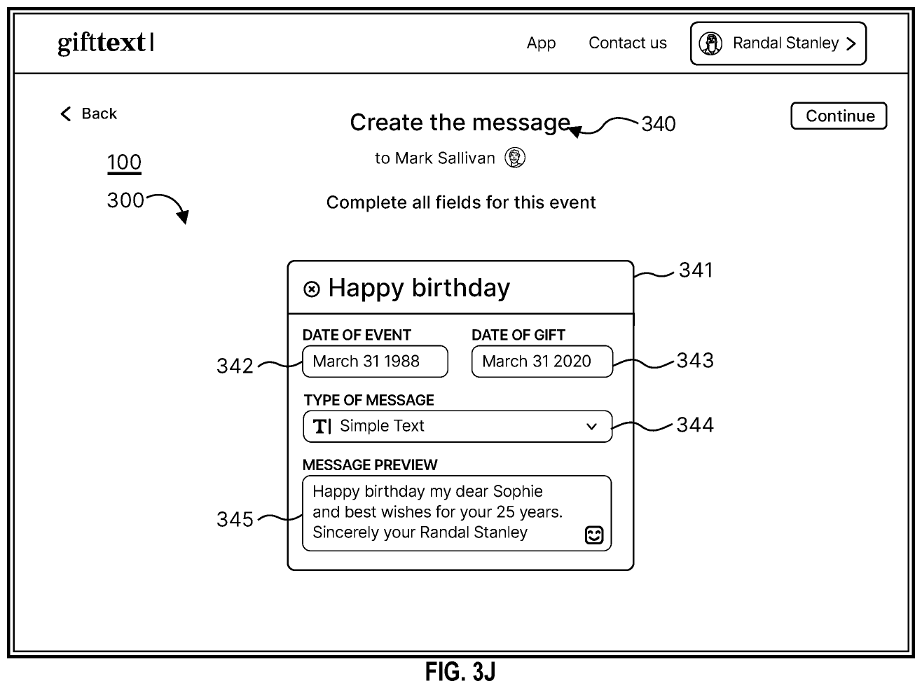

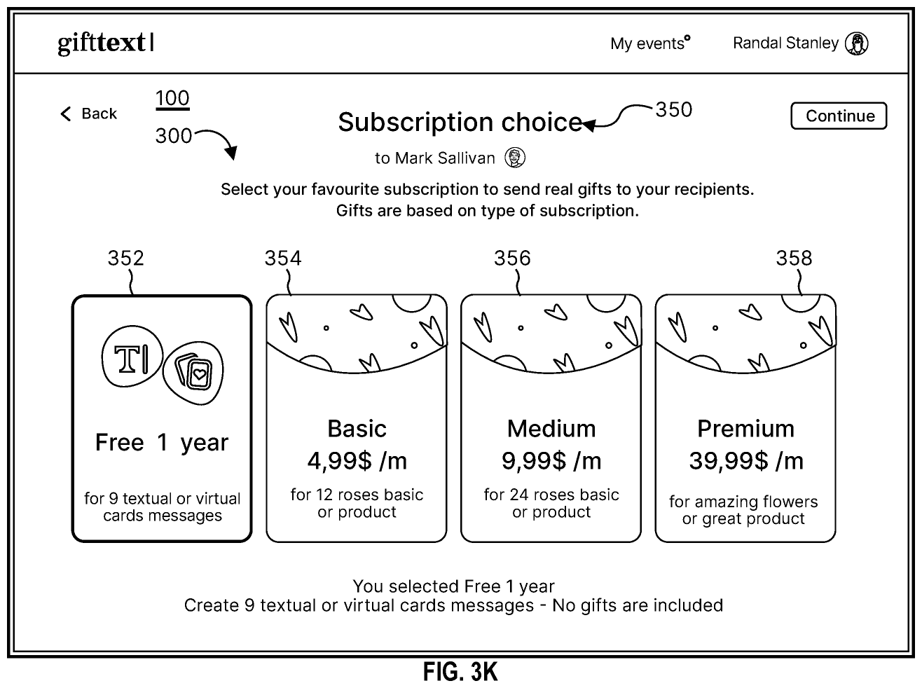

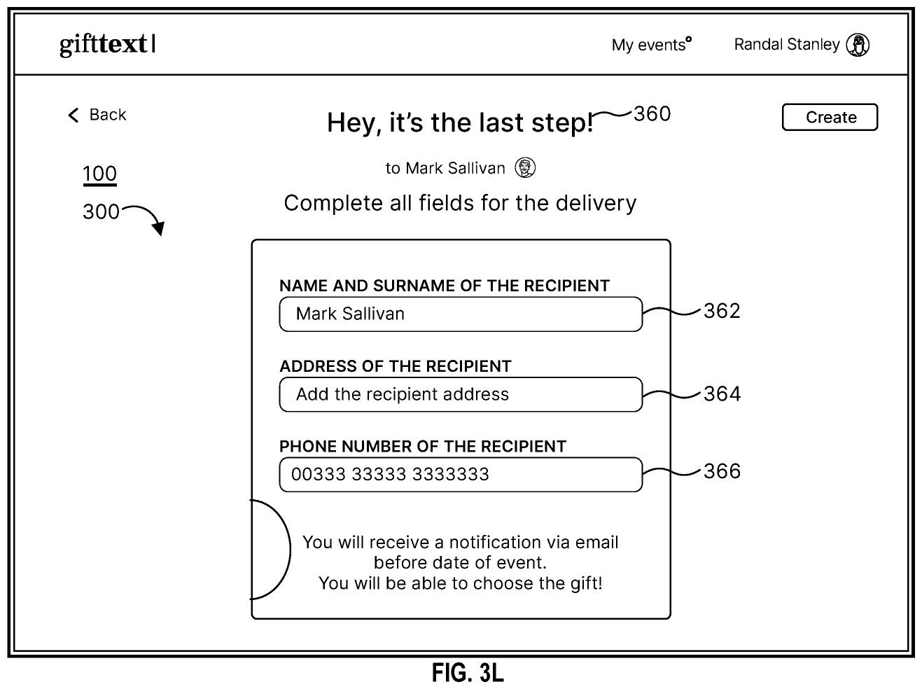

If comprising a software application or other computer-implemented method, the gifting method 100 can present one or more recipient profile pages 300 for enabling the gifter to enter a recipient profile for a selected recipient, at 120, as shown in FIGS. 3A-L. Turning to FIG. 3A, for example, the recipient profile pages 300 can include a new recipient creation page 310. The new recipient creation page 310 can present a name 314, an image 312, an age 316, a gender 318 and/or other recipient profile information of the selected recipient. The gifting method 100 can enable the gifter to enter and/or edit (or update) the recipient profile, as needed.

For example, the gifting method 100 can enable the gifter to enter and/or edit (or update) personal preference information for the selected recipient. The gifting method 100 can utilize the entered personal preference information to identify one or more appropriate gifts for the selected recipient. As illustrated in FIG. 3B, the gifting method 100 can present one or more preference quiz pages 320 for assisting the gifter with creating the recipient profile for the selected recipient. In selected embodiments, the preference quiz pages 320 can comprise a plurality of questions that are presented via a single preference quiz page 320 and/or via a plurality of hierarchically-arranged single preference quiz pages 320.

The preference quiz page 320 shown in FIG. 3B, for example, the preference quiz page 320 can include a question 321 that asks the gifter about the favorite products of the selected recipient. The preference quiz page 320 can present at least one product category option 222 for assisting the gifter with answering the question 321. Exemplary product category options 222 can include an apparel option 322A, a perfume option 322B, a makeup option, a sweets option 322C and/or a wine option 322D, without limitation. The preference quiz page 320 can prompt the gifter to select one or more of the product category options 222.

Based upon the selection of a product category option 222 by the gifter, the gifting method 100 can present one or more detailed preference quiz pages 320 for requesting additional personal preference information for the selected product category option 222. If the gifter selects the apparel option 322A, for example, the gifting method 100 can present an apparel preference quiz page 323 as shown in FIG. 3C. The apparel preference quiz page 323 can include a question 323A that asks the gifter for more detailed information about the apparel preferences of the selected recipient. In some embodiments, the apparel preference quiz page 323 can include an image 323B of an exemplary apparel item for facilitating consideration of the question 323A by the gifter. The apparel preference quiz page 323 can present at least one apparel preference option 323C for assisting the gifter with answering the question 323A.

The gifter alternatively can select the sweets option 322C, and the gifting method 100 can present a sweets preference quiz page 324 as shown in FIG. 3D. The sweets preference quiz page 324 can include a question 324A that asks the gifter for more detailed information about the sweets preferences of the selected recipient. In some embodiments, the sweets preference quiz page 324 can include an image 324B of an exemplary sweets item for facilitating consideration of the question 324A by the gifter. The sweets preference quiz page 324 can present at least one sweets preference option 324C for assisting the gifter with answering the question 324A.

Additionally and/or alternatively, if the gifter selects the makeup option, for example, the gifting method 100 can present a makeup preference quiz page 325 as shown in FIG. 3E. The makeup preference quiz page 325 can include a question 325A that asks the gifter for more detailed information about the makeup preferences of the selected recipient. In some embodiments, the makeup preference quiz page 325 can include an image 325B of an exemplary makeup item for facilitating consideration of the question 325A by the gifter. The makeup preference quiz page 325 can present at least one makeup preference option 325C for assisting the gifter with answering the question 325A.

As a further example, the gifter can select the perfume option 322B. The gifting method 100 thereby can present a perfume preference quiz page 326 as shown in FIG. 3F. The perfume preference quiz page 326 can include a question 326A that asks the gifter for more detailed information about the perfume preferences of the selected recipient. In some embodiments, the perfume preference quiz page 326 can include an image 326B of an exemplary perfume item for facilitating consideration of the question 326A by the gifter. The perfume preference quiz page 326 can present at least one perfume preference option 326C for assisting the gifter with answering the question 326A. Although shown and described above with reference to creating recipient profile pages 300 for a single selected recipient for purposes of illustration, the gifting method 100 can enable the gifter to create recipient profile pages 300 for any predetermined number of recipients.

Returning briefly again to FIG. 1, the gifting method 100 can enable the gifter to create one or more new occasions or other events for the selected recipient, at 130. The new event can comprise an occasion for which the gifter would like to present the selected recipient with a gift. Turning to FIG. 3G, for example, the gifting method 100 can present a new event creation page 330. The new event creation page 330 can present a question 332 that asks the gifter whether a new event should be created for the selected recipient. The name 314, image 312 and/or other recipient profile information of the selected recipient optionally can be presented on the new event creation page 330 for facilitating consideration of the question 332 by the gifter. Upon consider the question 332, the gifter can decline to create a new event, at 336, or choose to create a new event, at 334.

If the gifter chooses to create the new event, at 334, the gifting method 100 can assist the gifter with creating the new event. The gifting method 100, for example, can permit the gifter to select an event type of the new event from a list of predetermined events and/or can permit the gifter to enter a new event type. In selected embodiments, the gifting method 100 can present a new event type page 337 as illustrated in FIG. 3H. The new event type page 337 can prompt the gifter to select an event type, at 337A, from a list of predetermined events 337B. To facilitate the selection by the gifter, the new event type page 337 can include a search feature 337C by which the gifter can enter event type information for searching among the predetermined events 337B.

Additionally and/or alternatively, the gifting method 100 can present a new event type page 338 as illustrated in FIG. 3I. The new event type page 338 can prompt the gifter to select an event type, at 338A, and/or include a search feature 338B by which the gifter can enter event type information. Based upon the entered event type information, the gifting method 100, at 338, can propose a preexisting event type and/or can permit the gifter to create a customized event type. The customized event type, for example, can comprise an event type that is not included among the predetermined events 337B (shown in FIG. 3H) maintained by the gifting method 100.

Turning to FIG. 3J, the gifting method 100 optionally can present a message creation page 340. The message creation page 340 can enable the gifter to create a new message for accompanying the gift to be sent to the selected recipient in accordance with the new event. As shown in FIG. 3J, the message creation page 340 can permit the gifter to enter a subject line for the new message, at 341. A body of the new message can be entered, at 344. The body of the new message, as it will appear when received by the selected recipient, can be previewed, at 345. The gifter likewise can enter an event date 342 for the new event and/or a gift date 343 for delivering the gift via the message creation page 340.

The gifting method 100 can permit the gifter to choose a subscription type for the recipient profile of the selected recipient. As illustrated in FIG. 3K, for example, the gifting method 100 can present a subscription choice page 350 for assisting the gifter with choosing a suitable subscription type for the selected recipient. Exemplary recipient subscription types can include a free subscription type 352 and/or one or more fee-based subscription types, including a basic subscription type 354, a medium subscription type 356 and/or a premium subscription type 358. As above, the free subscription type 352 can permit the gifter to send free gifts, such a predetermined number of virtual (or textual) greeting cards, to a selected recipient during a preselected time period. The preselected time period can comprise any suitable time period, including one year.

Alternatively, the fee-based subscription types can permit the gifter to send enhanced gifts to one or more recipients. The basic subscription type 354, for example, can be offered for a basic periodic fee and enable the gifter to send basic gifts, such as one dozen roses or other basic gifts, to a selected recipient during a basic subscription period. Additionally and/or alternatively, the medium subscription type 356 can be available for a medium periodic fee, greater than the basic periodic fee, and enable the gifter to send medium gifts, such as two dozen roses or other medium gifts, to a selected recipient during a medium subscription period; whereas, the premium subscription type 358 can be available for a premium periodic fee, greater than the medium periodic fee, and enable the gifter to send premium gifts, such as premium gifts, to a selected recipient during a premium subscription period.

In selected embodiments, the gifting method 100 can permit the gifter to enter delivery information for delivering the gift to the selected recipient. FIG. 3L, for example, illustrates an exemplary delivery information entry page 360 of the gifting method 100. The delivery information entry page 360 can enable the gifter to enter the delivery information, such as a name 362 of the selected recipient, a delivery address 364 of the selected recipient and/or a telephone number 366 of the selected recipient. The gifting method 100 advantageously not only can assist the gifter with selecting the perfect gift for the selected recipient, but also can attend to scheduling delivery of the gift to the selected recipient in accordance with the entered delivery information.

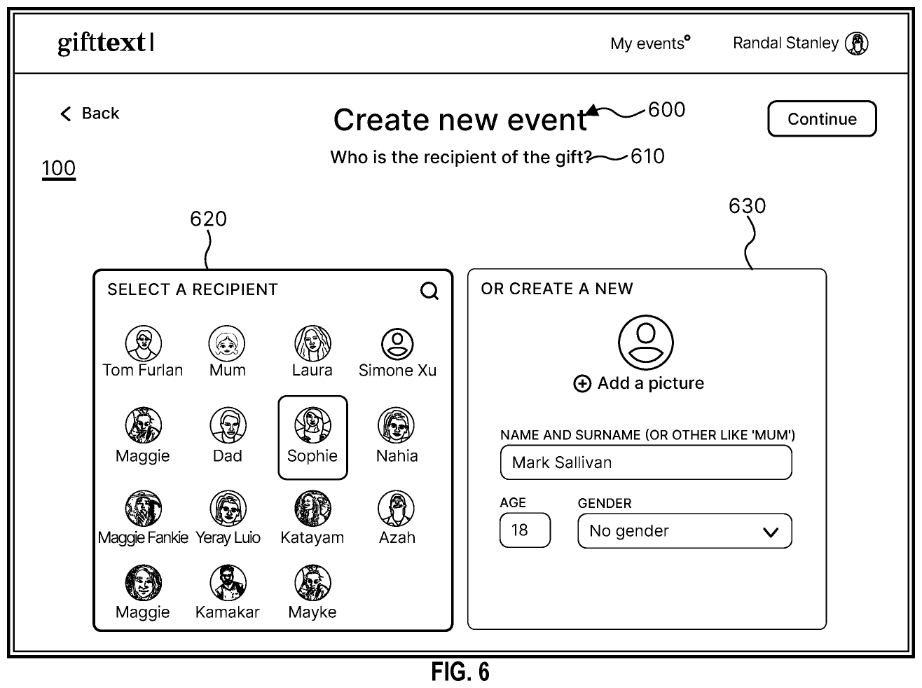

Although shown and described above with reference to creating a new event for a single selected recipient for purposes of illustration, the gifting method 100 can enable the gifter to create any preselected number of new events for any predetermined number of recipients. For example, the gifting method 100 can provide an exemplary new event page 600 as shown in FIG. 6. The new event page 600 can request that the gifter identify the recipient of the gift, at 610. As illustrated in FIG. 6, the gifter can be permitted to select among a group of recipients with existing recipient profiles, at 620, and/or to create a new recipient profile for a new recipient, at 630. The event for a recipient with existing recipient profiles or a new recipient can be created in the manner set forth.

Contrary to conventional static gift registries for only a single occasion, such as a wedding event or a housewarming event, the gifting method 100 advantageously can utilize a gift profile of the recipient of a gift. The gift profile can include one or more preferences of the recipient to help select an appropriate gift for the recipient. Exemplary recipient preferences can include one or more colors, one or more gift categories, such as gardening, kitchen appliances, and/or clothing, and optionally one or more specific gifts. The gifting method 100 optionally can enable the gifter to choose a gift based on the personal preferences of the gifter, not just a gift that was chosen by the recipient or the gift profile of the recipient. In selected embodiments, the gifting method 100 can utilize artificial intelligence to suggest gifts that are right for the occasion, such as St. Valentine's Day or Christmas and/or can consider the relationship between the gifter and the recipient.

To help facilitate accurate gift suggestions, the gifting method 100 can present the preference quiz pages 320 for asking the gifter probing questions. These questions can include a name and/or a telephone number of the recipient to help enable the gifting method 100 to determine whether the recipient has a gift profile. Additionally and/or alternatively, the questions can include: what is the occasion?; what is the relationship between the gifter and the recipient?; and what is the budget of the gift? The gifting method 100 can analyze the answers to these questions and thereby can suggest one or more gifts that are right those requirements.

The gifting method 100 thereby can work for any occasion and/or optionally can help the gifter choose a gift himself rather than gifts that were preselected by the recipient. If the recipient does not have a gift profile, the gifter can then start a gift profile for the recipient and answer preference questions as much as he wants and knows. Based on the gift profile of the recipient, the gifting method 100 can suggest one or more gifts that are appropriate for the occasion, relationship between the gifter and the recipient and desired budget. After the gifter chooses the gift for the recipient, the gifting method 100 optionally can suggest one or more greeting cards that are suitable for the occasion and/or deliver the gift virtually to the recipient in case the gift cannot be delivered to the recipient on time for the occasion.

Returning again to FIG. 1, the gifting method 100, at 140, optionally can enable the gifter to manage selected events associated with the recipient profiles. The gifting method 100, for example, can permit the gifter to view past, current and/or future events. In selected embodiments the gifter can edit one or more scheduled events via the gifting method 100. The gifting method 100 likewise can remind the gifter of an upcoming occasion for at least one recipient and prompt the gifter to utilize the gifting method 100 to select and deliver an appropriate to the recipient.

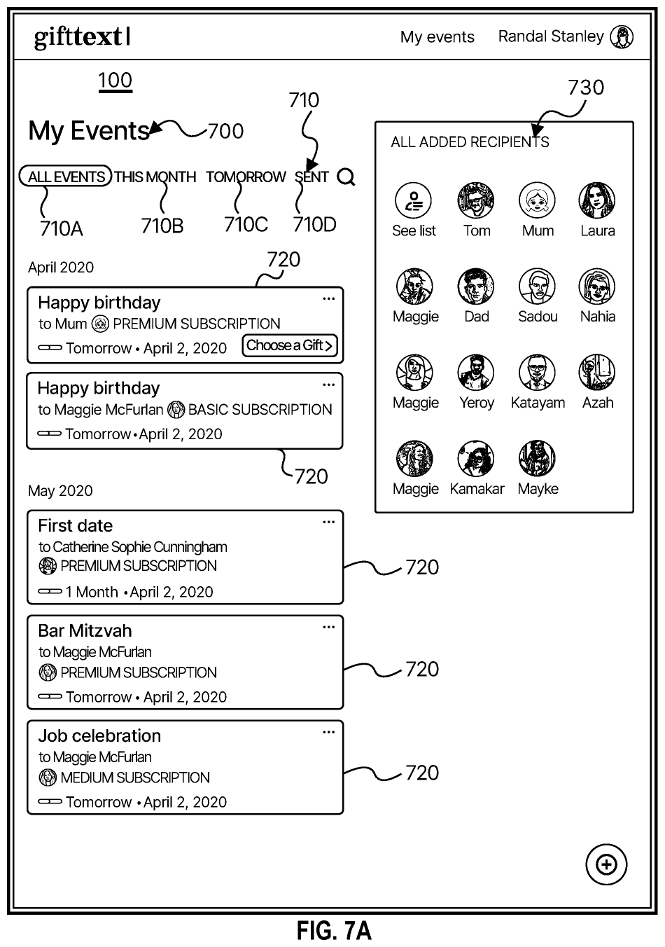

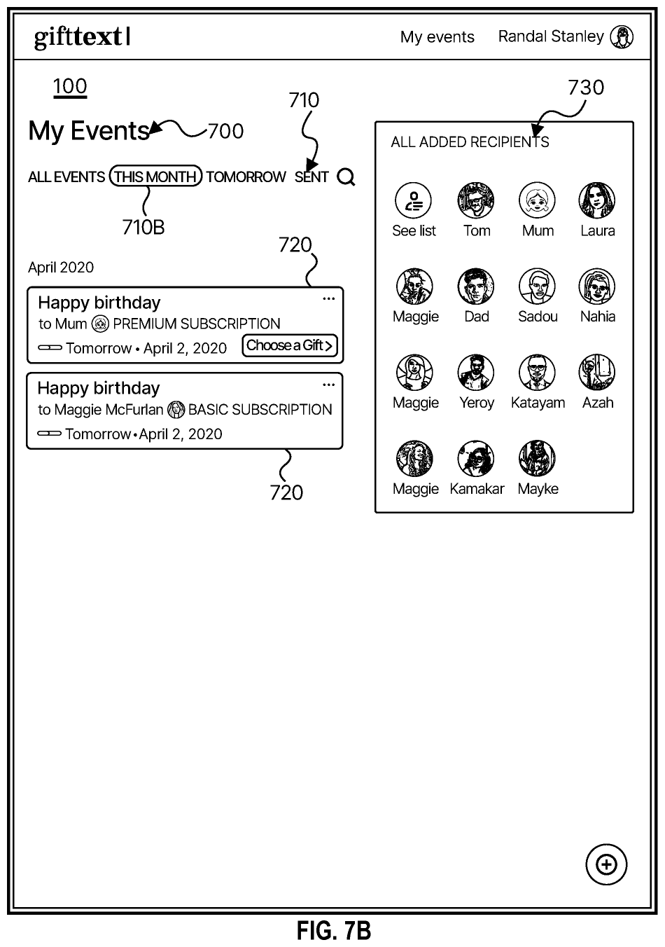

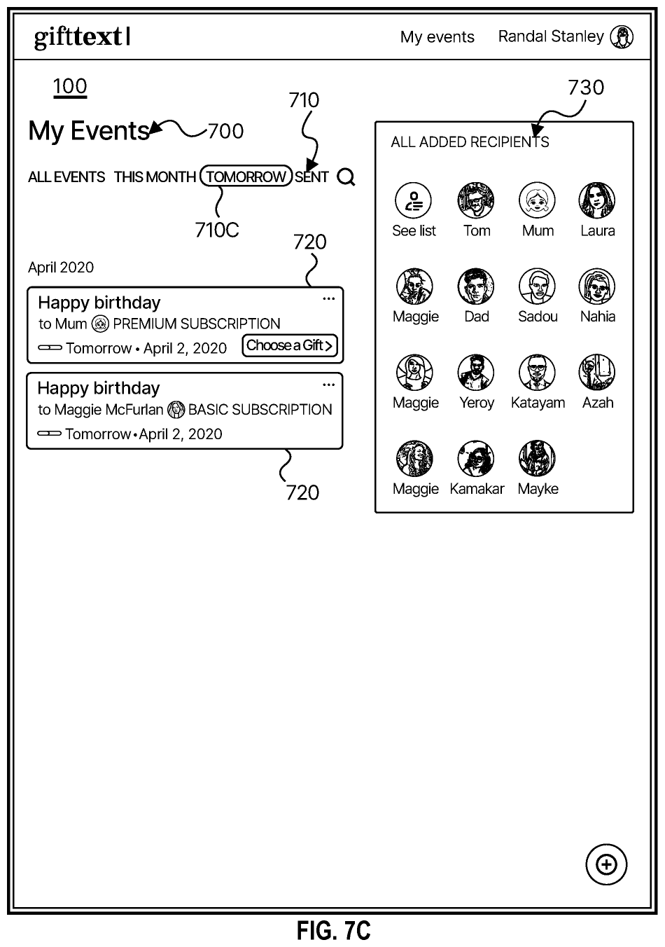

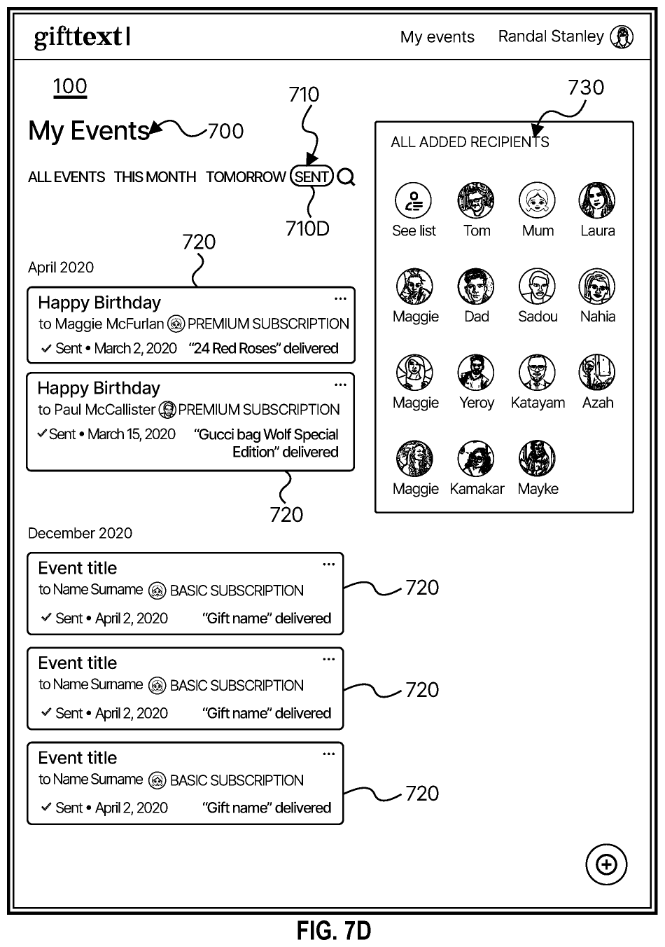

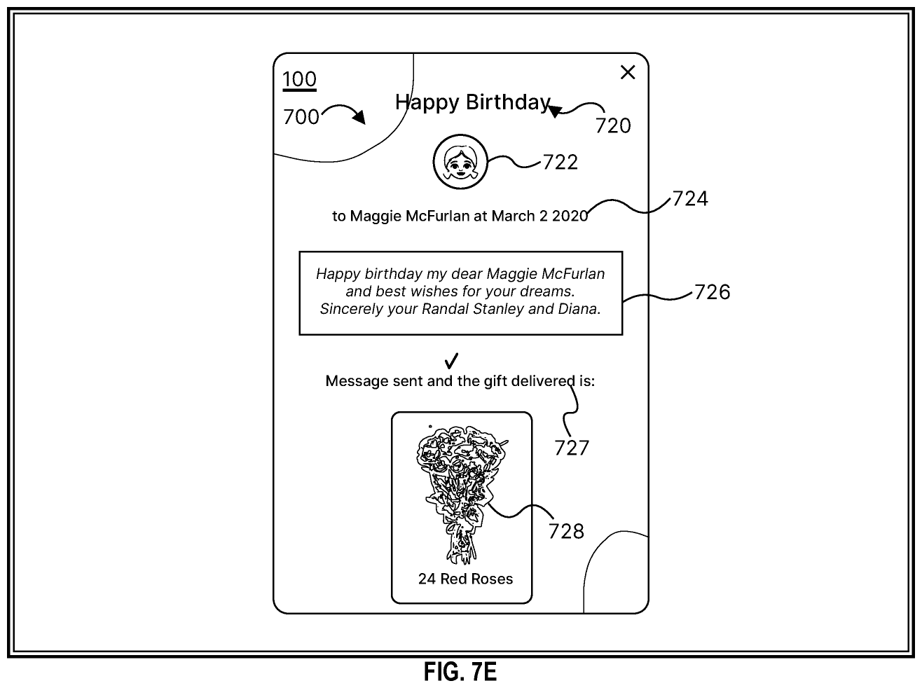

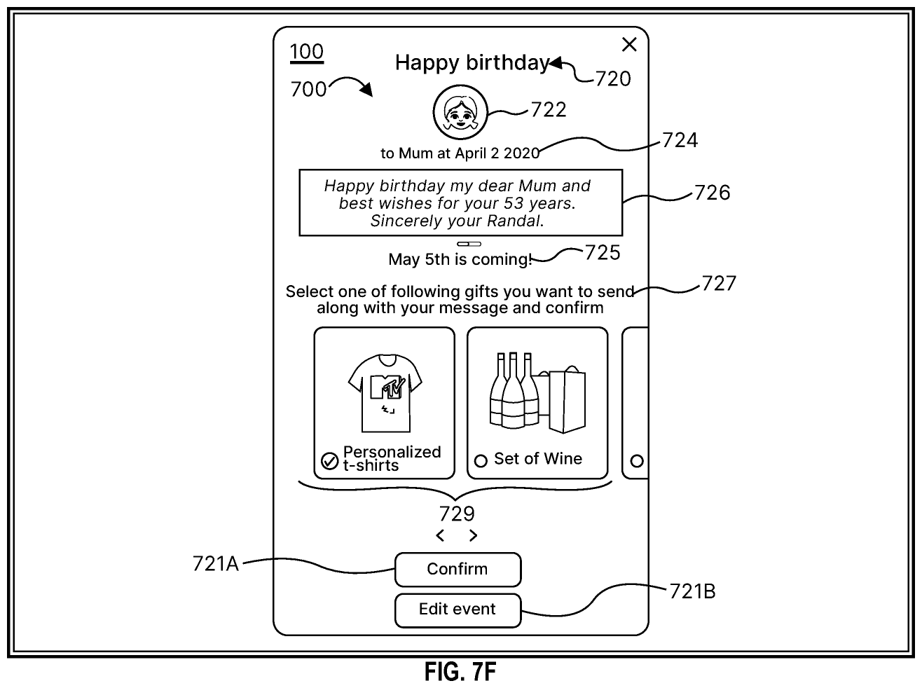

If comprising a software application or other computer-implemented method, the gifting method 100 optionally can present one or more event management pages for permitting the gifter to manage selected events associated with the recipient profiles. An exemplary event management page 700 is shown in FIG. 7A. Turning to FIG. 7A, the event management page 700 can enable the gifter to manage groups of events 720. The events 720 can be grouped in any suitable matter and, in selected embodiments, the event management page 700 can permit the gifter to select, at 710, a predetermined group of events 720. As shown in FIG. 7A, for example, the event management page 700 can facilitate presentation of a group of all of the events 720, at 710A.

Additionally and/or alternatively, the event management page 700 can facilitate presentation of a group of the events 720 occurring during the present month, at 710B, as shown in FIG. 7B, and/or a group of the events 720 occurring during on the following day, at 710C, as shown in FIG. 7C. FIG. 7D illustrates an embodiment of the event management page 700, wherein the event management page 700 can facilitate presentation of a group of the events 720 that have occurred (or sent), at 710D. Advantageously, the event management page 700 optionally can facilitate presentation of a group of the events 720 associated with a selected recipient, at 730. Although shown and described with reference to FIGS. 7A-D as grouping the events 720 based upon a single criteria for purposes of illustration, the event management page 700 can group the events 720 based upon more than one criteria. The event management page 700, for example, can group the events 720 occurring during the present month and being associated with a selected recipient.

Advantageously, the event management page 700 can enable the gifter to view a current event status and other event details for a selected event 720. Turning to FIG. 7E, for example, the event management page 700 is shown as presenting one or more event details of the selected event 720. The event details shown by the event management page 700 can include a recipient image 722, a recipient name and/or a delivery date 724, a recipient message 726, a current event status 727, and/or information about the gift associated with the selected event, without limitation.

Additionally and/or alternatively, the event management page 700 optionally can provide an advance event reminder to the gifter about an upcoming birthday or other occasion for one or more recipients. The advance event reminder advantageously can prompt the gifter to create an event for selecting a suitable gift for each upcoming occasion and delivering the gift to the relevant recipient. The exemplary event management page 700 of FIG. 7F can present the advance event reminder for a selected event 720 associated with an upcoming birthday or other occasion. As shown in FIG. 7F, the event management page 700 can include one or more event details of the selected event 720. The event details shown by the event management page 700 can include a recipient image 722, a recipient name 724, a recipient message 726, a date for the upcoming occasion 725, an invitation to select a gift for the upcoming occasion 727, and/or gift options for the upcoming occasion 729, without limitation. The gifting method 100 can present one or more gift options to the user, at 729, in the manner set forth in additional detail herein.

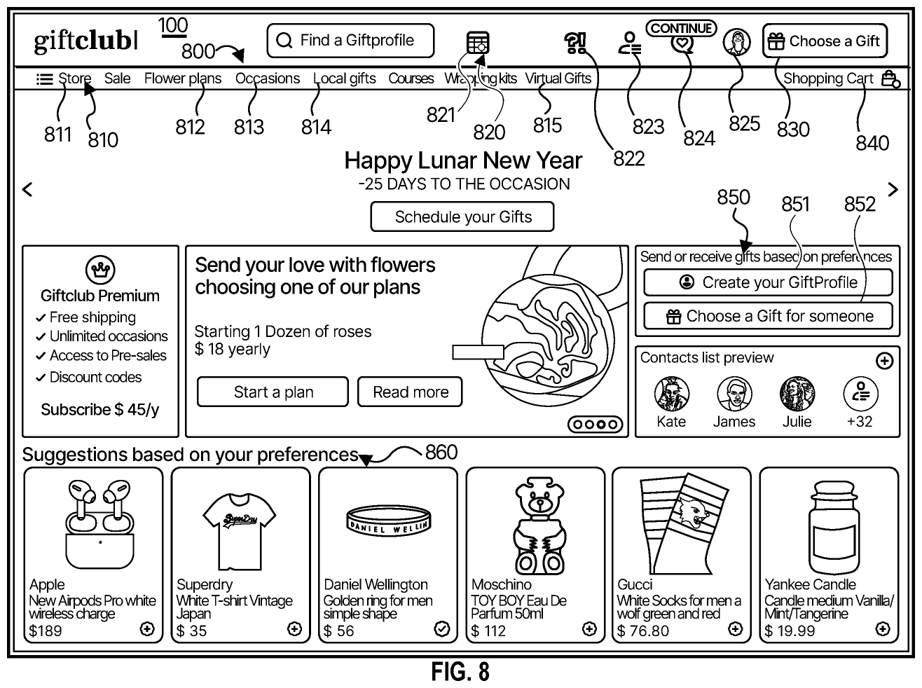

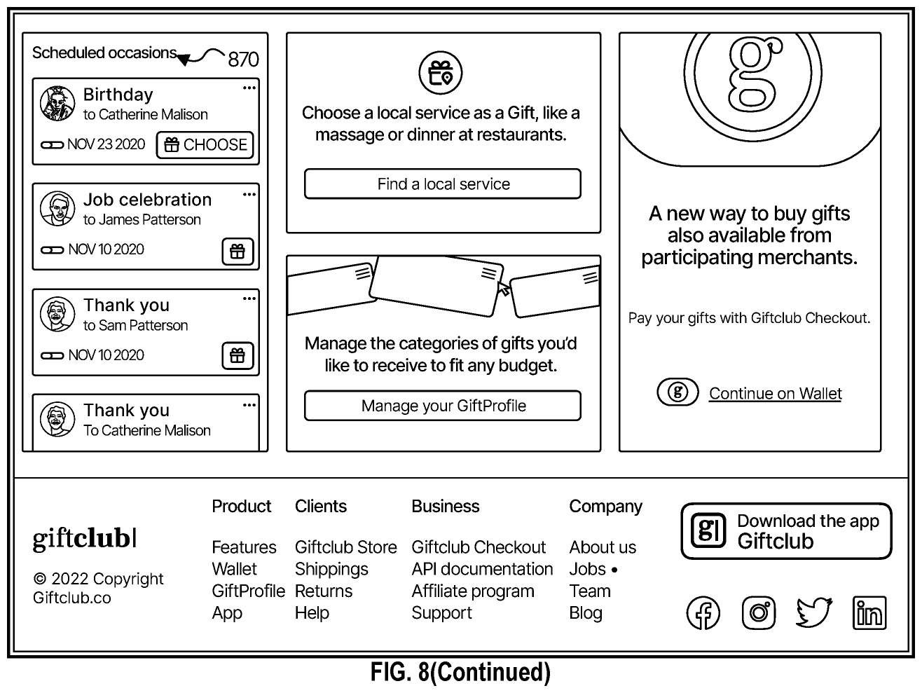

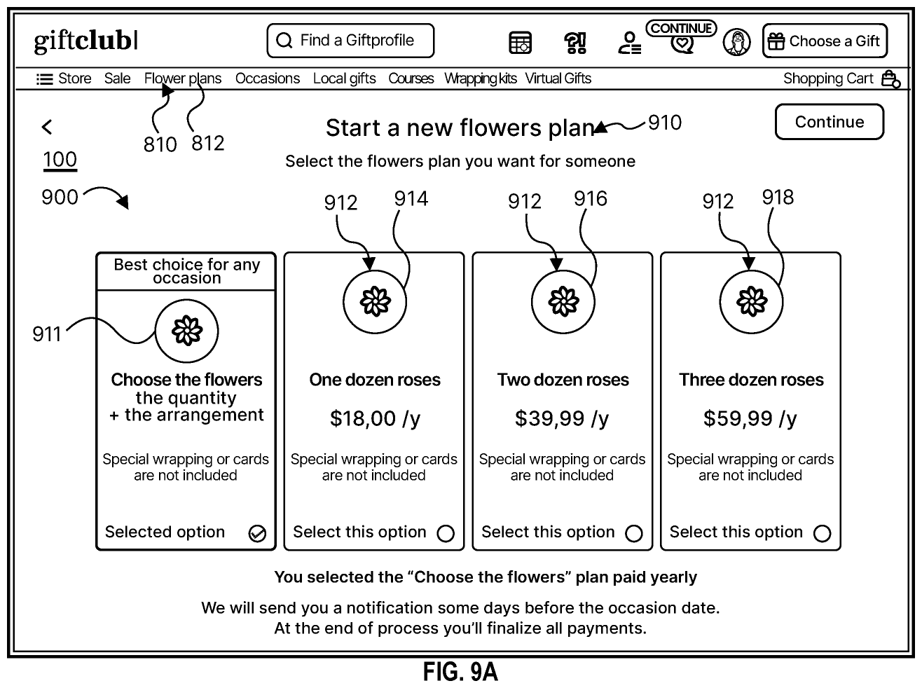

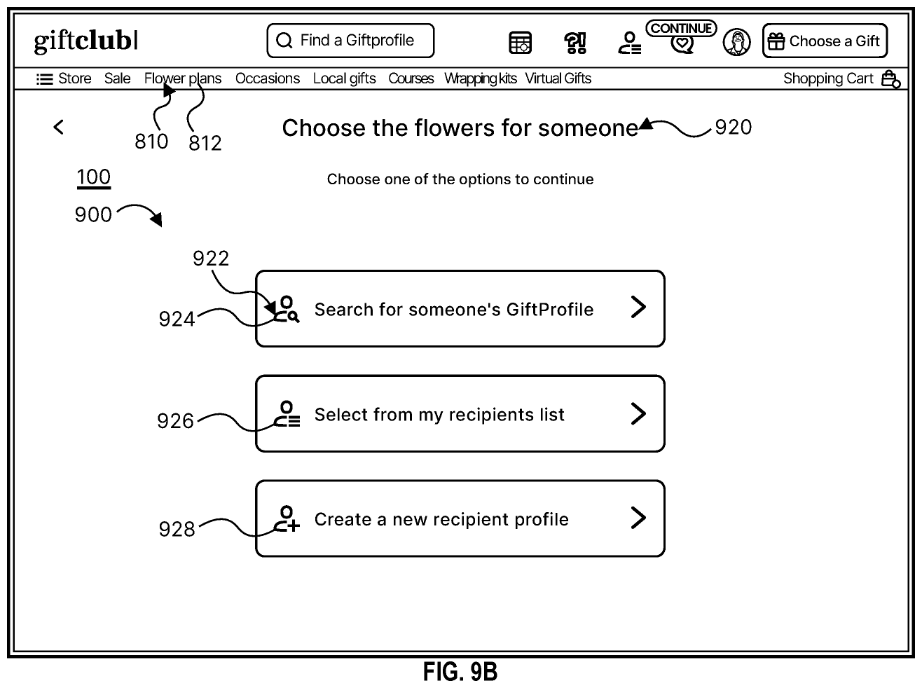

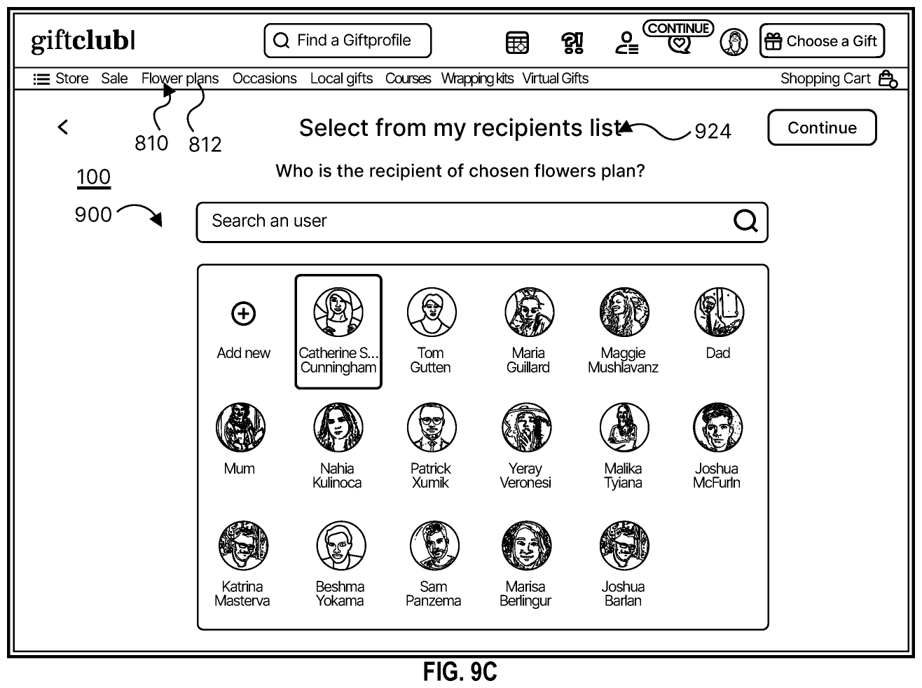

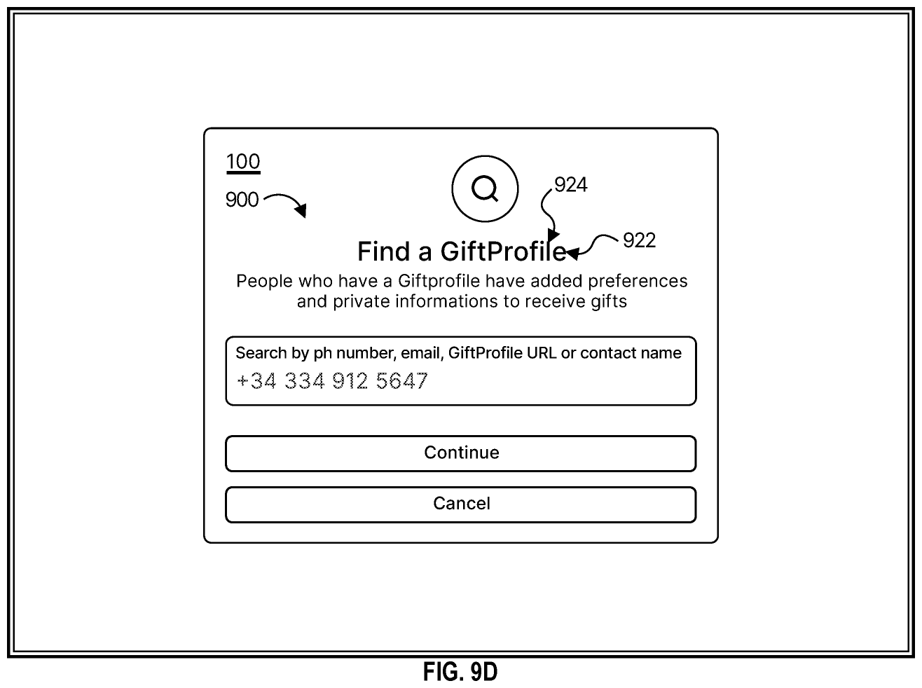

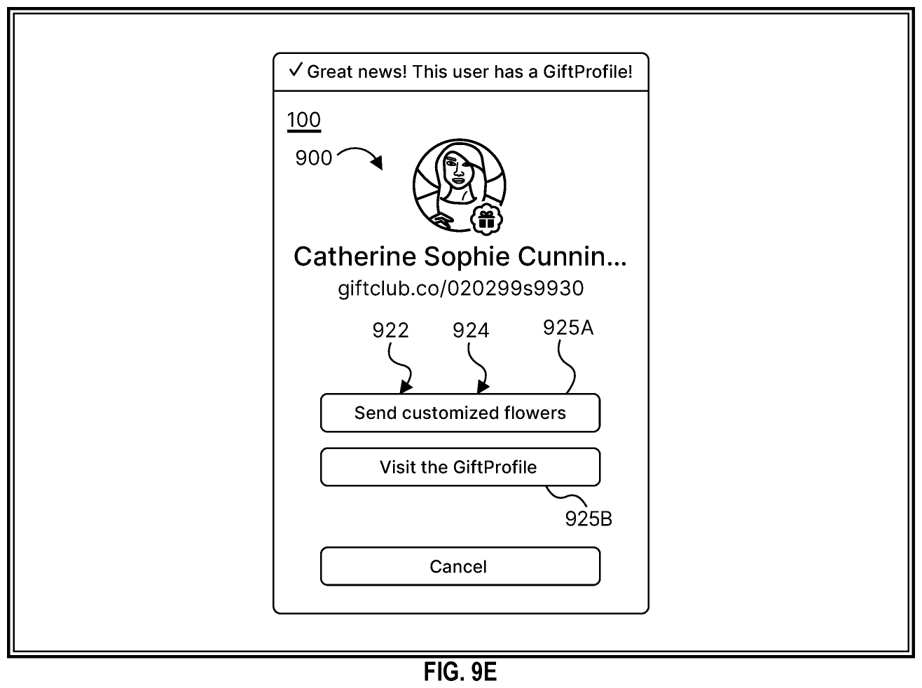

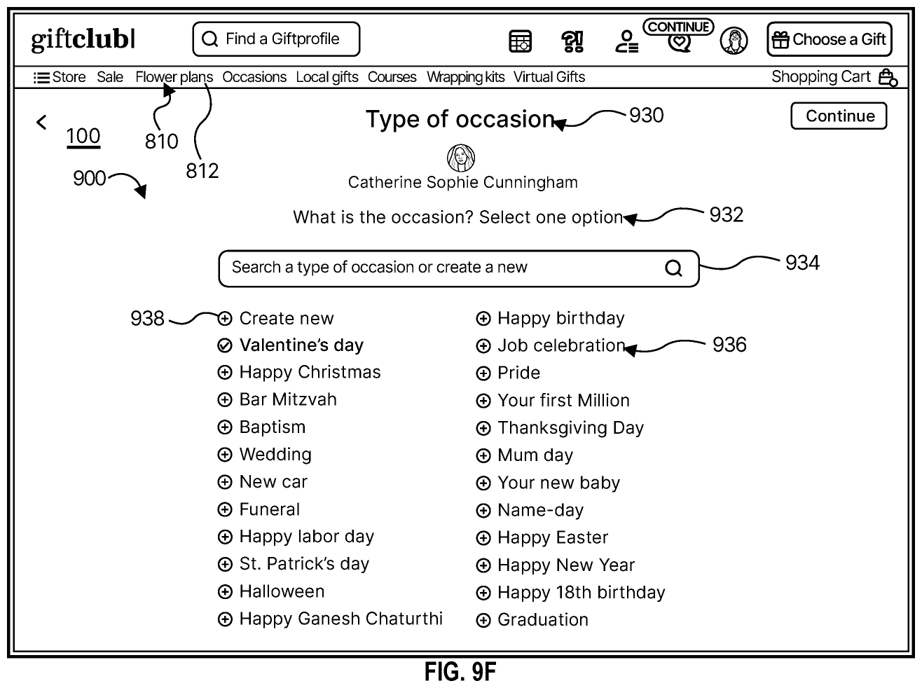

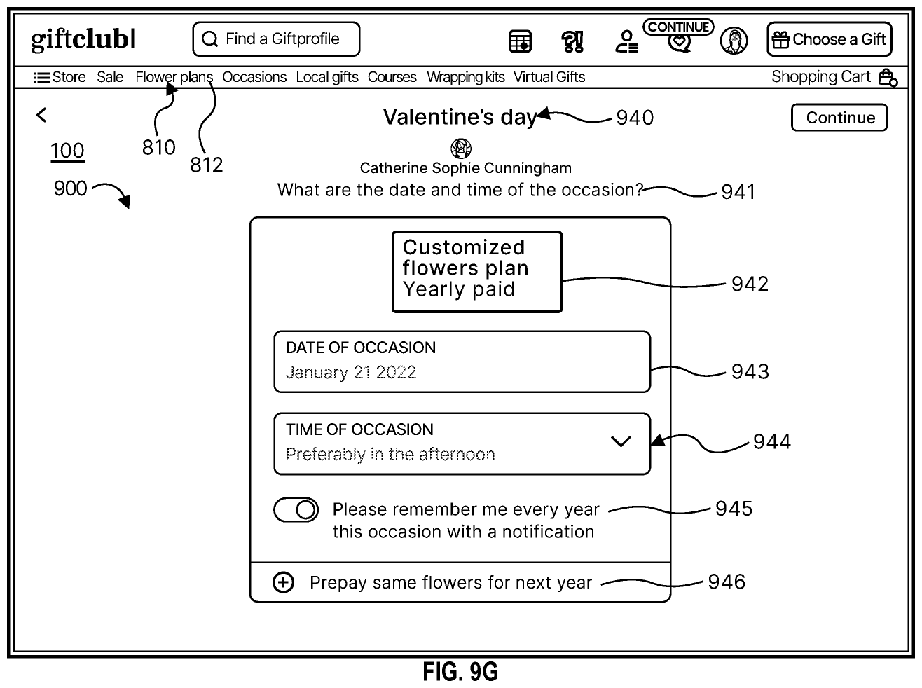

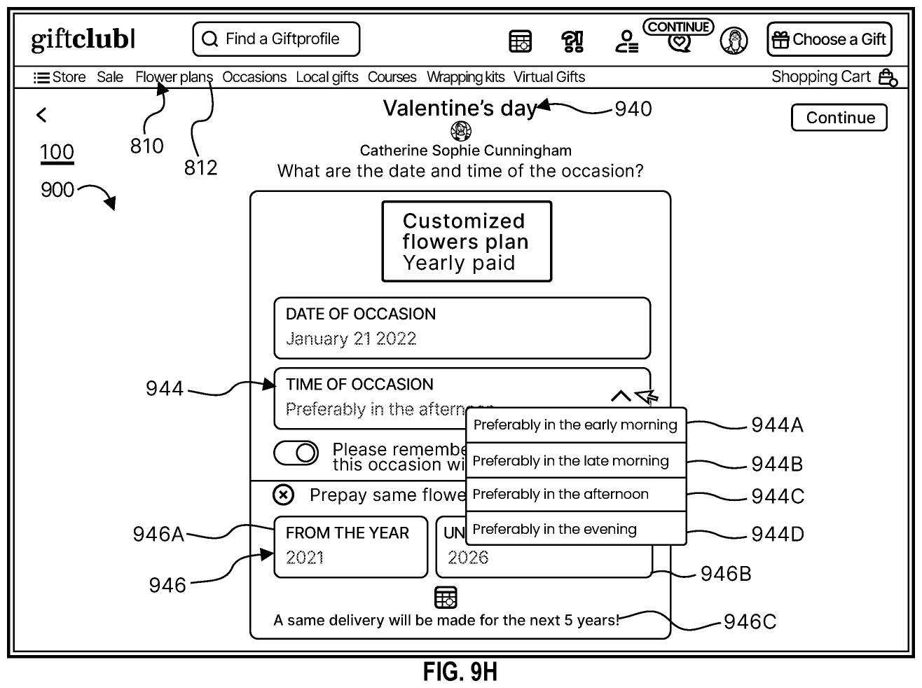

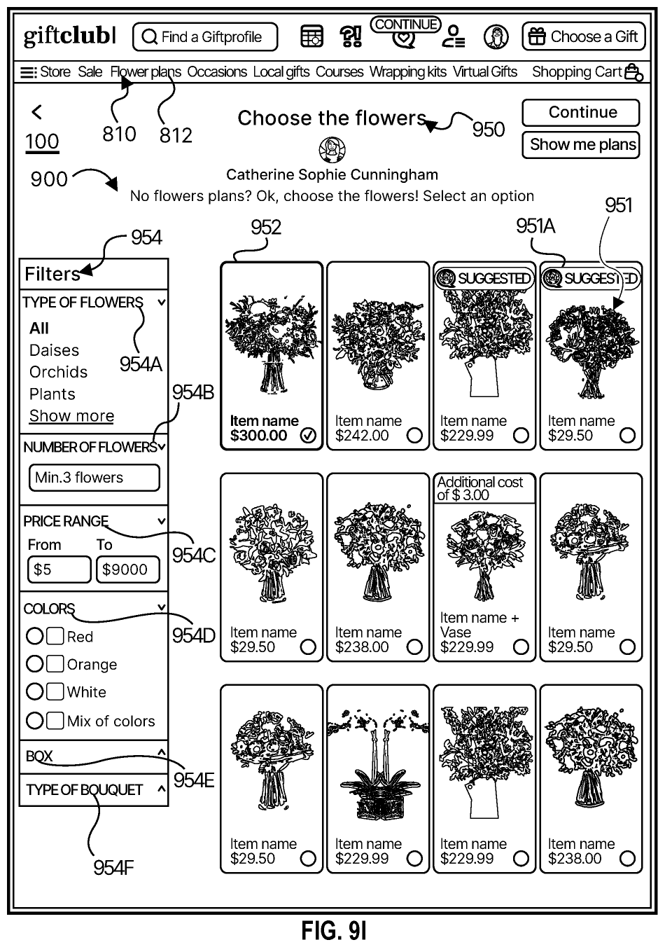

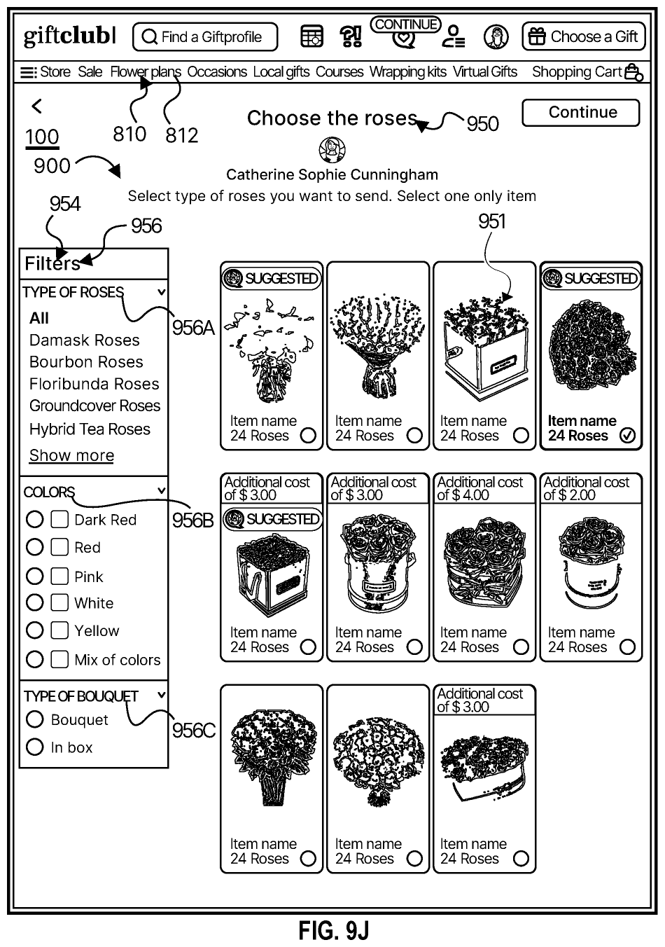

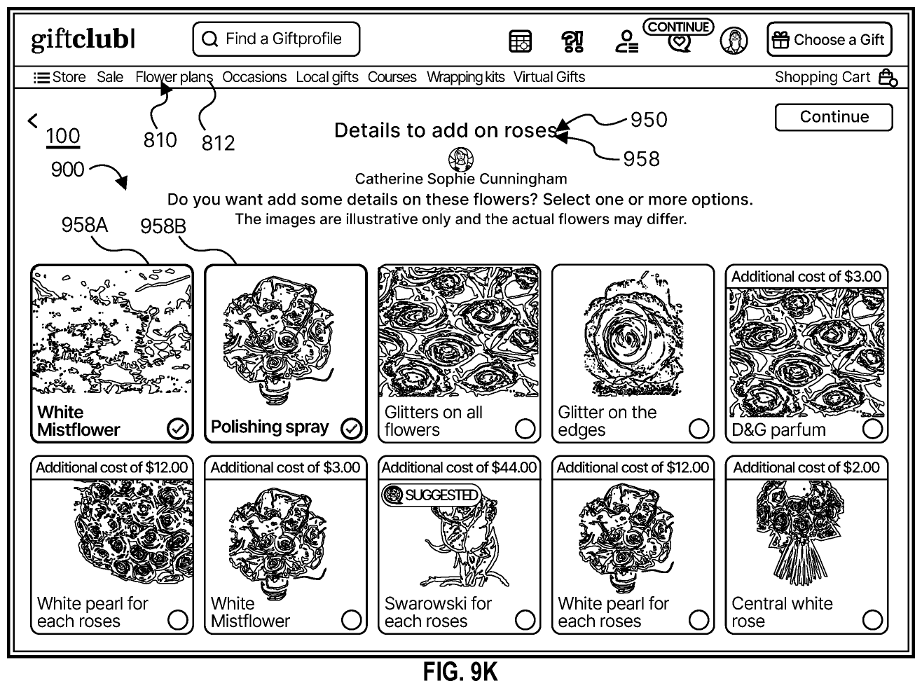

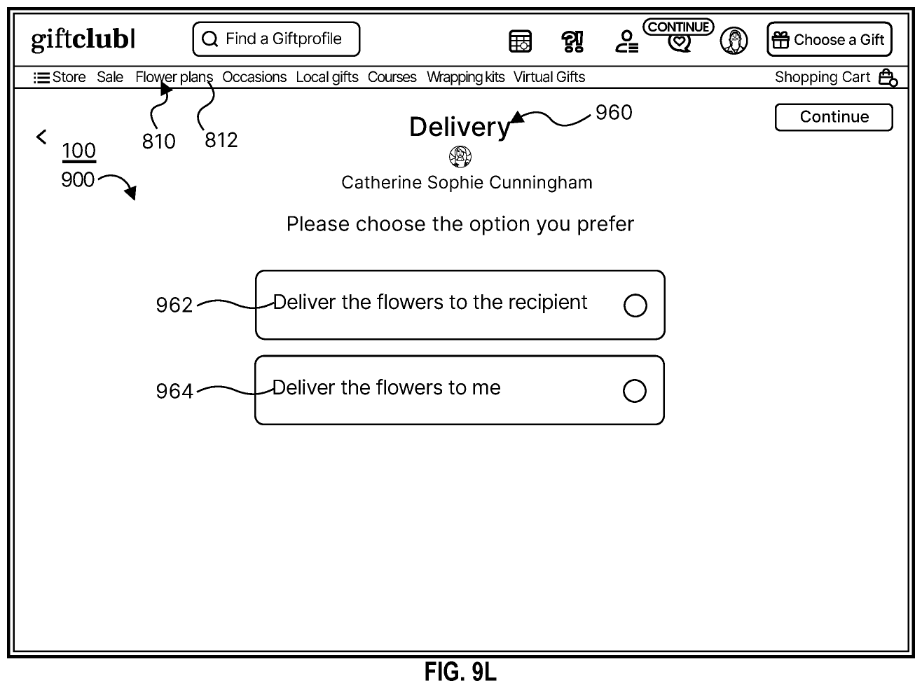

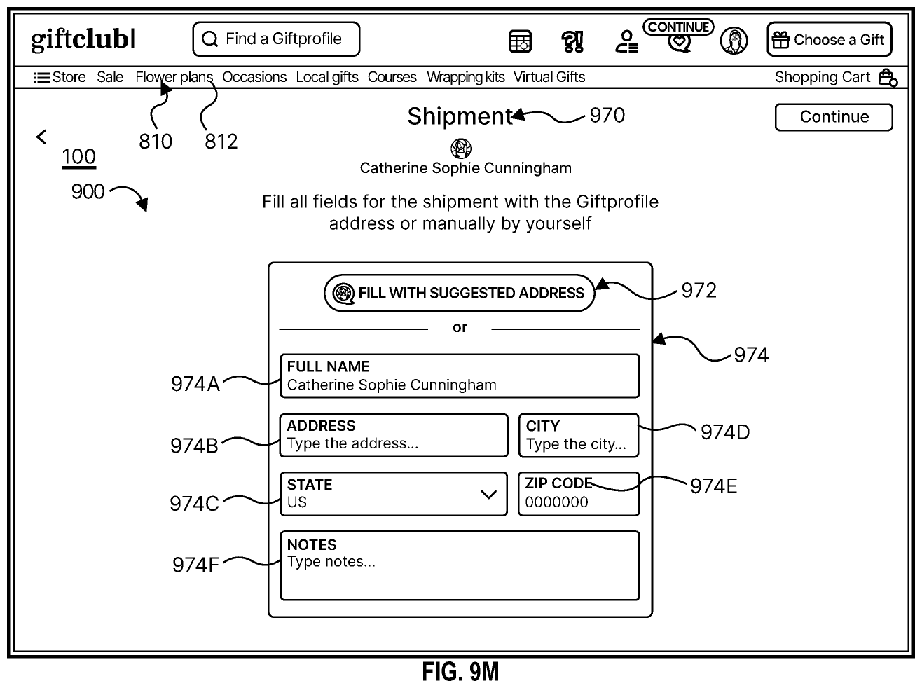

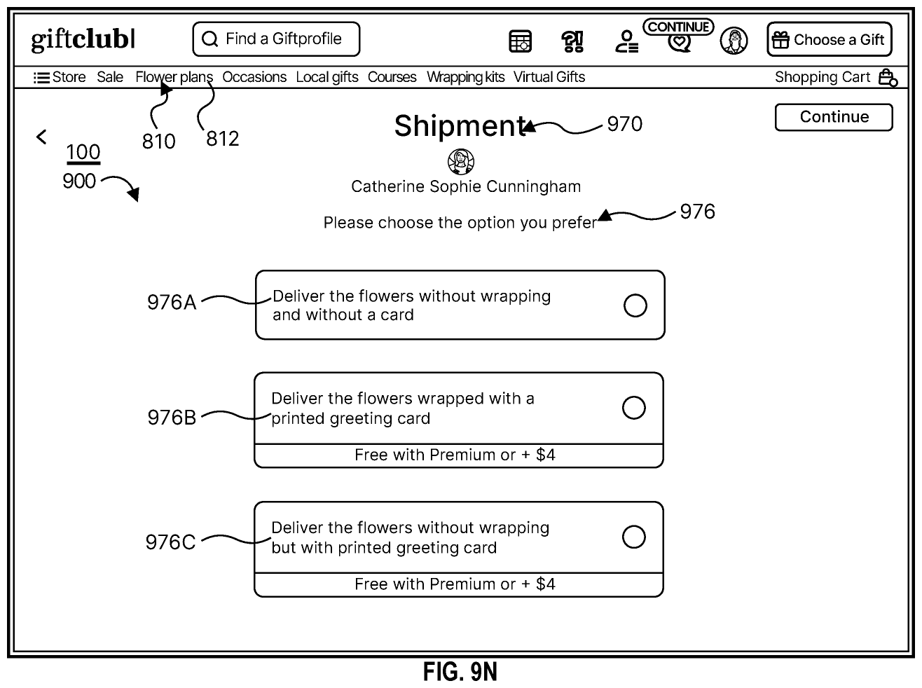

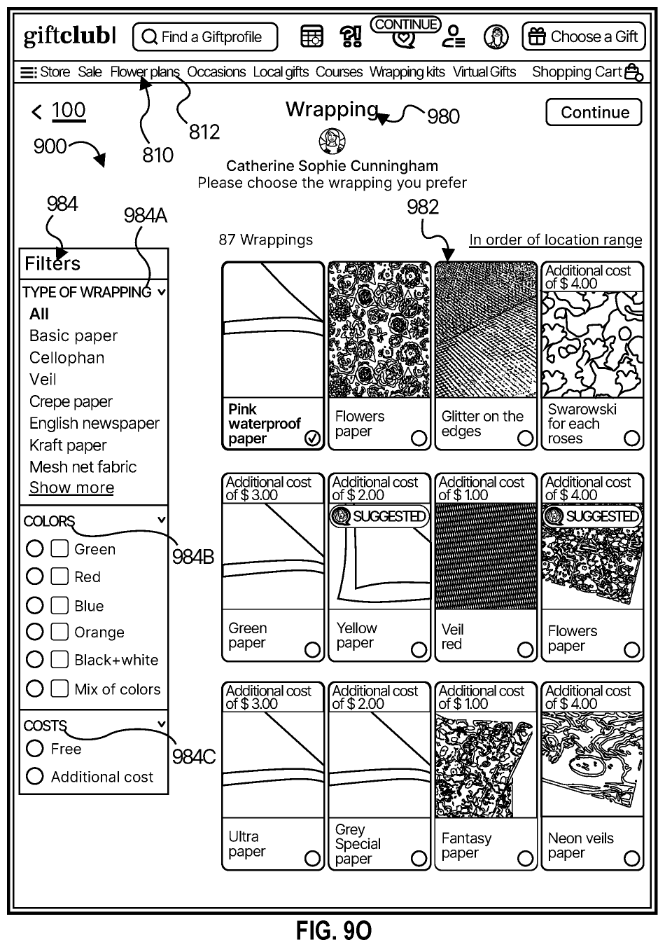

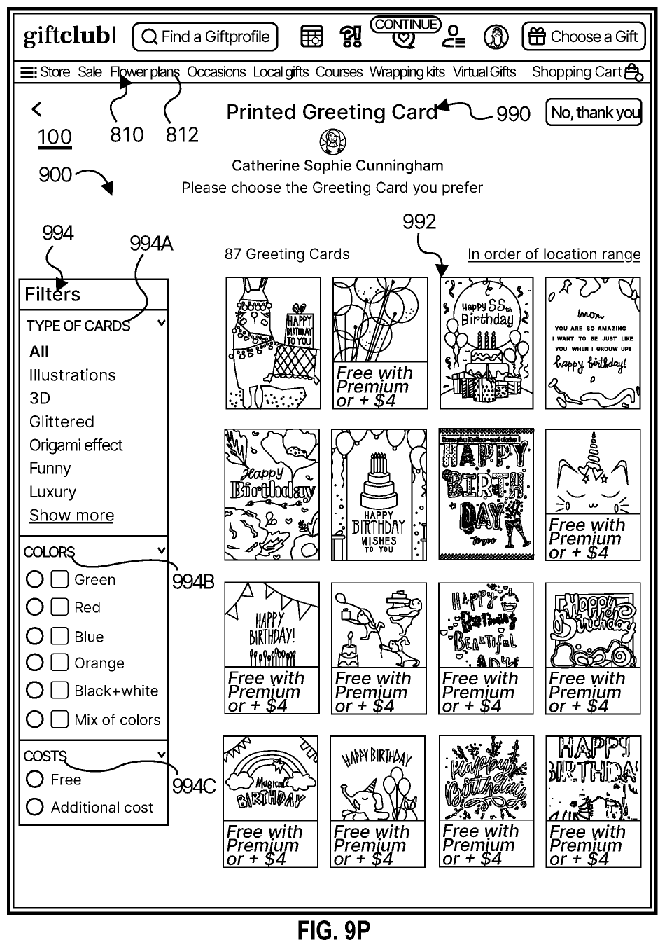

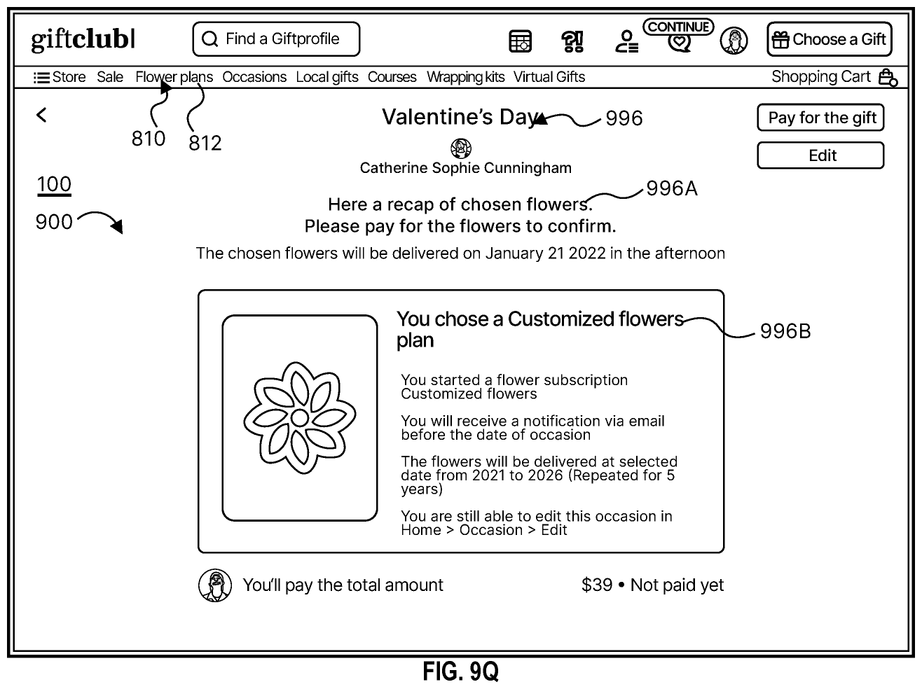

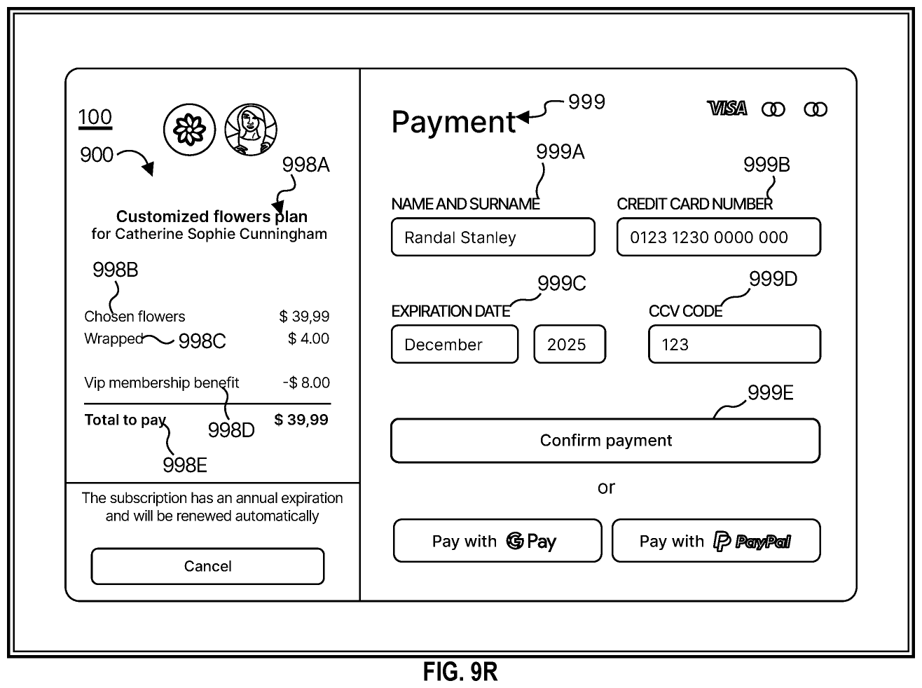

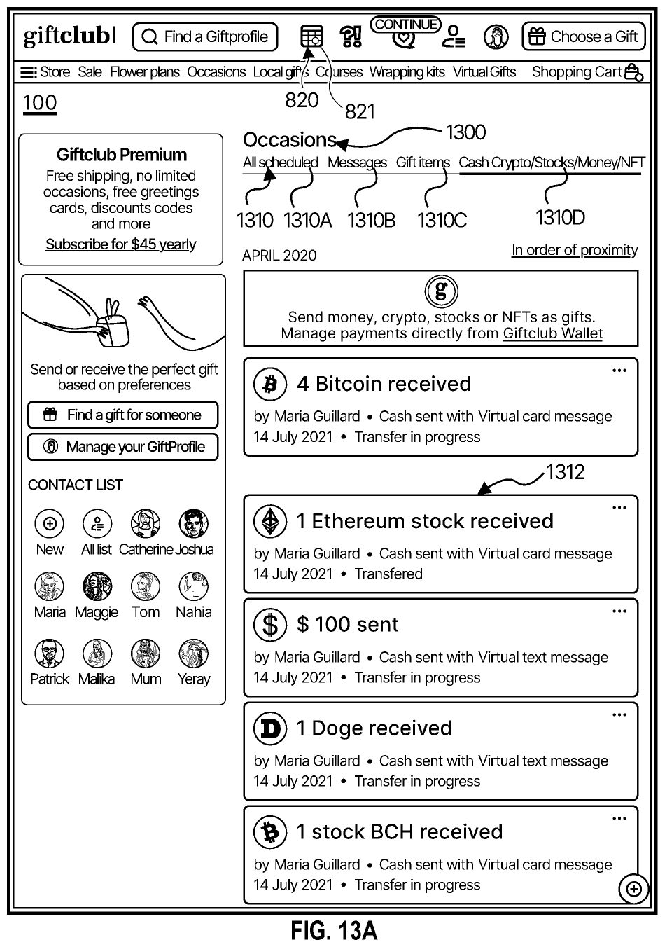

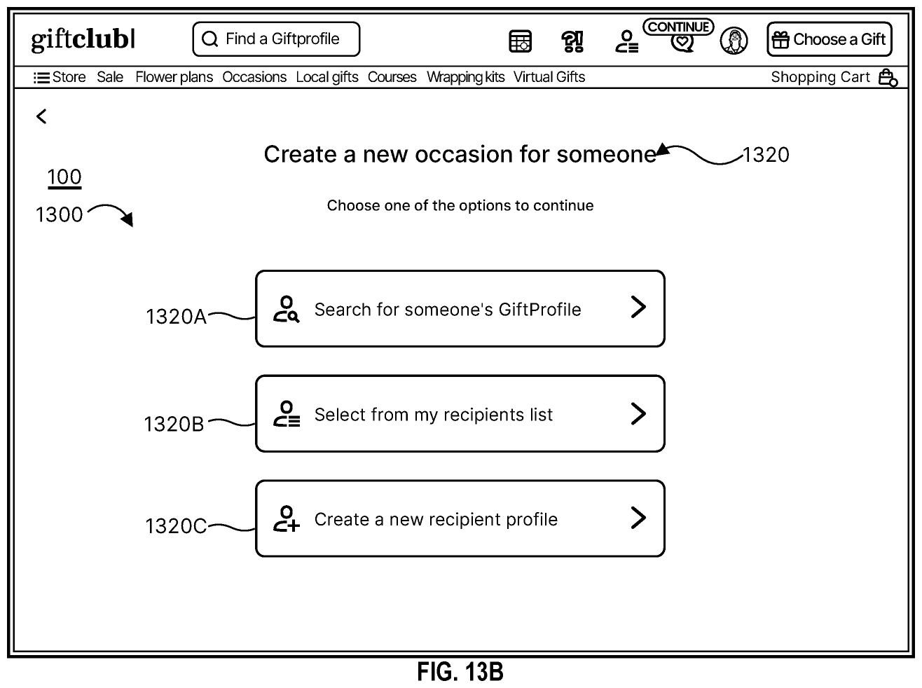

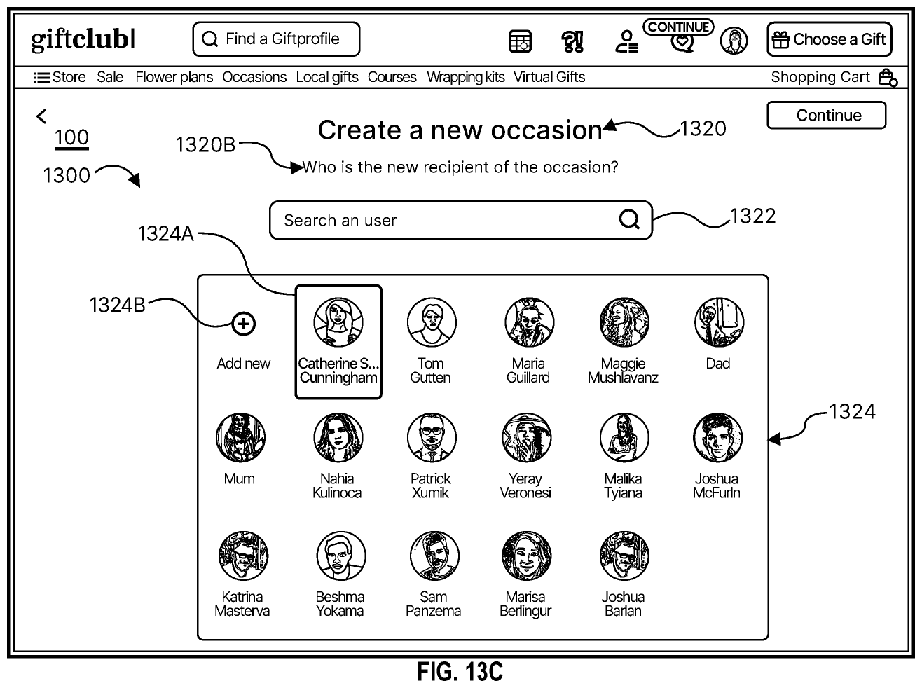

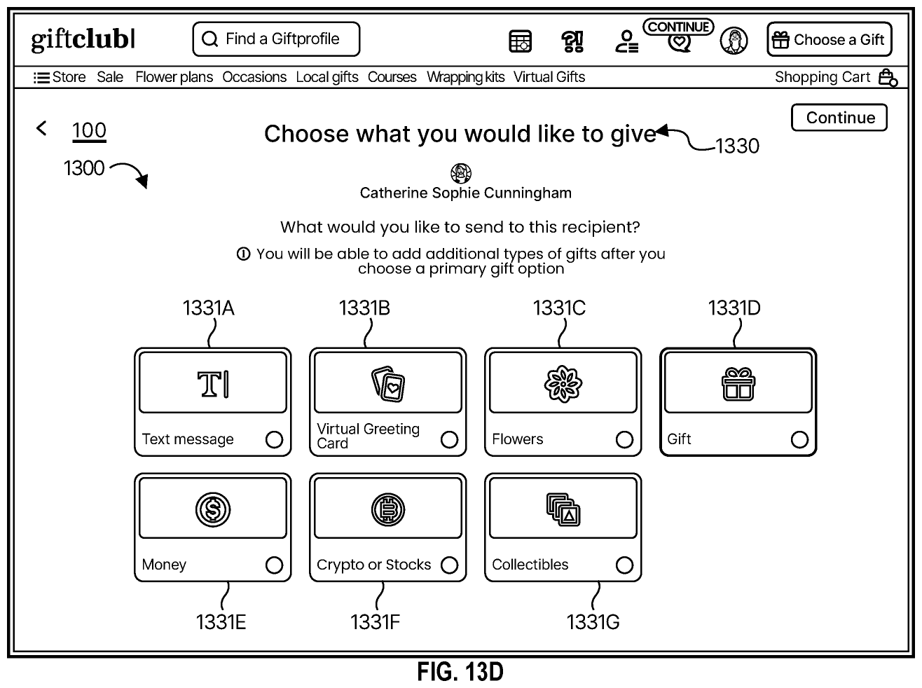

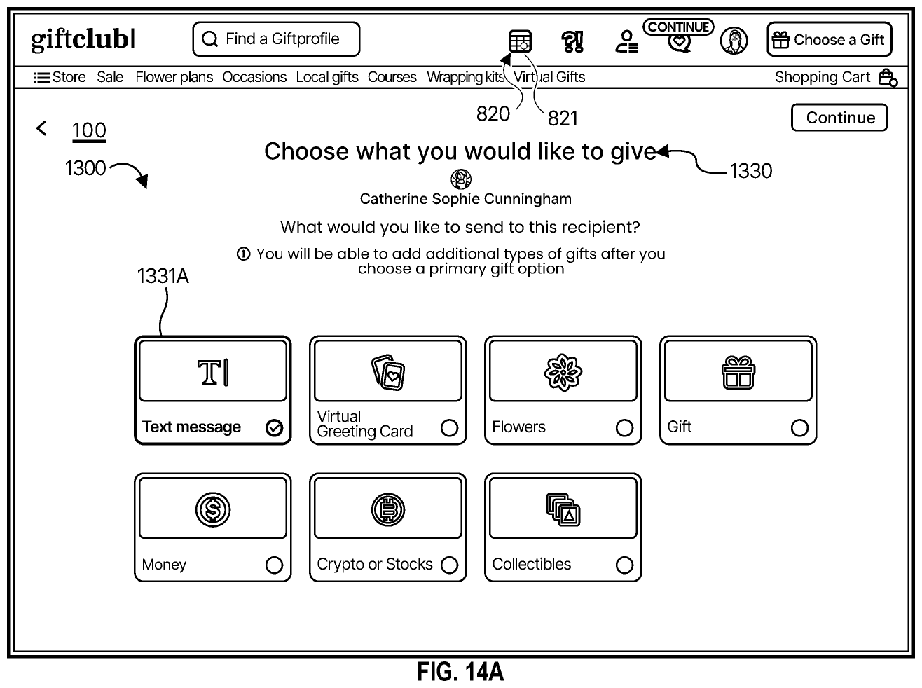

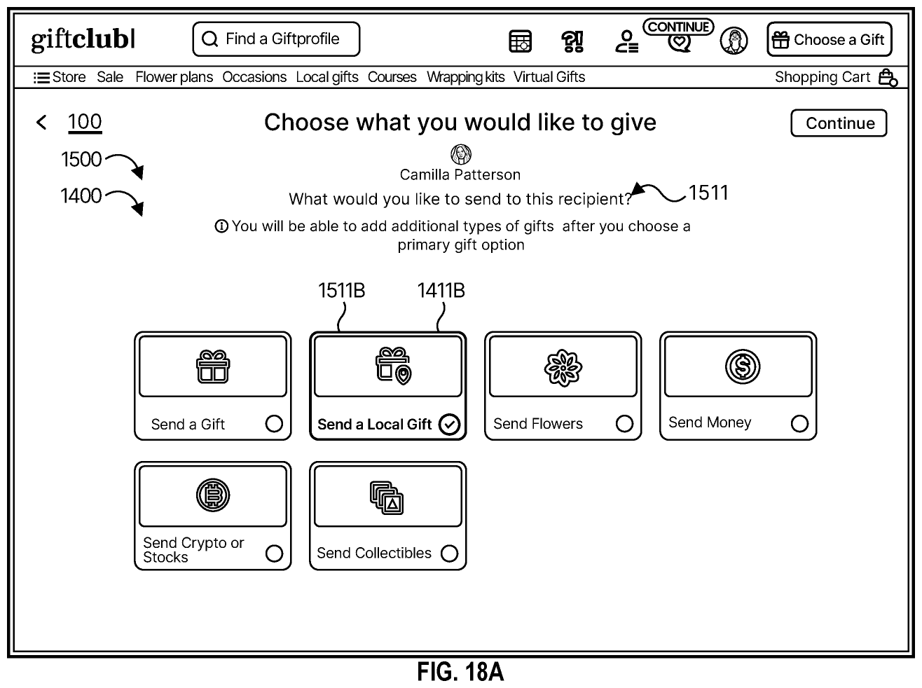

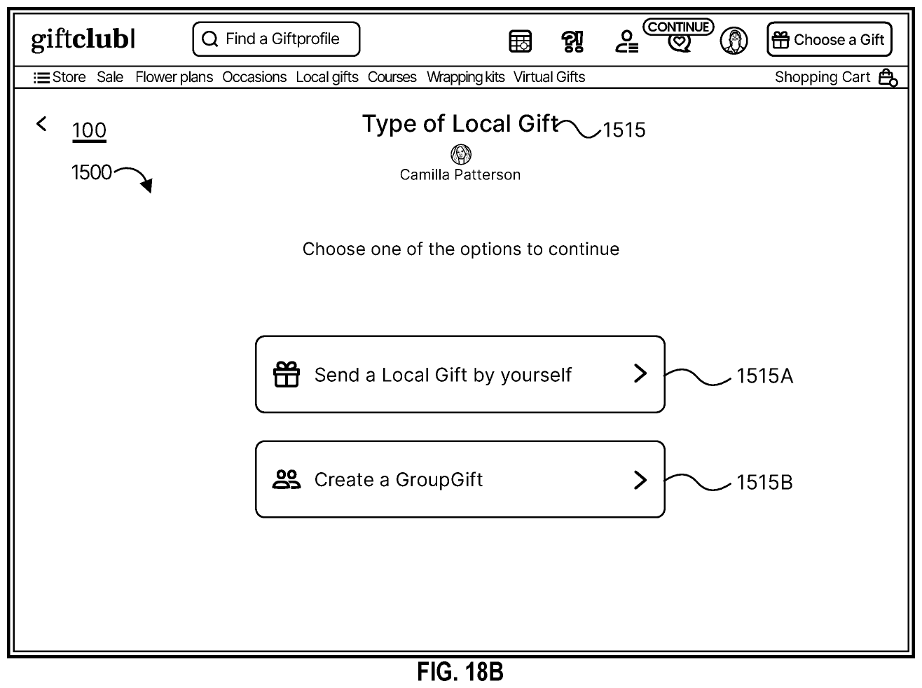

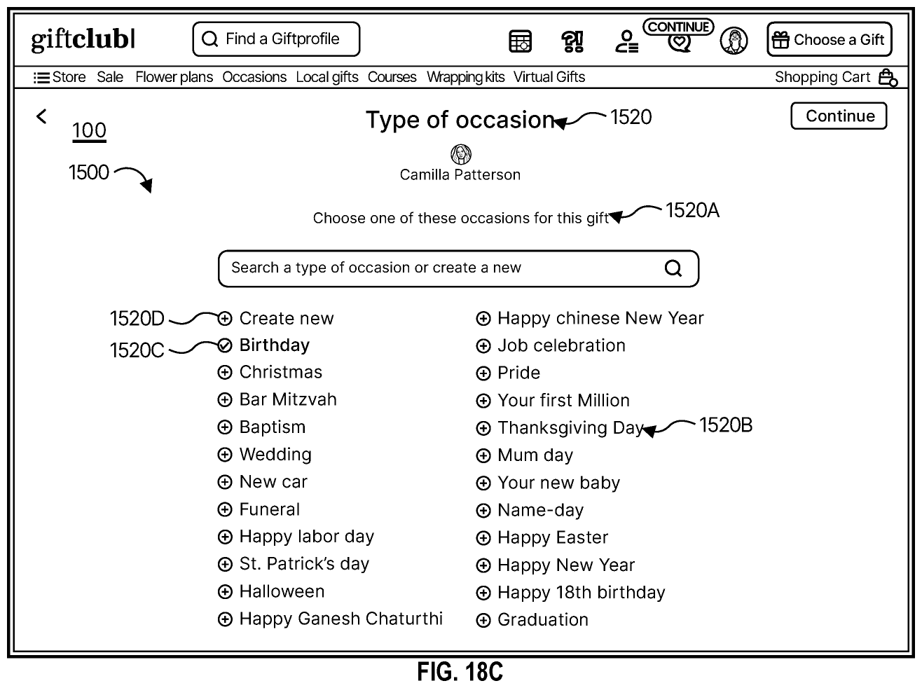

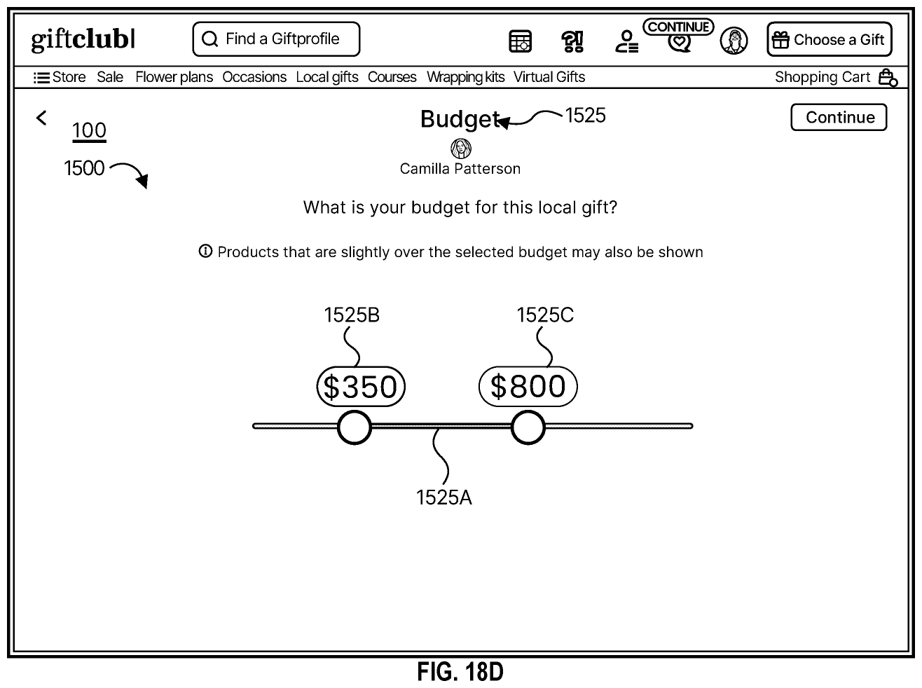

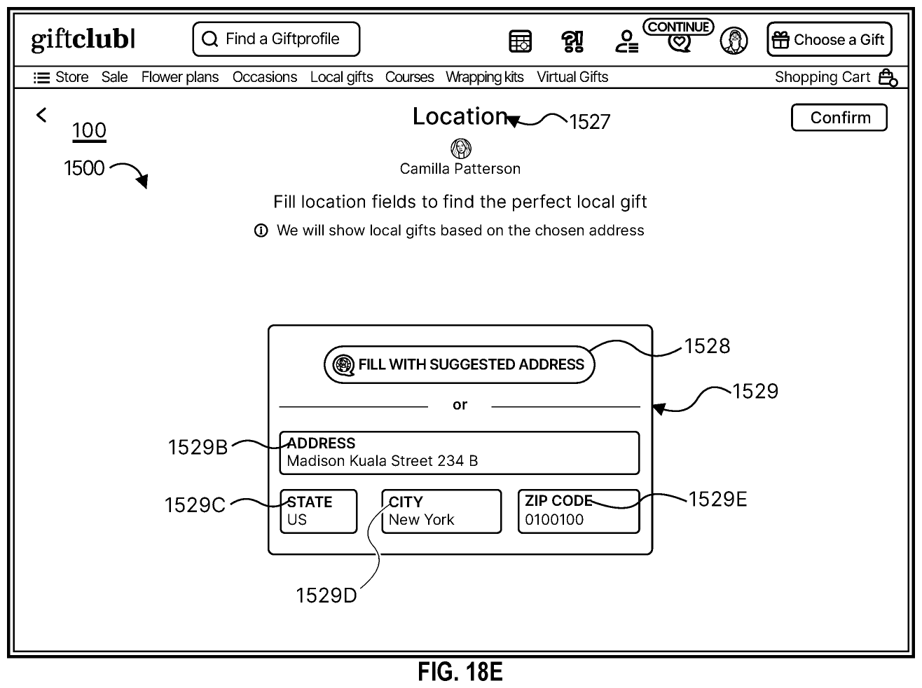

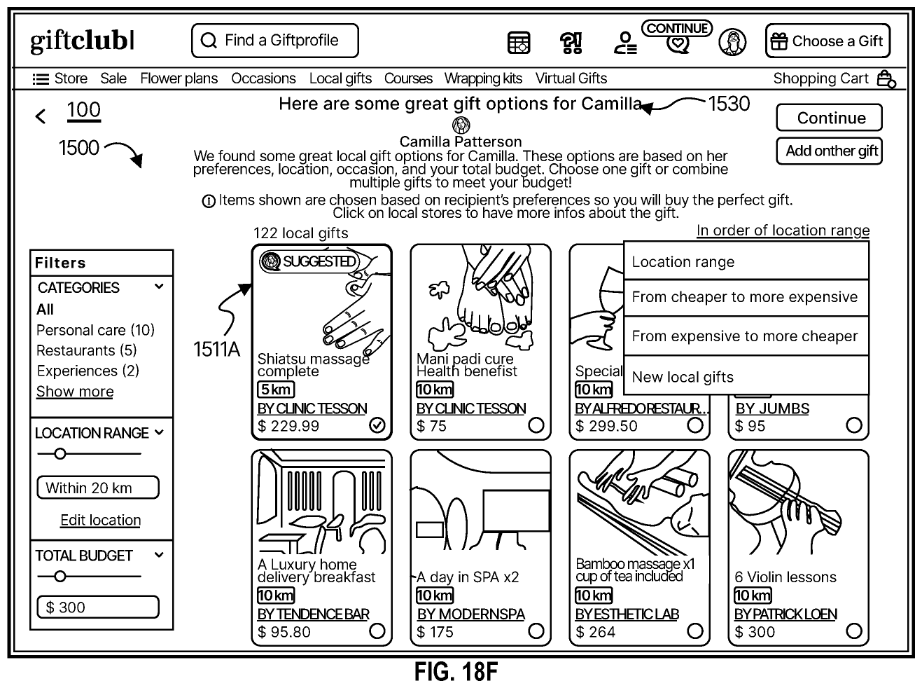

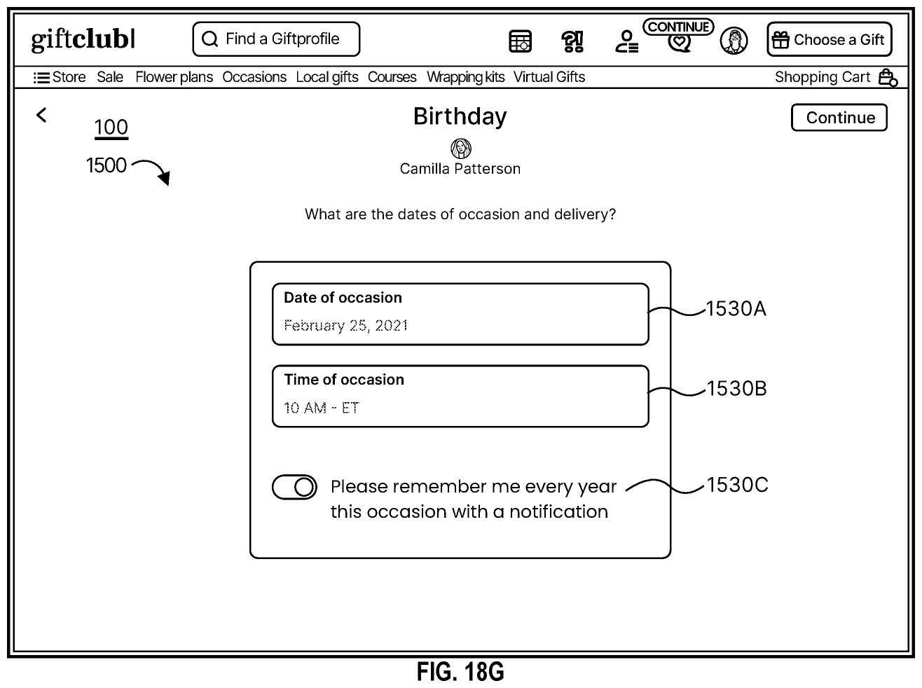

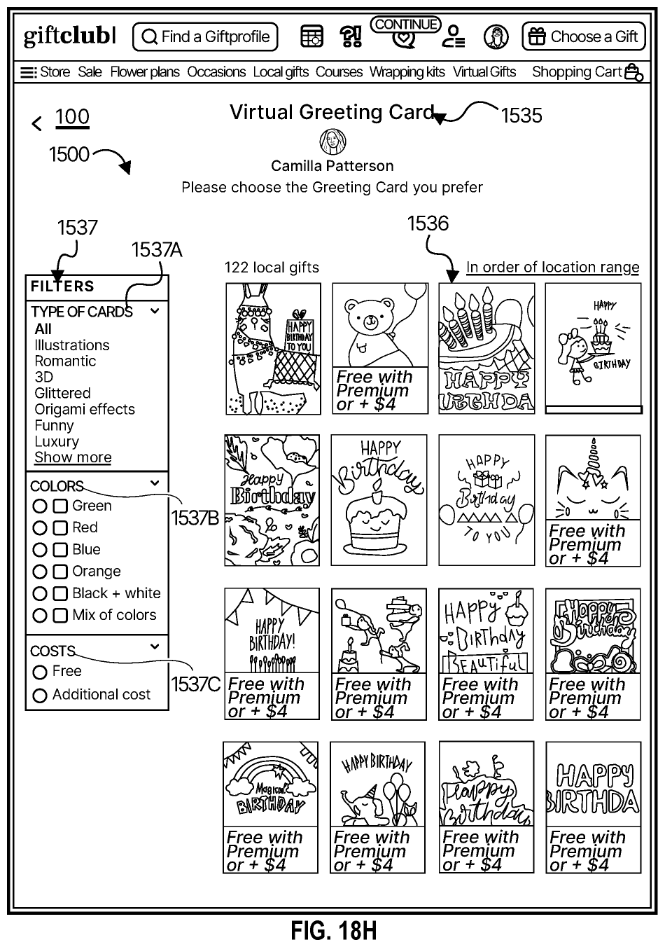

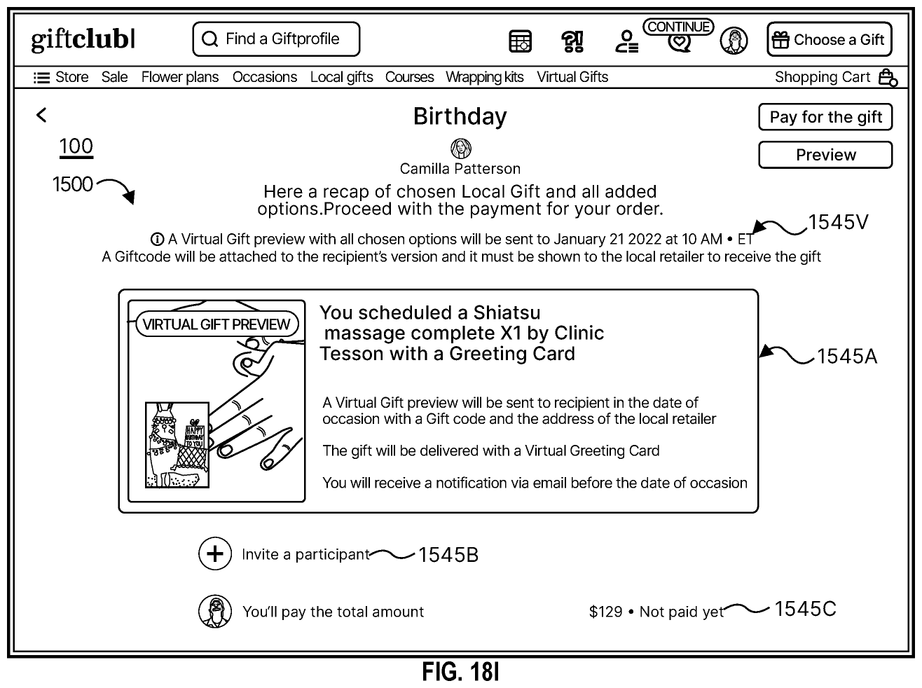

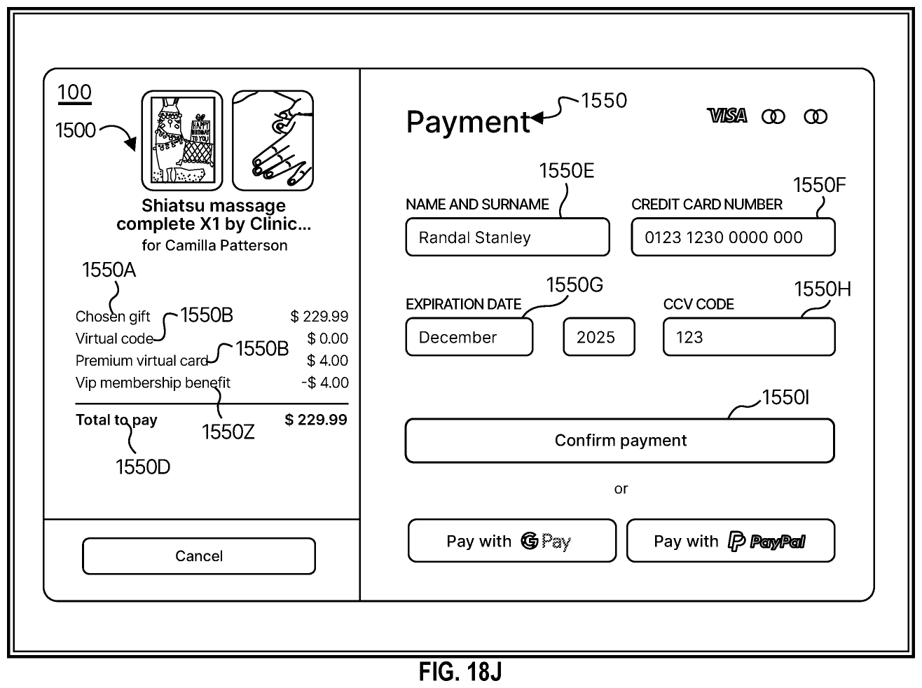

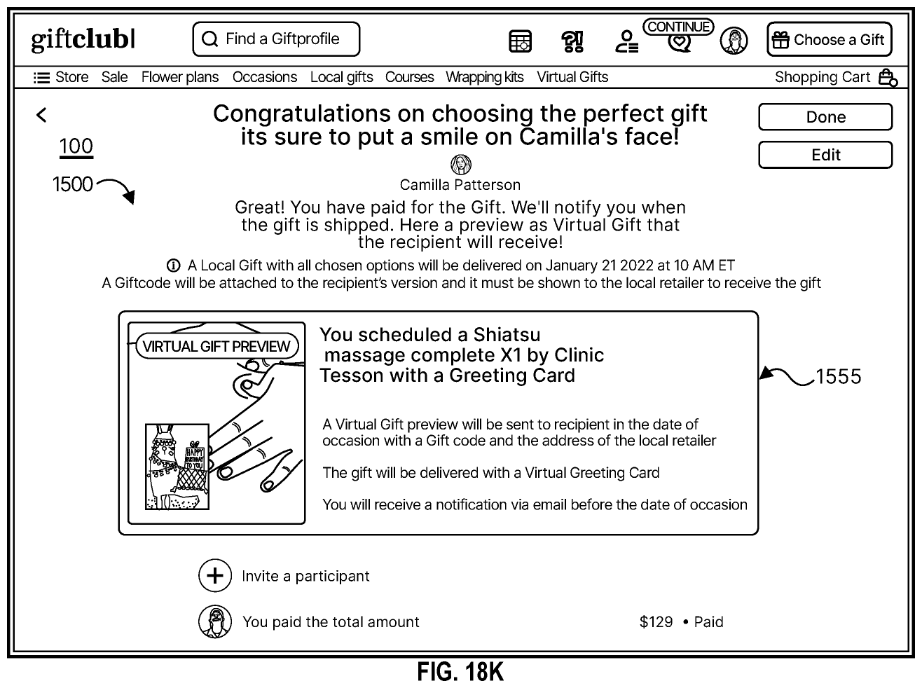

An exemplary home page 800 for the gifting method 100 is illustrated in FIG. 8. Turning to FIG. 8, the home page 800 is shown as including first and second navigation indicia 810, 820, such as tabs, folders and/or icons, for enabling the gifter to navigate the home page 800 and other content available via the gifting method 100. Exemplary first navigation indicia 810 can include, but is not limited to, a store navigation link 811, a flower plan navigation link 812, an occasions navigation link 813, a local gifts navigation link 814 and/or a virtual gift link 815. Activation of the store navigation link 811 can enable the gifter to view one or more products and/or services available via the gifting method 100. The gifter thereby can selected at least one of product and/or service to add to the gifter profile of the gifter and/or to send to a selected recipient as a gift. The flower plan navigation link 812 can permit the gifter to visit a flower plan page 900 in the manner described herein with reference to FIGS. 9A-R, the occasions navigation link 813 can enable the gifter to visit an occasions page 1300 in the manner described herein with reference to FIGS. 13A-D, and the local gifts navigation link 814 can permit the gifter to visit a local gifts page 1500 in the manner described herein with reference to FIGS. 18A-K.

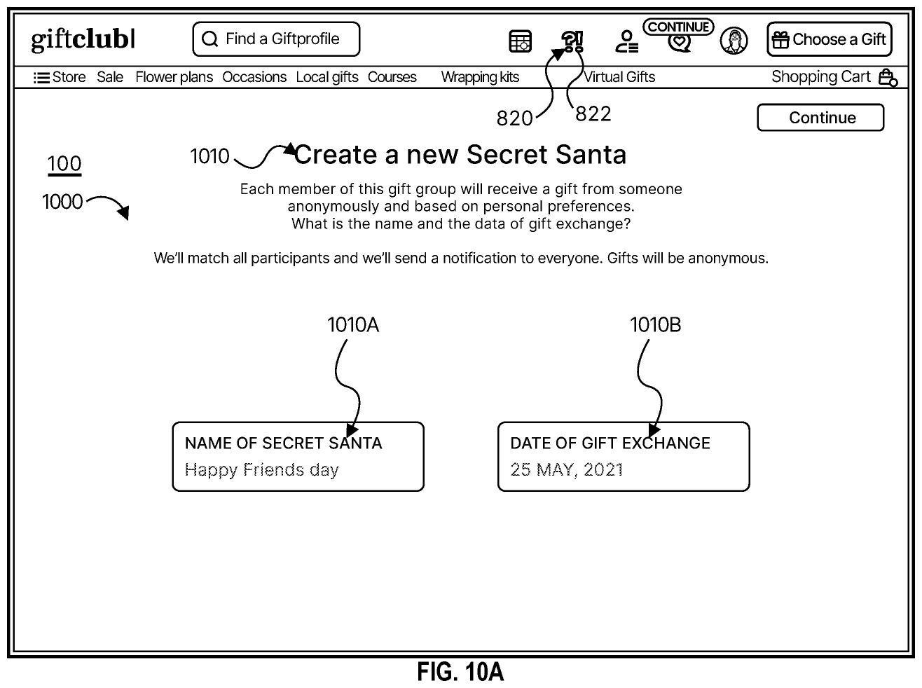

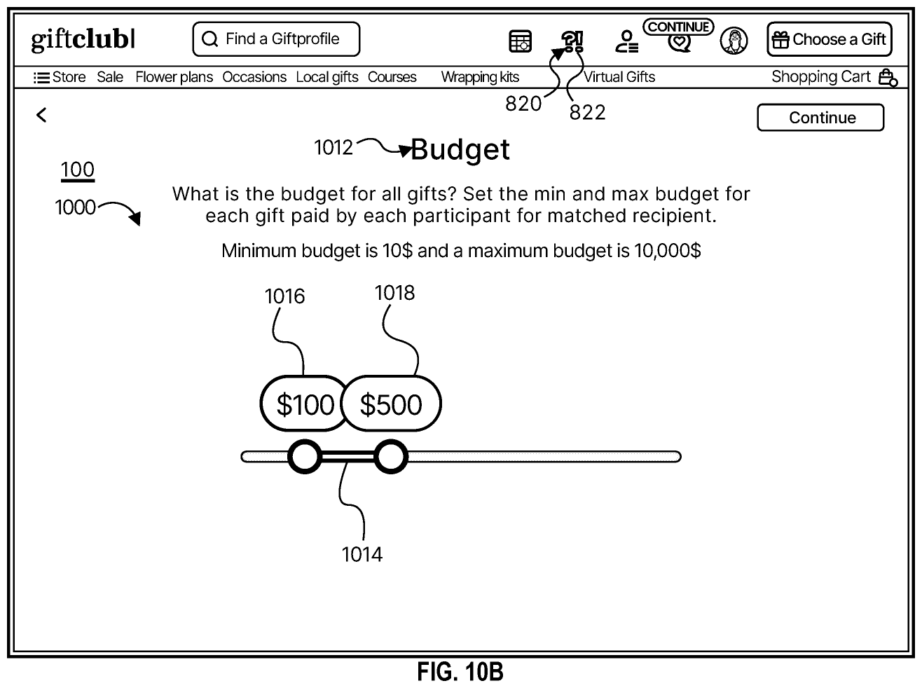

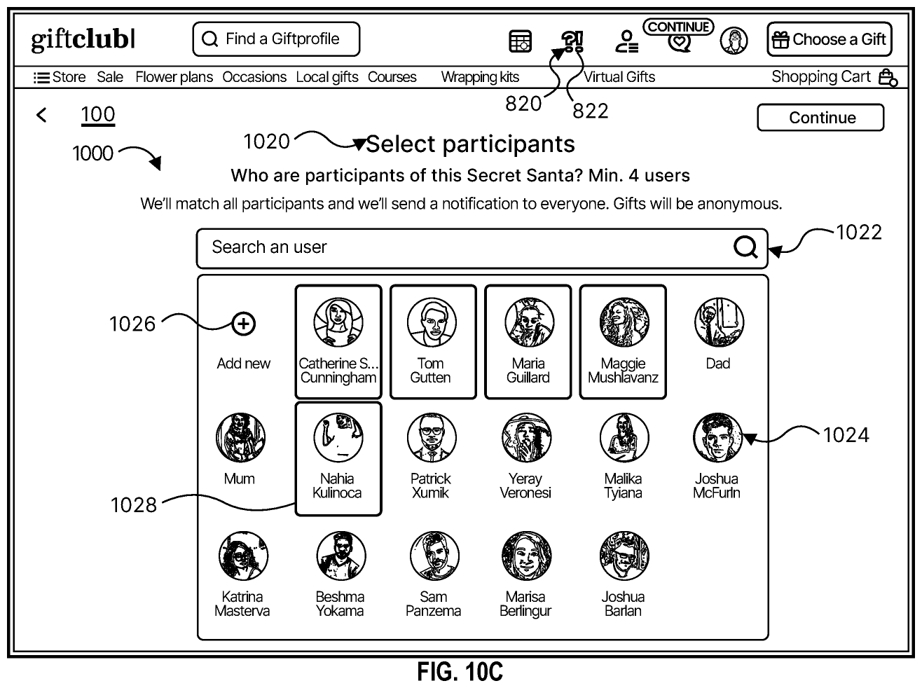

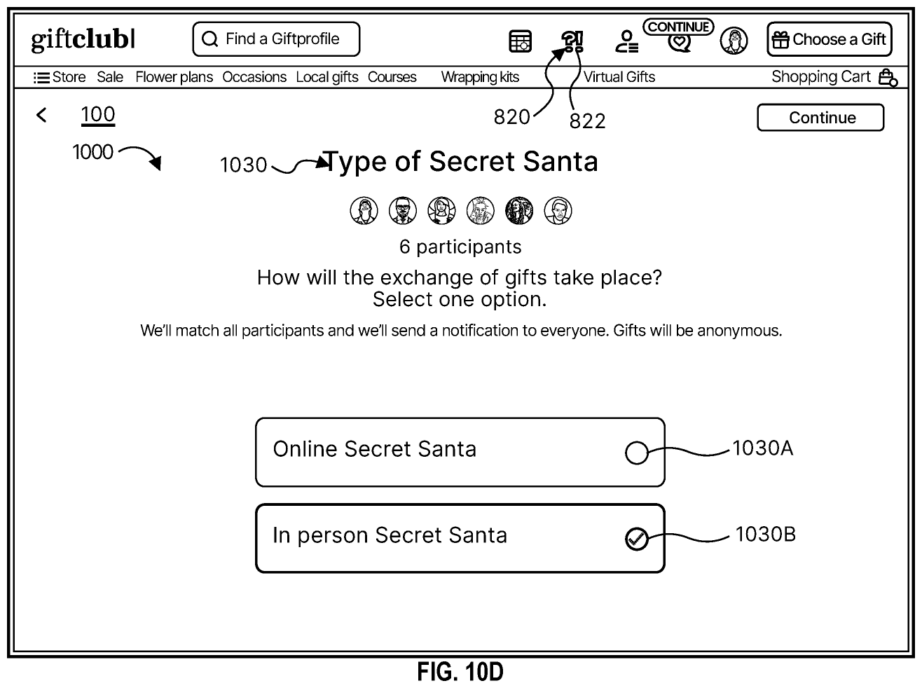

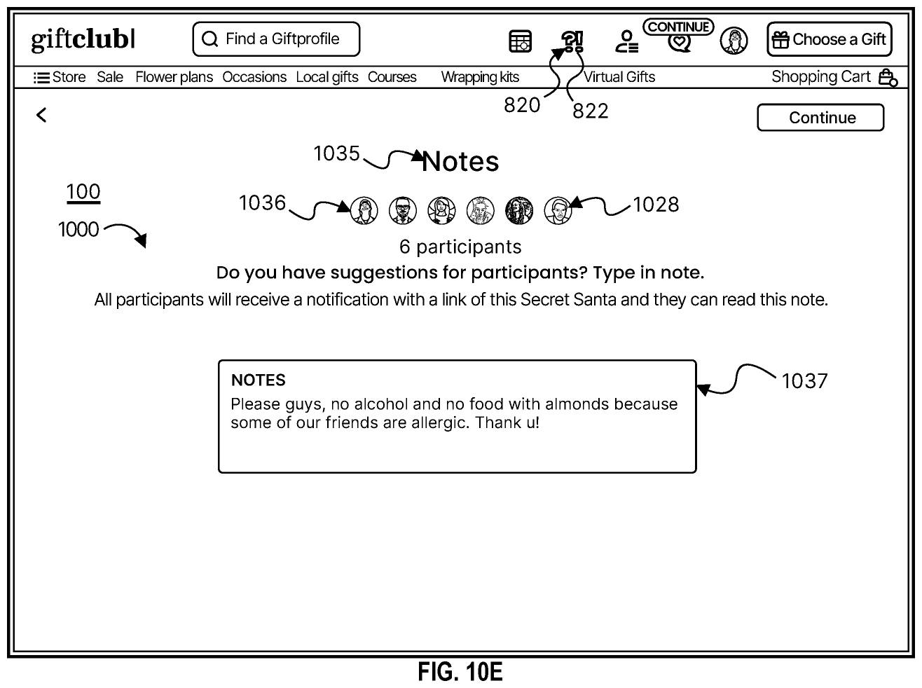

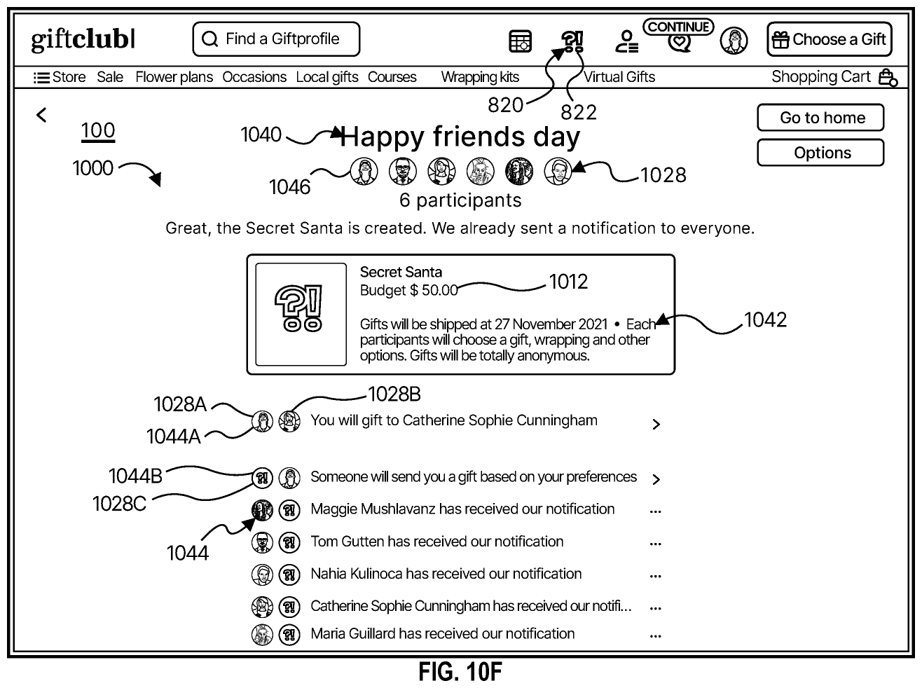

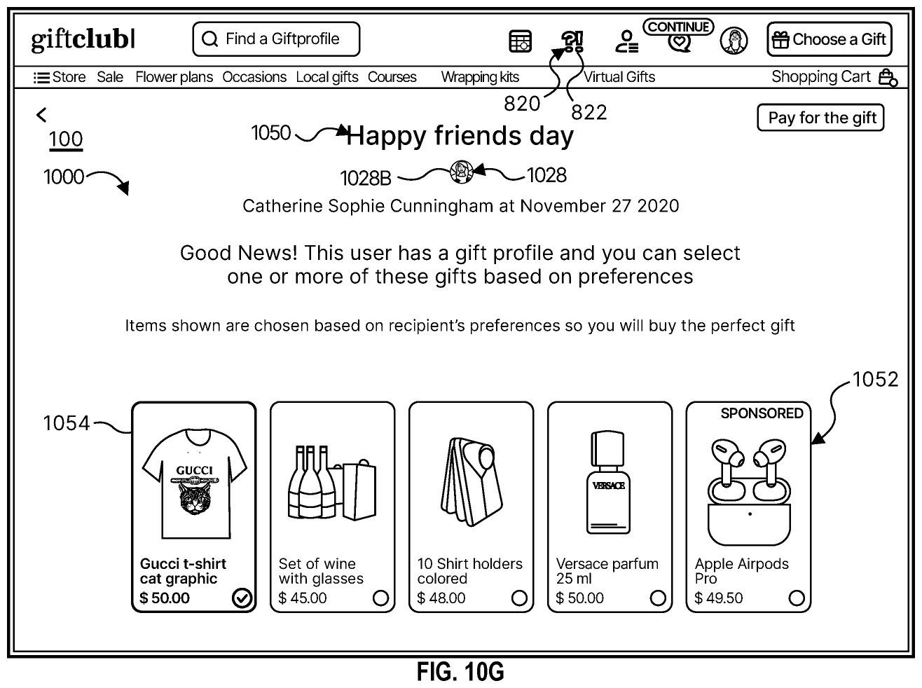

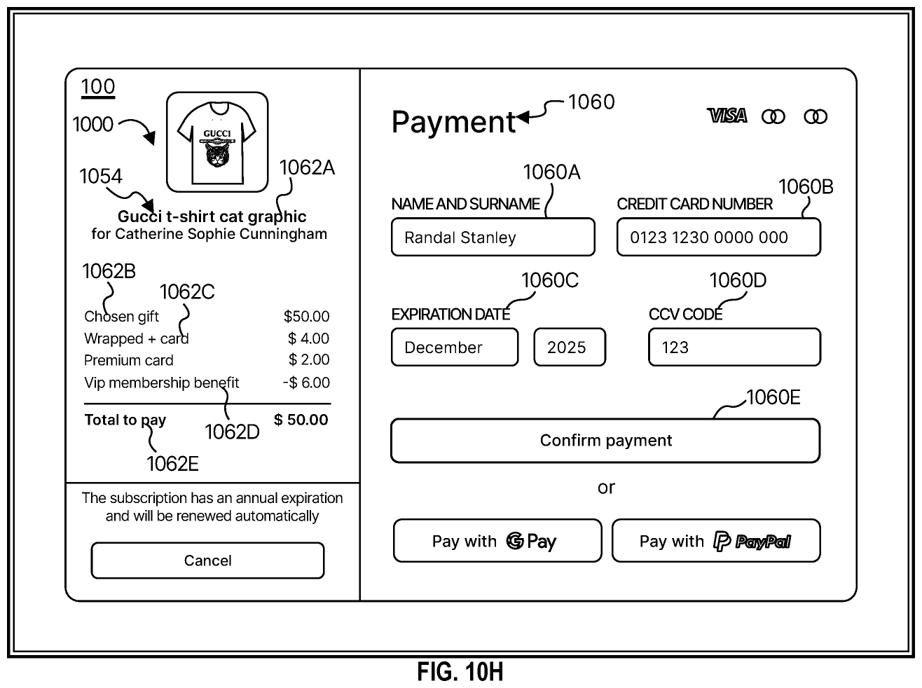

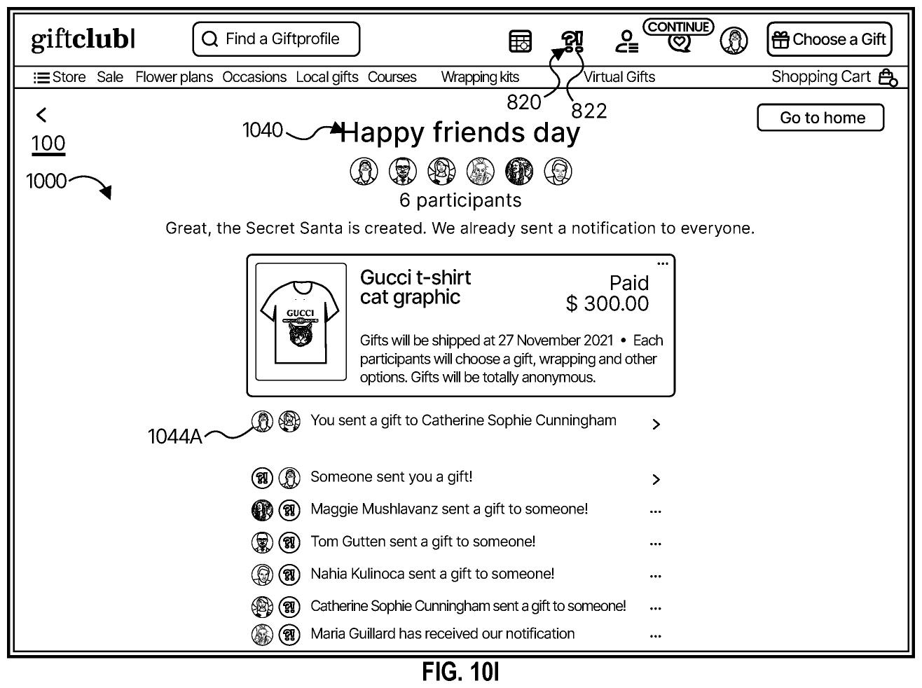

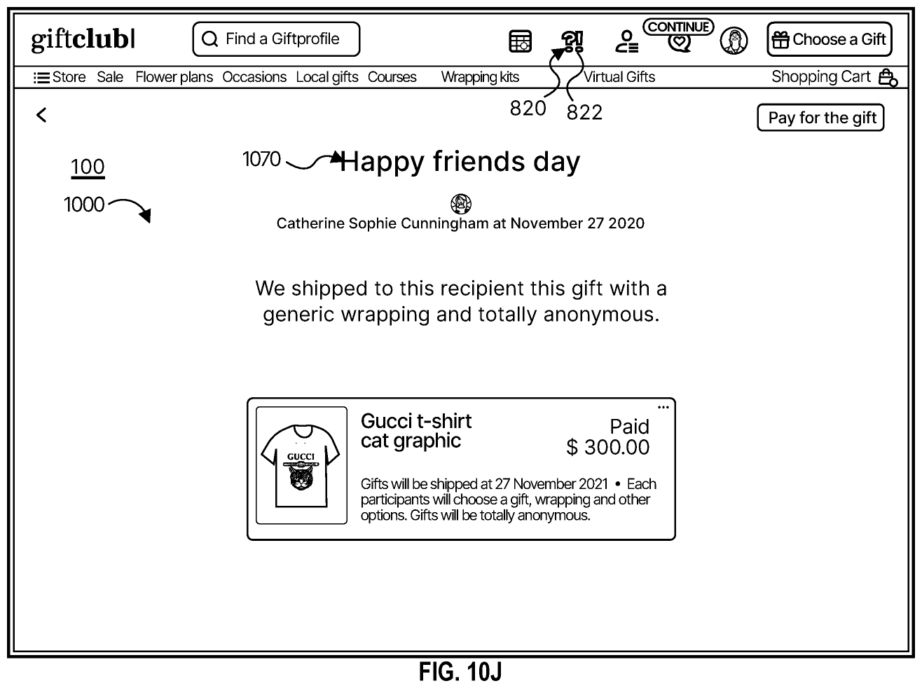

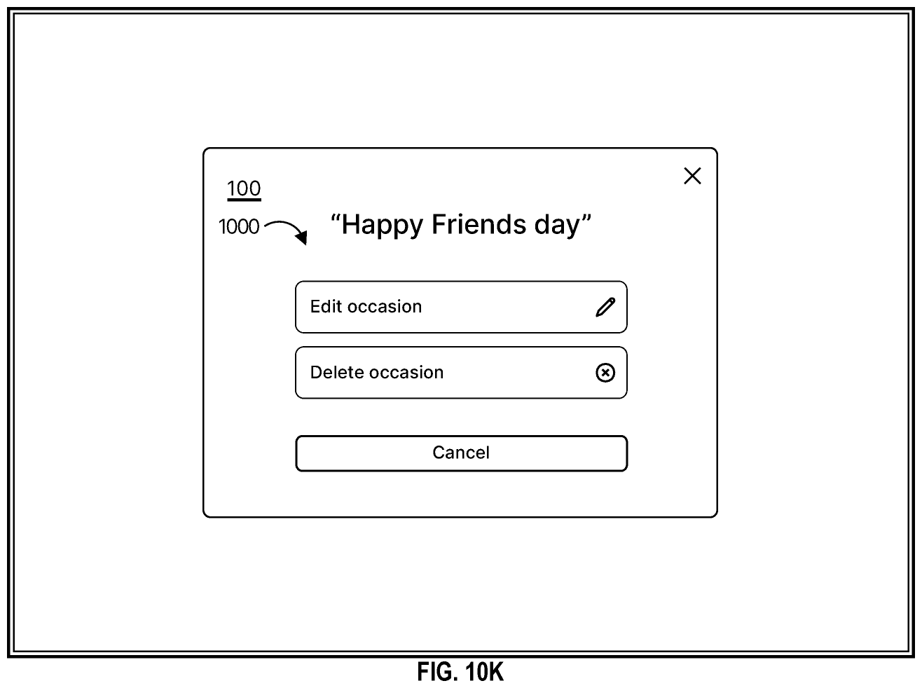

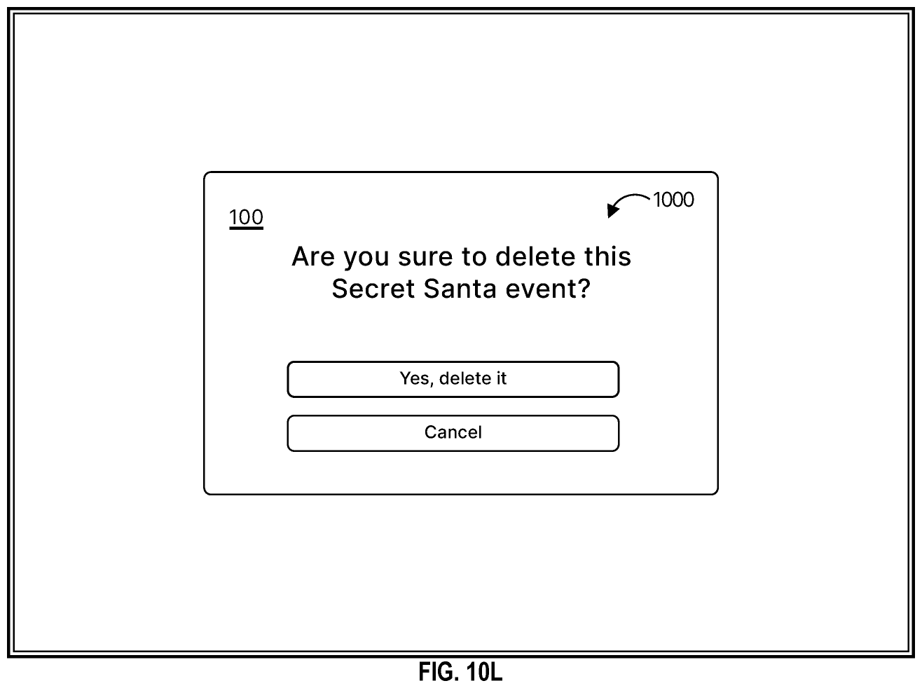

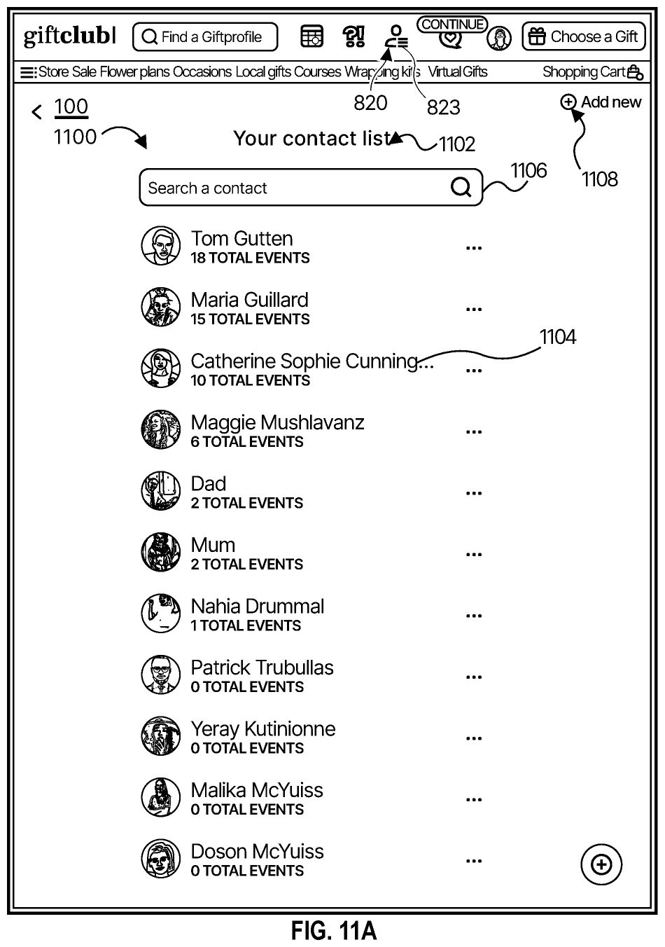

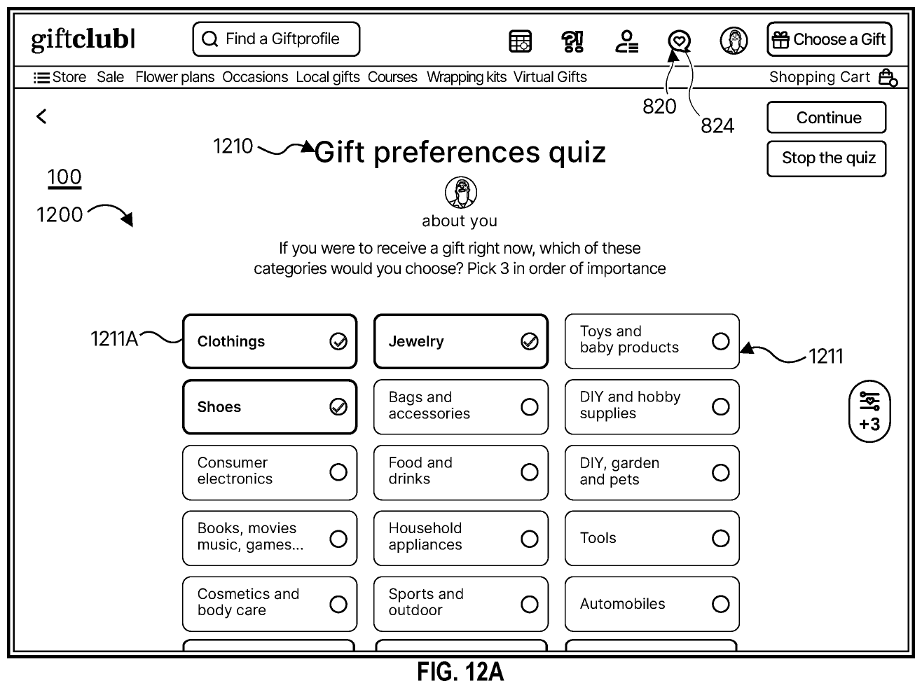

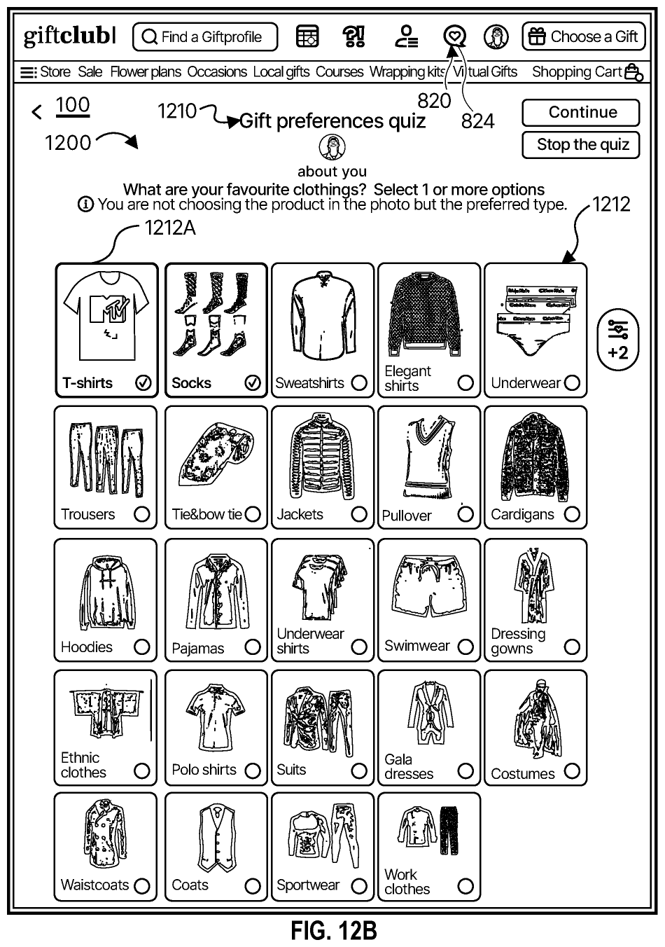

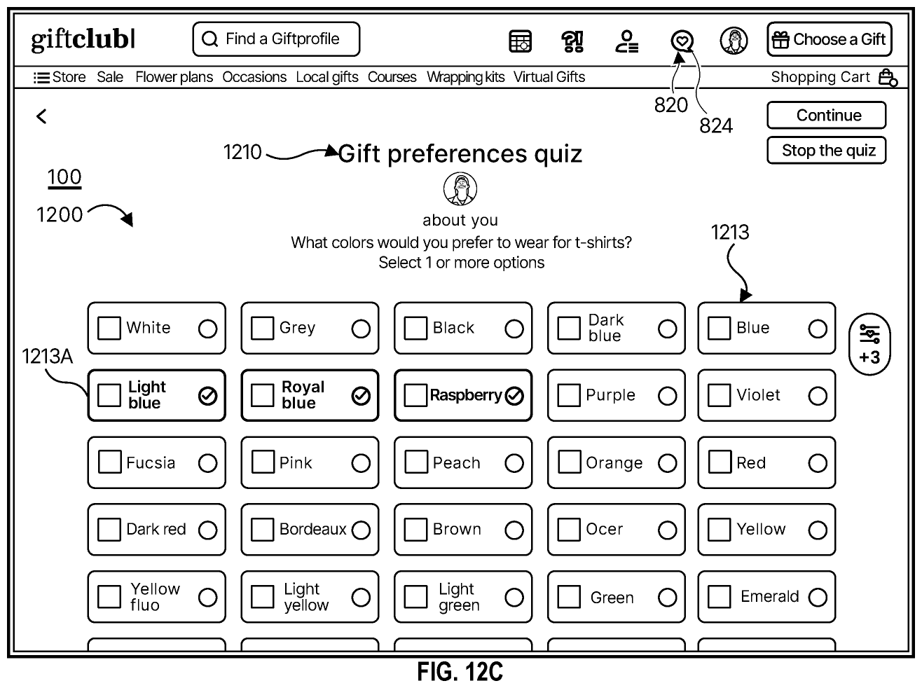

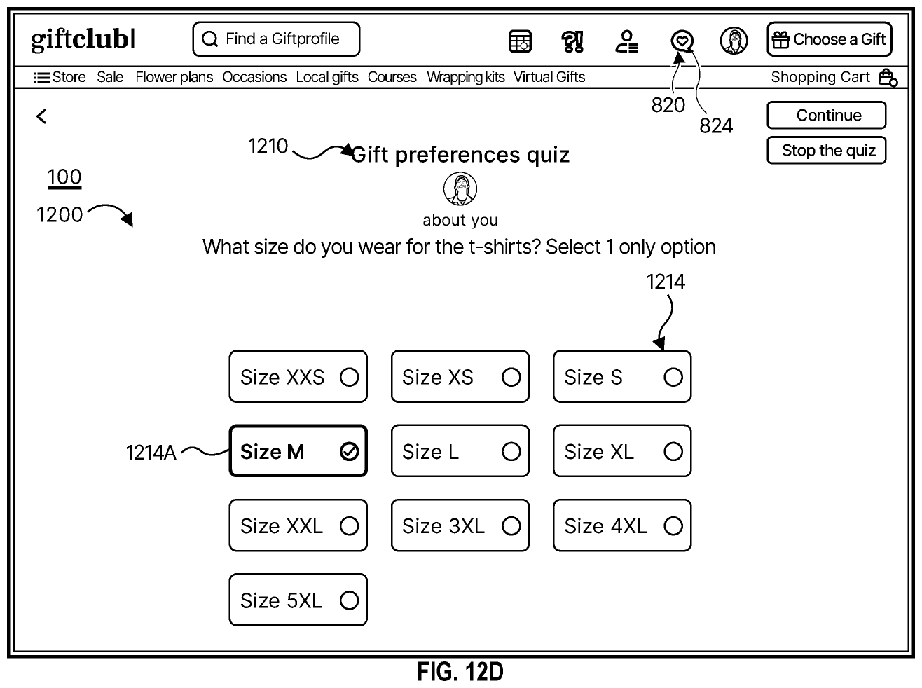

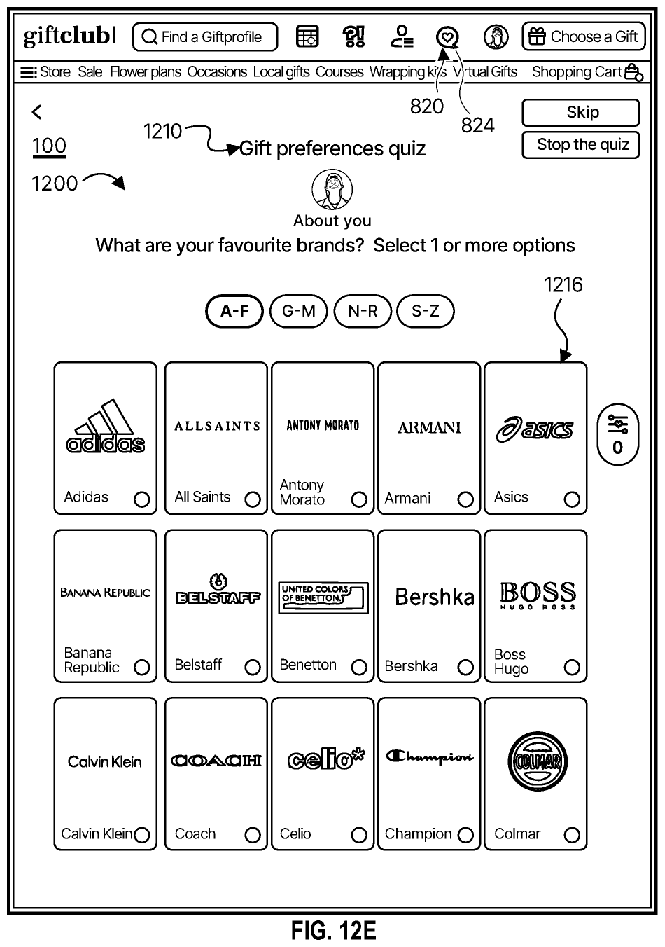

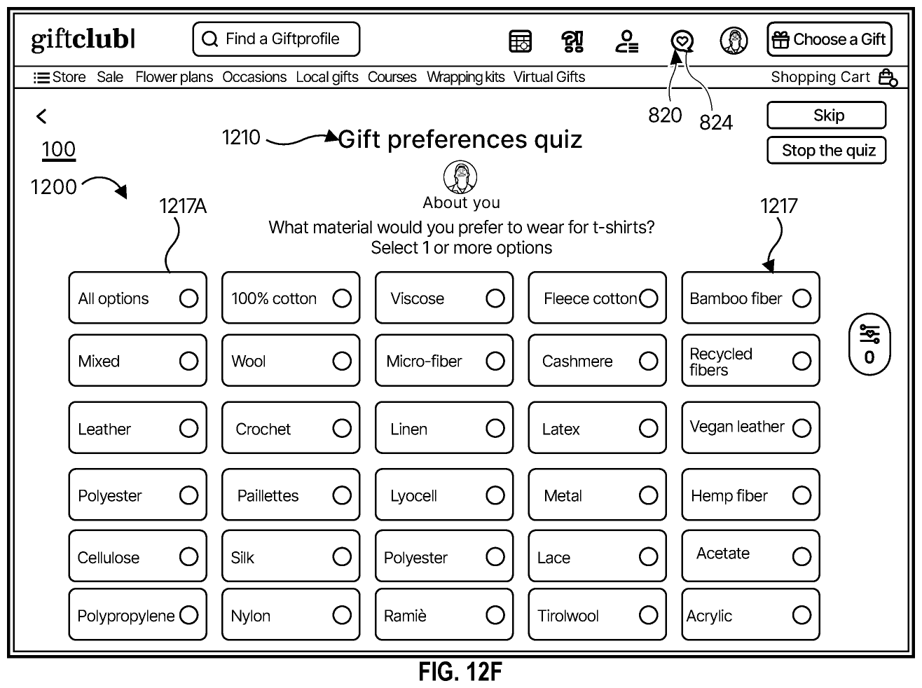

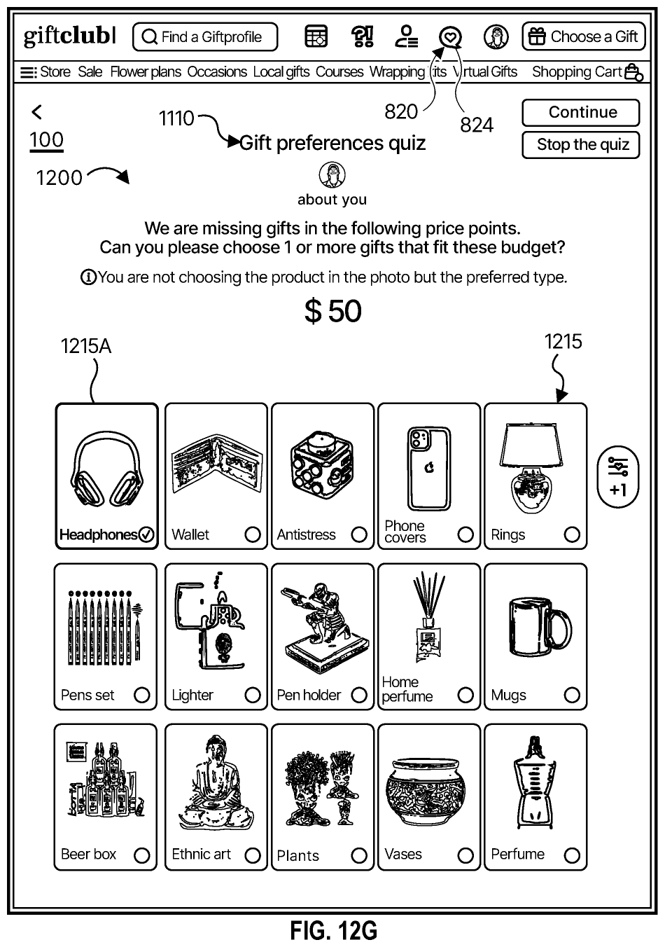

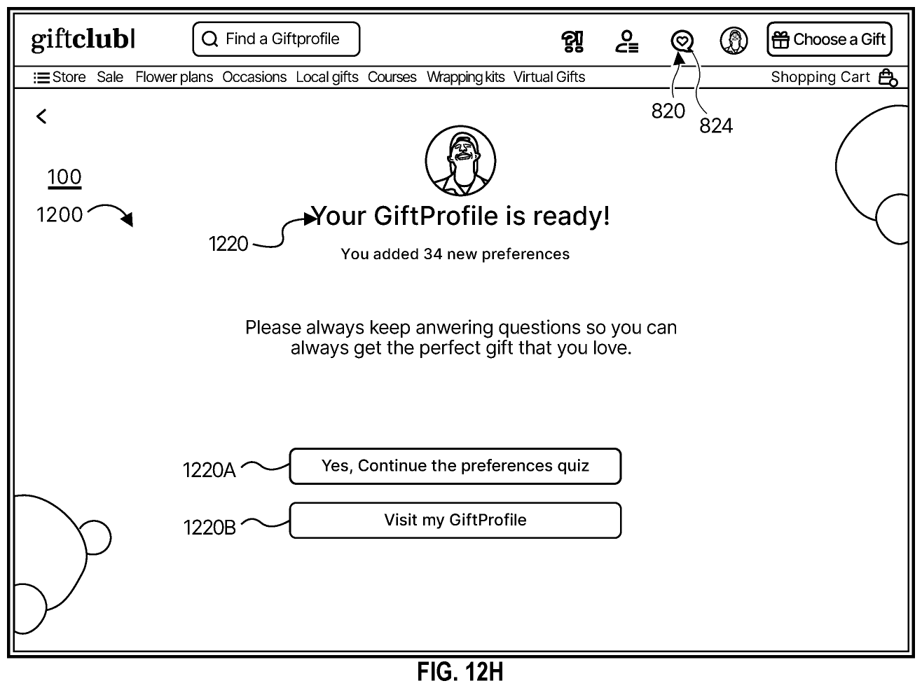

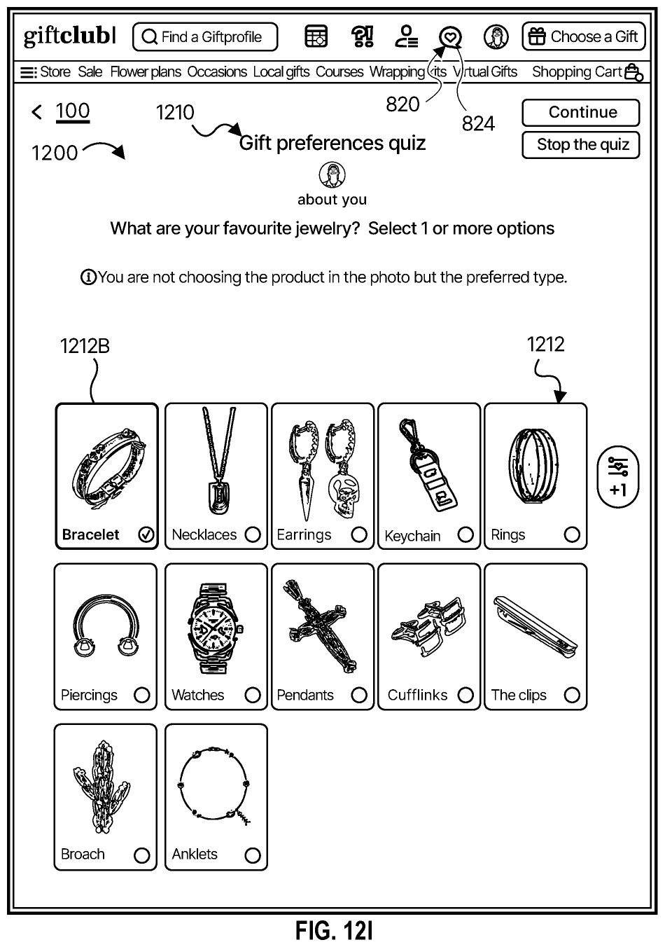

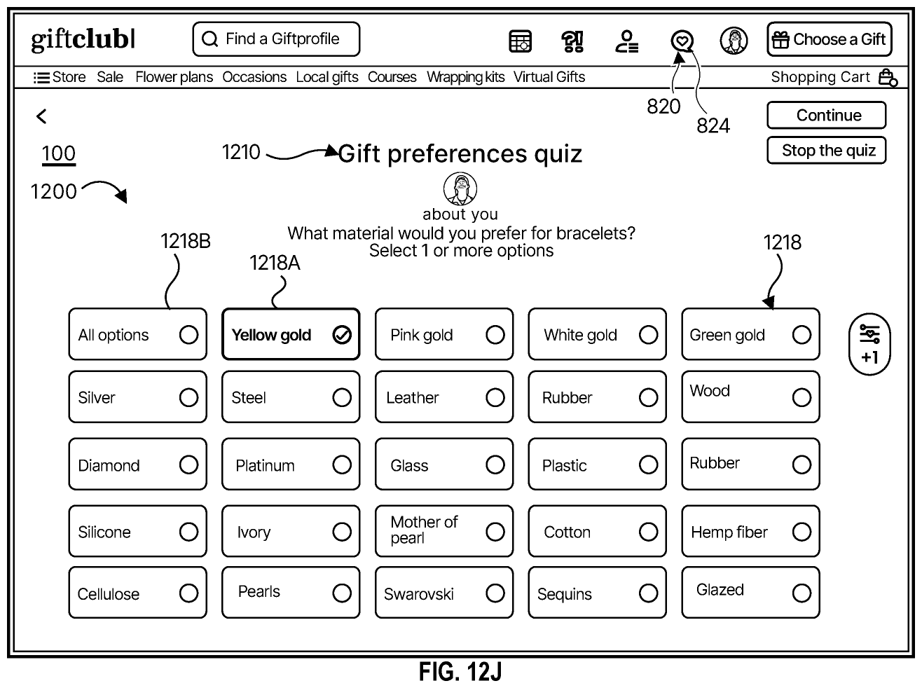

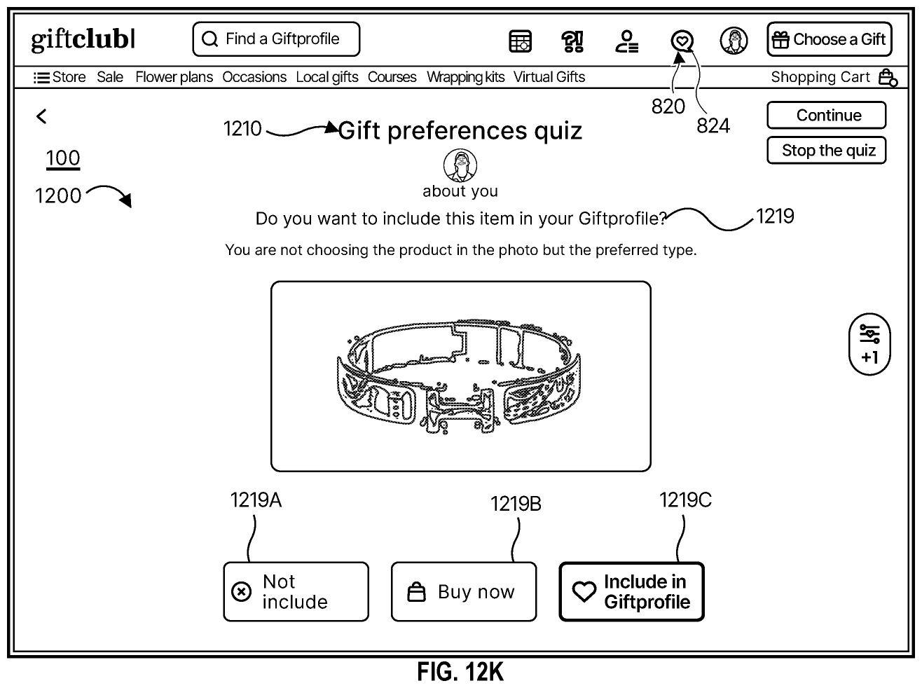

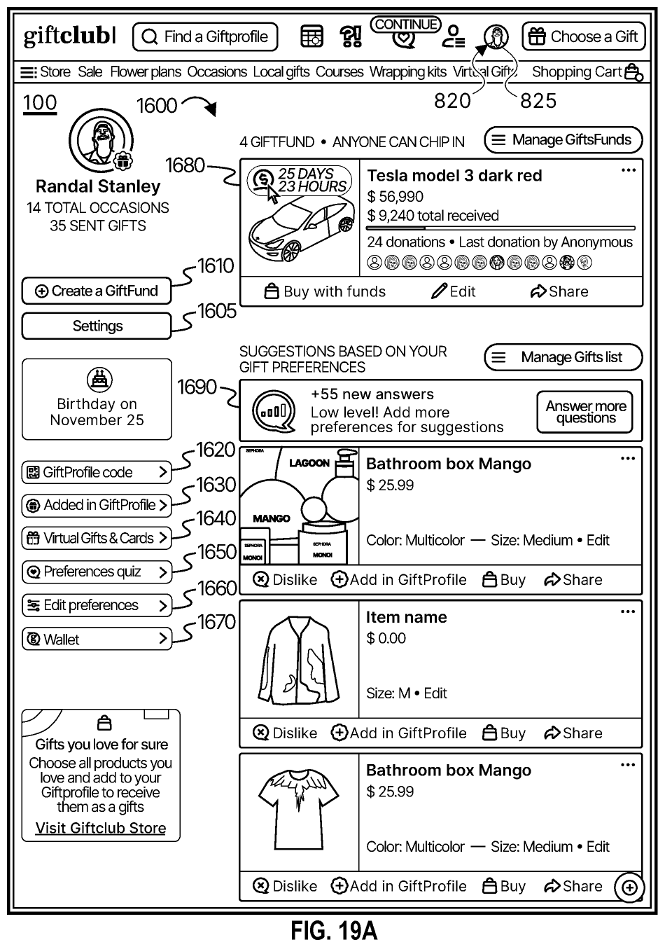

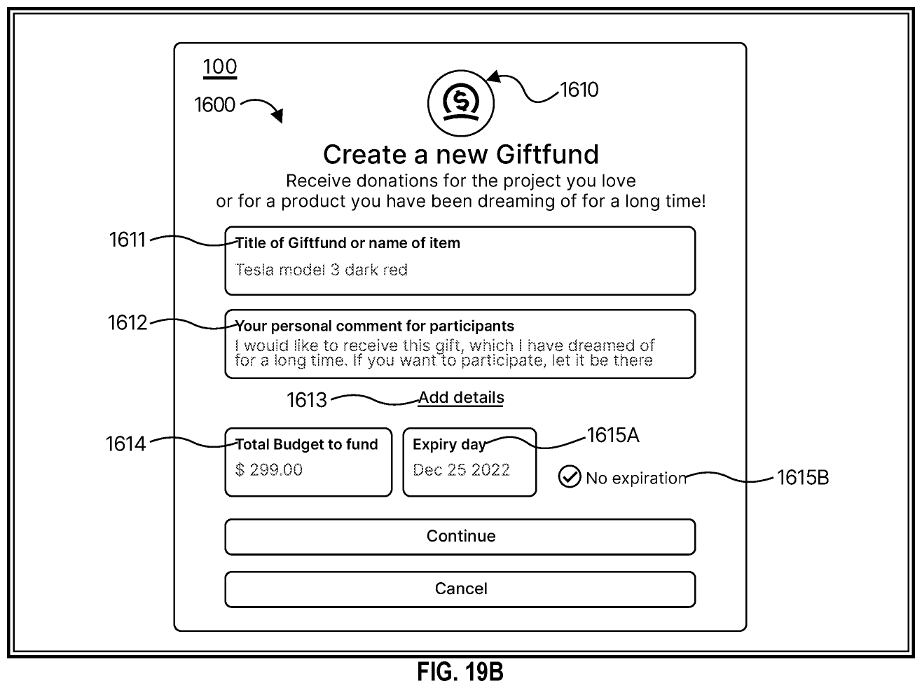

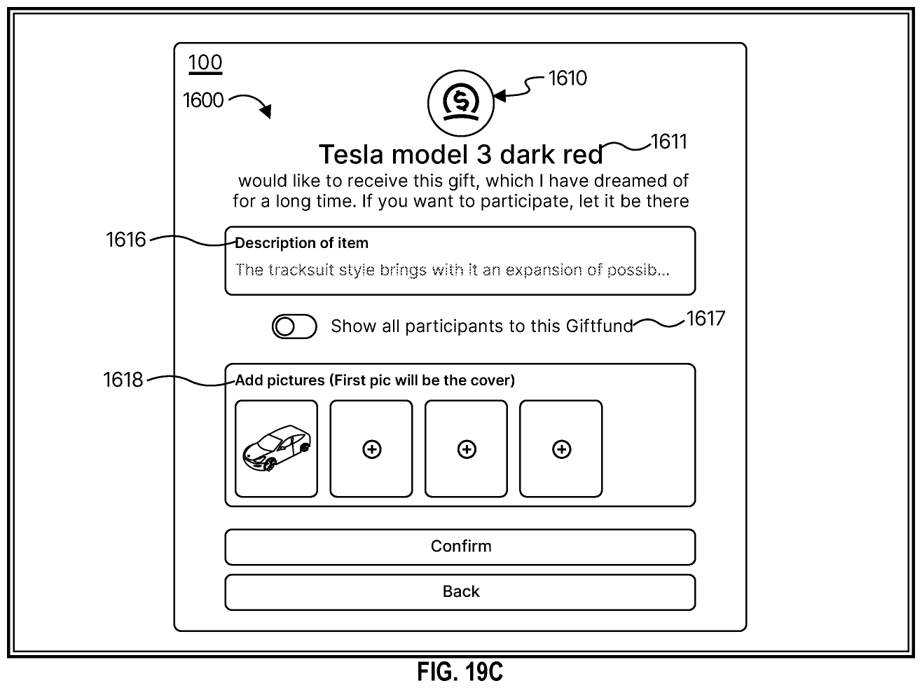

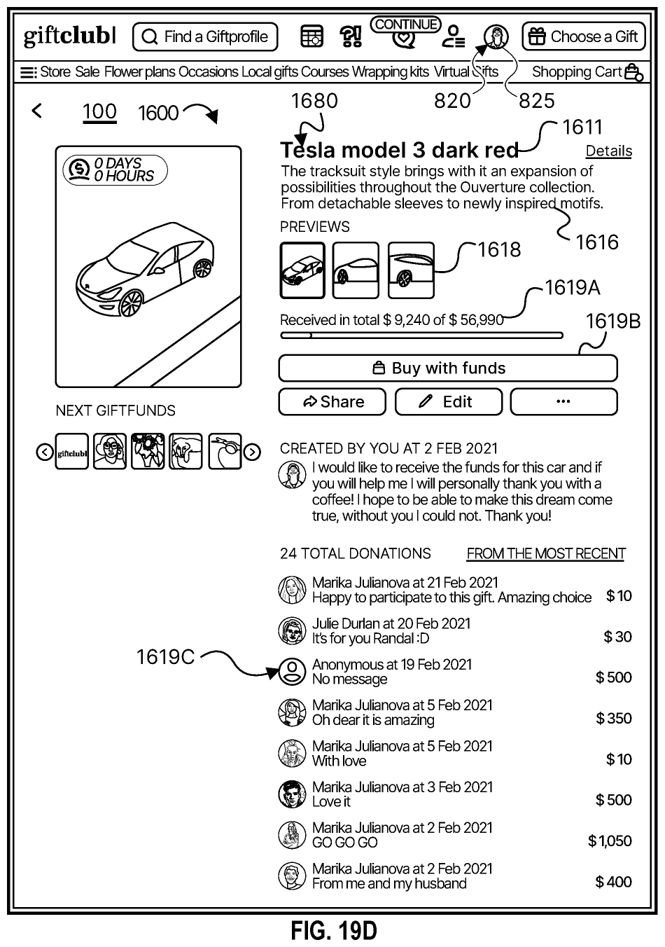

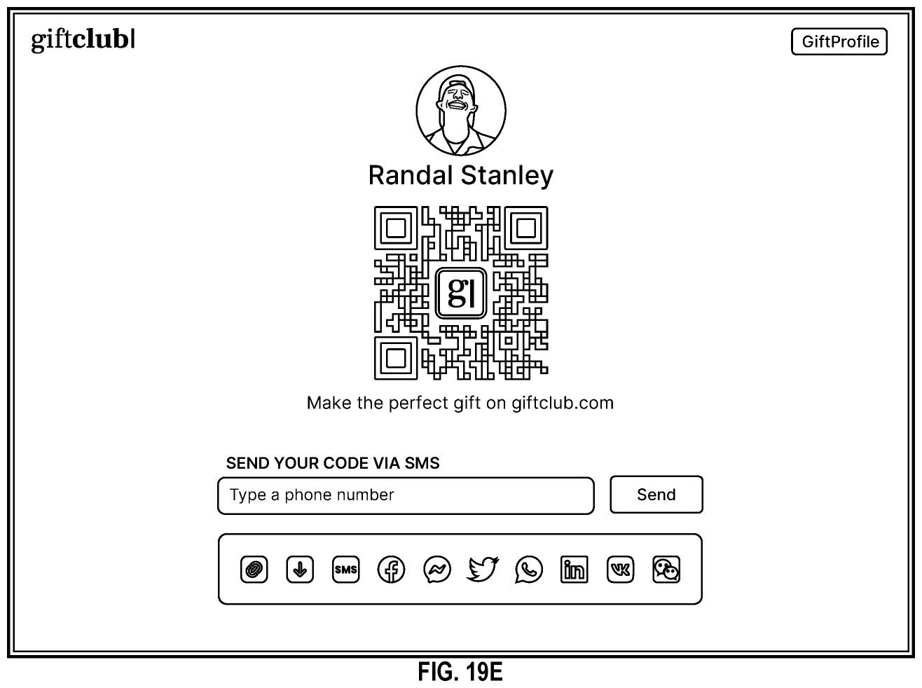

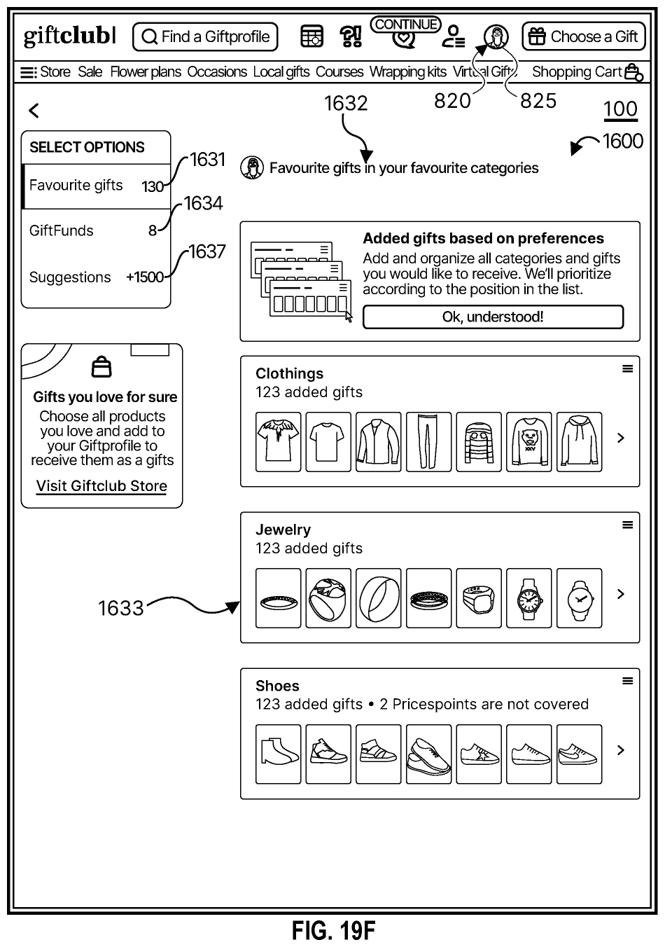

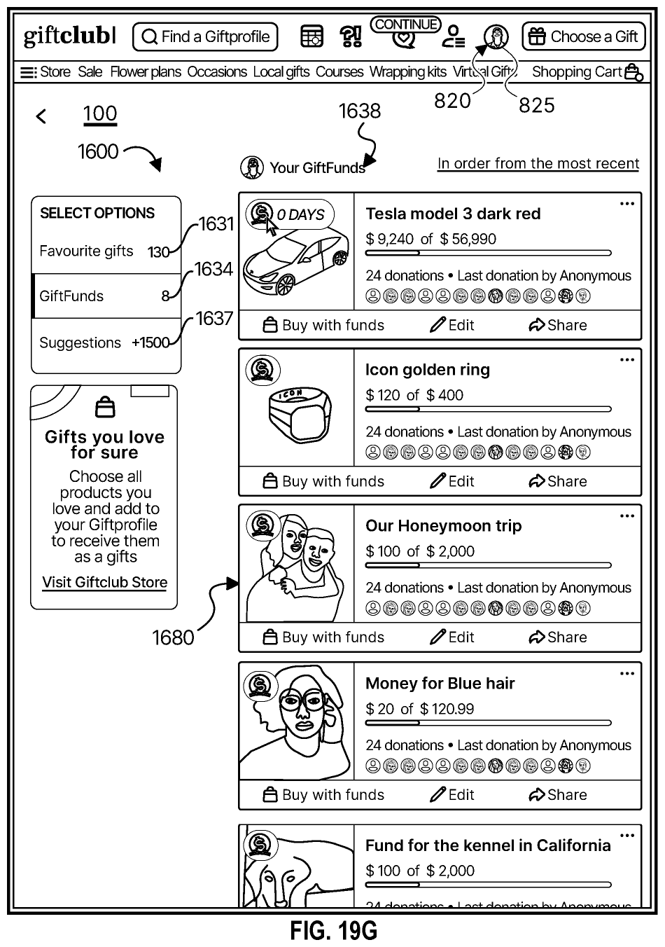

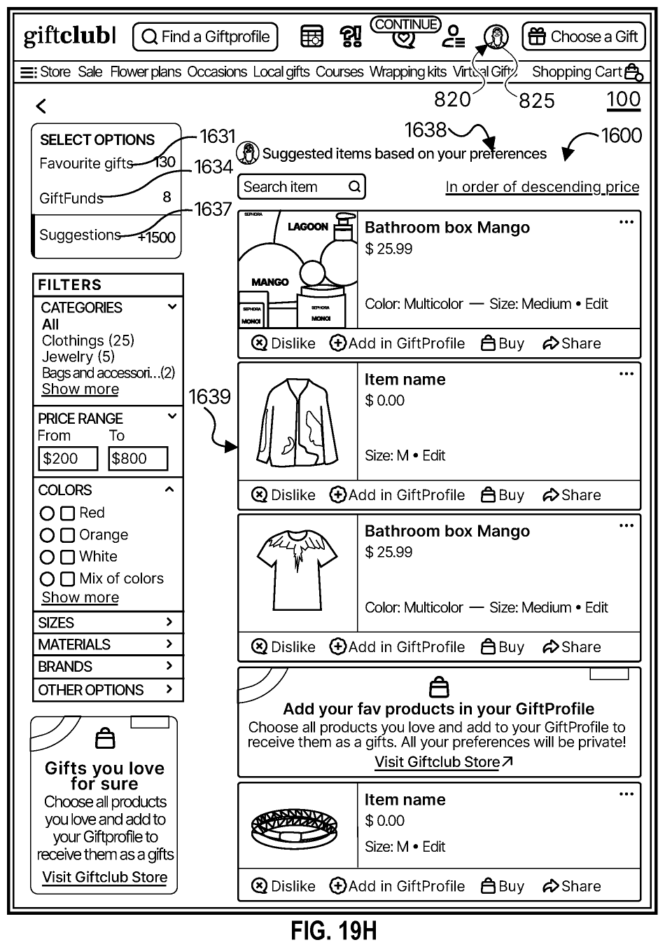

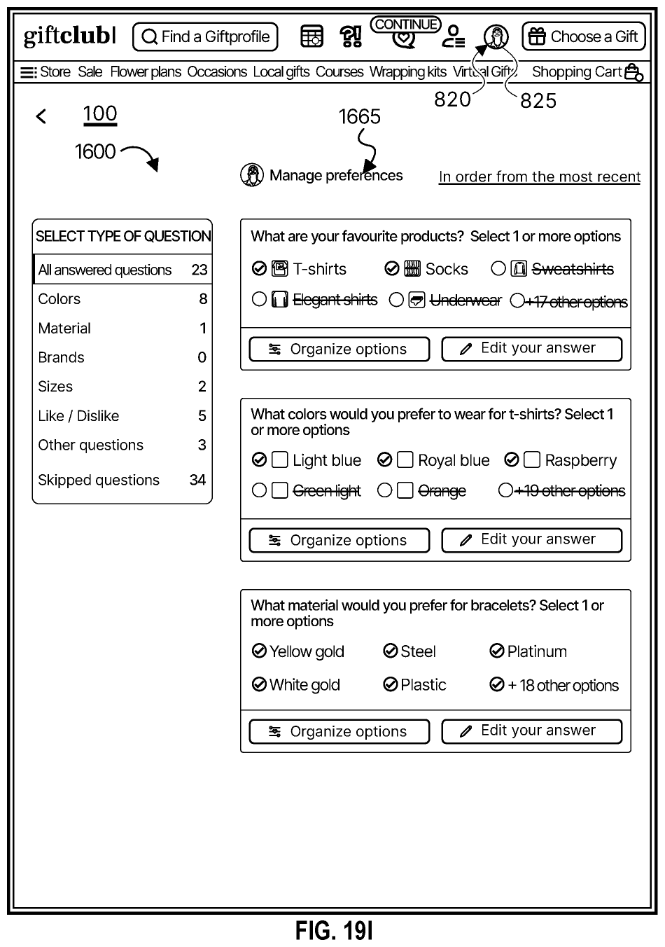

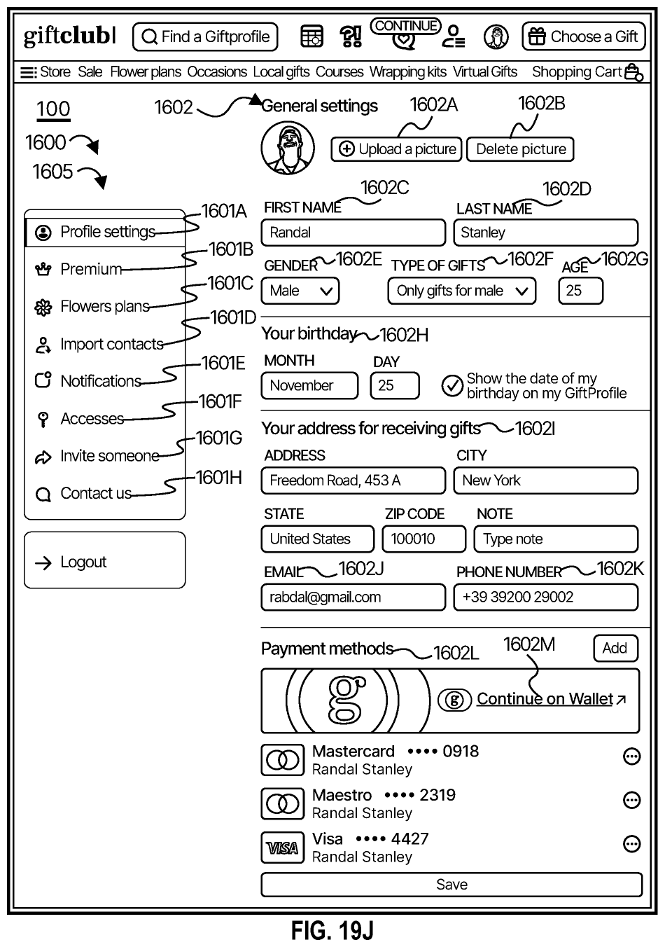

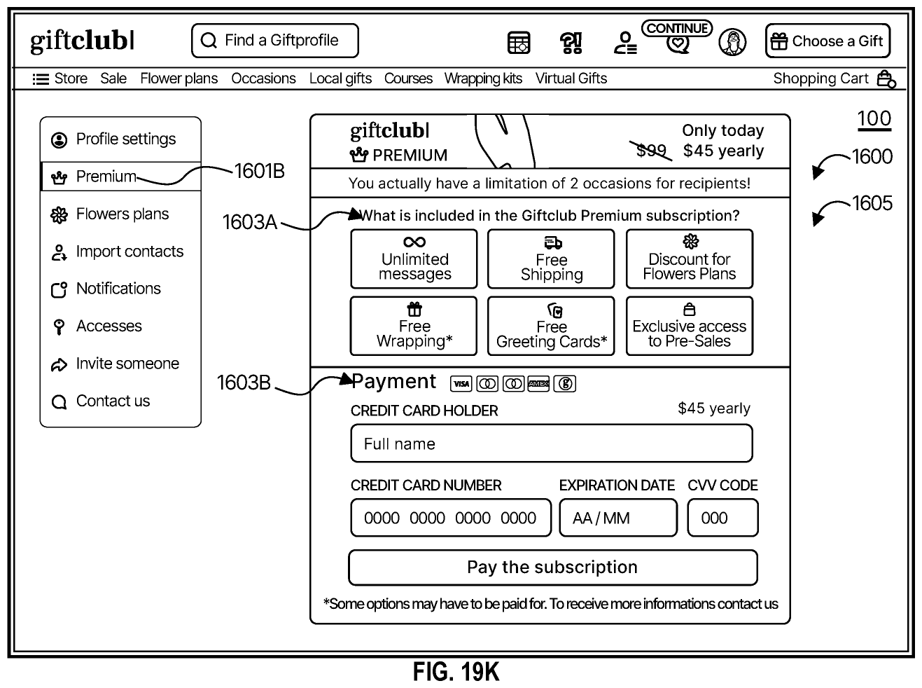

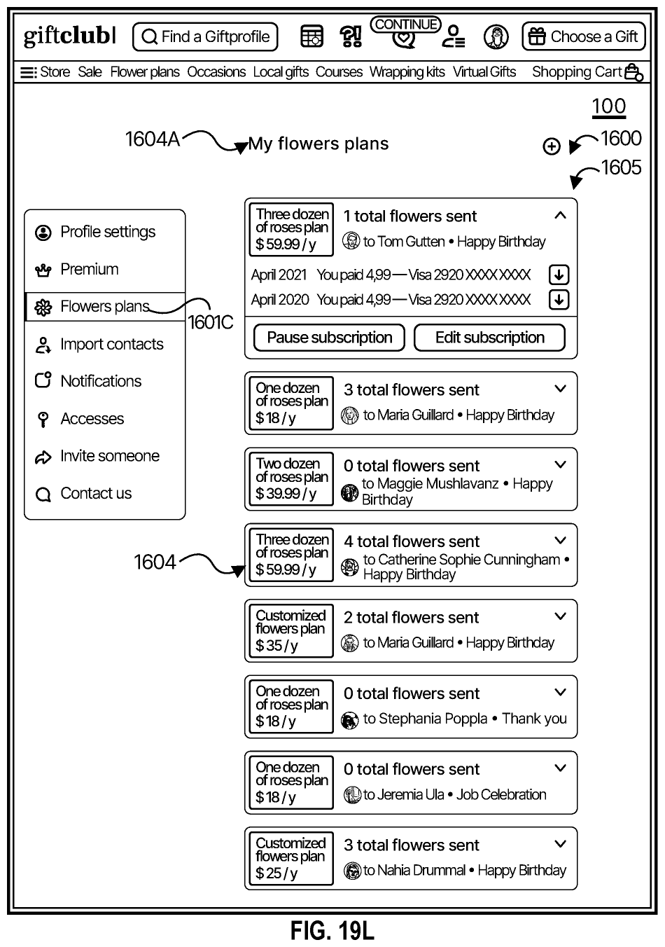

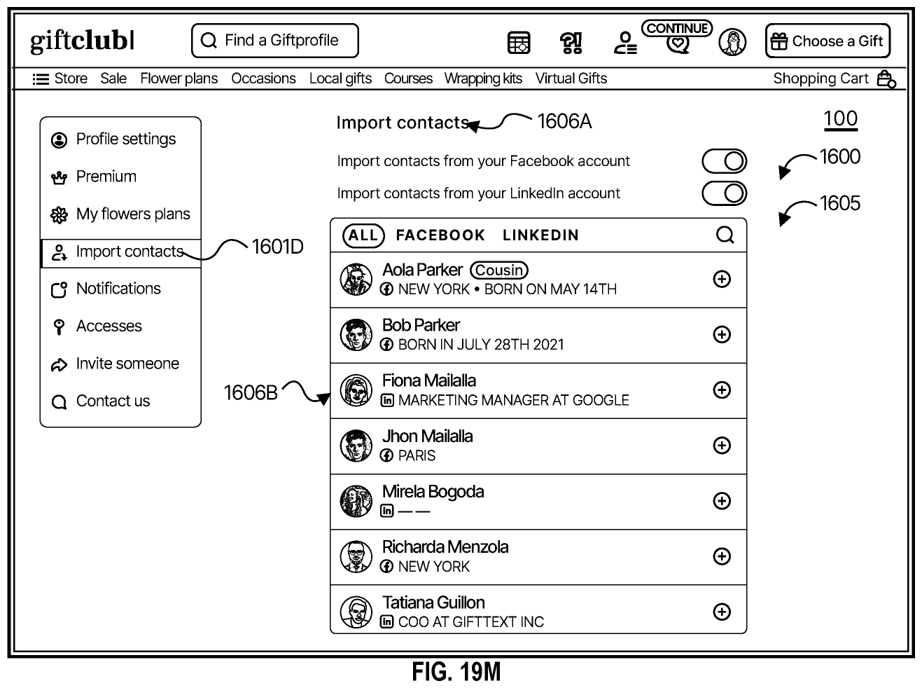

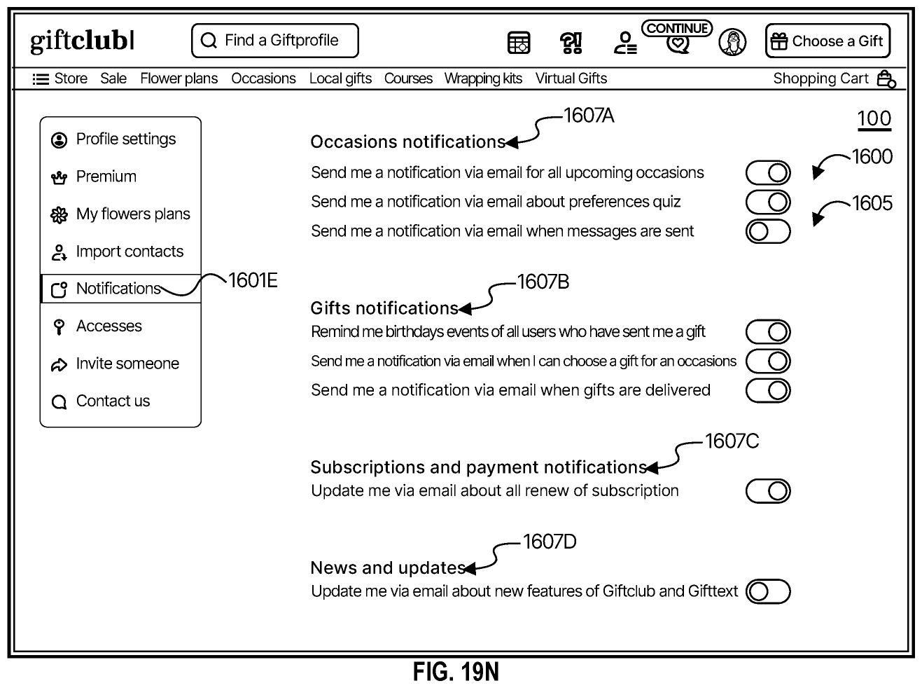

Exemplary second navigation indicia 820 of the home page 800 can include an occasions navigation link 821, a group gift exchange (or Secret Santa) navigation link 822, recipients navigation link 823, a preferences navigation link 824 and/or a gift profile navigation link 825, without limitation. Like the occasions navigation link 813, the occasions navigation link 821 can enable the gifter to visit the occasions page 1300 in the manner described herein with reference to FIGS. 13A-D. The group gift exchange navigation link 822 can permit the gifter to visit a group gift exchange page 1000 in the manner described herein with reference to FIGS. 10A-L, the preferences navigation link 824 can enable the gifter to access a gift preferences quiz page 1200 in the manner described herein with reference to FIGS. 12A-K and/or the gift profile navigation link 825 can permit the gifter to visit a gifter profile page 1600 in the manner described herein with reference to FIGS. 19A-O.

Via the recipients navigation link 823, the gifter can navigate a contact list page (not shown) that presents a roster of the one or more recipients associated with the gifter. The contact list page, for example, can include a recipient image, a recipient name, recipient contact information, recipient demographic information and/or other personal profile information for each recipient. Exemplary images for representing the recipient can include one or more photographs or other pictures, one or more avatars, one or more character (such as symbols, letters and/or numbers), and/or emojis, without limitation. In selected embodiments, the character can comprise a character in English or any other language, such as a character in traditional Chinese and/or simplified Chinese. Additionally and/or alternatively, the contact list page can include a number, description a date, a time and/or other event information about the events (or occasions) associated with each recipient.

As shown in FIG. 8, the home page 800 optionally can include a choose a gift link 830 for selecting a gift for a selected recipient, a shopping cart link 840 for viewing and/or purchasing at least one previously-selected gift, and/or a gifting indicia 850 for sending a gift to a selected recipient based upon one or more preferences of the selected recipient and/or receiving a gift by the gifter based upon one or more preferences of the gifter. The gifting indicia 850 can include a first gifting link 851 for enabling the gifter to create a gift profile and/or a second gifting link 852 for enabling the gifter to choose a gift for the gifter and/or the selected recipient. Additionally and/or alternatively, the home page 800 can suggest one or more gifts 860 based upon the preferences of the gifter and/or present a listing of at least one scheduled occasions 870 associated with the gifter and/or the recipients associated with the gifter.

An exemplary flower plan page 900 of the gifting method 100 is illustrated and described with reference to FIGS. 9A-R. Turning to FIG. 9A, the flower plan page 900 can enable the gifter to start a new flower plan 910. The gifter thereby can select a flower plan for the gifter or for a particular recipient. In selected embodiments, the flower plan page 900 can present the gifter with a plurality of flower plan options. The flower plan options shown in FIG. 9A can include an option for selecting a custom flower arrangement 911 and/or at least one option for selecting a preselected flow arrangement 912. Via the custom flower arrangement 911, the gifter can select at least one flower type, a number of each flower type, and/or a flower arrangement of the selected flowers. Exemplary preselected flow arrangements 912 can include one dozen roses 914, two dozen roses 916 and/or three dozen roses 918, without limitation. Each of the flower plan options can be associated with a flower plan option price.

Turning to FIG. 9B, the flower plan page 900 can enable the gifter to choose a recipient, at 920, to receive the flowers associated with the selected flower plan. The flower plan page 900 can present one or more options 922 for choosing the recipient. The gifter, for example, can be permitted to search for a gift profile of the chosen recipient, at 924, from among a plurality of recipient gift profiles, as shown in FIG. 9C. Additionally and/or alternatively, FIG. 9B shows that the gifter can choose the chosen recipient from a recipient list associated with the gifter, at 926, and/or to create a new recipient profile for the chosen recipient, at 928. As shown in FIG. 9D, for example, the gifter can search for the gift profile of the chosen recipient, at 924, by entering recipient information, such as a telephone number, an email address, a gift profile URL and/or a recipient name, associated with the chosen recipient. The gifting method 100 optionally can maintain the confidentiality of the chosen recipient by limiting the recipient information that is presented to the gifter.

If the gift profile of the chosen recipient is identified, the flower plan page 900 can enable the gifter to send the flowers to the chosen recipient, at 925A, and/or to visit the gift profile of the chosen recipient, at 925B, as illustrated in FIG. 9E. To assist the gifter with sending the flowers to the chosen recipient, the flower plan page 900 can present the gifter with a list 936 of potential occasions for sending flowers, at 932, and enable the gifter to select one or more of the listed occasions. The flower plan page 900 of FIG. 9F can permit the gifter to perform a search, at 934, for a desired type of occasion and/or to create a new occasion (or new type of occasion), at 938.

The flower plan page 900 can permit the gifter to select an appropriate occasion 940, such as Valentine's Day, and to provide detailed occasion indicia as illustrated in FIG. 9G. As shown in FIG. 9G, an occasion date and/or an occasion time can be entered for the occasion 940, at 942. The gifting method 100, for example, can permit the gifter to indicate an initial occasion date 943 and/or a preferred occasion time 944 via the flower plan page 900. The occasion time 944 can comprise a specific time of day and/or a range of times. As illustrated in FIG. 9H, the occasion time 944 can comprise an early morning time 944A, a late morning time 944B, an afternoon time 944C and/or an evening time 944D. In selected embodiments, the flower plan page 900 can include at least one annual or other reminder 945 when the occasion 940 recurs as shown in FIGS. 9G-H. The reminder 945 optionally can include start date indicia 946A and/or end date indicia 946B. The flower plan page 900 can include an optional flower prepayment plan 946.

As illustrated in FIGS. 9I-K, the flower plan page 900 can enable the gifter to select the flowers to be sent to the chosen recipient, at 950. The flower plan page 900 can present a listing 951 of one or more flower options as illustrated in FIG. 9I. Each flower option can include a photograph or other image of the flower option, a description of the flower option and/or a price of the flower option. One or more suggested flower options 951A can be included in the flower option listing 951. The suggested flower options 951A may be suggested based upon the preferences of the gifter and/or the preferences of the chosen recipient. To facilitate selection of an appropriate flower option 952, the flower plan page 900 can present one or more filters 954 for narrowing the presented flower option listing 951. The filters 954 can include, but are not limited to, a type of flower 954A, a number of flowers 954B, a price range of the gifter 954C, a color of the flowers 954D, whether a box is included with the flowers 954E and/or a type of bouquet for the flowers 954F.

The flower plan page 900, in selected embodiments, can include hierarchical filters 954. Turning to FIG. 9J, the filters optionally can include secondary filters 956. If the gifter identifies the type of flower 954A as being a rose, the flower plan page 900 can present a narrowed listing 951 of one or more rose options as illustrated in FIG. 9J. To facilitate selection of an appropriate rose option, the flower plan page 900 can present the one or more secondary filters 956 for further narrowing the presented flower option listing 951. The secondary filters 956 can include a type of rose 956A, a color of the roses 956B, and/or a type of bouquet for the roses 956C, without limitation. Details to add to the flowers 958 are illustrated in FIG. 9K. Exemplary flower details can include, but are not limited to, white mistflower 958A and/or polishing spray 958, without limitation. An additional cost may be associated with one or more of the flower details. The flower plan page 900 thereby can assist the gifter with selecting one or more flowers for the chosen recipient.

As illustrated in FIG. 9L, the flower plan page 900 can enable the gifter to provide delivery instruction, at 960, for the selected flowers. Delivery instruction, for example, can include instruction to deliver the selected flowers directly to the chosen recipient, at 962, and/or to deliver the selected flowers to the gifter, at 964. Additionally and/or alternatively, the flower plan page 900 can enable the gifter to provide shipment instruction, at 970, for the selected flowers. As shown in FIG. 9M, for example, the gifter can enter recipient information 972. The recipient information 972 can include, but is not limited to, a recipient name 974A, a recipient street address 974B, a recipient state 974C, a recipient city 974D and/or a recipient Zone Improvement Plan (or ZIP) code 974E. The gifter optionally can enter one or more notes 974F for the selected flowers via the flower plan page 900. The gifting method 100 optionally can suggest a shipping address for the selected flowers, while preferably maintaining the confidentiality of the chosen recipient by limiting the recipient information that is presented to the gifter.

The flower plan page 900 advantageously can enable the gifter to select one or more shipping options 976 for the selected flowers. Turning to FIG. 9N, for example, the flower plan page 900 can permit the gifter to select a gift wrapping option and/or a card option for the selected flowers. For example, the gifter can choose to ship the selected flowers to the chosen recipient without gift wrapping and without a card, at 976A. The gifter alternatively can ship the selected flowers to the chosen recipient with both gift wrapping and a card, at 976B, with a card but no gift wrapping, at 976C, and/or with gift wrapping but without a card.

As shown in FIG. 9O, the flower plan page 900 can include a gift wrapping page 980 for presenting one or more gift wrapping options 982 to the gifter. An additional cost may be associated with one or more of the gift wrapping options and the additional cost optionally can vary depending upon the type of flower plan selected by the gifter. At least one suggested gift wrapping option 982 may be suggested based upon the preferences of the gifter and/or the preferences of the chosen recipient. To facilitate selection of an appropriate gift wrapping option 982, the gift wrapping page 980 can present one or more filters 984 for narrowing the presented gift wrapping options 982. The filters 984 can include, but are not limited to, a type of gift wrapping 984A, a color of the gift wrapping 984B and/or a cost for the gift wrapping 984C.

The flower plan page 900 can include a greeting card page 990 for presenting one or more greeting card options 992 to the gifter as illustrated in FIG. 9P. An additional cost may be associated with one or more of the greeting card options and the additional cost optionally can vary depending upon the type of flower plan selected by the gifter. At least one suggested greeting card option 992 may be suggested based upon the preferences of the gifter and/or the preferences of the chosen recipient. To facilitate selection of an appropriate greeting card option 992, the greeting card page 990 can present one or more filters 994 for narrowing the presented greeting card options 992. The filters 994 can include a type of greeting card 994A, a color of the greeting card 994B and/or a cost for the greeting card 994C, without limitation. In selected embodiments, the gifter can include a gift, such as cash, cryptocurrency, stocks, money and/or non-fungible tokens (NTFs), with the greeting card sent to the recipient.

An optional flower recap page 996 for the flower plan page 900 is illustrated in FIG. 9Q. The flower recap page 996 can summarize the flower selection by the gifter and/or request payment for the selected flowers, at 996A. Additionally and/or alternatively, the flower recap page 996 can present one or more details 996B of the flower selection by the gifter. Turning to FIG. 9R, a payment page 999 of the flower plan page 900 is shown. The payment page 999 can confirm the flower plan 998A selected by the gifter, the chosen flowers and associated cost 998B, any additional gift wrapping, greeting card or other costs 998C, and/or any membership or other discounts 998D. A total price 998E can be shown on the payment page 999 for the flower selection.

The payment page 999 of FIG. 9R is illustrated as enabling the gifter to enter payment information. The payment information can include, but is not limited to, a gifter name 999A, a number 999B for a credit card, debit card or other transaction payment method associated with the gifter, an expiry date 999C for the payment method and/or a Card Verification Value (or CVV) 999D for the payment method. The payment page 999 optionally can ask the gifter to confirm the payment, at 999E, before submission of the payment information.

Turning to FIGS. 10A-L, an exemplary group gift exchange page 1000 of the gifting method 100 is shown. Pursuant to the group gift exchange page 1000, each recipient or other participant of the group gift exchange can receive a gift from another group gift exchange participant anonymously and/or based upon the personal preferences of the recipient and/or other group gift exchange participant, including the gifter. One example of a group gift exchange is a Secret Santa gift exchange.

As illustrated in FIG. 10A, a new group gift exchange event can be created, at 1010. The new group gift exchange event creation can include entering a name for the new group gift exchange event, at 1010A, and/or a date of the gift exchange, at 1010B. Budgetary information 1012 optionally can be established for the new group gift exchange event as shown in FIG. 10B. The budgetary information 1012, for example, can include a fixed amount of money and/or, as shown in FIG. 10B, can include a budget range 1014 with a low budget range amount 1016 and a high budget range amount 1018. Turning to FIG. 10C, the group gift exchange participants 1028 can be selected, at 1020. In selected embodiments, a user can search among the shared gifter profiles, at 1022, in an effort to selected one or more group gift exchange participants. Additionally and/or alternatively, the group gift exchange page 1000 can enable the user to select at least one group gift exchange participant from a listing of shared gifter profiles 1024 and/or to add at least one new group gift exchange participant, at 1026.

In selected embodiments, a type of group gift exchange event can be selected, at 1030, as illustrated in FIG. 10D. The group gift exchange event, for example, can comprise an online group gift exchange event 1030A and/or an in-person group gift exchange event 1030B. Turning to FIG. 10E, the group gift exchange page 1000 optionally can include a notes page 1035. The notes page 1035 can provide a listing 1036 of the group gift exchange participants 1028. As shown in FIG. 10E, the listing 1036 can include a number of the group gift exchange participants 1028 and identifying participant indicia for each the group gift exchange participant 1028. The identifying participant indicia can include, but is not limited to, a participant image, a participant name, participant contact information, participant demographic information and/or other personal profile information for each group gift exchange participant 1028. The notes page 1035 likewise can enable an event organizer or other group gift exchange participant 1028 to enter one or more notes, at 1037, for providing instruction, suggestions or other information for the group gift exchange participants 1028.

The group gift exchange page 1000 can include a group gift exchange event confirmation page 1040 as illustrated in FIG. 10F. The group gift exchange event confirmation page 1040 can provide a listing 1046 of the group gift exchange participants 1028. As shown in FIG. 10F, the listing 1046 can include a number of the group gift exchange participants 1028 and identifying participant indicia for each the group gift exchange participant 1028. The identifying participant indicia can include, but is not limited to, a participant image, a participant name, participant contact information, participant demographic information and/or other personal profile information for each group gift exchange participant 1028. As shown in FIG. 10F, the group gift exchange event confirmation page 1040 optionally can provide event details 1042 about the group gift exchange event. The event details 1042 can include, but are not limited to, the budgetary information 1012, shipping information, participant instruction and/or other information related to the group gift exchange event.

The group gift exchange event confirmation page 1040 optionally can include status information 1044 about the group gift exchange event. The status information 1044, for example, can include a notification status of a notification about the group gift exchange event as sent to each group gift exchange participant 1028. The status notification can include confirmation that a notification was sent to a selected group gift exchange participant 1028, that the notification was accepted by selected group gift exchange participant 1028, etc. Additionally and/or alternatively, each group gift exchange participant 1028A can receive a gift sending notification 1044A related to a first gift that the group gift exchange participant 1028A will provide to another group gift exchange participant 1028B and/or a gift receiving notification 1044B related to a second gift that the group gift exchange participant 1028A will receive from another group gift exchange participant 1028C.

The group gift exchange participant 1028A can activate the gift sending notification 1044A to select the first gift to be provided to the other group gift exchange participant 1028B. Stated somewhat differently, the group gift exchange page 1000 optionally can include one or more gift selection pages 1050 for enabling the group gift exchange participant 1028A to select a gift for the other group gift exchange participant 1028B pursuant to the group gift exchange event as illustrated in FIG. 10G. The gift selection pages 1050 can include identifying participant indicia for the other group gift exchange participant 1028B. The identifying participant indicia can include, but is not limited to, a participant image, a participant name, participant contact information, participant demographic information and/or other personal profile information for the other group gift exchange participant 1028B. The gift selection pages 1050 also can provide a listing 1052 of potential gifts based upon gift profile of the other group gift exchange participant 1028B. Thereby, the group gift exchange participant 1028A can select one of the listed potential gifts 1052 to be given as an event gift 1054 to the other group gift exchange participant 1028B.

Turning to FIG. 10H, a payment page 1060 of the group gift exchange page 1000 is shown. The payment page 1060 can confirm the event gift 1054 selected by the group gift exchange participant 1028A, such as via a gift description 1062A and/or a gift image, and associated cost 1062B, any additional gift wrapping, greeting card or other costs 1062C, and/or any membership or other discounts 1062D. A total price 1062E can be shown on the payment page 1060 for the event gift 1054.

The payment page 1060 of FIG. 10H is illustrated as enabling the group gift exchange participant 1028A to enter payment information. The payment information can include, but is not limited to, a participant name 1060A, a number 1060B for a credit card, debit card or other transaction payment method associated with the group gift exchange participant 1028A, an expiry date 1060C for the payment method and/or a CVV 1060D for the payment method. The payment page 1060 optionally can ask the group gift exchange participant 1028A to confirm the payment, at 1060E, before submission of the payment information. In selected embodiments, the group gift exchange event confirmation page 1040 can be updated to reflect the payment confirmation 1060E by the group gift exchange participant 1028A for the event gift 1054 to be provided to the other group gift exchange participant 1028B as shown in FIG. 10I. As illustrated in FIG. 10J, the group gift exchange page 1000 optionally can present a shipping confirmation page 1070 for confirming shipment of the event gift to the other group gift exchange participant 1028B. In selected embodiments, the group gift exchange event can be edited and/or deleted as shown in FIGS. 10K and 10L.

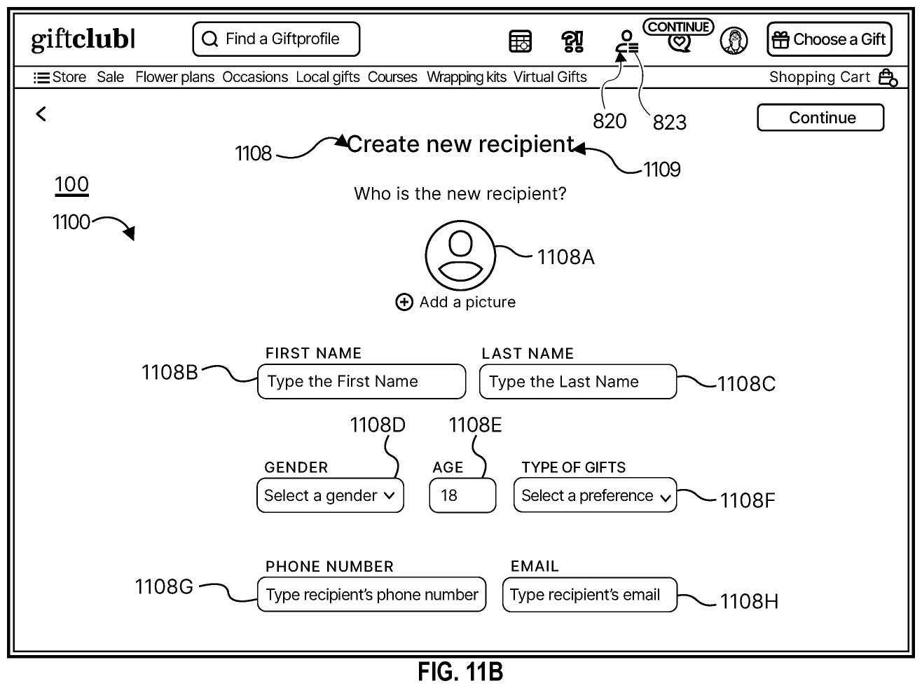

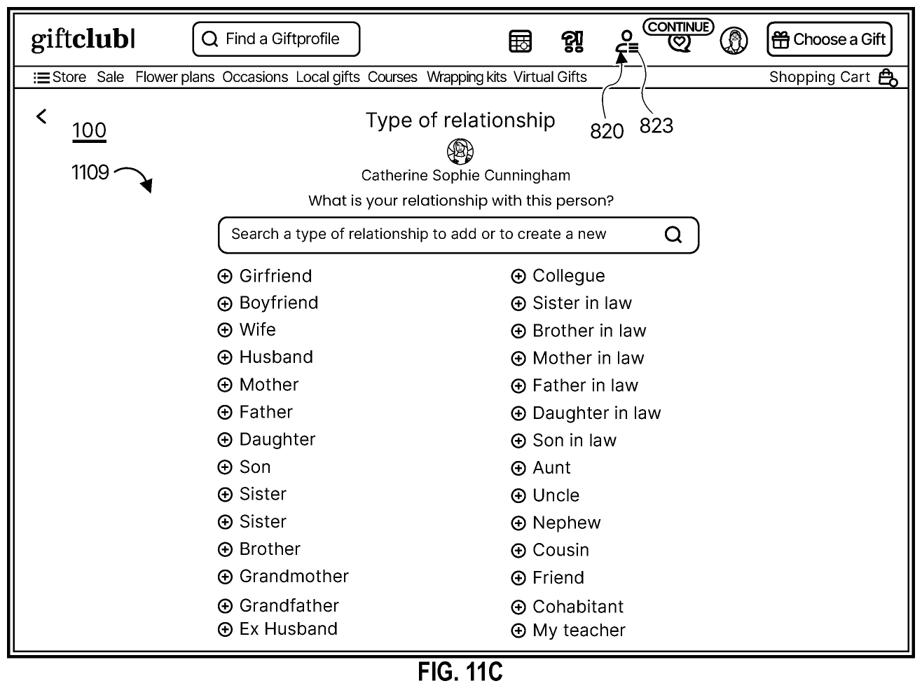

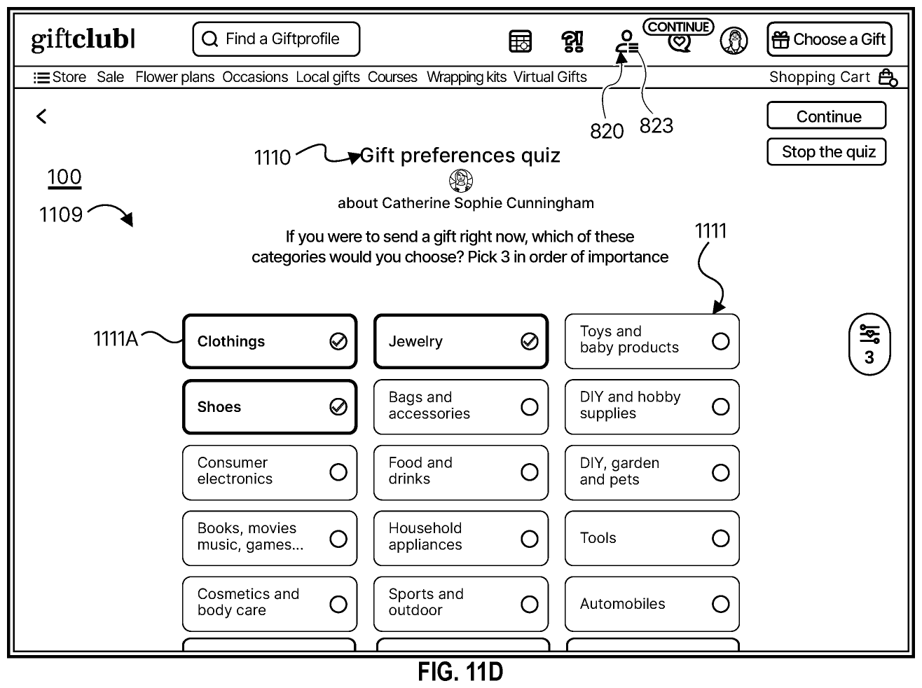

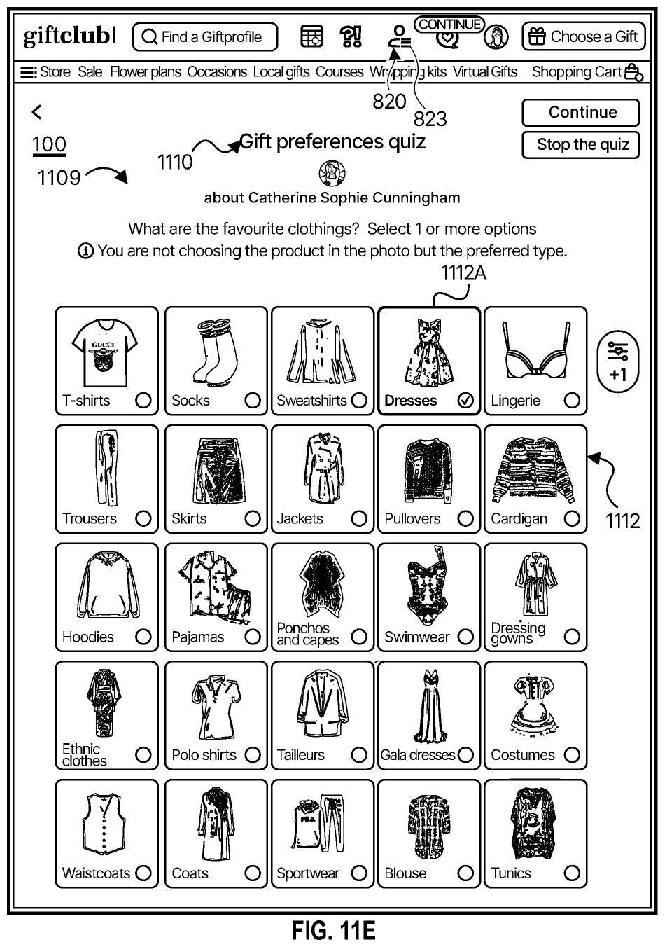

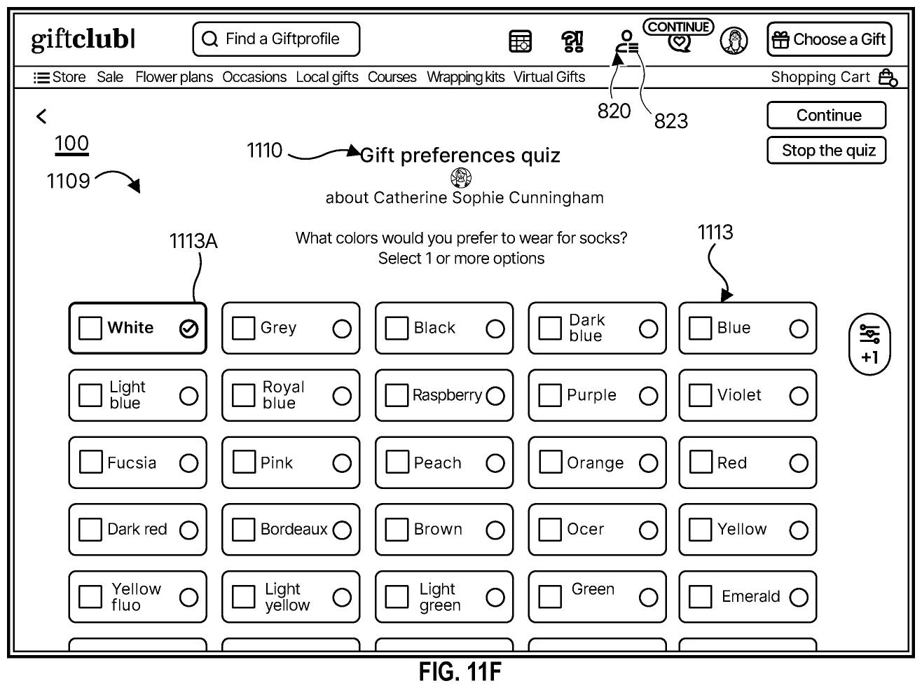

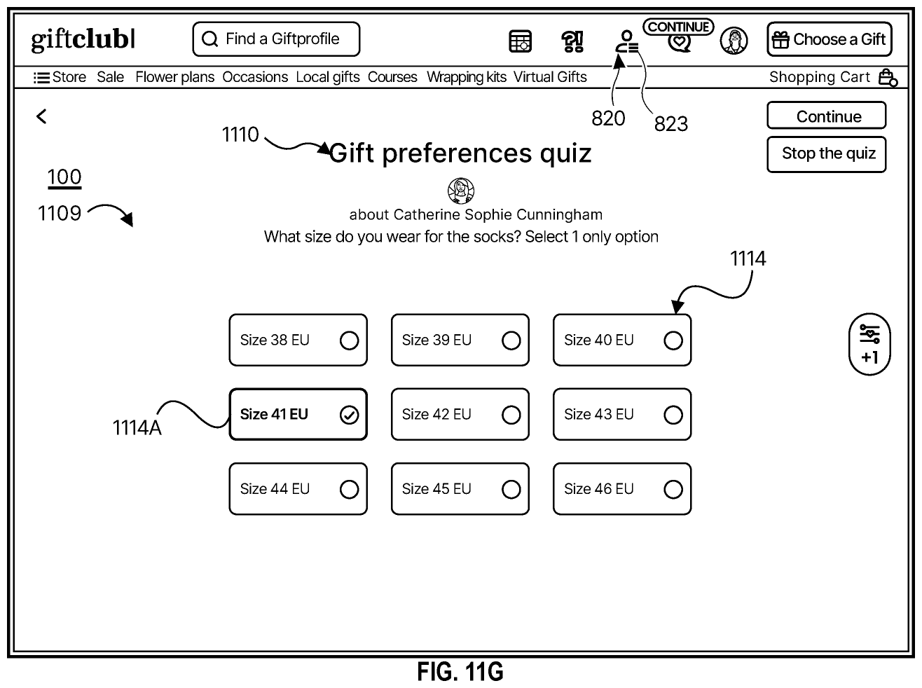

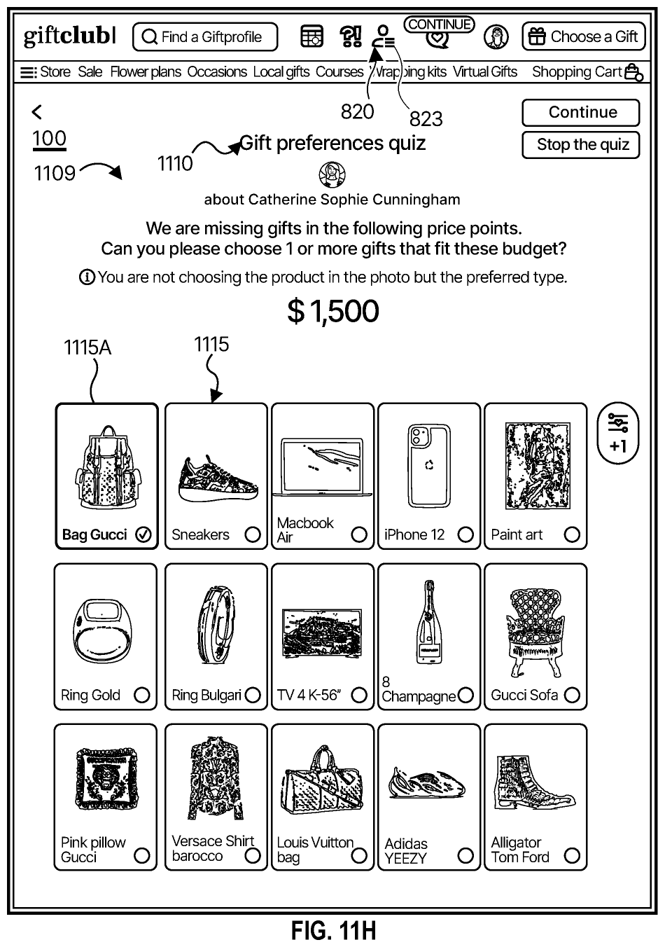

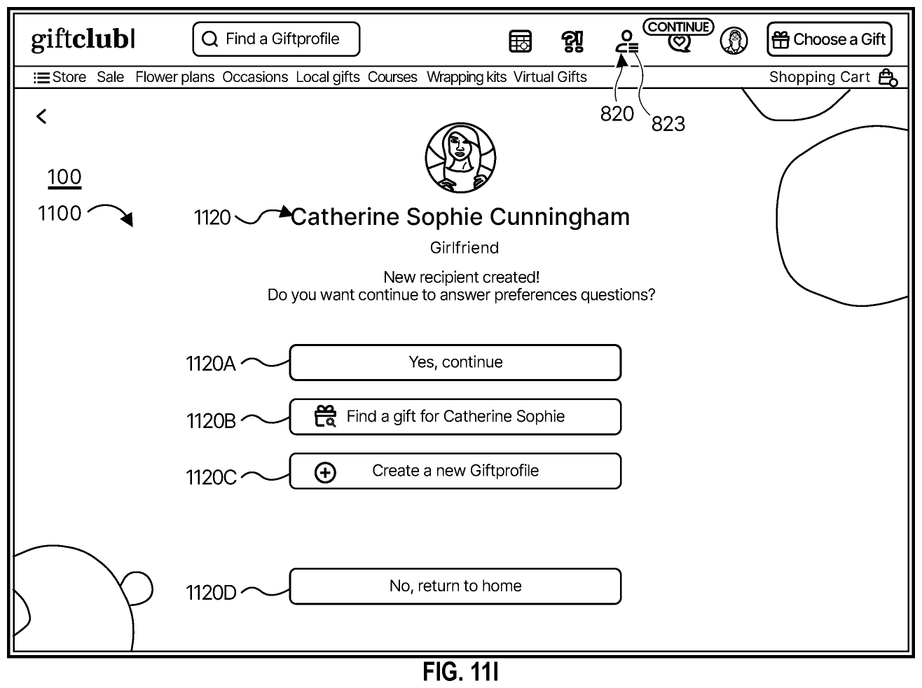

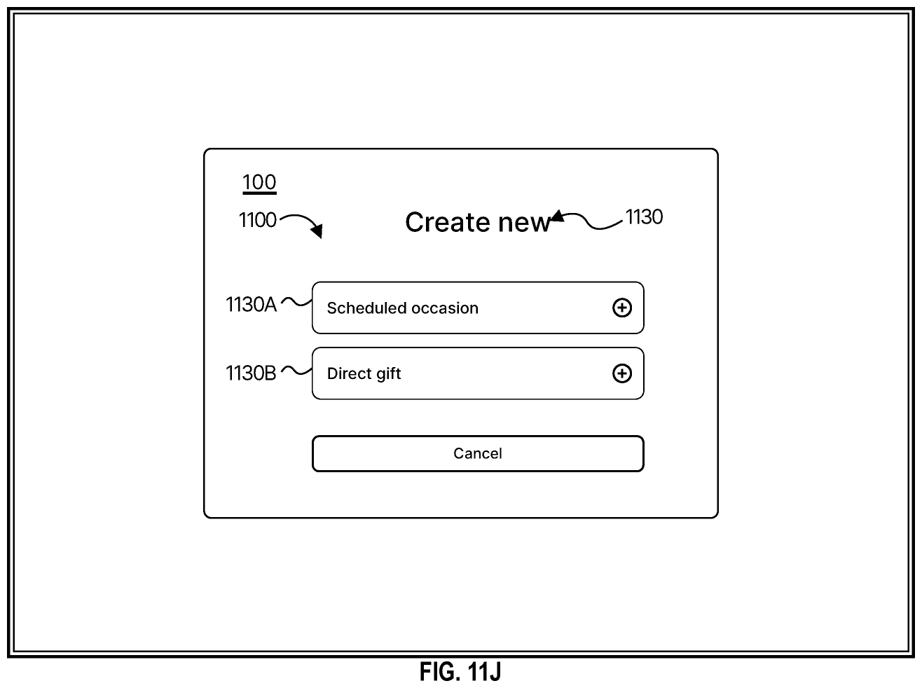

Upon activation of the recipients navigation link 823, the gifting method 100 can present a contact list page 1100 as illustrated in FIGS. 11A-J. The contact list page 1100 of FIG. 11A is shown as including a contact list 1102 of the gifter. The contact list 1102 can include a listing 1104 of the recipients and other users of the gifting method 100 who are associated with the gifter. Additionally and/or alternatively, the contact list page 1100 can have a search feature 1106 by which the gifter can search the recipient profile of the recipients and other users of the gifting method 100. The gifter, for example, can base the search on selected information, such as a recipient name, recipient contact information, recipient demographic information and/or other personal profile information.

In selected embodiments, the contact list page 1100 can enable the gifter to add a new contact, at 1108, to the contact list 1102. Turning to FIG. 11B, for example, the contact list page 1100 can present a create new recipient page 1109 for creating a new recipient profile for a new recipient who is associated with the gifter. The create new recipient page 1109 can enable the gifter to enter selected profile information for the new recipient profile. As shown in FIG. 11B, the selected profile information can include a new recipient image 1108A, a new recipient first name 1108B, a new recipient last name 1108C, a new recipient gender 1108D, a new recipient age 1108E, one or more new recipient gift preferences 1108F, a new recipient telephone number 1108G and/or a new recipient email address 1108H, without limitation. The selected profile information can include a relationship between the gifter and the new recipient as illustrated in FIG. 11C.

To facilitate creation of the new recipient profile, the create new recipient page 1109 can present a gift preference quiz 1110 for identifying the new recipient gift preferences 1108F of the new recipient as shown in FIGS. 11D-H. The gift preference quiz 1110, for example, can begin by presenting high-level preference options about the new recipient gift preferences 1108F of the new recipient and gradually seek more detailed new recipient gift preference information through a series of gift preference quiz pages. Turning to FIG. 11D, the gift preference quiz 1110 can present a plurality of broad gift categories 1111 and enable the gifter to select and/or rank one or more relevant broad gift categories 1111A for the new recipient. The gift preference quiz 1110 then can present a plurality of less broad (or more detailed) gift categories 1112 based upon the relevant broad gift categories 1111A as selected and ranked by the gifter and enable the gifter to select and/or rank one or more relevant less broad gift categories 1112A for the new recipient as illustrated in FIG. 11E. Stated somewhat differently, the gift preference quiz 1110 can comprise a hierarchical gift preference quiz.

The gift preference quiz 1110 optionally can present one or more detailed recipient preference options. As illustrated in FIG. 11F, for example, the gift preference quiz 1110 can present a plurality of clothing color preference options 1113 and enable the gifter to select and/or rank one or more relevant clothing color preference options 1113A for the new recipient. The gift preference quiz 1110 likewise can present a plurality of clothing size preference options 1114 and enable the gifter to select and/or rank one or more relevant clothing size preference options 1114A for the new recipient as shown in FIG. 11G. Additionally and/or alternatively, the gift preference quiz 1110 of FIG. 11H is shown as presenting a gift budget and a plurality of gift preference options 1115 within the gift budget and enable the gifter to select and/or rank one or more relevant gift preference options 1115A within the gift budget for the new recipient.

Turning to FIG. 11I, a new recipient profile completed page 1120 can be presented by the gifting method 100 once the new recipient profile is sufficient complete. The new recipient profile completed page 1120 can enable the gifter to continue to answer preference questions for the new recipient, at 1120A, to find a gift for the new recipient, at 1120B, and/or to create another new recipient profile for a different new recipient, at 1120C. The gifter optionally can elect to return to the home page 800 (shown in FIG. 8), at 1120D. If the gifter elects to find a gift for the new recipient, at 1120B, the gifting method 100 can present a new recipient gift page 1130 as shown in FIG. 11J. Turning to FIG. 11J, the gift can comprise a gift for a scheduled occasion, at 1130A and/or a gift for direct delivery to the new recipient, at 1130B.

Upon activation of the preferences navigation link 824, the gifting method 100 can present a gift preferences quiz page 1200 as illustrated in FIGS. 12A-K. The gift preferences quiz page 1200 can present a gift preferences quiz 1210 for enabling the gifter to identify gifter gift preferences for any gift received by the gifter. The gift preferences quiz 1210, for example, can begin by presenting high-level preference options about the gifter gift preferences of the gifter and gradually seek more detailed gifter gift preference information through a series of gift preferences quiz pages.

Turning to FIG. 12A, the gift preferences quiz 1210 can present a plurality of broad gift categories 1211 and enable the gifter to select and/or rank one or more relevant broad gift categories 1211A for the gifter. The gift preferences quiz 1210 then can present a plurality of less broad (or more detailed) gift categories 1212 based upon the relevant broad gift categories 1211A as selected and ranked by the gifter and enable the gifter to select and/or rank one or more relevant less broad gift categories 1212A for the gifter as illustrated in FIG. 12B.

Stated somewhat differently, the gift preferences quiz 1210 can comprise a hierarchical gift preferences quiz.

The gift preferences quiz 1210 optionally can present one or more detailed gifter preference options. As illustrated in FIG. 12C, for example, the gift preferences quiz 1210 can present a plurality of clothing color preference options 1213 and enable the gifter to select and/or rank one or more relevant clothing color preference options 1213A for the gifter. The gift preferences quiz 1210 likewise can present a plurality of clothing size preference options 1214 and enable the gifter to select and/or rank one or more relevant clothing size preference options 1214A for the gifter as shown in FIG. 12D.

Additionally and/or alternatively, the gift preferences quiz 1210 can enable the gifter to select one or more favorite brands 1216 as shown in FIG. 12E and/or one or more favorite clothing material 1217 as illustrated in FIG. 12F. The gifter can be permitted to select all presented quiz options, such as all material options 1217A. The gift preferences quiz 1210 of FIG. 12G is shown as presenting an optional gift budget and a plurality of gift preference options 1215 within the gift budget and enable the gifter to select and/or rank one or more relevant gift preference options 1215A within the gift budget for the gifter.

Turning to FIG. 12H, a new recipient profile completed page 1220 can be presented by the gifting method 100 once the gifter profile is sufficient complete. The gifter profile completed page 1220 can enable the gifter to continue to answer preference questions for the gifter, at 1220A and/or to visit the gifter profile, at 1220B. The gifter optionally can elect to return to the home page 800 (shown in FIG. 8).

If the gifter elects to continue to answer preference questions for the gifter, at 1220A, the gift preferences quiz 1210 can continue. As shown in FIG. 12I, for example, the gift preferences quiz 1210 can present a second plurality of less broad (or more detailed) gift categories 1212, such as jewelry, based upon a different relevant broad gift category 1211A (shown in FIG. 12A) as previously selected and ranked by the gifter. The gifter then can select and/or rank one or more relevant less broad jewelry gift categories 1212B for the gifter in the manner set forth above. The gift preferences quiz 1210 optionally can present one or more detailed gifter preference options. As illustrated in FIG. 12J, for example, the gift preferences quiz 1210 can present a plurality of jewelry material preference options 1218 and enable the gifter to select and/or rank one or more relevant jewelry material preference options 1218A for the gifter. The gifter can be permitted to select all presented quiz options, such as all jewelry material preference options 1218B.

Once the gifter identifies a selected gift based upon the gift preferences quiz 1210, the gift preferences quiz page 1200 can enable the gifter to confirm the selected gift as shown in FIG. 12K. The gift preferences quiz page 1200, for example, can enable the gifter to not include the selected gift in the gifter profile, at 1219A and/or to include the selected gift in the gifter profile, at 1219C. In selected embodiments, the gift preferences quiz page 1200 can permit the gifter to buy the selected gift, at 1219B.

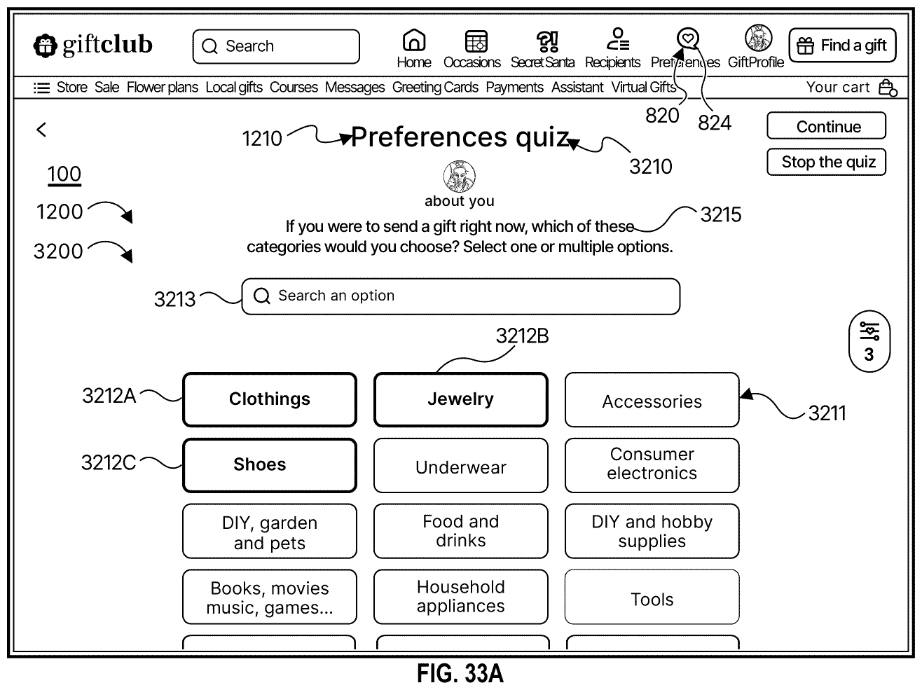

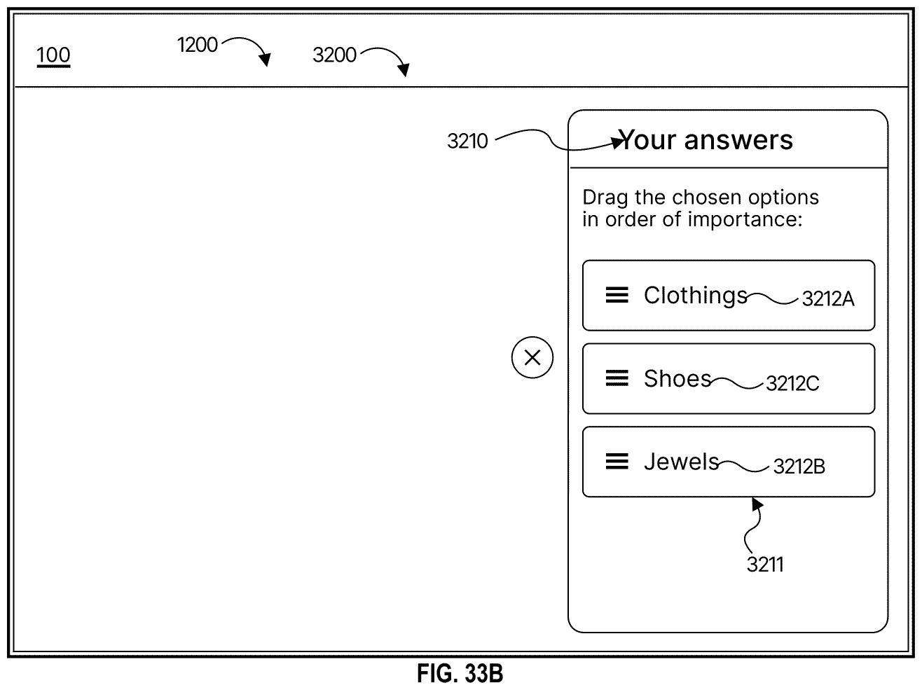

An alternative embodiment of the gift preferences quiz page 1200 is illustrated in FIGS. 33A-B. Turning to FIG. 33A, the gifting method 100 can present an alternative gift preferences quiz page 3200 upon activation of the preferences navigation link 824. In the manner discussed in more detail above with reference to FIGS. 12A-K, the gift preferences quiz page 3200 can present a gift preferences quiz 3210 for enabling the gifter to identify gifter gift preferences for any gift received by the gifter. The gift preferences quiz 3210, for example, can begin by presenting high-level preference options about the gifter gift preferences of the gifter and gradually seek more detailed gifter gift preference information through a series of gift preferences quiz pages.

The gift preferences quiz page 3200 can present a first question 3215 regarding in which one or more broad gift categories 3211 would the gifter like to receive a gift and can permit the gifter to respond to the first question 3215. To assist the gifter with responding to the first question 3125, the gift preferences quiz page 3200 can present a plurality of broad gift categories 3211 and/or enable the gifter to select one or more relevant broad gift categories 3212A-C. In selected embodiments, the gift preferences quiz page 3200 can present search indicia 3213 for permitting the gifter to search for among the broad gift categories 3211.

The gift preferences quiz page 3200 advantageously can enable the gifter to indicate an order of importance or otherwise rank the selected broad gift categories 3212A-C as illustrated in FIG. 33B. The gifter, for example, can be permitted to indicate the ranking by dragging the selected broad gift categories 3212A-C to a predetermined order on the gift preferences quiz page 3200.

As shown in FIG. 33B, a first selected broad gift category 3212A is shown as comprising a highest ranking broad gift category among the selected broad gift categories 3212A-C and can include an exemplary first category of clothing. A second selected broad gift category 3212C is illustrated in FIG. 33B as comprising a second-highest ranking broad gift category among the selected broad gift categories 3212A-C and can include an exemplary second category of shoes.

An exemplary third selected broad gift category 3212B can comprise a third-highest ranking broad gift category among the selected broad gift categories 3212A-C and can include an exemplary third category of jewels (or jewelry).

In the manner set forth in more detail above with reference to FIGS. 12A-K, the gift preferences quiz 3210 can present at least one less broad (or more detailed) gift category based upon the broad gift categories 3212A-C as selected and ranked by the gifter and enable the gifter to select and/or rank one or more relevant less broad gift categories for the gifter. Stated somewhat differently, the gift preferences quiz 3210 can comprise a hierarchical gift preferences quiz.

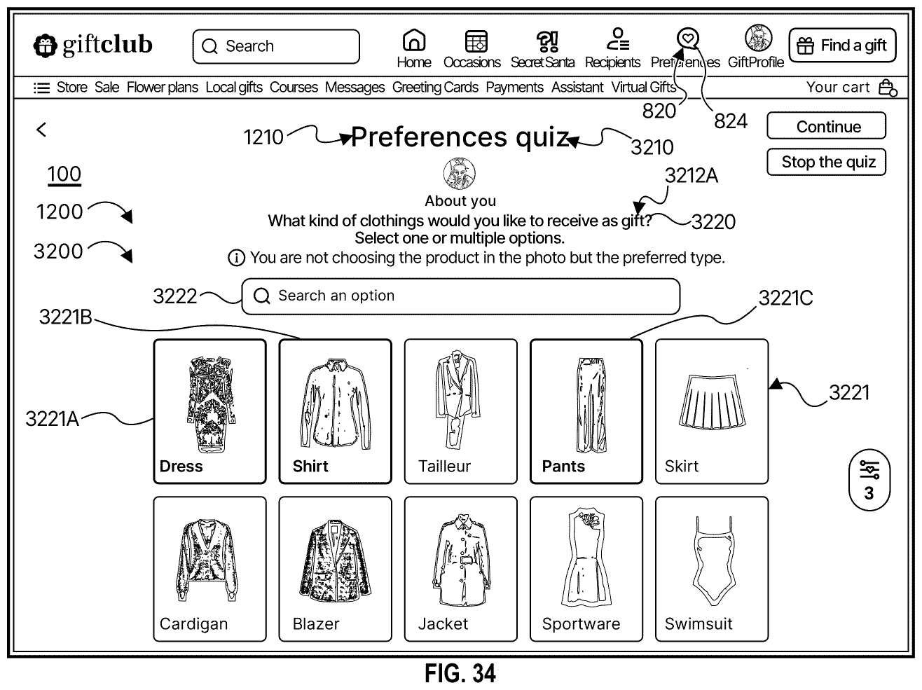

The gift preferences quiz 3210 can present one or more detailed gifter preference options for each of the broad gift categories as selected and/or ranked by the gifter. Turning to FIG. 34, the detailed gifter preference options can comprise detailed gifter preference options associated with the highest ranked selected broad gift category 3212A. The gift preferences quiz page 3200, for example, can present a second question 3220 regarding in which one or more gift subcategories 3221 within the highest ranked selected broad gift category 3212A that the gifter like to receive a gift and can permit the gifter to respond to the second question 3220. To assist the gifter with responding to the second question 3220, the gift preferences quiz page 3200 can present a plurality of gift subcategories 3221 and enable the gifter to select one or more relevant gift subcategories 3221A-C. In selected embodiments, the gift preferences quiz page 3200 can present search indicia 3222 for permitting the gifter to search for among the gift subcategories 3221.

The gift preferences quiz page 3200 optionally can enable the gifter to indicate an order of importance or otherwise rank the selected gift subcategories 3221 in the manner shown and described above with reference to the selected broad gift categories 3212A-C of FIG. 33B. As shown in FIG. 34, a first selected gift subcategory 3221A within the selected broad gift category 3212A of clothing can include an exemplary first subcategory of dresses. A second selected gift subcategory 3221C is illustrated in FIG. 34 as comprising an exemplary second subcategory of shirts. An exemplary third selected gift subcategory 3221B can include an exemplary third subcategory of pants.

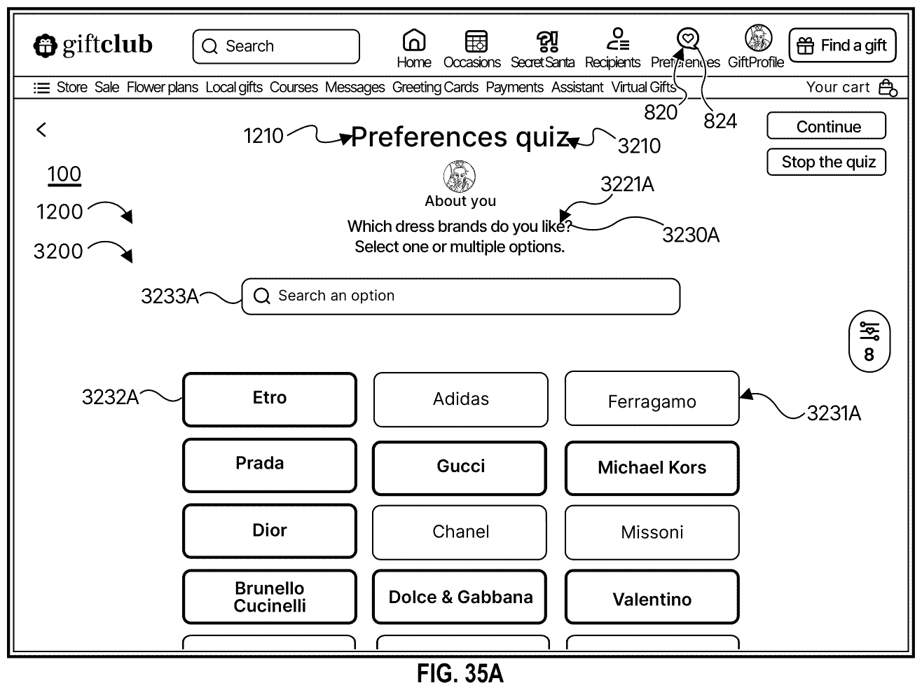

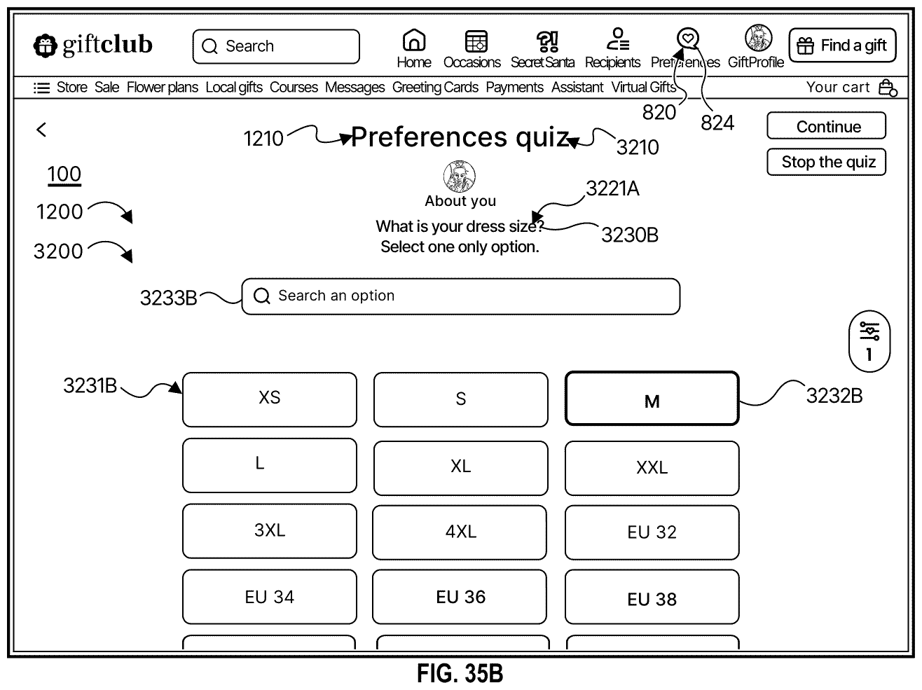

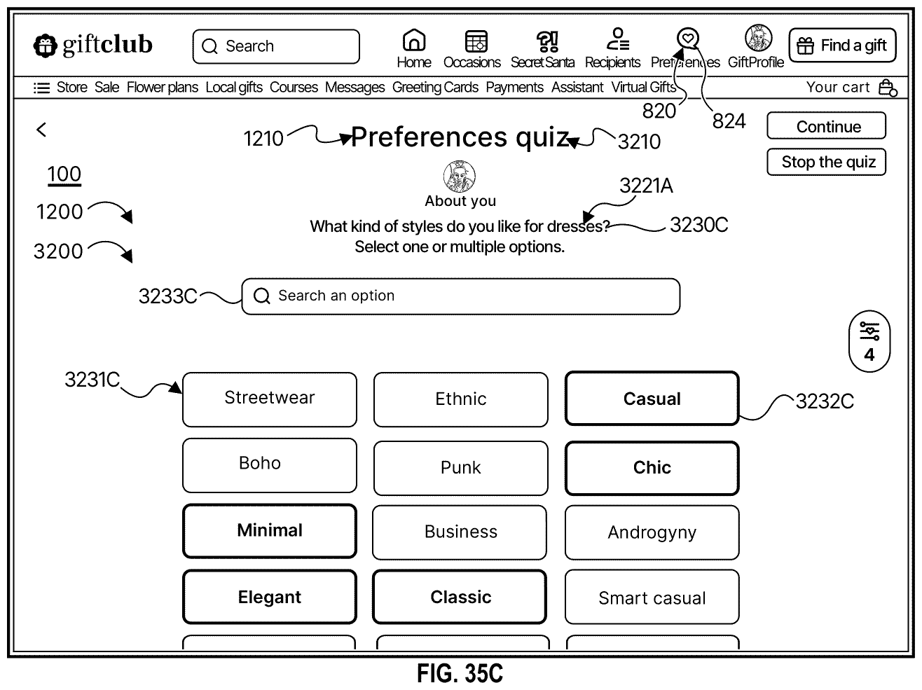

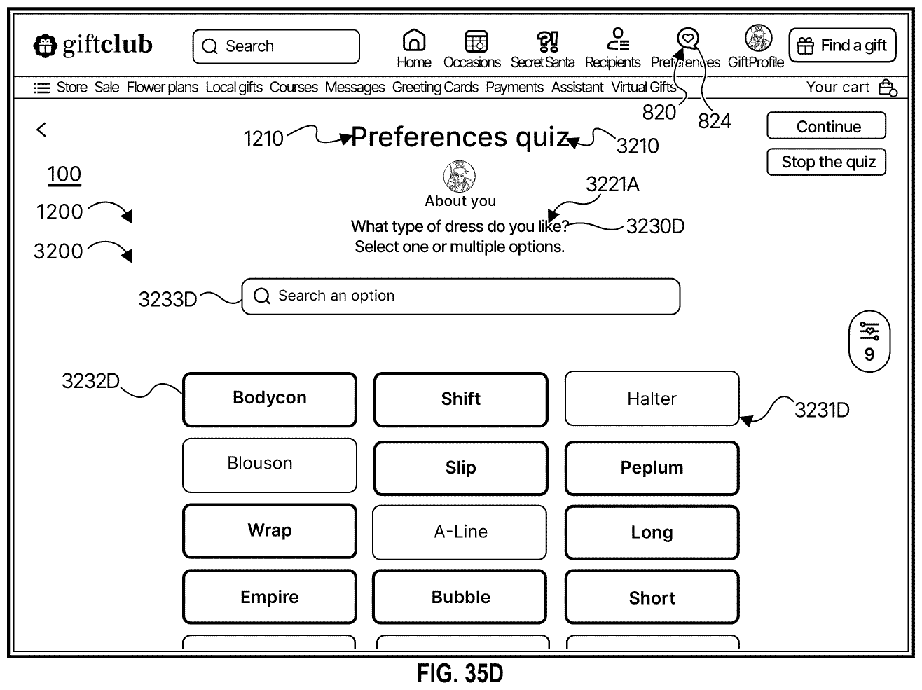

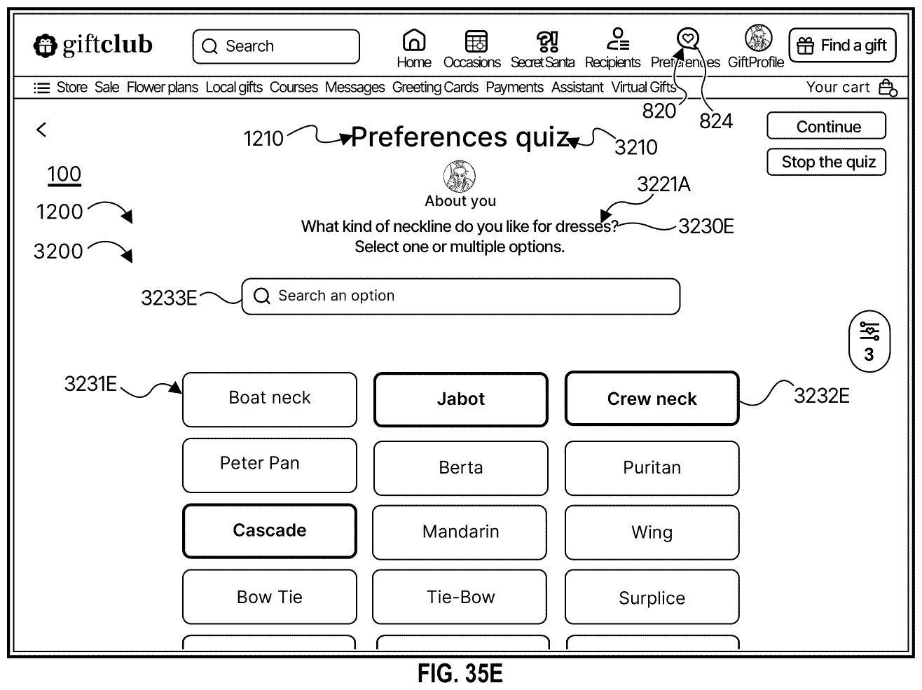

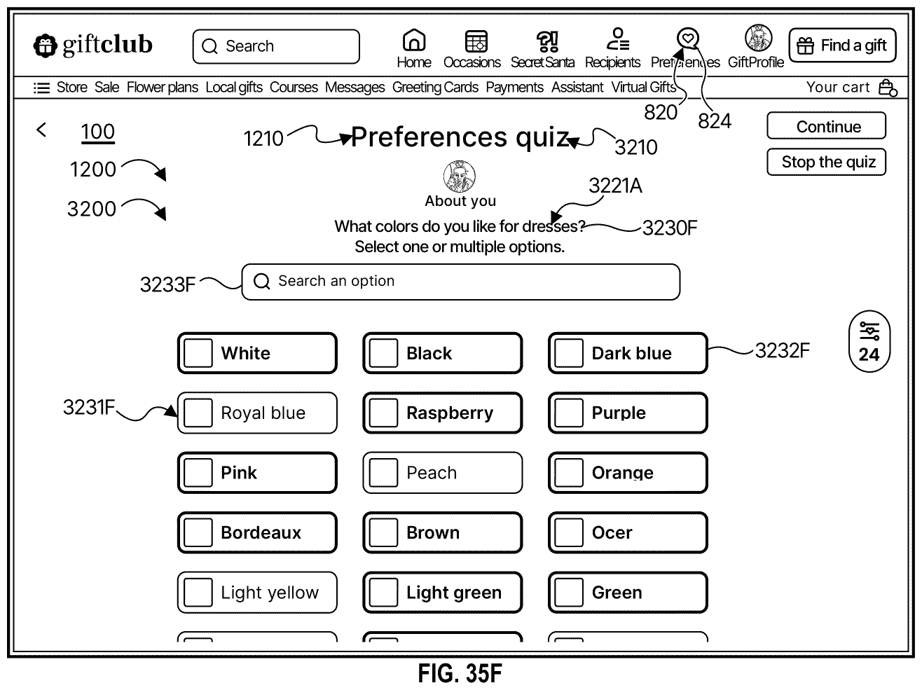

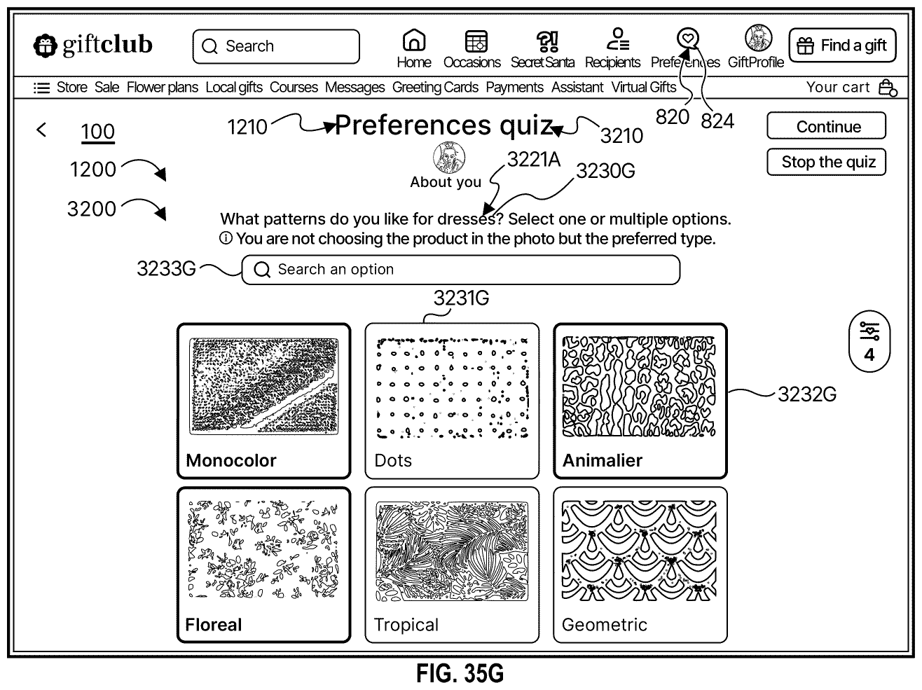

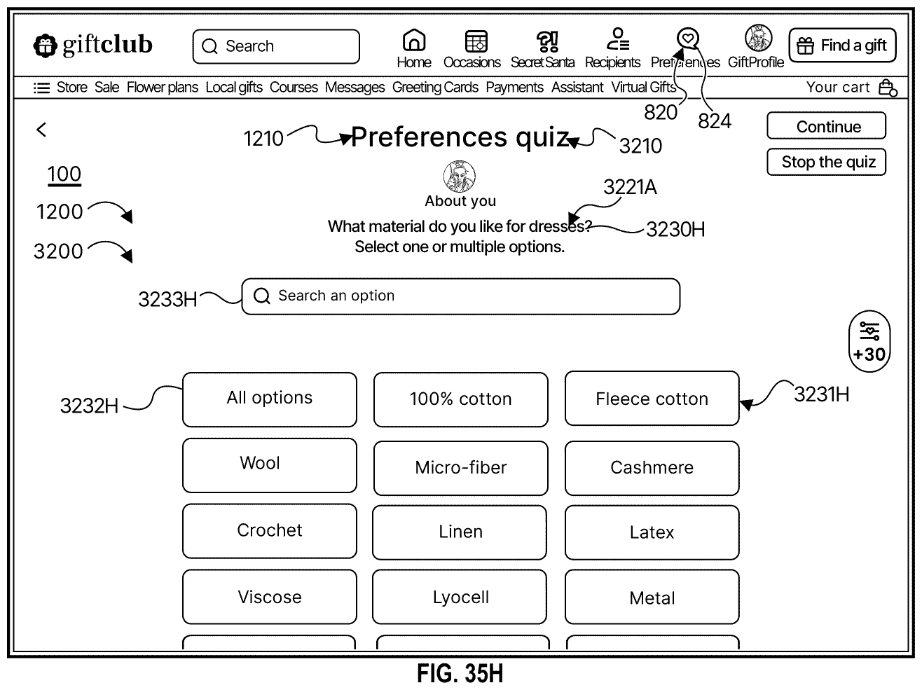

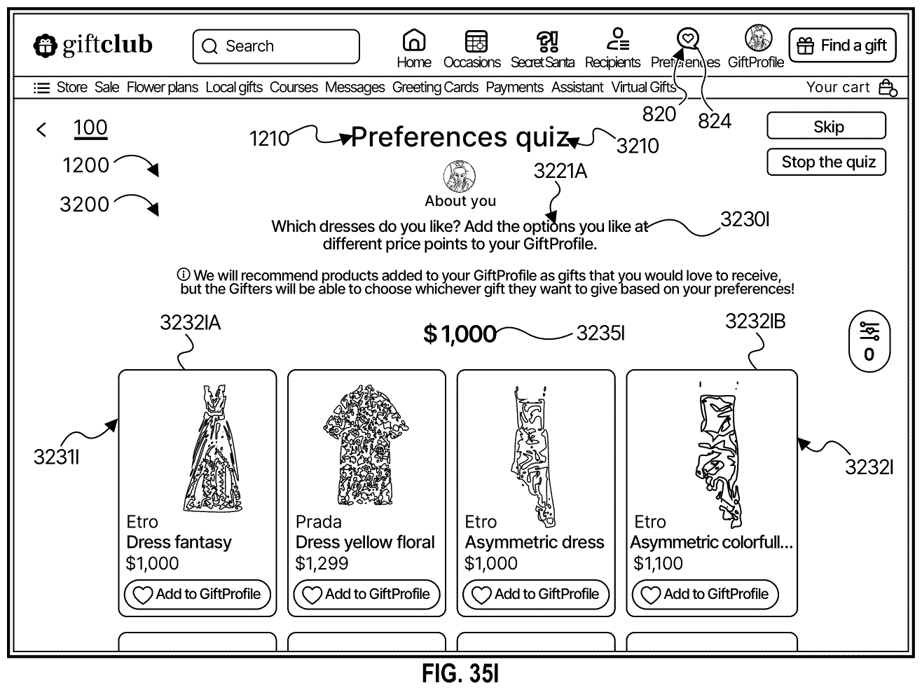

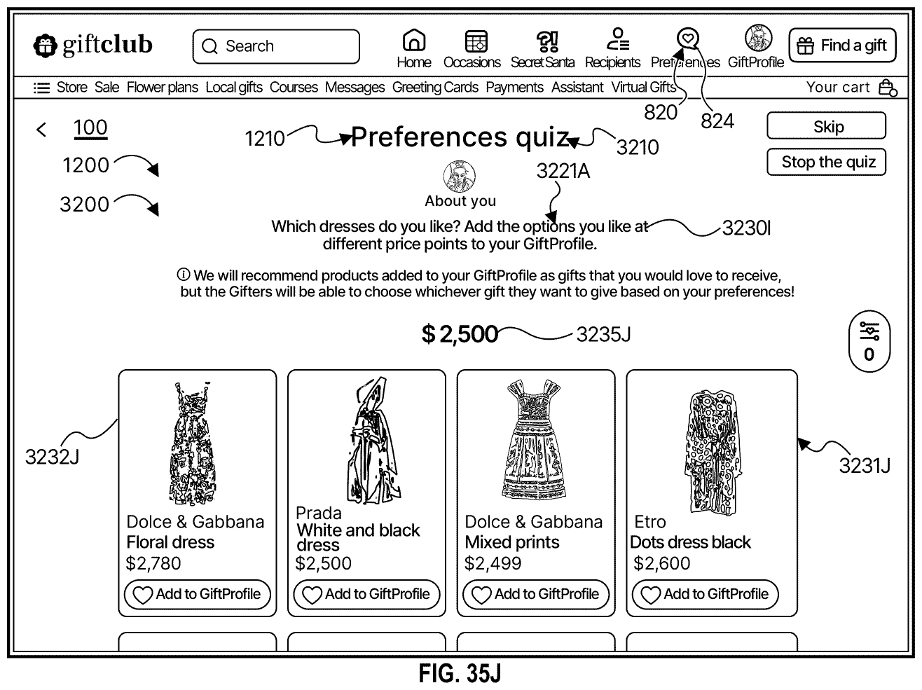

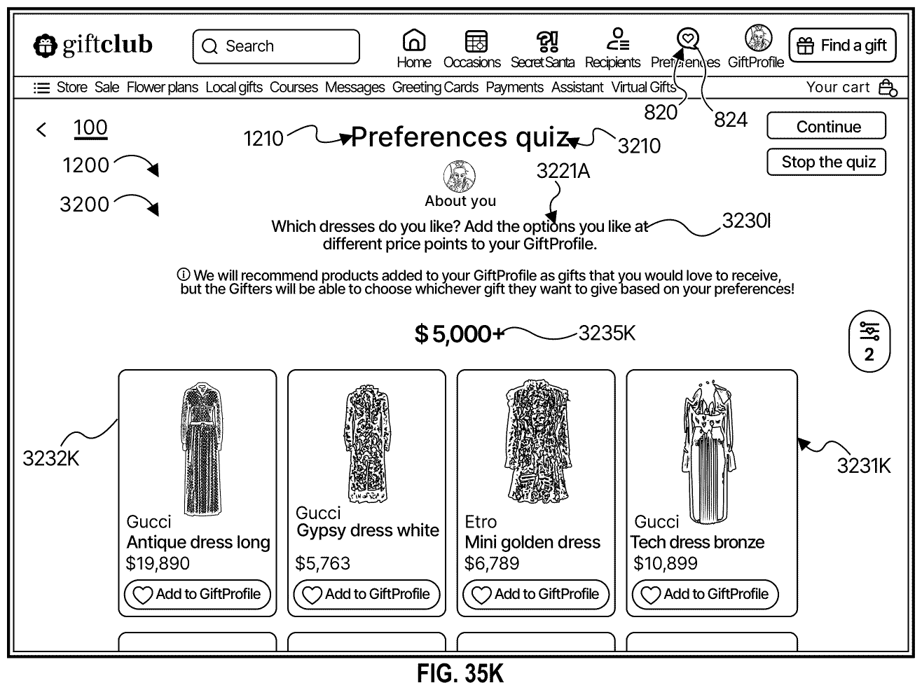

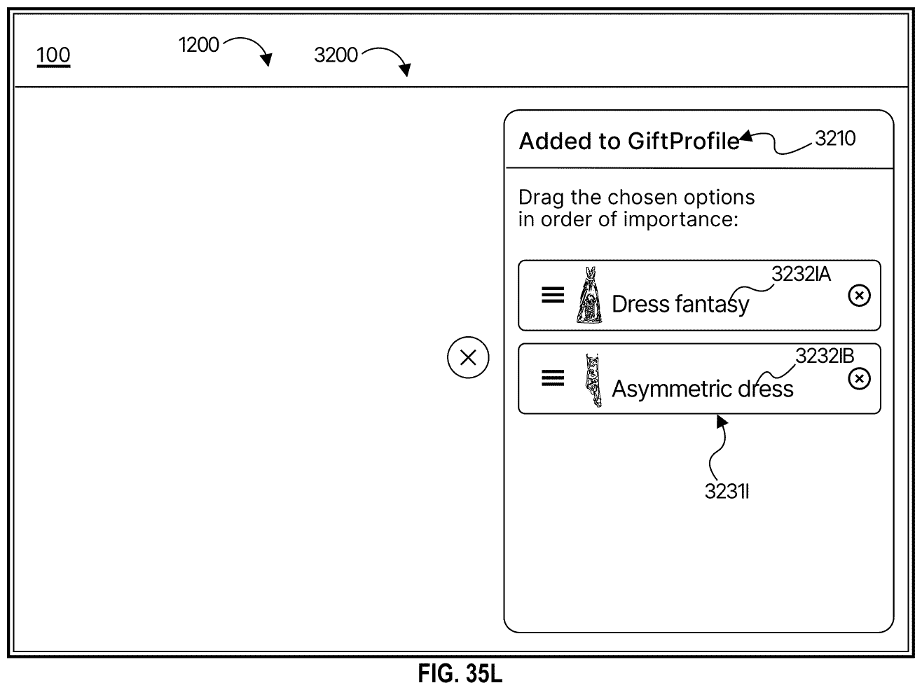

Additionally and/or alternatively, the gift preferences quiz 3210 can present one or more detailed gifter preference options for each of the gift subcategories 3221 as selected and/or ranked by the gifter. Turning to FIG. 35A, for example, the detailed gifter preference options can comprise detailed gifter preference options associated with the first selected gift subcategory 3221A of dresses within the selected broad gift category 3212A of clothing. The gift preferences quiz page 3200, for example, can present a third question 3230A regarding in which one or more first gift sub-subcategories 3231A within the first selected gift subcategory 3221A of dresses that the gifter would like to receive a gift and can permit the gifter to respond to the third question 3230A.

As illustrated in FIG. 35A, the first gift sub-subcategories 3231A can comprise one or more brands of dresses. To assist the gifter with responding to the third question 3230A, the gift preferences quiz page 3200 can present the first gift sub-subcategories 3231A and enable the gifter to select one or more relevant first gift sub-subcategories 3232A. In selected embodiments, the gift preferences quiz page 3200 can present search indicia 3233A for permitting the gifter to search for among the first gift sub-subcategories 3231A. The gift preferences quiz page 3200 optionally can enable the gifter to indicate an order of importance or otherwise rank the selected gift sub-subcategories 3232A in the manner shown and described above with reference to the selected broad gift categories 3212A-C of FIG. 33B.

The gift preferences quiz 3210 of FIG. 35B is illustrated as presenting one or more alternative detailed gifter preference options for each of the gift subcategories 3221 as selected and/or ranked by the gifter. Turning to FIG. 35B, for example, the detailed gifter preference options can comprise detailed gifter preference options associated with the first selected gift subcategory 3221A of dresses within the selected broad gift category 3212A of clothing. The gift preferences quiz page 3200, for example, can present a fourth question 3230B regarding in which one or more second gift sub-subcategories 3231B within the first selected gift subcategory 3221A of dresses that the gifter would like to receive a gift and can permit the gifter to respond to the fourth question 3230B.

As shown in FIG. 35B, the second gift sub-subcategories 3231B can comprise one or more dress sizes. To assist the gifter with responding to the fourth question 3230B, the gift preferences quiz page 3200 can present the second gift sub-subcategories 3231B and enable the gifter to select one or more relevant second gift sub-subcategories 3232B. In selected embodiments, the gift preferences quiz page 3200 can present search indicia 3233B for permitting the gifter to search for among the second gift sub-subcategories 3231B. The gift preferences quiz page 3200 optionally can enable the gifter to indicate an order of importance or otherwise rank the selected gift sub-subcategories 3232B in the manner shown and described above with reference to the selected broad gift categories 3212A-C of FIG. 33B.

Turning to FIG. 35C, the gift preferences quiz page 3200 optionally can present further detailed gifter preference options associated with the first selected gift subcategory 3221A of dresses within the selected broad gift category 3212A of clothing. The gift preferences quiz page 3200, for example, can present a fifth question 3230C regarding in which one or more third gift sub-subcategories 3231C within the first selected gift subcategory 3221A of dresses that the gifter would like to receive a gift and can permit the gifter to respond to the fifth question 3230C.

As illustrated in FIG. 35C, the third gift sub-subcategories 3231C can comprise one or more styles of dresses. To assist the gifter with responding to the fifth question 3230C, the gift preferences quiz page 3200 can present the third gift sub-subcategories 3231C and enable the gifter to select one or more relevant third gift sub-subcategories 3231C. In selected embodiments, the gift preferences quiz page 3200 can present search indicia 3233C for permitting the gifter to search for among the third gift sub-subcategories 3231C. The gift preferences quiz page 3200 optionally can enable the gifter to indicate an order of importance or otherwise rank the selected gift sub-subcategories 3232C in the manner shown and described above with reference to the selected broad gift categories 3212A-C of FIG. 33B.

Additionally and/or alternatively, the gift preferences quiz page 3200 can present a sixth question 3230D regarding in which one or more fourth gift sub-subcategories 3231D within the first selected gift subcategory 3221A of dresses that the gifter would like to receive a gift and can permit the gifter to respond to the six question 3230D. As shown in FIG. 35D, the fourth gift sub-subcategories 3231D can comprise one or more types of dresses. To assist the gifter with responding to the sixth question 3230D, the gift preferences quiz page 3200 can present the fourth gift sub-subcategories 3231D and enable the gifter to select one or more relevant fourth gift sub-subcategories 3231D.

The gift preferences quiz page 3200, in selected embodiments, can present search indicia 3233D for permitting the gifter to search for among the fourth gift sub-subcategories 3231D. The gift preferences quiz page 3200 optionally can enable the gifter to indicate an order of importance or otherwise rank the selected gift sub-subcategories 3232D in the manner shown and described above with reference to the selected broad gift categories 3212A-C of FIG. 33B.

Turning to FIG. 35E, the gift preferences quiz page 3200 likewise can present an optional seventh question 3230E regarding in which one or more fifth gift sub-subcategories 3231E within the first selected gift subcategory 3221A of dresses that the gifter would like to receive a gift and can permit the gifter to respond to the seventh question 3230E. As illustrated in FIG. 35E, the fifth gift sub-subcategories 3231E can comprise one or more necklines of dresses. To assist the gifter with responding to the seventh question 3230E, the gift preferences quiz page 3200 can present the fifth gift sub-subcategories 3231E and enable the gifter to select one or more relevant fifth gift sub-subcategories 3231E. In selected embodiments, the gift preferences quiz page 3200 can present search indicia 3233E for permitting the gifter to search for among the fifth gift sub-subcategories 3231E. The gift preferences quiz page 3200 optionally can enable the gifter to indicate an order of importance or otherwise rank the selected gift sub-subcategories 3232E in the manner shown and described above with reference to the selected broad gift categories 3212A-C of FIG. 33B.

FIG. 35F shows another alternative embodiment of the gift preferences quiz page 3200 that can present an eighth question 3230F regarding in which one or more sixth gift sub-subcategories 3231F within the first selected gift subcategory 3221A of dresses that the gifter would like to receive a gift and can permit the gifter to respond to the eighth question 3230F. As illustrated in FIG. 35F, the sixth gift sub-subcategories 3231F can comprise one or more colors of dresses. To assist the gifter with responding to the eighth question 3230F, the gift preferences quiz page 3200 can present the sixth gift sub-subcategories 3231F and enable the gifter to select one or more relevant sixth gift sub-subcategories 3231F.

The gift preferences quiz page 3200, in selected embodiments, can present search indicia 3233F for permitting the gifter to search for among the sixth gift sub-subcategories 3231F. The gift preferences quiz page 3200 optionally can enable the gifter to indicate an order of importance or otherwise rank the selected gift sub-subcategories 3232F in the manner shown and described above with reference to the selected broad gift categories 3212A-C of FIG. 33B.

The gift preferences quiz page 3200 of FIG. 35G is illustrated as presenting a ninth question 3230G regarding in which one or more seventh gift sub-subcategories 3231G within the first selected gift subcategory 3221A of dresses that the gifter would like to receive a gift and can permit the gifter to respond to the ninth question 3230G. As illustrated in FIG. 35G, the seventh gift sub-subcategories 3231G can comprise one or more patterns of dresses. To assist the gifter with responding to the ninth question 3230G, the gift preferences quiz page 3200 can present the seventh gift sub-subcategories 3231G and enable the gifter to select one or more relevant seventh gift sub-subcategories 3231G.

In selected embodiments, the gift preferences quiz page 3200 can present search indicia 3233G for permitting the gifter to search for among the seventh gift sub-subcategories 3231G. The gift preferences quiz page 3200 optionally can enable the gifter to indicate an order of importance or otherwise rank the selected gift sub-subcategories 3232G in the manner shown and described above with reference to the selected broad gift categories 3212A-C of FIG. 33B.

Additionally and/or alternatively, the gift preferences quiz page 3200 of FIG. 35H can present a tenth question 3230H regarding in which one or more eighth gift sub-subcategories 3231H within the first selected gift subcategory 3221A of dresses that the gifter would like to receive a gift and can permit the gifter to respond to the tenth question 3230H. As illustrated in FIG. 35H, the eighth gift sub-subcategories 3231H can comprise one or more dress materials. To assist the gifter with responding to the tenth question 3230H, the gift preferences quiz page 3200 can present the eighth gift sub-subcategories 3231H and enable the gifter to select one or more relevant eighth gift sub-subcategories 3231H.

The gift preferences quiz page 3200, in selected embodiments, can present search indicia 3233H for permitting the gifter to search for among the eighth gift sub-subcategories 3231H. The gift preferences quiz page 3200 optionally can enable the gifter to indicate an order of importance or otherwise rank the selected gift sub-subcategories 3232H in the manner shown and described above with reference to the selected broad gift categories 3212A-C of FIG. 33B.

Turning to FIGS. 35I-K, the gift preferences quiz page 3200 can enable the gifter to enter further preference information, such as a price point. As shown in FIG. 35I, for example, the gift preferences quiz page 3200 can present an eleventh question 3230I regarding a price point within the first selected gift subcategory 3221A of dresses that the gifter would like to receive a gift and can permit the gifter to respond to the eleventh question 3230I by entering a selected price point 32351. Based upon the selected price point 32351 and other preference information provided by the gifter, the gift preferences quiz page 3200 can present one or more gifts 3231I in the first selected gift subcategory 3221A based upon a result from the gift preferences quiz and enable the gifter to select at least one gift 32321 from the presented gifts 3231I. In other words, the gift preferences quiz page 3200 can permit the gifter to select a first dress 32321A and a second dress 32321B from among the presented gifts 3231I.

The gift preferences quiz page 3200 optionally can enable the gifter to indicate an order of importance or otherwise rank the presented selected gifts 32321 as illustrated in FIG. 35L. The gifter, for example, can be permitted to indicate the ranking by dragging the presented gifts 3231I to a predetermined order on the gift preferences quiz page 3200. As shown in FIG. 35L, the gifter, for example, can assign a first rank the first dress 3232IA that is greater than a second rank assigned to the second dress 3232IB.

The gift preferences quiz page 3200 of FIG. 35J can permit the gifter to select a second price point 3235J within the first selected gift subcategory 3221A of dresses that the gifter would like to receive a gift. As shown in FIG. 35J, the gift preferences quiz page 3200 can present a twelfth question 3230J regarding a price point within the first selected gift subcategory 3221A of dresses that the gifter would like to receive a gift and can permit the gifter to respond to the twelfth question 3230J by entering the selected second price point 3235J. Based upon the selected second price point 3235J and other preference information provided by the gifter, the gift preferences quiz page 3200 can present one or more gifts 3231J in the first selected gift subcategory 3221A based upon a result from the gift preferences quiz and enable the gifter to select at least one gift from the presented gifts 3231J. The gift preferences quiz page 3200 optionally can enable the gifter to indicate an order of importance or otherwise rank the presented selected gifts 3232J in the manner shown and described above with reference to the presented selected gifts 32321 of FIG. 35L.

As illustrated in FIG. 35K, the gift preferences quiz page 3200 can permit the gifter to select a third price point 3235K within the first selected gift subcategory 3221A of dresses that the gifter would like to receive a gift. As shown in FIG. 35K, the gift preferences quiz page 3200 can present a thirteenth question 3230K regarding a price point within the first selected gift subcategory 3221A of dresses that the gifter would like to receive a gift and can permit the gifter to respond to the thirteenth question 3230K by entering the selected third price point 3235K.

Based upon the selected third price point 3235K and other preference information provided by the gifter, the gift preferences quiz page 3200 can present one or more gifts 3231K in the first selected gift subcategory 3221A based upon a result from the gift preferences quiz and enable the gifter to select at least one gift from the presented gifts 3231K. The gift preferences quiz page 3200 optionally can enable the gifter to indicate an order of importance or otherwise rank the presented selected gifts 3232K in the manner shown and described above with reference to the presented gifts 32321 of FIG. 35L.

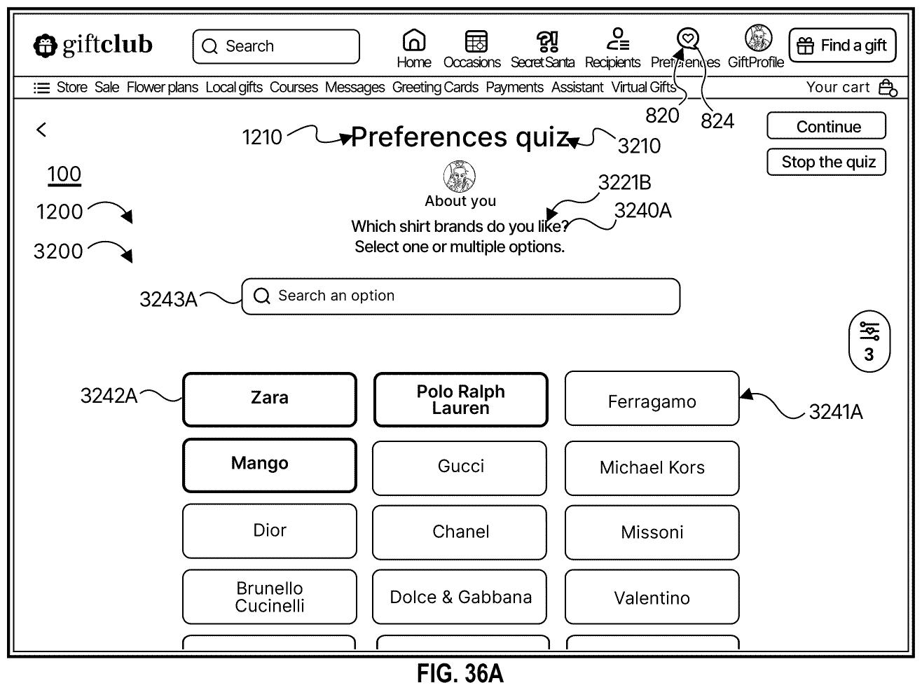

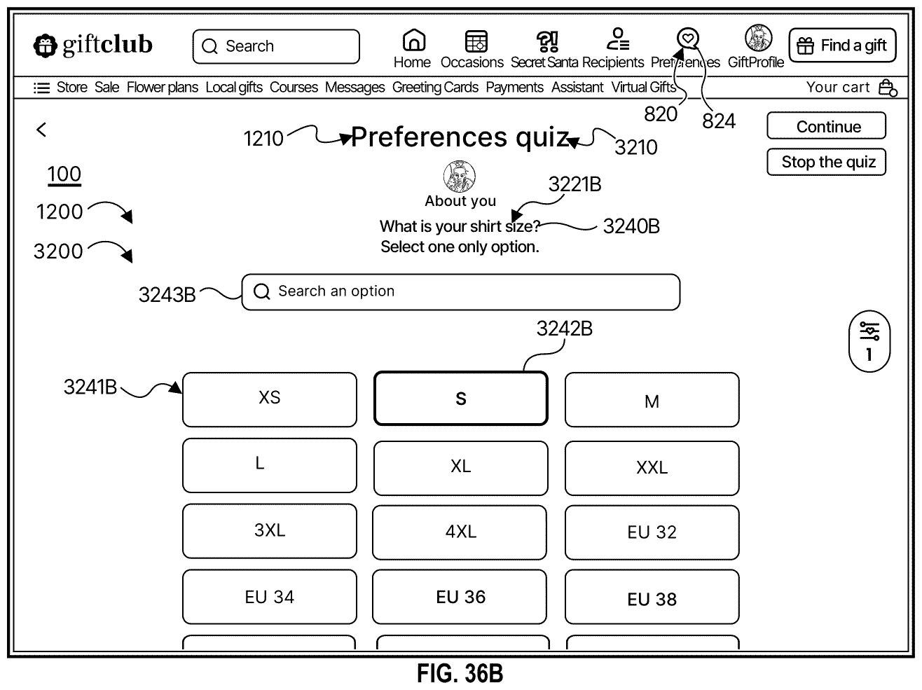

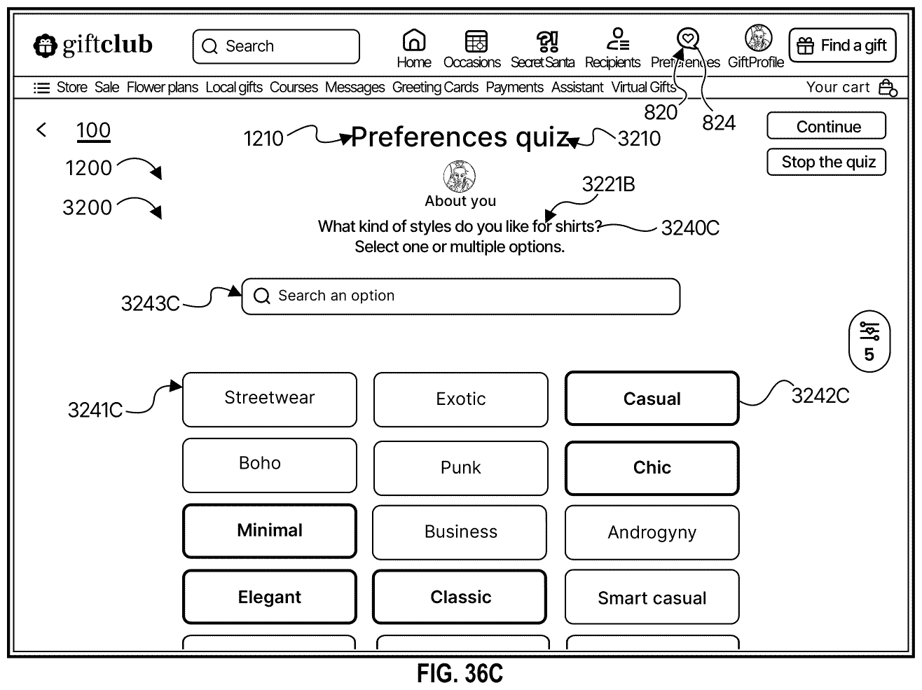

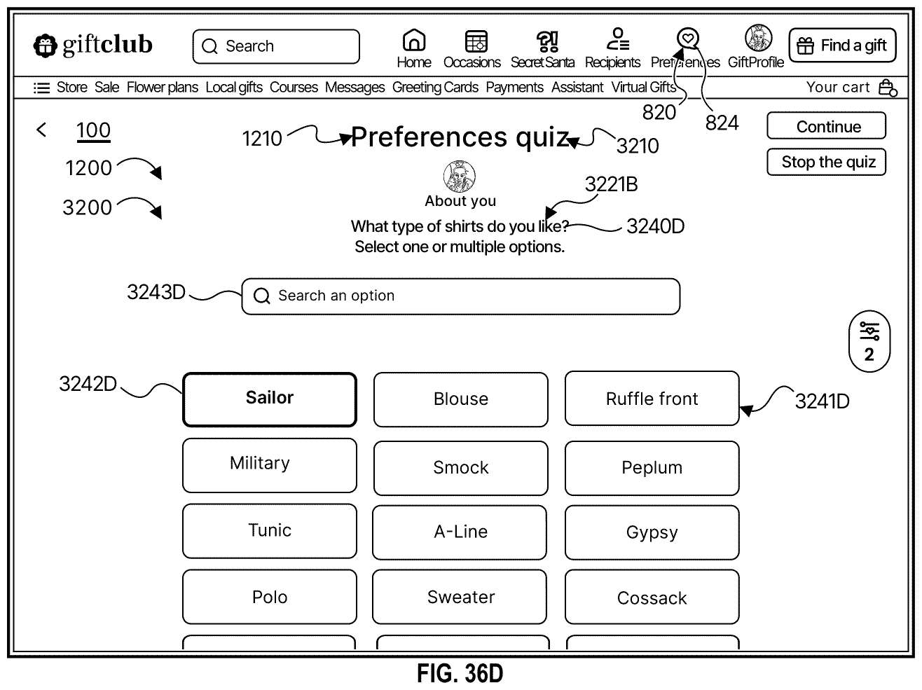

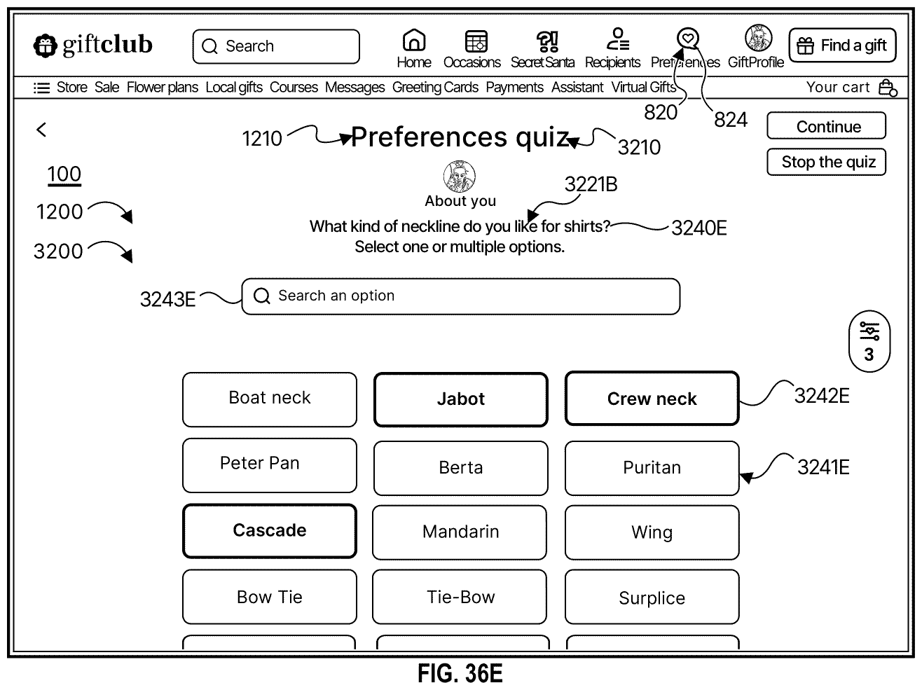

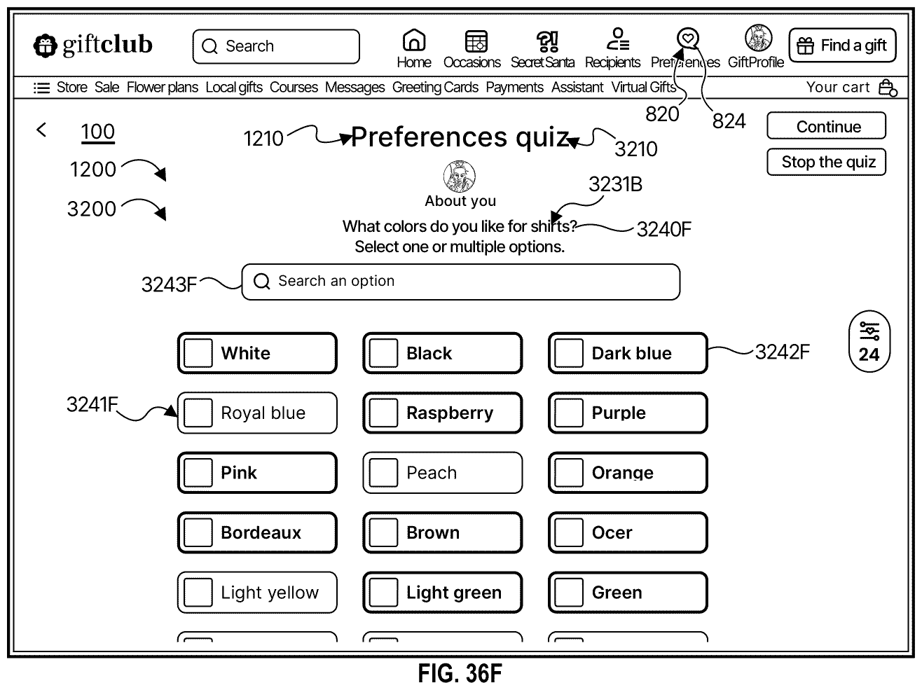

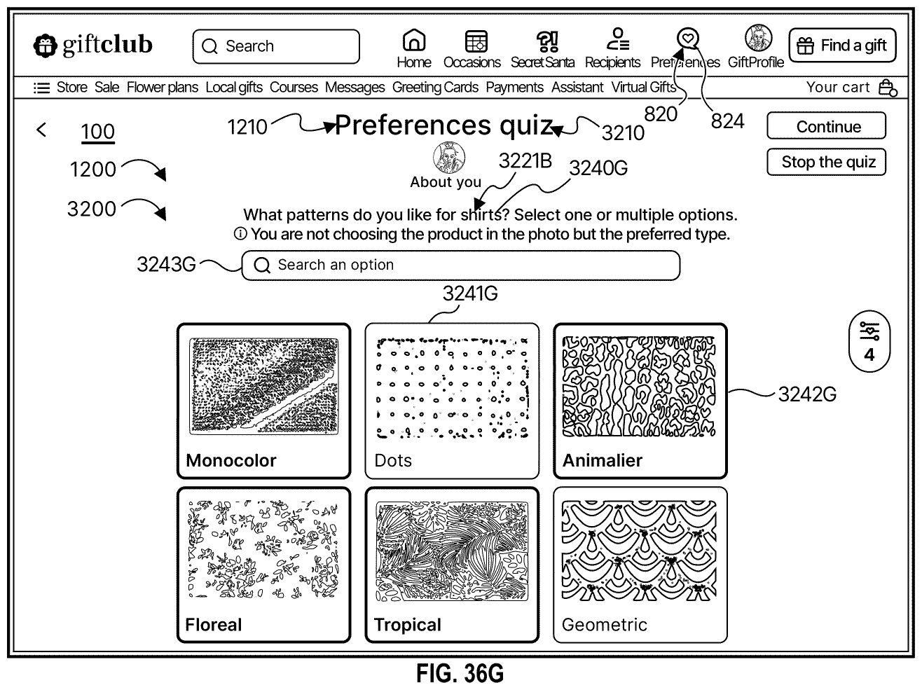

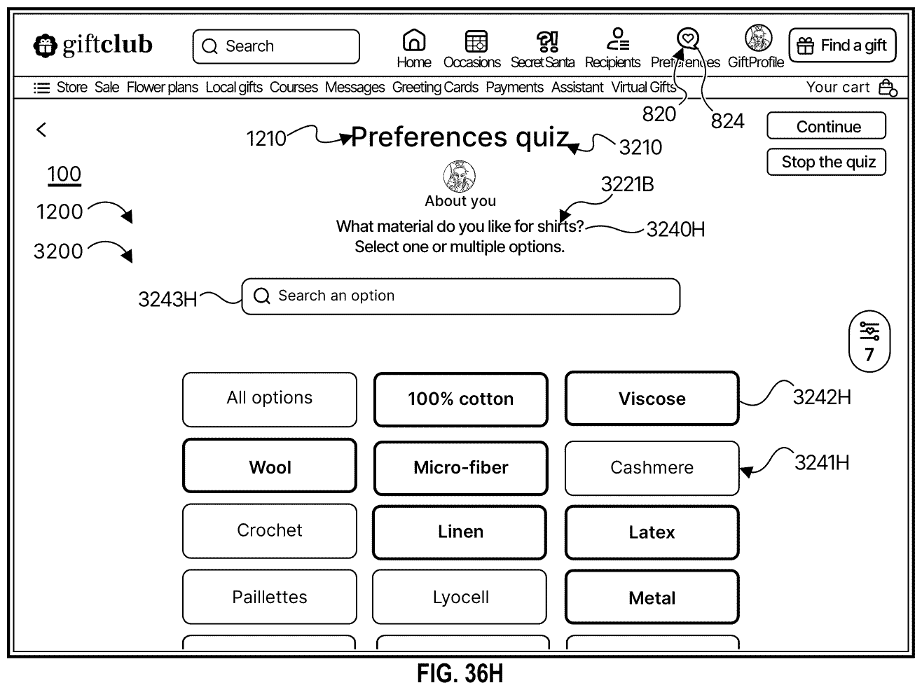

In selected embodiments, the gift preferences quiz 3210 can present one or more detailed gifter preference options for the second selected gift subcategory 3221B of shirts as selected and/or ranked by the gifter. Turning to FIG. 36A, for example, the detailed gifter preference options can comprise detailed gifter preference options associated with the second selected gift subcategory 3221B of shirts within the selected broad gift category 3212A of clothing. The gift preferences quiz page 3200, for example, can present a third question 3240A regarding in which one or more first gift sub-subcategories 3241A within the second selected gift subcategory 3221B of shirts that the gifter would like to receive a gift and can permit the gifter to respond to the third question 3240A.

As illustrated in FIG. 36A, the first gift sub-subcategories 3241A can comprise one or more brands of shirts. To assist the gifter with responding to the third question 3240A, the gift preferences quiz page 3200 can present the first gift sub-subcategories 3241A and enable the gifter to select one or more relevant first gift sub-subcategories 3242A. In selected embodiments, the gift preferences quiz page 3200 can present search indicia 3243A for permitting the gifter to search for among the first gift sub-subcategories 3241A. The gift preferences quiz page 3200 optionally can enable the gifter to indicate an order of importance or otherwise rank the selected gift sub-subcategories 3242A in the manner shown and described above with reference to the presented selected gifts 32321 as illustrated in FIG. 35L.

The gift preferences quiz 3210 of FIG. 36B is illustrated as presenting one or more alternative detailed gifter preference options for each of the gift subcategories 3221 as selected and/or ranked by the gifter. Turning to FIG. 36B, for example, the detailed gifter preference options can comprise detailed gifter preference options associated with the second selected gift subcategory 3221B of shirts within the selected broad gift category 3212A of clothing. The gift preferences quiz page 3200, for example, can present a fourth question 3240B regarding in which one or more second gift sub-subcategories 3241B within the second selected gift subcategory 3221B of shirts that the gifter would like to receive a gift and can permit the gifter to respond to the fourth question 3240B.

As shown in FIG. 36B, the second gift sub-subcategories 3241B can comprise one or more shirt sizes. To assist the gifter with responding to the fourth question 3240B, the gift preferences quiz page 3200 can present the second gift sub-subcategories 3241B and enable the gifter to select one or more relevant second gift sub-subcategories 3242B. In selected embodiments, the gift preferences quiz page 3200 can present search indicia 3243B for permitting the gifter to search for among the second gift sub-subcategories 3241B. The gift preferences quiz page 3200 optionally can enable the gifter to indicate an order of importance or otherwise rank the selected gift sub-subcategories 3242B in the manner shown and described above with reference to the presented selected gifts 32321 as illustrated in FIG. 35L.

Turning to FIG. 36C, the gift preferences quiz page 3200 optionally can present further detailed gifter preference options associated with the second selected gift subcategory 3221B of shirts within the selected broad gift category 3212A of clothing. The gift preferences quiz page 3200, for example, can present a fifth question 3240C regarding in which one or more third gift sub-subcategories 3241C within the second selected gift subcategory 3221B of shirts that the gifter would like to receive a gift and can permit the gifter to respond to the fifth question 3240C.

As illustrated in FIG. 36C, the third gift sub-subcategories 3241C can comprise one or more styles of shirts. To assist the gifter with responding to the fifth question 3240C, the gift preferences quiz page 3200 can present the third gift sub-subcategories 3241C and enable the gifter to select one or more relevant third gift sub-subcategories 3241C. In selected embodiments, the gift preferences quiz page 3200 can present search indicia 3243C for permitting the gifter to search for among the third gift sub-subcategories 3241C. The gift preferences quiz page 3200 optionally can enable the gifter to indicate an order of importance or otherwise rank the selected gift sub-subcategories 3242C in the manner shown and described above with reference to the presented selected gifts 32321 as illustrated in FIG. 35L.

Additionally and/or alternatively, the gift preferences quiz page 3200 can present a sixth question 3240D regarding in which one or more fourth gift sub-subcategories 3241D within the second selected gift subcategory 3221B of shirts that the gifter would like to receive a gift and can permit the gifter to respond to the six question 3240D. As shown in FIG. 36D, the fourth gift sub-subcategories 3241D can comprise one or more types of shirts. To assist the gifter with responding to the sixth question 3240D, the gift preferences quiz page 3200 can present the fourth gift sub-subcategories 3241D and enable the gifter to select one or more relevant fourth gift sub-subcategories 3241D.

The gift preferences quiz page 3200, in selected embodiments, can present search indicia 3243D for permitting the gifter to search for among the fourth gift sub-subcategories 3241D. The gift preferences quiz page 3200 optionally can enable the gifter to indicate an order of importance or otherwise rank the selected gift sub-subcategories 3242D in the manner shown and described above with reference to the presented selected gifts 32321 as illustrated in FIG. 35L.

Turning to FIG. 36E, the gift preferences quiz page 3200 likewise can present an optional seventh question 3240E regarding in which one or more fifth gift sub-subcategories 3241E within the second selected gift subcategory 3221B of shirts that the gifter would like to receive a gift and can permit the gifter to respond to the seventh question 3240E. As illustrated in FIG. 36E, the fifth gift sub-subcategories 3241E can comprise one or more necklines of shirts.

To assist the gifter with responding to the seventh question 3240E, the gift preferences quiz page 3200 can present the fifth gift sub-subcategories 3241E and enable the gifter to select one or more relevant fifth gift sub-subcategories 3241E. In selected embodiments, the gift preferences quiz page 3200 can present search indicia 3243E for permitting the gifter to search for among the fifth gift sub-subcategories 3241E. The gift preferences quiz page 3200 optionally can enable the gifter to indicate an order of importance or otherwise rank the selected gift sub-subcategories 3242E in the manner shown and described above with reference to the presented selected gifts 32321 as illustrated in FIG. 35L.

FIG. 36F shows another alternative embodiment of the gift preferences quiz page 3200 that can present an eighth question 3240F regarding in which one or more sixth gift sub-subcategories 3241F within the second selected gift subcategory 3221B of shirts that the gifter would like to receive a gift and can permit the gifter to respond to the eighth question 3240F. As illustrated in FIG. 36F, the sixth gift sub-subcategories 3241F can comprise one or more colors of shirts. To assist the gifter with responding to the eighth question 3240F, the gift preferences quiz page 3200 can present the sixth gift sub-subcategories 3241F and enable the gifter to select one or more relevant sixth gift sub-subcategories 3241F.

The gift preferences quiz page 3200, in selected embodiments, can present search indicia 3243F for permitting the gifter to search for among the sixth gift sub-subcategories 3241F. The gift preferences quiz page 3200 optionally can enable the gifter to indicate an order of importance or otherwise rank the selected gift sub-subcategories 3242F in the manner shown and described above with reference to the presented selected gifts 32321 as illustrated in FIG. 35L.

The gift preferences quiz page 3200 of FIG. 36G is illustrated as presenting a ninth question 3240G regarding in which one or more seventh gift sub-subcategories 3241G within the second selected gift subcategory 3221B of shirts that the gifter would like to receive a gift and can permit the gifter to respond to the ninth question 3240G. As illustrated in FIG. 36G, the seventh gift sub-subcategories 3241G can comprise one or more patterns of shirts. To assist the gifter with responding to the ninth question 3240G, the gift preferences quiz page 3200 can present the seventh gift sub-subcategories 3241G and enable the gifter to select one or more relevant seventh gift sub-subcategories 3241G.

In selected embodiments, the gift preferences quiz page 3200 can present search indicia 3243G for permitting the gifter to search for among the seventh gift sub-subcategories 3241G. The gift preferences quiz page 3200 optionally can enable the gifter to indicate an order of importance or otherwise rank the selected gift sub-subcategories 3242G in the manner shown and described above with reference to the presented selected gifts 32321 as illustrated in FIG. 35L.

Additionally and/or alternatively, the gift preferences quiz page 3200 of FIG. 36H can present a tenth question 3240H regarding in which one or more eighth gift sub-subcategories 3241H within the second selected gift subcategory 3221B of shirts that the gifter would like to receive a gift and can permit the gifter to respond to the tenth question 3240H. As illustrated in FIG. 36H, the eighth gift sub-subcategories 3241H can comprise one or more shirt materials. To assist the gifter with responding to the tenth question 3240H, the gift preferences quiz page 3200 can present the eighth gift sub-subcategories 3241H and enable the gifter to select one or more relevant eighth gift sub-subcategories 3241H.

The gift preferences quiz page 3200, in selected embodiments, can present search indicia 3243H for permitting the gifter to search for among the eighth gift sub-subcategories 3241H. The gift preferences quiz page 3200 optionally can enable the gifter to indicate an order of importance or otherwise rank the selected gift sub-subcategories 3242H in the manner shown and described above with reference to the presented selected gifts 32321 as illustrated in FIG. 35L.

Turning to FIG. 36I, the gift preferences quiz page 3200 can enable the gifter to enter further preference information, such as a price point, in the manner discussed with reference to the price point of FIGS. 35I-L. As shown in FIG. 36I, for example, the gift preferences quiz page 3200 can present an eleventh question 3240I regarding a price point within the second selected gift subcategory 3221B of shirts that the gifter would like to receive a gift and can permit the gifter to respond to the eleventh question 3240I by entering a selected price point 32451.

Based upon the selected price point 32451 and other preference information provided by the gifter, the gift preferences quiz page 3200 can present one or more gifts 32411 in the first selected gift subcategory 3221A based upon a result from the gift preferences quiz and enable the gifter to select at least one gift 32421 from the presented gifts 32411. The gift preferences quiz page 3200 optionally can enable the gifter to indicate an order of importance or otherwise rank the presented selected gifts 3242K in the manner shown and described above with reference to the presented selected gifts 32421 of FIG. 35L.

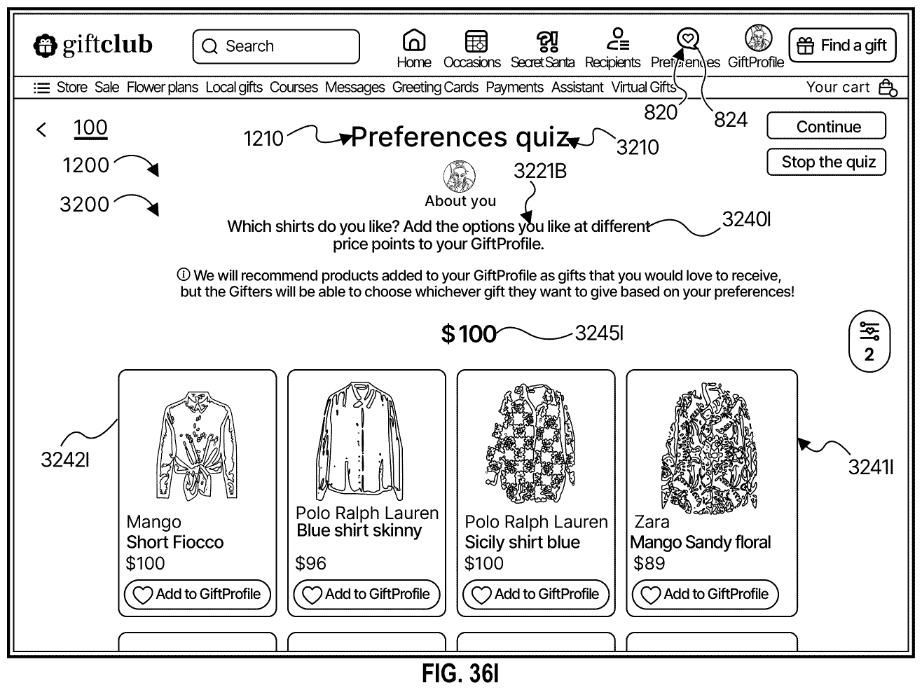

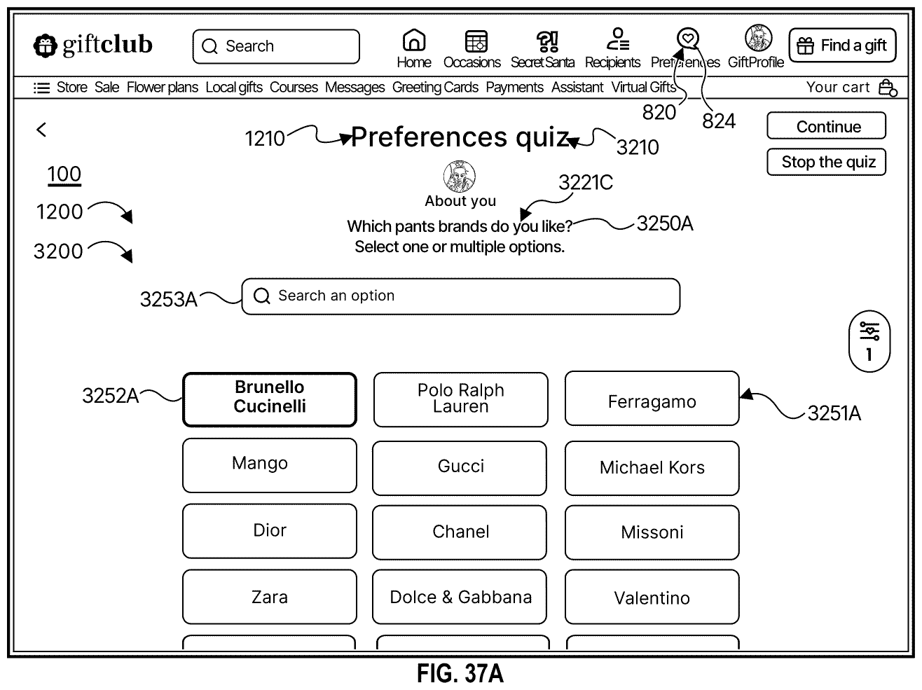

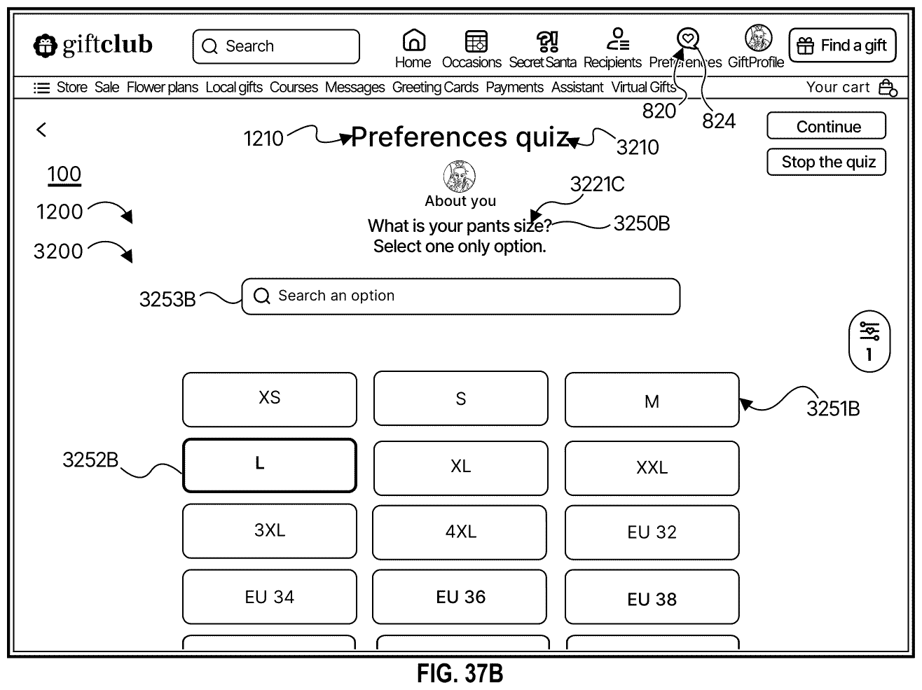

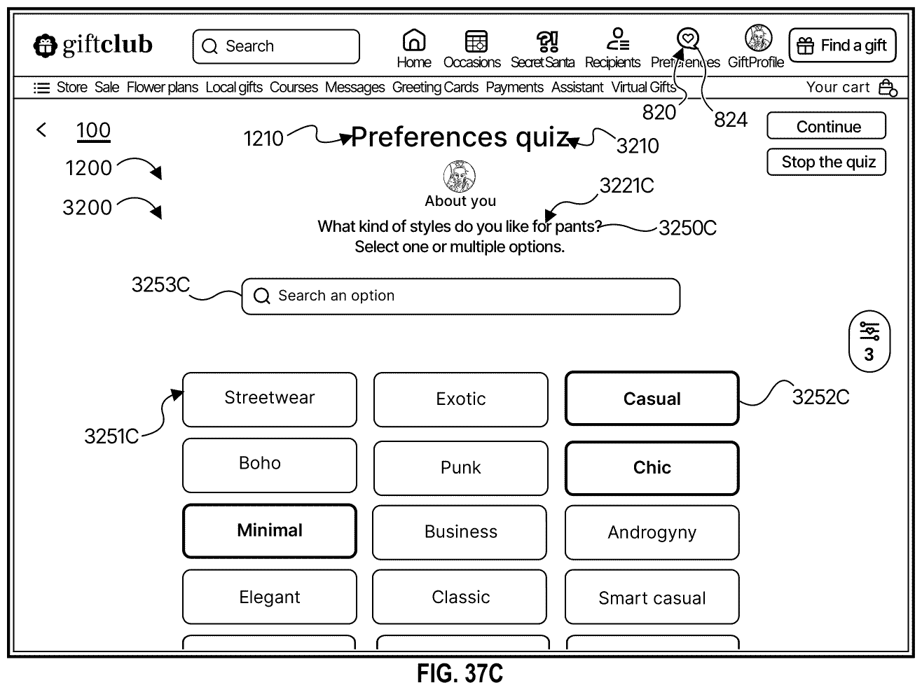

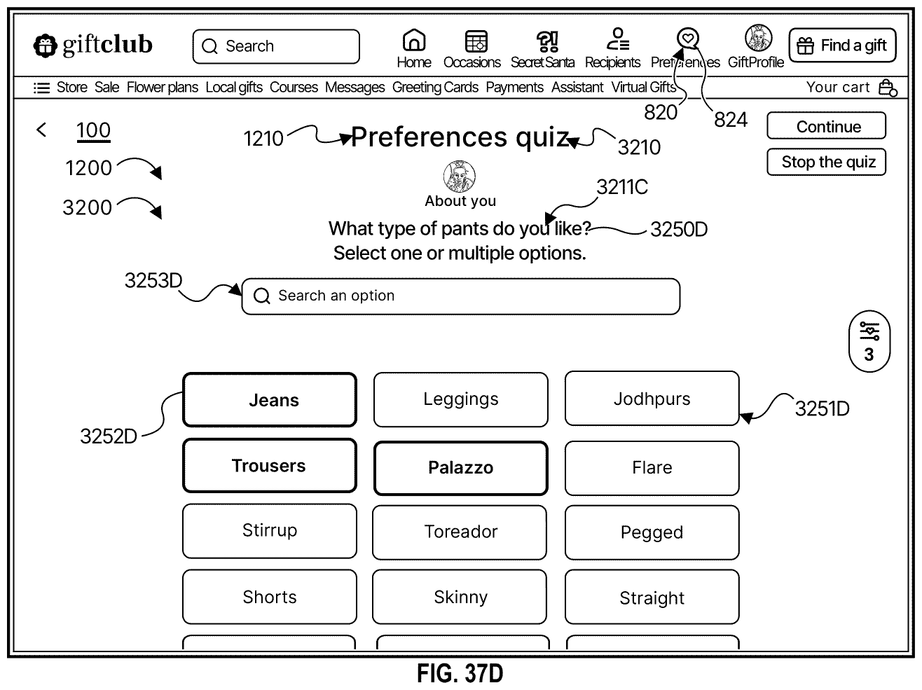

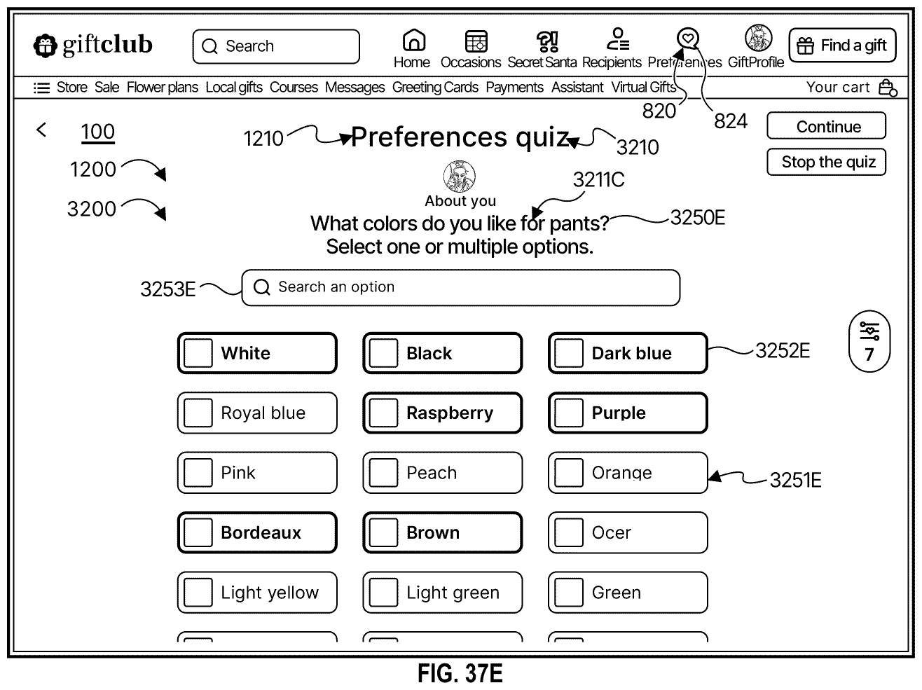

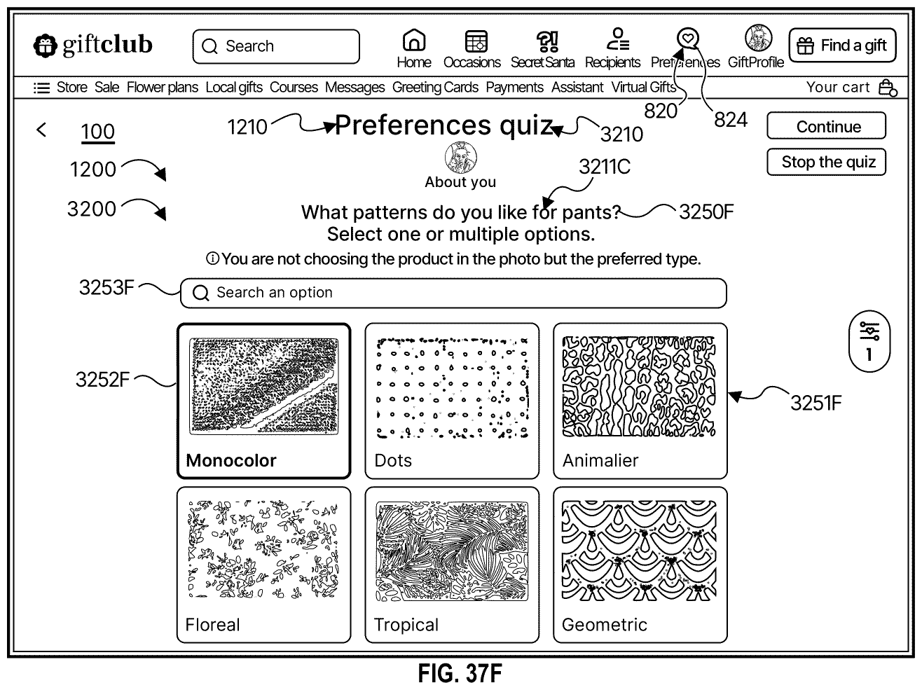

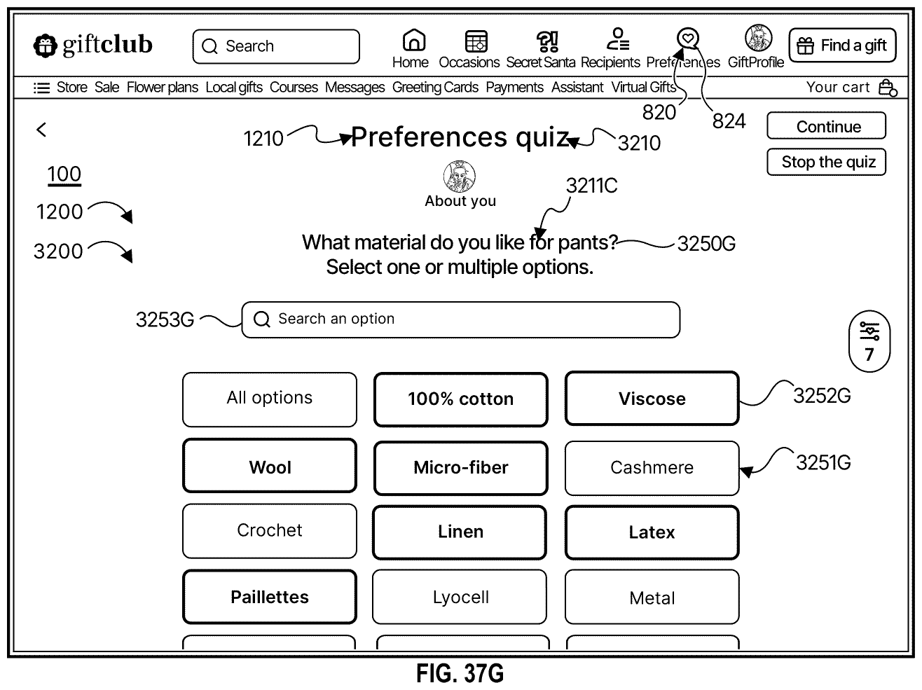

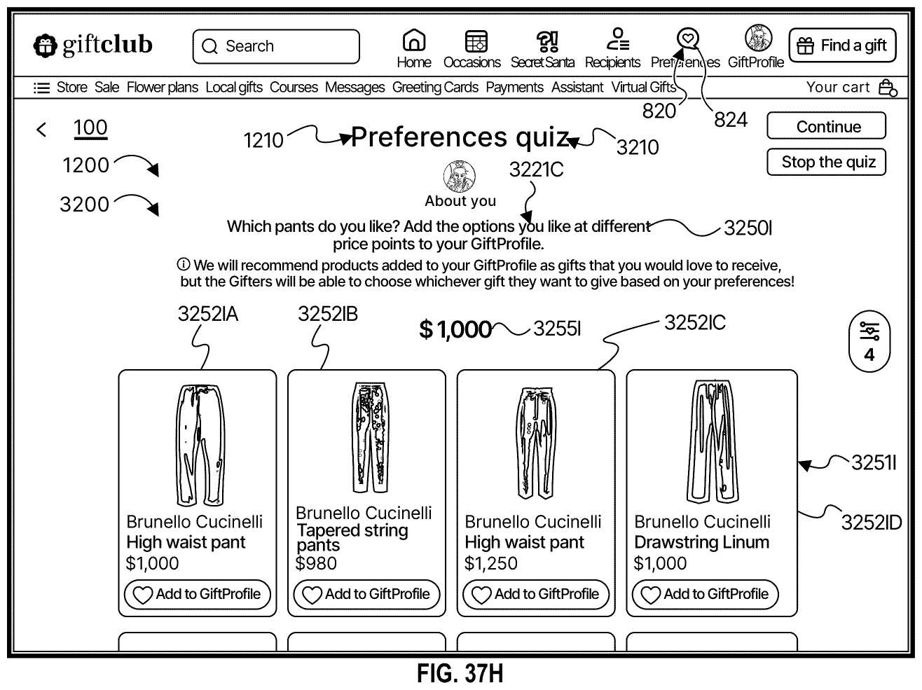

In selected embodiments, the gift preferences quiz 3210 can present one or more detailed gifter preference options for the third selected gift subcategory 3221C of pants as selected and/or ranked by the gifter. Turning to FIG. 37A, for example, the detailed gifter preference options can comprise detailed gifter preference options associated with the third selected gift subcategory 3221C of pants within the selected broad gift category 3212A of clothing. The gift preferences quiz page 3200, for example, can present a third question 3250A regarding in which one or more first gift sub-subcategories 3251A within the third selected gift subcategory 3221C of pants that the gifter would like to receive a gift and can permit the gifter to respond to the third question 3250A.

As illustrated in FIG. 37A, the first gift sub-subcategories 3251A can comprise one or more brands of pants. To assist the gifter with responding to the third question 3250A, the gift preferences quiz page 3200 can present the first gift sub-subcategories 3251A and enable the gifter to select one or more relevant first gift sub-subcategories 3252A. In selected embodiments, the gift preferences quiz page 3200 can present search indicia 3253A for permitting the gifter to search for among the first gift sub-subcategories 3251A. The gift preferences quiz page 3200 optionally can enable the gifter to indicate an order of importance or otherwise rank the selected gift sub-subcategories 3252A in the manner shown and described above with reference to the presented selected gifts 32321 as illustrated in FIG. 35L.

The gift preferences quiz 3210 of FIG. 37B is illustrated as presenting one or more alternative detailed gifter preference options for each of the gift subcategories 3221 as selected and/or ranked by the gifter. Turning to FIG. 37B, for example, the detailed gifter preference options can comprise detailed gifter preference options associated with the third selected gift subcategory 3221C of pants within the selected broad gift category 3212A of clothing. The gift preferences quiz page 3200, for example, can present a fourth question 3250B regarding in which one or more second gift sub-subcategories 3251B within the third selected gift subcategory 3221C of pants that the gifter would like to receive a gift and can permit the gifter to respond to the fourth question 3250B.

As shown in FIG. 37B, the second gift sub-subcategories 3251B can comprise one or more pant sizes. To assist the gifter with responding to the fourth question 3250B, the gift preferences quiz page 3200 can present the second gift sub-subcategories 3251B and enable the gifter to select one or more relevant second gift sub-subcategories 3252B. In selected embodiments, the gift preferences quiz page 3200 can present search indicia 3253B for permitting the gifter to search for among the second gift sub-subcategories 3251B. The gift preferences quiz page 3200 optionally can enable the gifter to indicate an order of importance or otherwise rank the selected gift sub-subcategories 3252B in the manner shown and described above with reference to the presented selected gifts 32321 as illustrated in FIG. 35L.

Turning to FIG. 37C, the gift preferences quiz page 3200 optionally can present further detailed gifter preference options associated with the third selected gift subcategory 3221C of pants within the selected broad gift category 3212A of clothing. The gift preferences quiz page 3200, for example, can present a fifth question 3250C regarding in which one or more third gift sub-subcategories 3251C within the third selected gift subcategory 3221C of pants that the gifter would like to receive a gift and can permit the gifter to respond to the fifth question 3250C.

As illustrated in FIG. 37C, the third gift sub-subcategories 3251C can comprise one or more styles of pants. To assist the gifter with responding to the fifth question 3250C, the gift preferences quiz page 3200 can present the third gift sub-subcategories 3251C and enable the gifter to select one or more relevant third gift sub-subcategories 3251C. In selected embodiments, the gift preferences quiz page 3200 can present search indicia 3253C for permitting the gifter to search for among the third gift sub-subcategories 3251C. The gift preferences quiz page 3200 optionally can enable the gifter to indicate an order of importance or otherwise rank the selected gift sub-subcategories 3252C in the manner shown and described above with reference to the presented selected gifts 32321 as illustrated in FIG. 35L.

Additionally and/or alternatively, the gift preferences quiz page 3200 can present a sixth question 3250D regarding in which one or more fourth gift sub-subcategories 3251D within the third selected gift subcategory 3221C of pants that the gifter would like to receive a gift and can permit the gifter to respond to the six question 3250D. As shown in FIG. 37D, the fourth gift sub-subcategories 3251D can comprise one or more types of pants. To assist the gifter with responding to the sixth question 3250D, the gift preferences quiz page 3200 can present the fourth gift sub-subcategories 3251D and enable the gifter to select one or more relevant fourth gift sub-subcategories 3251D.

The gift preferences quiz page 3200, in selected embodiments, can present search indicia 3253D for permitting the gifter to search for among the fourth gift sub-subcategories 3251D. The gift preferences quiz page 3200 optionally can enable the gifter to indicate an order of importance or otherwise rank the selected gift sub-subcategories 3252D in the manner shown and described above with reference to the presented selected gifts 32321 as illustrated in FIG. 35L.

FIG. 37E shows another alternative embodiment of the gift preferences quiz page 3200 that can present a seventh question 3250E regarding in which one or more fifth gift sub-subcategories 3251E within the third selected gift subcategory 3221C of pants that the gifter would like to receive a gift and can permit the gifter to respond to the seventh question 3250E.

As illustrated in FIG. 37E, the fifth gift sub-subcategories 3251E can comprise one or more colors of pants. To assist the gifter with responding to the eighth question 3250E, the gift preferences quiz page 3200 can present the fifth gift sub-subcategories 3251E and enable the gifter to select one or more relevant fifth gift sub-subcategories 3251E.

The gift preferences quiz page 3200, in selected embodiments, can present search indicia 3253E for permitting the gifter to search for among the fifth gift sub-subcategories 3251E. The gift preferences quiz page 3200 optionally can enable the gifter to indicate an order of importance or otherwise rank the selected gift sub-subcategories 3252E in the manner shown and described above with reference to the presented selected gifts 32321 as illustrated in FIG. 35L.

The gift preferences quiz page 3200 of FIG. 37F is illustrated as presenting a eight question 3250F regarding in which one or more sixth gift sub-subcategories 3251F within the third selected gift subcategory 3221C of pants that the gifter would like to receive a gift and can permit the gifter to respond to the eight question 3250F. As illustrated in FIG. 37F, the sixth gift sub-subcategories 3251F can comprise one or more patterns of pants. To assist the gifter with responding to the ninth question 3250F, the gift preferences quiz page 3200 can present the sixth gift sub-subcategories 3251F and enable the gifter to select one or more relevant sixth gift sub-subcategories 3251F.

In selected embodiments, the gift preferences quiz page 3200 can present search indicia 3253F for permitting the gifter to search for among the sixth gift sub-subcategories 3251F. The gift preferences quiz page 3200 optionally can enable the gifter to indicate an order of importance or otherwise rank the selected gift sub-subcategories 3252F in the manner shown and described above with reference to the presented selected gifts 32321 as illustrated in FIG. 35L.

Additionally and/or alternatively, the gift preferences quiz page 3200 of FIG. 37G can present a ninth question 3250G regarding in which one or more seventh gift sub-subcategories 3251G within the third selected gift subcategory 3221C of pants that the gifter would like to receive a gift and can permit the gifter to respond to the ninth question 3250G. As illustrated in FIG. 37G, the seventh gift sub-subcategories 3251G can comprise one or more pant materials. To assist the gifter with responding to the tenth question 3250G, the gift preferences quiz page 3200 can present the seventh gift sub-subcategories 3251G and enable the gifter to select one or more relevant seventh gift sub-subcategories 3251G.

The gift preferences quiz page 3200, in selected embodiments, can present search indicia 3253G for permitting the gifter to search for among the seventh gift sub-subcategories 3251G. The gift preferences quiz page 3200 optionally can enable the gifter to indicate an order of importance or otherwise rank the selected gift sub-subcategories 3252G in the manner shown and described above with reference to the presented selected gifts 32321 as illustrated in FIG. 35L.

Turning to FIG. 37H, the gift preferences quiz page 3200 can enable the gifter to enter further preference information, such as a price point 32551. As shown in FIG. 37H, for example, the gift preferences quiz page 3200 can present a tenth question 32501 regarding a price point within the third selected gift subcategory 3221C of pants that the gifter would like to receive a gift and can permit the gifter to respond to the tenth question 32501 by entering the selected price point 32551. Based upon the selected price point 32551 and other preference information provided by the gifter, the gift preferences quiz page 3200 can present one or more gifts 3251I in the third selected gift subcategory 3221C based upon a result from the gift preferences quiz and enable the gifter to select at least one gift 32521 from the presented gifts 3251I. In other words, the gift preferences quiz page 3200 can permit the gifter to select first pants 3252IA, second pants 3252IB, third pants 3252IC and/or fourth pants 3252ID from among the presented gifts 3251I.

The gift preferences quiz page 3200 optionally can enable the gifter to indicate an order of importance or otherwise rank the presented selected gifts 32521 as illustrated in FIG. 37I. The gifter, for example, can be permitted to indicate the ranking by dragging the presented gifts 3251I to a predetermined order on the gift preferences quiz page 3200. As shown in FIG. 37I, the gifter, for example, can assign a first ranking the second pants 3252IB, a second ranking to the fourth pants 3252ID, a third ranking to the third pants 3252IC and a fourth ranking to the first pants 3252IA.

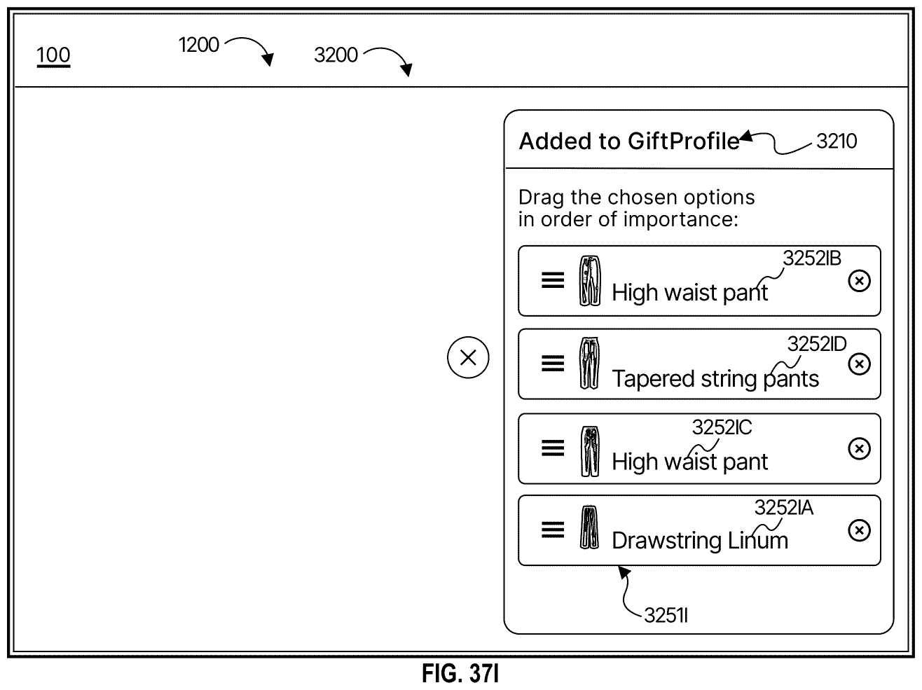

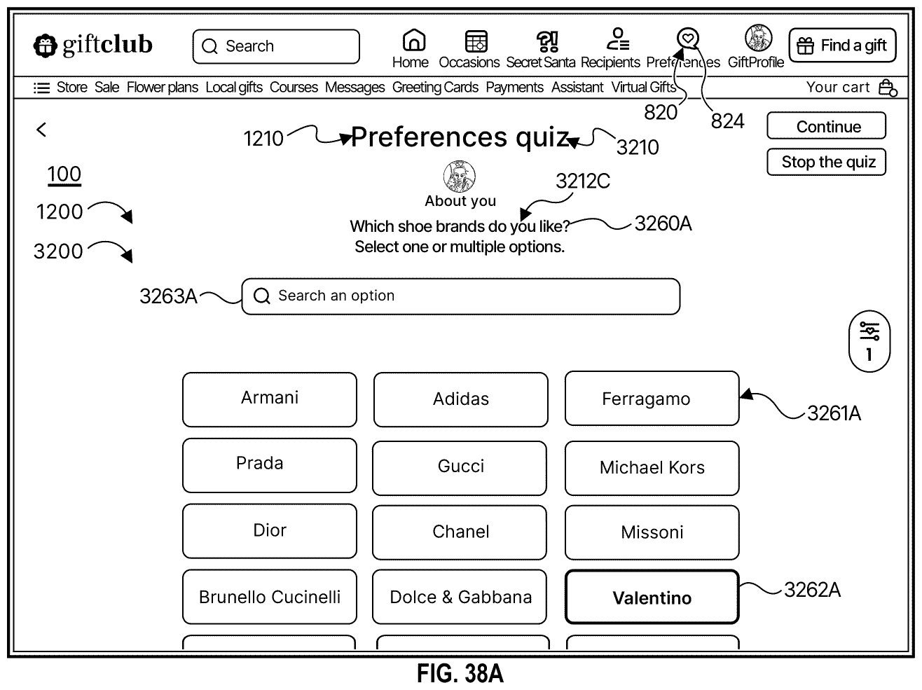

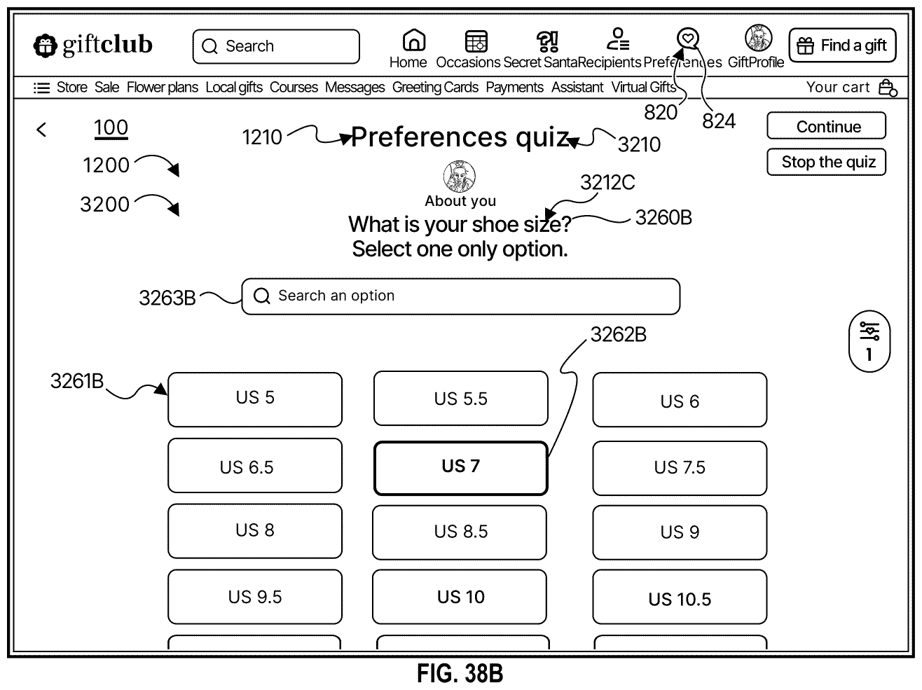

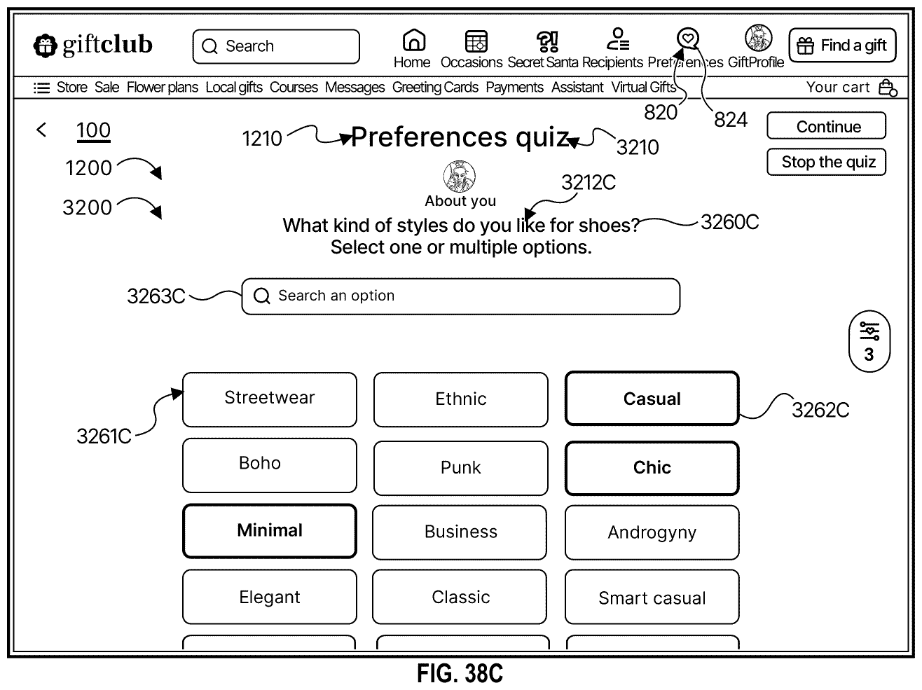

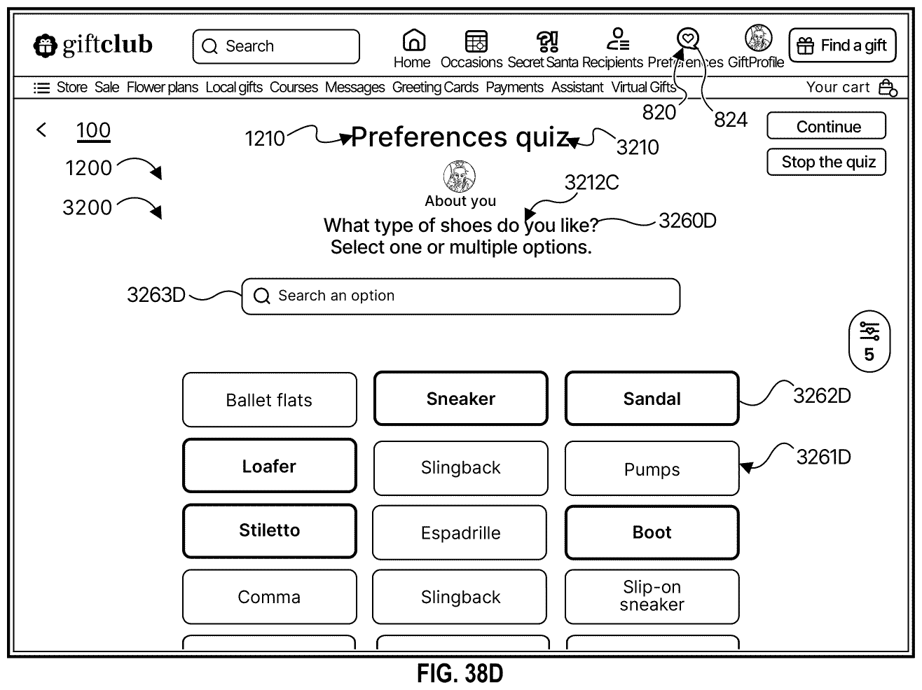

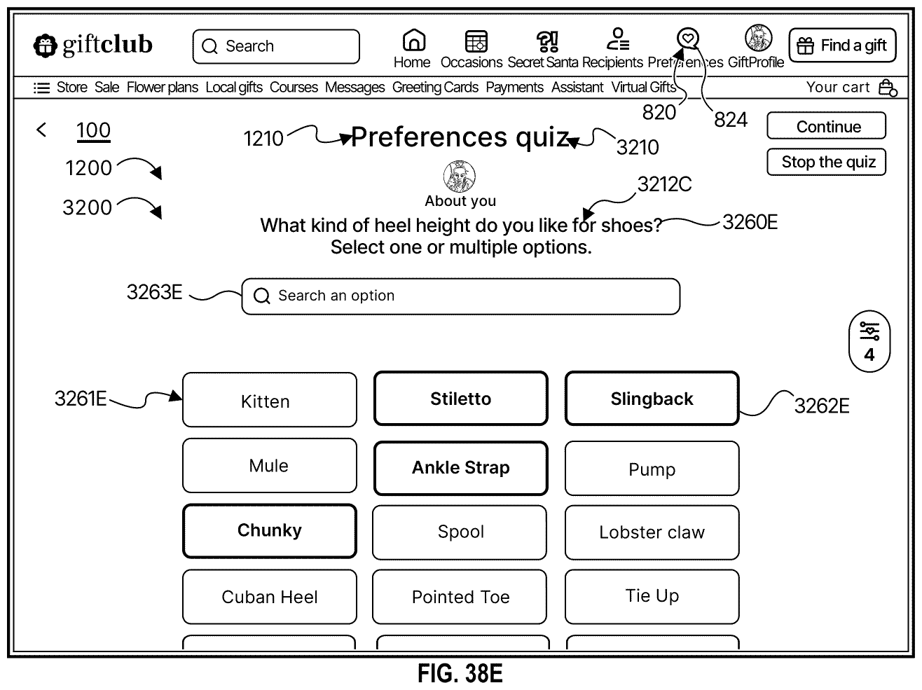

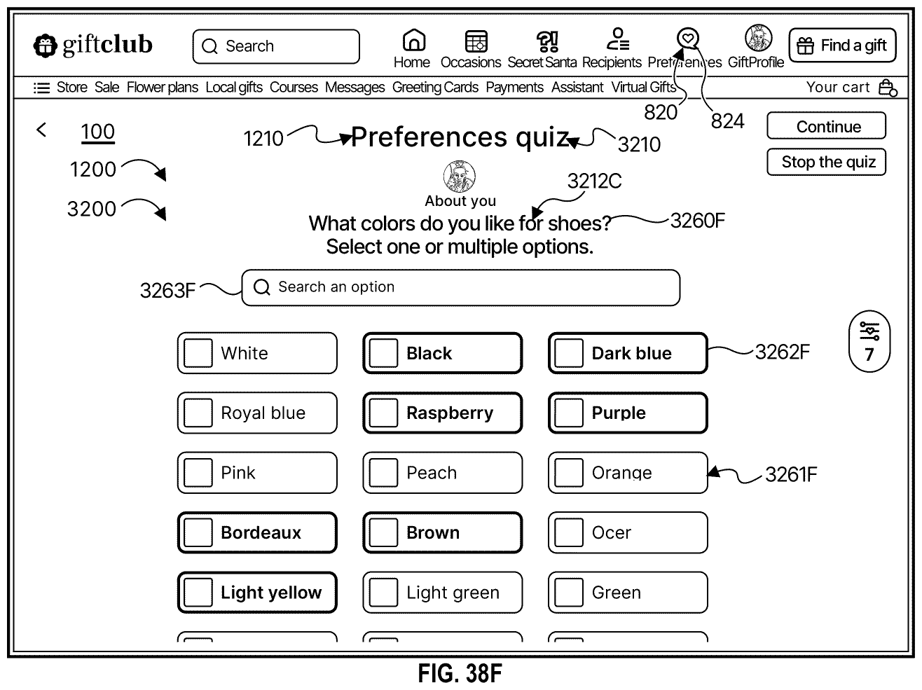

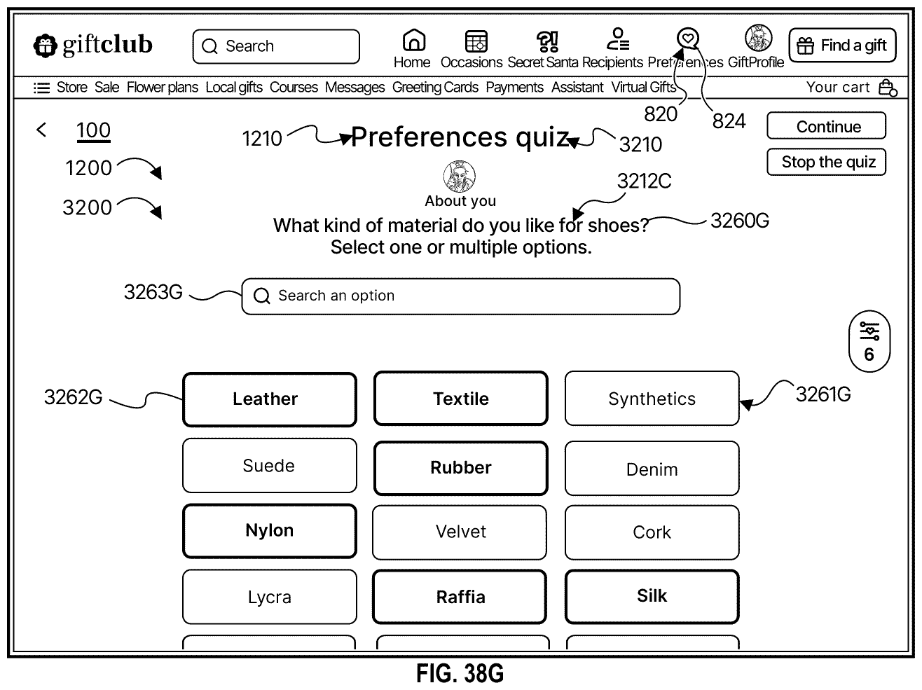

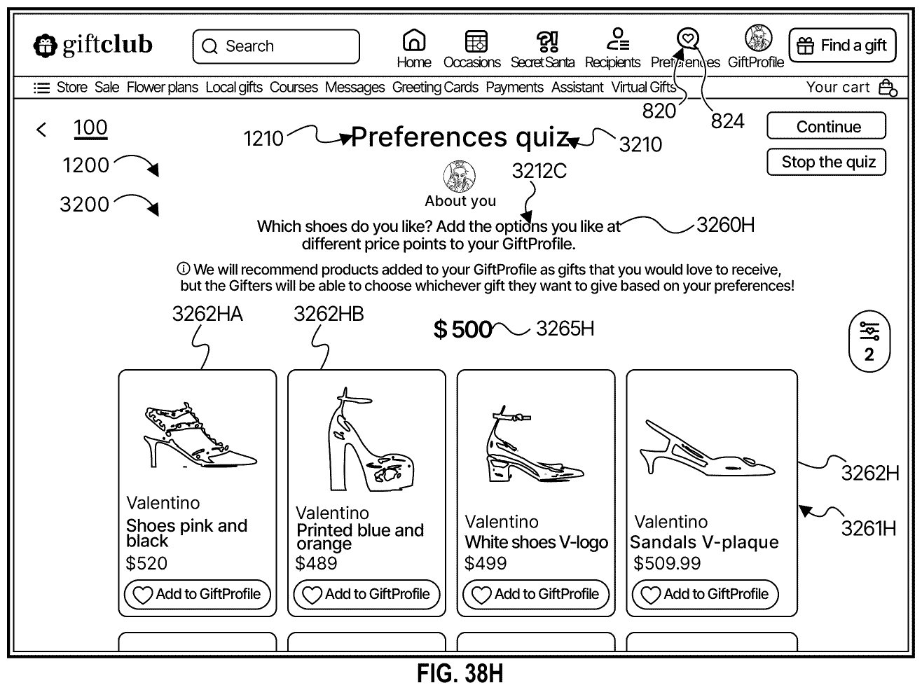

Additionally and/or alternatively, the gift preferences quiz 3210 can present one or more detailed gifter preference options for the second selected broad gift category 3212C as shown in FIGS. 38A-I. In the manner discussed above with reference to FIGS. 33A-B, the second selected broad gift category 3212C can comprise a second-highest ranking broad gift category 3211 (after the highest-ranking selected broad gift category 3212A) from which the gifter like to receive a gift. An exemplary second selected broad gift category 3212C can comprise shoes. Turning to FIG. 38A, for example, the gift preferences quiz page 3200, for example, can present a third question 3260A regarding in which one or more first gift subcategories 3261A within the second selected broad gift category 3212C of shoes that the gifter would like to receive a gift and can permit the gifter to respond to the third question 3260A. As illustrated in FIG. 38A, the first gift subcategories 3261A can comprise one or more brands of shoes.

To assist the gifter with responding to the third question 3260A, the gift preferences quiz page 3200 can present the first gift subcategories 3261A and enable the gifter to select one or more relevant first gift subcategories 3262A. In selected embodiments, the gift preferences quiz page 3200 can present search indicia 3263A for permitting the gifter to search for among the first gift subcategories 3261A. The gift preferences quiz page 3200 optionally can enable the gifter to indicate an order of importance or otherwise rank the selected gift subcategories 3262A in the manner shown and described above with reference to the presented selected gifts 32321 as illustrated in FIG. 35L.

The gift preferences quiz 3210 of FIG. 38B is illustrated as presenting one or more alternative detailed gifter preference options for the second selected broad gift category 3212C as selected and/or ranked by the gifter. Turning to FIG. 38B, for example, the detailed gifter preference options can comprise detailed gifter preference options associated with the second selected broad gift category 3212C of shoes within the selected broad gift category 3212A of clothing. The gift preferences quiz page 3200, for example, can present a fourth question 3260B regarding in which one or more second gift subcategories 3261B within the second selected broad gift category 3212C of shoes that the gifter would like to receive a gift and can permit the gifter to respond to the fourth question 3260B.

As shown in FIG. 38B, the second gift subcategories 3261B can comprise one or more shoe sizes. To assist the gifter with responding to the fourth question 3260B, the gift preferences quiz page 3200 can present the second gift subcategories 3261B and enable the gifter to select one or more relevant second gift subcategories 3262B. In selected embodiments, the gift preferences quiz page 3200 can present search indicia 3263B for permitting the gifter to search for among the second gift subcategories 3261B. The gift preferences quiz page 3200 optionally can enable the gifter to indicate an order of importance or otherwise rank the selected gift subcategories 3262B in the manner shown and described above with reference to the presented selected gifts 32321 as illustrated in FIG. 35L.

Turning to FIG. 38C, the gift preferences quiz page 3200 optionally can present further detailed gifter preference options associated with the second selected broad gift category 3212C of shoes within the selected broad gift category 3212A of clothing. The gift preferences quiz page 3200, for example, can present a fifth question 3260C regarding in which one or more third gift subcategories 3261C within the second selected broad gift category 3212C of shoes that the gifter would like to receive a gift and can permit the gifter to respond to the fifth question 3260C.

As illustrated in FIG. 38C, the third gift subcategories 3261C can comprise one or more styles of shoes. To assist the gifter with responding to the fifth question 3260C, the gift preferences quiz page 3200 can present the third gift subcategories 3261C and enable the gifter to select one or more relevant third gift subcategories 3261C. In selected embodiments, the gift preferences quiz page 3200 can present search indicia 3263C for permitting the gifter to search for among the third gift subcategories 3261C. The gift preferences quiz page 3200 optionally can enable the gifter to indicate an order of importance or otherwise rank the selected gift subcategories 3262C in the manner shown and described above with reference to the presented selected gifts 32321 as illustrated in FIG. 35L.

Additionally and/or alternatively, the gift preferences quiz page 3200 can present a sixth question 3260D regarding in which one or more fourth gift subcategories 3261D within the second selected broad gift category 3212C of shoes that the gifter would like to receive a gift and can permit the gifter to respond to the six question 3260D. As shown in FIG. 38D, the fourth gift subcategories 3261D can comprise one or more types of shoes. To assist the gifter with responding to the sixth question 3260D, the gift preferences quiz page 3200 can present the fourth gift subcategories 3261D and enable the gifter to select one or more relevant fourth gift subcategories 3261D.

The gift preferences quiz page 3200, in selected embodiments, can present search indicia 3263D for permitting the gifter to search for among the fourth gift subcategories 3261D. The gift preferences quiz page 3200 optionally can enable the gifter to indicate an order of importance or otherwise rank the selected gift subcategories 3262D in the manner shown and described above with reference to the presented selected gifts 32321 as illustrated in FIG. 35L.

Turning to FIG. 38E, the gift preferences quiz page 3200 likewise can present an optional seventh question 3260E regarding in which one or more fifth gift subcategories 3261E within the second selected broad gift category 3212C of shoes that the gifter would like to receive a gift and can permit the gifter to respond to the seventh question 3260E. As illustrated in FIG. 38E, the fifth gift subcategories 3261E can comprise one or more heel heights of shoes. To assist the gifter with responding to the seventh question 3260E, the gift preferences quiz page 3200 can present the fifth gift subcategories 3261E and enable the gifter to select one or more relevant fifth gift subcategories 3261E. In selected embodiments, the gift preferences quiz page 3200 can present search indicia 3263E for permitting the gifter to search for among the fifth gift subcategories 3261E. The gift preferences quiz page 3200 optionally can enable the gifter to indicate an order of importance or otherwise rank the selected gift subcategories 3262E in the manner shown and described above with reference to the presented selected gifts 32321 as illustrated in FIG. 35L.

FIG. 38F shows another alternative embodiment of the gift preferences quiz page 3200 that can present an eighth question 3260F regarding in which one or more sixth gift subcategories 3261F within the second selected broad gift category 3212C of shoes that the gifter would like to receive a gift and can permit the gifter to respond to the eighth question 3260F. As illustrated in FIG. 38F, the sixth gift subcategories 3261F can comprise one or more colors of shoes. To assist the gifter with responding to the eighth question 3260F, the gift preferences quiz page 3200 can present the sixth gift subcategories 3261F and enable the gifter to select one or more relevant sixth gift subcategories 3261F.

The gift preferences quiz page 3200, in selected embodiments, can present search indicia 3263F for permitting the gifter to search for among the sixth gift subcategories 3261F. The gift preferences quiz page 3200 optionally can enable the gifter to indicate an order of importance or otherwise rank the selected gift subcategories 3262F in the manner shown and described above with reference to the presented selected gifts 32321 as illustrated in FIG. 35L.

The gift preferences quiz page 3200 of FIG. 38G is illustrated as presenting a ninth question 3260G regarding in which one or more seventh gift subcategories 3261G within the second selected broad gift category 3212C of shoes that the gifter would like to receive a gift and can permit the gifter to respond to the ninth question 3260G. As illustrated in FIG. 38G, the seventh gift subcategories 3261G can comprise one or more shoe materials. To assist the gifter with responding to the ninth question 3260G, the gift preferences quiz page 3200 can present the seventh gift subcategories 3261G and enable the gifter to select one or more relevant seventh gift subcategories 3261G.

In selected embodiments, the gift preferences quiz page 3200 can present search indicia 3263G for permitting the gifter to search for among the seventh gift subcategories 3261G. The gift preferences quiz page 3200 optionally can enable the gifter to indicate an order of importance or otherwise rank the selected gift subcategories 3262G in the manner shown and described above with reference to the presented selected gifts 32321 as illustrated in FIG. 35L.

Turning to FIG. 38H, the gift preferences quiz page 3200 can enable the gifter to enter further preference information, such as a price point 3265H. As shown in FIG. 38H, for example, the gift preferences quiz page 3200 can present a tenth question 3260H regarding a price point within the second selected broad gift category 3212C of shoes that the gifter would like to receive a gift and can permit the gifter to respond to the tenth question 3260H by entering the selected price point 3265H. Based upon the selected price point 3265H and other preference information provided by the gifter, the gift preferences quiz page 3200 can present one or more gifts 3261H in the second selected broad gift category 3212C based upon a result from the gift preferences quiz and enable the gifter to select at least one gift 3262H from the presented gifts 3261H. In other words, the gift preferences quiz page 3200 can permit the gifter to select a first pair of shoes 3262HA and a second pair of shoes 3262HB from among the presented gifts 3261H.

The gift preferences quiz page 3200 optionally can enable the gifter to indicate an order of importance or otherwise rank the presented selected gifts 3262H as illustrated in FIG. 38I. The gifter, for example, can be permitted to indicate the ranking by dragging the presented selected gifts 3262H to a predetermined order on the gift preferences quiz page 3200. As shown in FIG. 38I the gifter, for example, can assign a first rank the first pair of shoes 3262HB that is greater than a second rank assigned to the second pair of shoes 3262HA.

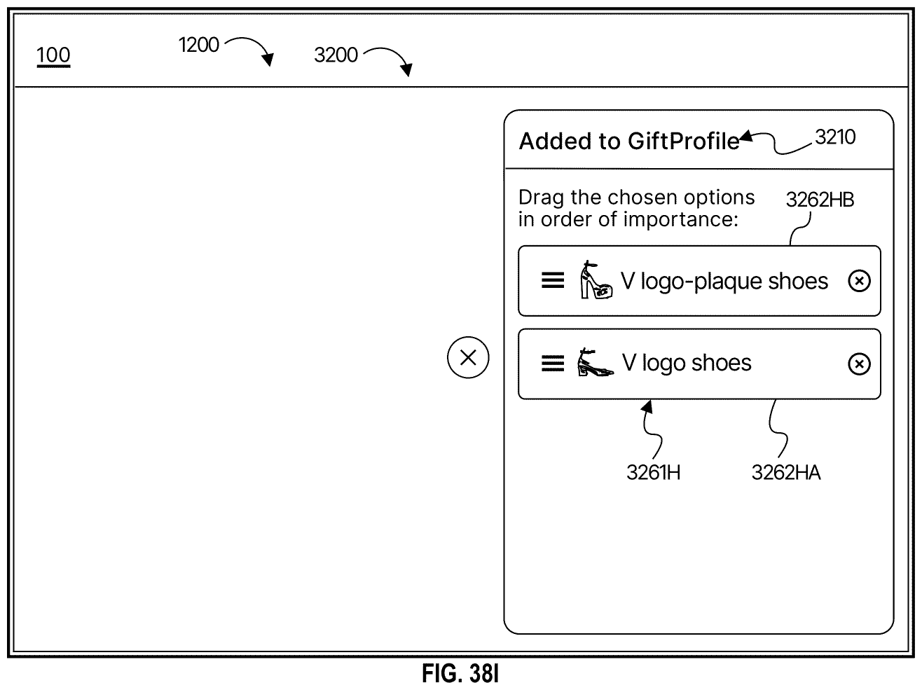

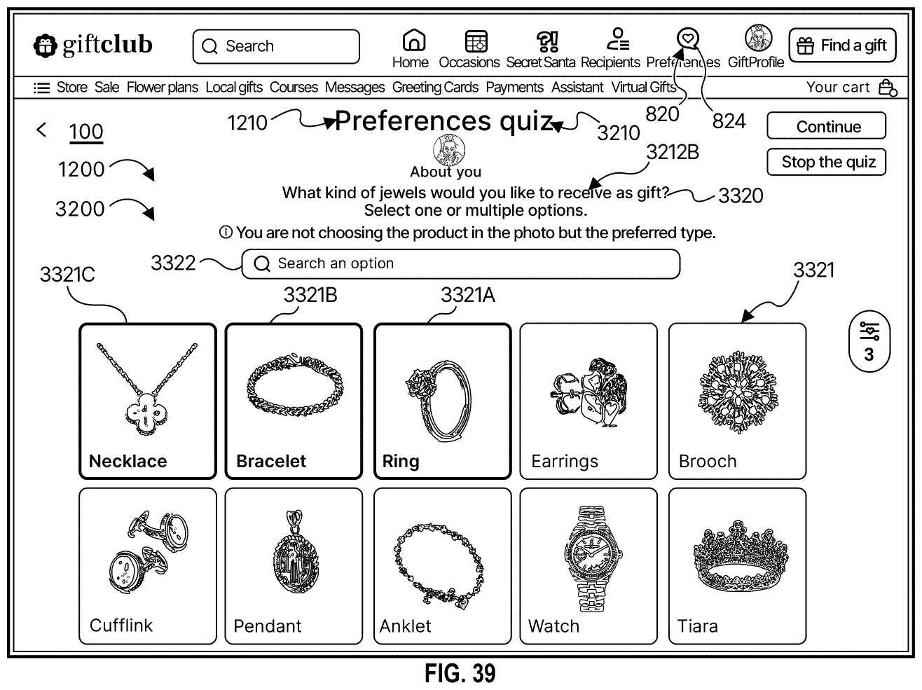

In the manner set forth above with reference to FIG. 34, the gift preferences quiz 3210 can present one or more detailed gifter preference options for each of the broad gift categories as selected and/or ranked by the gifter. In the manner discussed above with reference to FIGS. 33A-B, the second selected broad gift category 3212B can comprise a third-highest ranking broad gift category 3211 (after the highest-ranking selected broad gift category 3212A and the second highest-ranking selected broad gift category 3212C) from which the gifter like to receive a gift. As illustrated in FIG. 39, the third selected broad gift category 3312B can comprise jewels (or jewelry).

The gift preferences quiz page 3200, for example, can present a second question 3320 regarding in which one or more gift subcategories 3321 within the highest ranked selected broad gift category 3212A that the gifter like to receive a gift and can permit the gifter to respond to the second question 3320. To assist the gifter with responding to the second question 3320, the gift preferences quiz page 3200 can present a plurality of gift subcategories 3321 and enable the gifter to select one or more relevant gift subcategories 3321A-C. In selected embodiments, the gift preferences quiz page 3200 can present search indicia 3322 for permitting the gifter to search for among the gift subcategories 3321.

The gift preferences quiz page 3200 optionally can enable the gifter to indicate an order of importance or otherwise rank the selected gift subcategories 3321 in the manner shown and described above with reference to the selected broad gift categories 3212A-C of FIG. 33B. As shown in FIG. 39, a first selected gift subcategory 3321A within the second selected broad gift category 3212B of jewelry can include an exemplary first subcategory of rings. A second selected gift subcategory 3321B is illustrated in FIG. 39 as comprising bracelets. An exemplary third selected gift subcategory 3321C can comprise necklaces.

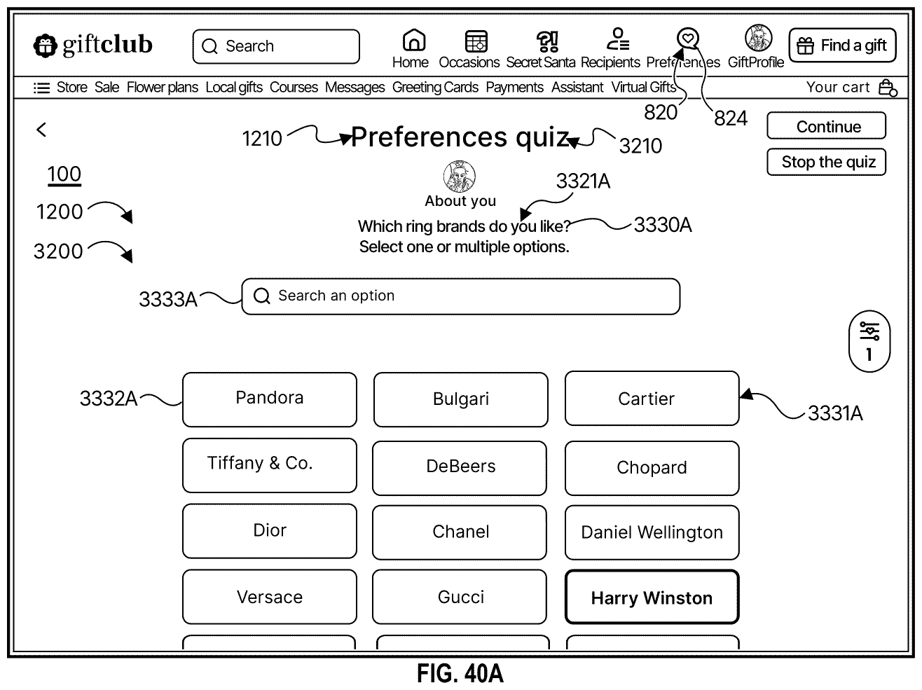

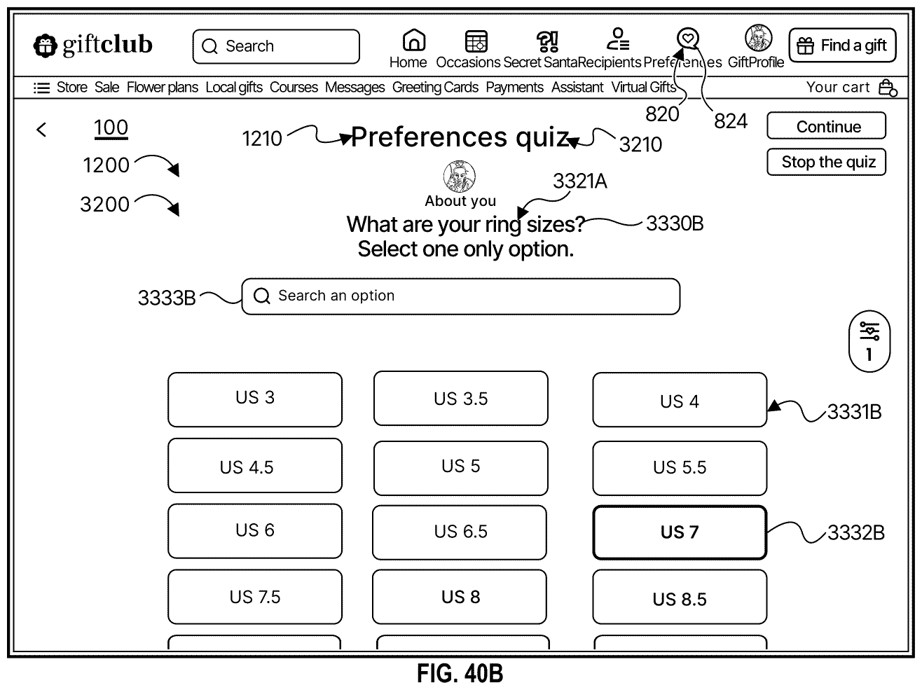

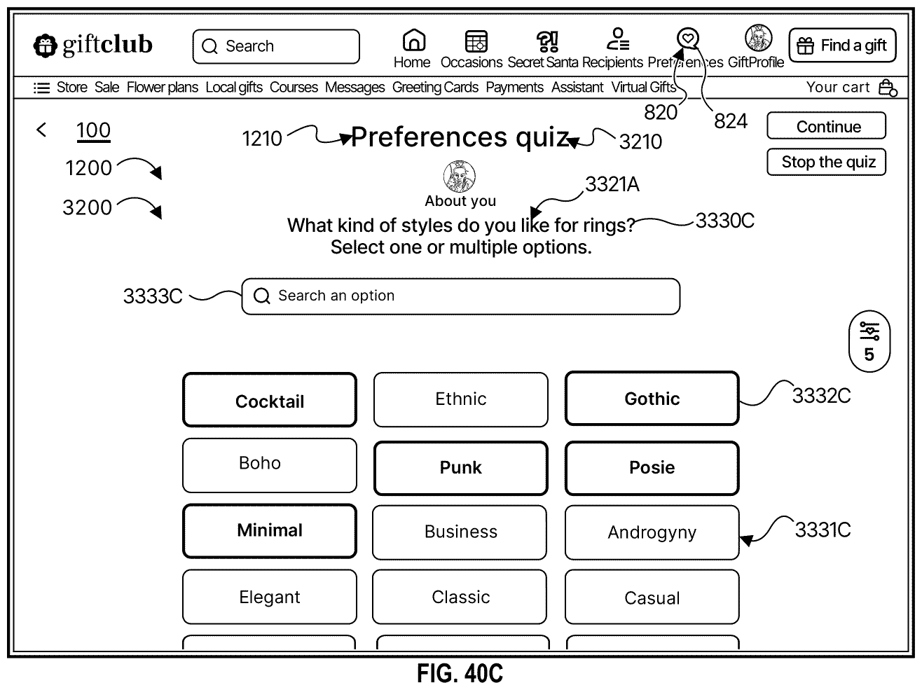

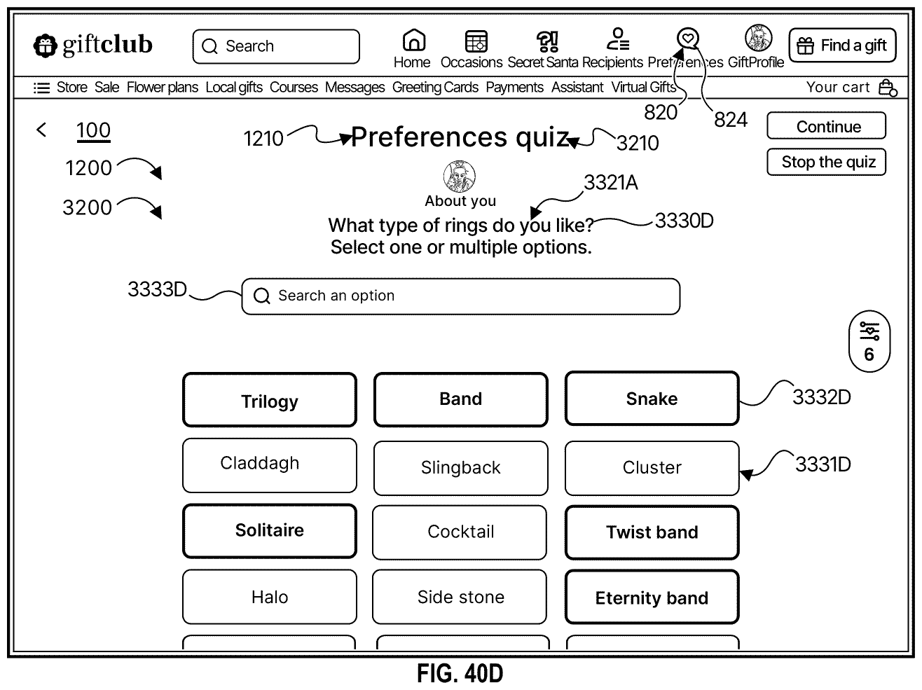

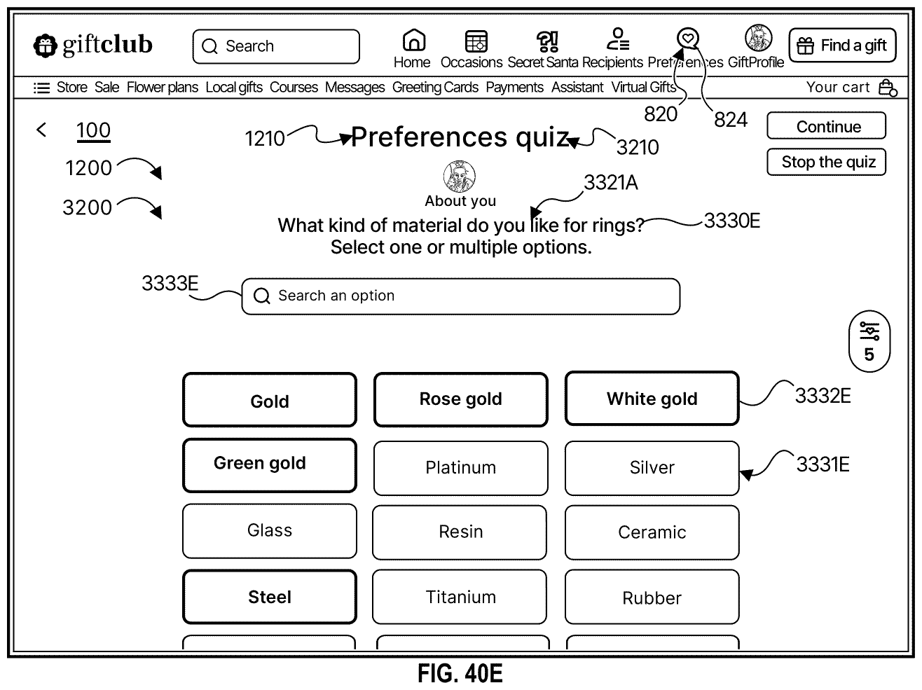

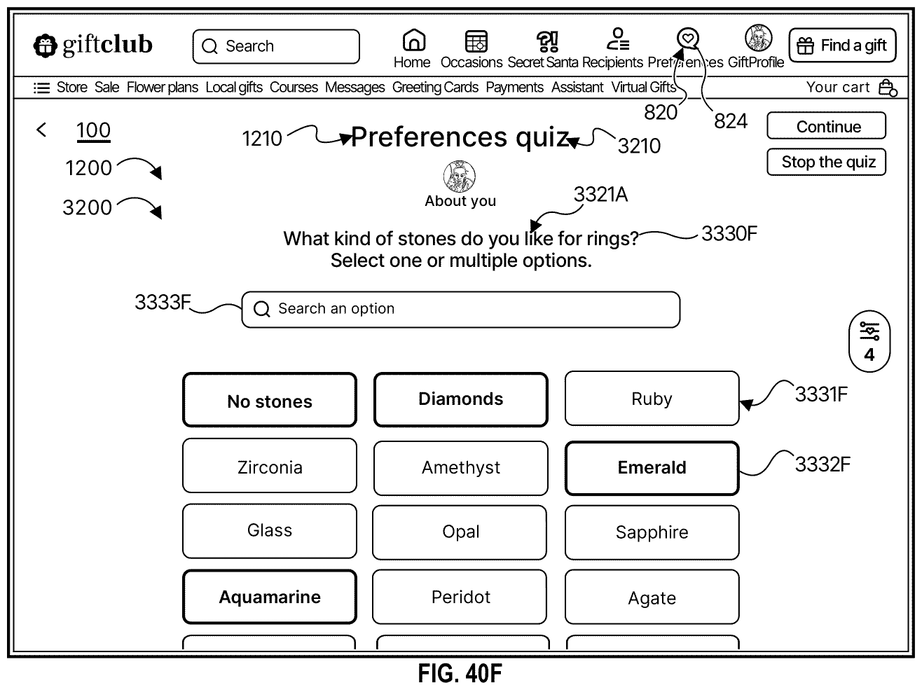

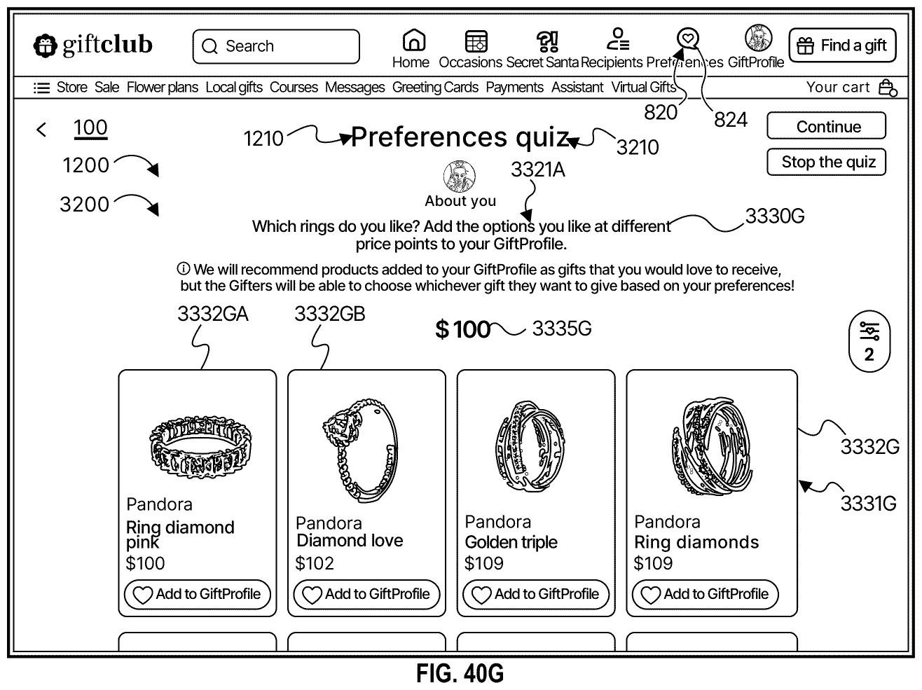

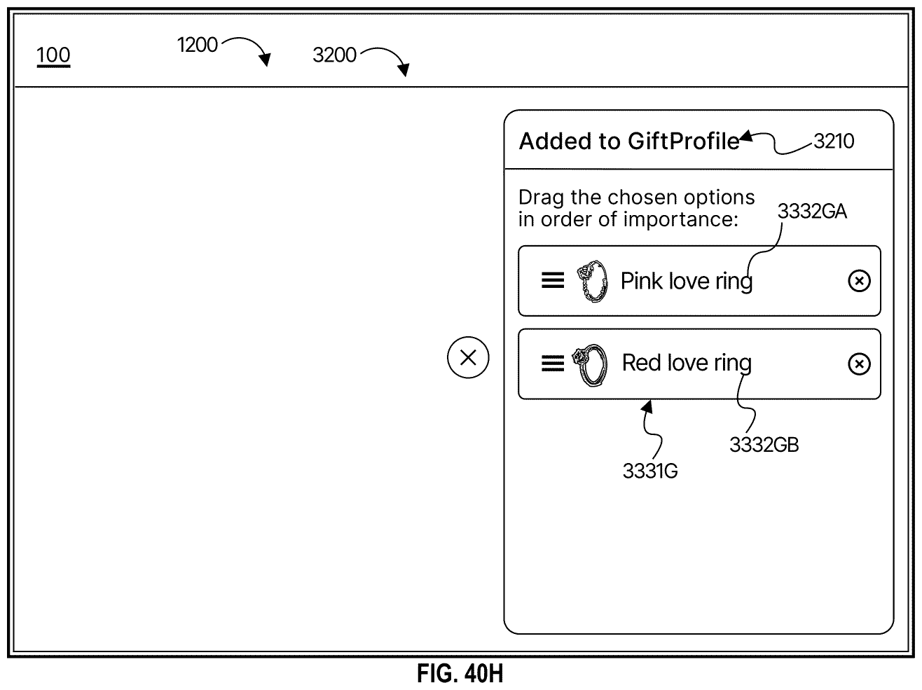

Additionally and/or alternatively, the gift preferences quiz 3310 can present one or more detailed gifter preference options for each of the gift subcategories 3321 as selected and/or ranked by the gifter. Turning to FIG. 40A, for example, the detailed gifter preference options can comprise detailed gifter preference options associated with the first selected gift subcategory 3321A of rings within the selected broad gift category 3312B of jewelry. The gift preferences quiz page 3200, for example, can present a third question 3330A regarding in which one or more first gift sub-subcategories 3331A within the first selected gift subcategory 3321A of rings that the gifter would like to receive a gift and can permit the gifter to respond to the third question 3330A.

As illustrated in FIG. 40A, the first gift sub-subcategories 3331A can comprise one or more brands of rings. To assist the gifter with responding to the third question 3330A, the gift preferences quiz page 3200 can present the first gift sub-subcategories 3331A and enable the gifter to select one or more relevant first gift sub-subcategories 3332A. In selected embodiments, the gift preferences quiz page 3200 can present search indicia 3333A for permitting the gifter to search for among the first gift sub-subcategories 3331A. The gift preferences quiz page 3200 optionally can enable the gifter to indicate an order of importance or otherwise rank the selected gift sub-subcategories 3332A in the manner shown and described above with reference to the presented selected gifts 32321 as illustrated in FIG. 35L.

The gift preferences quiz 3310 of FIG. 40B is illustrated as presenting one or more alternative detailed gifter preference options for each of the gift subcategories 3321 as selected and/or ranked by the gifter. Turning to FIG. 40B, for example, the detailed gifter preference options can comprise detailed gifter preference options associated with the first selected gift subcategory 3321A of rings within the selected broad gift category 3312B of jewelry. The gift preferences quiz page 3200, for example, can present a fourth question 3330B regarding in which one or more second gift sub-subcategories 3331B within the first selected gift subcategory 3321A of rings that the gifter would like to receive a gift and can permit the gifter to respond to the fourth question 3330B.

As shown in FIG. 40B, the second gift sub-subcategories 3331B can comprise one or more ring sizes. To assist the gifter with responding to the fourth question 3330B, the gift preferences quiz page 3200 can present the second gift sub-subcategories 3331B and enable the gifter to select one or more relevant second gift sub-subcategories 3332B. In selected embodiments, the gift preferences quiz page 3200 can present search indicia 3333B for permitting the gifter to search for among the second gift sub-subcategories 3331B. The gift preferences quiz page 3200 optionally can enable the gifter to indicate an order of importance or otherwise rank the selected gift sub-subcategories 3332B in the manner shown and described above with reference to the presented selected gifts 32321 as illustrated in FIG. 35L.

Turning to FIG. 40C, the gift preferences quiz page 3200 optionally can present further detailed gifter preference options associated with the first selected gift subcategory 3321A of rings within the selected broad gift category 3312B of jewelry. The gift preferences quiz page 3200, for example, can present a fifth question 3330C regarding in which one or more third gift sub-subcategories 3331C within the first selected gift subcategory 3321A of rings that the gifter would like to receive a gift and can permit the gifter to respond to the fifth question 3330C.

As illustrated in FIG. 40C, the third gift sub-subcategories 3331C can comprise one or more styles of rings. To assist the gifter with responding to the fifth question 3330C, the gift preferences quiz page 3200 can present the third gift sub-subcategories 3331C and enable the gifter to select one or more relevant third gift sub-subcategories 3331C. In selected embodiments, the gift preferences quiz page 3200 can present search indicia 3333C for permitting the gifter to search for among the third gift sub-subcategories 3331C. The gift preferences quiz page 3200 optionally can enable the gifter to indicate an order of importance or otherwise rank the selected gift sub-subcategories 3332C in the manner shown and described above with reference to the presented selected gifts 32321 as illustrated in FIG. 35L.

Additionally and/or alternatively, the gift preferences quiz page 3200 can present a sixth question 3330D regarding in which one or more fourth gift sub-subcategories 3331D within the first selected gift subcategory 3321A of rings that the gifter would like to receive a gift and can permit the gifter to respond to the six question 3330D. As shown in FIG. 40D, the fourth gift sub-subcategories 3331D can comprise one or more types of rings. To assist the gifter with responding to the sixth question 3330D, the gift preferences quiz page 3200 can present the fourth gift sub-subcategories 3331D and enable the gifter to select one or more relevant fourth gift sub-subcategories 3331D.

The gift preferences quiz page 3200, in selected embodiments, can present search indicia 3333D for permitting the gifter to search for among the fourth gift sub-subcategories 3331D. The gift preferences quiz page 3200 optionally can enable the gifter to indicate an order of importance or otherwise rank the selected gift sub-subcategories 3332D in the manner shown and described above with reference to the presented selected gifts 32321 as illustrated in FIG. 35L.

Turning to FIG. 40E, the gift preferences quiz page 3200 likewise can present an optional seventh question 3330E regarding in which one or more fifth gift sub-subcategories 3331E within the first selected gift subcategory 3321A of rings that the gifter would like to receive a gift and can permit the gifter to respond to the seventh question 3330E. As illustrated in FIG. 40E, the fifth gift sub-subcategories 3331E can comprise one or more ring materials. To assist the gifter with responding to the seventh question 3330E, the gift preferences quiz page 3200 can present the fifth gift sub-subcategories 3331E and enable the gifter to select one or more relevant fifth gift sub-subcategories 3331E. In selected embodiments, the gift preferences quiz page 3200 can present search indicia 3333E for permitting the gifter to search for among the fifth gift sub-subcategories 3331E. The gift preferences quiz page 3200 optionally can enable the gifter to indicate an order of importance or otherwise rank the selected gift sub-subcategories 3332E in the manner shown and described above with reference to the presented selected gifts 32321 as illustrated in FIG. 35L.

FIG. 40F shows another alternative embodiment of the gift preferences quiz page 3200 that can present an eighth question 3330F regarding in which one or more sixth gift sub-subcategories 3331F within the first selected gift subcategory 3321A of rings that the gifter would like to receive a gift and can permit the gifter to respond to the eighth question 3330F. As illustrated in FIG. 40F, the sixth gift sub-subcategories 3331F can comprise one or more stones for rings. To assist the gifter with responding to the eighth question 3330F, the gift preferences quiz page 3200 can present the sixth gift sub-subcategories 3331F and enable the gifter to select one or more relevant sixth gift sub-subcategories 3331F.

The gift preferences quiz page 3200, in selected embodiments, can present search indicia 3333F for permitting the gifter to search for among the sixth gift sub-subcategories 3331F. The gift preferences quiz page 3200 optionally can enable the gifter to indicate an order of importance or otherwise rank the selected gift sub-subcategories 3332F in the manner shown and described above with reference to the presented selected gifts 32321 as illustrated in FIG. 35L.

Turning to FIG. 40G, the gift preferences quiz page 3200 can enable the gifter to enter further preference information, such as a price point 3335G. As shown in FIG. 40G, for example, the gift preferences quiz page 3200 can present a ninth question 3330G regarding the price point within the first selected gift subcategory 3321A of rings that the gifter would like to receive a gift and can permit the gifter to respond to the ninth question 3330G by entering a selected price point 3335G. Based upon the selected price point 3335G and other preference information provided by the gifter, the gift preferences quiz page 3200 can present one or more gifts 3331G in the first selected gift subcategory 3321A based upon a result from the gift preferences quiz and enable the gifter to select at least one gift 3332G from the presented gifts 3331G. In other words, the gift preferences quiz page 3200 can permit the gifter to select a first ring 3332GA and a second ring 3332GB from among the presented gifts 3331G.

The gift preferences quiz page 3200 optionally can enable the gifter to indicate an order of importance or otherwise rank the presented selected gifts 3332G as illustrated in FIG. 40H. The gifter, for example, can be permitted to indicate the ranking by dragging the presented gifts 3331G to a predetermined order on the gift preferences quiz page 3200. As shown in FIG. 40H, the gifter, for example, can assign a first rank the first ring 3332GA that is greater than a second rank assigned to the second ring 3332GB.

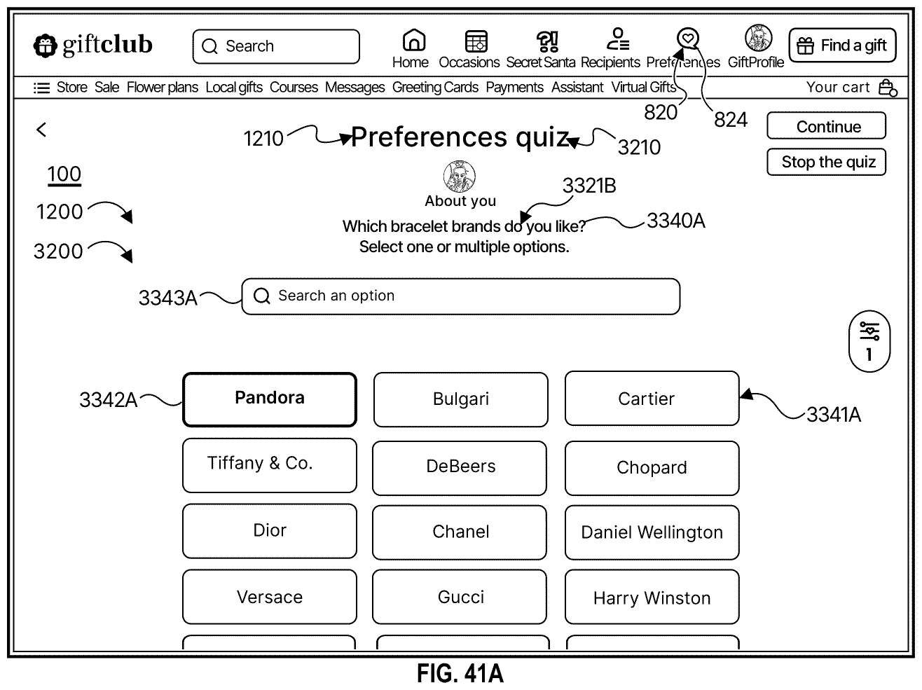

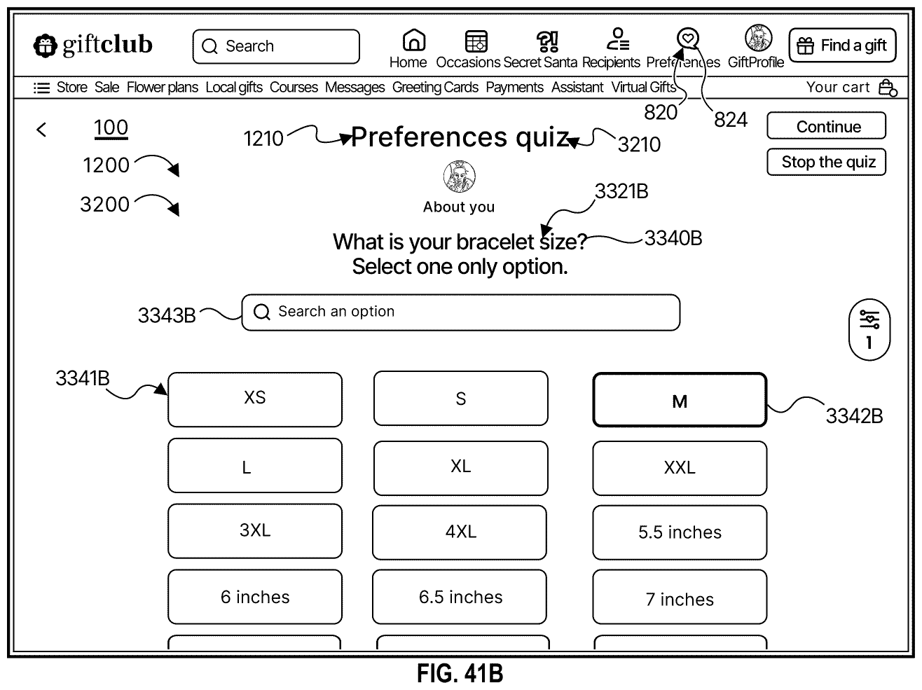

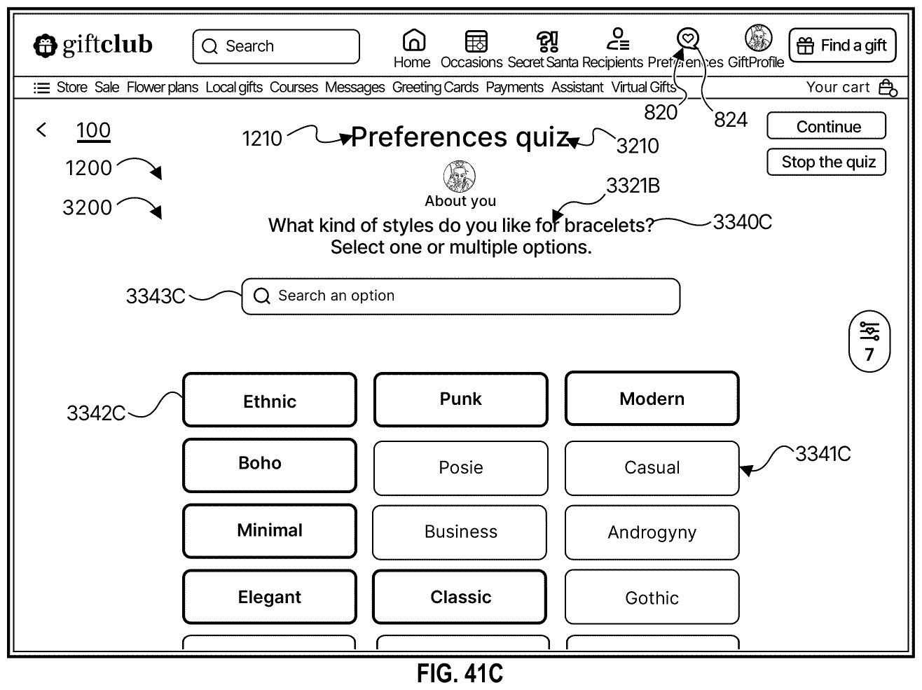

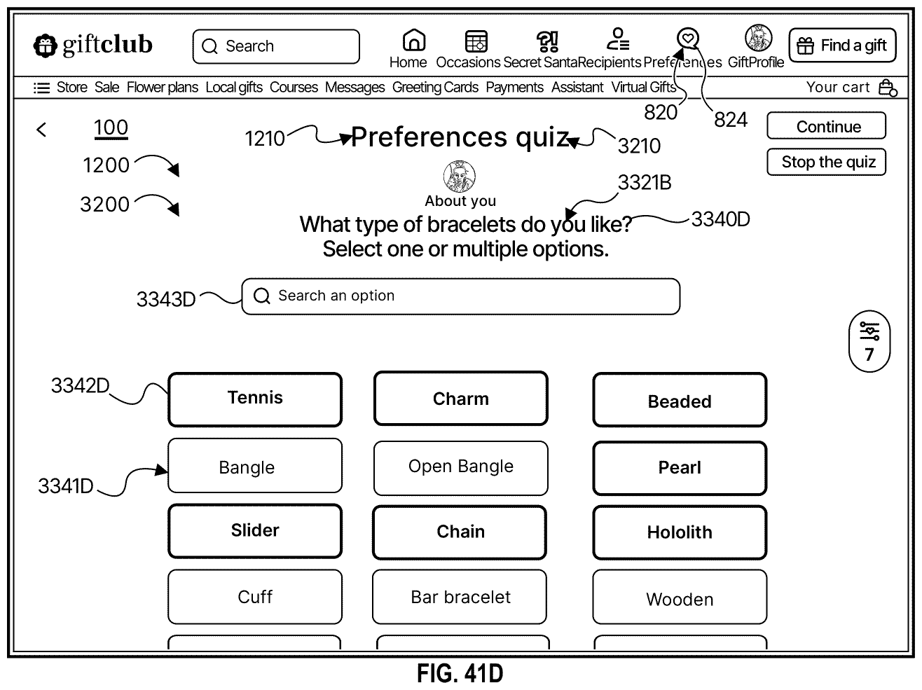

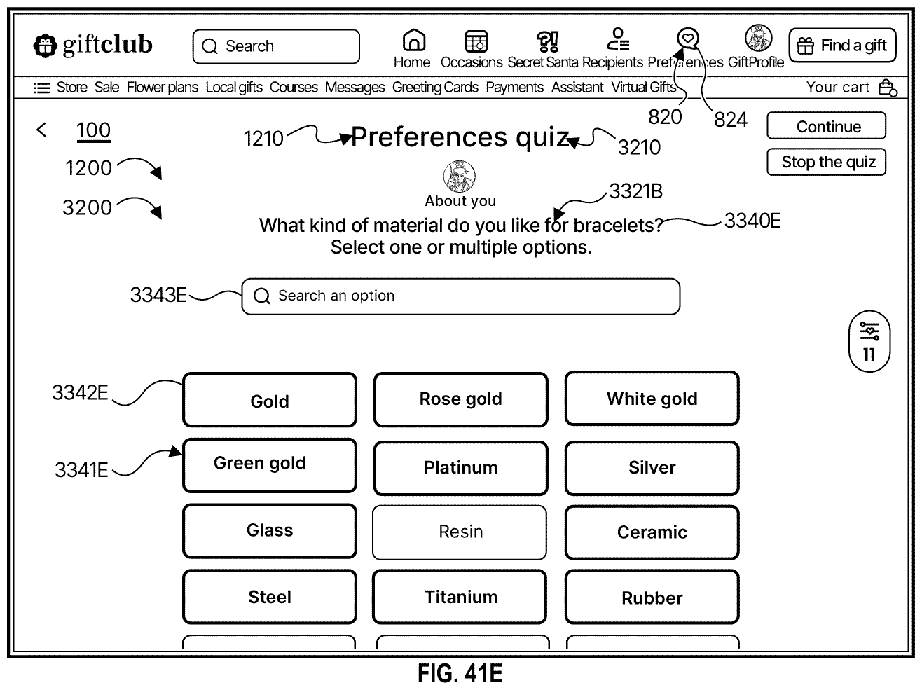

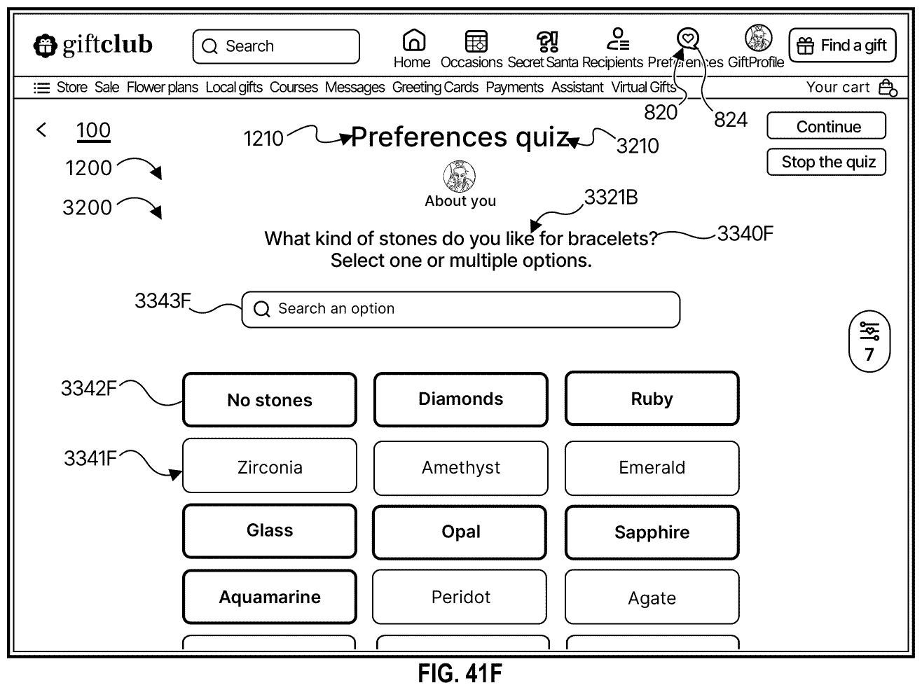

In selected embodiments, the gift preferences quiz 3210 can present one or more detailed gifter preference options for the second selected gift subcategory 3321B of bracelets as selected and/or ranked by the gifter. Turning to FIG. 41A, for example, the detailed gifter preference options can comprise detailed gifter preference options associated with the second selected gift subcategory 3321B of bracelets within the selected broad gift category 3312B of jewelry. The gift preferences quiz page 3200, for example, can present a third question 3340A regarding in which one or more first gift sub-subcategories 3341A within the second selected gift subcategory 3321B of bracelets that the gifter would like to receive a gift and can permit the gifter to respond to the third question 3340A.

As illustrated in FIG. 41A, the first gift sub-subcategories 3341A can comprise one or more brands of bracelets. To assist the gifter with responding to the third question 3340A, the gift preferences quiz page 3200 can present the first gift sub-subcategories 3341A and enable the gifter to select one or more relevant first gift sub-subcategories 3342A. In selected embodiments, the gift preferences quiz page 3200 can present search indicia 3343A for permitting the gifter to search for among the first gift sub-subcategories 3341A. The gift preferences quiz page 3200 optionally can enable the gifter to indicate an order of importance or otherwise rank the selected gift sub-subcategories 3342A in the manner shown and described above with reference to the presented selected gifts 32321 as illustrated in FIG. 35L.

The gift preferences quiz 3310 of FIG. 41B is illustrated as presenting one or more alternative detailed gifter preference options for each of the gift subcategories 3321 as selected and/or ranked by the gifter. Turning to FIG. 41B, for example, the detailed gifter preference options can comprise detailed gifter preference options associated with the second selected gift subcategory 3321B of bracelets within the selected broad gift category 3312B of jewelry. The gift preferences quiz page 3200, for example, can present a fourth question 3340B regarding in which one or more second gift sub-subcategories 3341B within the second selected gift subcategory 3321B of bracelets that the gifter would like to receive a gift and can permit the gifter to respond to the fourth question 3340B.

As shown in FIG. 41B, the second gift sub-subcategories 3341B can comprise one or more bracelet sizes. To assist the gifter with responding to the fourth question 3340B, the gift preferences quiz page 3200 can present the second gift sub-subcategories 3341B and enable the gifter to select one or more relevant second gift sub-subcategories 3342B. In selected embodiments, the gift preferences quiz page 3200 can present search indicia 3343B for permitting the gifter to search for among the second gift sub-subcategories 3341B. The gift preferences quiz page 3200 optionally can enable the gifter to indicate an order of importance or otherwise rank the selected gift sub-subcategories 3342B in the manner shown and described above with reference to the presented selected gifts 32321 as illustrated in FIG. 35L.

Turning to FIG. 41C, the gift preferences quiz page 3200 optionally can present further detailed gifter preference options associated with the second selected gift subcategory 3321B of bracelets within the selected broad gift category 3312B of jewelry. The gift preferences quiz page 3200, for example, can present a fifth question 3340C regarding in which one or more third gift sub-subcategories 3341C within the second selected gift subcategory 3321B of bracelets that the gifter would like to receive a gift and can permit the gifter to respond to the fifth question 3340C.

As illustrated in FIG. 41C, the third gift sub-subcategories 3341C can comprise one or more styles of bracelets. To assist the gifter with responding to the fifth question 3340C, the gift preferences quiz page 3200 can present the third gift sub-subcategories 3341C and enable the gifter to select one or more relevant third gift sub-subcategories 3341C. In selected embodiments, the gift preferences quiz page 3200 can present search indicia 3343C for permitting the gifter to search for among the third gift sub-subcategories 3341C. The gift preferences quiz page 3200 optionally can enable the gifter to indicate an order of importance or otherwise rank the selected gift sub-subcategories 3342C in the manner shown and described above with reference to the presented selected gifts 32321 as illustrated in FIG. 35L.

Additionally and/or alternatively, the gift preferences quiz page 3200 can present a sixth question 3340D regarding in which one or more fourth gift sub-subcategories 3341D within the second selected gift subcategory 3321B of bracelets that the gifter would like to receive a gift and can permit the gifter to respond to the six question 3340D. As shown in FIG. 41D, the fourth gift sub-subcategories 3341D can comprise one or more types of bracelets. To assist the gifter with responding to the sixth question 3340D, the gift preferences quiz page 3200 can present the fourth gift sub-subcategories 3341D and enable the gifter to select one or more relevant fourth gift sub-subcategories 3341D.

The gift preferences quiz page 3200, in selected embodiments, can present search indicia 3343D for permitting the gifter to search for among the fourth gift sub-subcategories 3341D. The gift preferences quiz page 3200 optionally can enable the gifter to indicate an order of importance or otherwise rank the selected gift sub-subcategories 3342D in the manner shown and described above with reference to the presented selected gifts 32321 as illustrated in FIG. 35L.

Turning to FIG. 41E, the gift preferences quiz page 3200 likewise can present an optional seventh question 3340E regarding in which one or more fifth gift sub-subcategories 3341E within the second selected gift subcategory 3321B of bracelets that the gifter would like to receive a gift and can permit the gifter to respond to the seventh question 3340E. As illustrated in FIG. 41E, the fifth gift sub-subcategories 3341E can comprise one or more bracelet materials.

To assist the gifter with responding to the seventh question 3340E, the gift preferences quiz page 3200 can present the fifth gift sub-subcategories 3341E and enable the gifter to select one or more relevant fifth gift sub-subcategories 3341E. In selected embodiments, the gift preferences quiz page 3200 can present search indicia 3343E for permitting the gifter to search for among the fifth gift sub-subcategories 3341E. The gift preferences quiz page 3200 optionally can enable the gifter to indicate an order of importance or otherwise rank the selected gift sub-subcategories 3342E in the manner shown and described above with reference to the presented selected gifts 32321 as illustrated in FIG. 35L.

FIG. 41F shows another alternative embodiment of the gift preferences quiz page 3200 that can present an eighth question 3340F regarding in which one or more sixth gift sub-subcategories 3341F within the second selected gift subcategory 3321B of bracelets that the gifter would like to receive a gift and can permit the gifter to respond to the eighth question 3340F. As illustrated in FIG. 41F, the sixth gift sub-subcategories 3341F can comprise one or more stones for bracelets. To assist the gifter with responding to the eighth question 3340F, the gift preferences quiz page 3200 can present the sixth gift sub-subcategories 3341F and enable the gifter to select one or more relevant sixth gift sub-subcategories 3341F.

The gift preferences quiz page 3200, in selected embodiments, can present search indicia 3343F for permitting the gifter to search for among the sixth gift sub-subcategories 3341F. The gift preferences quiz page 3200 optionally can enable the gifter to indicate an order of importance or otherwise rank the selected gift sub-subcategories 3342F in the manner shown and described above with reference to the presented selected gifts 32321 as illustrated in FIG. 35L.

Turning to FIG. 41G, the gift preferences quiz page 3200 can enable the gifter to enter further preference information, such as a price point 3345G. As shown in FIG. 41G, for example, the gift preferences quiz page 3200 can present a ninth question 3340G regarding the price point within the second selected gift subcategory 3321B of bracelets that the gifter would like to receive a gift and can permit the gifter to respond to the ninth question 3340G by entering a selected price point 3345G. Based upon the selected price point 3345G and other preference information provided by the gifter, the gift preferences quiz page 3200 can present one or more gifts 3341G in the second selected gift subcategory 3321B based upon a result from the gift preferences quiz and enable the gifter to select at least one gift 3342G from the presented gifts 3341G. In other words, the gift preferences quiz page 3200 can permit the gifter to select a first bracelet 3342GA and a second bracelet 3342GB from among the presented gifts 3341G. The gift preferences quiz page 3200 optionally can enable the gifter to indicate an order of importance or otherwise rank the presented selected gifts 3341G in the manner shown and described above with reference to the presented selected gifts 32321 of FIG. 35L.

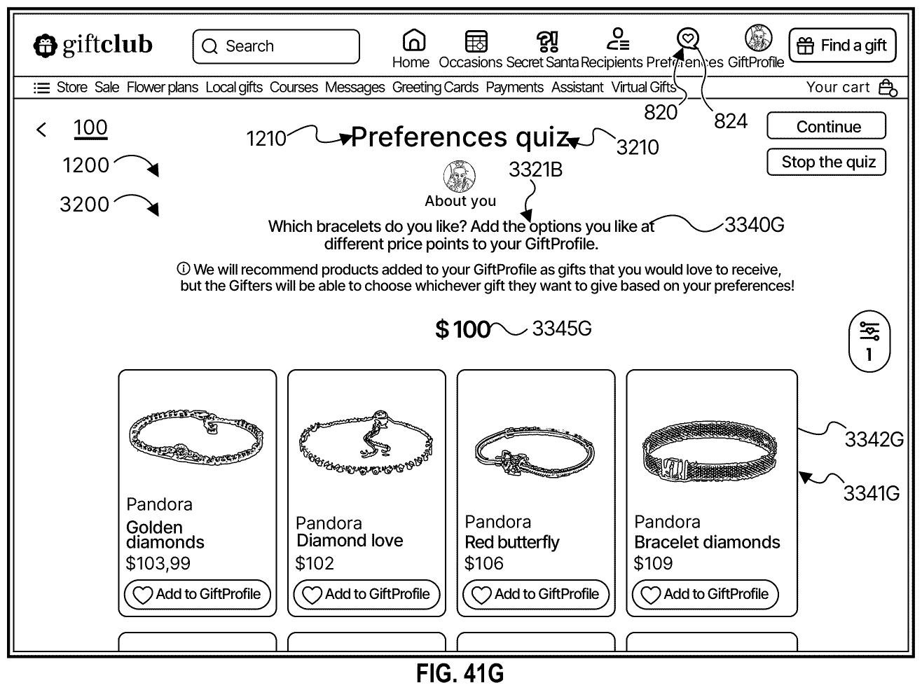

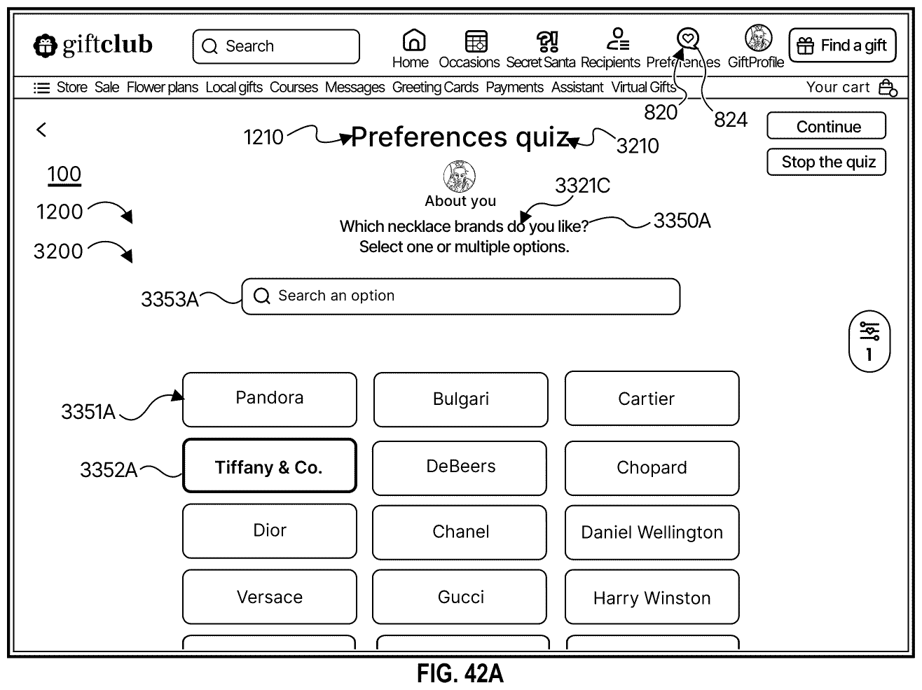

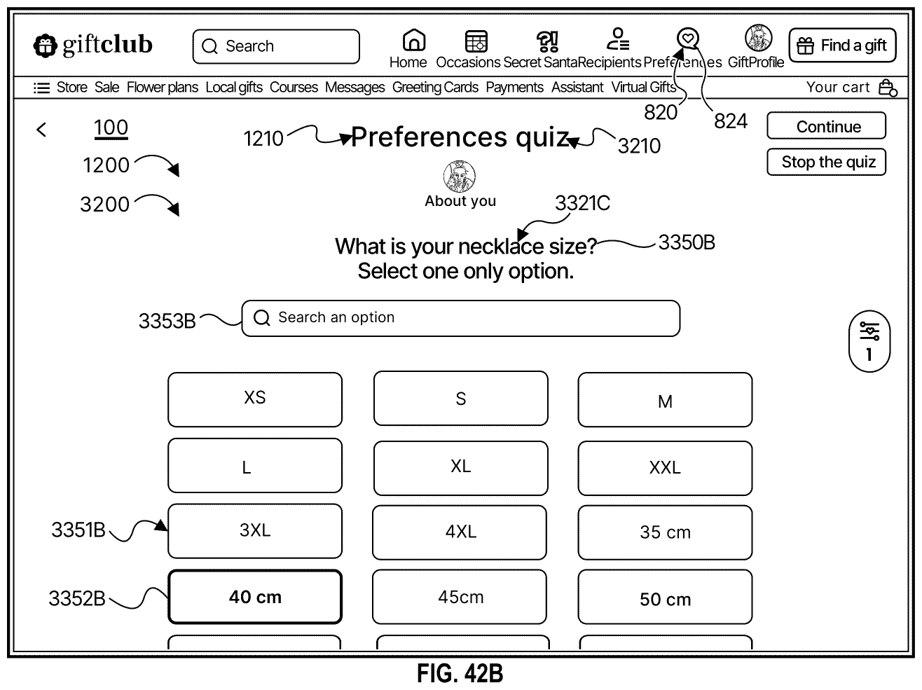

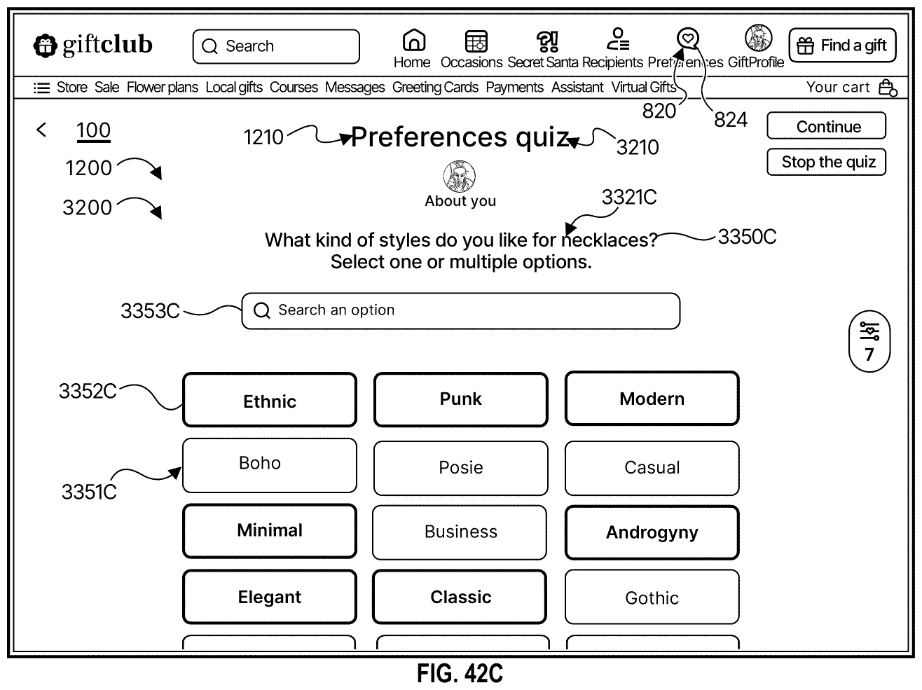

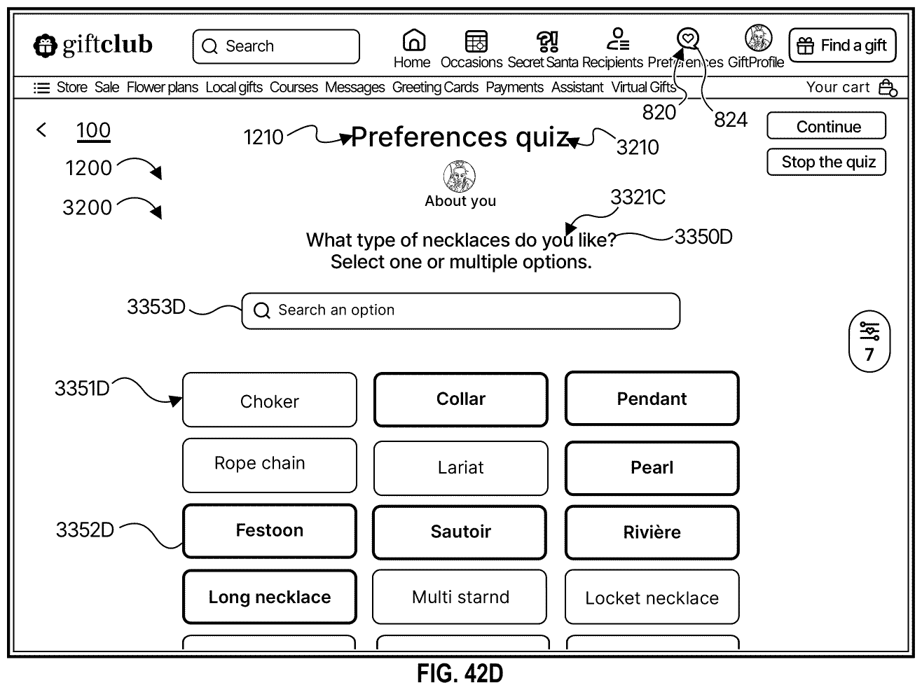

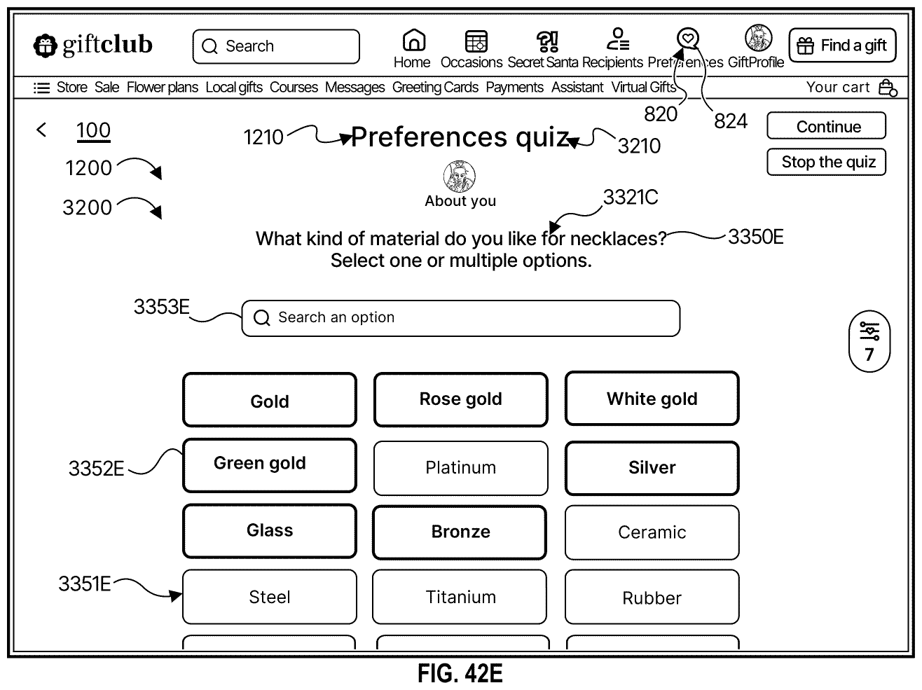

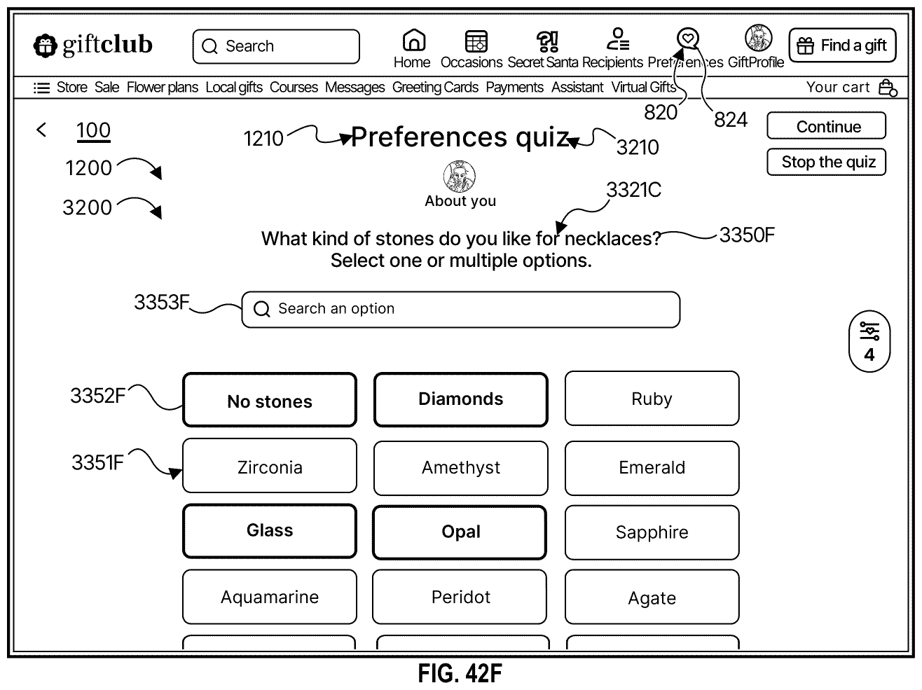

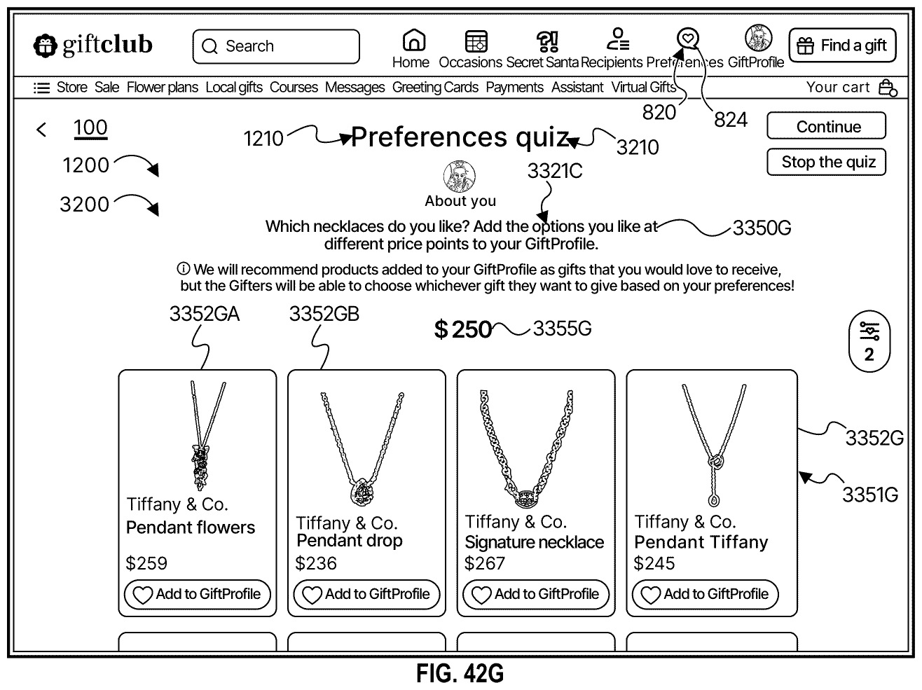

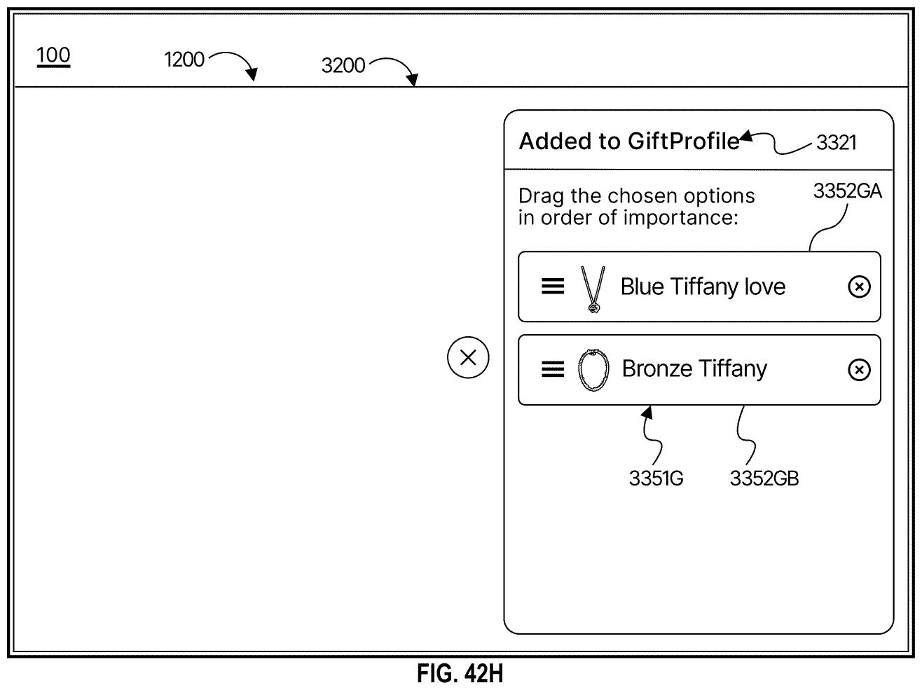

In selected embodiments, the gift preferences quiz 3210 can present one or more detailed gifter preference options for the third selected gift subcategory 3321C of necklaces as selected and/or ranked by the gifter. Turning to FIG. 42A, for example, the detailed gifter preference options can comprise detailed gifter preference options associated with the third selected gift subcategory 3321C of necklaces within the selected broad gift category 3312B of jewelry. The gift preferences quiz page 3200, for example, can present a third question 3350A regarding in which one or more first gift sub-subcategories 3351A within the third selected gift subcategory 3321C of necklaces that the gifter would like to receive a gift and can permit the gifter to respond to the third question 3350A.

As illustrated in FIG. 42A, the first gift sub-subcategories 3351A can comprise one or more brands of necklaces. To assist the gifter with responding to the third question 3350A, the gift preferences quiz page 3200 can present the first gift sub-subcategories 3351A and enable the gifter to select one or more relevant first gift sub-subcategories 3352A. In selected embodiments, the gift preferences quiz page 3200 can present search indicia 3353A for permitting the gifter to search for among the first gift sub-subcategories 3351A. The gift preferences quiz page 3200 optionally can enable the gifter to indicate an order of importance or otherwise rank the selected gift sub-subcategories 3352A in the manner shown and described above with reference to the presented selected gifts 32321 as illustrated in FIG. 35L.

The gift preferences quiz 3310 of FIG. 42B is illustrated as presenting one or more alternative detailed gifter preference options for each of the gift subcategories 3321 as selected and/or ranked by the gifter. Turning to FIG. 42B, for example, the detailed gifter preference options can comprise detailed gifter preference options associated with the third selected gift subcategory 3321C of necklaces within the selected broad gift category 3312B of jewelry. The gift preferences quiz page 3200, for example, can present a fourth question 3350B regarding in which one or more second gift sub-subcategories 3351B within the third selected gift subcategory 3321C of necklaces that the gifter would like to receive a gift and can permit the gifter to respond to the fourth question 3350B.

As shown in FIG. 42B, the second gift sub-subcategories 3351B can comprise one or more necklace sizes. To assist the gifter with responding to the fourth question 3350B, the gift preferences quiz page 3200 can present the second gift sub-subcategories 3351B and enable the gifter to select one or more relevant second gift sub-subcategories 3352B. In selected embodiments, the gift preferences quiz page 3200 can present search indicia 3353B for permitting the gifter to search for among the second gift sub-subcategories 3351B. The gift preferences quiz page 3200 optionally can enable the gifter to indicate an order of importance or otherwise rank the selected gift sub-subcategories 3352B in the manner shown and described above with reference to the presented selected gifts 32321 as illustrated in FIG. 35L.

Turning to FIG. 42C, the gift preferences quiz page 3200 optionally can present further detailed gifter preference options associated with the third selected gift subcategory 3321C of necklaces within the selected broad gift category 3312B of jewelry. The gift preferences quiz page 3200, for example, can present a fifth question 3350C regarding in which one or more third gift sub-subcategories 3351C within the third selected gift subcategory 3321C of necklaces that the gifter would like to receive a gift and can permit the gifter to respond to the fifth question 3350C.

As illustrated in FIG. 42C, the third gift sub-subcategories 3351C can comprise one or more styles of necklaces. To assist the gifter with responding to the fifth question 3350C, the gift preferences quiz page 3200 can present the third gift sub-subcategories 3351C and enable the gifter to select one or more relevant third gift sub-subcategories 3351C. In selected embodiments, the gift preferences quiz page 3200 can present search indicia 3353C for permitting the gifter to search for among the third gift sub-subcategories 3351C. The gift preferences quiz page 3200 optionally can enable the gifter to indicate an order of importance or otherwise rank the selected gift sub-subcategories 3352C in the manner shown and described above with reference to the presented selected gifts 32321 as illustrated in FIG. 35L.

Additionally and/or alternatively, the gift preferences quiz page 3200 can present a sixth question 3350D regarding in which one or more fourth gift sub-subcategories 3351D within the third selected gift subcategory 3321C of necklaces that the gifter would like to receive a gift and can permit the gifter to respond to the six question 3350D. As shown in FIG. 42D, the fourth gift sub-subcategories 3351D can comprise one or more types of necklaces. To assist the gifter with responding to the sixth question 3350D, the gift preferences quiz page 3200 can present the fourth gift sub-subcategories 3351D and enable the gifter to select one or more relevant fourth gift sub-subcategories 3351D.

The gift preferences quiz page 3200, in selected embodiments, can present search indicia 3353D for permitting the gifter to search for among the fourth gift sub-subcategories 3351D. The gift preferences quiz page 3200 optionally can enable the gifter to indicate an order of importance or otherwise rank the selected gift sub-subcategories 3352D in the manner shown and described above with reference to the presented selected gifts 32321 as illustrated in FIG. 35L.

Turning to FIG. 42E, the gift preferences quiz page 3200 likewise can present an optional seventh question 3350E regarding in which one or more fifth gift sub-subcategories 3351E within the third selected gift subcategory 3321C of necklaces that the gifter would like to receive a gift and can permit the gifter to respond to the seventh question 3350E. As illustrated in FIG. 42E, the fifth gift sub-subcategories 3351E can comprise one or more necklace materials.

To assist the gifter with responding to the seventh question 3350E, the gift preferences quiz page 3200 can present the fifth gift sub-subcategories 3351E and enable the gifter to select one or more relevant fifth gift sub-subcategories 3351E. In selected embodiments, the gift preferences quiz page 3200 can present search indicia 3353E for permitting the gifter to search for among the fifth gift sub-subcategories 3351E. The gift preferences quiz page 3200 optionally can enable the gifter to indicate an order of importance or otherwise rank the selected gift sub-subcategories 3352E in the manner shown and described above with reference to the presented selected gifts 32321 as illustrated in FIG. 35L.

FIG. 42F shows another alternative embodiment of the gift preferences quiz page 3200 that can present an eighth question 3350F regarding in which one or more sixth gift sub-subcategories 3351F within the third selected gift subcategory 3321C of necklaces that the gifter would like to receive a gift and can permit the gifter to respond to the eighth question 3350F. As illustrated in FIG. 42F, the sixth gift sub-subcategories 3351F can comprise one or more stones for necklaces. To assist the gifter with responding to the eighth question 3350F, the gift preferences quiz page 3200 can present the sixth gift sub-subcategories 3351F and enable the gifter to select one or more relevant sixth gift sub-subcategories 3351F.

The gift preferences quiz page 3200, in selected embodiments, can present search indicia 3353F for permitting the gifter to search for among the sixth gift sub-subcategories 3351F. The gift preferences quiz page 3200 optionally can enable the gifter to indicate an order of importance or otherwise rank the selected gift sub-subcategories 3352F in the manner shown and described above with reference to the presented selected gifts 32321 as illustrated in FIG. 35L.

Turning to FIG. 42G, the gift preferences quiz page 3200 can enable the gifter to enter further preference information, such as a price point 3355G. As shown in FIG. 42G, for example, the gift preferences quiz page 3200 can present a ninth question 3350G regarding the price point within the third selected gift subcategory 3321C of necklaces that the gifter would like to receive a gift and can permit the gifter to respond to the ninth question 3350G by entering a selected price point 3355G. Based upon the selected price point 3355G and other preference information provided by the gifter, the gift preferences quiz page 3200 can present one or more gifts 3351G in the third selected gift subcategory 3321C based upon a result from the gift preferences quiz and enable the gifter to select at least one gift 3352G from the presented gifts 3351G. In other words, the gift preferences quiz page 3200 can permit the gifter to select a first necklace 3352GA and a second necklace 3352GB from among the presented gifts 3351G.

The gift preferences quiz page 3200 optionally can enable the gifter to indicate an order of importance or otherwise rank the presented selected gifts 3352G as illustrated in FIG. 42H. The gifter, for example, can be permitted to indicate the ranking by dragging the presented gifts 3351G to a predetermined order on the gift preferences quiz page 3200. As shown in FIG. 42H, the gifter, for example, can assign a first rank the first necklace 3352GA that is greater than a second rank assigned to the second necklace 3352GB.

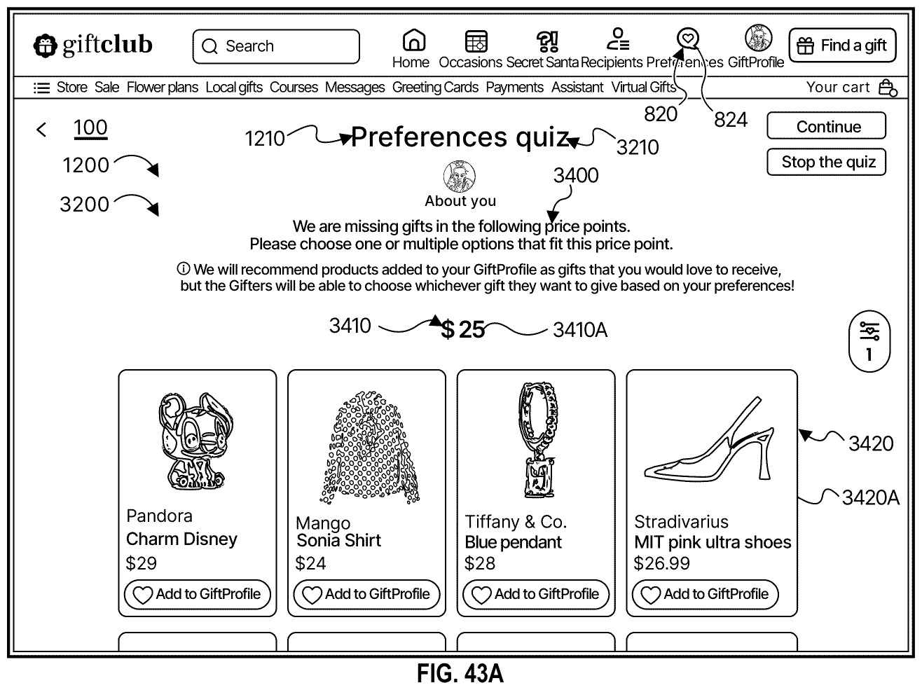

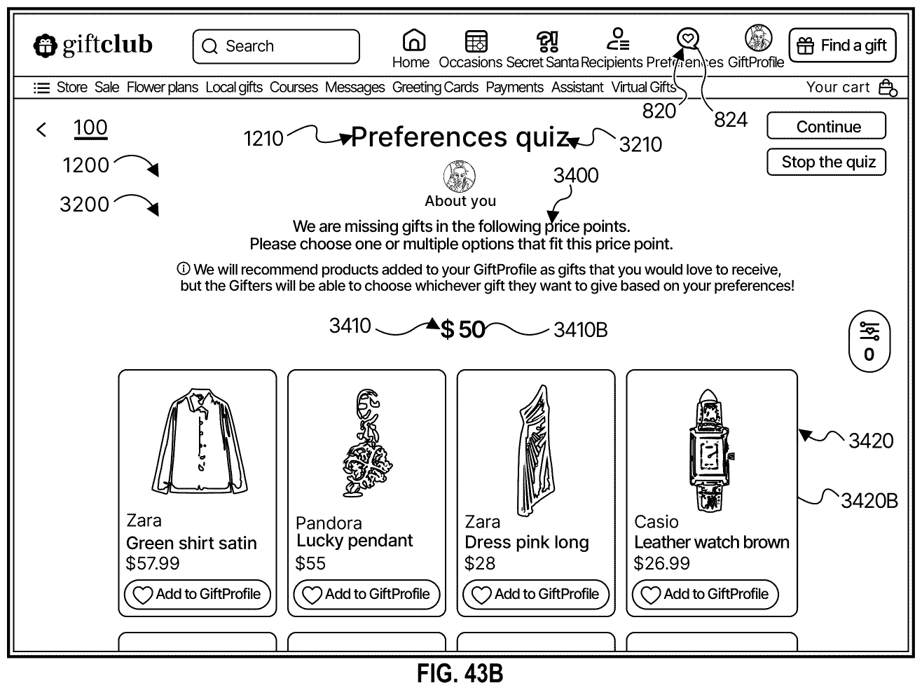

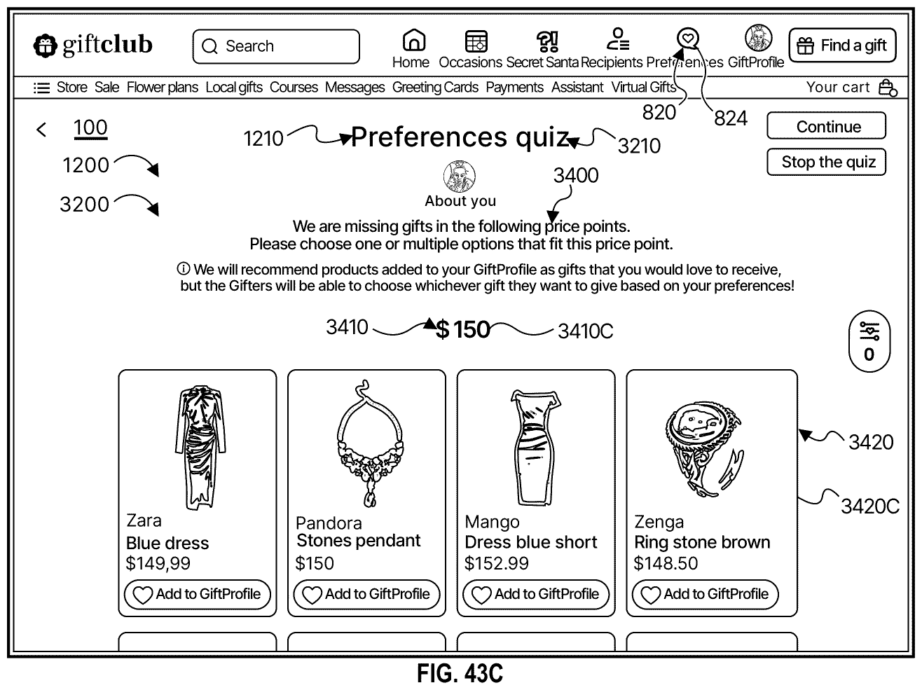

Turning to FIGS. 43A-C, the gift preferences quiz page 3200, in selected embodiments, can determine that one or more price points 3410 are not associated with at least one gift 3420. The gifter profile 3400 of the gifter, in other words, can be missing a gift 3420 for the one or more price points 3410. As shown in FIG. 43A, for example, the gift preferences quiz page 3200 can indicate that the gifter profile 3400 does not include any gifts 3420A with a first price point 3410A of $25. The gift preferences quiz page 3200 of FIG. 43B is illustrated as indicating that the gifter profile 3400 does not include any gifts 3420B that are associated with a second price point 3410B of $50. Additionally and/or alternatively, the gift preferences quiz page 3200 of FIG. 43C can indicate that the gifter profile 3400 is not associated with any gifts 3420C with a third price point 3410C of $150.

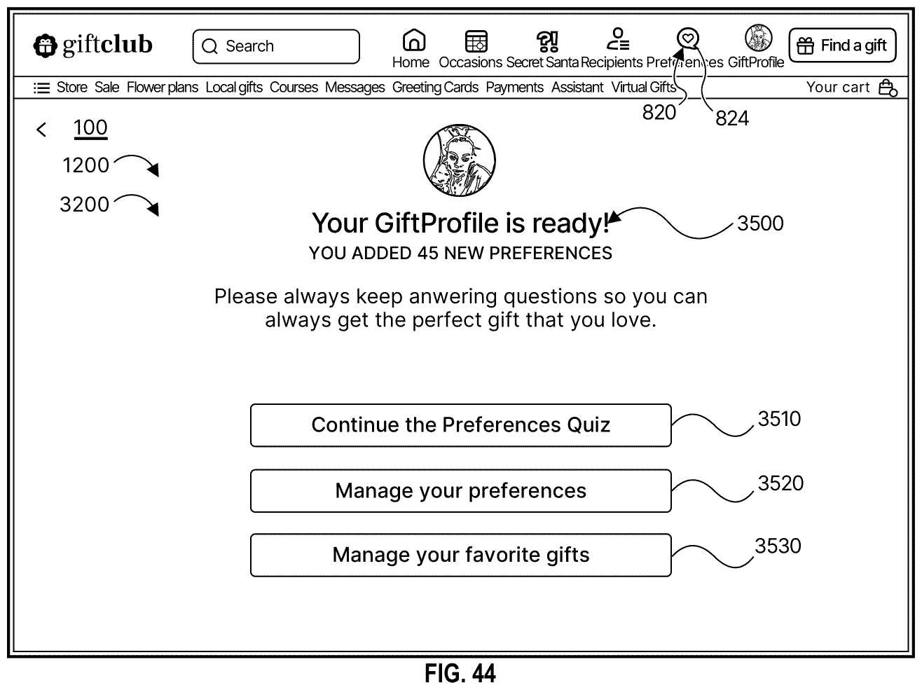

Once the gifter has completed the gift preference quiz, in whole and/or in part, the gift preferences quiz page 3200 optionally can comprise a gift preference quiz completion page 3500 as illustrated in FIG. 44. The gift preference quiz completion page 3500 can permit the gifter to continue with the gift preference quiz, at 3510, to manage one or more preferences of the gifter, at 3520, and/or managing one or more favorite gifts of the gifter, without limitation.

Activation of the occasions navigation link 813 or the occasions navigation link 821 of the gifting method 100 can enable the gifter to visit an occasions page 1300 as illustrated in FIGS. 13A-D. Turning to FIG. 13A, the occasions page 1300 can present one or more occasions 1310 associated with the gifter. The occasions 1310 can be sorted and/or presented in any suitable matter and, as shown in FIG. 13A, can be sorted by all scheduled occasions 1310A, messages 1310B, gift items 1310C and/or cash, cryptocurrency, stocks, money and/or non-fungible tokens (NTFs) 1310D. Occasions 1312 associated with the cash, cryptocurrency, stocks, money and/or non-fungible tokens (NTFs) 1310D can be presented in a chronological, monetary amount, or any other suitable order.

Turning to FIG. 13B, the occasions page 1300 can enable the gifter to create a new occasion, at 1320. The occasions page 1300 can permit the new occasion 1320 to be created for one or more selected recipients. Each recipient can be selected by searching for a gift profile of the recipient, at 1320A, selecting the recipient from a recipient list associated with the gifter, at 1320B, and/or creating a new recipient profile for a new recipient, at 1320C. If the gifter opts to select the recipient from the recipient list associated with the gifter, at 1320B, the occasions page 1300 can enable the gifter to search for a gift profile of the selected recipient, at 1320B, from among a plurality of recipient gift profiles, as shown in FIG. 13C. Additionally and/or alternatively, the gifter can select the selected recipient from a recipient list 1324 associated with the gifter, at 1324A, and/or to create a new recipient profile for the chosen recipient, at 1324B.

The occasions page 1300 likewise can enable the gifter to choose what the gifter would like to give to the selected recipient, at 1330, as illustrated in FIG. 13D. The gifter, for example, can send a text message 1331A, a virtual greeting card 1331B, flowers 1331C, a gift 1331D, money 1331E, cryptocurrency or stocks 1331F and/or collectables 1331G to the selected recipient. In selected embodiments, the gifter can give the flowers 1331C to the selected recipient via the flower plan page 900 of the gifting method 100 as shown described herein with reference to FIGS. 9A-R.

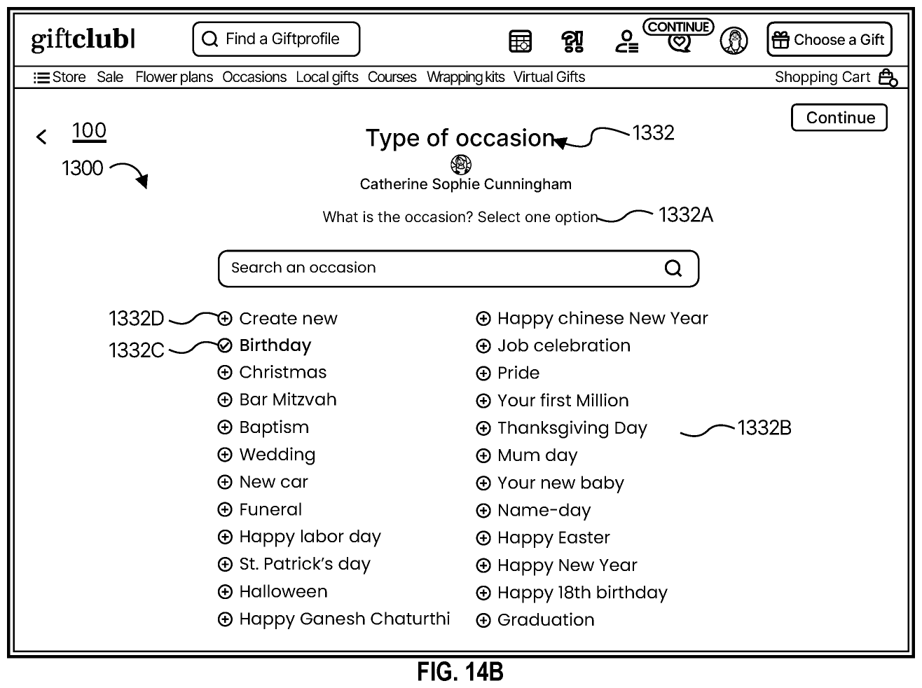

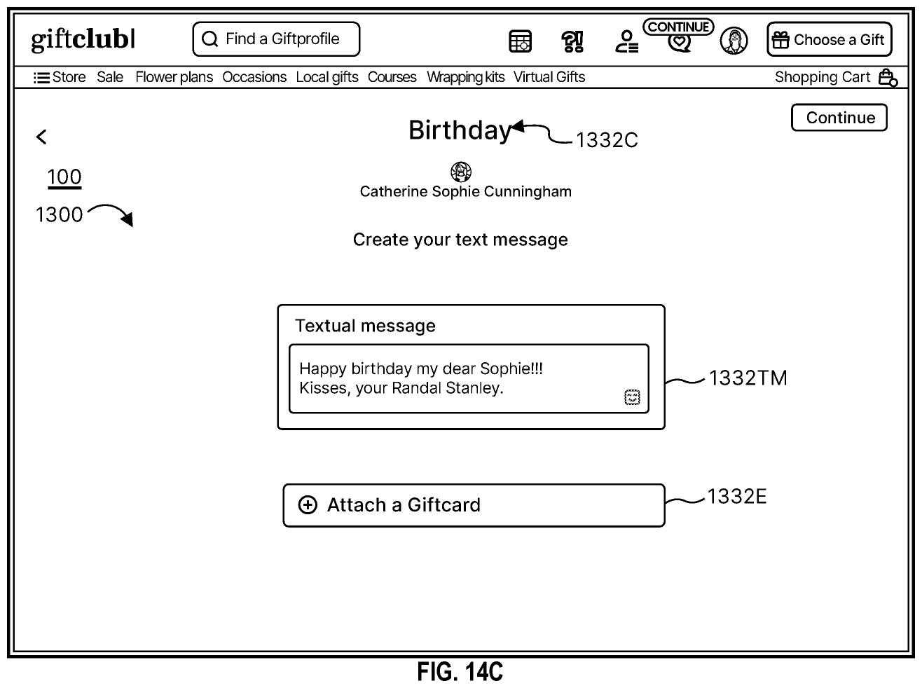

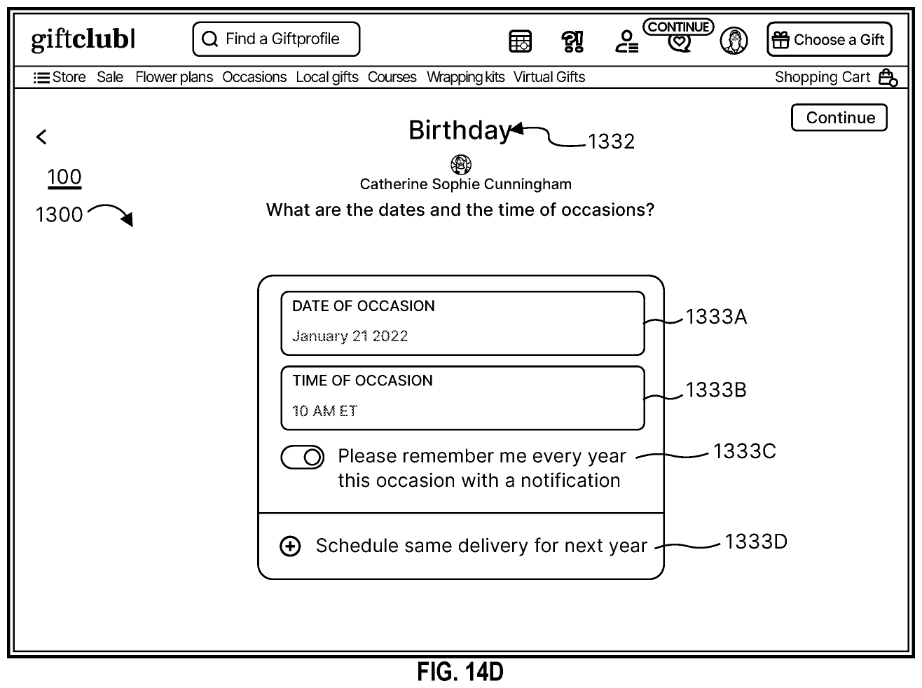

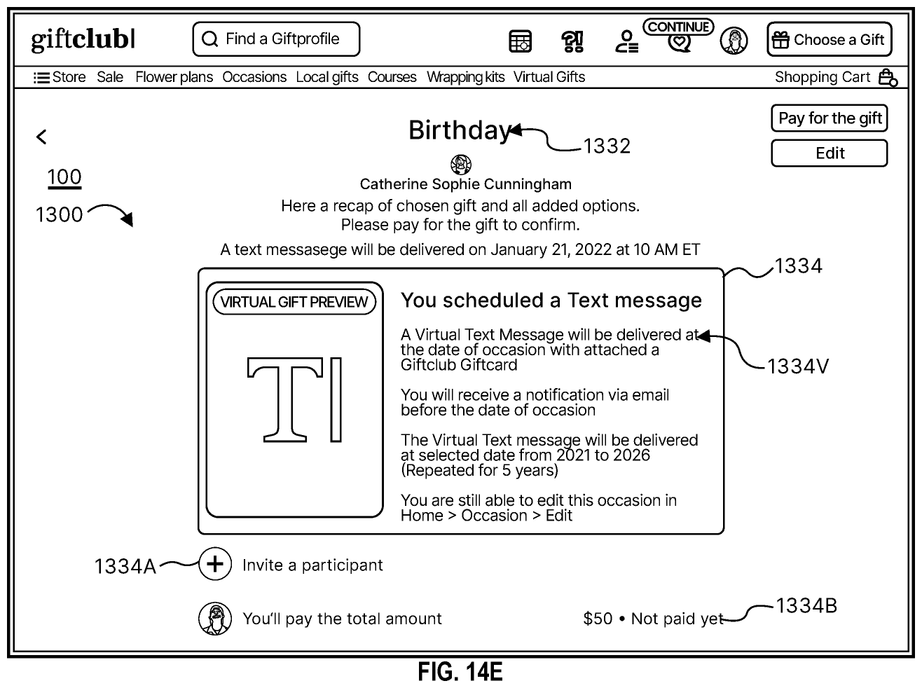

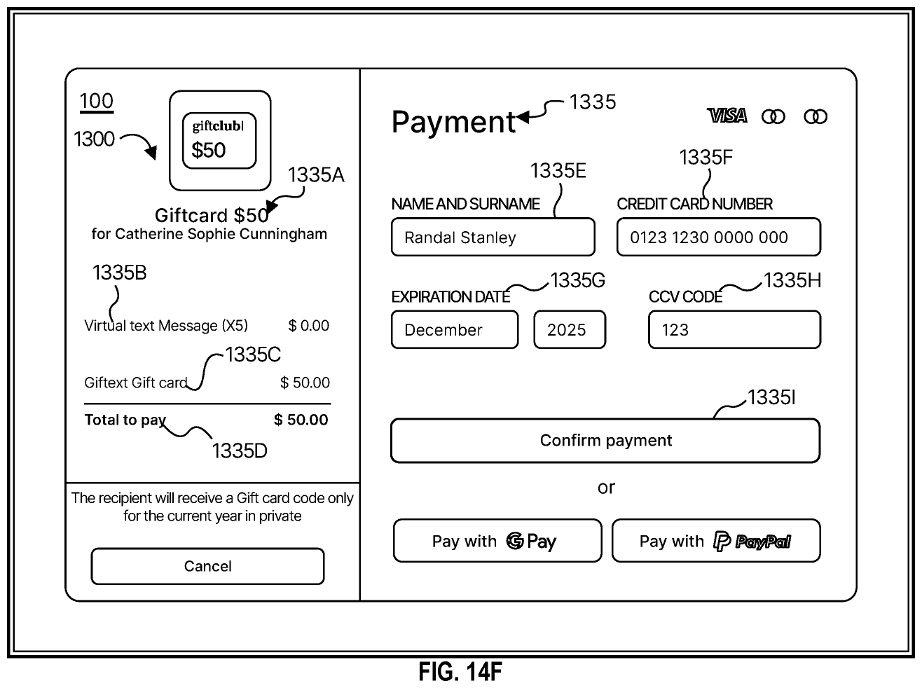

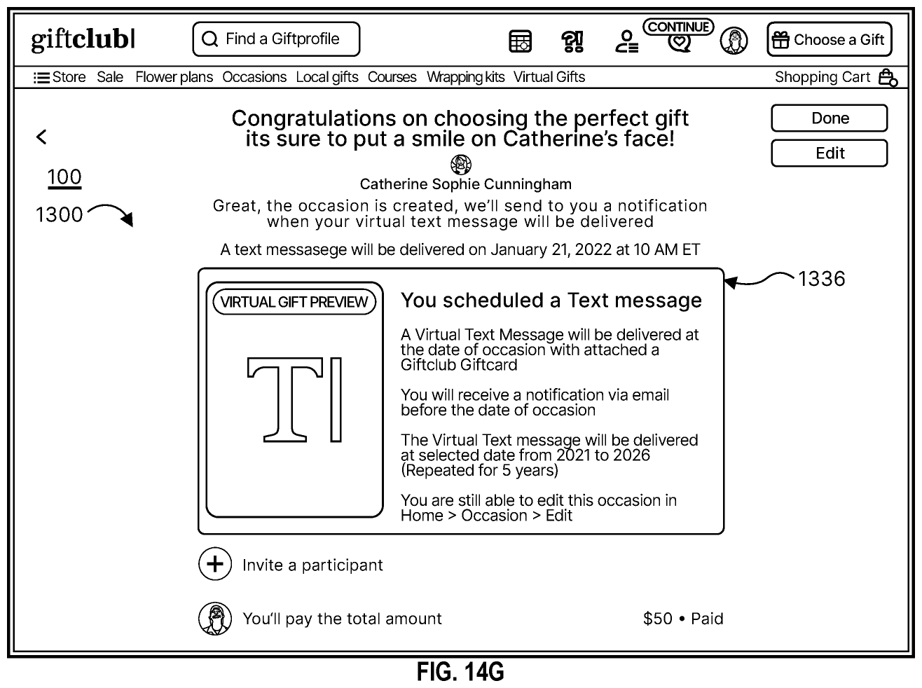

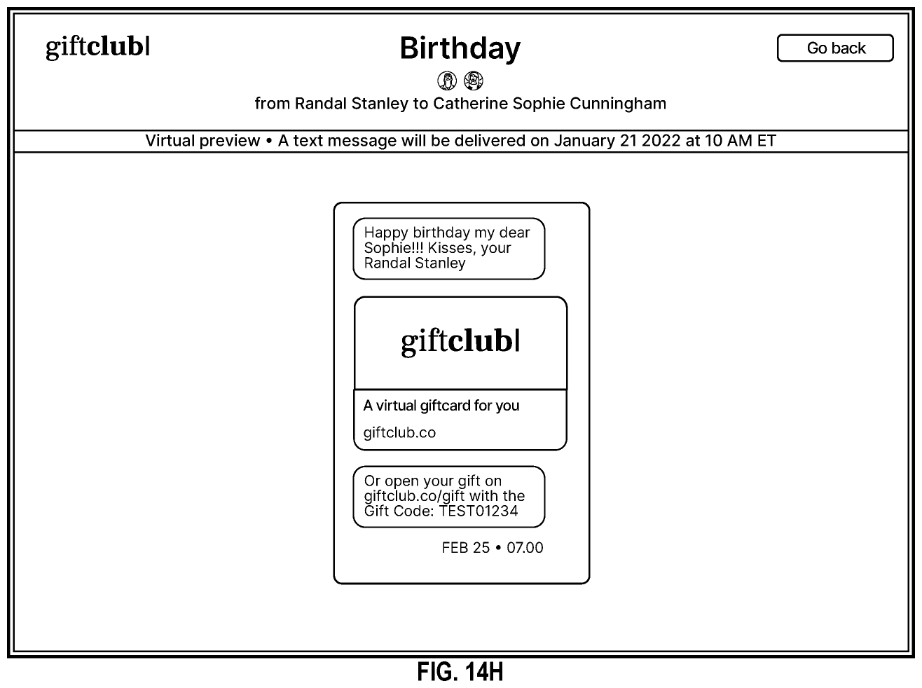

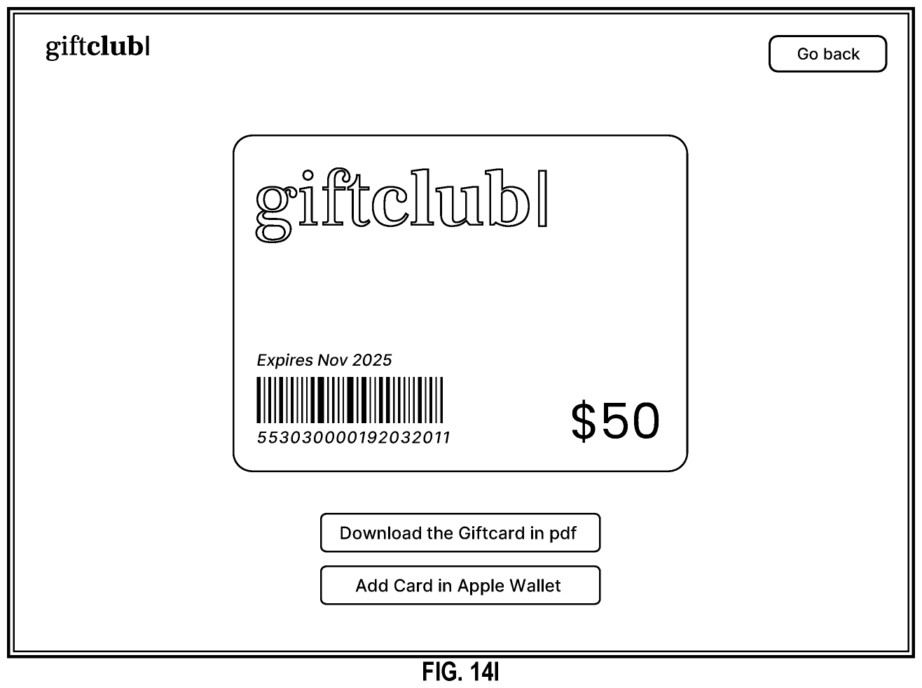

FIG. 14A illustrates the occasions page 1300 when the gifter elects to send a text message 1331A to the selected recipient. The occasions page 1300 can enable the gifter to identify an occasion type 1332 for the new occasion as shown in FIG. 14B. The gifter, for example, can search for an appropriate occasion type 1332, at 1332A, from among a plurality of preselected occasion types. Additionally and/or alternatively, the gifter can select the occasion type 1332 from an occasion type list 1332B and/or to create a new occasion type 1332D for the new occasion 1320. The gifter thereby can select an appropriate occasion type 1332C for the new occasion. The occasions page 1300 optionally can enable the gifter to enter a textual message 1332TM and/or attach a gift card 1332E to the text message 1331A as illustrated in FIG. 14C. The occasions page 1300 of FIG. 14D can enable the gifter to set an occasion date 1333A and/or occasion time 1333B for the new occasion 1320. The gifter likewise can elect to receive annual or otherwise periodic reminders about the new occasion 1320, at 1333C, and/or schedule the same text message for periodic delivery, at 1333D.

Turning to FIG. 14E, the occasions page 1300 can provide a recap information, at 1334, for the text message 1331A. The occasions page 1300 optionally can invite another recipient, at 1134A, to participate in the text message 1331A and/or remind the gifter, at 1334B, of any amount due but not yet paid. Additionally and/or alternatively, the occasions page 1300 can provide a virtual text message preview of the text message 1331A for viewing, at 1334V, via a virtual gifts and cards link 1640 (shown in FIG. 19A) of the gifter profile page 1600 (shown in FIG. 19A) and/or a recipient profile page of the selected recipient. Turning to FIG. 14F, a payment page 1335 of the occasions page 1300 is shown. The payment page 1335 can confirm the text message 1331A selected by the gifter, any associated cost 1335B and/or any greeting card or other costs 1335C. A total price 1335D can be shown on the payment page 1335 for the text message 1331A.

The payment page 1335 of FIG. 14F is illustrated as enabling the gifter to enter payment information. The payment information can include, but is not limited to, a gifter name 1335E, a number 1335F for a credit card, debit card or other transaction payment method associated with the gifter, an expiry date 1335G for the payment method and/or a CVV 1335H for the payment method. The payment page 1335 optionally can ask the gifter to confirm the payment, at 1335I, before submission of the payment information. The occasions page 1300 can provide payment confirmation and scheduling information, at 1336, for the text message 1331A as illustrated in FIG. 14G. An exemplary text message 1331A and associated gift card as received by the selected recipient are illustrated in FIGS. 14H-I.

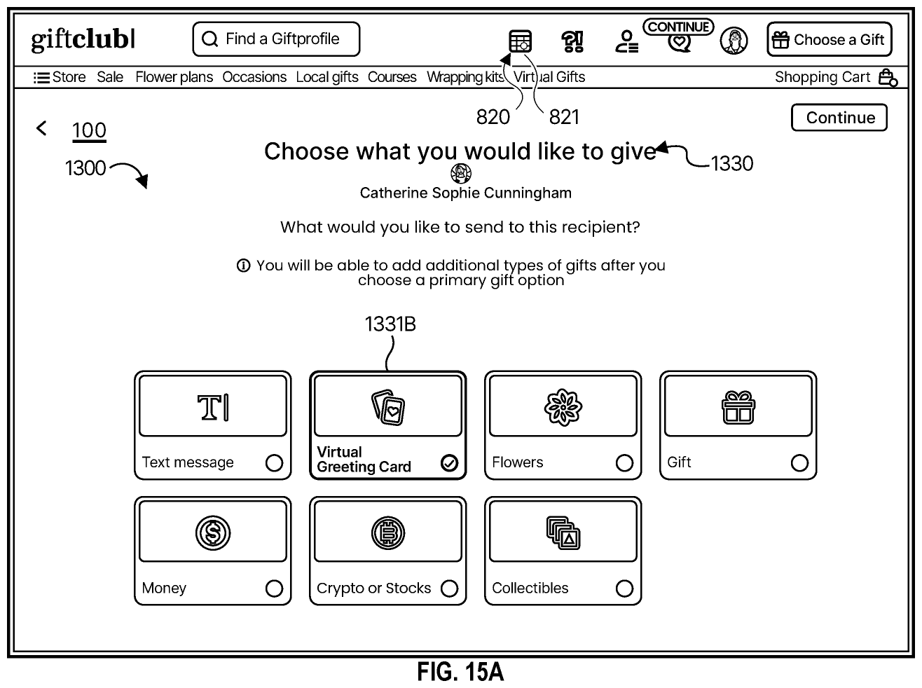

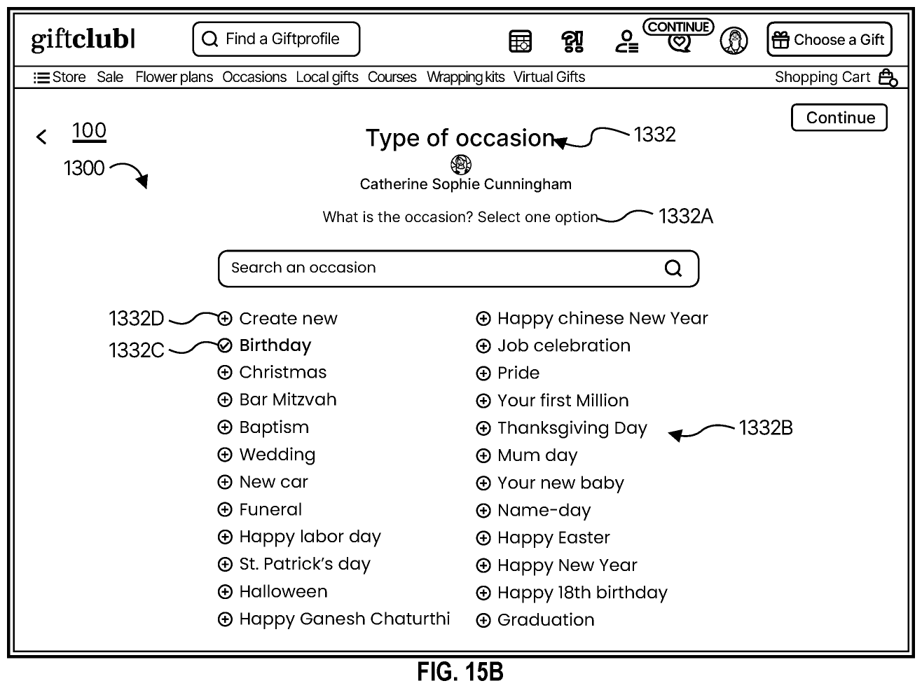

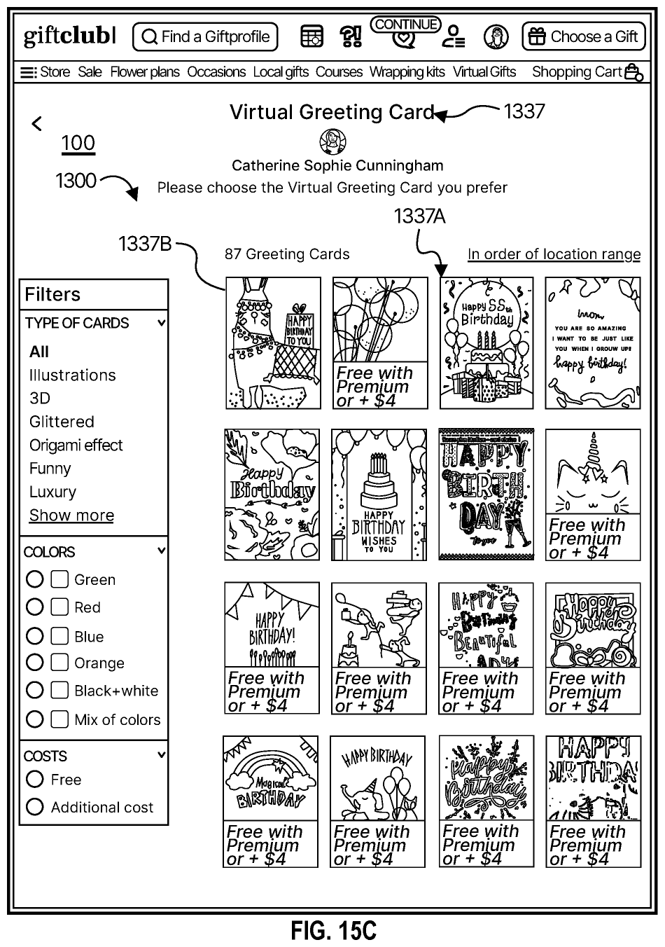

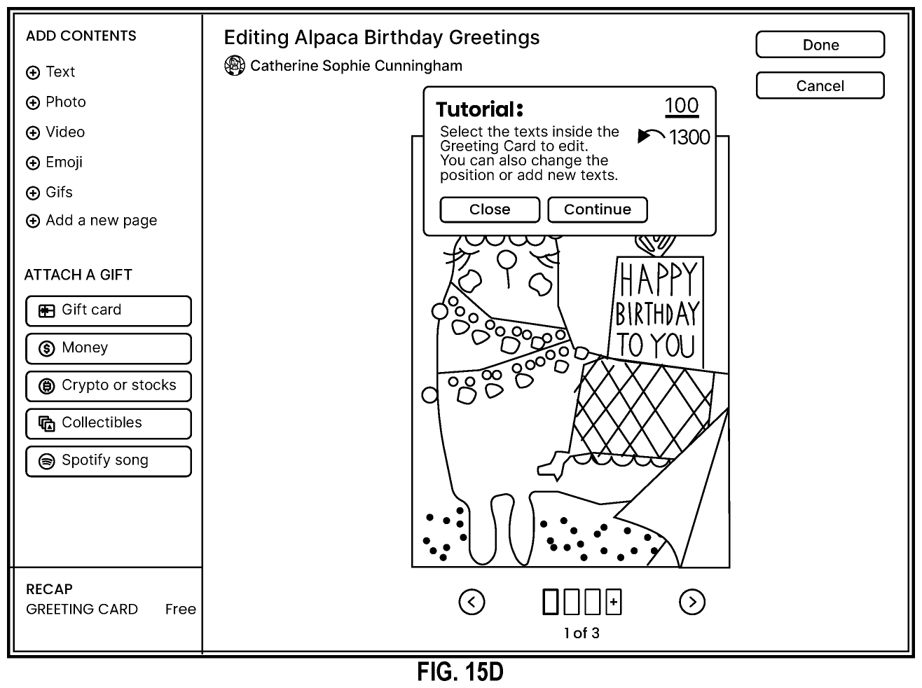

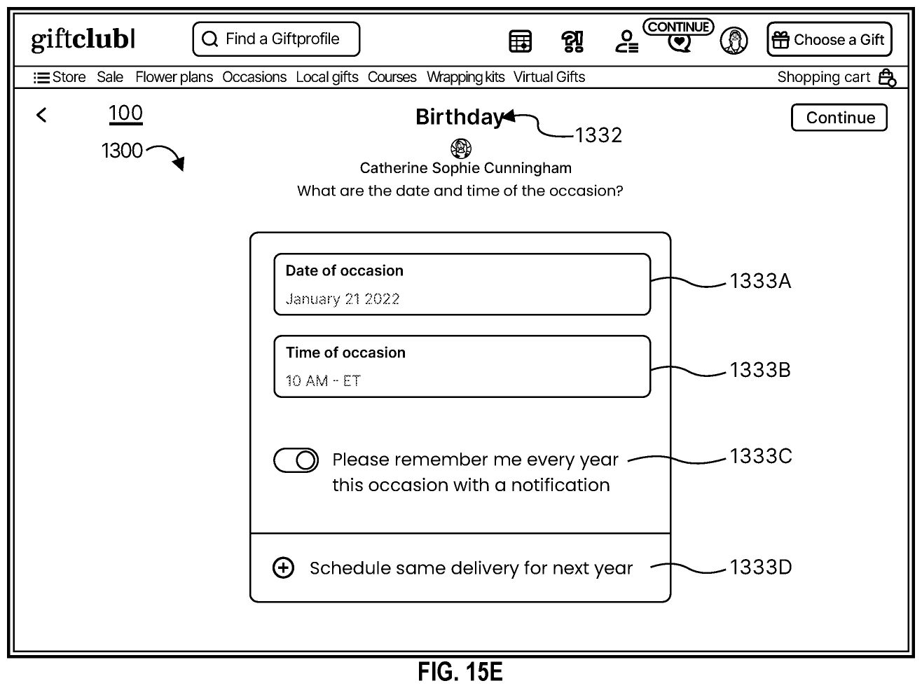

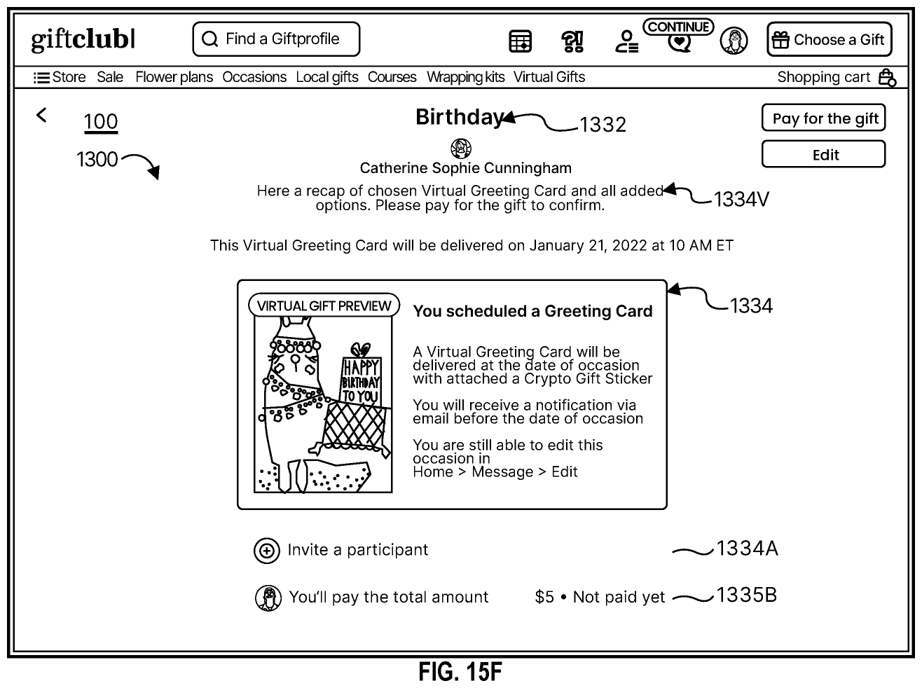

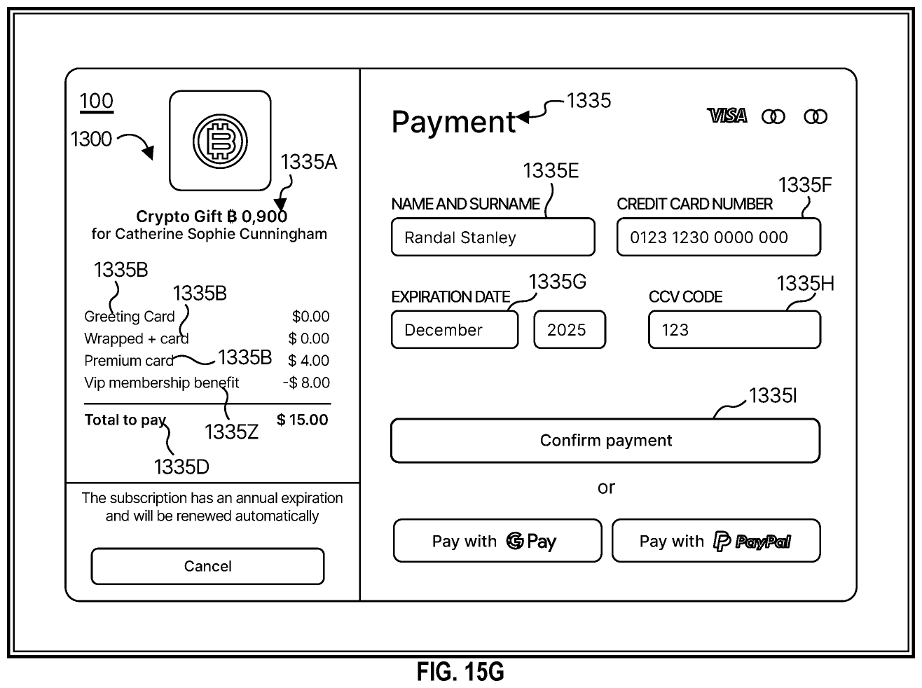

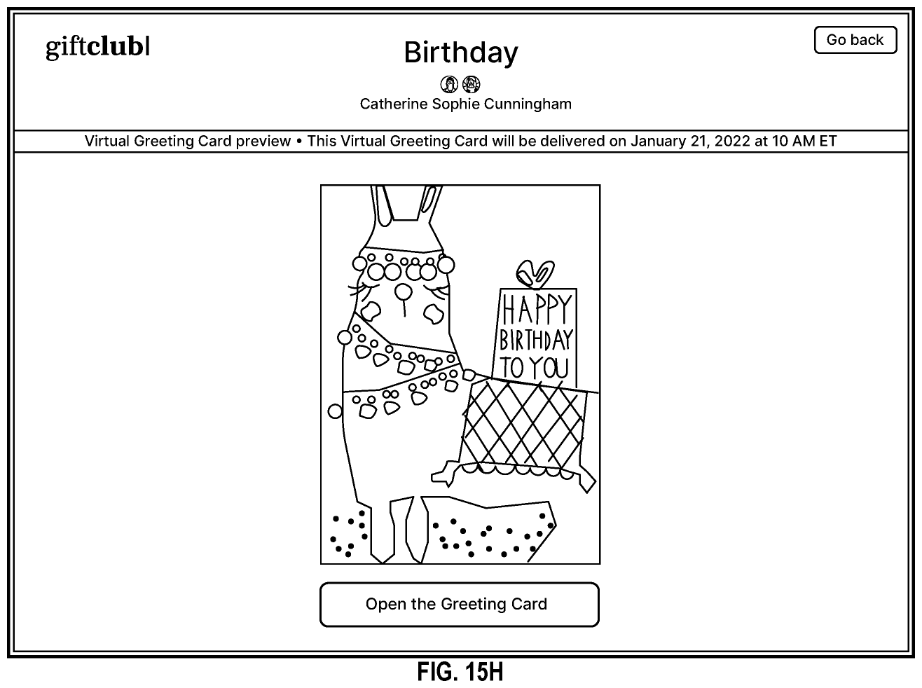

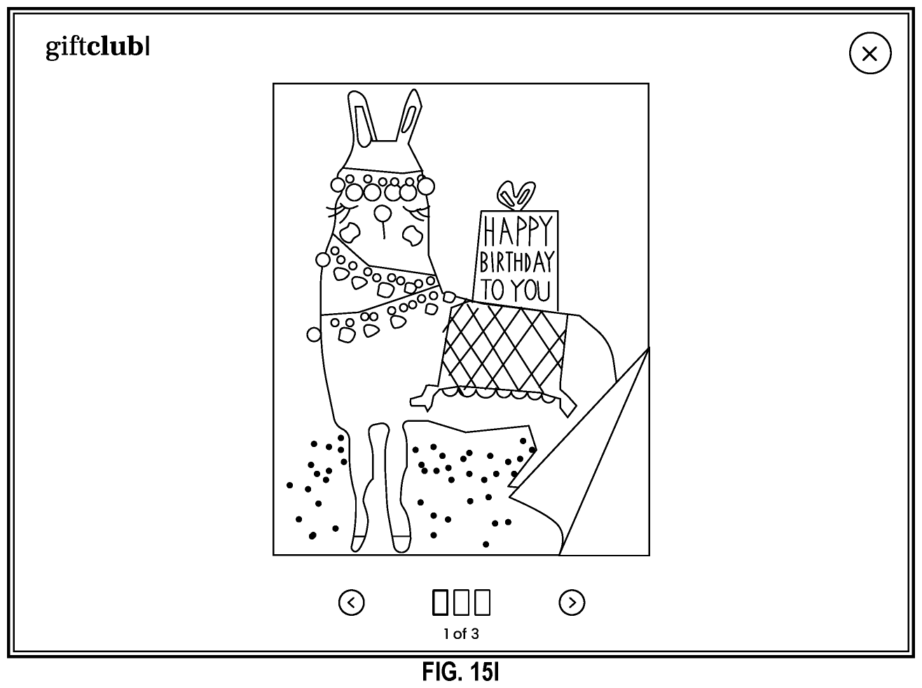

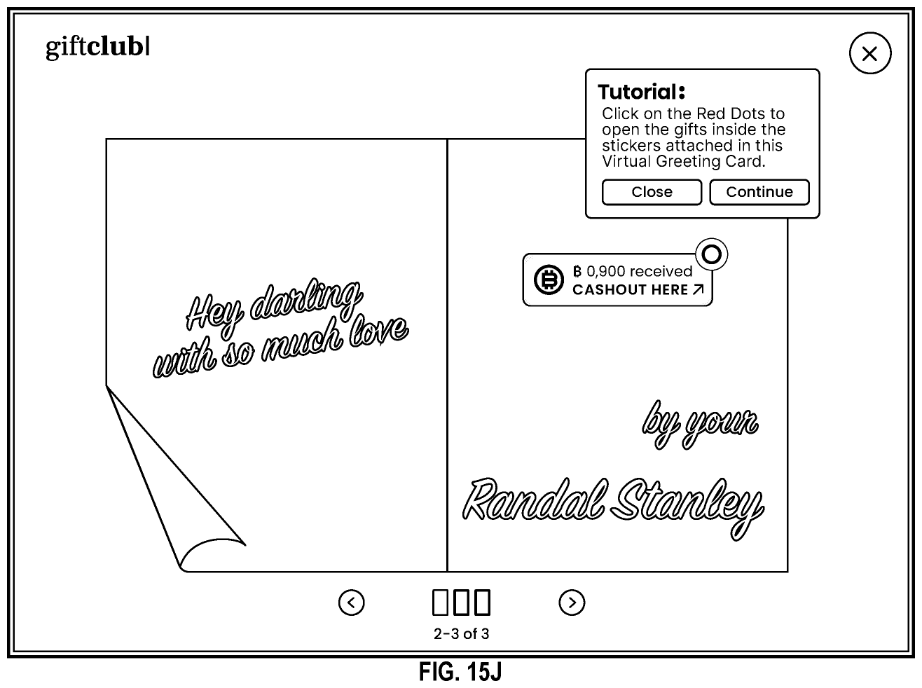

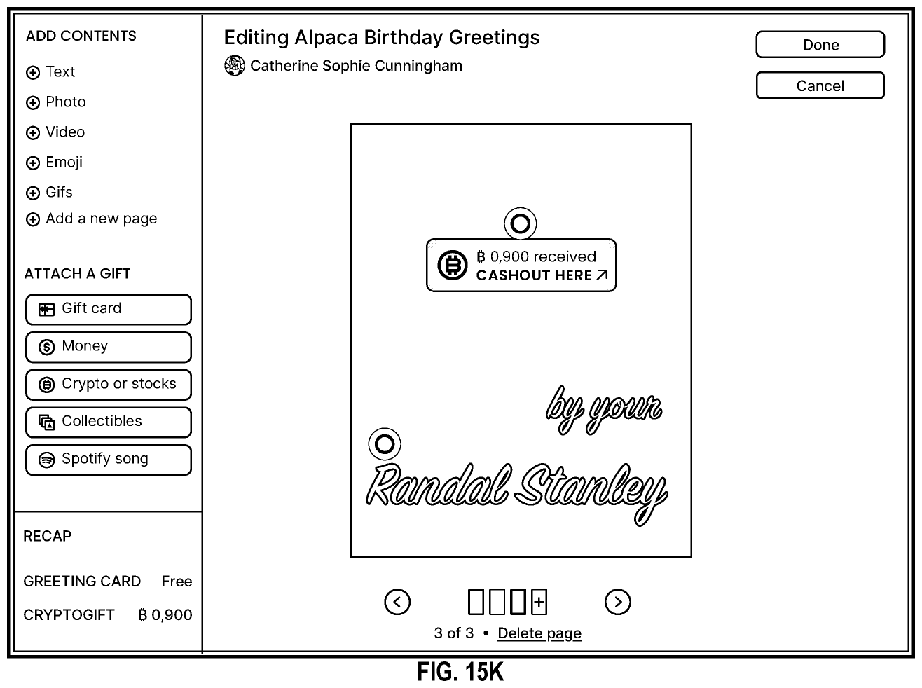

FIG. 15A illustrates the occasions page 1300 when the gifter elects to send a virtual greeting card 1331B to the selected recipient. The occasions page 1300 can enable the gifter to identify an occasion type 1332 for the new occasion as shown in FIG. 15B. The gifter, for example, can search for an appropriate occasion type 1332, at 1332A, from among a plurality of preselected occasion types. Additionally and/or alternatively, the gifter can select the occasion type 1332 from an occasion type list 1332B and/or to create a new occasion type 1332D for the new occasion 1320. The gifter thereby can select an appropriate occasion type 1332C for the new occasion. The occasions page 1300 of FIG. 15C is shown as presenting one or more proposed virtual greeting cards 1137A for consideration by the gifter and as enabling the gifter to select a relevant virtual greeting card 1137B for dispatch to the selected recipient. The occasions page 1300 optionally can enable the gifter to enter a textual message and/or attach a gift card to the virtual greeting card 1331B as illustrated in FIG. 15D. In selected embodiments, the gifter can include a gift, such as cash, cryptocurrency, stocks, money and/or non-fungible tokens (NTFs), with the virtual greeting card sent to the recipient.

Additionally and/or alternatively, the occasions page 1300 can enable the gifter to send a charitable donation to a selected charity as a gift to the recipient. The charitable donation optionally can be included as a gift associated with a greeting card, such as the virtual greeting card. The occasions page 1300, for example, can present a charitable donation link (not shown) for enabling the gifter to make the charitable donation in the name of the recipient and/or to make the charitable donation as a gift in honor of an event, such as a birthday or anniversary, associated with the recipient. Upon activation of the charitable donation link, the occasions page 1300 can present a list of charities from which to choose and/or a search box for enabling the gifter to choose a charity based on the cause, for example, cancer or Alzheimer's disease.

The donation details can include a name and/or logo of the chosen charity and/or the donation amount. If associated with a greeting card, the donation details can be presented inside of the greeting card, can be presented via a sticker within the greeting card and/or can appear inside a wrapped virtual package.

The occasions page 1300 of FIG. 15E can enable the gifter to set an occasion date 1333A and/or occasion time 1333B for the new occasion 1320. The gifter likewise can elect to receive annual or otherwise periodic reminders about the new occasion 1320, at 1333C, and/or schedule the same text message for periodic delivery, at 1333D. Turning to FIG. 15F, the occasions page 1300 can provide a recap information, at 1334, for the virtual greeting card 1331B. The occasions page 1300 optionally can invite another recipient, at 1134A, to participate in the virtual greeting card 1331B and/or remind the gifter, at 1334B, of any amount due but not yet paid. Additionally and/or alternatively, the occasions page 1300 can provide a virtual greeting card preview of the virtual greeting card 1331B for viewing, at 1334V, via a virtual gifts and cards link 1640 (shown in FIG. 19A) of the gifter profile page 1600 (shown in FIG. 19A) and/or a recipient profile page of the selected recipient.

Turning to FIG. 15G, a payment page 1335 of the occasions page 1300 is shown. The payment page 1335 can confirm the virtual greeting card 1331B selected by the gifter, any associated gift costs 1335A, any additional gift wrapping, greeting card or other costs 1335B, and/or any membership or other discounts 1335Z. A total price 1335D can be shown on the payment page 1335 for the virtual greeting card 1331B. The payment page 1335 of FIG. 15G is illustrated as enabling the gifter to enter payment information. The payment information can include, but is not limited to, a gifter name 1335E, a number 1335F for a credit card, debit card or other transaction payment method associated with the gifter, an expiry date 1335G for the payment method and/or a CVV 1335H for the payment method. The payment page 1335 optionally can ask the gifter to confirm the payment, at 1335I, before submission of the payment information. The occasions page 1300 can provide scheduling information, at 1336, for the virtual greeting card 1331B. An exemplary virtual greeting card 1331B as received by the selected recipient are illustrated in FIGS. 15H-K.

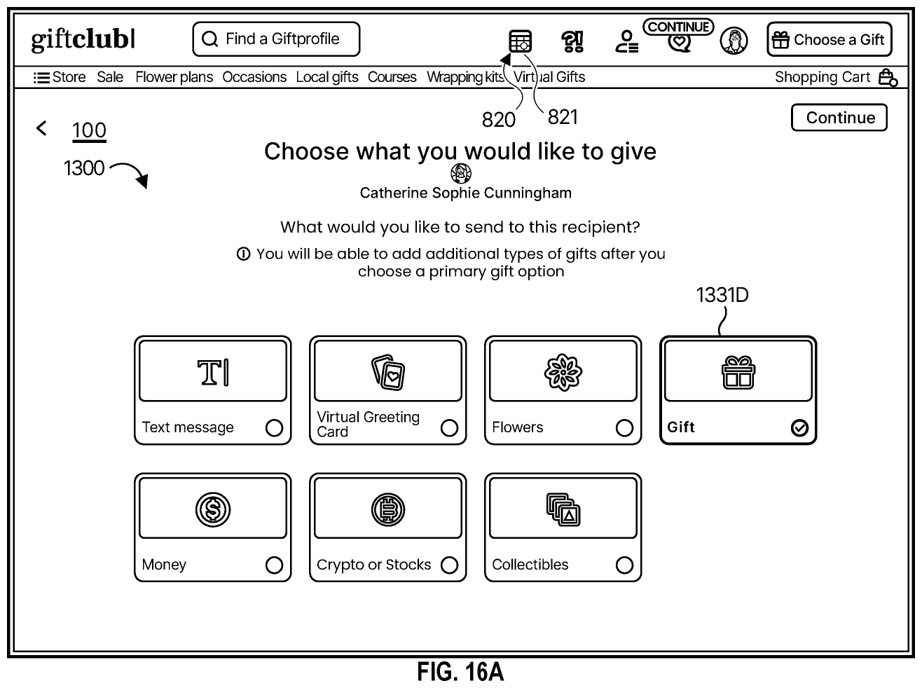

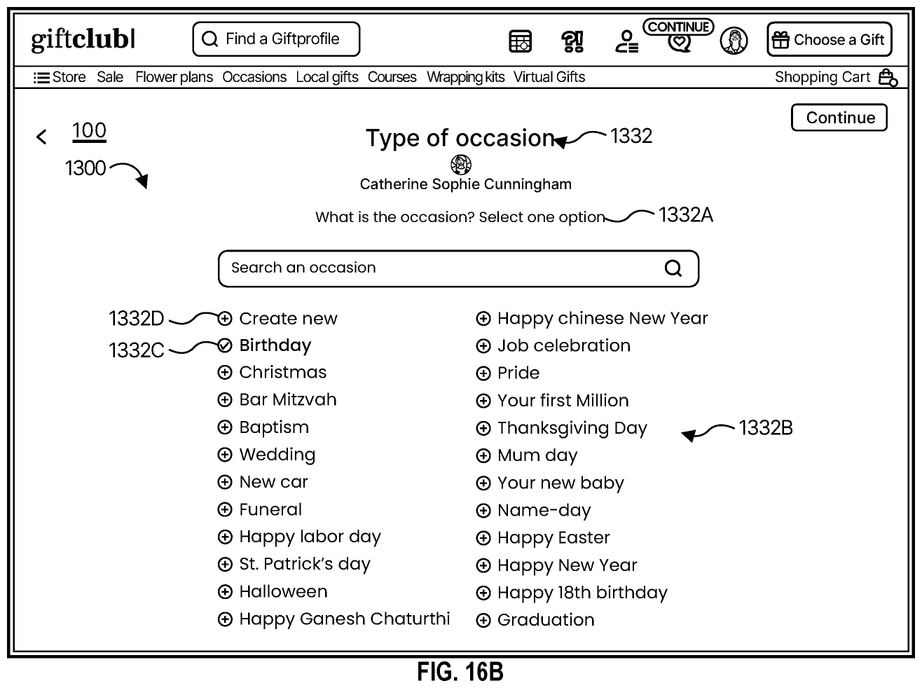

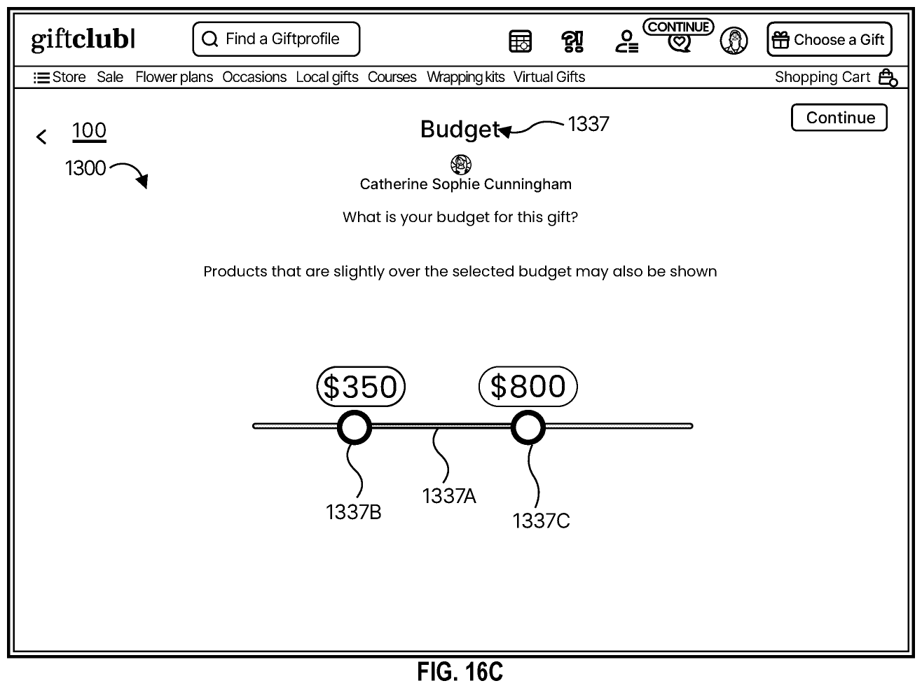

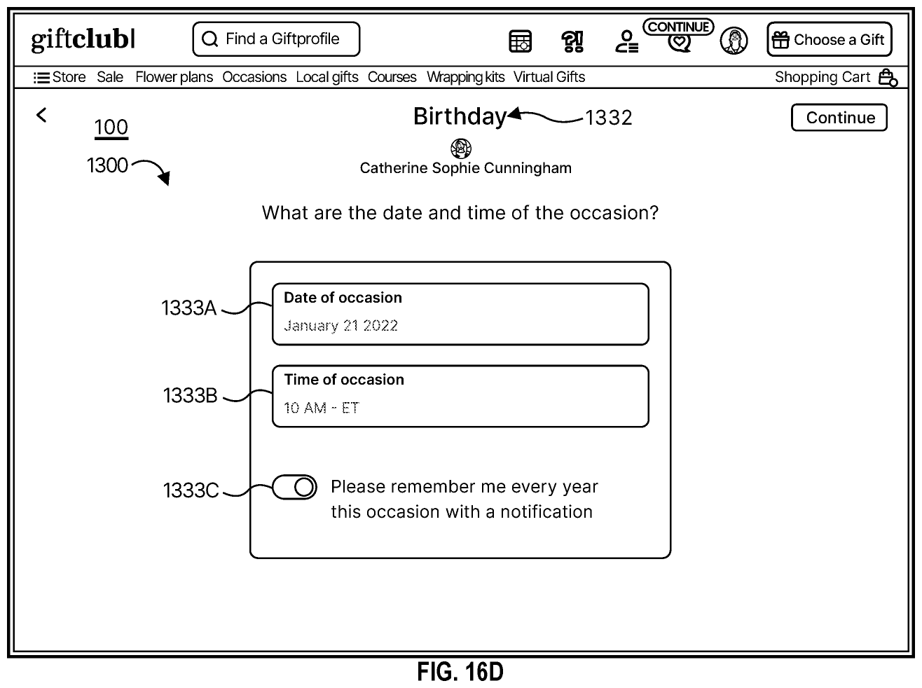

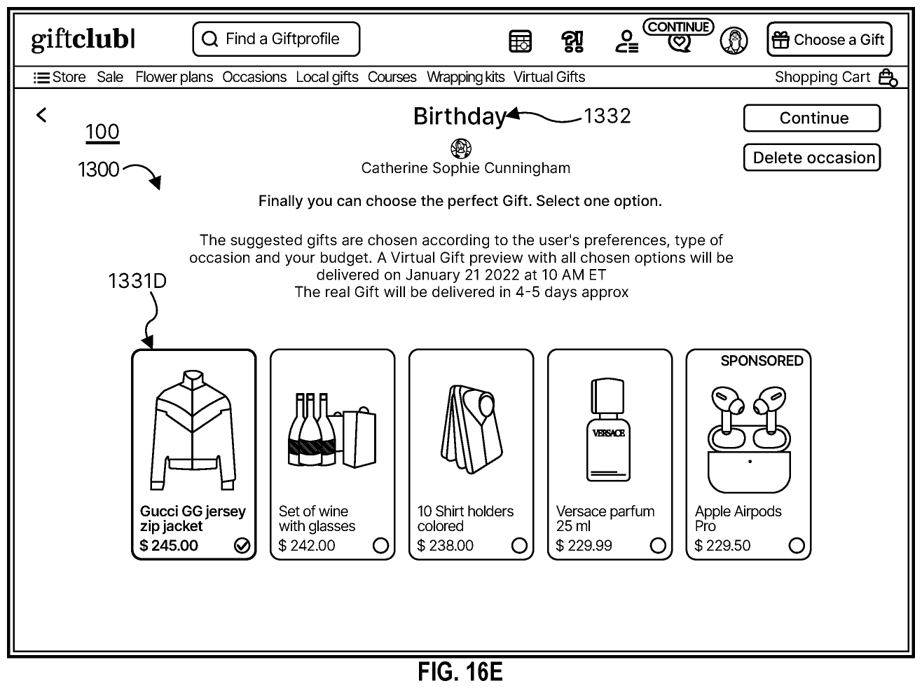

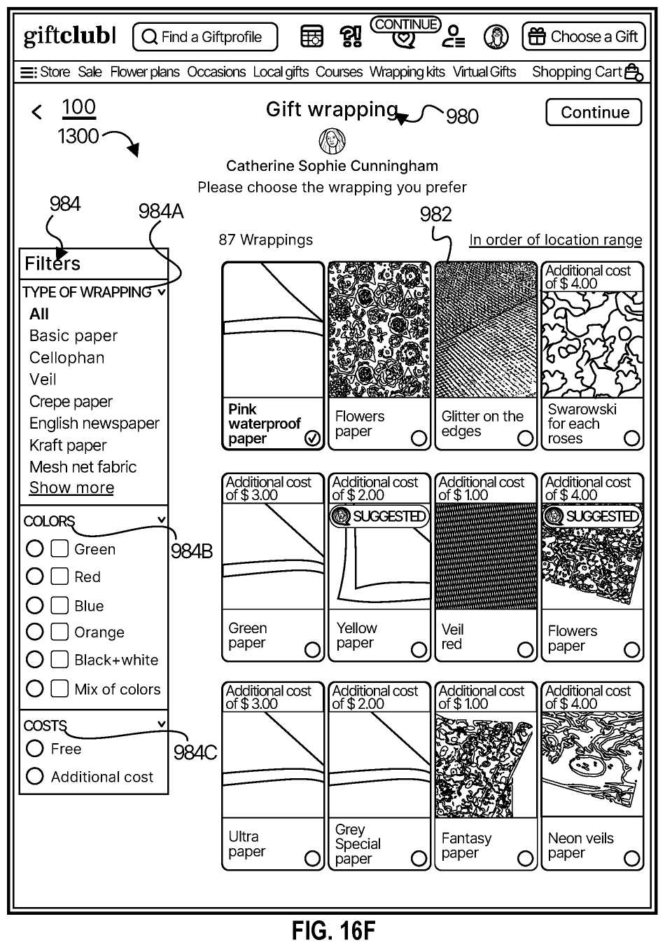

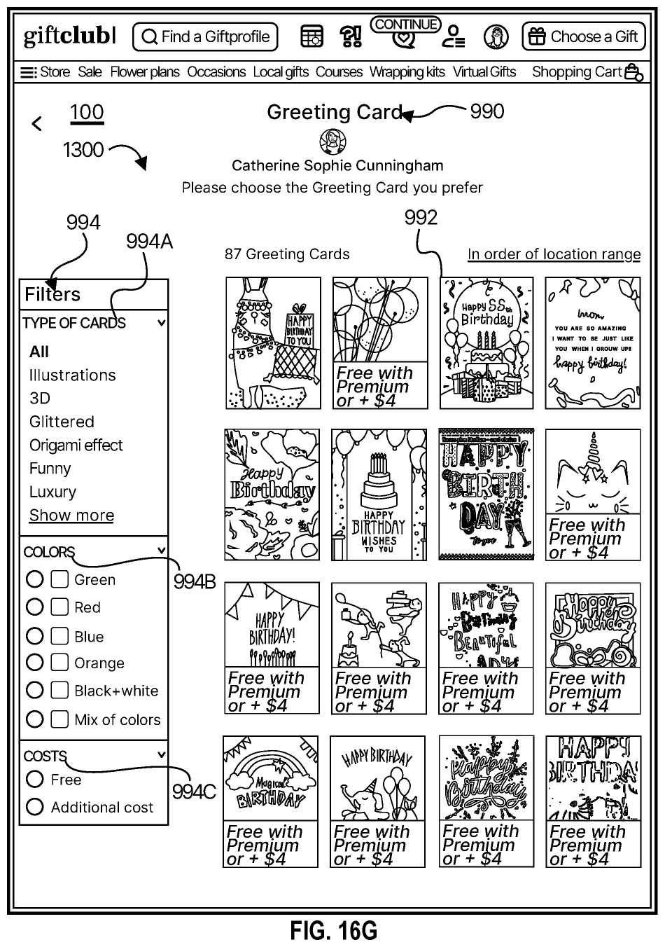

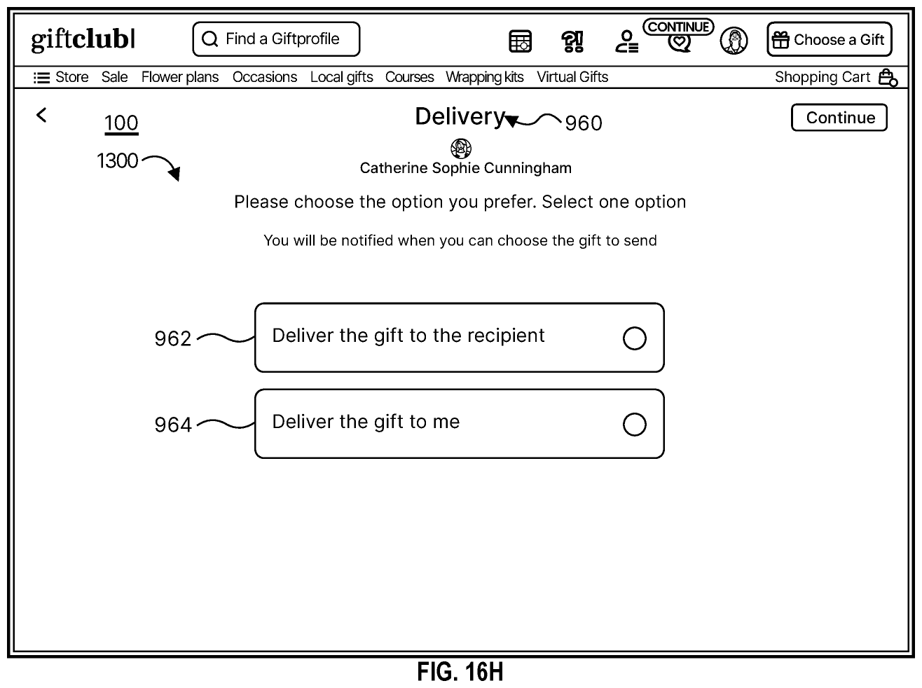

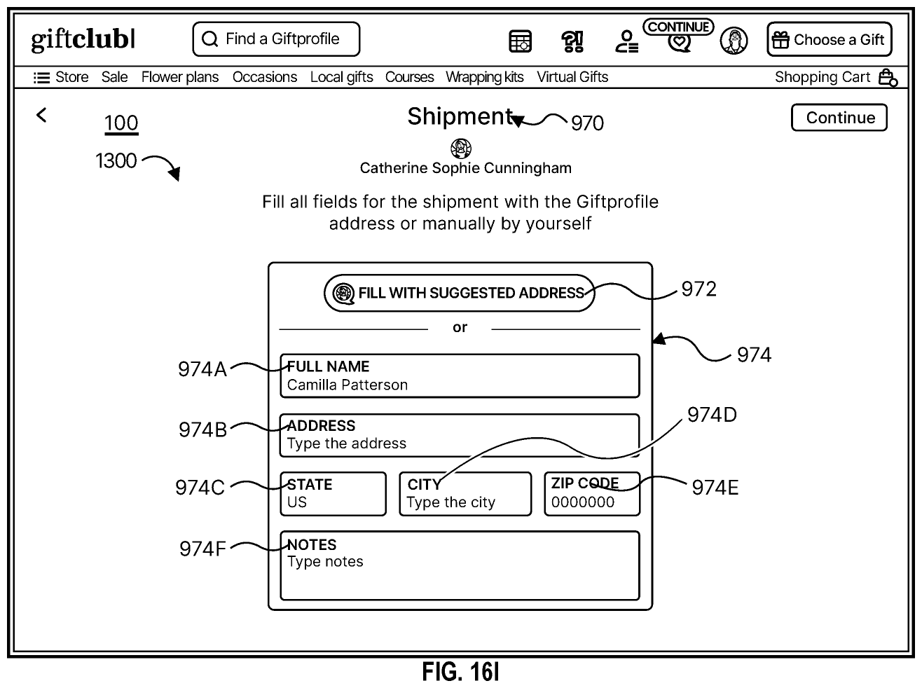

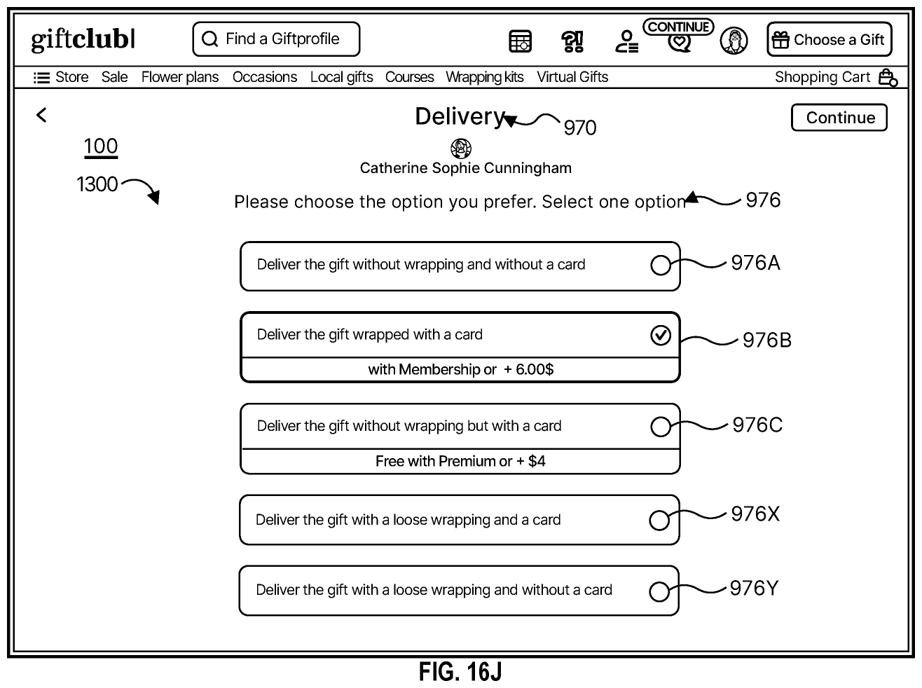

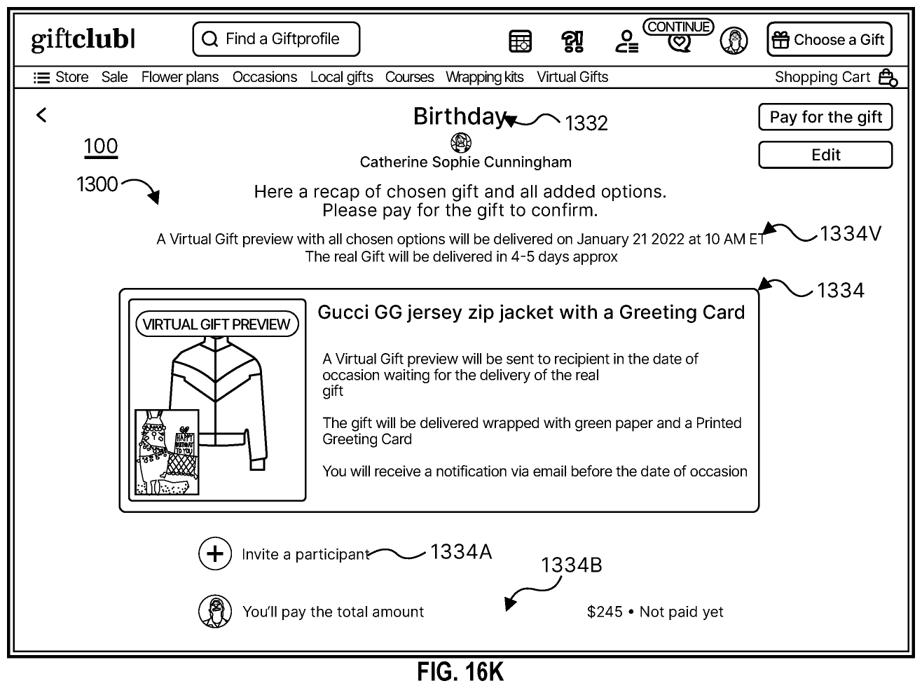

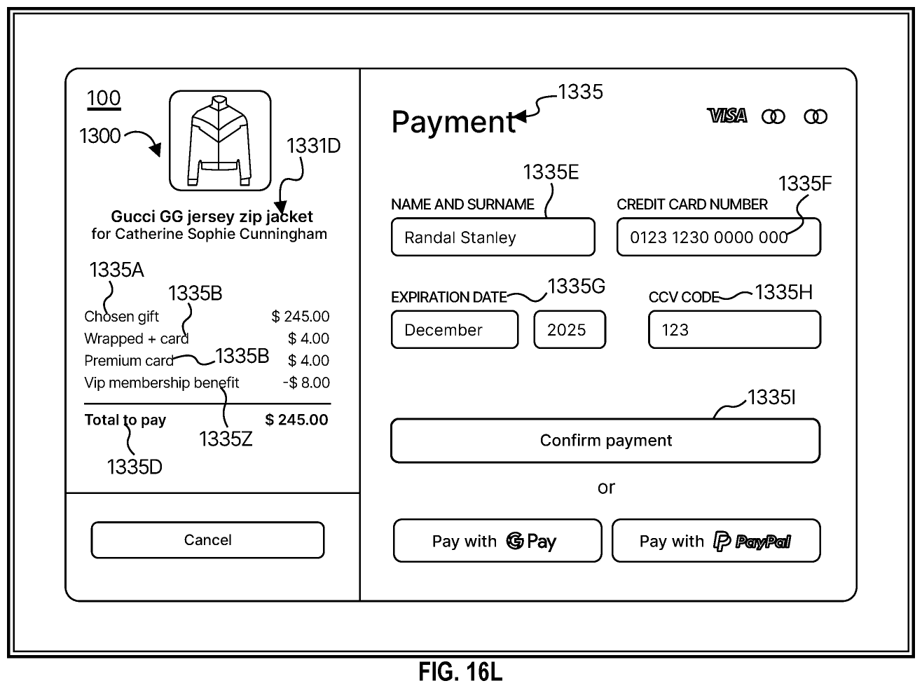

FIG. 16A illustrates the occasions page 1300 when the gifter elects to send a selected gift 1331D to the selected recipient. The occasions page 1300 can enable the gifter to identify an occasion type 1332 for the new occasion as shown in FIG. 16B. The gifter, for example, can search for an appropriate occasion type 1332, at 1332A, from among a plurality of preselected occasion types. Additionally and/or alternatively, the gifter can select the occasion type 1332 from an occasion type list 1332B and/or to create a new occasion type 1332D for the new occasion 1320. The gifter thereby can select an appropriate occasion type 1332C for the new occasion.

Budgetary information 1337 optionally can be established for the selected gift 1331D as shown in FIG. 16C. The budgetary information 1337, for example, can include a fixed amount of money and/or, as shown in FIG. 16C, can include a budget range 1337A with a low budget range amount 1337B and a high budget range amount 1337C. The occasions page 1300 of FIG. 16D can enable the gifter to set an occasion date 1333A and/or occasion time 1333B for the new occasion 1320. The gifter likewise can elect to receive annual or otherwise periodic reminders about the new occasion 1320, at 1333C, and/or schedule the same selected gift 1331D for periodic delivery. Turning to FIG. 16E, the selected gift 1331D can be selected in the manner set forth in more detail herein, such as based upon the occasion type 1332, the budgetary information 1337 and/or preferences of the gifter and/or recipient as set forth in the respective profiles.

As shown in FIG. 16F, the occasions page 1300 can include a gift wrapping page 980 for presenting one or more gift wrapping options 982 to the gifter. An additional cost may be associated with one or more of the gift wrapping options and the additional cost optionally can vary depending upon the type of selected gift 1331D selected by the gifter. At least one suggested gift wrapping option 982 may be suggested based upon the preferences of the gifter and/or the preferences of the selected recipient. To facilitate selection of an appropriate gift wrapping option 982, the gift wrapping page 980 can present one or more filters 984 for narrowing the presented gift wrapping options 982. The filters 984 can include, but are not limited to, a type of gift wrapping 984A, a color of the gift wrapping 984B and/or a cost for the gift wrapping 984C.

The occasions page 1300 can include a greeting card page 990 for presenting one or more greeting card options 992 to the gifter as illustrated in FIG. 16G. An additional cost may be associated with one or more of the greeting card options and the additional cost optionally can vary depending upon the type of selected gift 1331D selected by the gifter. At least one suggested greeting card option 992 may be suggested based upon the preferences of the gifter and/or the preferences of the selected recipient. To facilitate selection of an appropriate greeting card option 992, the greeting card page 990 can present one or more filters 994 for narrowing the presented greeting card options 992. The filters 994 can include a type of greeting card 994A, a color of the greeting card 994B and/or a cost for the greeting card 994C, without limitation.

As illustrated in FIG. 16H, the occasions page 1300 can enable the gifter to provide delivery instruction, at 960, for the selected gift 1331D. Delivery instruction, for example, can include instruction to deliver the selected gift 1331D directly to the chosen recipient, at 962, and/or to deliver the selected gift 1331D to the gifter, at 964. Additionally and/or alternatively, the occasions page 1300 can enable the gifter to provide shipment instruction, at 970, for the selected gift 1331D. As shown in FIG. 16I, for example, the gifter can enter recipient information 972. The recipient information 972 can include, but is not limited to, a recipient name 974A, a recipient street address 974B, a recipient state 974C, a recipient city 974D and/or a recipient ZIP code 974E. The gifter optionally can enter one or more notes 974F for the selected gift 1331D via the occasions page 1300. The gifting method 100 optionally can suggest a shipping address for the selected gift 1331D, while preferably maintaining the confidentiality of the chosen recipient by limiting the recipient information that is presented to the gifter.

The occasions page 1300 advantageously can enable the gifter to select one or more shipping options 976 for the selected gift 1331D. Turning to FIG. 16J, for example, the occasions page 1300 can permit the gifter to select a gift wrapping option and/or a card option for the selected gift 1331D. For example, the gifter can choose to ship the selected gift 1331D to the chosen recipient without gift wrapping and without a card, at 976A. The gifter alternatively can ship the selected gift 1331D to the chosen recipient with both gift wrapping and a card, at 976B, with a card but no gift wrapping, at 976C, with a loose wrapping and a card, at 976X and/or with a loose wrapping and without a card, at 976Y. Turning to FIG. 16K, the occasions page 1300 can provide a recap information, at 1334, for the gift 1331D. The occasions page 1300 optionally can invite another recipient, at 1134A, to participate in the gift 1331D and/or remind the gifter, at 1334B, of any amount due but not yet paid. Additionally and/or alternatively, the occasions page 1300 can provide a virtual gift preview of the gift 1331D for viewing, at 1334V, via a virtual gifts and cards link 1640 (shown in FIG. 19A) of the gifter profile page 1600 (shown in FIG. 19A) and/or a recipient profile page of the selected recipient.

Turning to FIG. 16L, a payment page 1335 of the occasions page 1300 is shown. The payment page 1335 can confirm the gift 1331D selected by the gifter, any associated gift costs 1335A, any additional gift wrapping, greeting card or other costs 1335B, and/or any membership or other discounts 1335Z. A total price 1335D can be shown on the payment page 1335 for the gift 1331D. The payment page 1335 of FIG. 16L is illustrated as enabling the gifter to enter payment information. The payment information can include, but is not limited to, a gifter name 1335E, a number 1335F for a credit card, debit card or other transaction payment method associated with the gifter, an expiry date 1335G for the payment method and/or a CVV 1335H for the payment method. The payment page 1335 optionally can ask the gifter to confirm the payment, at 1335I, before submission of the payment information.

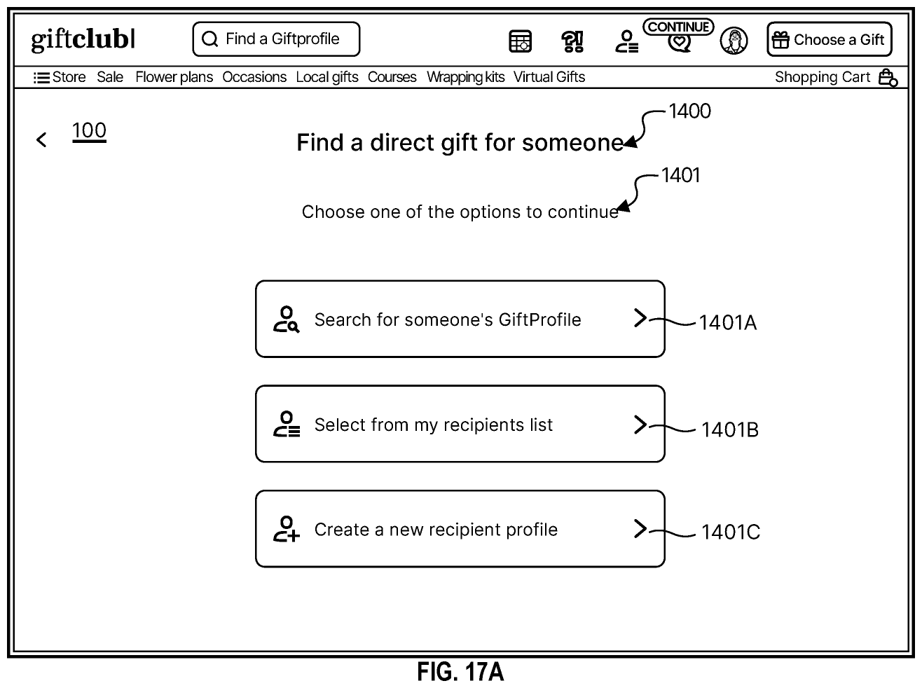

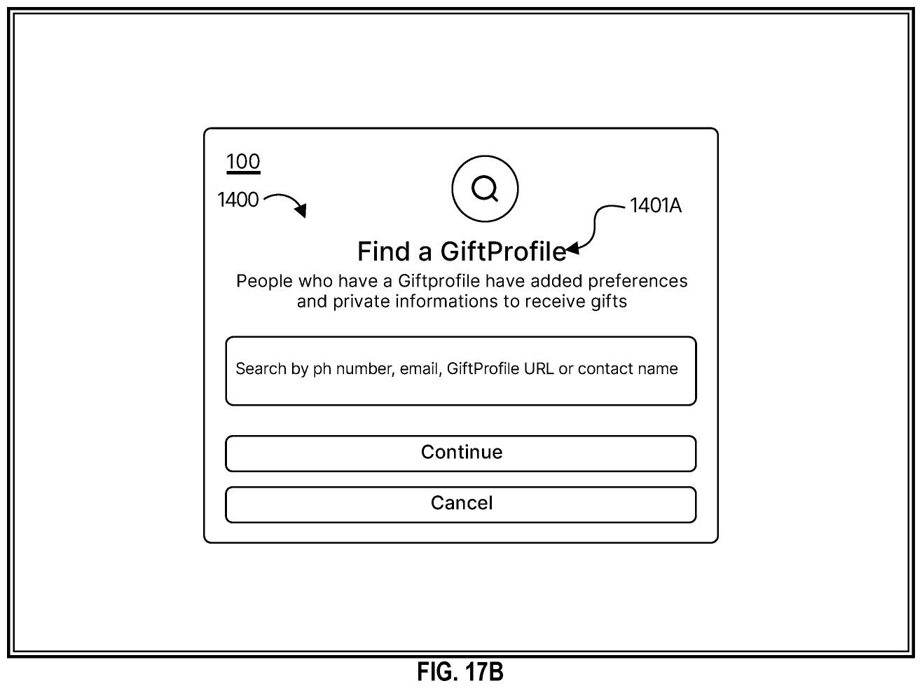

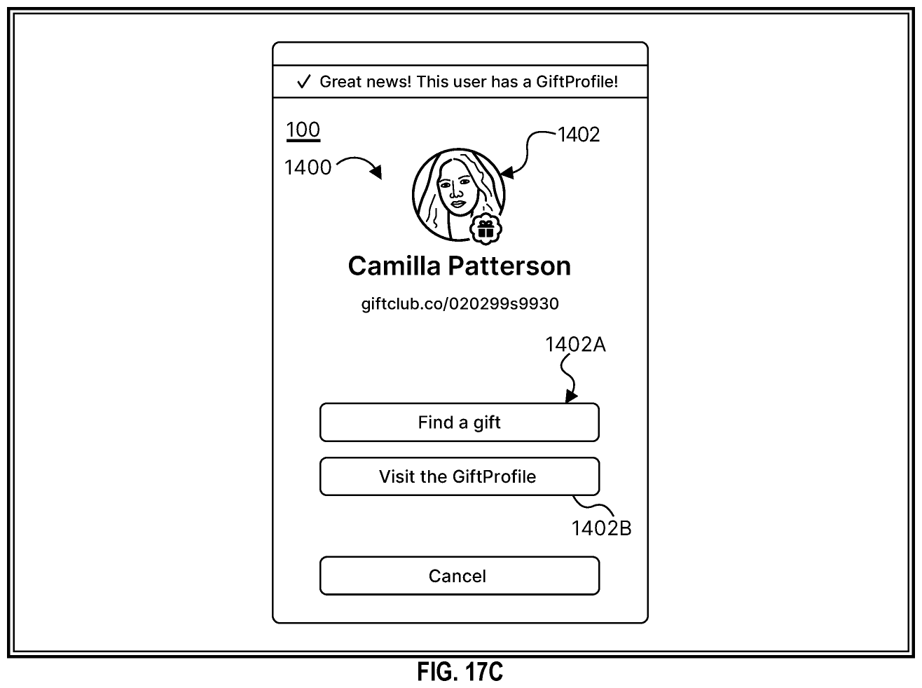

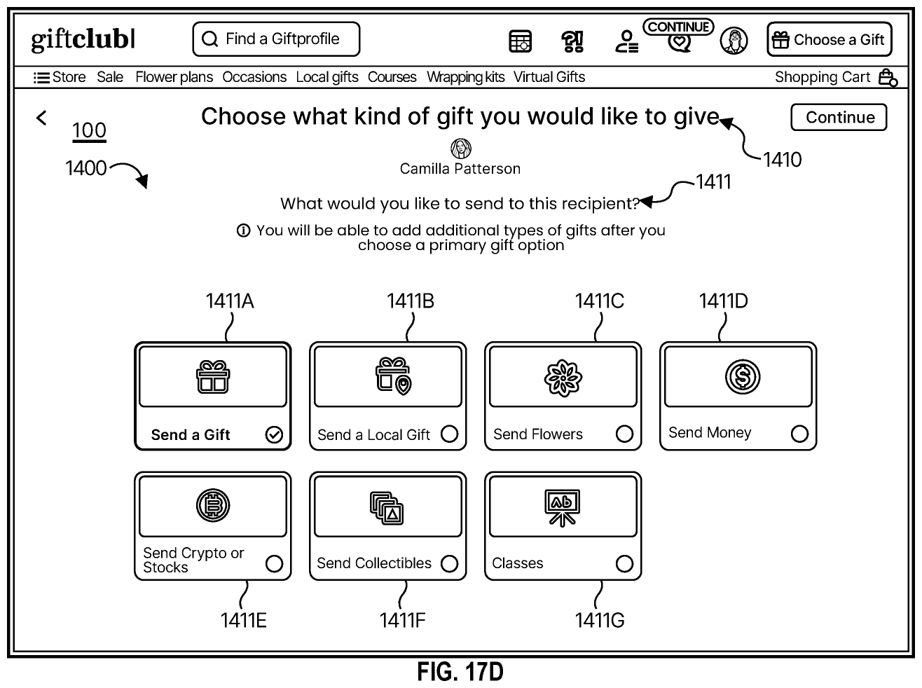

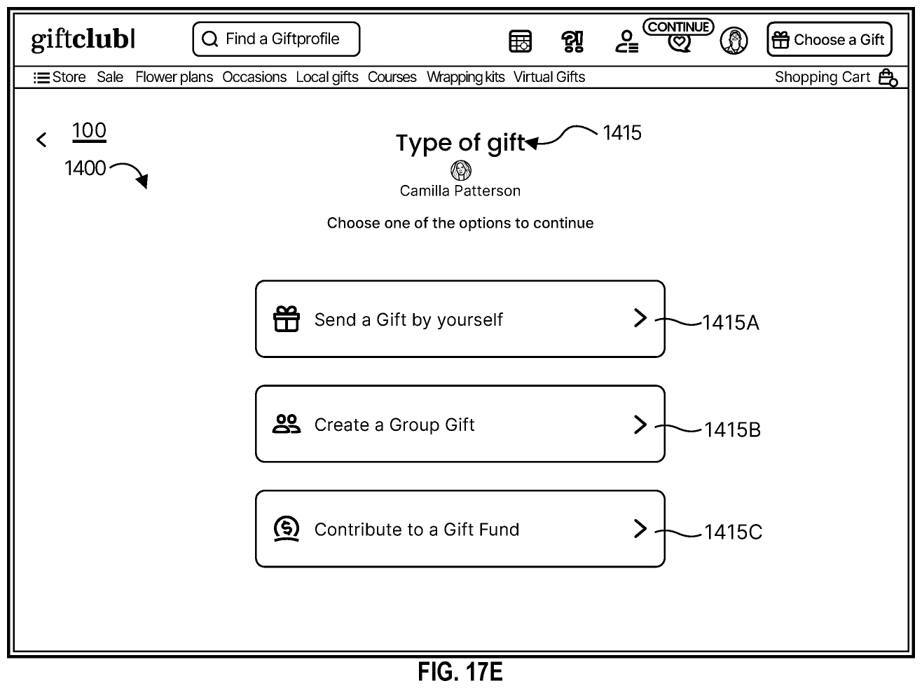

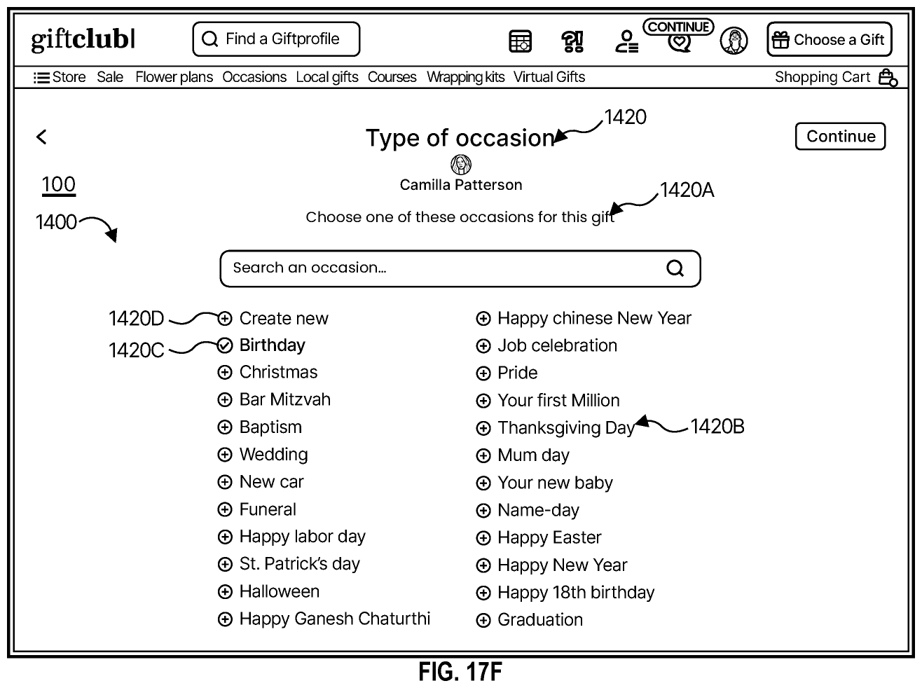

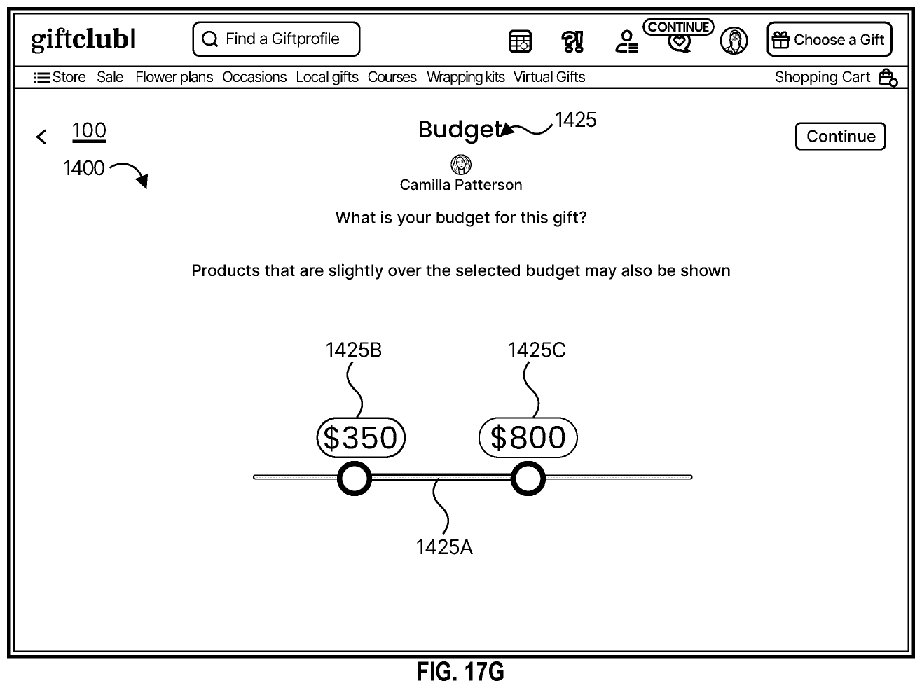

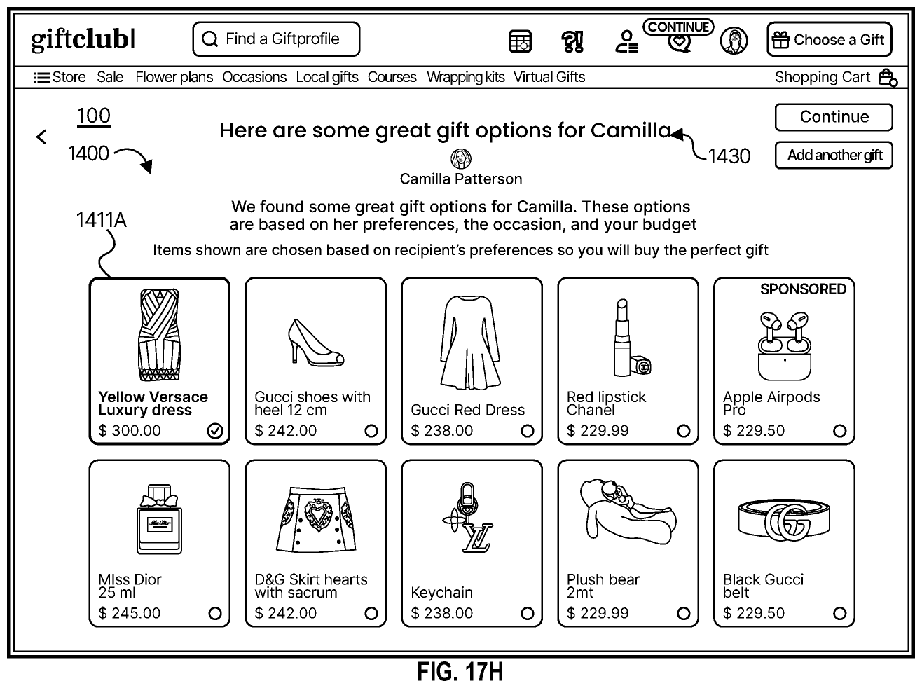

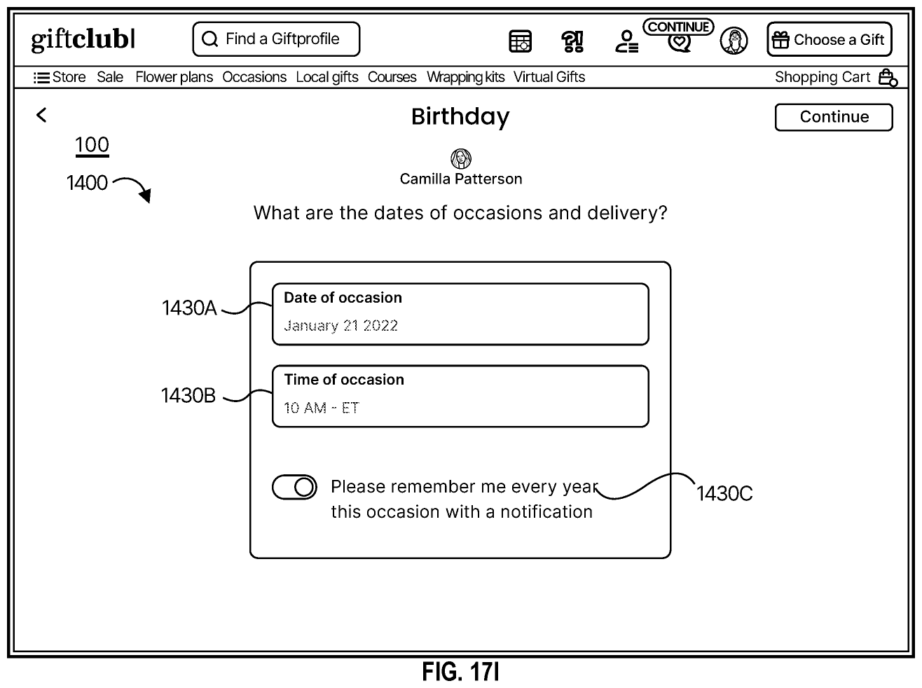

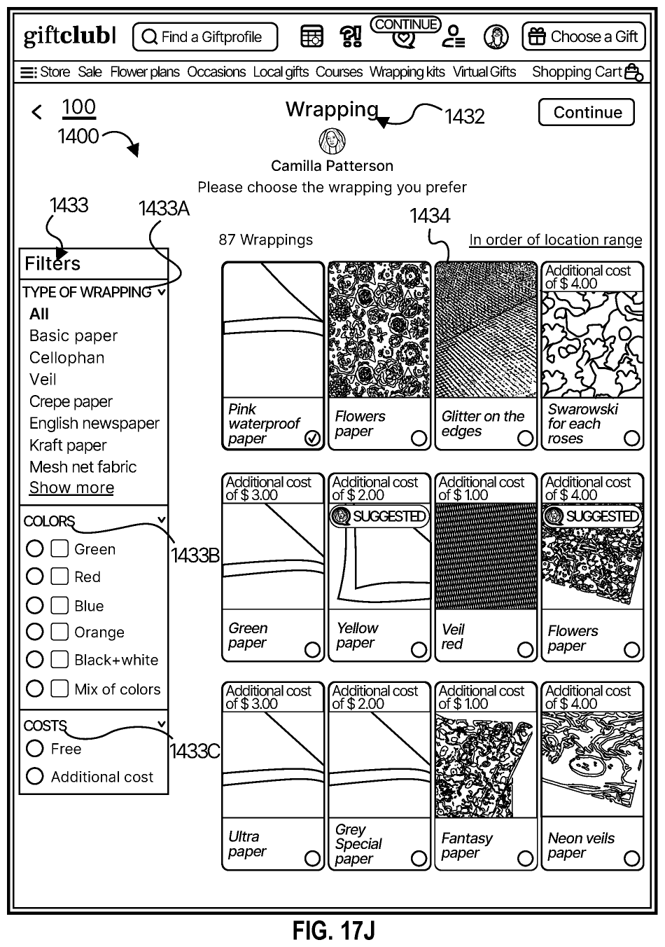

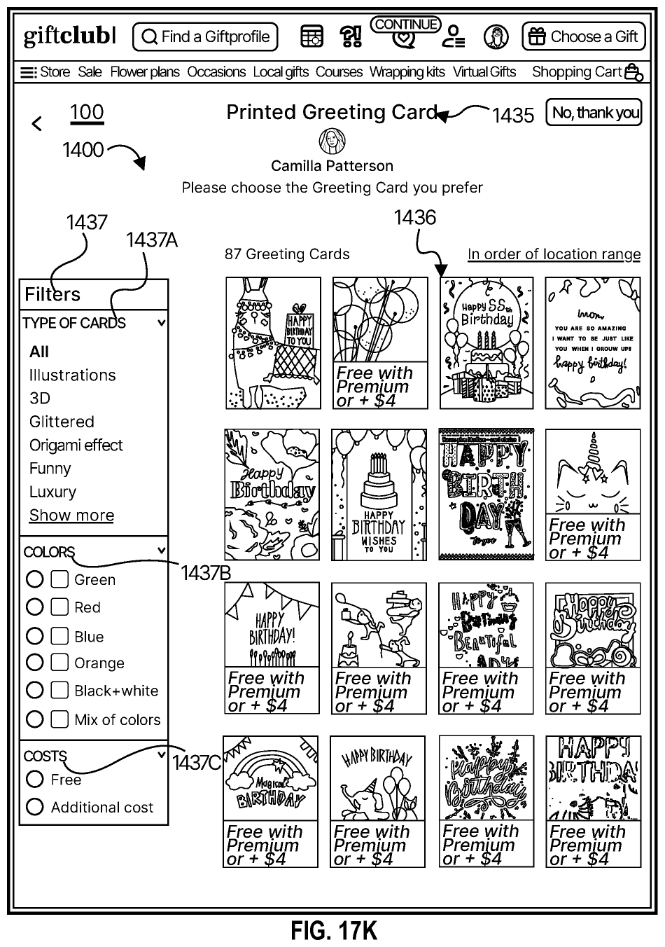

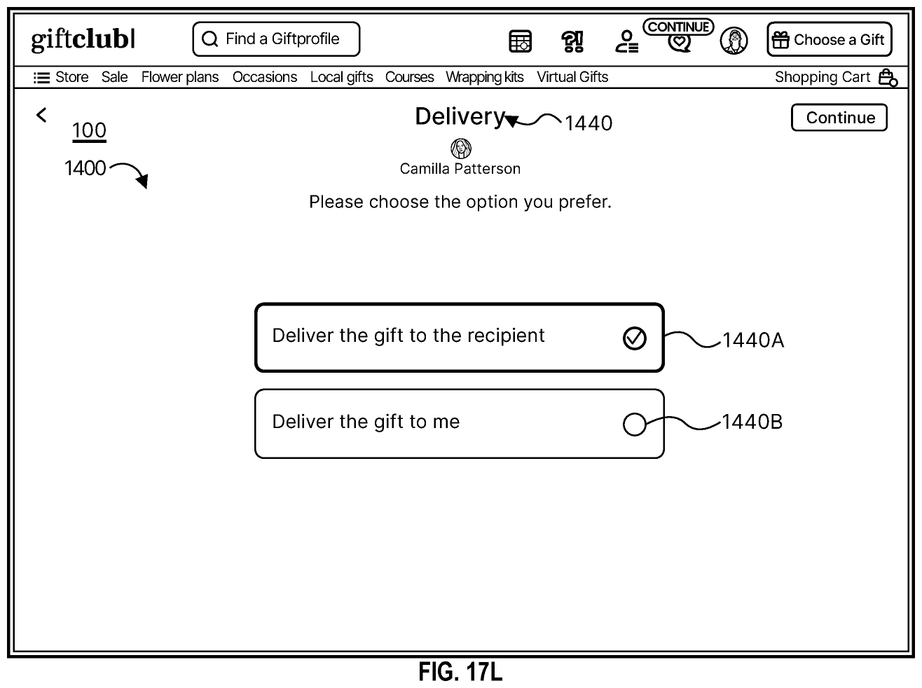

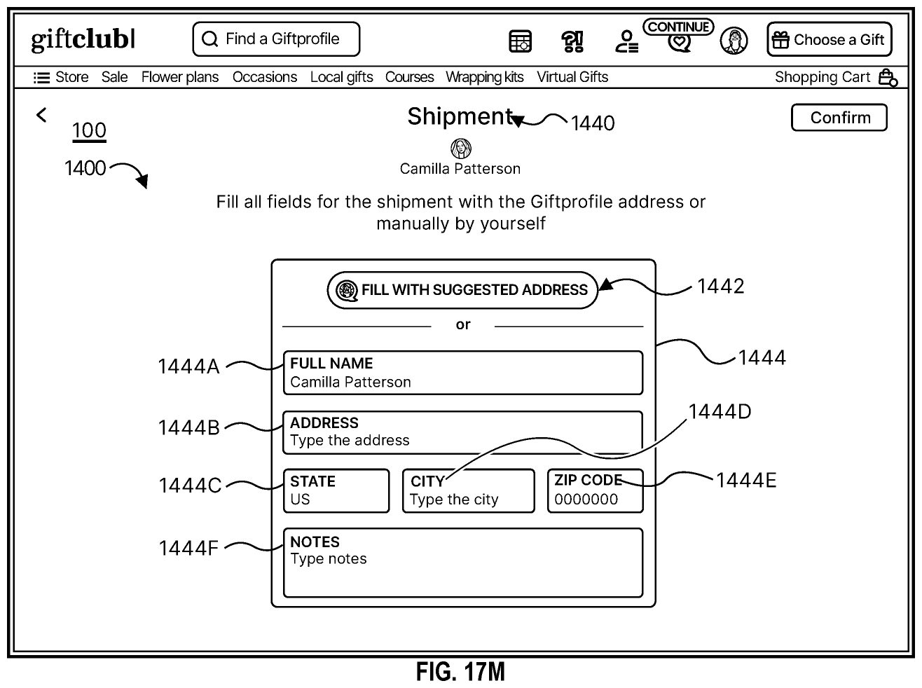

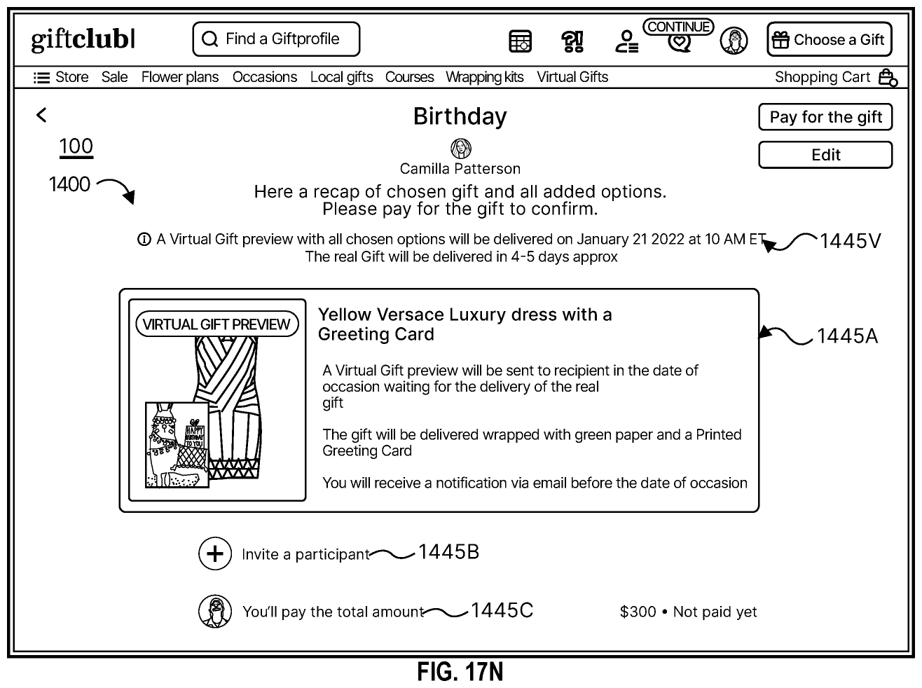

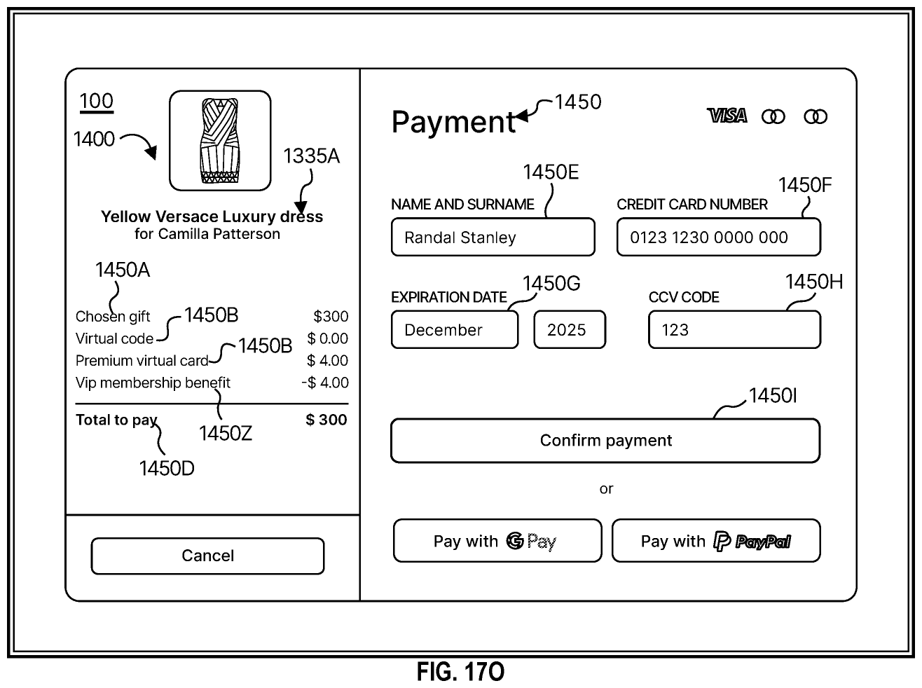

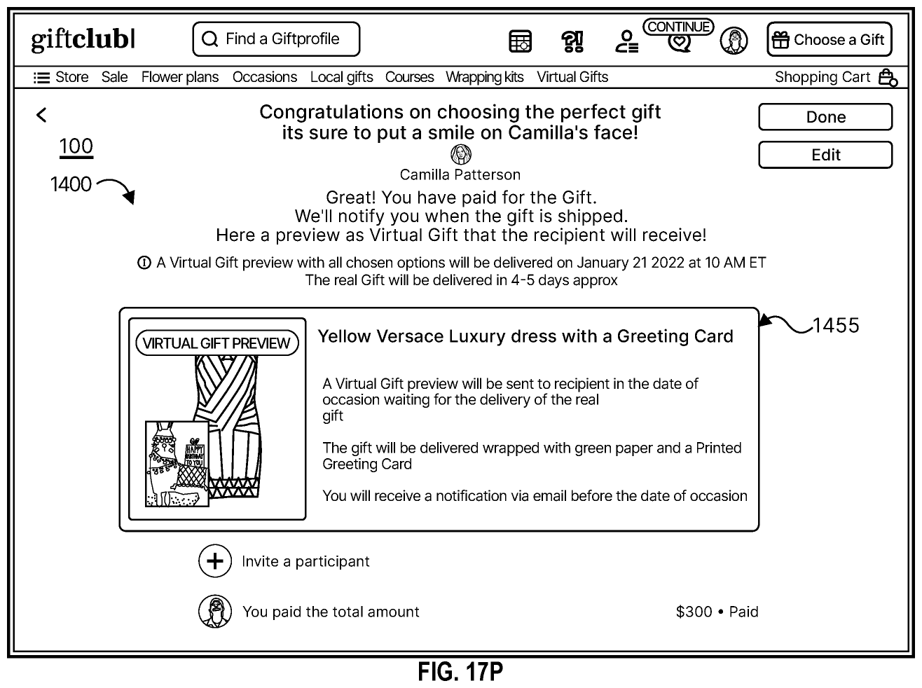

In selected embodiments, the gifting method 100 can include a direct gift page 1400 for providing a direct gift to a selected recipient. An exemplary direct gift page 1400 is shown and described with reference to FIGS. 17A-P. Turning to FIG. 17A, the direct gift page 1400 is shown as presenting one or more direct gift options 1401 for providing a direct gift to the selected recipient. The direct gift options 1401 can include options for selecting the selected recipient and can include searching for a gift profile for the selected recipient, at 1401A, selecting the selected recipient from a recipient list associated with the gifter, at 1401B, and/or creating a new recipient profile for the selected recipient, at 1401C, without limitation.

The gifter, for example, can search for the gift profile of the selected recipient, by entering recipient information, such as a telephone number, an email address, a gift profile URL and/or a recipient name, associated with the chosen recipient as shown in FIG. 17B. The gifting method 100 optionally can maintain the confidentiality of the chosen recipient by limiting the recipient information that is presented to the gifter. Once the gift profile 1042 of the selected recipient has been identified, the direct gift page 1400 of FIG. 17C can enable the gifter to find an appropriate gift for the selected recipient, at 1402A, and/or visit the gift profile 1042 of the selected recipient, at 1402B.

The direct gift page 1400 likewise can enable the gifter to choose what direct gift that the gifter would like to give to the selected recipient, at 1411, as illustrated in FIG. 17D. The gifter, for example, can send a direct gift 1411A, a local gift 1411B, flowers 1411C, money 1411D, cryptocurrency or stocks 1411E, collectables 1411F and/or classes 1411G to the selected recipient. The direct gift page 1400 optionally can enable the gifter to send a charitable donation to a selected charity as a gift to the recipient. The charitable donation optionally can be included as a gift associated with a greeting card, such as a virtual greeting card. The direct gift page 1400, for example, can present a charitable donation link (not shown) for enabling the gifter to make the charitable donation in the name of the recipient and/or to make the charitable donation as a gift in honor of an event, such as a birthday or anniversary, associated with the recipient. Upon activation of the charitable donation link, the direct gift page 1400 can present a list of charities from which to choose and/or a search box for enabling the gifter to choose a charity based on the cause, for example, cancer or Alzheimer's disease. The donation details can include a name and/or logo of the chosen charity and/or the donation amount. If associated with a greeting card, the donation details can be presented inside of the greeting card, can be presented via a sticker within the greeting card and/or can appear inside a wrapped virtual package.

In selected embodiments, the gifter can give the flowers 1411C to the selected recipient via the flower plan page 900 of the gifting method 100 as shown described herein with reference to FIGS. 9A-R. Additionally and/or alternatively, the direct gift page 1400 can enable the gifter to select a gifting option 1415 as illustrated in FIG. 17E. Exemplary gifting options 1415 can include, but are not limited to, enabling the gifter to send the direct gift 1411A to the selected recipient alone, at 1415A, enabling the gifter to send the direct gift 1411A to the selected recipient as a part of a group gift, at 1415B, and/or the enabling the gifter to contribute to a gift fund for buying the direct gift 1411A for the selected recipient, at 1415C.

Turning to FIG. 17F, the direct gift page 1400 can enable the gifter to identify an occasion type 1420 for the direct gift 1411A. The gifter, for example, can search for an appropriate occasion type 1420, at 1420A, from among a plurality of preselected occasion types. Additionally and/or alternatively, the gifter can select the occasion type 1420 from an occasion type list 1420B and/or to create a direct gift 1411A type 1420D for the direct gift 1411A. The gifter thereby can select an appropriate occasion type 1420C for the direct gift 1411A. Budgetary information 1425 optionally can be established for the direct gift 1411A as shown in FIG. 17G. The budgetary information 1425, for example, can include a fixed amount of money and/or, as shown in FIG. 17G, can include a budget range 1425A with a low budget range amount 1425B and a high budget range amount 1425C.

The direct gift 1411A can be selected in the manner set forth in more detail herein, such as based upon the occasion type 1420, the budgetary information 1425 and/or preferences of the gifter and/or recipient as set forth in the respective profiles as illustrated in FIG. 17H. The direct gift page 1400 of FIG. 17I can enable the gifter to set an occasion date 1430A and/or occasion time 1430B for the direct gift 1411A. The gifter likewise can elect to receive annual or otherwise periodic reminders about the direct gift 1411A, at 1430C, and/or schedule the same direct gift 1411A for periodic delivery.

As shown in FIG. 17J, the direct gift page 1400 can include a gift wrapping page 1432 for presenting one or more gift wrapping options 1434 to the gifter. An additional cost may be associated with one or more of the gift wrapping options and the additional cost optionally can vary depending upon the type of direct gift 1411A selected by the gifter. At least one suggested gift wrapping option 1434 may be suggested based upon the preferences of the gifter and/or the preferences of the selected recipient. To facilitate selection of an appropriate gift wrapping option 1434, the gift wrapping page 1432 can present one or more filters 1433 for narrowing the presented gift wrapping options 1434. The filters 1433 can include, but are not limited to, a type of gift wrapping 1433A, a color of the gift wrapping 1433B and/or a cost for the gift wrapping 1433C.

The direct gift page 1400 can include a greeting card page 1435 for presenting one or more greeting card options 1436 to the gifter as illustrated in FIG. 17K. An additional cost may be associated with one or more of the greeting card options and the additional cost optionally can vary depending upon the type of direct gift 1411A selected by the gifter. At least one suggested greeting card option 1436 may be suggested based upon the preferences of the gifter and/or the preferences of the selected recipient. To facilitate selection of an appropriate greeting card option 1436, the greeting card page 1435 can present one or more filters 1437 for narrowing the presented greeting card options 1436. The filters 1437 can include a type of greeting card 1437A, a color of the greeting card 1437B and/or a cost for the greeting card 1437C, without limitation.

As illustrated in FIG. 17L, the direct gift page 1400 can enable the gifter to provide delivery instruction, at 1440, for the direct gift 1411A. Delivery instruction, for example, can include instruction to deliver the direct gift 1411A directly to the chosen recipient, at 1440A, and/or to deliver the direct gift 1411A to the gifter, at 1440B. Additionally and/or alternatively, the direct gift page 1400 can enable the gifter to provide shipment instruction, at 1440, for the direct gift 1411A. As shown in FIG. 17L, for example, the gifter can enter recipient information 1442. The recipient information 1442 can include, but is not limited to, a recipient name 1444A, a recipient street address 1444B, a recipient state 1444C, a recipient city 1444D and/or a recipient ZIP code 1444E. The gifter optionally can enter one or more notes 1444F for the direct gift 1411A via the direct gift page 1400. The gifting method 100 optionally can suggest a shipping address for the direct gift 1411A, while preferably maintaining the confidentiality of the chosen recipient by limiting the recipient information that is presented to the gifter.

Turning to FIG. 17N, the direct gift page 1400 can provide a recap information, at 1445A, for the direct gift 1411A. The direct gift page 1400 optionally can invite another recipient, at 1445B, to participate in the direct gift 1411A and/or remind the gifter, at 1445C, of any amount due but not yet paid. Additionally and/or alternatively, the direct gift page 1400 can provide a virtual gift preview of the direct gift 1411A for viewing, at 1334V, via a virtual gifts and cards link 1640 (shown in FIG. 19A) of the gifter profile page 1600 (shown in FIG. 19A) and/or a recipient profile page of the selected recipient.

A payment page 1450 of the direct gift page 1400 is shown in FIG. 17O. The payment page 1450 can confirm the direct gift 1411A selected by the gifter, any associated gift costs 1450A, any additional gift wrapping, greeting card or other costs 1450B, and/or any membership or other discounts 1450Z. A total price 1450D can be shown on the payment page 1450 for the direct gift 1411A. The payment page 1450 of FIG. 17L is illustrated as enabling the gifter to enter payment information. The payment information can include, but is not limited to, a gifter name 1450E, a number 1450F for a credit card, debit card or other transaction payment method associated with the gifter, an expiry date 1450G for the payment method and/or a CVV 1450H for the payment method. The payment page 1450 optionally can ask the gifter to confirm the payment, at 14501, before submission of the payment information. As illustrated in FIG. 17P, the direct gift page 1400 can provide payment confirmation and scheduling information, at 1455, for the direct gift 1411A.

The gifting method 100 can include an optional local gift page 1500 for providing a local gift to a selected recipient. A local gift can be a gift provided by a vendor who is located in a vendor geographic region that is the same as (or adjacent to) a recipient geographic region of the recipient. The vendor, for example, can be located in the same ZIP code as the recipient and/or within a predetermined distance (such as a predetermined number of miles) from a delivery address associated with the recipient. In selected embodiments, the local gift page 1500 can include one or more comment features with the direct gift page 1400 shown in FIGS. 17A-P. An exemplary local gift page 1500 is shown and described with reference to FIGS. 18A-K. Turning to FIG. 18A, the local gift page 1500 can enable the gifter to choose what local gift that the gifter would like to give to the selected recipient, at 1511, as illustrated in FIG. 18A.

In selected embodiments, the gifter can give the flowers 1511C to the selected recipient via the flower plan page 900 of the gifting method 100 as shown described herein with reference to FIGS. 9A-R. Additionally and/or alternatively, the local gift page 1500 can enable the gifter to select a gifting option 1515 as illustrated in FIG. 18B. Exemplary gifting options 1515 can include, but are not limited to, enabling the gifter to send the local gift 1511A to the selected recipient alone, at 1515A, enabling the gifter to send the local gift 1511A to the selected recipient as a part of a group gift, at 1515B, and/or the enabling the gifter to contribute to a gift fund for buying the local gift 1511A for the selected recipient.

Turning to FIG. 18C, the local gift page 1500 can enable the gifter to identify an occasion type 1520 for the local gift 1511A. The gifter, for example, can search for an appropriate occasion type 1520, at 1520A, from among a plurality of preselected occasion types. Additionally and/or alternatively, the gifter can select the occasion type 1520 from an occasion type list 1520B and/or to create a local gift 1511A type 1520D for the local gift 1511A. The gifter thereby can select an appropriate occasion type 1520C for the local gift 1511A. Budgetary information 1525 optionally can be established for the local gift 1511A as shown in FIG. 18D. The budgetary information 1525, for example, can include a fixed amount of money and/or, as shown in FIG. 18D, can include a budget range 1525A with a low budget range amount 1525B and a high budget range amount 1525C.

The local gift page 1500 can enable the gifter to provide recipient location instruction, at 1527, identifying a gift vendor in a local geographic region of the selected recipient. As shown in FIG. 18E, for example, the gifter can enter recipient information 1529. The recipient information 972 can include, but is not limited to, a recipient street address 1529B, a recipient state 1529C, a recipient city 1529D and/or a recipient ZIP code 1529E. The gifting method 100, at 1528, optionally can suggest a local geographic region of the selected recipient, while preferably maintaining the confidentiality of the selected recipient by limiting the recipient information that is presented to the gifter.

The local gift 1511A can be selected in the manner set forth in more detail herein, such as based upon the occasion type 1520, the budgetary information 1525, recipient location and/or preferences of the gifter and/or recipient as set forth in the respective profiles as illustrated in FIG. 18F. The local gift page 1500 of FIG. 18G can enable the gifter to set an occasion date 1530A and/or occasion time 1530B for the local gift 1511A. The gifter likewise can elect to receive annual or otherwise periodic reminders about the local gift 1511A, at 1530C, and/or schedule the same local gift 1511A for periodic delivery.

The local gift page 1500 can include a gift wrapping page for presenting one or more gift wrapping options to the gifter in the manner discussed in more detail above with reference to FIG. 17J and/or a greeting card page for presenting one or more greeting card options to the gifter in the manner discussed in more detail above with reference to FIG. 17K. Additionally and/or alternatively, the local gift page 1500 can include a virtual greeting card page 1535 for presenting one or more virtual greeting card options 1536 to the gifter as illustrated in FIG. 18H. An additional cost may be associated with one or more of the virtual greeting card options and the additional cost optionally can vary depending upon the type of local gift 1511A selected by the gifter. At least one suggested virtual greeting card option 1536 may be suggested based upon the preferences of the gifter and/or the preferences of the selected recipient. To facilitate selection of an appropriate virtual greeting card option 1536, the virtual greeting card page 1535 can present one or more filters 1537 for narrowing the presented virtual greeting card options 1536. The filters 1537 can include a type of virtual greeting card 1537A, a color of the virtual greeting card 1537B and/or a cost for the virtual greeting card 1537C, without limitation.

Turning to FIG. 18I, the local gift page 1500 can provide a recap information, at 1545A, for the local gift 1511A. The local gift page 1500 optionally can invite another recipient, at 1545B, to participate in the local gift 1511A and/or remind the gifter, at 1545C, of any amount due but not yet paid. Additionally and/or alternatively, the local gift page 1500 can provide a virtual gift preview of the local gift 1511A for viewing, at 1545V, via a virtual gifts and cards link 1640 (shown in FIG. 19A) of the gifter profile page 1600 (shown in FIG. 19A) and/or a recipient profile page of the selected recipient. A payment page 1550 of the local gift page 1500 is shown in FIG. 18J. The payment page 1550 can confirm the local gift 1511A selected by the gifter, any associated gift costs 1550A, any additional gift wrapping, greeting card or other costs 1550B, and/or any membership or other discounts 1550Z. A total price 1550D can be shown on the payment page 1550 for the local gift 1511A.

The payment page 1550 of FIG. 18J is illustrated as enabling the gifter to enter payment information. The payment information can include, but is not limited to, a gifter name 1550E, a number 1550F for a credit card, debit card or other transaction payment method associated with the gifter, an expiry date 1550G for the payment method and/or a CVV 1550H for the payment method. The payment page 1550 optionally can ask the gifter to confirm the payment, at 1550I, before submission of the payment information. As illustrated in FIG. 18K, the local gift page 1500 can provide payment confirmation and scheduling information, at 1555, for the local gift 1511A.

If the gifter selects a gift that will not be available for shipment to the recipient before the date of the event or other occasion, the gifting method 100 can generate a virtual gift for dispatch to the recipient. The virtual gift can comprise a preview of the actual selected gift. Stated somewhat differently, the virtual gift can be dispatched to the recipient if an availability date of the actual selected gift is not before or does not otherwise match the date of the occasion. The virtual gift, for example, can be sent to the recipient if the actual selected gift is not expected to arrive in time for the occasion.

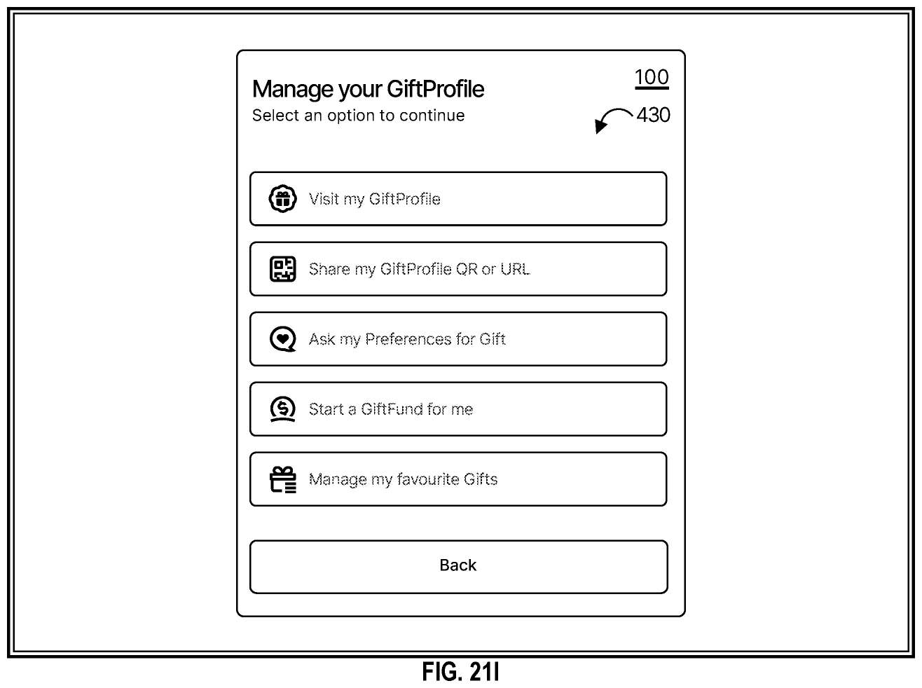

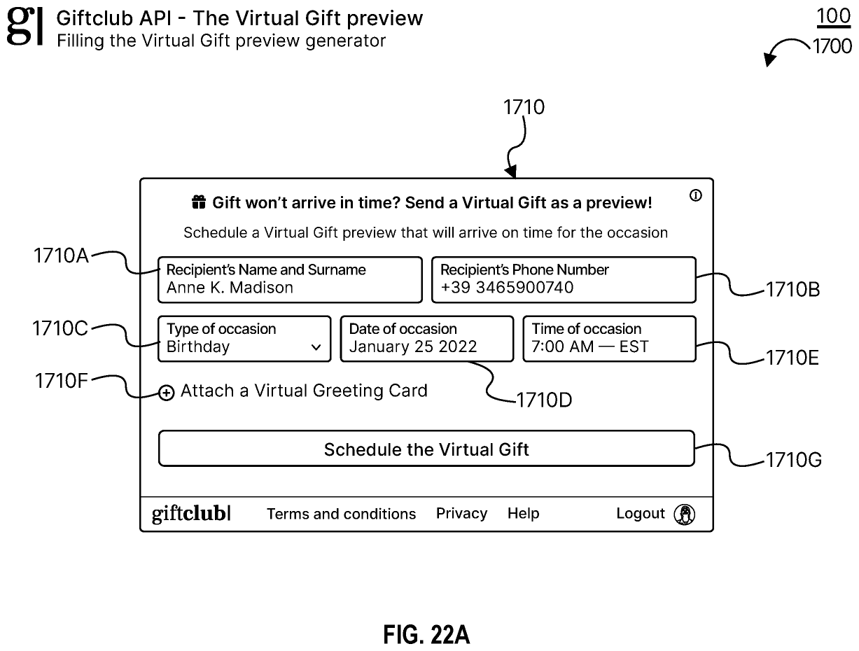

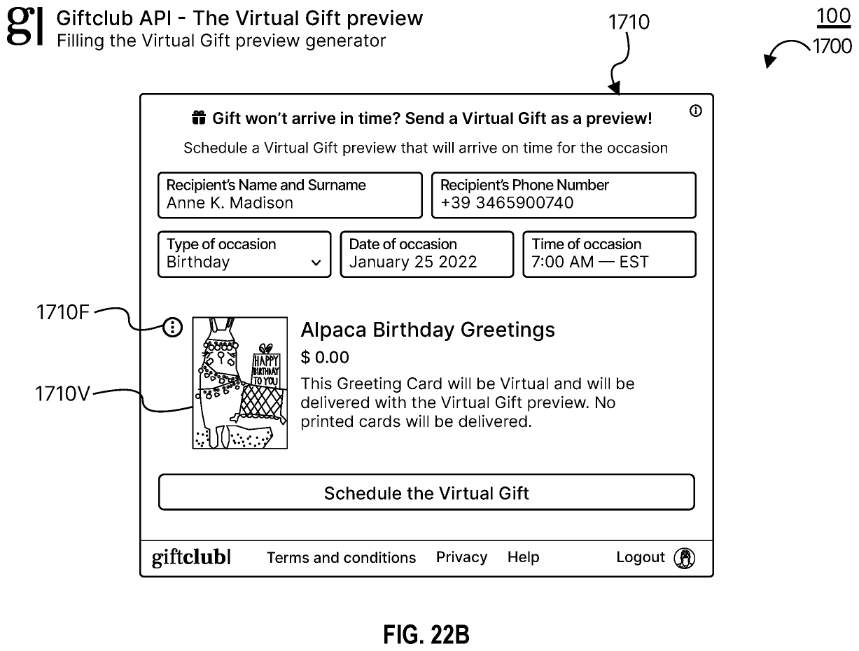

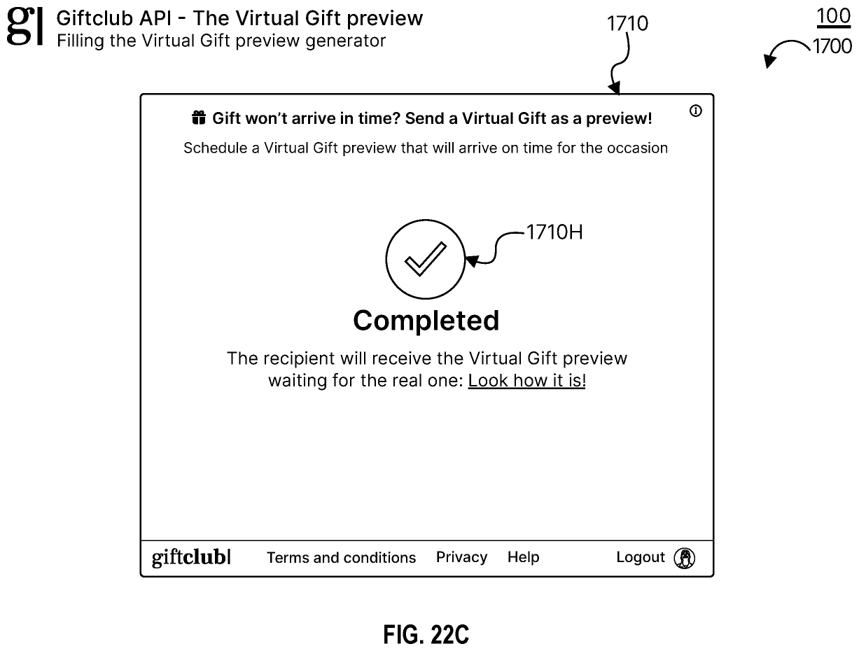

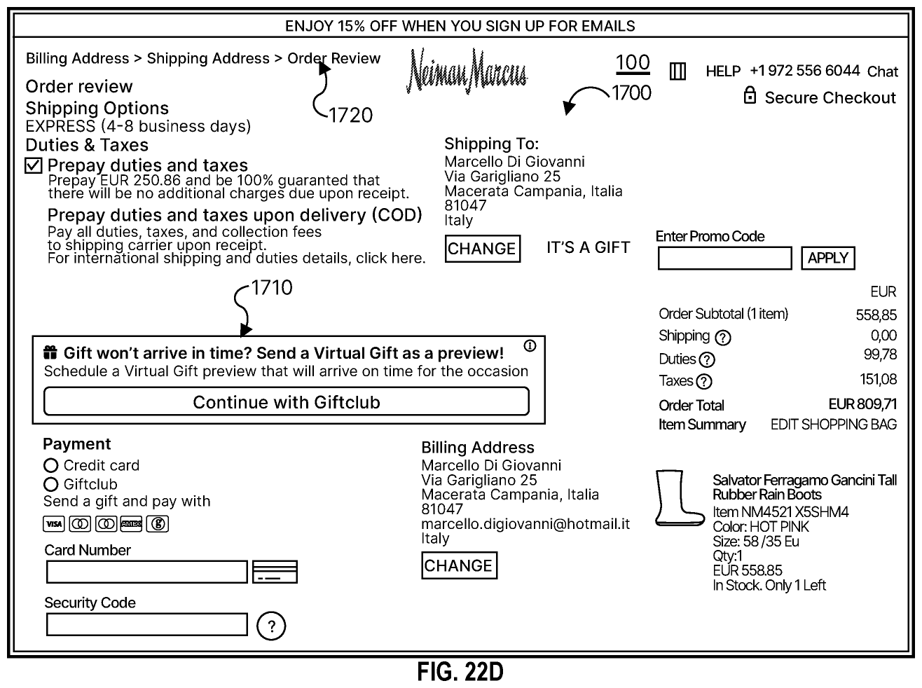

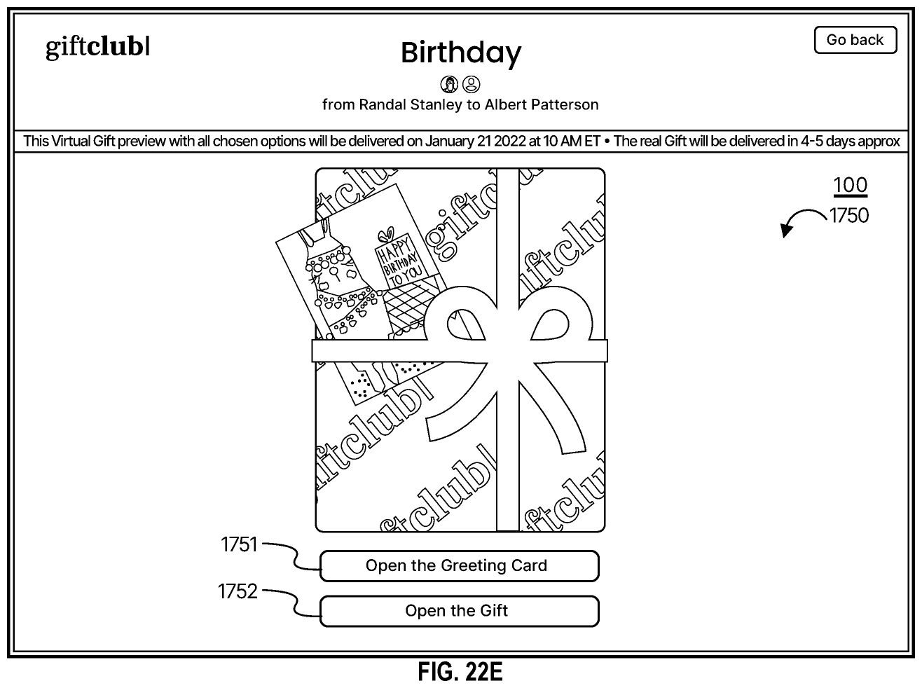

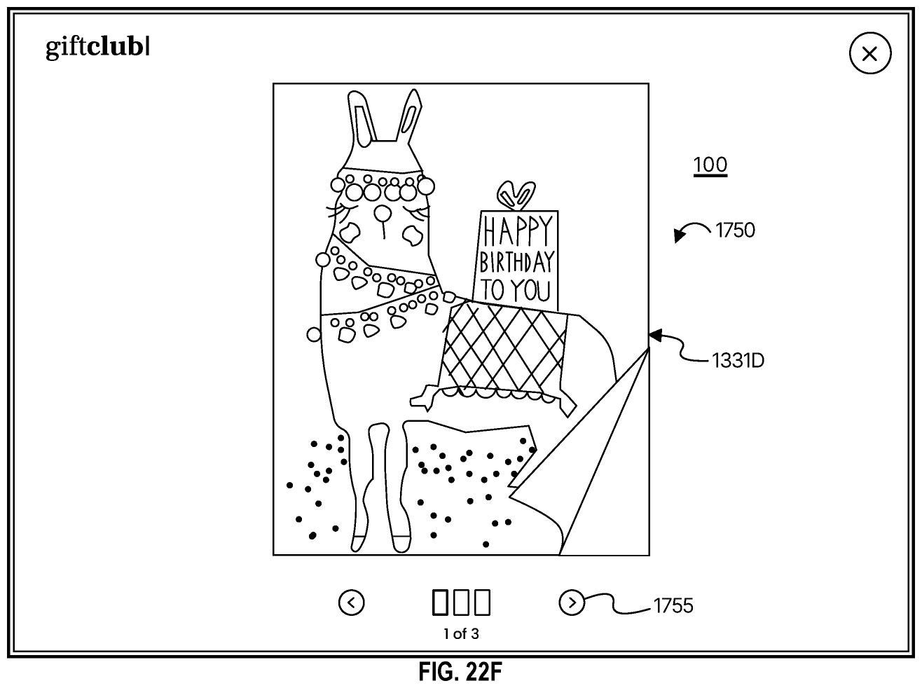

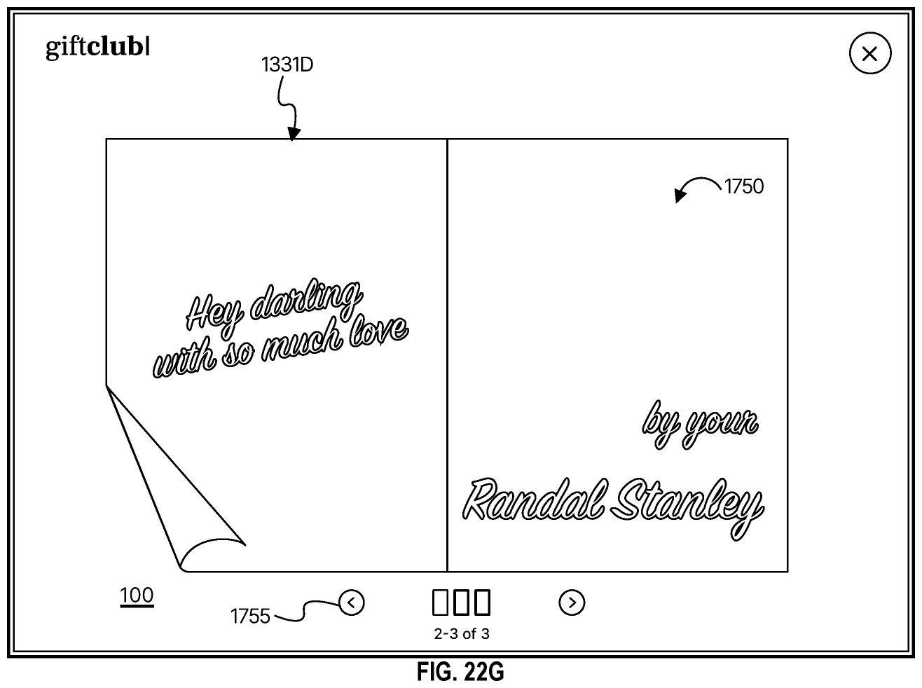

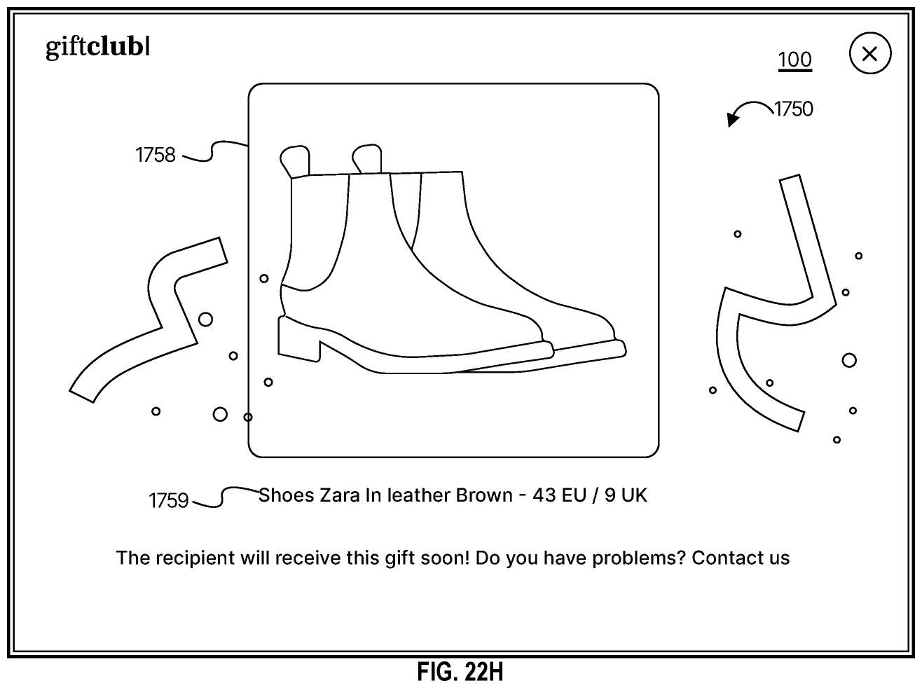

Turning to FIG. 22A, the gifting method 100 can include a virtual gift page 1700 with a virtual gift link 1710 for generating the virtual gift. The virtual gift page 1700 can be accessed by activating the virtual gift link 815 (shown in FIG. 8). Via the virtual gift page 1700, the gifter can send the virtual gift virtual gift message 1750 (shown in FIGS. 22E-H) to the recipient who can access a virtual greeting card and/or open the virtual gift. The virtual greeting card can be provided in the manner set forth in more detail above with reference to the virtual greeting card 1331B shown and described herein with reference to FIGS. 15A-K.

The virtual gift page 1700 can enable the gifter to generate the virtual gift message 1750, for instance, if the actual selected gift will not arrive in time for the occasion. As shown in FIGS. 22A-B, the gifter can generate the generate the virtual gift message 1750 by entering a recipient name 1710A of the recipient, a recipient telephone number 1710B of the recipient, an occasion type 1710C of the occasion, an occasion date 1710D of the occasion and/or an occasion time 1710E of the occasion, without limitation. The virtual gift page 1700 optionally can include provision, at 1710F, for attaching a virtual greeting card 1331B (shown in FIGS. 15A-K). In selected embodiments, a preview 1710V of the virtual greeting card 1331B can be included on the virtual gift page 1700.

Once satisfied, the gifter can send the virtual gift message 1750 to the recipient via activation of a virtual gift scheduling link 1710G. The gifting method 100 thereby can present a virtual message confirmation 1710H to the gifter as shown in FIG. 22C. Additionally and/or alternatively, the gifting method 100 can present a virtual message receipt 1720 as illustrated in FIG. 22D. The virtual message receipt 1720 can include the virtual gift link 1710 and other details about the gift order details, such as a shipping information, cost information, billing information and other details about the actual selected gift.

FIGS. 22E-H show an exemplary virtual gift message 1750 as received by the recipient. Turning to FIG. 22E, the virtual gift message 1750 can identify the message as comprising a virtual gift and include selected textual and graphics indicia. The virtual gift message optionally can enable the recipient to access the virtual greeting card 1331B (shown in FIGS. 22F and 22G), at 1751, and/or to access the virtual gift 1758 (shown in FIG. H), at 1752. As shown in FIGS. 22F and 22G, the virtual greeting card 1331B can include greeting card navigation indicia 1755. Additionally and/or alternatively, the virtual gift 1758 can include an image of the actual selected gift and/or a textual description 1759 of the actual selected gift as illustrated in FIG. 22H.

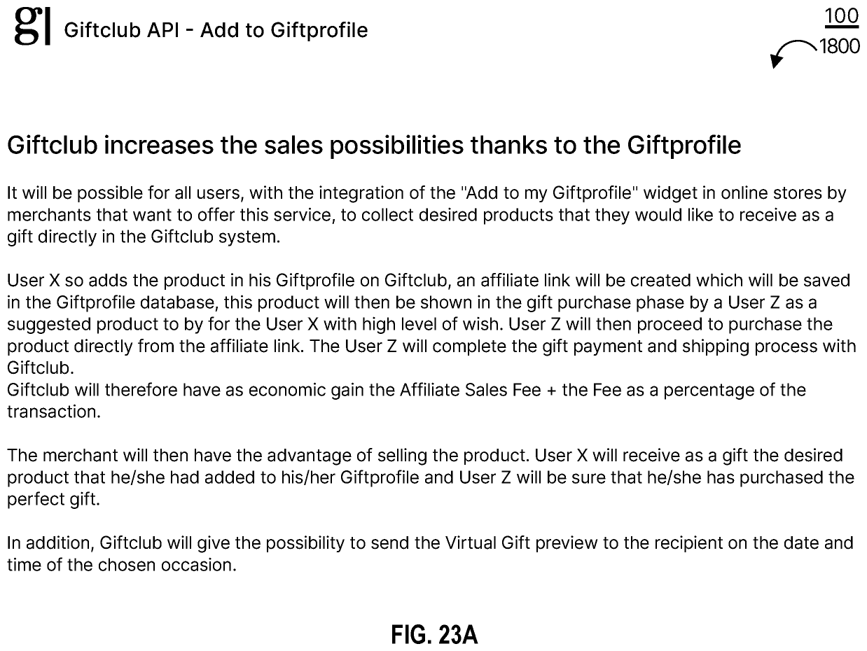

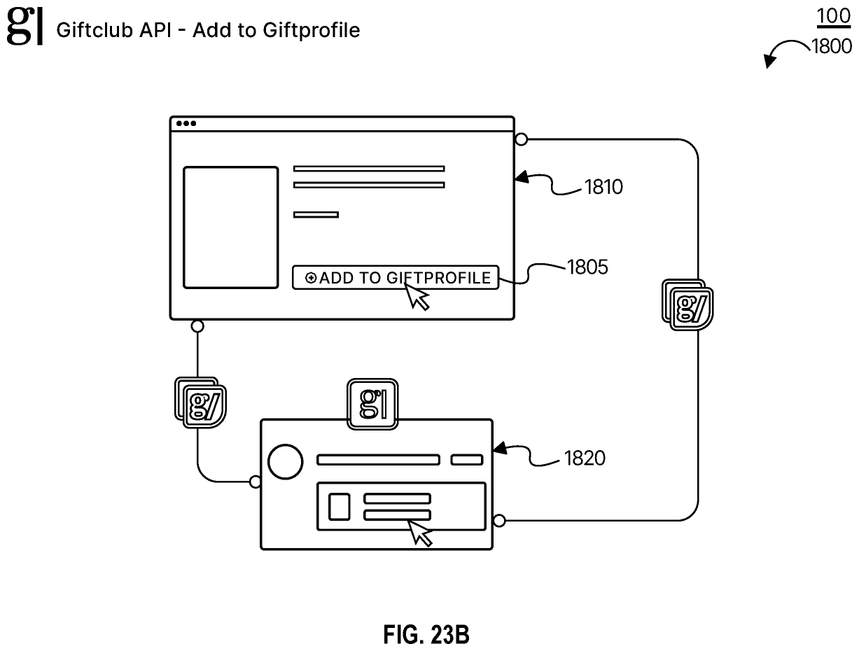

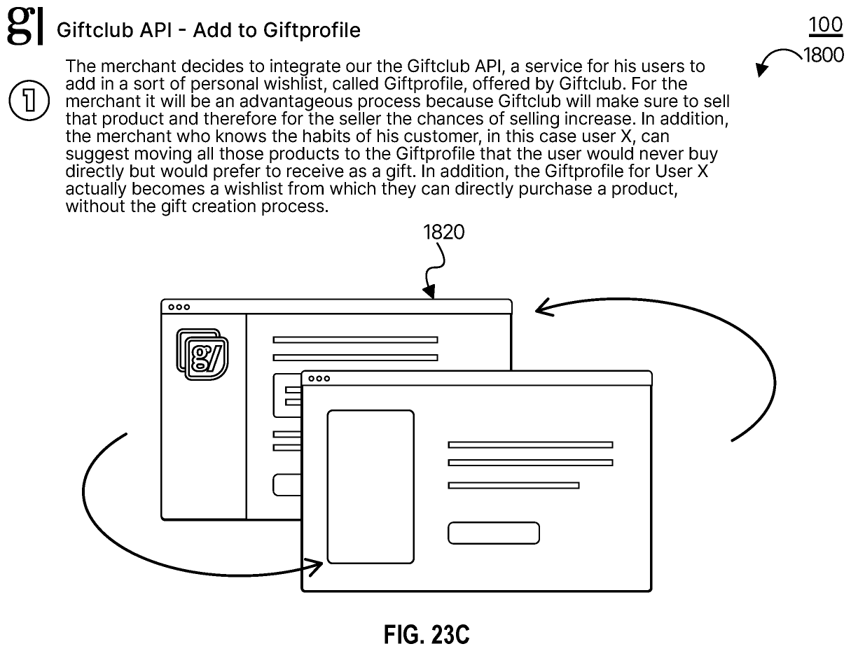

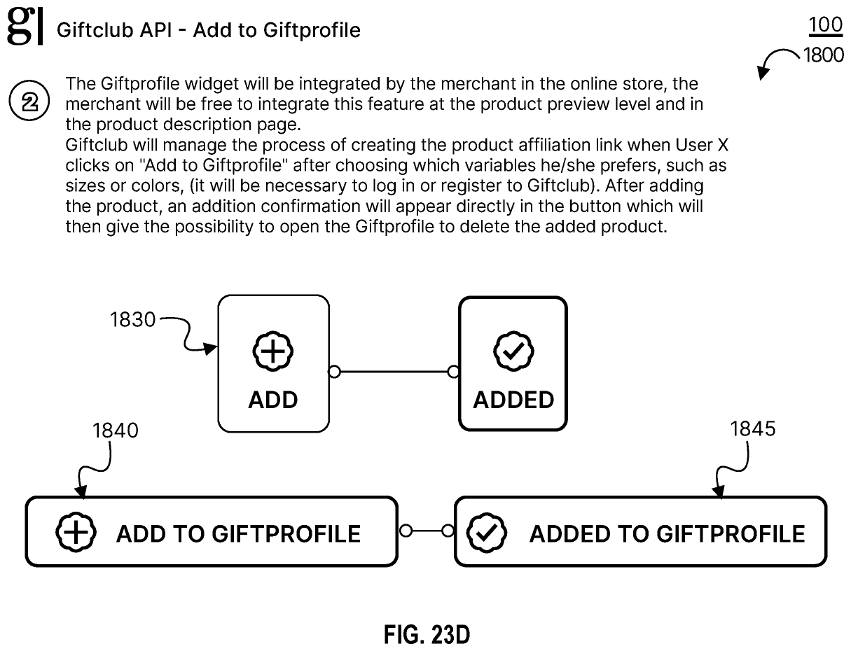

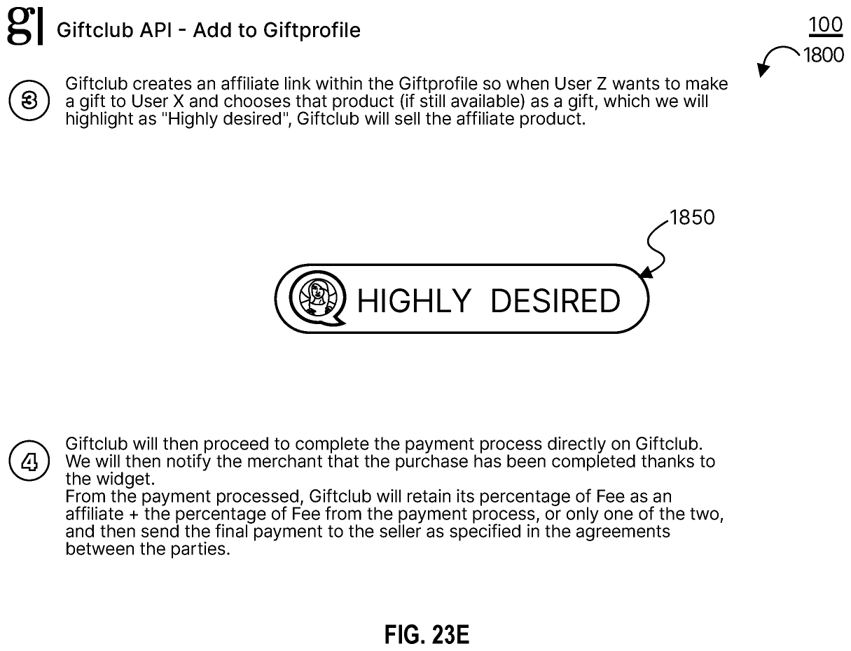

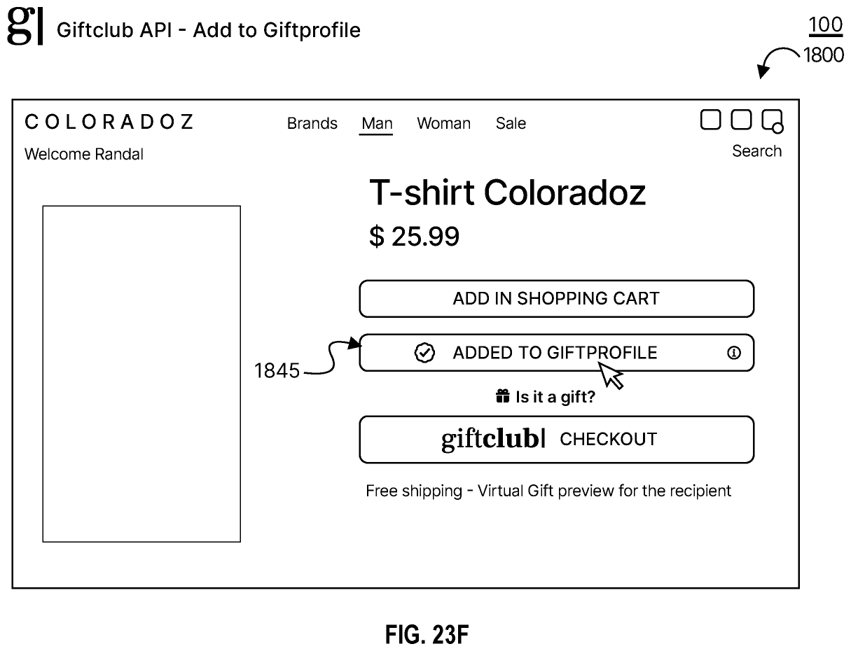

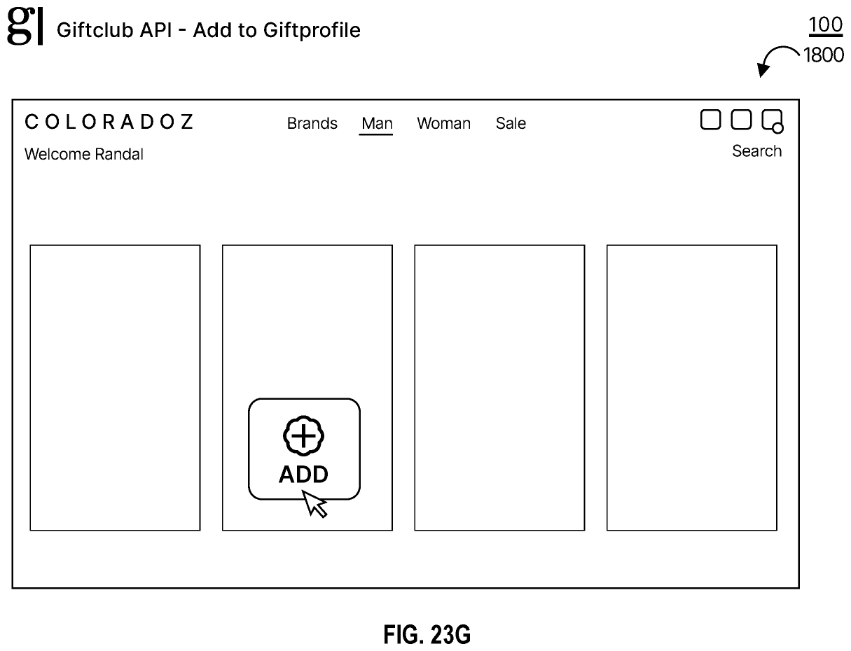

In selected embodiments of the gifting method 100, one or more merchants or other vendors (not shown) can enable the gifter to include one or more products and/or services available from the vendors into the gifter profile of the gifting method 100 as shown in FIGS. 23A-G. Information about the vendor products and/or vendor services can be available, for example, from a vendor website associated with the vendor and preferably being separate from a website associated with the gifting method 100. The gifting method 100 thereby can access the information about the vendor products and/or vendor services and incorporate the information about the vendor products and/or vendor services into the gifter profile. For example, an application programming interface (or API) 1820 (shown in FIG. 23C) available from the gifting method 100 can be installed at the vendor website to facilitate the information transfer. The gifting method 100 thereby can enable the vendor products and/or vendor services to be selected by the gifter in the same manner as any other gift available from the gifting method 100, including as the gift 1331D (shown in FIG. 16K), the direct gift 1411A (shown in FIG. 17N) and/or the local gift 1511A (shown in FIG. 18I), without limitation.

Turning to FIGS. 23A-G, enabling the gifter to include one or more products and/or services available from the vendors into the gifter profile advantageously can help increases the sales possibilities for the vendor. The gifting method 100 can integrate an “Add to my Giftprofile” widget 1805 into an online store 1810 of a selected vendor as illustrated in FIG. 23B. The “Add to my Giftprofile” widget 1805 can enable the gifter and other users to collect one or more desired products and/or services that the users would like to receive as a gift directly in the gifting method 100. A first user, for example, can add a desired product to the user profile associated with the first user. Once the desired product is added to the user profile, an affiliate link (not shown) can be created which will be saved in a database 1820 of the gifting method 100. The desired product can be presented to other users as a suggested gift for the first user, preferably with high level of wish.

A second user then can proceed to purchase the desired product directly via the affiliate link. In selected embodiments, the second user can complete the gift payment and shipping process via the gifting method 100. The vendor can experience an advantage of selling the desired product, the first user will receive as a gift the desired product that he had added to his user profile, and the second user will be sure that he has purchased the perfect gift for the first user. Additionally and/or alternatively, the gifting method 100 can present an option to the second user to send a Virtual Gift preview to the first user on the date and time of the chosen occasion in the manner discussed in more detail herein.

As shown in FIG. 23C, the vendor can decide whether to integrate the application programming interface 1820 available from the gifting method 100 into the online store 1810 (shown in FIG. 23B) of the vendor. The application programming interface 1820 can provide a service for one or more customers of the vendor to add in a sort of personal wish list of products and/or services available from the vendor to the user profiles in the gifting method 100 for the customers. In selected embodiments, the vendor can know one or more buying habits of a selected customer and can suggest moving the products and/or services preferred by the customer to the user profile of the selected customer. These preferred products and/or services can include, but are not limited to, products and/or services that the selected customer would never buy directly but would prefer to receive as a gift. The selected customer optionally can directly purchase at least one of the preferred products and/or services via the gifting method 100 without initiating the gift creation process.

The “Add to my Giftprofile” widget 1805 (shown in FIG. 23B) can be integrated, at 1830, by the vendor into the online store 1810 (shown in FIG. 23B) of the vendor. In selected embodiments, the vendor can integrate the widget 1805, at the product/service preview level and/or in the product/service description page. The gifting method 100 optionally can manage the process of creating the product/service affiliation link when the selected user clicks on an “Add to Giftprofile” link 1840 after choosing one or more preferred variables, such as sizes and/or colors. After the selected user adds the product/service, the gifting method 100 can present a confirmation message 1845, which optionally can present the selected user with an opportunity to open the user profile of the selected user and to delete the added product/service.

As illustrated in FIG. 23E, the gifting method 100 can be configured to create an affiliate link within the user profile of the first user so when the second user wants to make a gift to the first user and chooses a selected product/service as a gift, the gifting method 100 can highlight the selected product/service as being “highly desired,” at 1850, and the gifting method 100 can sell the product/service available from the affiliate. In selected embodiments, the gifting method 100 can proceed to complete the payment process. The gifting method 100, for example, can notify the vendor that the purchase has been completed via the “Add to my Giftprofile” widget 1805 (shown in FIG. 23B).

Activation of the gift profile navigation link 825 of the gifting method 100 can enable the gifter to access a gifter profile page 1600 as illustrated in FIGS. 19A-O. Turning to FIG. 19A, the gifter profile page 1600 can enable the gifter to manage the gifter profile. The gifter, for example, can activate the settings link 1605 for accessing the gifter profile page shown in FIG. 19J. Turning to FIG. 19J, the gifter profile page can enable the gifter to enter initial and/or updated gifter profile information, at 1601A. The gifter profile information, at 1601A, can include general gifter information, such as a updating an image, at 1602A and/or deleting an image, at 1602B. The gifter profile page likewise can enable the gifter to enter and/or update a first gifter name 1602C, a last gifter 1602D, a gifter gender 1602E, preference gift type 1602F and/or a gifter age 1602G.

As shown in FIG. 19J, the gifter profile page can enable the gifter to enter initial and/or updated gifter birthdate information 1602H and/or contact information. The contact information for the gifter can include, but is not limited to, a gifter shipping address 16021, a gifter email address 1602J and/or a gifter telephone number 1602K. In selected embodiments, the gifter shipping address 16021 (and/or other contact information) can comprise contact information for sending gifts purchased for the gifter by another user of the gifting method 100. The other user preferably will be unable to see or otherwise access the gifter shipping address 16021 and/or can search for the gifter based upon the gifter name, gifter telephone number and/or other gifter contact information. In selected embodiments, the other use a gift profile code associated with the gifter to access the gift profile of the gifter.

The gifter optionally can be enabled to provide initial and/or updated payment information 1602L. The payment information 1602L can include one or more credit cards, one or more debit cards, etc. In a preferred embodiment, the gifter profile page can enable the gifter to access a digital (or electronic) wallet 1602M of the gifter. The digital wallet 1602M can enable the gifter to pay for any subscription fees for accessing the gifting method 100, to pay for any gifts sent by the gifter and/or to send money and/or cryptocurrency to a recipient.

Turning to FIG. 19K, the gifter profile page can enable the gifter to manage a premium subscription to the gifting method 100, at 1601B. The gifter profile page can present an interactive listing of features included in the premium subscription, at 1603A. The gifter can enter any payment information 1603B for any additional premium subscription features. Additionally and/or alternatively, the gifter profile page can enable the gifter to manage any flower plan 910 (shown in FIGS. 9A-R), at 1601C. The gifter can view all current and/or historic flower plan orders 1604, and, as desired, access the flower plan details for a selected flower plan order 1604A. As illustrated in FIG. 19M, the gifter can import one or more contacts, at 1601D, from a selected third party data source. The gifter profile page can enable the gifter to select which data source, at 1606A, from which the contact are imported and/or view a contact listing 1606B from each data source or as aggregated from all data sources.

The gifter profile page of FIG. 19N can permit to manage one or more notifications that can be generated by the gifting method 100, at 1601E. Stated somewhat differently, the gifter can select which of the generated notifications that the gifter wishes to receive. The notifications, for example, can include notifications regarding occasions 1607A, notifications regarding gifts 1607B, notifications regarding subscriptions and payments 1607C, and/or notifications regarding news and updates 1607D, without limitation. Turning to FIGS. 19A and 190, the gifter profile page, at 1601F, can permit the gifter to control access to the gifter profile of the gifter. The gifter profile, for example, can enable the gifter to provide a gifter email address 1608A, a gifter telephone number 1608B, and/or a gifter password 1608C for controlling access to the gifter profile of the gifter. The gifter optionally can restrict access to the gifter profile of the gifter via third party websites, such as Facebook or Google, and/or delete the gifter profile of the gifter.

The gifter profile page 1600 of FIG. 19A can enable the gifter to create, at 1610, a gift fund 1680 for a predetermined project or a preselected gift that the gifter would like to receive. In other words, the gifting method 100 advantageously can permit the gifter to list one or more items that the gifter would like to receive as a gift and enable other users to contribute to the cost of the listed items. Exemplary gifts can include “big ticket” or other expensive items such as college tuition and/or a house down payment, without limitation. The gift fund 1680 thereby can permit the gifter to select the preselected gift and then post the preselected gift for other users of the gifting method 100 and other individuals to make donations for purchasing the preselected gift for the gifter.

Exemplary gift fund creation pages for creating the gift fund 1680 are shown in FIGS. 19B-C. Turning to FIG. 19B, the gift fund creation page, at 1611, can permit the gifter to enter a title (or item name) for the gift fund 1680 (or the preselected gift) and/or, at 1612, to enter one or more personal comments for potential gift fund donors and other participants. Other details about the gift fund 1680 optionally can be added, at 1613. Additionally and/or alternatively, the gift fund creation page can enable entry of a budget for the gift fund, at 1614, and an indication of an expiry date 1615A or no expiry date 1615B. The gift fund creation page of FIG. 19C can permit entry of a description of the preselected gift, at 1616, an indication of whether the gift fund participants should be shown, at 1617, and/or an addition of one or more images of the preselected gift, at 1618.

The gift fund 1680 for the preselected gift, once created, can be presented via the gifter profile page 1600 as shown in FIGS. 19A and 19D. As illustrated in FIG. 19D, the gifter profile page 1600 can show a donation total 1619A for the gift fund 1680 and enable the gifter to purchase the preselected gift, at 1619B. The gifter profile page 1600 optionally can present donation information 1619C, such as a donor name, donation amount, donation date and/or donor comment.

Returning to FIG. 19A, the gifter profile page 1600 can enable the gifter to access a gift profile code, at 1620. Exemplary gift profile codes can include, but are not limited to, a bar code, a Universal Product Code (or UPC) and/or, as shown in FIG. 19E, a Quick Response (or QR) code. The gifter profile page 1600 likewise can permit the gifter to access added in gift profile information, at 1630. As shown in FIGS. 19F-H, the gift profile information can be viewed via a favorite gifts link 1631, a gift funds link 1634 and/or a suggestions link 1637. FIG. 19F shows one embodiment by which favorite gifts information 1632 can be presented via activation of the favorite gifts link 1631. The favorite gifts information 1632 can include at least one category 1633 of gifts and present information about one or more favorite gifts in each category 1633.

Activation of the gift funds link 1634 can enable presentation of a gift fund listing 1638 of each gift fund 1680 associated with the gifter as illustrated in FIG. 19G. Turning to FIG. 19H, activation of the suggestions link 1637 can enable the gifter profile page 1600 to present a gift suggestion list 1638 of suggested gifts or other items 1639. The gifting method 100 can identify the suggested gifts or other items 1639 based upon the gifter profile and other known preferences. The gifter profile page 1600 can permit the gifter to search among the suggested gifts or other items 1639 and/or to sort the suggested gifts or other items 1639 based upon one or more predetermined criteria. As illustrated in FIG. 19H, the gifter can be permitted to like, dislike, purchase and/or share each of the suggested gifts or other items 1639. One or more of the suggested gifts or other items 1639 optionally can be added to the gift profile of the gifter as desired.

Returning again to FIG. 19A, the gifter profile page 1600 can enable the gifter to access the virtual gifts, texts, and greeting cards 1640 sent by the gifter and/or received by the gifter. Exemplary virtual gifts, texts, and greeting cards 1640 can include, but are not limited to, the virtual text message preview 1334V of the text message 1331A (collectively shown in FIG. 14E), the virtual greeting card preview 1334V of the virtual greeting card 1331B (collectively shown in FIG. 14F), the virtual gift preview 1334V of the gift 1331D (collectively shown in FIG. 16K), the virtual gift preview 1334V of the direct gift 1411A (collectively shown in FIG. 17N) and/or the virtual gift preview 1545V of the local gift 1511A (collectively shown in FIG. 18I).

Activation of the gift preference quiz link 1650 can initiate a new or updated gift preference quiz for the gifter and/or a selected recipient in the manner discussed in more detail herein. The manage preferences link 1660 can be activated to access the manage preferences page 1665 shown in FIG. 19I. The manage preferences page 1665 advantageously can be used to customize the gifter profile page 1600, including any gift suggestions 1690 shown on the gifter profile page 1600, in accordance with the specific product likes and dislikes of the gifter. The gifter can use the wallet access link 16670 of FIG. 19A to manage a digital (or electronic) wallet of the gifter.

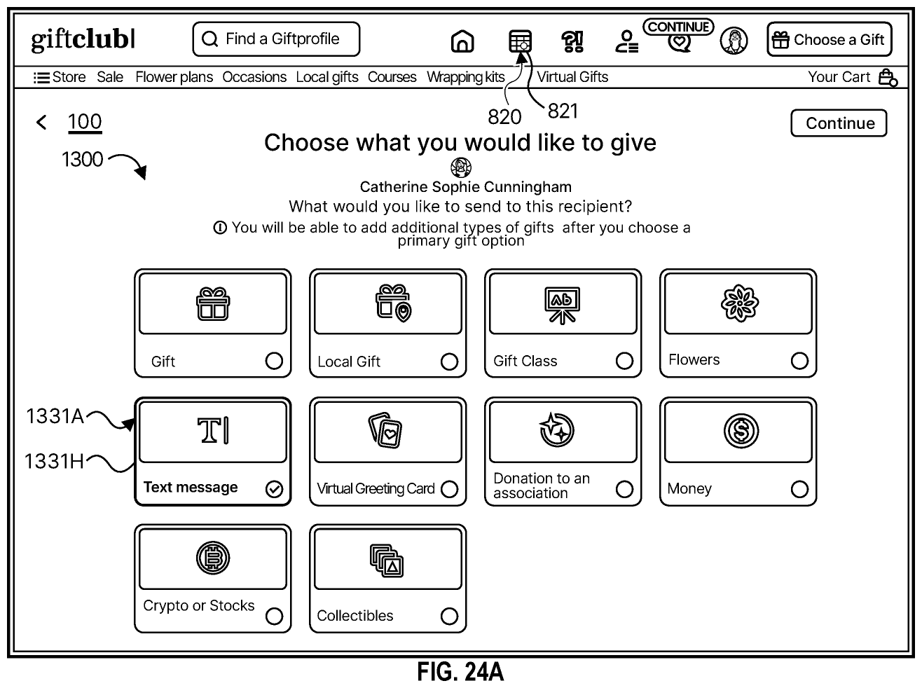

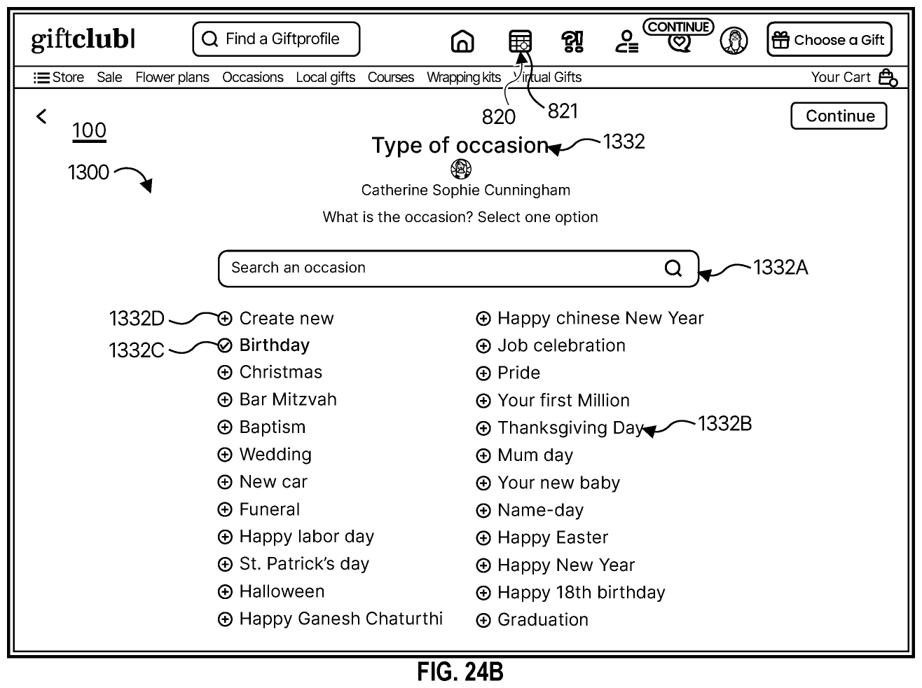

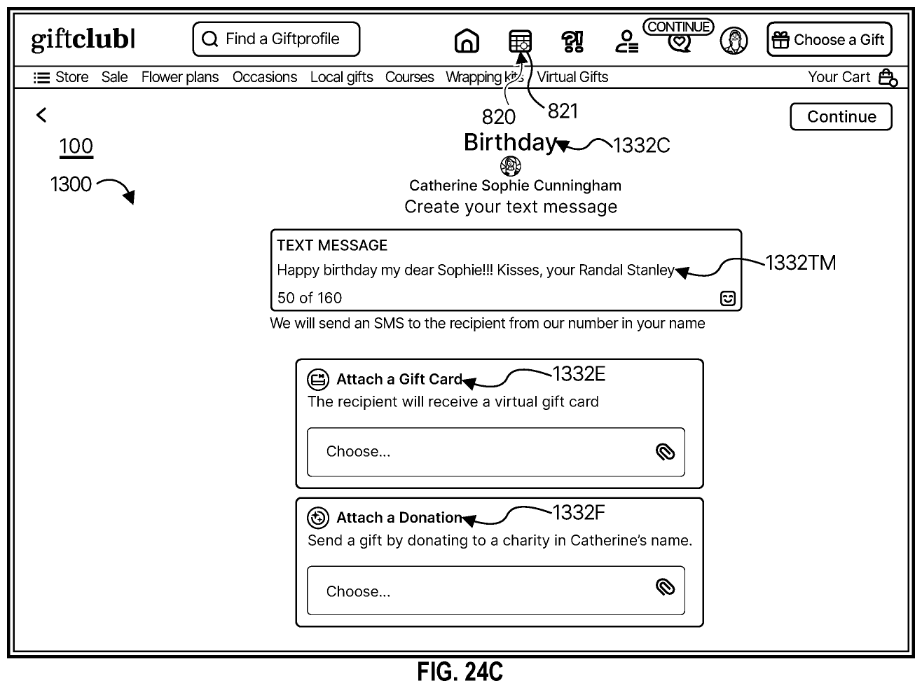

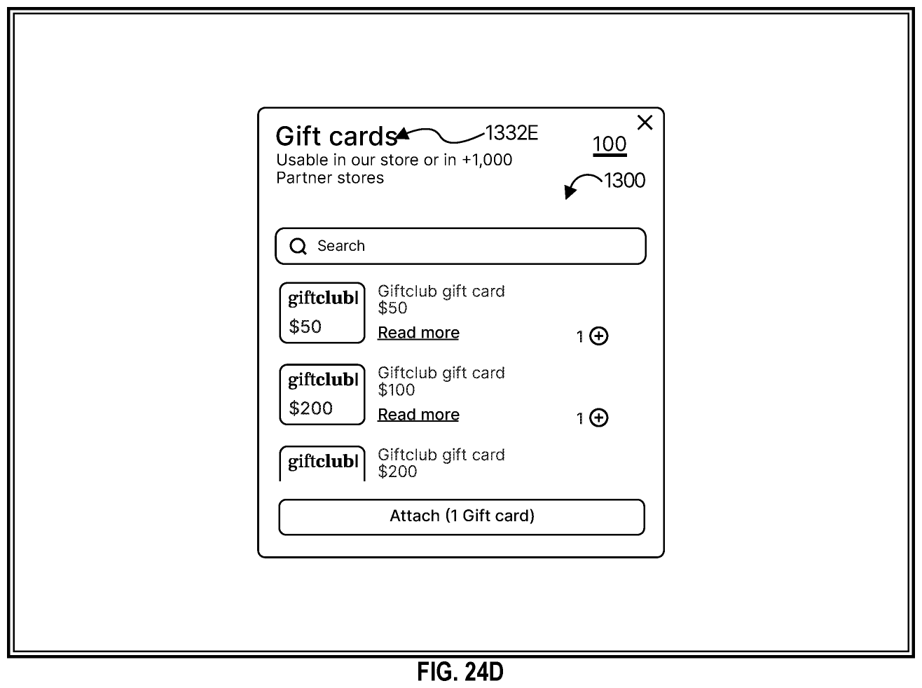

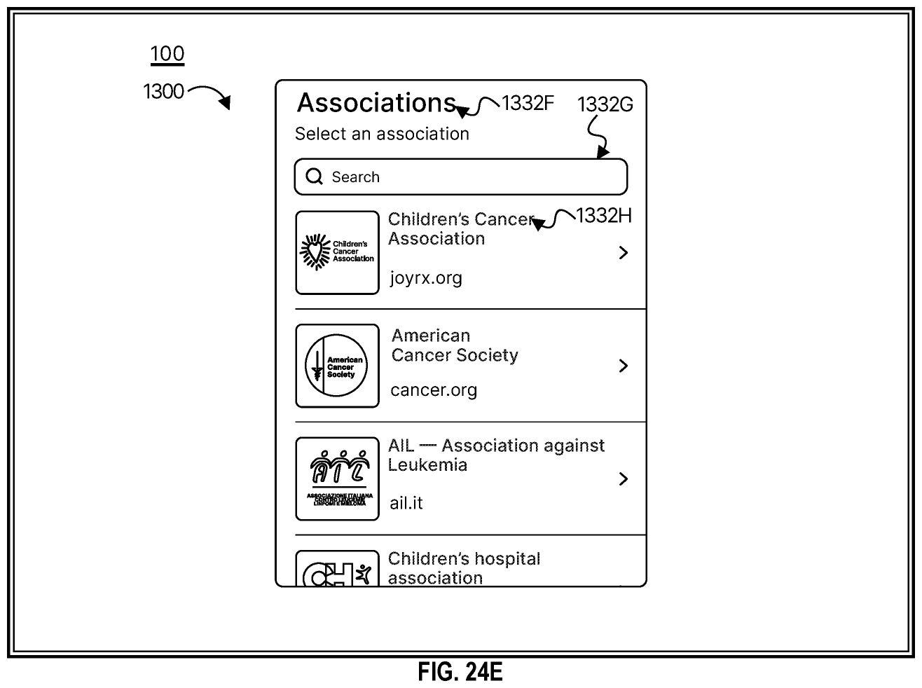

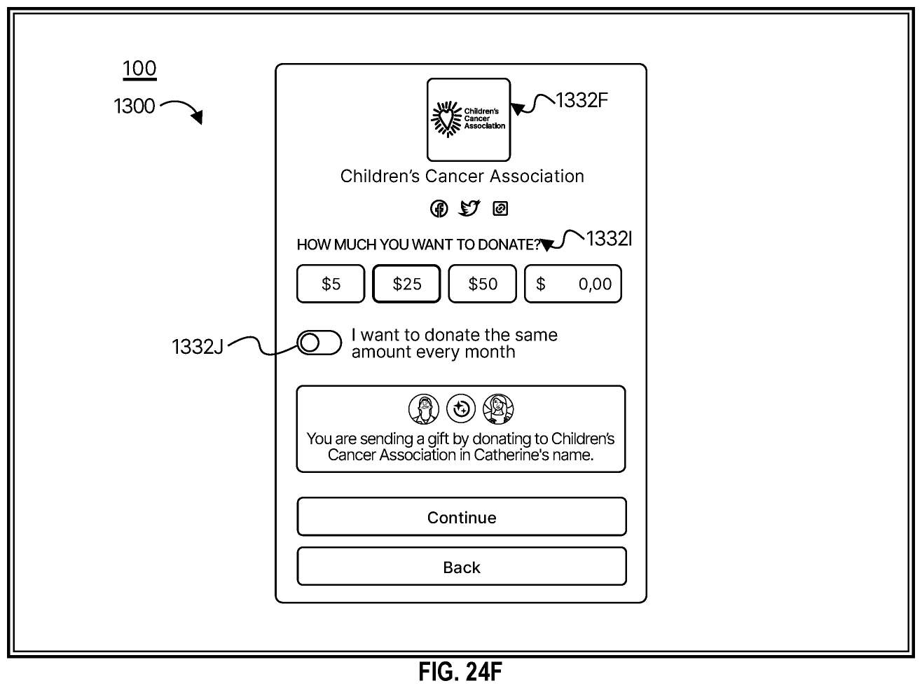

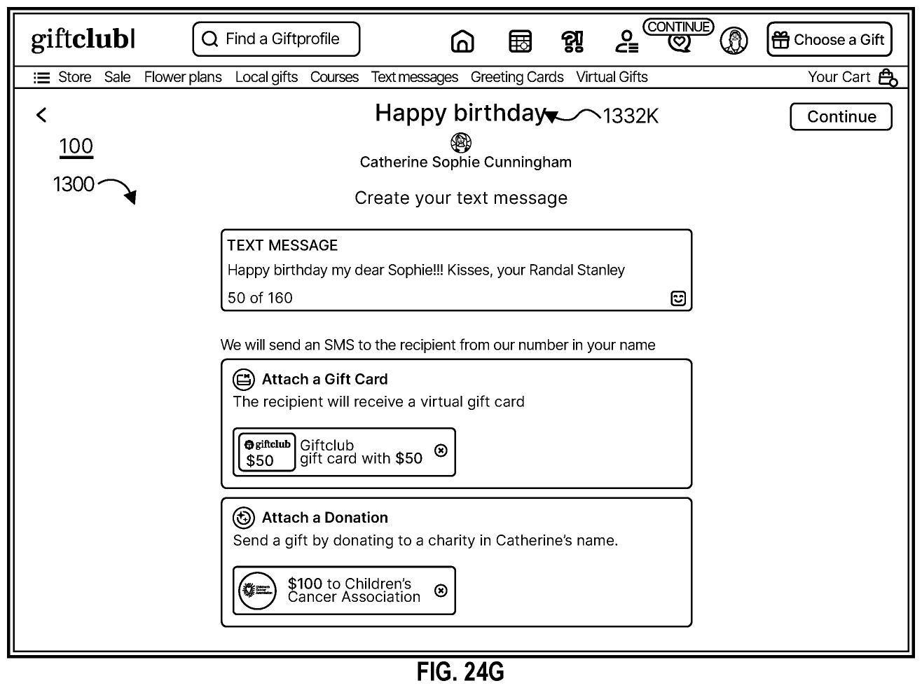

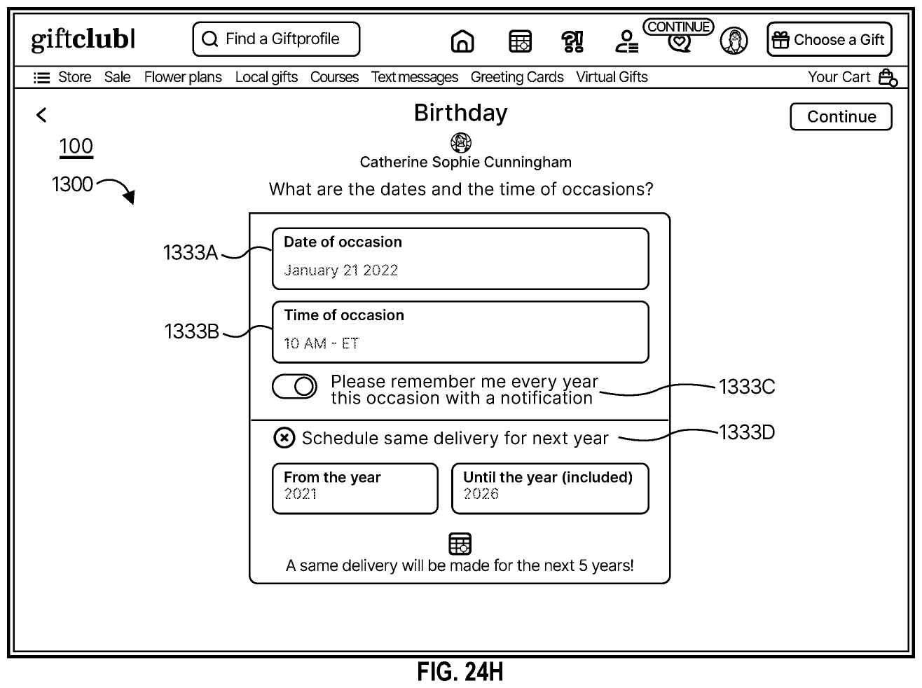

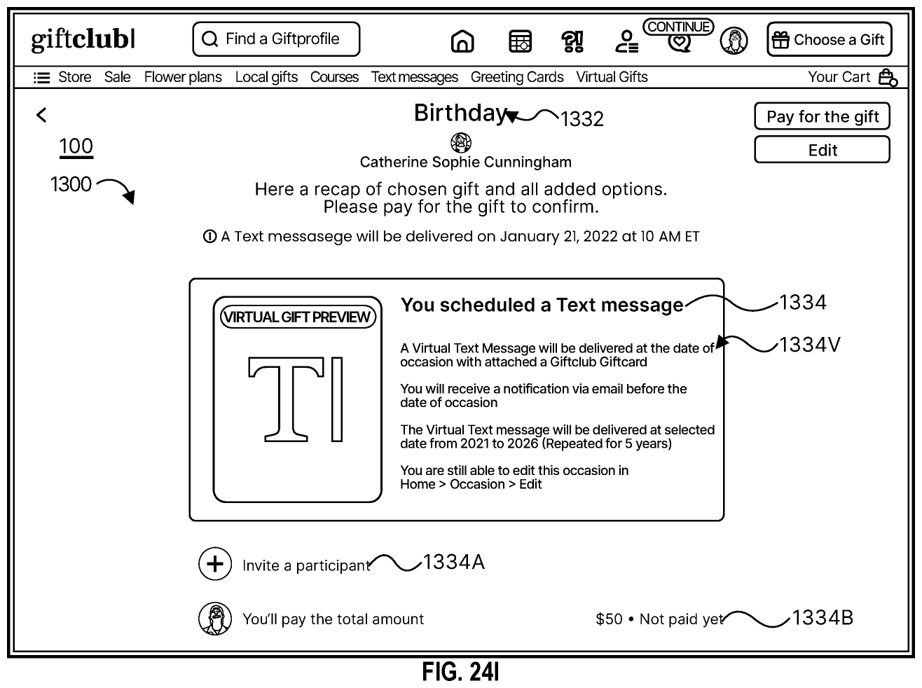

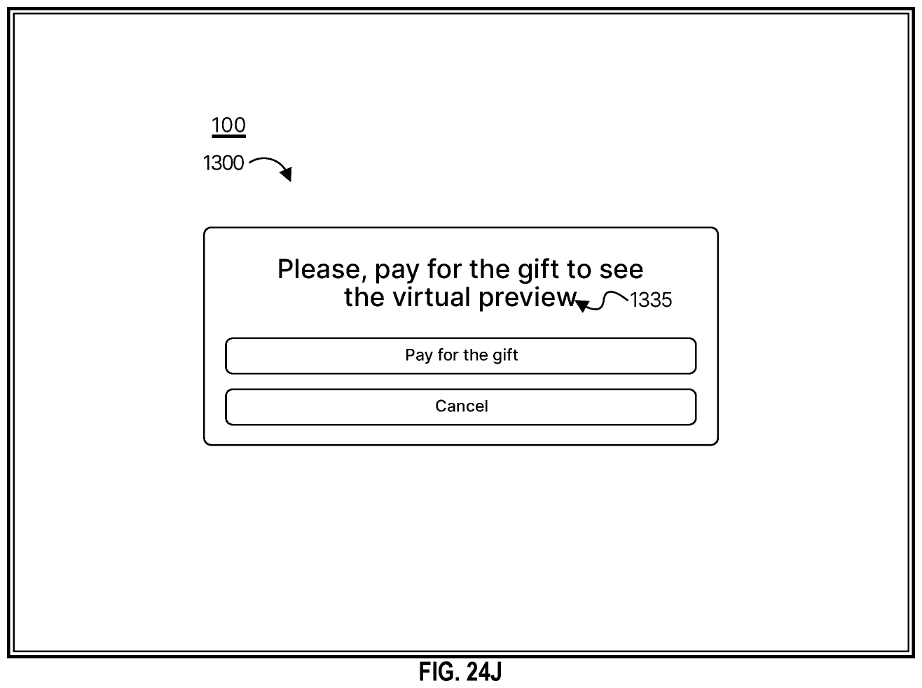

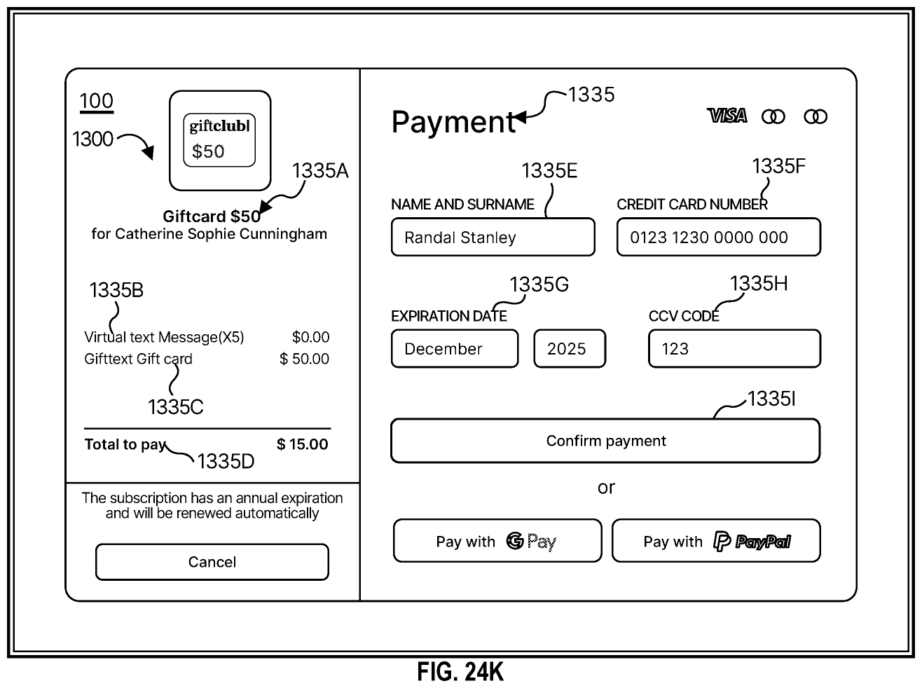

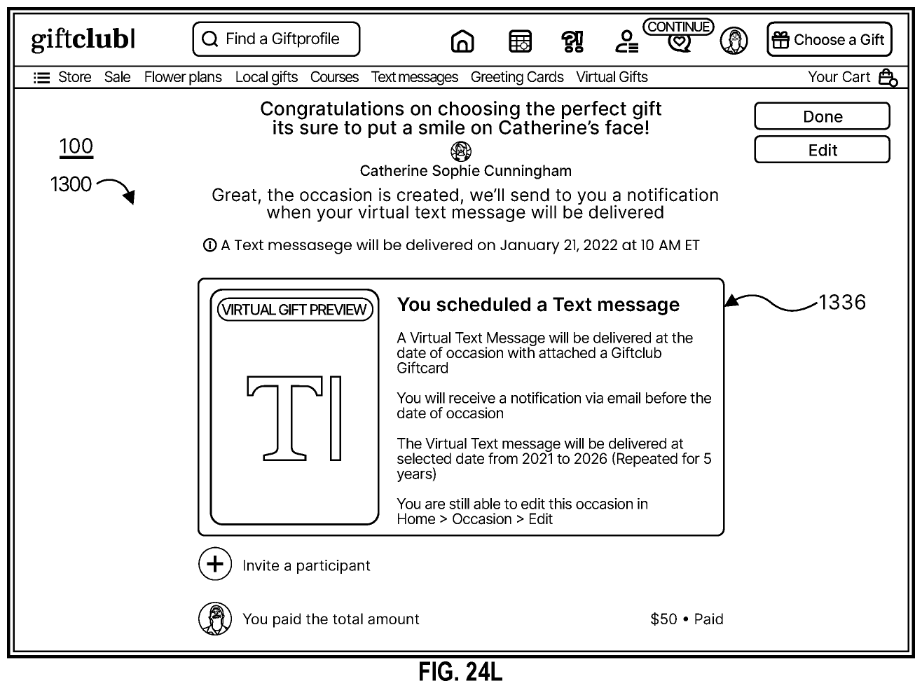

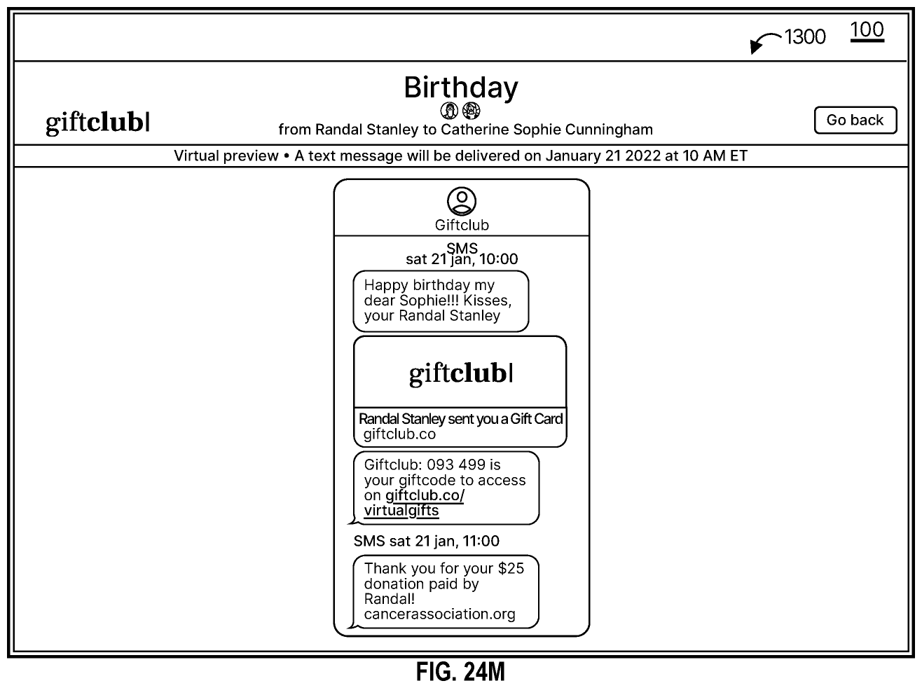

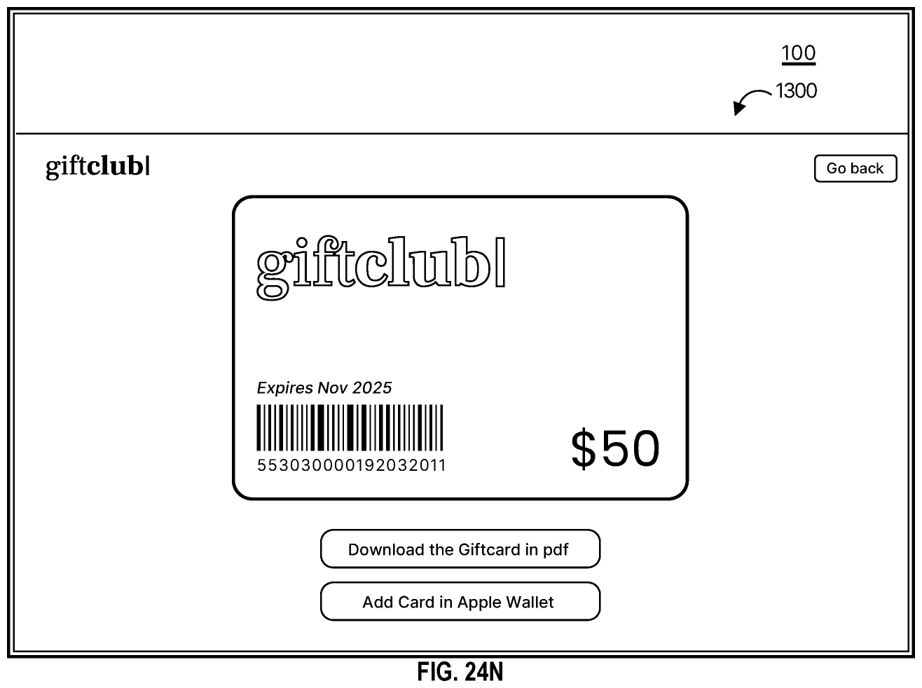

FIG. 24A illustrates an alternative embodiment of the occasions page 1300 when the gifter elects to send a text message 1331H to the selected recipient. The occasions page 1300 can enable the gifter to identify an occasion type 1332 for the new occasion as shown in FIG. 24B. The gifter, for example, can search for an appropriate occasion type 1332, at 1332A, from among a plurality of preselected occasion types. Additionally and/or alternatively, the gifter can select the occasion type 1332 from an occasion type list 1332B and/or to create a new occasion type 1332D for the new occasion 1320. The gifter thereby can select an appropriate occasion type 1332C for the new occasion. In the manner set forth above with reference to FIG. 14C, the occasions page 1300 can enable the gifter to enter a textual message 1332TM and optionally to attach a gift card 1332E to the text message 1331A as illustrated in FIGS. 24C-D.

Advantageously, the occasions page 1300 can permit the gifter to include a charitable donation 1332F with the textual message 1332TM. As shown in FIG. 24E, for example, the occasions page 1300 can enable the gifter to search for an appropriate charitable organization (or association), at 1332G, and/or to select the appropriate charitable organization from among a listing 1332H of one or more preselected charitable organizations. The occasions page 1300 likewise can permit the gifter to indicate an amount of money to be charitably donated to the selected charitable organization. The gifter, for example, can select or otherwise enter a charitable donation with a predetermined monetary amount, at 13321, and/or authorize a periodic charitable donation in the predetermined monetary amount, at 1332J, as illustrated in FIG. 24F.

FIG. 24G shows that the occasions page 1300 can include a text message with charitable donation confirmation page 1332K. The occasions page 1300 of FIG. 24H can enable the gifter to set an occasion date 1333A and/or occasion time 1333B for the new occasion 1320. The gifter likewise can elect to receive annual or otherwise periodic reminders about the new occasion 1320, at 1333C, and/or schedule the same text message for periodic delivery, at 1333D.

Turning to FIG. 24I, the occasions page 1300 can provide a recap information, at 1334, for the text message 1331A. The occasions page 1300 optionally can invite another recipient, at 1134A, to participate in the text message 1331A and/or remind the gifter, at 1334B, of any amount due but not yet paid. Additionally and/or alternatively, the occasions page 1300 can provide a virtual text message preview of the text message 1331A for viewing, at 1334V, via a virtual gifts and cards link 1640 (shown in FIG. 19A) of the gifter profile page 1600 (shown in FIG. 19A) and/or a recipient profile page of the selected recipient. Turning to FIGS. 24J-K, a payment page 1335 of the occasions page 1300 is shown. The payment page 1335 can confirm the text message 1331A selected by the gifter, any associated cost 1335B and/or any greeting card or other costs 1335C. A total price 1335D can be shown on the payment page 1335 for the text message 1331A.

The payment page 1335 of FIG. 24K is illustrated as enabling the gifter to enter payment information. The payment information can include, but is not limited to, a gifter name 1335E, a number 1335F for a credit card, debit card or other transaction payment method associated with the gifter, an expiry date 1335G for the payment method and/or a CVV 1335H for the payment method. The payment page 1335 optionally can ask the gifter to confirm the payment, at 1335I, before submission of the payment information. The occasions page 1300 can provide payment confirmation and scheduling information, at 1336, for the text message 1331A as illustrated in FIG. 24L. An exemplary text message 1331A and associated gift card as received by the selected recipient are illustrated in FIGS. 24M-N. A charity donation sticker or other donation indicia optionally can be attached or otherwise associated with the text message. The charitable donation can be paid to the selected charitable organization in the name of the selected recipient, and/or the selected recipient can receive a thank you message or other donation confirmation receipt message from the selected charitable organization via electronic mail (or email) messaging, short message service (SMS) messaging or another communication channel.

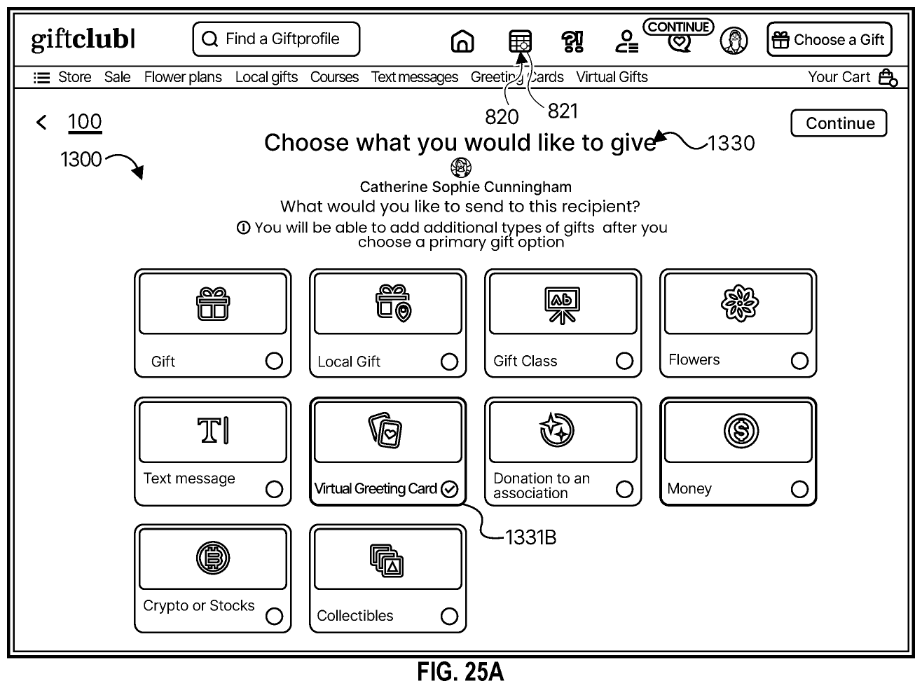

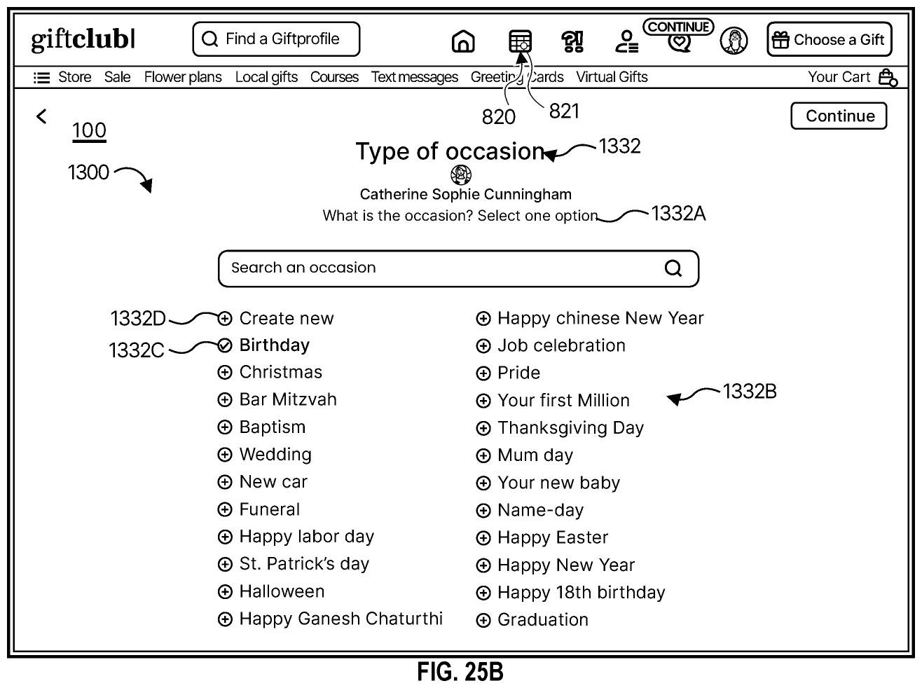

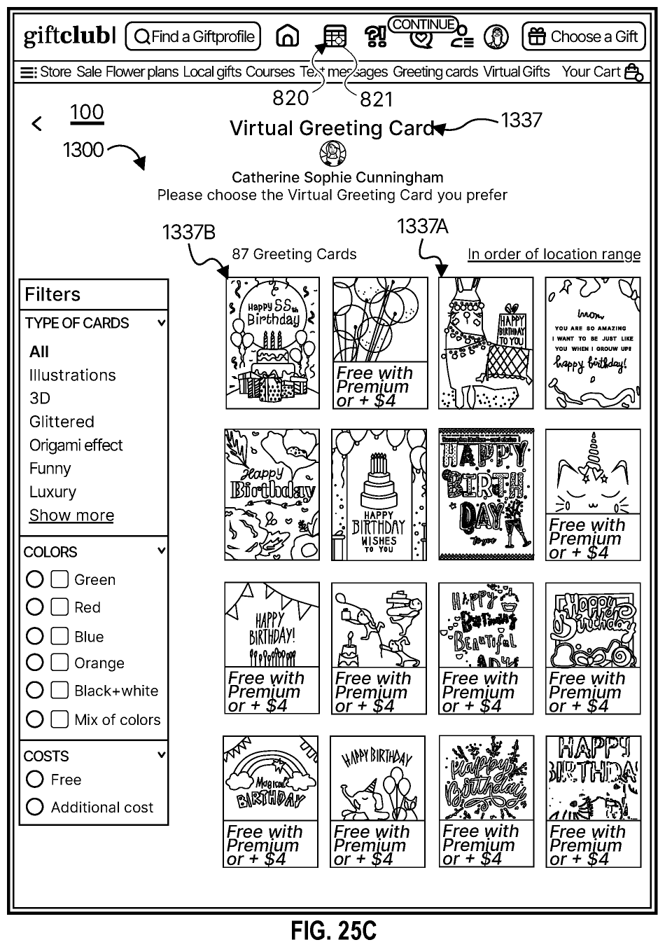

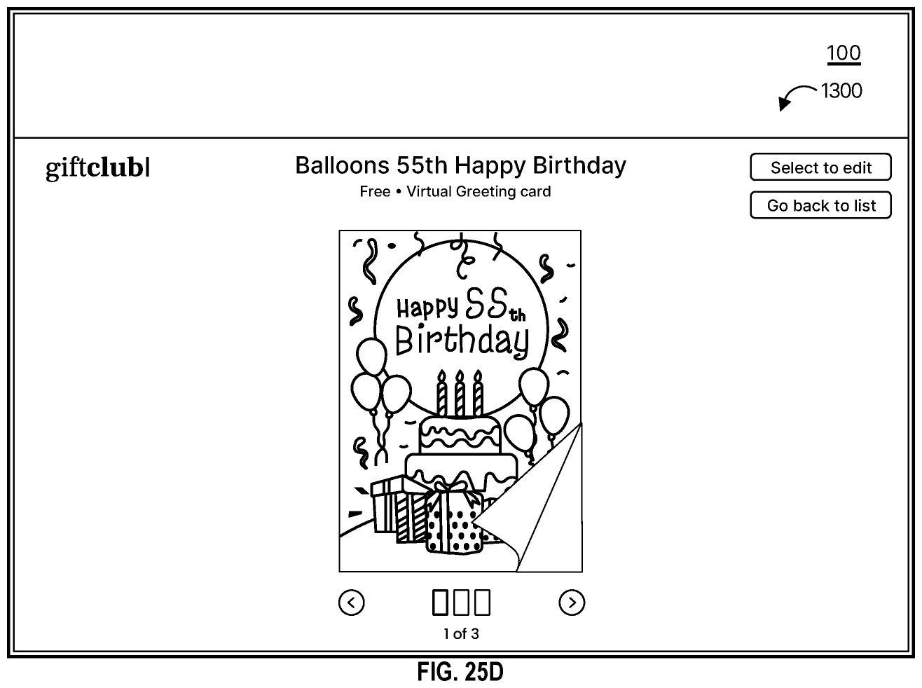

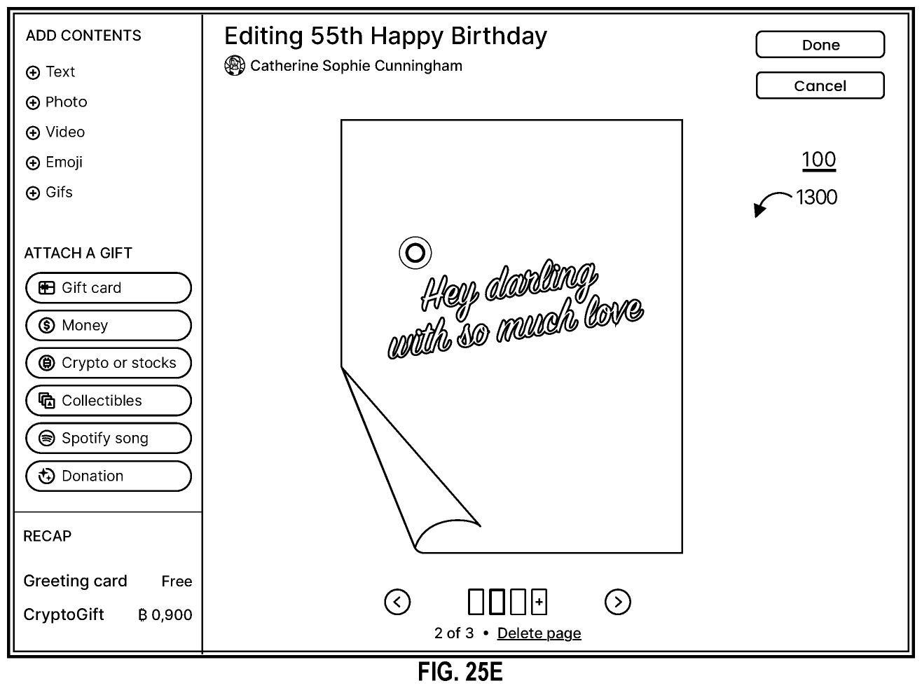

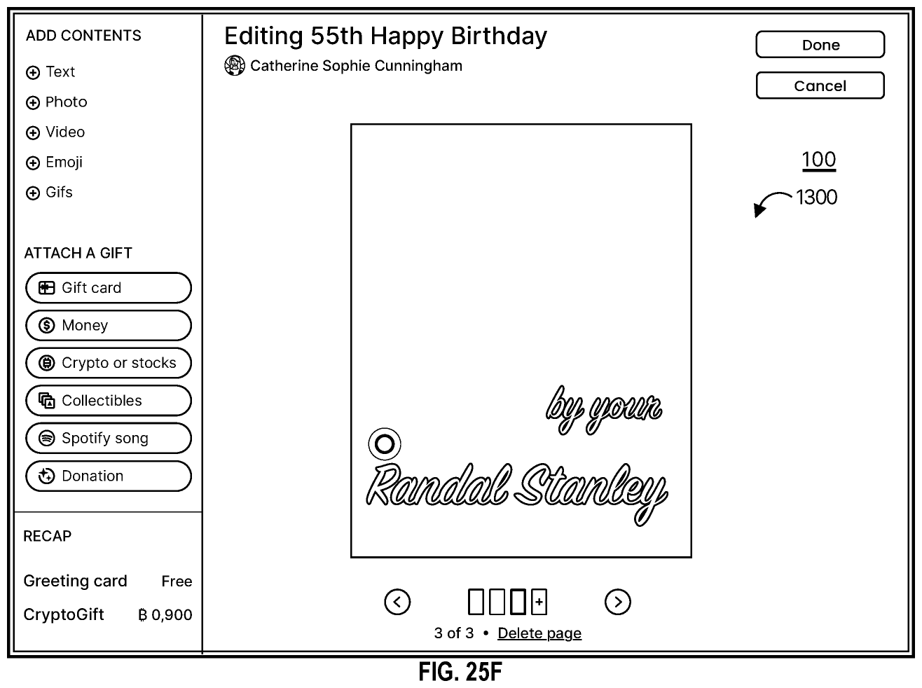

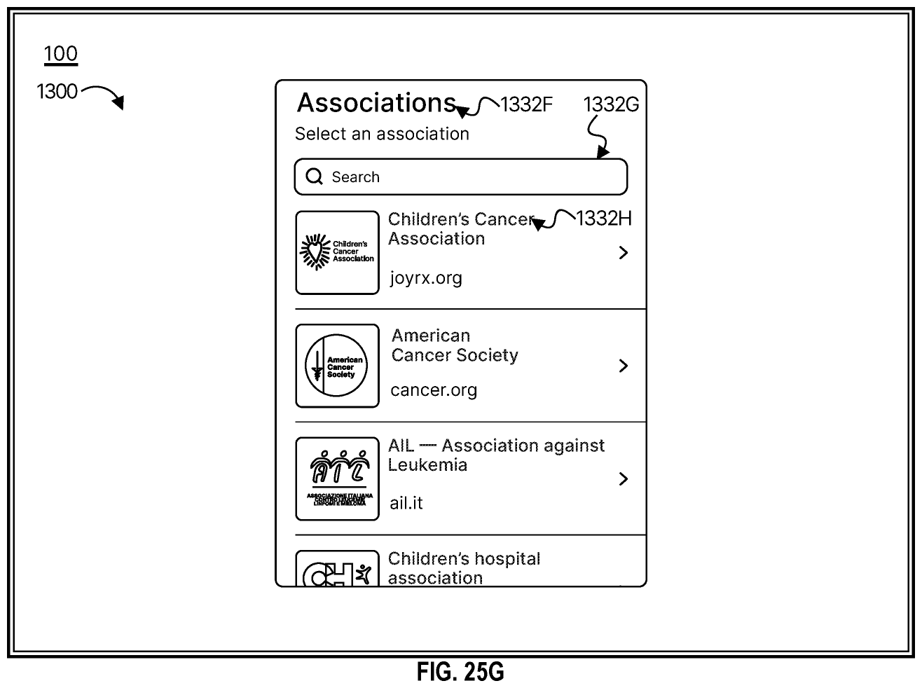

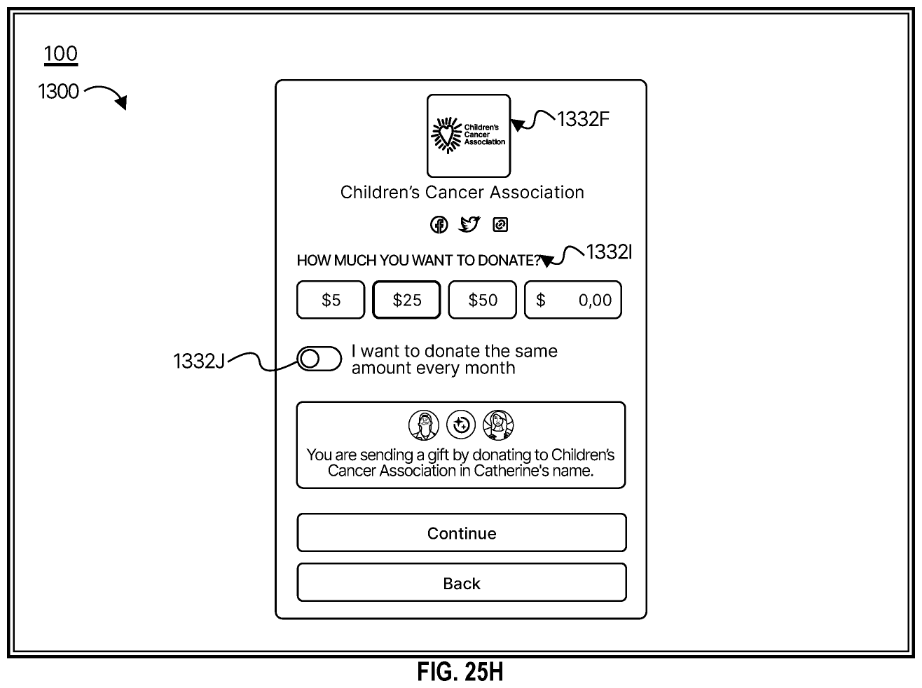

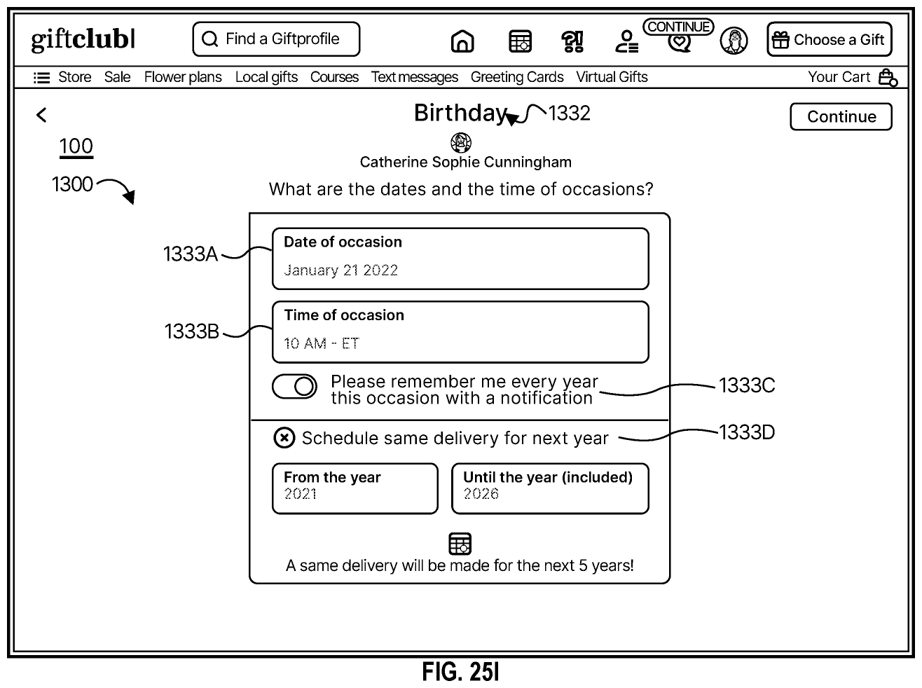

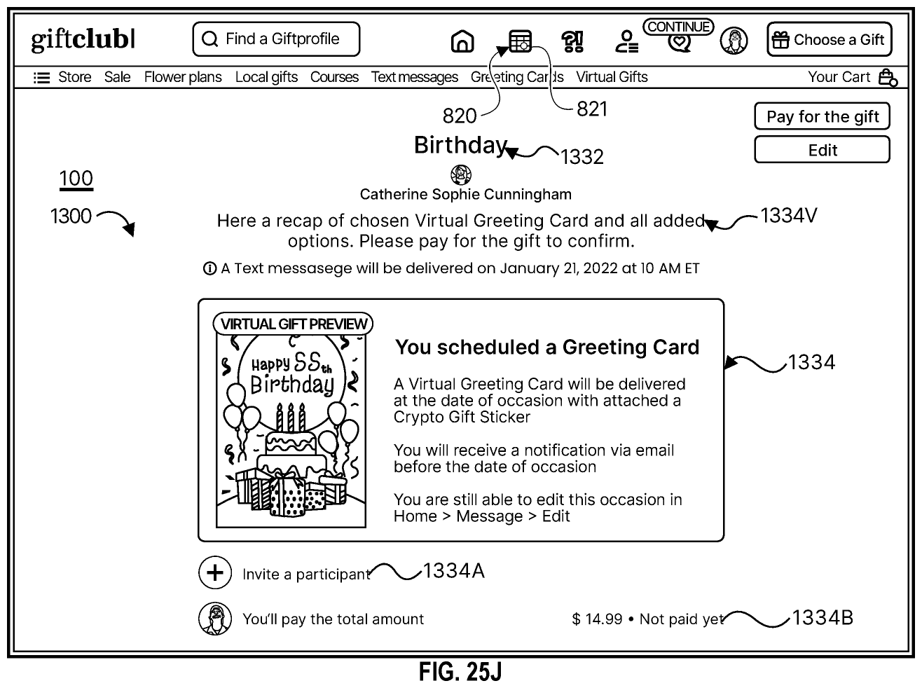

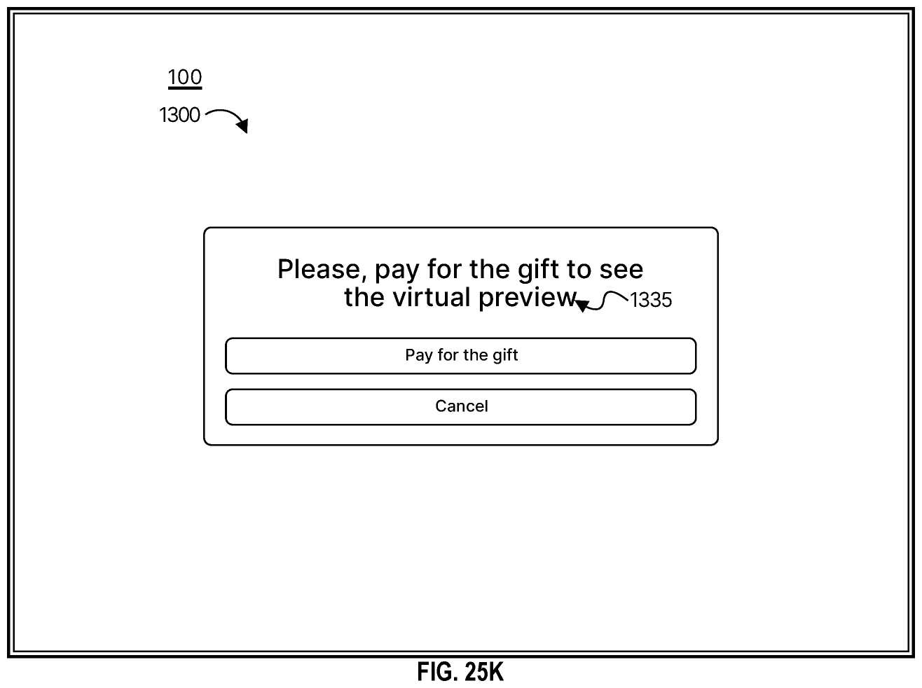

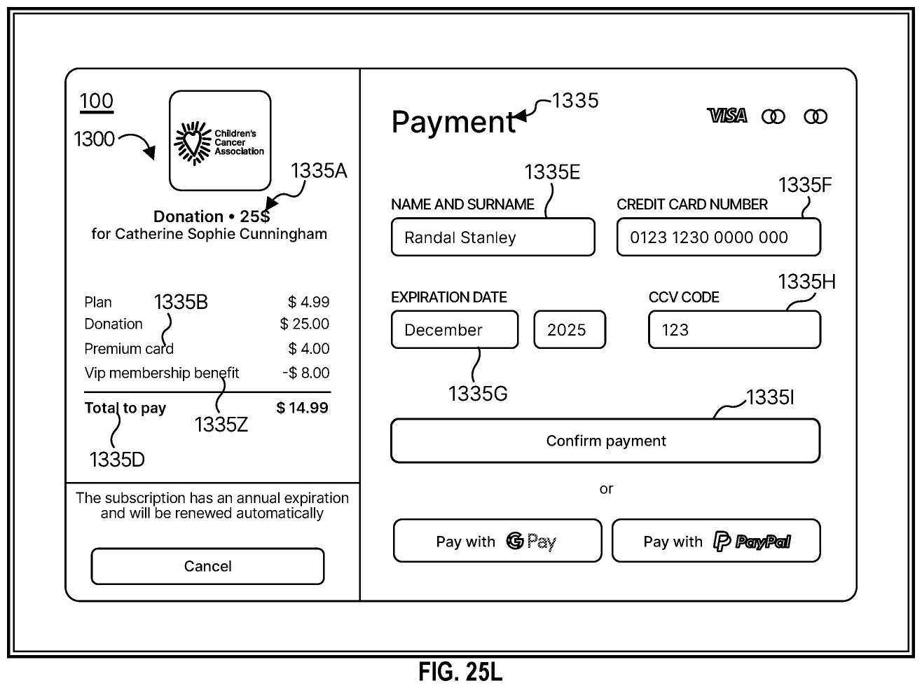

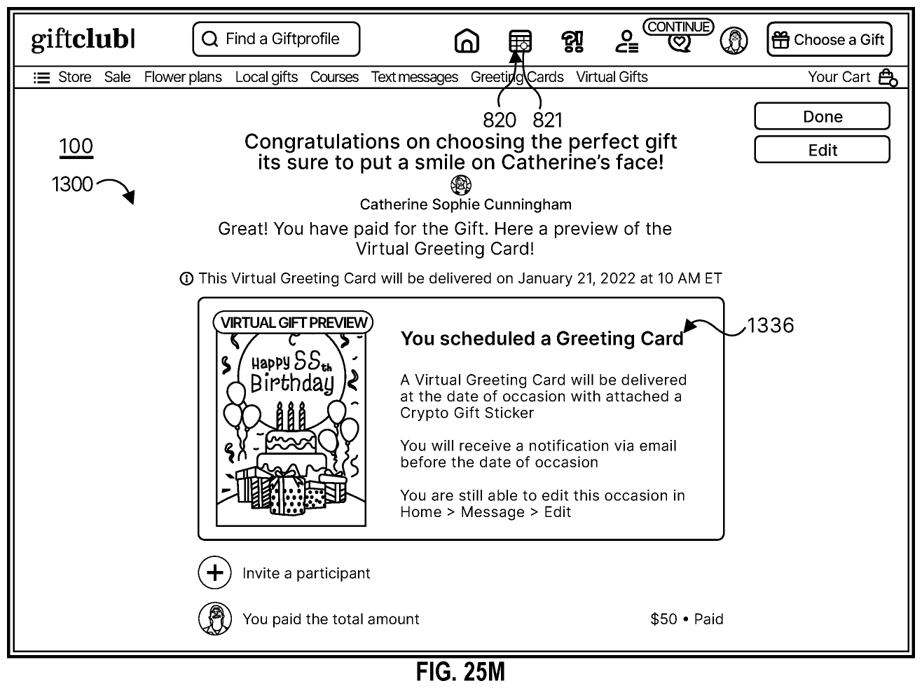

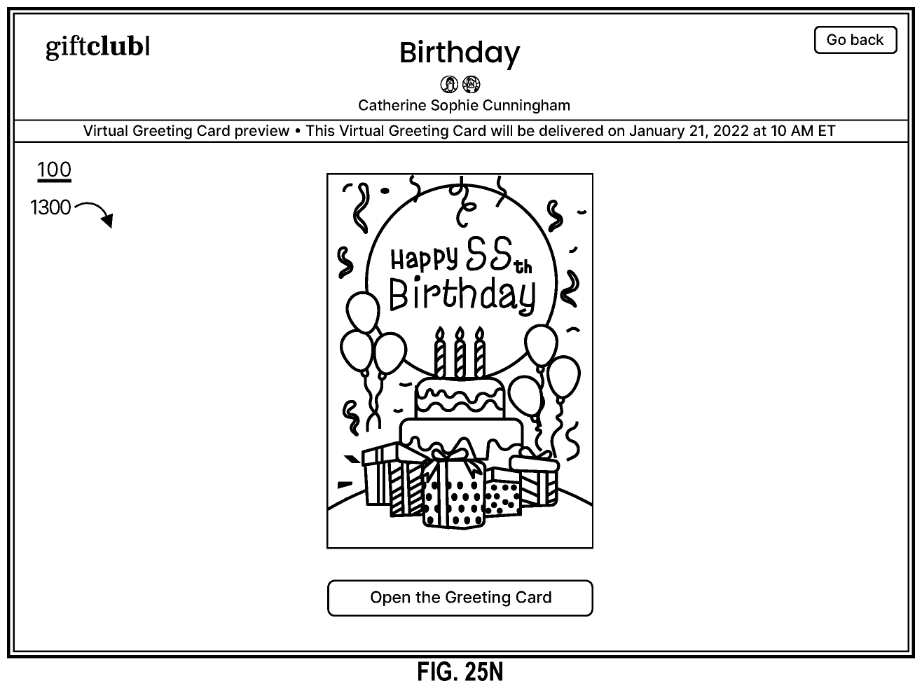

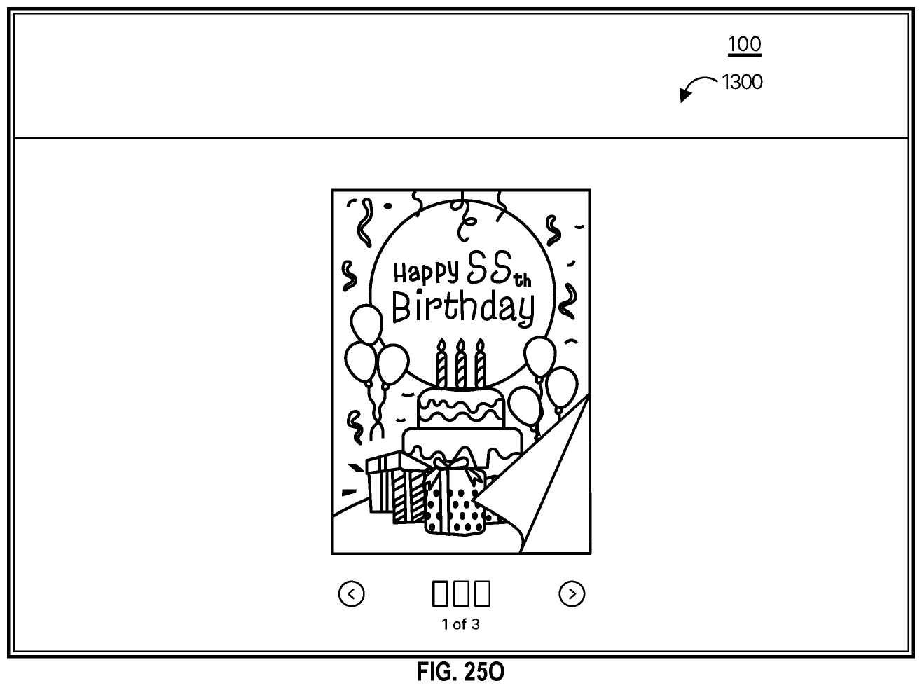

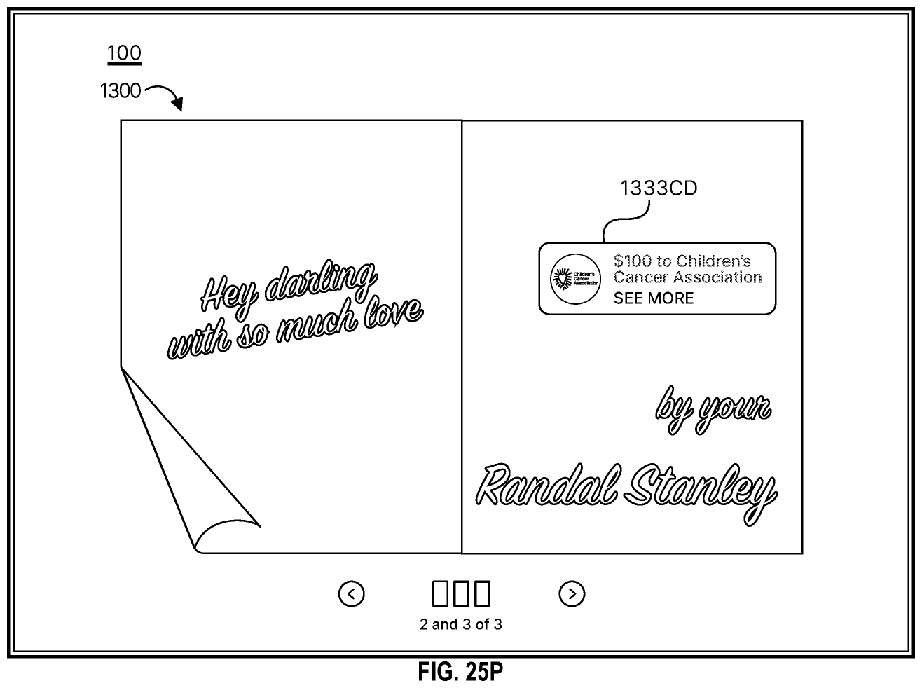

FIG. 25A illustrates another alternative embodiment of the occasions page 1300 that can be presented when the gifter elects to send a virtual greeting card 1331B to the selected recipient. The occasions page 1300 can enable the gifter to identify an occasion type 1332 for the new occasion as shown in FIG. 25B. The gifter, for example, can search for an appropriate occasion type 1332, at 1332A, from among a plurality of preselected occasion types. Additionally and/or alternatively, the gifter can select the occasion type 1332 from an occasion type list 1332B and/or to create a new occasion type 1332D for the new occasion 1320. The gifter thereby can select an appropriate occasion type 1332C for the new occasion. The occasions page 1300 of FIG. 25C is shown as presenting one or more proposed virtual greeting cards 1137A for consideration by the gifter and as enabling the gifter to select a relevant virtual greeting card 1137B for dispatch to the selected recipient. The occasions page 1300 optionally can enable the gifter to enter a textual message and/or attach a gift card to the virtual greeting card 1331B as illustrated in FIGS. 25D-F. In selected embodiments, the gifter can include a gift, such as cash, cryptocurrency, stocks, money and/or non-fungible tokens (NTFs), with the virtual greeting card sent to the recipient.

Advantageously, the occasions page 1300 can permit the gifter to include a charitable donation 1332F with the virtual greeting card 1331B. As shown in FIG. 25G, for example, the occasions page 1300 can enable the gifter to search for an appropriate charitable organization (or association), at 1332G, and/or to select the appropriate charitable organization from among a listing 1332H of one or more preselected charitable organizations. The occasions page 1300 likewise can permit the gifter to indicate an amount of money to be charitably donated to the selected charitable organization. The gifter, for example, can select or otherwise enter a charitable donation with a predetermined monetary amount, at 13321, and/or authorize a periodic charitable donation in the predetermined monetary amount, at 1332J, as illustrated in FIG. 25H.

The occasions page 1300 of FIG. 25I can enable the gifter to set an occasion date 1333A and/or occasion time 1333B for the new occasion 1320. The gifter likewise can elect to receive annual or otherwise periodic reminders about the new occasion 1320, at 1333C, and/or schedule the same text message for periodic delivery, at 1333D. Turning to FIG. 25J, the occasions page 1300 can provide a recap information, at 1334, for the virtual greeting card 1331B. The occasions page 1300 optionally can invite another recipient, at 1134A, to participate in the virtual greeting card 1331B and/or remind the gifter, at 1334B, of any amount due but not yet paid. Additionally and/or alternatively, the occasions page 1300 can provide a virtual greeting card preview of the virtual greeting card 1331B for viewing, at 1334V, via a virtual gifts and cards link 1640 (shown in FIG. 19A) of the gifter profile page 1600 (shown in FIG. 19A) and/or a recipient profile page of the selected recipient.

Turning to FIGS. 25K-L, a payment page 1335 of the occasions page 1300 is shown. The payment page 1335 can confirm the virtual greeting card 1331B selected by the gifter, any associated gift costs 1335A, any additional gift wrapping, greeting card, charitable donation amount or other costs 1335B, and/or any membership or other discounts 1335Z. A total price 1335D can be shown on the payment page 1335 for the virtual greeting card 1331B. The payment page 1335 of FIG. 25G is illustrated as enabling the gifter to enter payment information. The payment information can include, but is not limited to, a gifter name 1335E, a number 1335F for a credit card, debit card or other transaction payment method associated with the gifter, an expiry date 1335G for the payment method and/or a CVV 1335H for the payment method. The payment page 1335 optionally can ask the gifter to confirm the payment, at 1335I, before submission of the payment information. Turning to FIG. 25M, the occasions page 1300 can provide scheduling information, at 1336, for the virtual greeting card 1331B.

An exemplary virtual greeting card 1331B as received by the selected recipient are illustrated in FIGS. 25N-P. A charity donation sticker or other donation indicia 1333CD optionally can be attached or otherwise associated with the text message. The charitable donation can be paid to the selected charitable organization in the name of the selected recipient, and/or the selected recipient can receive a thank you message or other donation confirmation receipt message from the selected charitable organization via SMS messaging or another communication channel.

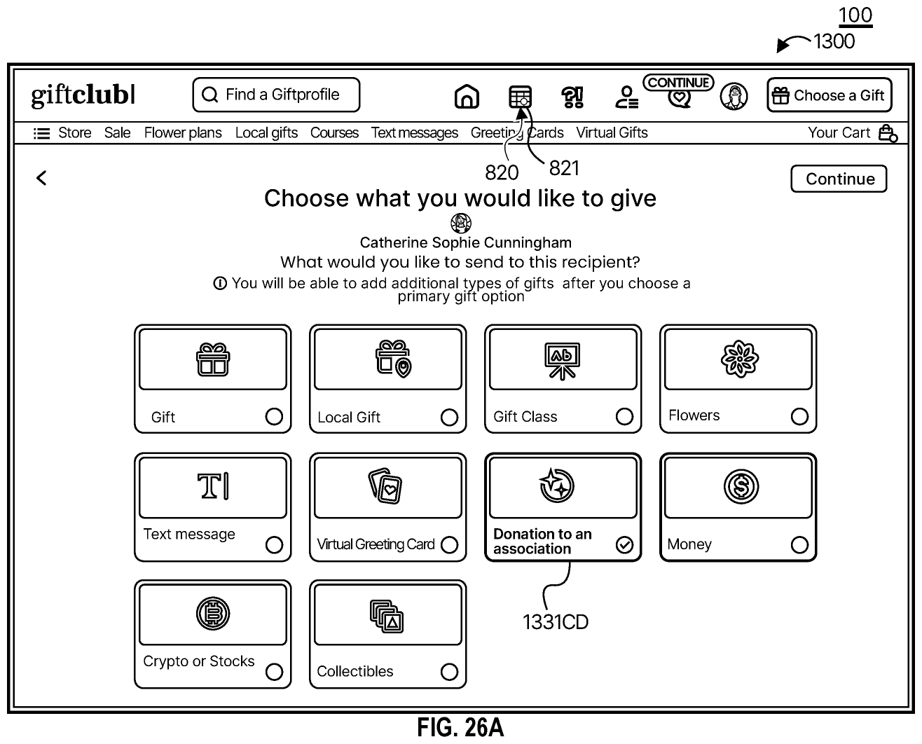

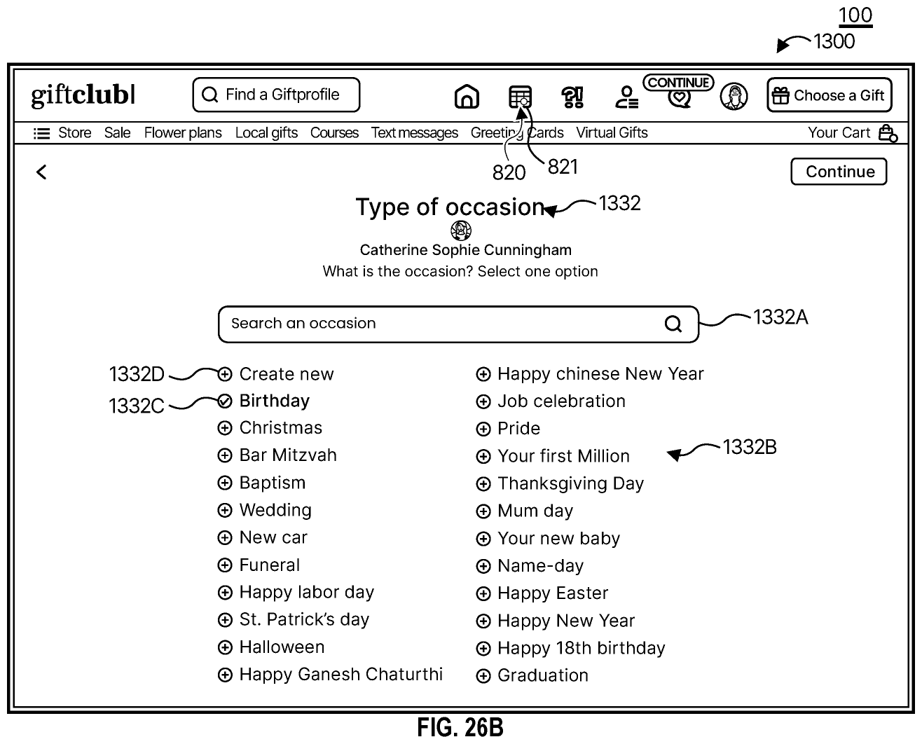

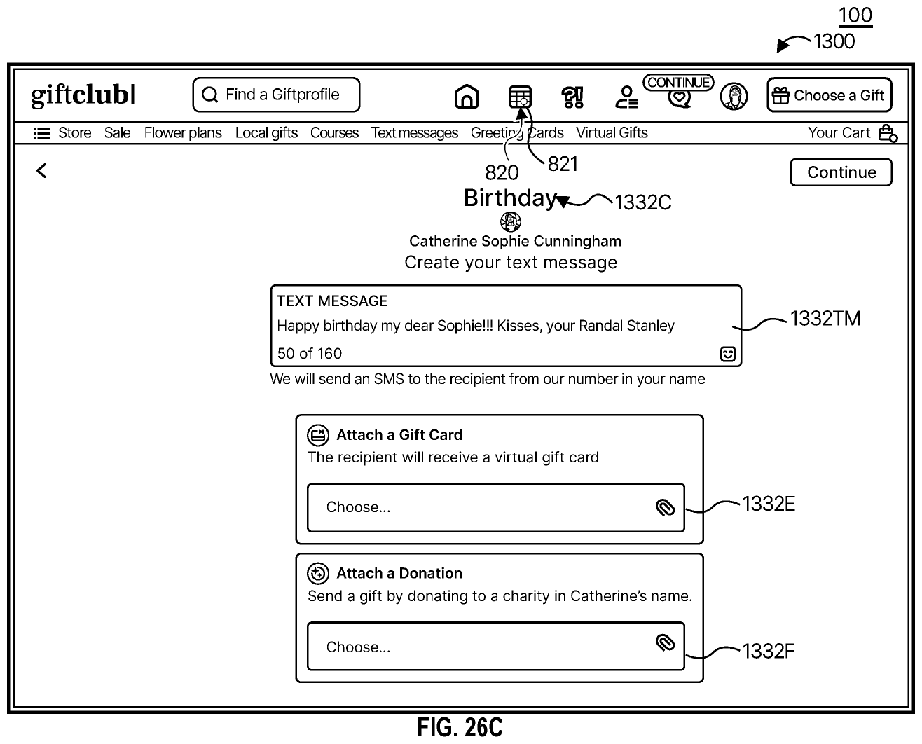

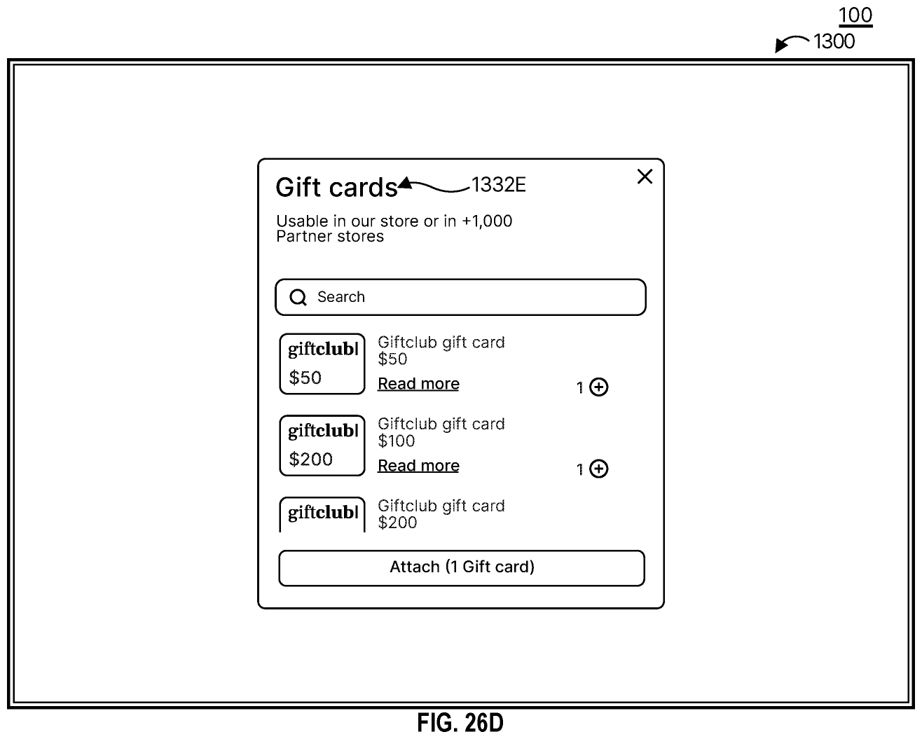

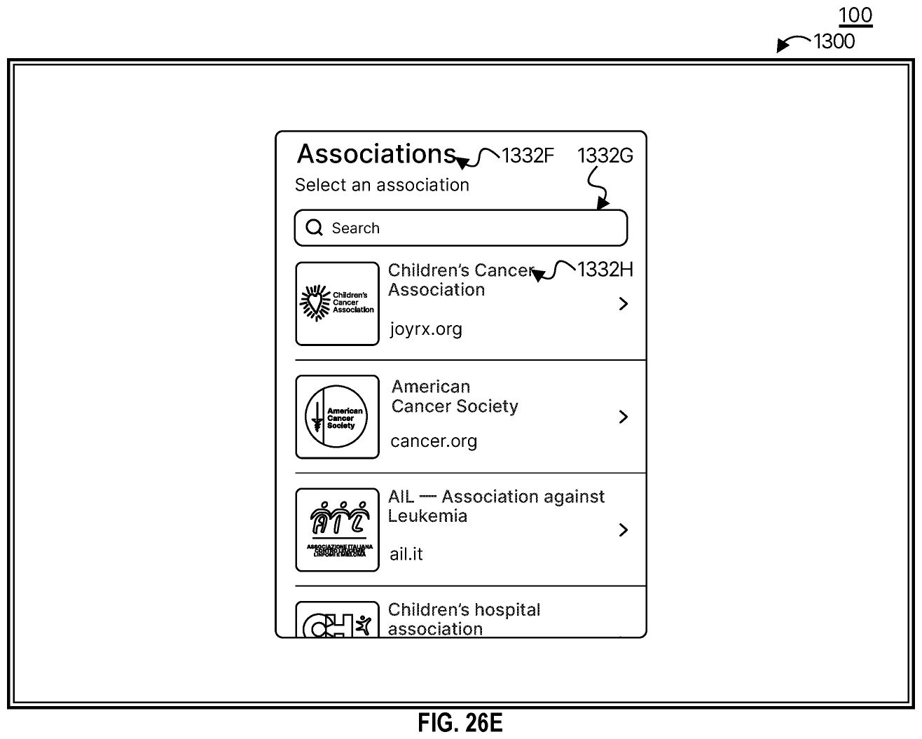

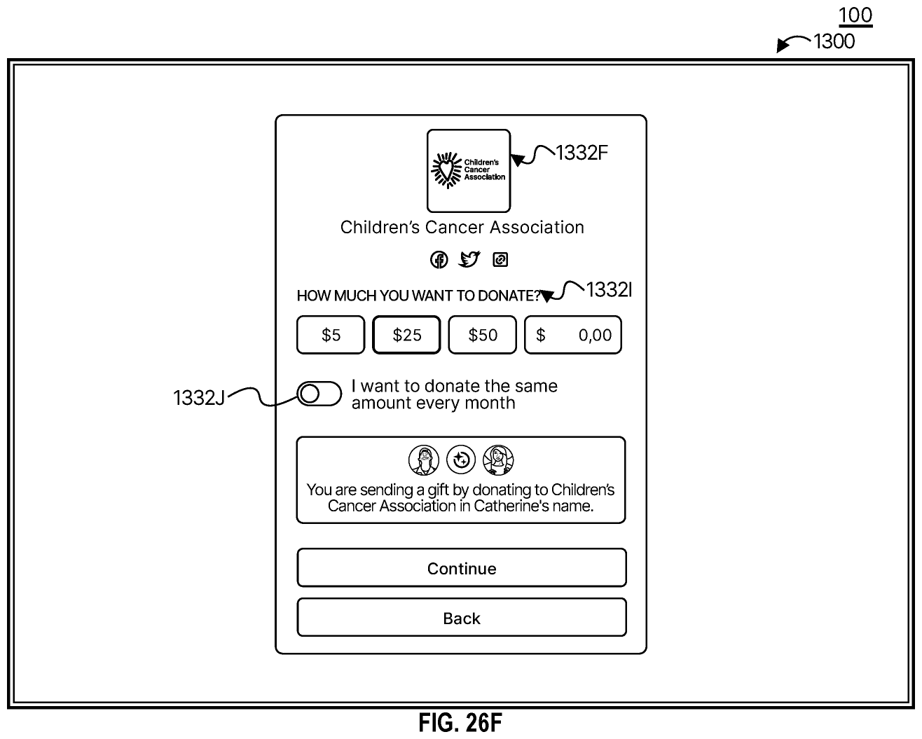

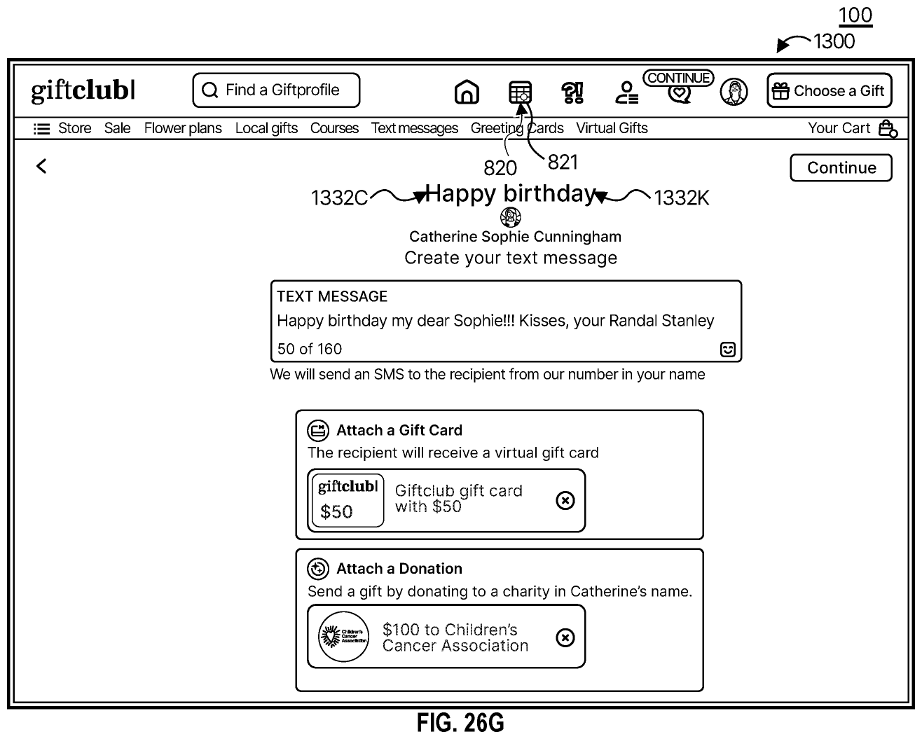

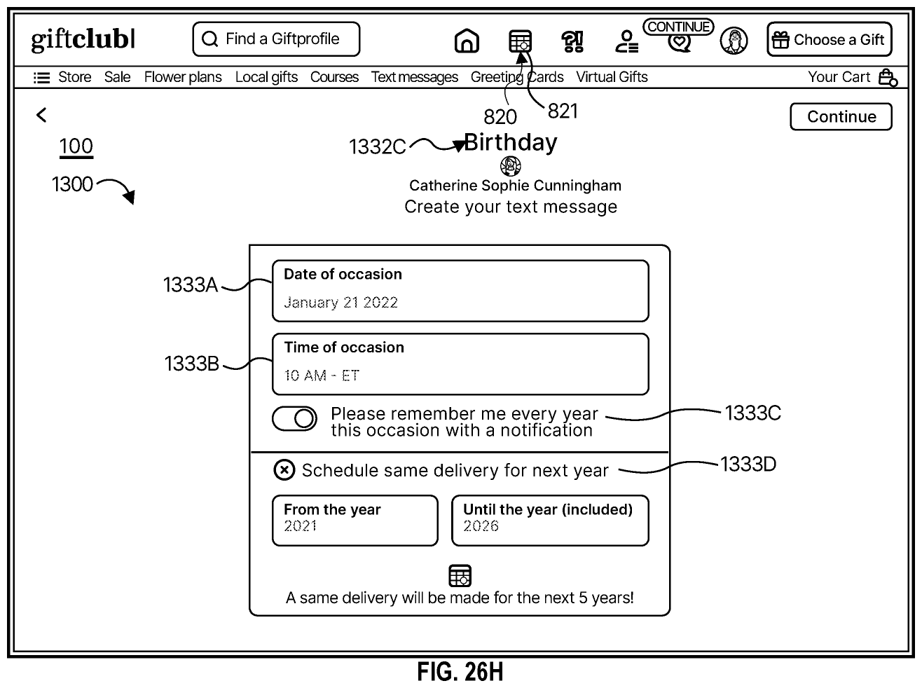

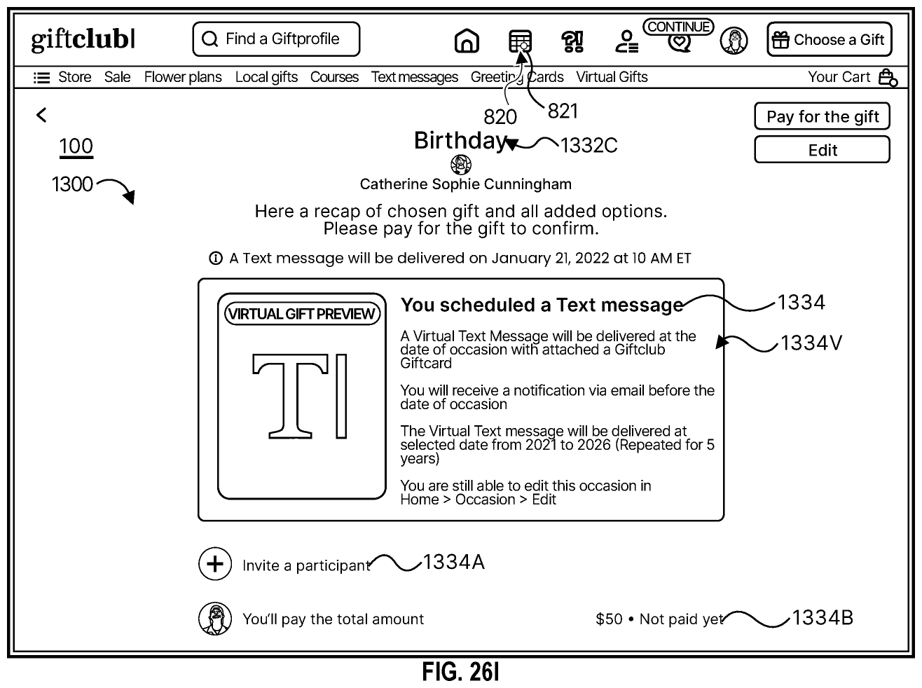

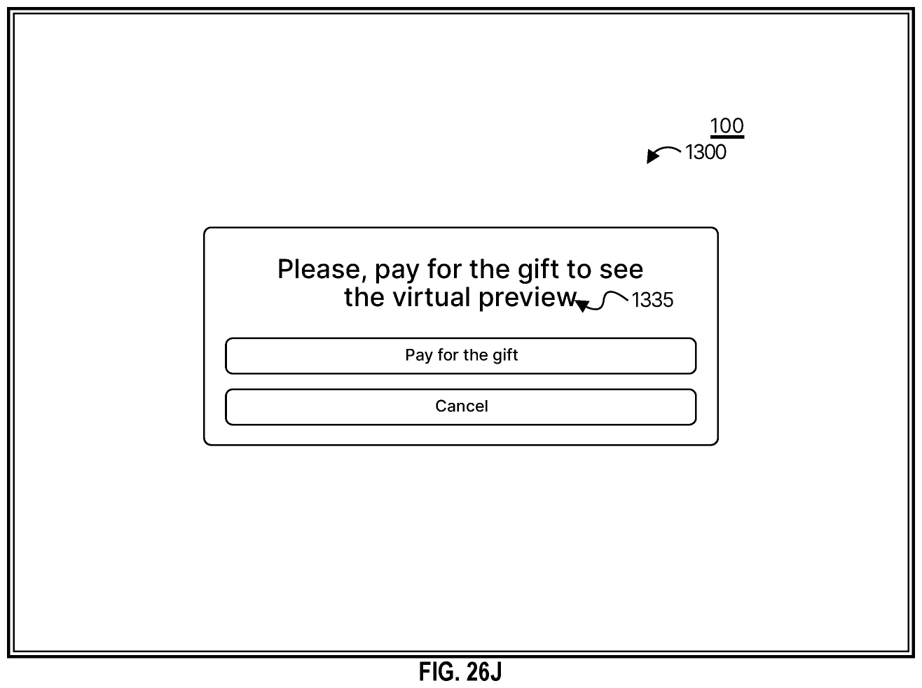

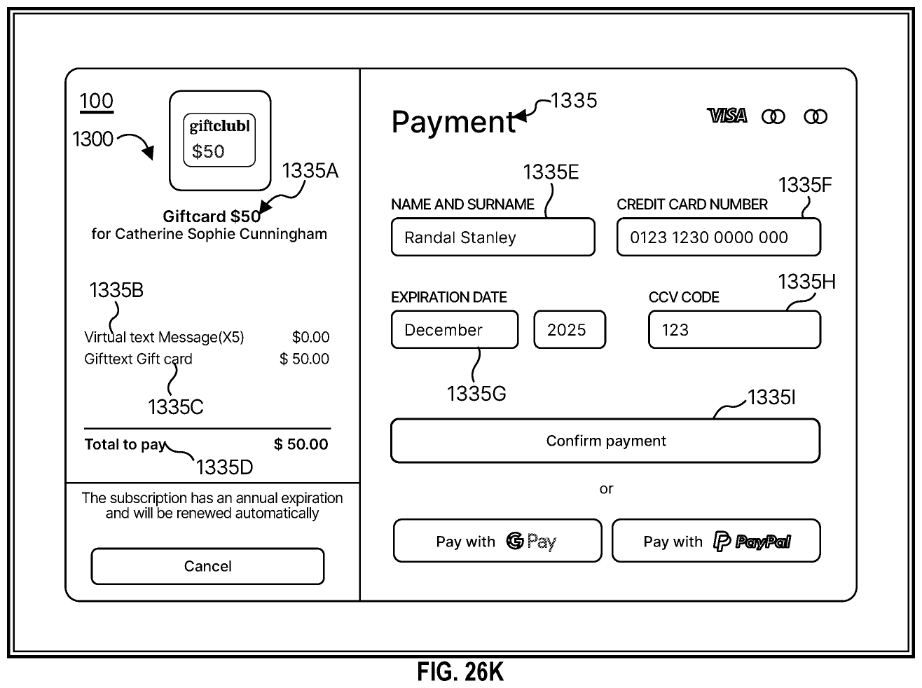

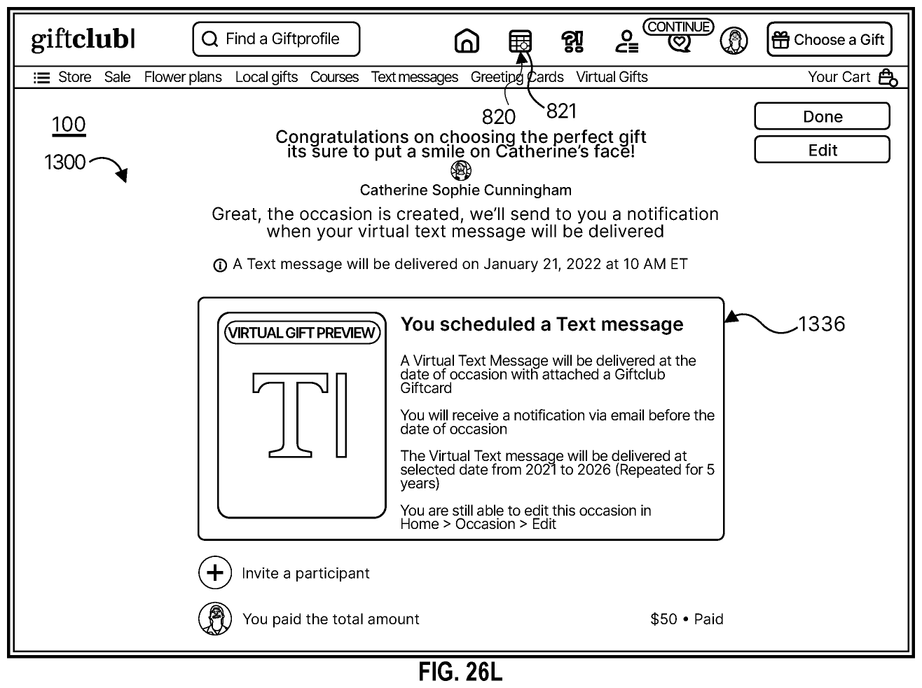

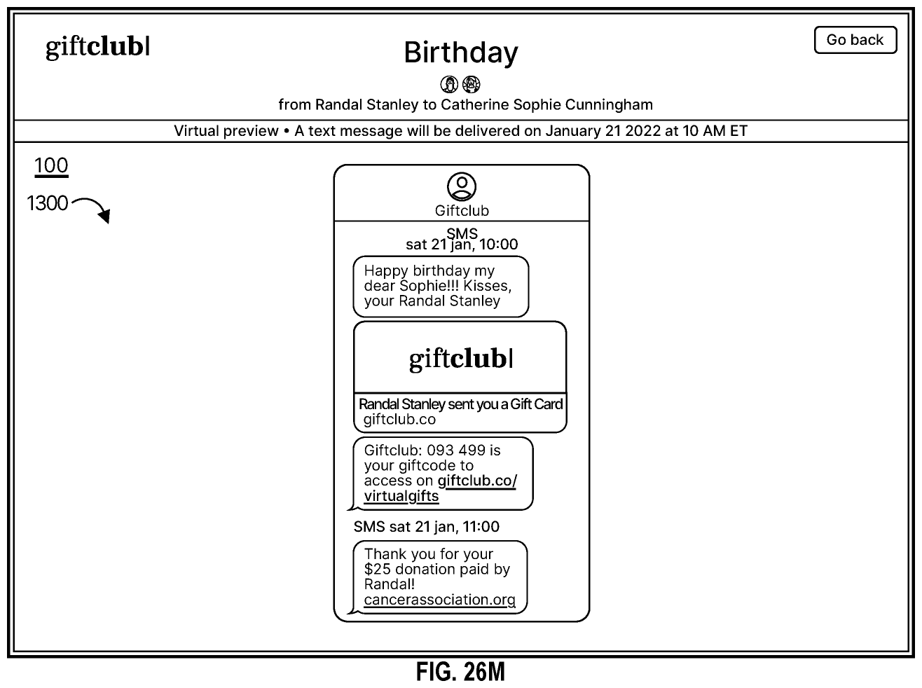

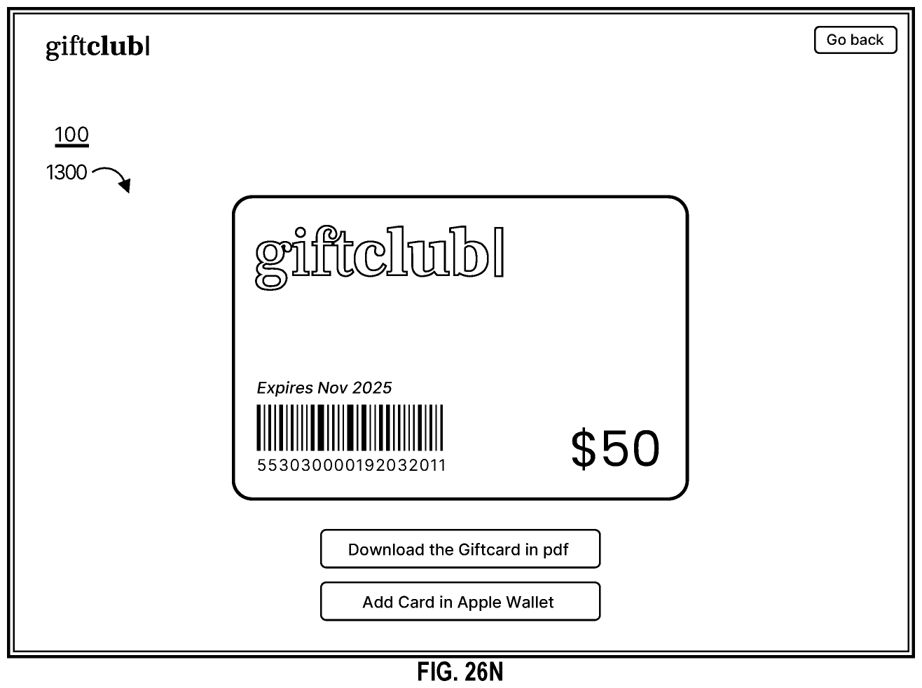

Turning to FIG. 26A, another alternative embodiment of the occasions page 1300 is illustrated when the gifter elects to send a charitable donation 1331CD to a predetermined charitable organization on behalf of (or in the name of) the selected recipient. The occasions page 1300 can enable the gifter to identify an occasion type 1332 for the new occasion for which the charitable donation will be made as shown in FIG. 26B. The gifter, for example, can search for an appropriate occasion type 1332, at 1332A, from among a plurality of preselected occasion types. Additionally and/or alternatively, the gifter can select the occasion type 1332 from an occasion type list 1332B and/or to create a new occasion type 1332D for the new occasion 1320. The gifter thereby can select an appropriate occasion type 1332C for the new occasion. In the manner set forth above with reference to FIG. 14C, the occasions page 1300 can enable the gifter to enter a textual message 1332TM and optionally to attach a gift card 1332E to the text message 1331A as illustrated in FIGS. 26C-D.

Advantageously, the occasions page 1300 can permit the gifter to include a charitable donation 1332F with the textual message 1332TM. As shown in FIG. 26E, for example, the occasions page 1300 can enable the gifter to search for an appropriate charitable organization (or association), at 1332G, and/or to select the appropriate charitable organization from among a listing 1332H of one or more preselected charitable organizations. The occasions page 1300 likewise can permit the gifter to indicate an amount of money to be charitably donated to the selected charitable organization. The gifter, for example, can select or otherwise enter a charitable donation with a predetermined monetary amount, at 13321, and/or authorize a periodic charitable donation in the predetermined monetary amount, at 1332J, as illustrated in FIG. 26F.

Turning to FIG. 26G, the occasions page 1300 can include a text message with charitable donation confirmation page 1332K. The occasions page 1300 of FIG. 26H can enable the gifter to set an occasion date 1333A and/or occasion time 1333B for the new occasion 1320. The gifter likewise can elect to receive annual or otherwise periodic reminders about the new occasion 1320, at 1333C, and/or schedule the same text message for periodic delivery, at 1333D.

Turning to FIG. 26I, the occasions page 1300 can provide a recap information, at 1334, for the text message 1331A. The occasions page 1300 optionally can invite another recipient, at 1134A, to participate in the text message 1331A and/or remind the gifter, at 1334B, of any amount due but not yet paid. Additionally and/or alternatively, the occasions page 1300 can provide a virtual text message preview of the text message 1331A for viewing, at 1334V, via a virtual gifts and cards link 1640 (shown in FIG. 19A) of the gifter profile page 1600 (shown in FIG. 19A) and/or a recipient profile page of the selected recipient.

FIGS. 26J-K illustrate an exemplary payment page 1335 of the occasions page 1300. The payment page 1335 can confirm the text message 1331A selected by the gifter, any associated cost 1335B and/or any greeting card or other costs 1335C. A total price 1335D can be shown on the payment page 1335 for the text message 1331A. The payment page 1335 of FIG. 26K is illustrated as enabling the gifter to enter payment information. The payment information can include, but is not limited to, a gifter name 1335E, a number 1335F for a credit card, debit card or other transaction payment method associated with the gifter, an expiry date 1335G for the payment method and/or a CVV 1335H for the payment method. The payment page 1335 optionally can ask the gifter to confirm the payment, at 1335I, before submission of the payment information.

The occasions page 1300 can provide payment confirmation and scheduling information, at 1336, for the text message 1331A as illustrated in FIG. 26L. An exemplary text message 1331A and associated gift card as received by the selected recipient are illustrated in FIGS. 26M-N. A charity donation sticker or other donation indicia optionally can be attached or otherwise associated with the text message. The charitable donation can be paid to the selected charitable organization in the name of the selected recipient, and/or the selected recipient can receive a thank you message or other donation confirmation receipt message from the selected charitable organization via SMS messaging or another communication channel.

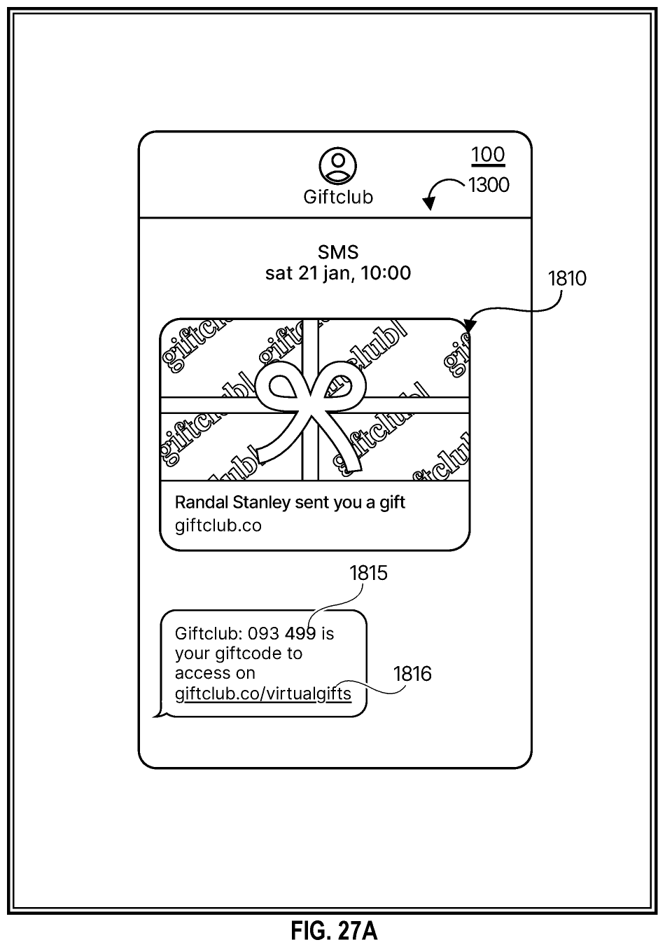

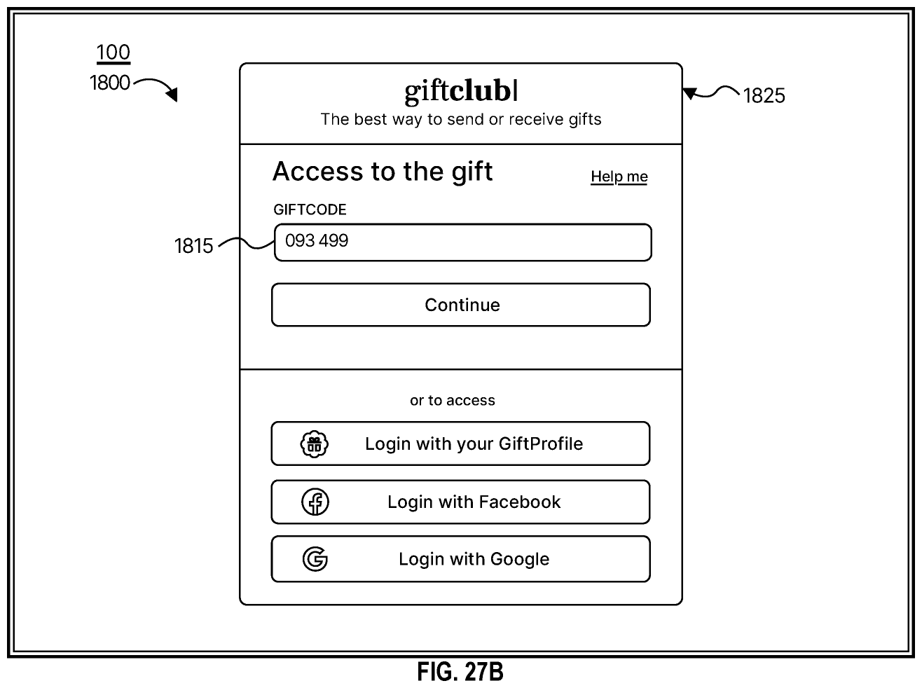

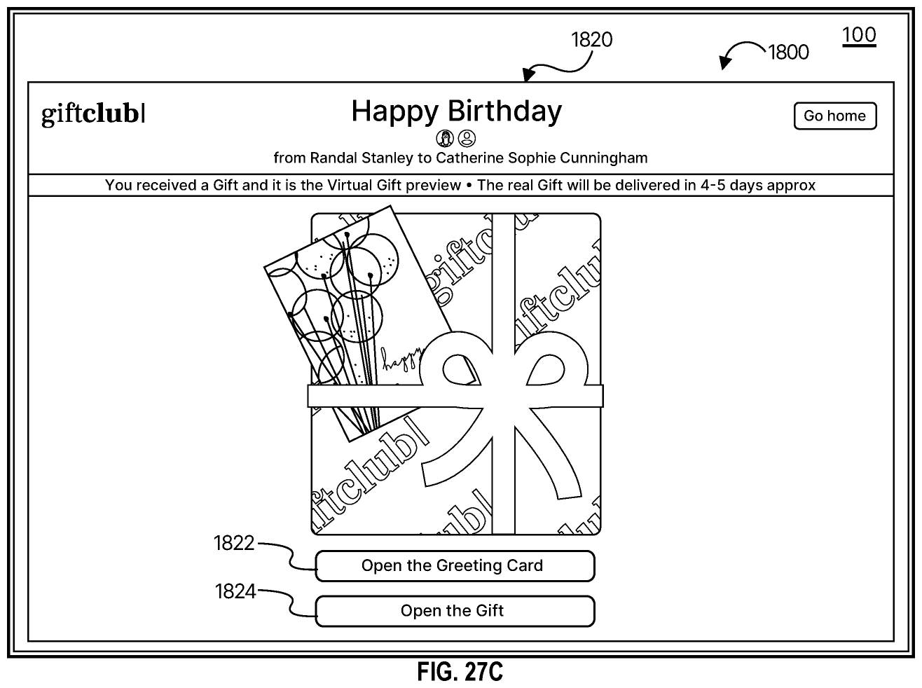

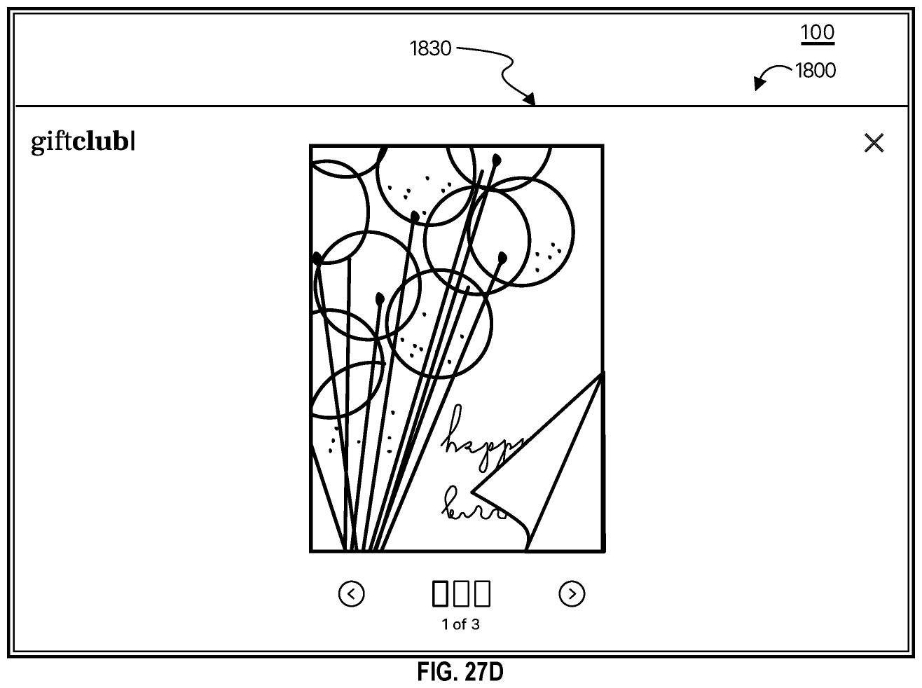

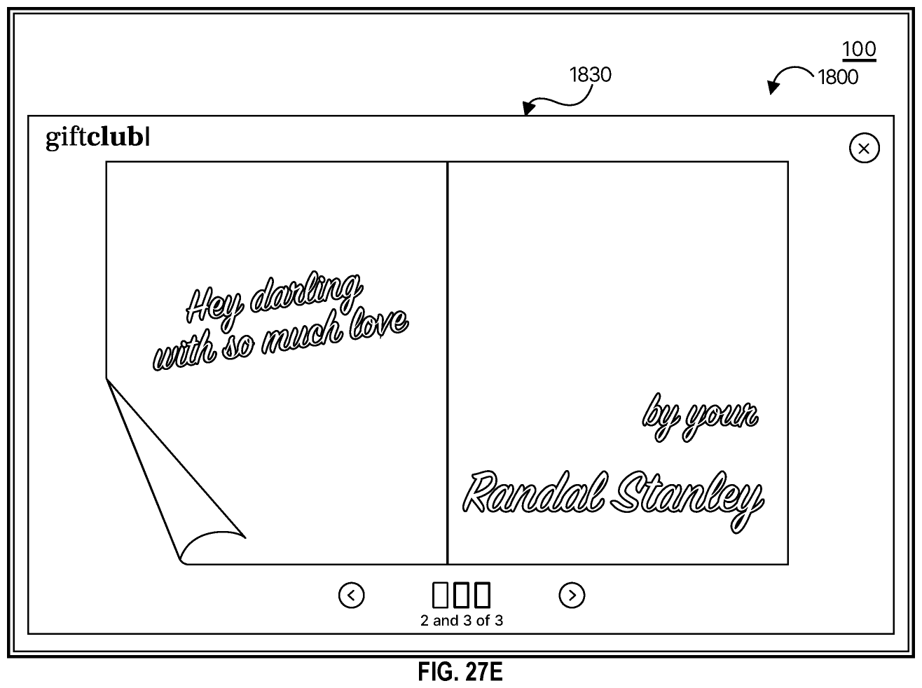

In selected embodiments, the gifting method 100 can include a gift code that is associated with a virtual gift sent to a selected recipient. The gift code can comprise any conventional type of alphanumeric or other type of code and is shown in FIGS. 27A-E as comprising a numeric gift code 1815. Turning to FIG. 27A, the gift code 1815 can be included in a text message 1810 that informs the selected recipient of the virtual gift 1820 (shown in FIG. 27C). The gift code 1815 advantageously can enable the selected recipient to access the virtual gift 1820. The text message, for example, can include a preview of the virtual gift 1820 via SMS messaging or another communication channel.

The gift code 1815 can be accompanied by a virtual gift link 1816, which can be activated to access a virtual gift page 1800 (shown in FIG. 27C) of the gifting method 100.

Additionally and/or alternatively, the selected recipient can enter the gift code 1815 via a gift access page 1825 as shown in FIG. 27B to access the virtual gift page 1800. As illustrated in FIG. 27C, the virtual gift page 1800 can enable the selected recipient to access the virtual gift 1820, at 1824, and/or to access a greeting card 1830 associated with the virtual gift 1820, at 1822. In selected embodiments, the virtual gift page 1800 can enable the selected recipient to access information, such as delivery dates, exchanges and further details, associated with the virtual gift 1820. An exemplary greeting card 1830 as received by the selected recipient is illustrated in FIGS. 27D-E.

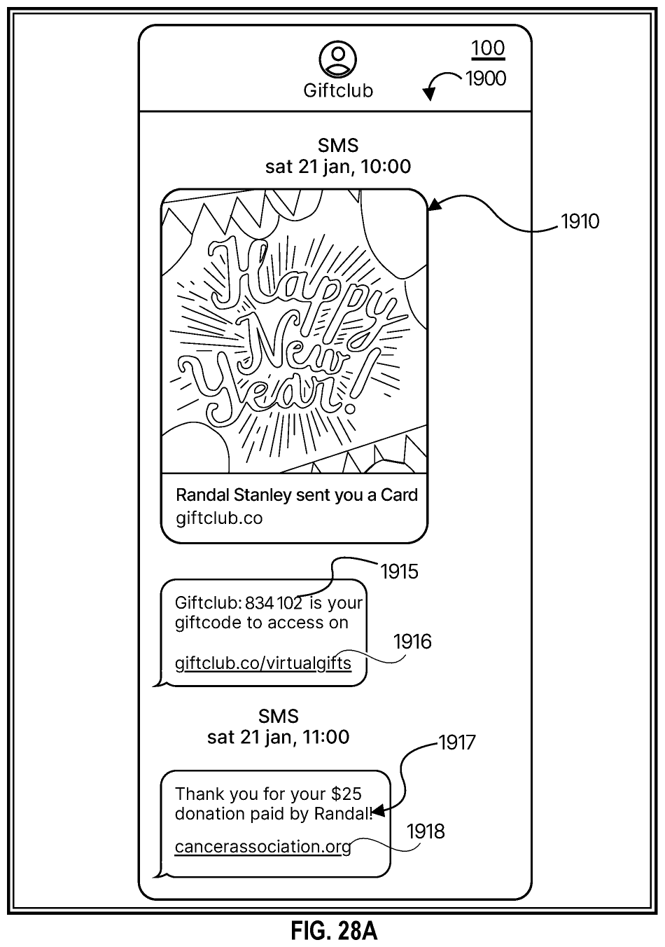

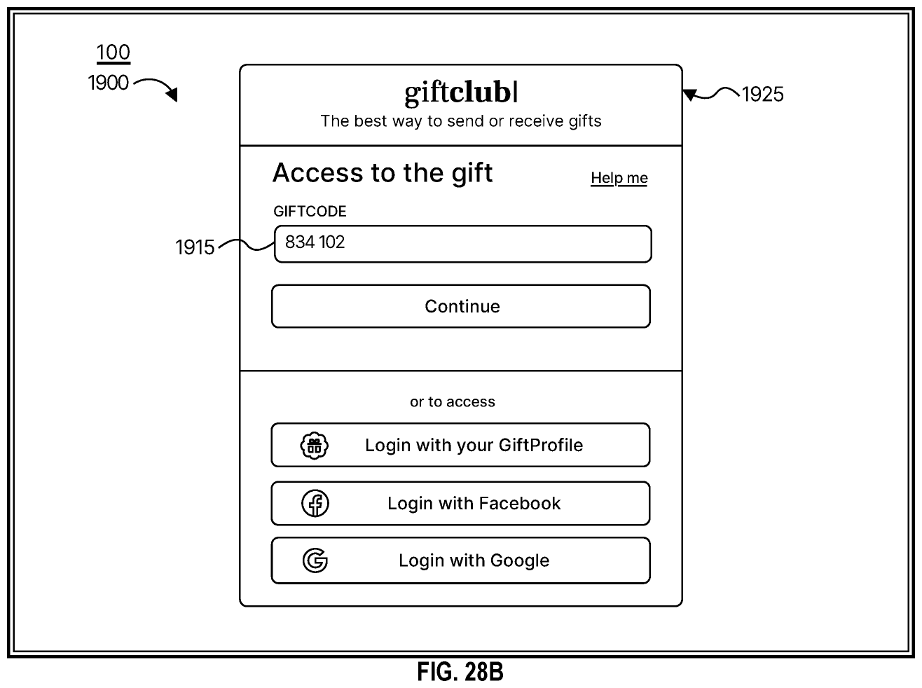

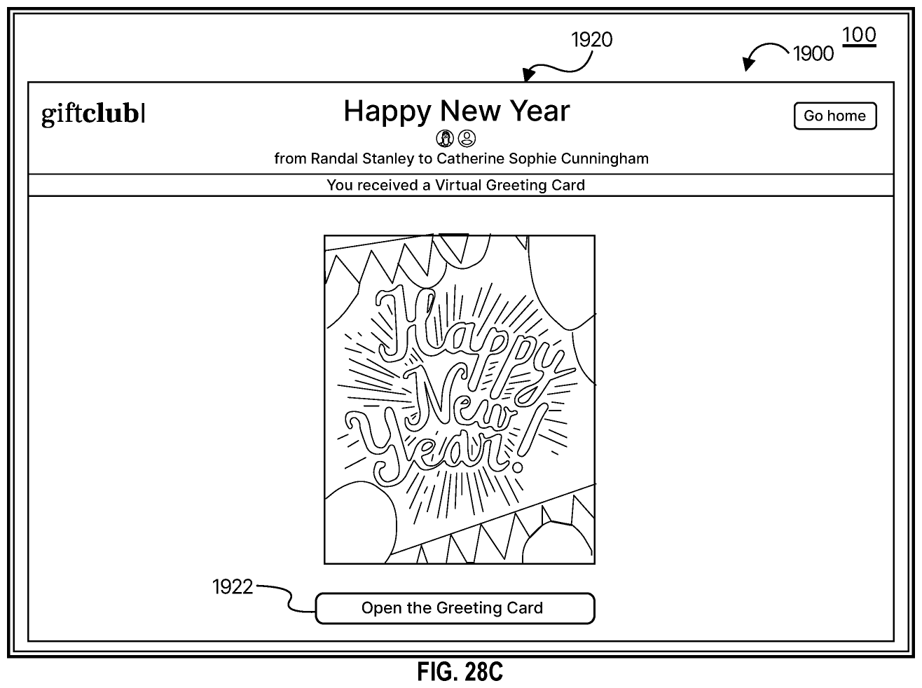

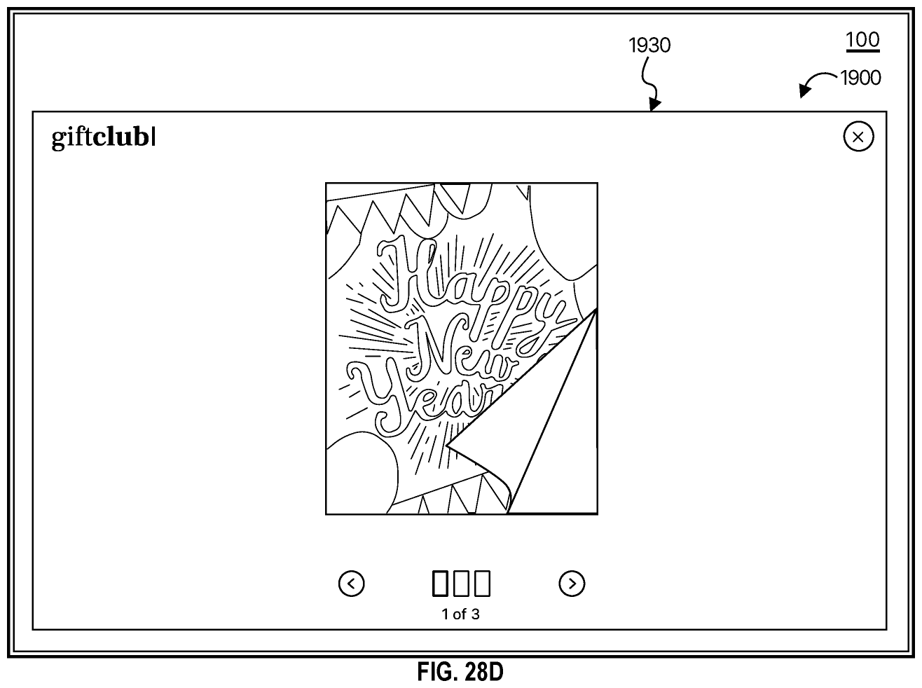

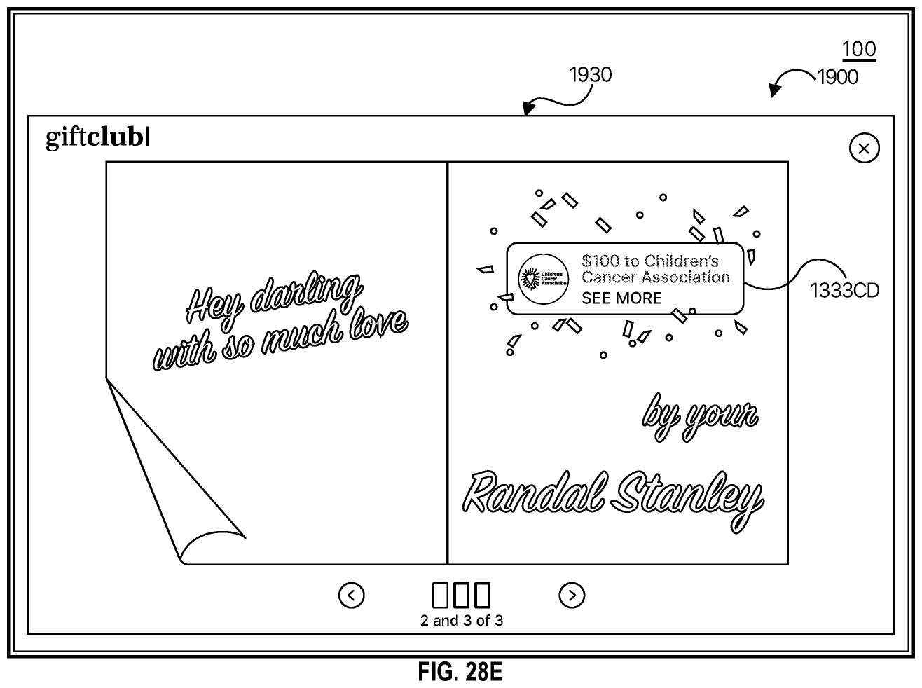

The gifting method 100 optionally can include a greeting card code that is associated with a virtual greeting card sent to a selected recipient. The greeting card code can comprise any conventional type of alphanumeric or other type of code and is shown in FIGS. 28A-E as comprising a numeric greeting card code 1915. Turning to FIG. 28A, the greeting card code 1915 can be included in a text message 1910 that informs the selected recipient of the virtual greeting card 1920 (shown in FIG. 28C). The greeting card code 1915 advantageously can enable the selected recipient to access the virtual greeting card 1920.

In the manner set forth above with reference to FIGS. 25A-P, the gifter can include a charitable donation to a charitable organization in the name of the selected recipient with the virtual greeting card. The text message 1910 of FIG. 28A is shown as including a notification 1917 with regard to the charitable donation as well as a link 1918 to a website of the charitable organization. The greeting card code 1915 can be accompanied by a virtual greeting card link 1916 to a virtual greeting card page 1900 (shown in FIG. 28C) of the gifting method 100. Additionally and/or alternatively, the selected recipient can enter the greeting card code 1915 via a virtual greeting card access page 1925 as shown in FIG. 28B to access the virtual greeting card page 1900.

As illustrated in FIG. 28C, the virtual greeting card page 1900 can enable the selected recipient to access the virtual greeting card 1920, at 1924, and/or to access a greeting card 1930 associated with the virtual greeting card 1920, at 1922. In selected embodiments, the virtual greeting card page 1900 can enable the selected recipient to access information, such as delivery dates, exchanges and further details, associated with the virtual greeting card 1920. An exemplary virtual greeting card 1930 as received by the selected recipient is illustrated in FIGS. 28D-E. The exemplary virtual greeting card 1930 is shown as including a charity donation sticker or other donation indicia 1333CD in the manner shown and described in more detail above with reference to FIGS. 25N-P.

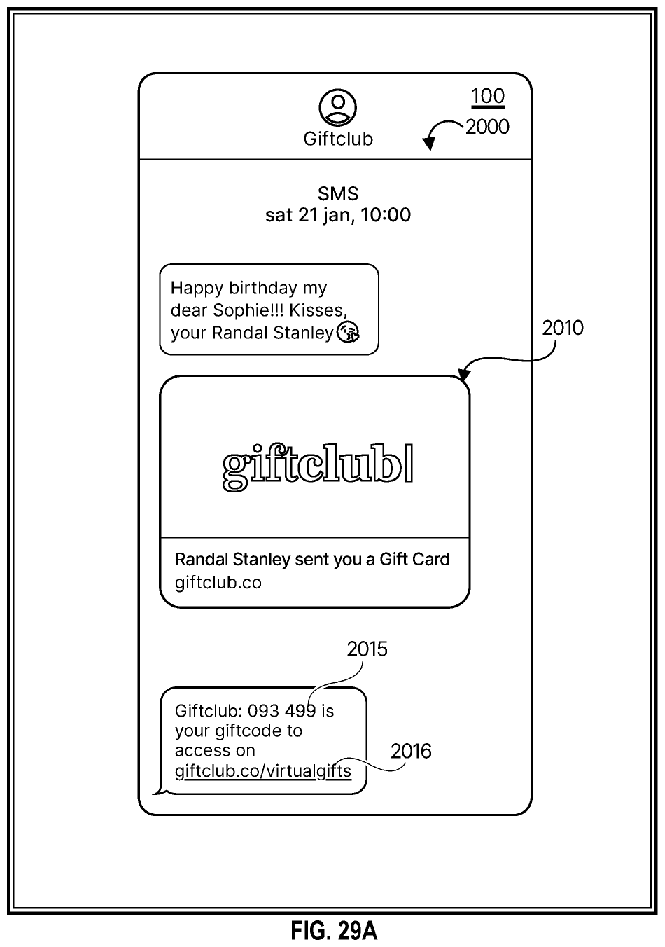

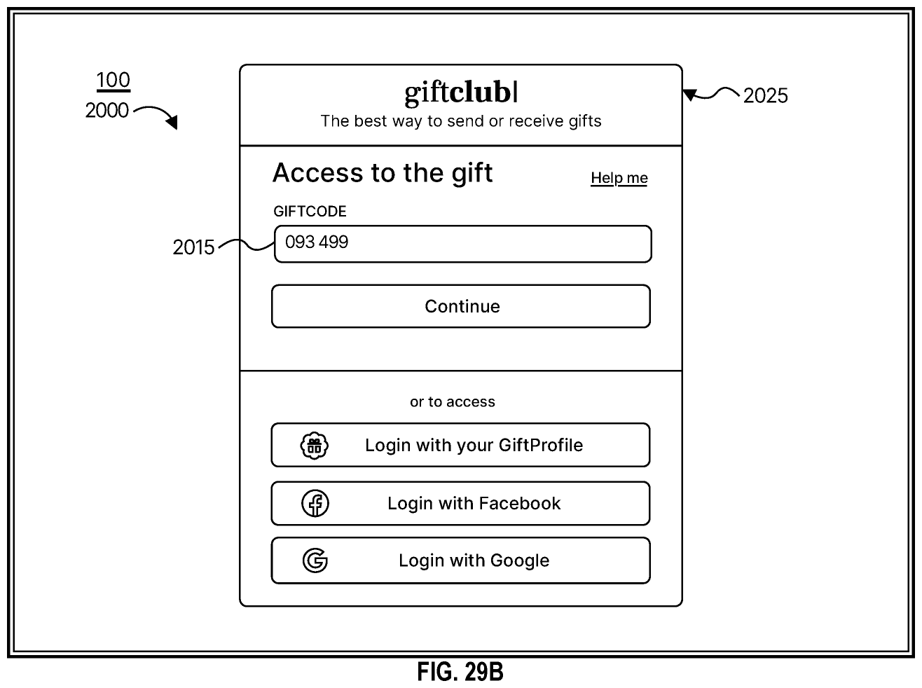

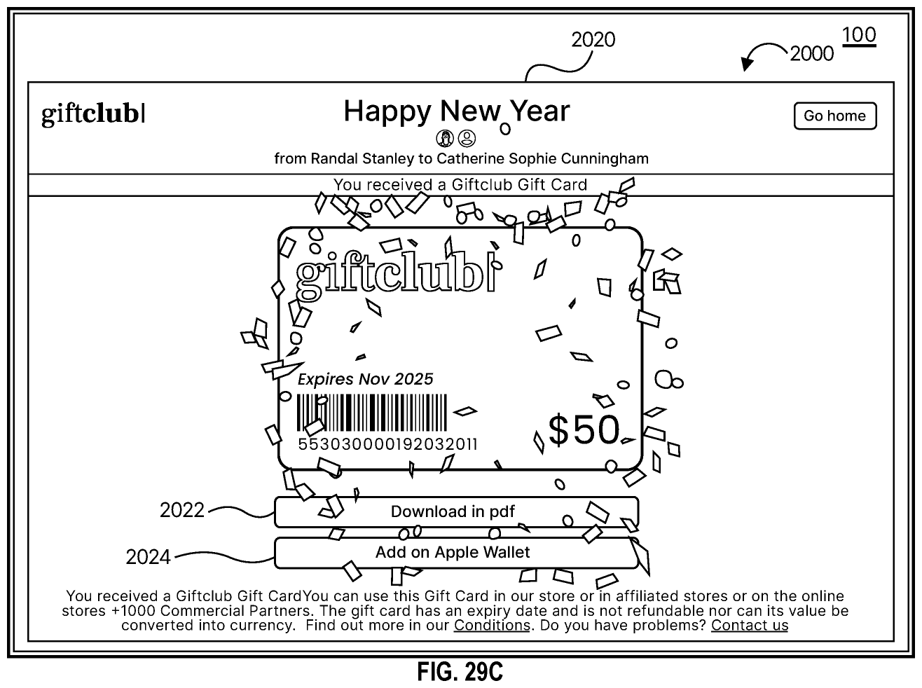

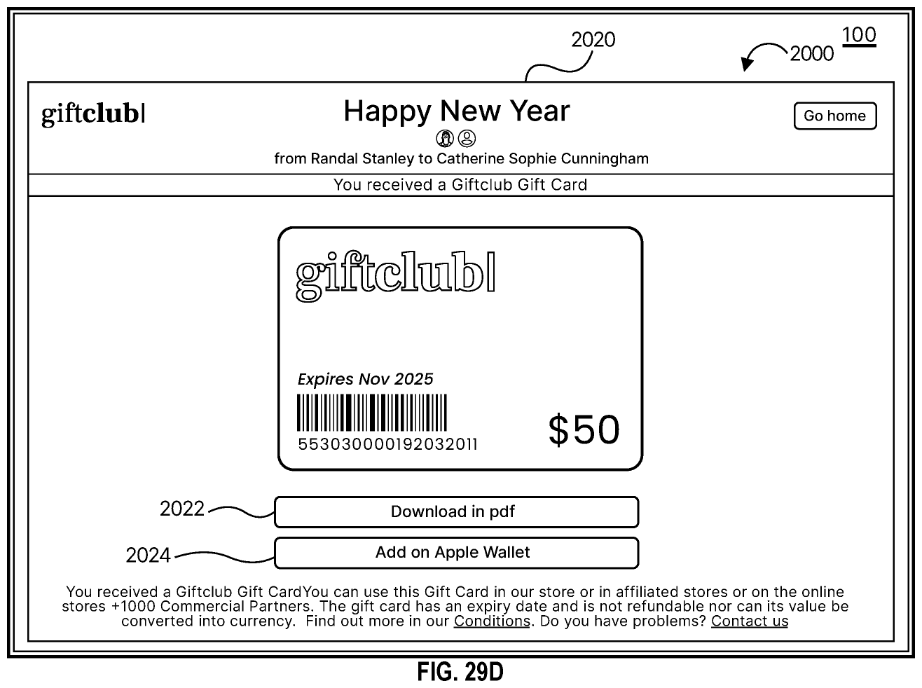

In selected embodiments, the gifting method 100 can include a gift card code that is associated with a gift card sent to a selected recipient. The gift card code can comprise any conventional type of alphanumeric or other type of code and is shown in FIGS. 29A-D as comprising a numeric gift card code 2015. Turning to FIG. 29A, the gift card code 2015 can be included in a text message 2010 that informs the selected recipient of the gift card 2020 (shown in FIG. 29C). The gift card code 2015 advantageously can enable the selected recipient to access the gift card 2020. The text message, for example, can include a preview of the gift card 2020 via SMS messaging or another communication channel.

The gift card code 2015 can be accompanied by a gift card link 2016, which can be activated to access a gift card page 2000 (shown in FIG. 29C) of the gifting method 100. Additionally and/or alternatively, the selected recipient can enter the gift card code 2015 via a gift card access page 2025 as shown in FIG. 29B to access the gift card page 2000. As illustrated in FIG. 29C, the gift card page 2000 can enable the selected recipient to download the gift card 2020, at 2022, and/or to apply a balance of the gift card 2020 to an Apple Wallet or other payment device, at 2024. An exemplary greeting card 2030 as received by the selected recipient is shown in FIGS. 29C-D.

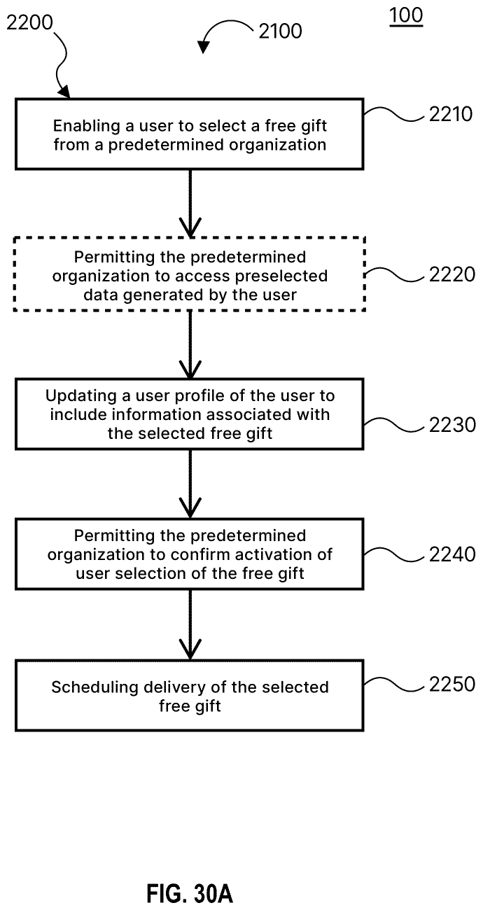

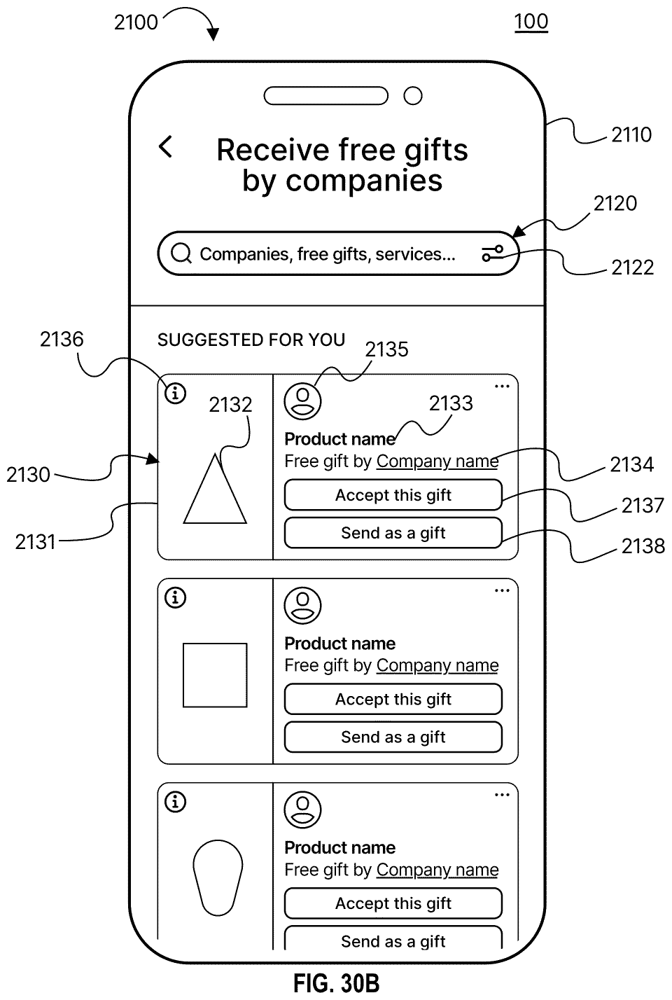

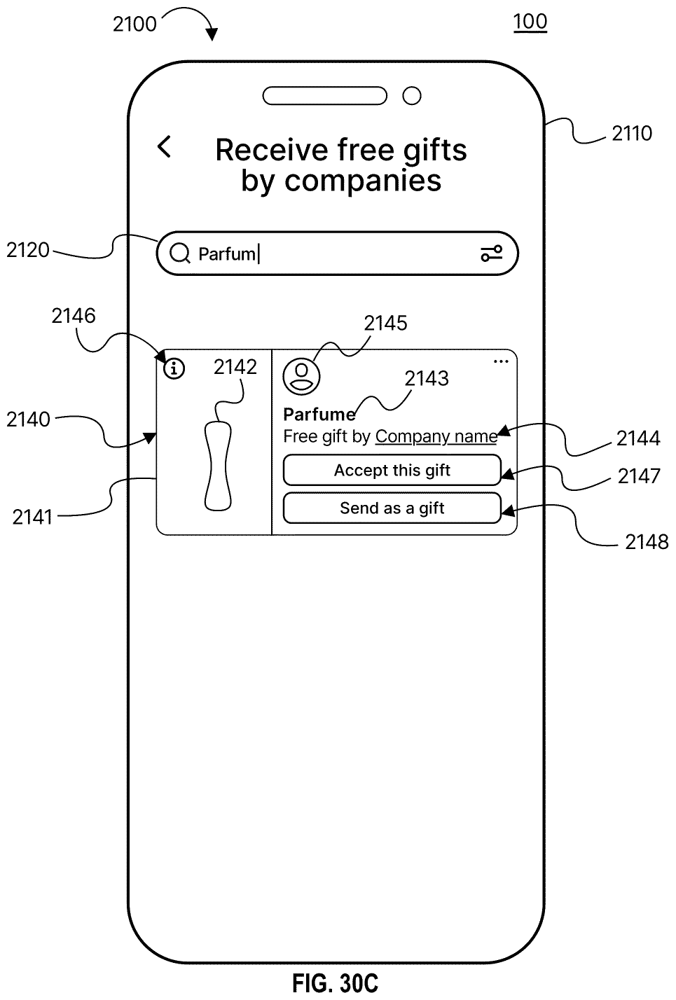

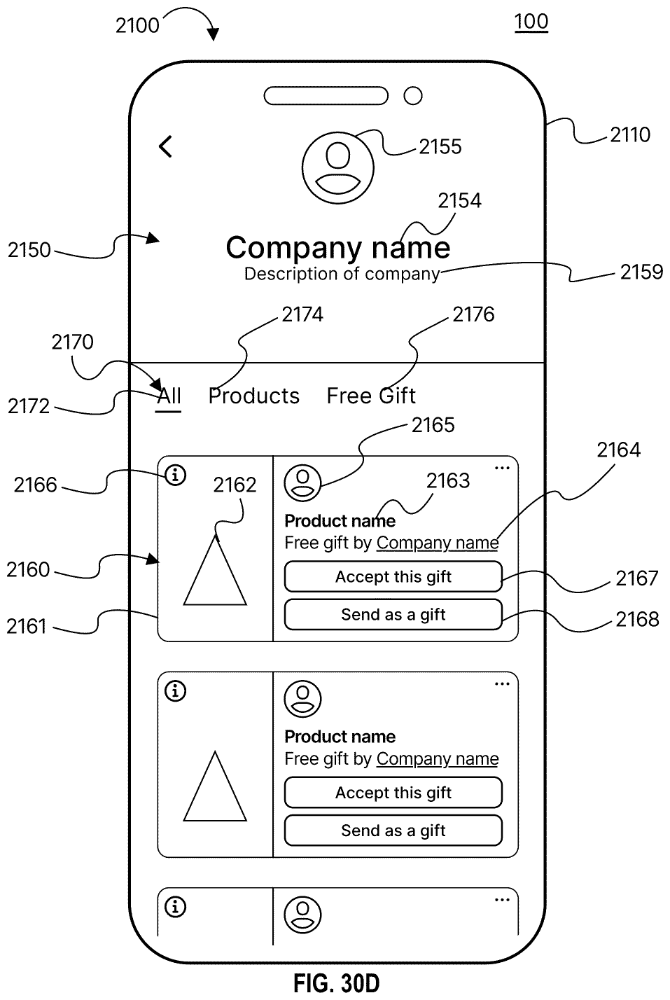

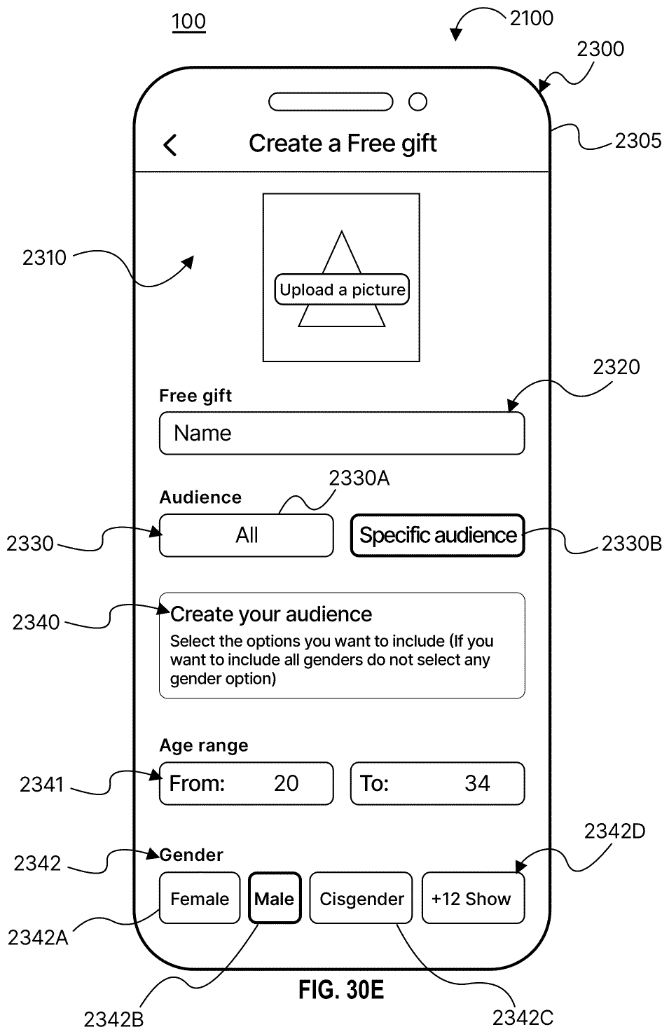

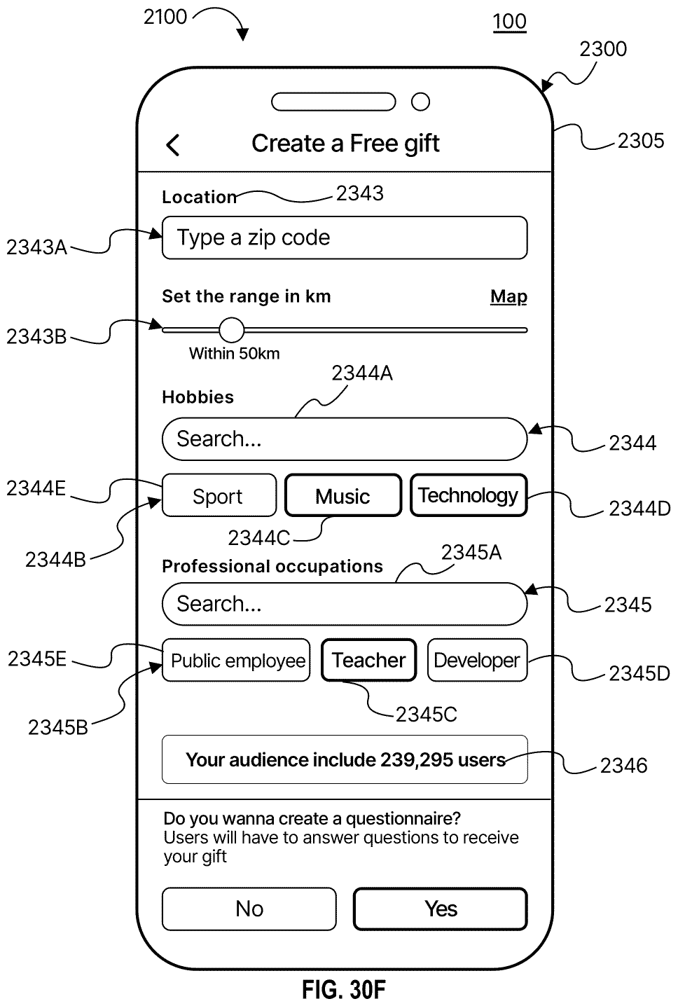

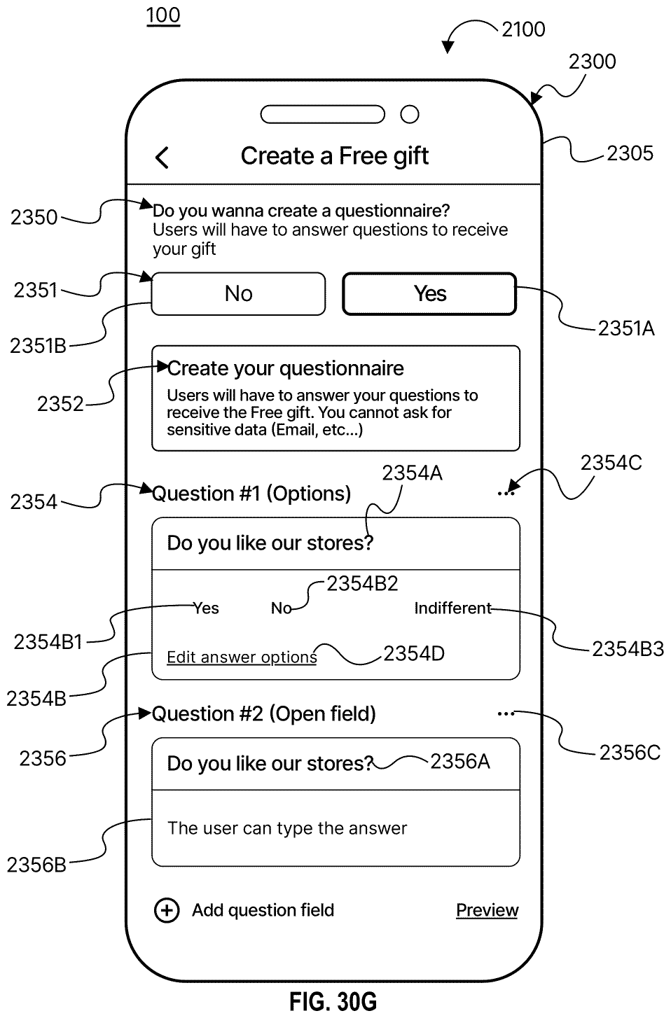

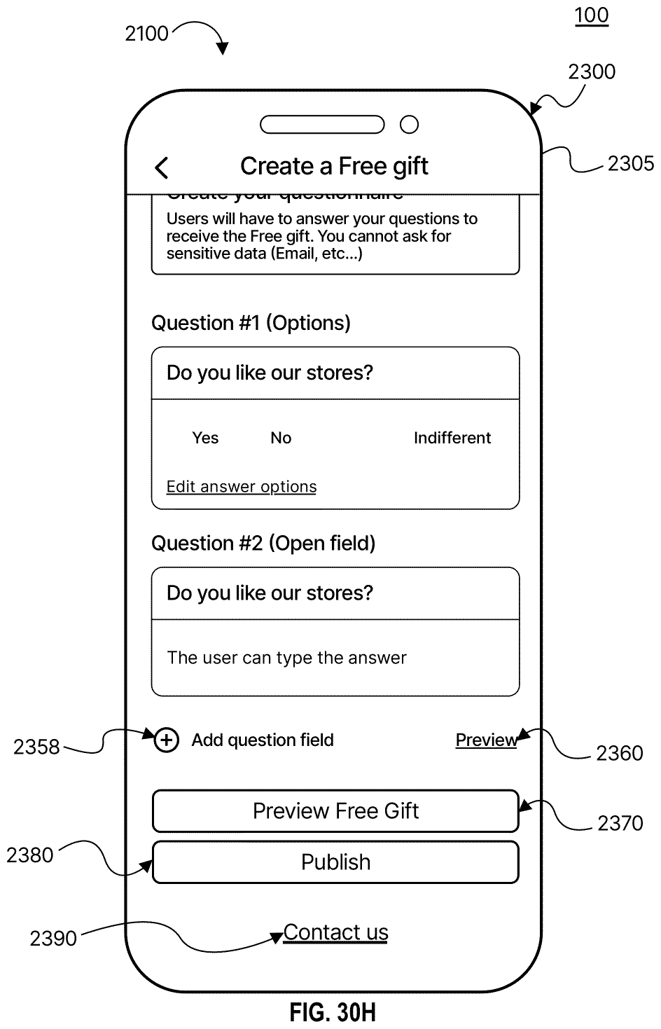

In selected embodiments, the gifting method 100 advantageously can include an optional free gift feature. An exemplary embodiment of the free gift feature 2100 is shown and described herein with reference to FIGS. 30A-H. The free gift feature 2100 can enable a gifter or other user to receive a free gift via the gifting method 100. Exemplary free gifts can comprise, but are not limited to, physical gifts, digital gifts, virtual gifts, and/or discount codes. The free gift can include a product and/or a service, without limitation. Additionally and/or alternatively, the free gift can be offered as a part of an advertising campaign. Stated somewhat differently, the free gift can become advertising or otherwise comprise an advertisement.

FIG. 30A shows an exemplary method 2200 for implementing the free gift feature 2100. Turning to FIG. 30A, the method 2200 can include, at 2210, enabling the gifter or other user to select a free gift from a predetermined company, organization, vendor or other source for free gifts. The gifter, for example, can be associated with a gifter profile in the manner shown and described above with reference to FIGS. 2A-G. In other words, the gifter can enter and/or maintain the gifter profile.

The gifter thereby can include one or more items of personal information, one or more items of preference information and one or more items of other information in the gifter profile. The gifter can enter preference information, for instance, in response to one or more preference quiz pages 320 (shown in FIG. 3B) in the manner set forth above with reference to FIGS. 3A-L. In selected embodiments, the preference information can include at least one preference of the gifter with one or more brand preferences, dietary preferences, dietary restrictions, favorite colors and/or favorite flowers, without limitation, as discussed in more detail above with reference to FIGS. 2A-G.

The method 2200 can enable the user to select a free gift, at 2210, in any suitable manner. If the gifting method 100 and/or the free gift feature 2100 comprise a software application or other computer-implemented method, the free gift feature 2100 can present a free gift notification (not shown). The free gift notification can indicate, for example, that a predetermined organization has offered to provide a free gift to the gifter. In selected embodiments, the free gift notification can identify the free gift, which optionally can be selected by the predetermined organization based upon a gifter profile of the gifter. The free gift notification can identify the selected free gift in any suitable manner, including, but not limited to, via a name of the selected free gift, a textual description of the selected free gift and/or an image of the selected free gift. Preferably, the free gift notification can include a name and other information about the predetermined organization. The free gift notification can present offers for more than one free gift for the gifter, including offers for free gifts from more than one predetermined organization.

Additionally and/or alternatively, the free gift feature 2100 can enable the gifter to browse information about the predetermined organization and/or information about the free gift. The free gift feature 2100, for example, can provide a button, link or other activatable indicia for accessing the organization or gift information. Upon activation of the activatable indicia, the gifter can search for organization profiles associated with respective organizations for free gift offers. Activation of the activatable indicia optionally can enable the gifter to directly search for available free gift offers. The free gift feature 2100 can present the search results in any suitable manner, such as via a search result list.

In selected embodiments, the gifter can search advertising content by searching for free gift offers. The gifter can interact with the advertising content in any suitable manner. The free gift feature 2100, for example, can enable the gifter to interact with the advertising content via one or more data-based interactions and/or one or more research-based interactions, without limitation. For the data-based interactions, the free gift feature 2100 can connect the gifter with the predetermined organization based upon the gifter profile, including the preference information, and other information provided by the gifter. The free gift feature 2100 can present the free gift notification based upon the data-based interactions.

Additionally and/or alternatively, the free gift feature 2100 can enable the gifter to activate the activatable indicia for accessing the organization or gift information. The gifter thereby can search directly for the predetermined organization and select at least one free gift offered by the predetermined organization. Optionally, the direct search can be based upon one or more parameters being placed on the gifter profile, including the preference information, and other information provided by the gifter. The free gift feature 2100 can present the free gift notification based upon the search-based interactions.

The free gift feature 2100 thereby can enable the gifter to review the available free gifts and to select one or more of the available free gifts from the relevant predetermined organization(s). The selected free gift can comprise a physical gift, a digital gift, a virtual gift, and/or a discount code in the manner set forth above. In selected embodiments, the gifter can agree to receive the selected physical gift at a physical address associated with the gifter and/or the selected digital gift, virtual gift, and/or discount code via a link, electronic mail messaging, SMS messaging or another communication channel. The selected digital gift, virtual gift, and/or discount code then can be presented at a store or otherwise utilized to receive the selected gift.

In selected embodiments, such as a subscription model of the gifting method 100, the predetermined company, organization, vendor or other free gift source can be inhibited from accessing personal data associated with the gifter. The method 2200 optionally can include, at 2220, permitting the free gift source to access preselected data associated with the gifter or other user as shown in FIG. 30A. The preselected data preferably can include non-personal information entered by the gifter. In other words, the method 2200, at 2220, can enable the free gift source to access non-personal information generated by the gifter.

The free gift feature 2100, for example, can enable the free gift source to access aggregated (or group) information about the gifter and other users who have interacted with the advertising content. Exemplary aggregated information can include, but is not limited to, a percentage of users within a selected gender group, a percentage of users within a selected age or range of ages, a percentage of users located within a selected geographic region, a percentage of users having a preselected preference, and/or a percentage of users who have made purchases within a preselected purchase amount range. Exemplary age ranges can include, but are not limited to, a first age range below nine years of age, a second age range between ten years and sixteen years of age, and/or a third age range between seventeen years and twenty years of age.

Exemplary geographic regions can include a town, county, state and/or country, without limitation. The preselected preferences can comprise, for instance, generic preferences on a category of a selected brand. Exemplary preselected preferences can include, but are not limited, a first preference for shirts and/or a second preference for the color blue. The purchase amount ranges can be based upon average purchases users for themselves and others. Exemplary purchase amount ranges can include a first purchase amount range below ten dollars, a second purchase amount range between ten dollars and one hundred dollars, and/or a third purchase amount range between one hundred and ten dollars and two hundred dollars, without limitation.

Additionally and/or alternatively, the free gift feature 2100 as a premium service can permit the free gift source to access individualized data associated with the gifter. The free gift feature 2100, for example, can provide an email address, telephone number and/or demographic information of the gifter to the free gift source. Providing the free gift source with access to the individualized data associated with the gifter preferably is preauthorized via a user agreement executed by the gifter and/or is a condition of the free gift offer.

The method 2200 is shown in FIG. 30A as comprising, at 2230, updating the gifter profile of the gifter to include information associated with the selected free gift. Exemplary free gift information can include a brand name of the selected free gift, a color of the selected free gift, and/or a gift type of the selected free gift, without limitation. In selected embodiments, the method 2200, at 2230, can automatically incorporate the free gift information into the preference information within the gifter profile of the gifter. The free gift information, for example, can be incorporated into the preference information within the gifter profile in the same manner as if the free gift information were entered by the gifter. By including the free gift information in the gifter profile, the free gift feature 2100 can present advertising content associated with the free gift source. The gifting method 100, in other words, can increase an amount of advertising content from the free gift source that is presented to the gifter.

At 2240, the method 2200 can permit the predetermined organization to confirm that the gifter has selected the free gift. Stated somewhat differently, the predetermined organization can confirm activation of the gifter's selection of the free gift. If the free gift is part of an advertising campaign, for example, the method 2200 can associate the free gift with a free gift advertising package, and the predetermine organization can confirm that the free gift advertising package has been activated.

The free gift advertising package can include highlighting one or more products and/or services associated with the predetermined organization. In selected embodiments, products and/or services associated with the predetermined organization can be highlighted for a predetermined time period. Exemplary predetermined time periods can include a day, a week and/or a month, without limitation.

The highlighted products and/or services, for example, can be associated with a selected brand of the predetermined organization and/or can be listed in a relevant product and/or service category, such as the category of gifts discussed in more detail above, of the gifting method 100. Additionally and/or alternatively, the free gift advertising package can suggest the selected brand of the predetermined organization to a user when utilizing the gifting method 100 to send a gift to the gifter. The gifting method 100 optionally can enable the predetermined organization to choose which products and/or services are to be highlighted.

In selected embodiments, the free gift advertising package can include highlighting one or more products and/or services associated with the predetermined organization in the preference quiz pages 320 in the manner set forth above with reference to FIGS. 3A-L, in a banner advertisement (not shown) and/or on the home page 800 (shown in FIG. 8) for the gifting method 100. The free gift feature 2100 optionally can enable the predetermined organization to choose the products and/or services to be highlighted. Additionally and/or alternatively, the free gift advertising package can include the premium service as set forth above. The premium service can permit the predetermined organization to access individualized data associated with the gifter. The predetermined organization can have access to the personal information, the preference information or other information of the gifter. The individualized data of the gifter, for example, can be drawn from the gifter profile in the manner discussed herein.

The selected free gift can be scheduled for delivery to the gifter, at 2250. The predetermined organization, for example, can initiate delivery of the selected free gift to the gifter in any suitable manner. In manner discussed above, the gifter can agree to receive the selected physical gift at a physical address associated with the gifter and/or the selected digital gift, virtual gift, and/or discount code via a link, electronic mail messaging, SMS messaging or another communication channel. The selected digital gift, virtual gift, and/or discount code then can be presented at a store or otherwise utilized to receive the selected gift. The predetermined organization thereby can reach the gifter as a part of an advertising campaign.

In selected embodiments, the free gift feature 2100 can enable each company, organization, vendor or other gift source to create an appropriate seller profile. The predetermined organization, for example, can create an organization profile. The predetermined organization can create the organization profile in any suitable manner in any suitable manner, such as in the manner discussed herein by which the gifter can create the gifter profile, and can designate the predetermined organization as a seller or other type of vendor. The organization profile can include an image associated with the predetermined organization, a textual description of the predetermined organization and/or contact information, such as a link to a relevant social network, for the predetermined organization, without limitation.

The predetermined organization optionally can include information about its products and/or services in the organization profile. The information can include, but are not limited to, a category, a price, a brand and/or other properties of each relevant product and/or service. In selected embodiments, the product and/or service information can include an image associated with the product and/or service, a textual description of the product and/or service, and/or reviews of the product and/or service, without limitation.

Each organization (or seller) profile can be linked with the gifting method 100. The products and/or services set forth in the organization profiles thereby can be added to, and/or presented by, the gifting method 100. In selected embodiments, the products and/or services set forth in the organization profiles can be presented based upon the product and/or service properties included in the organization profile. The products and/or services, for example, can be presented based upon the category, the price, the brand and/or the other properties of the products and/or services and can be available for sale via the gifting method 100. The gifter thereby can purchase one or more of the presented products and/or services as a gift for a selected gift recipient, which optionally can include the gifter, in the manner discussed in more detail above.

The organization profile can be associated with a management cost for the predetermined organization. The management cost can comprise a fixed management cost and/or a variable management cost.

Additionally and/or alternatively, the organization profile can enable the predetermined organization to provide free gifts to users of the gifting method 100. The free gifts, for example, can be a part of a real advertising campaign, such as a well-defined advertising package, supported by the free gift feature 2100. Exemplary advertising campaigns can include, but are not limited to, the free gift advertising package discussed above.

In the manner discussed above, after the gifter selects a free gift from the predetermined organization, the products and/or services associated with the free gift can be highlighted. The products and/or services associated with the free gift, for example, can be presented as suggested products and/or services via the preference quiz pages 320 (shown in FIGS. 3A-L). Additionally and/or alternatively, the products and/or services associated with the free gift can comprise suggested gifts for friends of the gifter and/or presented via a banner advertisement and/or on the home page 800 for the gifting method 100.

The free gift feature 2100 advantageously can provide numerous benefits for each company, organization, vendor or other gift source. Exemplary benefits can include, but are not limited to, brand visibility, cross advertising, positive brand association, reaching gifters and other users of the gifting method 100 with purchase suggestions, reaching real gifters and other users of the gifting method 100 for future sales, direct user interaction with the brand, general data about reached gifters and other users of the gifting method 100, opportunity to sell additional related products, conversations about the brand resulting from viral features, and/or direct sales via a store of the gifting method 100. The free gift feature 2100 optionally can offer a faster sales checkout process with easy address and/or payment management. Additionally and/or alternatively, selected gifts can be branded in a virtual gift space of the gifter or other user of the gifting method 100.

If the gifting method 100 and/or the free gift feature 2100 comprise a software application or other computer-implemented method, the gifting method 100 can present one or more free gift pages 2110 for enabling the gifter or other user to select the free gift from the free gifts source, at 2210. Stated somewhat differently, the free gift pages 2110 can comprise at least one dedicated page for permitting the gifter to select a free gift available from the predetermined organization or other free gifts source for delivery.

Exemplary free gift pages 2110 are shown in FIGS. 30B-D. Turning to FIG. 30B, the free gift search feature 2120 is illustrated as present a listing 2130 of one or more suggested free gifts 2131 for the gifter. Each listed suggested free gift 2131 is shown as being presented with a photograph or other image 2132 of the suggested free gift 2131 and/or a product (or service) name 2133 of the suggested free gift 2131. A name 2134 and/or a logo, photograph or other image 2135 associated with the free gift source of the suggested free gift 2131 optionally can be presented with the listed suggested free gift 2131.

Each listed suggested free gift 2131, in selected embodiments, can be associated with an information feature 2136. The information feature 2136 can provide additional information about the suggested free gift 2131. For example, the additional information can a basis by which the gifting method 100 and/or the free gift feature 2100 has suggested the suggested free gift 2131 for the gifter. Exemplary bases can comprise, but are not limited to, one or more preferences of the gifter as set forth in the gifter profile and/or preference information provided by the gifter in response to one or more preference quiz pages 320 (shown in FIG. 3B) in the manner set forth above with reference to FIGS. 3A-L. The listed suggested free gifts 2131 thereby may be of interest to the gifter.

Additionally and/or alternatively, the listed suggested free gift 2131 can be associated with a gift selection feature. The gift selection feature can enable the gifter to accept the suggested free gift 2131 offered by the free gift source. As illustrated in FIG. 30B, the gift selection feature can include an accept this gift feature 2137 by which the gifter can select the suggested free gift 2131 for delivery to the gifter and/or a send this gift feature 2138 by which the gifter can select the suggested free gift 2131 for delivery to another user or other third party. In the manner set forth with reference to FIG. 30A, delivery of the suggested free gift 2131 can include delivery at a physical address of the gifter or other user if the suggested free gift 2131 comprises a physical gift and/or can include delivery via a link, electronic mail messaging, SMS messaging or another communication channel to the gifter or other user if the suggested free gift 2131 comprises a digital gift, virtual gift, and/or discount code. In selected embodiments, the gift selection feature can permit the gifter to select from among a physical gift, a digital gift, a virtual gift, and/or a discount code and/or to specify the manner of delivery.

The free gift page 2110 of FIG. 30B is shown as including an optional free gift search feature 2120 by which the gifter can enter search information to search for a free gift. The free gift search feature 2120 can permit the gifter to search for a free gift based upon a name of the predetermined company, organization, vendor or other source for free gifts, based upon a name or type of product, based upon a name or type of service. Additionally and/or alternatively, the gifter can browse all free gifts available via the gifting method 100 and/or the free gift feature 2100. The free gift search feature 2120 of FIG. 30B is shown as including an optional filtering feature 2122 by which the gifter can filter results of the search for a free gift. The search results, for example, can be filtered based upon one or more categories of free gifts.

Turning to FIG. 30C, for example, the free gift search feature 2120 is shown as being utilized to enter a search criterion, such as a name or type of product. The free gift page 2110 can compare the search criterion with all of the free gifts available via the gifting method 100 and/or the free gift feature 2100 and present a listing 2140 of one or more suggested free gifts 2141 for the gifter based upon the comparison. Each listed suggested free gift 2141 is shown as being presented with a photograph or other image 2142 of the suggested free gift 2141 and/or a product (or service) name 2143 of the suggested free gift 2141. A name 2144 and/or a logo, photograph or other image 2145 associated with the free gift source of the suggested free gift 2141 optionally can be presented with the listed suggested free gift 2141.

Each listed suggested free gift 2141, in selected embodiments, can be associated with an information feature 2146. The information feature 2146 can provide additional information about the suggested free gift 2141. For example, the additional information can a basis by which the gifting method 100 and/or the free gift feature 2100 has included the listed suggested free gift 2141 in the listing 2140. Exemplary bases can comprise, but are not limited to, one or more preferences of the gifter as set forth in the gifter profile and/or preference information provided by the gifter in response to one or more preference quiz pages 320 (shown in FIG. 3B) in the manner set forth above with reference to FIGS. 3A-L. The listed suggested free gifts 2141 thereby may be of interest to the gifter.

Additionally and/or alternatively, the listed suggested free gift 2141 can be associated with a gift selection feature. The gift selection feature can enable the gifter to accept the suggested free gift 2141 offered by the free gift source. As illustrated in FIG. 30C, the gift selection feature can include an accept this gift feature 2147 by which the gifter can select the suggested free gift 2141 for delivery to the gifter and/or a send this gift feature 2148 by which the gifter can select the suggested free gift 2141 for delivery to another user or other third party. In the manner set forth with reference to FIG. 30A, delivery of the suggested free gift 2141 can include delivery at a physical address of the gifter or other user if the suggested free gift 2141 comprises a physical gift and/or can include delivery via a link, electronic mail messaging, SMS messaging or another communication channel to the gifter or other user if the suggested free gift 2141 comprises a digital gift, virtual gift, and/or discount code. In selected embodiments, the gift selection feature can permit the gifter to select from among a physical gift, a digital gift, a virtual gift, and/or a discount code and/or to specify the manner of delivery.

The free gift search feature 2120 of the free gift page 2110 alternatively can be utilized to enter a name or other information associated with a preselected free gift source as illustrated in FIG. 30D. The free gift page 2110 can compare the preselected free gift source information with all of the free gifts available via the gifting method 100 and/or the free gift feature 2100 and present a listing 2160 of one or more suggested free gifts 2161 for the gifter based upon the comparison. Each listed suggested free gift 2161 is shown as being presented with a photograph or other image 2162 of the suggested free gift 2161 and/or a product (or service) name 2163 of the suggested free gift 2161. A name 2164 and/or a logo, photograph or other image 2165 associated with the free gift source of the suggested free gift 2161 optionally can be presented with the listed suggested free gift 2161.

Each listed suggested free gift 2161, in selected embodiments, can be associated with an information feature 2166. The information feature 2166 can provide additional information about the suggested free gift 2161. For example, the additional information can a basis by which the gifting method 100 and/or the free gift feature 2100 has included the listed suggested free gift 2161 in the listing 2160. Exemplary bases can comprise, but are not limited to, one or more preferences of the gifter as set forth in the gifter profile and/or preference information provided by the gifter in response to one or more preference quiz pages 320 (shown in FIG. 3B) in the manner set forth above with reference to FIGS. 3A-L. The listed suggested free gifts 2161 thereby may be of interest to the gifter.

Additionally and/or alternatively, the listed suggested free gift 2161 can be associated with a gift selection feature. The gift selection feature can enable the gifter to accept the suggested free gift 2161 offered by the free gift source. As illustrated in FIG. 30D, the gift selection feature can include an accept this gift feature 2167 by which the gifter can select the suggested free gift 2161 for delivery to the gifter and/or a send this gift feature 2168 by which the gifter can select the suggested free gift 2161 for delivery to another user or other third party. In the manner set forth with reference to FIG. 30A, delivery of the suggested free gift 2161 can include delivery at a physical address of the gifter or other user if the suggested free gift 2161 comprises a physical gift and/or can include delivery via a link, electronic mail messaging, SMS messaging or another communication channel to the gifter or other user if the suggested free gift 2161 comprises a digital gift, virtual gift, and/or discount code. In selected embodiments, the gift selection feature can permit the gifter to select from among a physical gift, a digital gift, a virtual gift, and/or a discount code and/or to specify the manner of delivery.

The free gift page 2110 optionally can include a filtering feature 2170 for filtering the listing 2160 of suggested free gifts 2161. The filtering feature 2170 can enable to filter the suggested free gifts 2161 presented via the free gift page 2110 in accordance with one or more preselected criteria. As illustrated in FIG. 30D, exemplary criteria for filtering the suggested free gifts 2161 can include all free and priced (or non-free) products and/or services 2172 available from the free gift source, all free and priced (or non-free) products 2174 available from the free gift source and/or all free products and/or services (or gifts) 2176 available from the free gift source, without limitation.

Advantageously, the free gift page 2110 can present enhanced gift source information 2150 about the free gift source in selected embodiments. As illustrated in FIG. 30D, for example, the enhanced gift source information 2150 can include, but is not limited to, a name 2154 associated with the free gift source, a logo, photograph or other image 2155 associated with the free gift source, and/or a textual description 2159 of the free gift source. The textual description 2159 can include a general discussion about the free gift source, its operations, mission statement and/or available products and/or services, without limitation. In selected embodiments, the enhanced gift source information 2150 can be provided via a gift source profile associated with the free gift source.

Turning to FIGS. 30E-H, the gifting method 100 can present one or more free gift creation pages 2300 for enabling the free gift source to create and/or maintain the gift source profile in association with one or more free gifts. Stated somewhat differently, the free gift creation page 2300 can comprise at least one dedicated page for permitting the free gift source to add a free gift offering to the gift source profile of the free gift source.

The gift source profile of the free gift source can include, but is not limited to, including the name 2154 (shown in FIG. 30D) associated with the free gift source, the logo, photograph or other image 2155 (shown in FIG. 30D) associated with the free gift source, and/or the textual description 2159 (shown in FIG. 30D) of the free gift source. Although a link to a website or other resource (not shown) associated with the free gift source optionally can be included in the textual description 2159, the gifting method 100 and/or the free gift feature 2100 preferably inhibit inclusion of such links in the gift source profiles of the free gift sources. In selected embodiments, the gift source profile can include a listing of one or more free gifts offered by the free gift source.

An exemplary free gift creation page 2300 is shown in FIG. 30E. As shown in FIG. 30E, the free gift creation page 2300 can enable the free gift source to create a new free gift page 2305 for a selected free gift. The free gift page 2305 can include a photograph or other image 2310 of the selected free gift and/or a product (or service) name 2320 of the selected free gift.

In selected embodiments, the free gift creation page 2300 can enable the free gift source to specify an audience, at 2330, for the selected free gift. The free gift creation page 2300, in other words, can be configured, at 2330, to permit the free gift source to filter a predetermined group of one or more users of the gifting method 100 and/or the free gift feature 2100 to whom the selected free gift may be offered or otherwise presented. The free gift source can elect to offer or otherwise present the selected free gift to all users in an unfiltered manner, at 2330A, and/or to offer or otherwise present the selected free gift only to a specified audience of predetermined group of users, at 2330B.

If the selected free gift is to be offered only to the specified audience, the free gift creation page 2300 can enable the free gift source to filter or otherwise create the specified audience, at 2340. The free gift source, for example, can filter the group of users to whom the selected free gift may be offered, at 2340, based upon one or more demographic characteristics. As illustrated in FIG. 30E, the free gift source can filter the group of users to whom the selected free gift may be offered, at 2341, based upon a preselected age (or a preselected age range) for the specified audience. The preselected age range can include a lower age range limit 2341A and/or an upper age range limit 2341B.

Additionally and/or alternatively, the free gift source can filter the group of users to whom the selected free gift may be offered, at 2342, based upon at least one preselected gender of the specified audience. Exemplary preselected genders can include, but are not limited to, a female gender 2342A, a male gender 2342B, a cisgender 2342C and/or at least one other gender 2342D.

Turning to FIG. 30F, the free gift creation page 2300 can enable the free gift source to filter or otherwise create the specified audience, at 2340, based upon one or more other user characteristics. The free gift source, for example, can filter the group of users to whom the selected free gift may be offered, at 2343, based upon a predetermined geographic location. The predetermined geographic location can be specified in any suitable manner. As illustrated in FIG. 30F, the free gift creation page 2300 can permit the free gift source to enter a preselected zip code 2343A for the specified audience. The free gift source optionally can define a preselected distance range 2343B for the specified audience relative to the preselected zip code 2343A via the free gift creation page 2300.

In selected embodiments, the free gift creation page 2300 can enable the free gift source to filter or otherwise create the specified audience based upon one or more hobbies 2344. The free gift creation page 2300, for example, can include a hobby search feature 2344A by which the free gift source can enter hobby information. The free gift source thereby can search the gifting method 100 and/or the free gift feature 2100 for one or more predetermined hobbies that match the entered hobby information. Additionally and/or alternatively, the free gift creation page 2300 can present at least one predetermined hobby 2344B for selection by the free gift source. Exemplary predetermined hobbies 2344B can include music 2344C, technology 2344D and/or sports 2344E, without limitation.

The free gift creation page 2300 optionally can enable the free gift source to filter or otherwise create the specified audience based upon one or more occupations 2345, such as professional occupations. The free gift creation page 2300, for example, can include an occupation search feature 2345A by which the free gift source can enter occupation information. The free gift source thereby can search the gifting method 100 and/or the free gift feature 2100 for one or more predetermined occupations that match the entered occupation information. Additionally and/or alternatively, the free gift creation page 2300 can present at least one predetermined occupation 2345B for selection by the free gift source. Exemplary predetermined occupations 2345B can include, but are not limited to, teacher 2345C, developer 2345D and/or public employee 2345E.

As shown in FIG. 30F, the free gift creation page 2300 advantageously can present a number of users who satisfy the entered filter requirements. The users who satisfy the entered filter requirements, in other words, can comprise the specified audience for the selected free gift. The gifting method 100 and/or the free gift feature 2100 thereby can be configured to offer the selected free gift to the users within the specified audience. Although shown and described with reference to selected filtering factors for purposes of illustration only, the free gift creation page 2300 can enable the free gift source to create the specified audience based upon any predetermined number, type and/or combination of filtering factors without limitation.

In selected embodiments, the free gift creation page 2300 can permit the free gift source to attach one or more conditions on any offer for the selected free gift. The free gift source, in other words, can designate the offer for the selected free gift as being conditional. The free gift creation page 2300, for example, can enable the free gift source to require the user to respond to a questionnaire as a condition for receiving the selected free gift. In selected embodiments, users must complete the questionnaire to receive the selected free gift.

As illustrated in FIGS. 30G-H, the free gift creation page 2300 can include a questionnaire creation feature 2350. The questionnaire creation feature 2350 can provide the free gift source with an option 2351 to create a questionnaire. The options 2351 shown in FIG. 30G include a first option 2351A to create the questionnaire and/or a second option 2351B to decline to create the questionnaire 2351B. If the free gift source opts to create the questionnaire, at 2352, the questionnaire creation feature 2350 can enable the free gift source to add one or more questionnaire question fields, at 2358, to the questionnaire. The questionnaire can include any suitable number, type and/or arrangement of questionnaire question fields.

An exemplary type of questionnaire question field can comprise a first questionnaire question field 2354 that can present a preset option question 2354A with one or more predetermined question response options 2354B to the user. The user thereby can respond to the preset option question 2354A by selecting at least one of the predetermined question response options 2354B. Exemplary predetermined question response options 2354B can include an affirmative response option 2354B1, a negative response option 2354B2 and/or an indifferent response option 2354B3, without limitation. The free gift creation page 2300 can permit the free gift source to edit the predetermined question response options 2354B, at 2354D. The free gift source can manage the preset option question 2354A via an optional question management feature 2354C of the free gift creation page 2300. The question management feature 2354C, for example, can enable the free gift source to delete or otherwise manage the preset option question 2354A.

Additionally and/or alternatively, a second questionnaire question field 2356 can present an open-field question 2356A with user response field or region 2356B to the user. The user can respond to the open-field question 2356A by entering a textual or other response via the user response field 2356B. The user response field 2356B optionally can permit the user to attach one or more user files or other items (not shown) as a part of the response to the open-field question 2356A. In selected embodiments, the free gift creation page 2300 can enable the free gift source to delete or otherwise manage the open-field question 2356A via a question management feature 2356C.

As shown in FIG. 30H, the free gift creation page 2300 can include a questionnaire preview feature 2360 for presenting a preview of the questionnaire. The questionnaire preview feature 2360 can enable the free gift source to preview the questionnaire, for example, before the questionnaire is published or otherwise available to the users of the gifting method 100 and/or the free gift feature 2100. The free gift creation page 2300 optionally can include a free gift preview feature 2370 for presenting a preview of the free gift and/or a preview of the user characteristics of the specified audience for the free gift. In selected embodiments, the free gift preview feature 2370 can enable the free gift source to preview the free gift and/or the user characteristics of any specified audience before the free gift becomes available to the users of the gifting method 100 and/or the free gift feature 2100.

The free gift source can publish the offer for the free gift via a publication feature 2380 of the free gift creation page 2300. Upon publication, the offer for the free gift can be made available to all users or the specified audience via the gifting method 100 and/or the free gift feature 2100. The free gift source can seek support and any other assistance regarding the free gift creation page 2300 via a support feature 2390.

In selected embodiments, the gifting method 100 advantageously can include an optional swipe to gift feature. An exemplary embodiment of the swipe to gift feature 2400 is shown and described herein with reference to FIGS. 31A-N. The swipe to gift feature 2400 can enable a gifter to automatically fill (or autofill) address and other information associated with a gift recipient or other user of the gifting method 100. Additionally and/or alternatively, the swipe to gift feature 2400 can permit the gifter to pre-schedule giving a gift to the gift recipient or other user. The swipe to gift feature 2400 advantageously can help to simplify and/or expedite the gift-giving process while reducing risk of error. Stated somewhat differently, the swipe to gift feature 2400 can simplify and/or expedite a process of the gifter sending a gift to a recipient and/or a process of confirming payment for the gift by the gifter.

Turning to FIG. 31A-C, the swipe to gift feature 2400 can be associated with a swipe to gift page 2405 of the gifting method 100. The swipe to gift page 2405 advantageously can include all gift information about a gift to be sent to a gift recipient. Exemplary gift information can include, but is not limited to, a recipient profile of the recipient, a relationship between the recipient and the gifter, an occasion or other motivation for the gift, an occasion date for the occasion, a gift delivery date of delivery for the gift, a gift price (or a gift price range) for the gift and/or payment information for processing payment of the gift. The recipient profile, for instance, can include personal preferences, delivery address information and other contact information for the recipient; whereas, the gift delivery date can match or otherwise comprise the same date as the occasion date if the gift is a virtual gift. In selected embodiments, the swipe to gift page 2405 can comprise a single page for presenting all of the gift information.

As illustrated in FIG. 31A, for example, the swipe to gift page 2405 optionally can enable the gifter to select a gift price (or a gift price range) 2410 of the gift for the recipient. The gifter, for example, can select the price (or the price range) 2410 if the gifting method 100 has not previously received price information from the gifter. In selected embodiments, the gift price (or the gift price range) can include (or exclude) any taxes and/or can include (or exclude) any shipping charges. Any shipping charges can be based upon the delivery address information of the recipient.

The gift page 2405 can enable the gift to select the gift price range by selecting a minimum gift price value 2412 and a maximum gift price value 2414 as shown in FIG. 31A. Without limitation, an exemplary minimum gift price value 2412 can be ten dollars; whereas, exemplary maximum gift price values 2414 can comprise one hundred dollars, two hundred dollars and/or ten thousand dollars. The gift page 2405 can present the selected gift price range, at 2416. The selected price (or the selected price range) can be accepted by activation of continue indicia 2418 of the gift page 2405.

Turning to FIG. 31B, the swipe to gift page 2405 can propose a gift for the gifter to provide to the recipient. The swipe to gift page 2405 optionally can include a swipe to gift indicia 2420. Advantageously, the swipe to gift page 2405 can automatically-prefill gift information associated the gift for the gifter. The automatically-prefilled gift information, for example, can include selected recipient information 2430 about the recipient and the relevant occasion. As shown in FIG. 31B, the selected recipient and occasion information 2430 can include, but is not limited to, a photograph or other image 2432 associated with the recipient, a recipient name 2434 of the recipient, an occasion name 2436 for the relevant occasion and/or a gift date 2438 for the gift.

Additionally and/or alternatively, the automatically-prefilled gift information can include gift delivery information 2440. The gift delivery information 2440 can include a gift link 2442, a projected delivery date and/or time of delivery 2444 and/or an actual delivery date and/or time of delivery 2446, without limitation. If the gift comprises a virtual gift, the virtual gift can be delivered via electronic mail messaging, SMS messaging or another communication channel. In selected embodiments, the gifter can preselect the projected delivery date and/or time of delivery 2444.

The automatically-prefilled gift information likewise can include gift shipping information 2450. The swipe to gift page 2405 can automatically prefill the shipping information with the delivery address information and other contact information for the recipient as set forth in the recipient profile of the recipient. In selected embodiments, the gifter can provide an alternative delivery address for the gift.

Advantageously, the swipe to gift feature 2400 and/or the gifting method 100 can automatically select a gift 2460 for the recipient. The automatically-selected gift 2460 can be presented via the swipe to gift page 2405. If the automatically-selected gift 2460 comprises a virtual gift, the virtual gift can be selected and/or previewed, for example, in the manner discussed in more detail herein with reference to FIGS. 15A-K. As illustrated in FIG. 31B, the swipe to gift page 2405 can present a photograph or other image 2462 associated with the selected gift and/or a gift name 2464 of the selected gift, without limitation. In selected embodiments, the gifter can select an alternative gift. The swipe to gift page 2405, for example, can present a list of alternative gifts for selection by the gifter, enable the gifter to revise the price (or the price range) 2410 (shown in FIG. 31A) or otherwise enable the gifter to select the alternative gift.

The swipe to gift page 2405 optionally can include an automatically-prefilled greeting card 2466 for accompanying the selected gift. The swipe to gift feature 2400 and/or the gifting method 100 can automatically select and prefill the greeting card 2466 based, for example, upon the recipient preferences of the recipient and/or the occasion. If the greeting card 2466 comprises a virtual greeting card, the virtual greeting card can be selected, previewed and/or edited, for example, in the manner discussed in more detail herein with reference to FIGS. 22A-H and/or can be delivered via electronic mail messaging, SMS messaging or another communication channel. The virtual greeting card can be delivered with, or separately from, delivery of an associated virtual gift.

As shown in FIG. 31B, the automatically-prefilled gift information can include gift price and payment information 2470. The gift price and payment information 2470 can include, but is not limited to, a final gift price 2472 for the gift and/or gift payment information 2474. In selected embodiments, the gift payment information 2474 can comprise payment information included in the gifter profile of the gifter. Swipe to gift indicia 2480 can be actuated to approve the gift for the recipient.

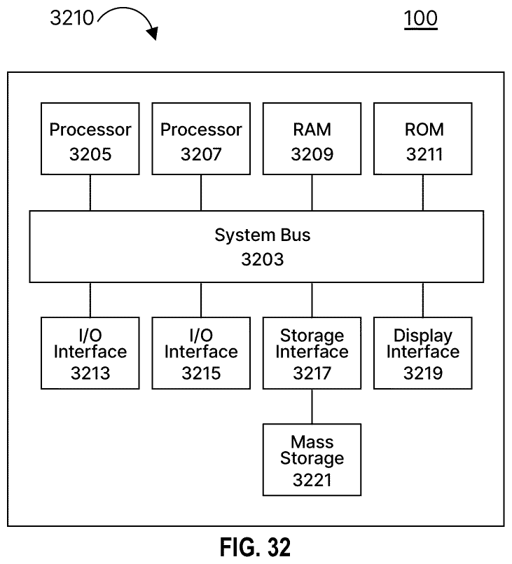

After the gift has been approved, the gift page 2405 optionally can audibly and/or visually present confirmation indicia 2490 for confirming that the recipient will receiving the gift as shown in FIG. 31C. In selected embodiments, the swipe to gift feature 2400 and/or the gifting method 100 can be executed via a computer system (or circuit) 3201 (shown in FIG. 32), such as a laptop system (or circuit), a handheld computer system (or circuit) and a server system (or circuit), that is associated with the gifter. The confirmation indicia 2490 optionally can include vibrating the computer system 3201. A delivery progress of the gift, a preview of the greeting card 2466 and/or other information about the gift and/or greeting card 2466 can be viewed via the virtual gift page 1700 (shown in FIG. 22A).

The purchase of the gift can be consummated after the gifter approves the gift. In selected embodiments, the purchase of the gift can be consummated in any suitable manner. For example, the purchase can be consummated via a pass-through plug-in integration with a website (not shown) of a vendor who is fulling the gift purchase. The vendor website preferably includes a plug-in application that enables the swipe to gift feature 2400 and/or the gifting method 100 to automatically add the gift to a shopping cart on the vendor website with the billing address of the gifter and the delivery address of the recipient. The vendor, for example, can have an affiliate relationship with the swipe to gift feature 2400 and/or the gifting method 100 such that the swipe to gift feature 2400 and/or the gifting method 100 can monetize the sale of the gift.

Additionally and/or alternatively, the vendor and the swipe to gift feature 2400 (and/or the gifting method 100) can have a relationship through dropshipping. The swipe to gift feature 2400 and/or the gifting method 100 thereby can process the gift payment from the gifter and utilize a regular dropshipping procedure. The vendor and the swipe to gift feature 2400 (and/or the gifting method 100) optionally can have a marketplace relationship. In other words, the swipe to gift feature 2400 and/or the gifting method 100 can charge the gifter for the gift, and the gifter can pay the vendor within a predetermined number of days for the gift. The gifter, for example, can pay the vendor within twenty-five days of delivery of the gift, and/or a percentage of the payment can be provided to the gifting method 100 for permitting the vendor to participate with the gifting method 100. If the gift is owned by the swipe to gift feature 2400 and/or the gifting method 100, the swipe to gift feature 2400 and/or the gifting method 100 can collect payment from the gifter and attend to other financial and delivery aspects of the purchase.

In selected embodiments, the swipe to gift feature 2400 can send a gift announcement 2500 to the recipient as illustrated in FIG. 31D. The gift announcement 2500, for example, can comprise a gift announcement page 2505 that can be presented via a computer system (or circuit) 3201 (shown in FIG. 32), such as a laptop system (or circuit), a handheld computer system (or circuit) and a server system (or circuit), that is associated with the recipient. At the projected delivery date and/or time 2444 and/or the actual delivery date and/or time 2446 the gift announcement 2500 can be delivered to the recipient. The gift announcement 2500 can be delivered in any suitable manner, including via electronic mail messaging, SMS messaging or another communication channel, without limitation. Dispatch of the gift announcement 2500 via SMS messaging advantageously can help ensure that the gift and the greeting card are timely sent.

In selected embodiments, the gift announcement 2500 can include a preview of the gift and/or a preview of the greeting card. The gift announcement 2500, for example, can include gifter information 2510. The gifter information 2510 can include a photograph or other image 2512 of the gifter, a name of the gifter, a telephone number associated with the gifter, and/or a telephone number 2514 associated with the gifting method 100. The gift announcement 2500 can include a visual preview 2520 of the gift, preferably shown as a wrapped gift, and/or a gift access code 2530 for enabling the recipient to access the gift. The gift access code 2530 advantageously can prevent the gift announcement 2500 from appearing to be a part of a scam or other form of impropriety.

The gift announcement 2500 can present the recipient with one or more options for opening the gift. For example, the gift announcement 2500 can enable the recipient to visit a preselected web page and to enter the gift code. Entry of the gift code can permit the recipient to preview the gift. The recipient optionally can directly access a virtual gift page 1700 (shown in FIG. 22A) associated with the recipient profile of the recipient. The gift thereby can be presented as a virtual gift on the virtual gift page 1700. The recipient thereby can open the virtual gift page 1700 to unwrap or otherwise access the virtual gift. Additionally and/or alternatively, the recipient can activate the visual preview 2520 of the gift to be redirected to the virtual gift page 1700, where the virtual gift can be unwrapped or otherwise accessed. If the recipient has not accessed the virtual gift page 1700, the recipient can open the gift via the univocal gift code received via the gift announcement.

The swipe to gift feature 2400 preferably is available in contexts in which it is possible for the swipe to gift feature 2400 and/or the gifting method 100 to auto-fill fields required for creation. In a notification context, for example, the gifter can have a gifter profile with credit card information in the settings page of the platform. The gifter can prefer to pay gifts with the credit card in the future, avoiding manually entering the data each time, and has a list of recipients and most of them already have a respective recipient profiles. The swipe to gift feature 2400 and/or the gifting method 100 thereby has birthday and relationship to the gifter for each recipient.

For example, the gifter can receive a notification from the swipe to gift feature 2400, stating that “tomorrow is Julie's birthday—Do you want to send a gift?” and presenting “Fast process with Swipe to gift” indicial. The gifter alternatively can create a gift for Julie via the gifting method 100. Since Julie has a recipient profile, the swipe to gift feature 2400 already knows:
the recipient profile of the recipient (Julie, her preferences and her address to receive a gift);
the relationship (Julie is a colleague of the gifter);
the occasion (birthday);
the date of the occasion (tomorrow); and/or
the payment data (The gifter already pre-saved in the setting page his credit card data).

In the manner set forth above with reference to FIG. 31A, the gift feature 2400 can enable the gifter to select a gift price (or a gift price range) 2410, such as a budget from $100 to $200. Additionally and/or alternatively, the swipe to gift page 2405 can propose a gift for the gifter to provide to the recipient and can automatically-prefill gift information that is associated the gift in the manner set forth herein with reference to FIG. 31B. The automatically-prefill gift information can include:
a name of the recipient with the occasion and the occasion date;
a projected delivery date and/or time of delivery 2444, comprising delivery via SMS of a virtual gift preview link (date and time);
an actual delivery date and/or time of delivery 2446 for the real gift with a delivery estimate in days;
a gift shipping information 2450 for with prefilled shipment address of the recipient;
a selected gift 2460 based on the gift price (or the gift price range) 2410 (shown in FIG. 31A) with an automatically-prefilled greeting card 2466 (delivered with the virtual gift, no cards will be printed in the real gift); and/or
gift price and payment information 2470.

In selected embodiments, no card will be provided with a physical, tangible gift.

The gifter can be enabled to edit each entry of the automatically-prefill gift information and, upon approval of the gift for the recipient, can actuate the swipe to gift indicia 2480 to confirm the gift and payment. The gift will be sent based on the projected delivery date and/or time of delivery 2444 and/or the actual delivery date and/or time of delivery 2446. The gifter can view delivery progress of the gift, a preview of the greeting card 2466 and/or other information about the gift and/or greeting card 2466 via the virtual gift page 1700 (shown in FIG. 22A).

In a send-a-gift context, the gifter can have a gifter profile with credit card information in the settings page of the platform. The gifter can prefer to pay gifts with the credit card in the future, avoiding manually entering the data each time. Wanting to send a gift to his mother, Patricia, the gifter searched for, and located, a recipient profile for his mother and actuates the send-a-gift feature of the gifting method 100. In the send-a-gift context, the gifting method 100 knows:
the recipient profile of the recipient (Patricia, her preferences and her address to receive the gift); and/or
the relationship (Patricia is the mother of the gifter).

The gifting method 100 likewise can present a questionnaire to the gifter. In selected embodiments, the questionnaire can be presented in the form of the preference quiz pages 320 (shown in FIG. 3B). The gifting method 100 thereby can ask the gifter to select:
an occasion (Mother's Day);
a date of the occasion (next Sunday); and/or
a gift price (or a gift price range) for the gift (such as a budget from $100 to $200).

The gifting method 100 can prompt the gifter to create a gift and/or to make other customizations, such as messages, cards, wrapping, flowers, choice of the gift, participants, etc.

The gifter can select one or more of the customizations or, ignoring the questionnaire, can utilize the swipe to gift feature 2400 for accelerating the gifting process. In view of the selected gift price range from $100 to $200, the swipe to gift feature 2400 can propose a gift for the gifter to provide to the recipient and can automatically-prefill gift information that is associated the gift in the manner set forth herein with reference to FIG. 31B. The automatically-prefill gift information can include:
a name of the recipient with the occasion and the occasion date;
a projected delivery date and/or time of delivery 2444, comprising delivery via SMS of a virtual gift preview link (date and time);
an actual delivery date and/or time of delivery 2446 for the real gift with a delivery estimate in days;
a gift shipping information 2450 for with prefilled shipment address of the recipient;
a selected gift 2460 based on the gift price range with an automatically-prefilled greeting card 2466 (delivered with the virtual gift, no cards will be printed in the real gift); and/or
gift price and payment information 2470.

In selected embodiments, no card will be provided with a physical, tangible gift.

The gifter can be enabled to edit each entry of the automatically-prefill gift information and, upon approval of the gift for the recipient, can actuate the swipe to gift indicia 2480 to confirm the gift and payment. The gift will be sent based on the projected delivery date and/or time of delivery 2444 and/or the actual delivery date and/or time of delivery 2446. The gifter can view delivery progress of the gift, a preview of the greeting card 2466 and/or other information about the gift and/or greeting card 2466 via the virtual gift page 1700 (shown in FIG. 22A).

As an example of an invited as participant context, Peter, together with one or more colleagues, would like to send a gift to Angela, their office manager. Peter, the colleagues, and Angela each have established respective user profiles via the gifting method 100, and Peter and his colleagues want to create a unique gift for Angela. One of the colleagues, John, has utilized the gifting method 100 to create a customized the greeting card for Angela and to select a gift based upon a preselected gift price range and recipient preferences set forth in John's user profile. John then adds Peter to the gift participants.

Peter can receive an invitation to participate in the gift to Angela via SMS messaging or another communication channel. The invitation can include a notification, such as “John has invited you to participate in a gift for Angela—Continue with Swipe to Gift.” Peter can accept the invitation and be redirected to the swipe to gift feature 2400 of the gifting method 100. The swipe to gift feature 2400 can include gift information that has been prefilled by John such that Peter only has to actuate the swipe to gift indicia 2480 to approve the gift for Angela.

The swipe to gift indicia 2480 for enabling the gifter to approve the gift for the recipient can be provided in any suitable manner. In selected embodiments, the gifting method 100 can provide the swipe to gift indicia 2480 as one or more buttons or other (physical and/or virtual) actuatable controls for approving the gift.

Turning to FIG. 31E, for example, the gift indicia 2480 is shown as comprising a slidable button 2482. Upon reviewing the automatically-prefilled gift information discussed in more detail above with reference to FIGS. 31A-C, the gifter 2700 can confirm the automatically-prefilled gift information and proceed to approving and/or paying for the gift by actuating the slidable button 2482. As shown in FIG. 31E, the gifter 2700 can slide the slidable button 2482 toward a photograph or other image 2483 associated with the recipient. The gifter 2700 can slide the slidable button 2482 in any suitable manner. A finger 2710 of the gifter 2700 can contact and move the slidable button 2482. In selected embodiments, the gifter 2700 can utilize a device (not shown), such as a mouse, cursor or trackball, to move the slidable button 2482.

Additionally and/or alternatively, the gift indicia 2480 can comprise a depressible button 2484 as shown in FIG. 31F. Upon reviewing the automatically-prefilled gift information discussed in more detail above with reference to FIGS. 31A-C, the gifter 2700 can confirm the automatically-prefilled gift information and proceed to approving and/or paying for the gift by actuating the depressible button 2484. The gifter 2700, in other words, can depress the depressible button 2484 to approve and/or pay for the gift. The gifter 2700 can depress the depressible button 2484 in any suitable manner. A finger 2710 of the gifter 2700 can contact and push upon the depressible button 2484. In selected embodiments, the gifter 2700 can utilize a device (not shown), such as a mouse, cursor or trackball, to depress the depressible button 2484.

As shown in FIGS. 31E-F, the gift indicia 2480 optionally can include identifying information 2846 for identifying a use, operation or other purpose of the gift indicia 2480. The identifying information 2846, for example, can include a textual message 2484A and/or a logo or other branding indicia 2846B associated with the swipe to gift feature 2400.

The gift indicia 2480 can present the identifying information 2846 in any suitable manner. Turning to FIG. 31G, for example, the textual message 2484A can comprise “Fast process with” in a vertical arrangement with respect to the branding indicia 2846B. Alternatively, the textual message 2484A can comprise “Continue with” in a vertical arrangement with respect to the branding indicia 2846B as shown in FIG. 31H, or the textual message 2484A can comprise “Send with” in a vertical arrangement with respect to the branding indicia 2846B as illustrated in FIG. 31I. FIG. 31J shows the textual message 2484A of “Buy and send with” in a vertical arrangement with respect to the branding indicia 2846B.

In selected embodiments, the gift indicia 2480 can present the textual message 2484A and the branding indicia 2846B in a horizontal arrangement. Turning to FIG. 31K, for example, the textual message 2484A can comprise “Fast process with” in a horizontal arrangement with respect to the branding indicia 2846B. Alternatively, the textual message 2484A can comprise “Continue with” in a horizontal arrangement with respect to the branding indicia 2846B as illustrated in FIG. 31L, or the textual message 2484A can comprise “Buy and send with” in a horizontal arrangement with respect to the branding indicia 2846B as shown in FIG. 31M. FIG. 31N illustrates the textual message 2484A of “Send with” in a horizontal arrangement with respect to the branding indicia 2846B.

According to various embodiments, various functionality of the gifting method 100 discussed herein can be performed by and/or with the help of one or more computer systems (or circuits). Such a computer can be and/or incorporate, as just some examples, a personal computer, a server, a smartphone, a system-on-a-chip, and/or a microcontroller, without limitation. Such a computer can, in various embodiments, run Linux, MacOS, Windows, or another operating system.

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 32 is an example computer employable in various embodiments of the present invention. Exemplary computer system (or circuit) 3201 includes system bus 3203 which operatively connects two processors 3205 and 3207, random access memory (RAM) 3209, read-only memory (ROM) 3211, input and/or output (I/O) interfaces 3213 and 3215, storage interface 3217, and display interface 3219.

Storage interface 3217 in turn connects to mass storage 3221. Each of I/O interfaces 3213 and 3215 can, as just some examples, be a Universal Serial Bus (USB), a Thunderbolt, an Ethernet, a Bluetooth, a Long Term Evolution (LTE), a 5G, an IEEE 488, and/or other interface. Mass storage 3221 can be a flash drive, a hard drive, an optical drive, or a memory chip, as just some possibilities. Processors 3205 and 3207 can each be, as just some examples, a commonly known processor such as an ARM-based or x86-based processor.

Computer 3201 can, in various embodiments, include or be connected to a touch screen, a mouse, and/or a keyboard. Computer 3201 can additionally include or be attached to card readers, digital video disk (or DVD) drives, floppy disk drives, hard drives, memory cards, read only memory (ROM), and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules can, for example, be programmed using Python, Java, JavaScript, Swift, React, C, C++, C #, and/or another language. Corresponding program code can be placed on media such as, for example, DVD, CD-ROM, memory card, and/or floppy disk. It is noted that any indicated division of operations among particular software modules is for purposes of illustration, and that alternate divisions of operation may be employed.

Accordingly, any operations indicated as being performed by one software module can instead be performed by a plurality of software modules. Similarly, any operations indicated as being performed by a plurality of modules can instead be performed by a single module. It is noted that operations indicated as being performed by a particular computer can instead be performed by a plurality of computers. It is further noted that, in various embodiments, peer-to-peer and/or grid computing techniques may be employed.

It is additionally noted that, in various embodiments, remote communication among software modules may occur. Such remote communication can, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

In selected embodiments, one or more of the features disclosed herein can be provided as a computer program product. The computer program product, for example, can be encoded on one or more non-transitory machine-readable storage media, such as magnetic, optical and/or electronic storage media of any kind and without limitation. As used herein, a phrase in the form of at least one of A, B, C and D herein is to be construed as meaning one or more of A, one or more of B, one or more of C and/or one or more of D. Likewise, a phrase in the form of A, B, C or D as used herein is to be construed as meaning A or B or C or D. For example, a phrase in the form of A, B, C or a combination thereof is to be construed as meaning A or B or C or any combination of A, B and/or C.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A computer-implemented gifting method, comprising:
enabling a gifting user to create and maintain a recipient profile for a recipient user via a server circuit, the recipient profile including relationship information between the gifting user and the recipient user, occasion information for one or more occasions associated with the recipient user, recipient preference information, recipient contact information, and gifting user payment information for the gifting user;
notifying the gifting user of an upcoming occasion for the recipient user based upon the occasion information of the recipient profile via the server circuit;
permitting the gifting user to provide budgetary information for a gift to be dispatched to the recipient user for the upcoming occasion via the server circuit;
proposing one or more suggested gifts for the upcoming occasion based upon the budgetary information, the relationship information and the recipient preference information via the server circuit;
enabling the gifting user to select a selected gift from among the suggested gifts via the server circuit;
applying the recipient contact information to dispatch the selected gift to the recipient via the server circuit; and
applying the gifting user payment information to pay for the selected gift via the server circuit.

2. The computer-implemented gifting method of claim 1,
wherein said enabling the gifting user to create and maintain the recipient profile includes administering a gift preference quiz via the server circuit, the gift preference quiz identifying the recipient preference information for the recipient profile, and
wherein said notifying the gifting user of the upcoming occasion comprises periodically notifying the gifting user of the upcoming occasion for the recipient user.

3. The computer-implemented gifting method of claim 1,
wherein said proposing the one or more suggested gifts includes proposing a flower plan for sending a predetermined quantity and arrangement of flowers to the recipient user annually based upon the occasion information in the recipient profile and proposing a gift that comprises at least one of money, cryptocurrency, stocks, collectables and classes, and
wherein the method further comprises enabling the gifting user to create and maintain a gifting user profile via the server circuit, the gifting user profile including occasion information for one or more occasions associated with the gifting user, gifting user preference information and gifting user contact information.

4. The computer-implemented gifting method of claim 3, further comprising:
enabling the gifting user to select a free gift from a predetermined organization via the server circuit, the free gift being offered by the predetermined organization based upon the gifting user profile of the gifting user;
permitting the predetermined organization to access preselected data generated by the gifting user via the server circuit;
updating the gifting user profile to include information associated with the free gift via the server circuit;
permitting the predetermined organization to confirm activation of the selection of the free gift by the gifting user via the server circuit; and
applying the gifting user contact information to dispatch the free gift to the gifting user via the server circuit.

5. The computer-implemented gifting method of claim 4,
wherein said permitting the predetermined organization to access the preselected data generated by the gifting user comprises permitting the predetermined organization to access non-personal information generated by the gifting user, and
wherein the free gift is a part of an advertising campaign by the predetermined organization.

6. The computer-implemented gifting method of claim 1, wherein said proposing the one or more suggested gifts includes automatically prefilling gift information for a selected suggested gift based upon the recipient profile and presenting swipe to gift indicia for actuation by the gifting user to approve the selected suggested gift for dispatch to the recipient.

7. The computer-implemented gifting method of claim 6,
wherein said automatically prefilling gift information includes automatically prefilling a name of the recipient user, occasion information for the upcoming occasion, a name of the selected suggested gift, gift delivery information, the recipient contact information and the gifting user payment information for approval by the gifting user, and
wherein the method further comprises automatically prefilling a greeting card associated with the selected suggested gift based upon the recipient profile.

8. The computer-implemented gifting method of claim 1, wherein said proposing the one or more suggested gifts includes proposing a virtual gift for the recipient user.

9. The computer-implemented gifting method of claim 8,
wherein said proposing the virtual gift comprises proposing the virtual gift as a substitute for a tangible gift when the tangible gift is not expected to be delivered to the recipient user in time for the upcoming occasion.
wherein said applying the recipient contact information to dispatch the selected gift comprises sending the virtual gift to the recipient user via a link, electronic mail messaging or short message service (SMS) messaging, and
wherein the method further comprises presenting a gift announcement associated with the virtual gift to the recipient user, the gift announcement including a preview of the selected gift, information for identifying the gifting user and a gift access code for enabling the recipient user to access the virtual gift.

10. The computer-implemented gifting method of claim 1, wherein said enabling the gifting user to select the selected gift comprises enabling the gifting user to select the selected gift as part of a group gift exchange that includes the gifting user, the recipient user and a third user.

11. The computer-implemented gifting method of claim 10,
wherein said enabling the gifting user to select the selected gift as part of the group gift exchange comprises enabling the gifting user to select the selected gift as part of an anonymous group gift exchange, and
wherein the method further comprises:
enabling the third user to create and maintain a user profile for the gifting user via the server circuit, the user profile including relationship information between the third user and the gifting user, occasion information for one or more occasions associated with the gifting user, gifting user preference information, gifting user contact information, and third user payment information for the third user;
permitting the third user to provide budgetary information for a second gift to be dispatched to the gifting user for the upcoming occasion via the server circuit;
proposing one or more suggested second gifts for the upcoming occasion based upon the budgetary information, the relationship information and the gifting user preference information via the server circuit;
enabling the third user to select a selected second gift from among the suggested second gifts via the server circuit;
applying the gifting user contact information to dispatch the selected second gift to the gifting user via the server circuit; and
applying the third user payment information to pay for the selected second gift via the server circuit.

12. The computer-implemented gifting method of claim 1, wherein said enabling the gifting user to create and maintain the recipient profile for the recipient user includes enabling the gifting user to create a new occasion for the recipient profile.

13. The computer-implemented gifting method of claim 1, wherein said enabling the gifting user to create and maintain the recipient profile for the recipient user includes enabling the gifting user to view at least one of past occasions, current occasions and future occasions associated with the recipient profile and enabling the gifting user to select one or more occasions associated with the recipient profile for presentation.

14. The computer-implemented gifting method of claim 13, wherein said enabling the gifting user to select the one or more occasions associated with the recipient profile for presentation includes enabling the gifting user to divide the selected occasions into two or more occasion groups and presenting one or more occasion details for each of the selected occasions.

15. The computer-implemented gifting method of claim 1, further comprising permitting the gifting user to send a text message to the recipient user for an occasion selected from among the one or more occasions associated with the recipient user in the recipient profile.

16. The computer-implemented gifting method of claim 15, wherein said permitting the gifting user to send the text message includes permitting the gifting user to select the selected occasion by searching among the one or more occasions associated with the recipient user in the recipient profile, permitting the gifting user to include a virtual greeting card with the text message and permitting the gifting user to include a gift code with the text message.

17. The computer-implemented gifting method of claim 1, further comprising:
permitting the gifting user to send a virtual greeting card to the recipient user for an occasion selected from among the one or more occasions associated with the recipient user in the recipient profile; and
enabling the gifting user to select a direct gift for dispatch to the recipient user via the recipient contact information;
enabling the gifting user to select a local gift for dispatch to the recipient user via the recipient contact information, the local gift being provided by a vendor who is located in a vendor geographic region that is proximal to a recipient user geographic region associated with the recipient contact information.

18. The computer-implemented gifting method of claim 17, wherein said enabling the gifting user to select the direct gift comprises enabling the gifting user to make a charitable donation in the name of the recipient user.

19. A computer program product for assisting gifters with finding gifts for recipients, the computer program product being encoded on one or more non-transitory machine-readable storage media and comprising:
instruction for enabling a gifting user to create and maintain a recipient profile for a recipient user, the recipient profile including relationship information between the gifting user and the recipient user, occasion information for one or more occasions associated with the recipient user, recipient preference information, recipient contact information, and gifting user payment information for the gifting user;
instruction for notifying the gifting user of an upcoming occasion for the recipient user based upon the occasion information of the recipient profile;
instruction for permitting the gifting user to provide budgetary information for a gift to be dispatched to the recipient user for the upcoming occasion;
instruction for proposing one or more suggested gifts for the upcoming occasion based upon the budgetary information, the relationship information and the recipient preference information;
instruction for enabling the gifting user to select a selected gift from among the suggested gifts;
instruction for applying the recipient contact information to dispatch the selected gift to the recipient; and
instruction for applying the gifting user payment information to pay for the selected gift.

20. A system for assisting gifters with finding gifts for recipients, comprising:
a computer circuit for enabling a gifting user to create and maintain a recipient profile for a recipient user, the recipient profile including relationship information between the gifting user and the recipient user, occasion information for one or more occasions associated with the recipient user, recipient preference information, recipient contact information, and gifting user payment information for the gifting user;
said computer circuit notifying the gifting user of an upcoming occasion for the recipient user based upon the occasion information of the recipient profile, permitting the gifting user to provide budgetary information for a gift to be dispatched to the recipient user for the upcoming occasion, proposing one or more suggested gifts for the upcoming occasion based upon the budgetary information, the relationship information and the recipient preference information, enabling the gifting user to select a selected gift from among the suggested gifts, applying the recipient contact information to dispatch the selected gift to the recipient and applying the gifting user payment information to pay for the selected gift; and
a database circuit for storing the recipient profile among other user profiles created and maintained by other system users.
